(19) United States
(12) Patent Application Publication
(10) Pub. No.: US 2023/0315247 A1
(43) Pub. Date: Oct. 5, 2023

(54) Devices, Methods, and Graphical User Interfaces for Accessing System Functions of Computer Systems While Displaying Three-Dimensional Environments

(71) Applicant: Apple Inc., Cupertino, CA (US)

(72) Inventors: Israel Pastrana Vicente, San Jose, CA (US); Jonathan R. Dascola, San Francisco, CA (US); Stephen O. Lemay, Palo Alto, CA (US); Christopher D. McKenzie, Burlingame, CA (US); Jay Moon, San Francisco, CA (US); Jesse Chand, San Francisco, CA (US); Dorian D. Dargan, Oakland, CA (US); Amy E. DeDonato, San Francisco, CA (US); Matan Stauber, San Francisco, CA (US); Lorena S. Pazmino, San Francisco, CA (US); Evgenii Krivoruchko, San Francisco, CA (US)

(21) Appl. No.: 18/110,323

(22) Filed: Feb. 15, 2023

Related U.S. Application Data
(60) Provisional application No. 63/445,698, filed on Feb. 14, 2023.
(60) Provisional application No. 63/409,594, filed on Sep. 23, 2022.
(60) Provisional application No. 63/310,970, filed on Feb. 16, 2022.

(51) Int. Cl. G06F 3/04815; G06F 3/01; G06F 3/04842; G06F 3/16; G06F 3/04847

(52) U.S. Cl. CPC G06F 3/04815; G06F 3/013; G06F 3/017; G06F 3/04842; G06F 3/04847; G06F 3/165; G06F 3/167

(57) ABSTRACT

A computer system displays a first user interface object at a first position in the three-dimensional environment that has a first spatial arrangement relative to a respective portion of a user. While displaying the first user interface object, the computer system detects an input that corresponds to movement of a viewpoint of the user, and in response, maintains display of the first user interface object at a respective position in the three-dimensional environment having the first spatial arrangement relative to the respective portion of the user. While displaying the first user interface object, the computer system detects a first gaze input directed to the first user interface object, and in response, in accordance with a determination that the first gaze input satisfies attention criteria with respect to the first user interface object, displays a plurality of affordances for accessing system functions of the computer system.

### RELATED APPLICATIONS

This application claims priority to U.S. Provisional Application Serial No. 63/445,698, filed Feb. 14, 2023, U.S. Provisional Application Serial No. 63/409,594, filed Sep. 23, 2022, and U.S. Provisional Application Serial No. 63/310,970, filed Feb. 16, 2022, each of which are incorporated herein by reference in its entirety.

### TECHNICAL FIELD

The present disclosure relates generally to computer systems that are in communication with a display generation component and, optionally, one or more input devices that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user’s eyes and hand in space relative to the GUI (and/or computer system) or the user’s body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a computer system that is displaying one or more portions of a three-dimensional environment. Such methods and interfaces may complement or replace conventional methods for interacting with a computer system that is displaying one or more portions of a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system displays, via a first display generation component, a first user interface object while a first view of a three-dimensional environment is visible, wherein the first user interface object is displayed at a first position in the three-dimensional environment, and wherein the first position in the three-dimensional environment has a first spatial arrangement relative to a respective portion of a user. While displaying the first user interface object in the first view of the three-dimensional environment, the computer system detects, via one or more input devices, an input that corresponds to movement of a viewpoint of the user from a first viewpoint to a second viewpoint in the three-dimensional environment. In response to detecting the input that corresponds to movement of the viewpoint of the user from the first viewpoint to the second viewpoint in the three-dimensional environment, the computer system maintains display of the first user interface object at a respective position in the three-dimensional environment having the first spatial arrangement relative to the respective portion of the user while a second view of the three-dimensional environment is visible. While the second view of the three-dimensional environment is visible and while displaying the first user interface object in the second view of the three-dimensional environment, the computer system detects, via the one or more input devices, a first gaze input directed to the first user interface object. In response to detecting the first gaze input directed to the first user interface object, in accordance with a determination that the first gaze input satisfies attention criteria with respect to the first user interface object, the computer system displays a plurality of affordances for accessing system functions of the first computer system.

In some embodiments, a computer system displays, via a first display generation component, a first user interface object while a first view of a three-dimensional environment is visible, wherein the first user interface object is displayed at a first position in the three-dimensional environment, and wherein the first position in the three-dimensional environment has a first spatial arrangement relative to a respective portion of the user. While displaying the first user interface object in the first view of the three-dimensional environment, the computer system detects, via one or more input devices, a first gaze input directed to the first user interface object. In response to detecting the first gaze input directed to the first user interface object: in accordance with a determination that a first event for a first notification satisfies timing criteria, the computer system displays content associated with the first notification; and in accordance with a determination that the first event for the first notification does not satisfy the timing criteria, the computer system displays a plurality of affordances for performing system operations associated with the first computer system without displaying the content associated with the first notification.

In some embodiments, a computer system displays, via a first display generation component, a first user interface object while a first view of a three-dimensional environment is visible, wherein the first user interface object is displayed at a first position in the three-dimensional environment, and wherein the first position in the three-dimensional environment has a first spatial arrangement relative to a respective portion of the user. While displaying the first user interface object in the first view of the three-dimensional environment, the computer system detects, via one or more input devices, a first gaze input directed to the first user interface object. In response to detecting the first gaze input directed to the first user interface object: in accordance with a determination that there is a request for the first computer system to join a first communication session that satisfies timing criteria, the computer system displays a first user interface that includes an affordance for joining the first communication session; and in accordance with a determination that there is not a request to join a communication session that satisfies the timing criteria, the computer system displays a plurality of affordances for performing system operations associated with the first computer system without displaying the affordance for joining a communication session.

In some embodiments, a computer system displays, via a first display generation component, a first view of a three-dimensional environment that corresponds to a first viewpoint of a user. The first view of the three-dimensional environment includes a first user interface element that is displayed at a first position in the three-dimensional environment, the first user interface element has a first spatial relationship with the first viewpoint of the user while the first user interface element is displayed at the first position in the three-dimensional environment, and the first user interface element includes at least a first affordance. While displaying the first view of the three-dimensional environment, including displaying the first user interface element at the first position in the three-dimensional environment, the computer system detects first movement of a viewpoint of the user from the first viewpoint to a second viewpoint. In response to detecting the first movement of the viewpoint of the user from the first viewpoint to the second viewpoint, while a second view of the three-dimensional environment that corresponds to the second viewpoint of the user is visible via the one or more display generation components, the computer system displays the first user interface element at a second position in the three-dimensional environment, wherein the first user interface element has the first spatial relationship with the second viewpoint of the user while the first user interface element is displayed at the second position in the three-dimensional environment. While displaying the first user interface element in the second view of the three-dimensional environment, the computer system detects, via one or more input devices, a first input that corresponds to activation of the first affordance. In response to detecting the first input that corresponds to activation of the first affordance, the computer system displays a second user interface element in the second view of the three-dimensional environment, wherein the second user interface element is displayed at a third position in the three-dimensional environment. While displaying the second view of the three-dimensional environment, including displaying the second user interface element at the third position in the three-dimensional environment, the computer system detects second movement of the viewpoint of the user from the second viewpoint to a third viewpoint. In response to detecting the second movement of the viewpoint of the user from the second viewpoint to the third viewpoint, while a third view of the three-dimensional environment that corresponds to the third viewpoint of the user is visible via the one or more display generation components, the computer system displays the second user interface element at a location in the third view of the three-dimensional environment that corresponds to the third position in the three-dimensional environment.

In some embodiments, while a first view of a three-dimensional environment is visible via the first display generation component, a computer system detects, via one or more input devices, a first user input, including detecting a first gaze input that is directed to a first position in the three-dimensional environment. In response to detecting the first user input including detecting the first gaze input: in accordance with a determination that the first position in the three-dimensional environment has a first spatial relationship to a viewport through which the three-dimensional environment is visible, the computer system displays a first user interface object in the first view of the three-dimensional environment, wherein the first user interface object includes one or more affordances for accessing a first set of functions of the first computer system, wherein the first user interface object is displayed at a second position in the three-dimensional environment that has a second spatial relationship, different from the first spatial relationship, to the viewport through which the three-dimensional environment is visible; and in accordance with a determination that the first position in the three-dimensional environment does not have the first spatial relationship to the viewport through which the three-dimensional environment is visible, the computer system forgoes displaying the first user interface object in the first view of the three-dimensional environment.

In some embodiments, while a first view of a three-dimensional environment is visible via the first display generation component, a computer system detects, via one or more input devices, that attention of a user of the computer system is directed to a first portion of the first view of the three-dimensional environment. In response to detecting that the attention of the user is directed to the first portion of the first view of the three-dimensional environment: in accordance with a determination that the first portion of the first view of the three-dimensional environment has a first spatial relationship to a viewport through which the three-dimensional environment is visible while a first set of one or more contextual conditions are met at a time that the attention of the user is directed to the first portion of the first view of the three-dimensional environment, the computer system displays a first set of one or more user interface objects that correspond to the first set of one or more contextual conditions; and in accordance with a determination that the first portion of the first view of the three-dimensional environment has the first spatial relationship to the viewport through which the three-dimensional environment is visible while a second set of one or more contextual conditions, different from the first set of one or more contextual conditions, are met at the time that the attention of the user is directed to the first portion of the first view of the three-dimensional environment, the computer system displays a second set of one or more user interface objects that correspond to the second set of one or more contextual conditions, the second set of one or more user interface objects being different from the first set of one or more user interface objects.

In some embodiments, while a first view of an environment is visible via one or more display generation components, a computer system detects occurrence of a first event. In response to detecting the occurrence of the first event, the computer system displays, via a first display generation component, a first indication of a first notification corresponding to the first event. After displaying, via the first display generation component, the first indication of the first notification corresponding to the first event: in accordance with a determination that attention of a user of the computer system was directed to the first indication within a first threshold amount of time and then moved away from the first indication before first criteria are met, the computer system maintains display of the first indication for a first duration of time and ceases display of the first indication after expiration of the first duration of time; and in accordance with a determination that the attention of the user of the computer system was not directed to the first indication within the first threshold amount of time, the computer system maintains display of the first indication for a second duration of time and ceases display of the first indication after expiration of the second duration of time, wherein the second duration of time is different from the first duration of time.

In some embodiments, while a respective view of a three-dimensional environment that includes one or more physical objects is visible via a first display generation component, a computer system detects a first input that corresponds to a request to display one or more notifications in the respective view of the three-dimensional environment. In response to detecting the first input, the computer system displays a respective notification that corresponds to a previously detected event at a respective location in the three-dimensional environment. In accordance with a determination that the representation of the physical environment at the respective location at which the respective notification is displayed has a first set of values for a first visual characteristic, the computer system displays the respective notification with a first visual appearance that is based at least in part on the first set of values for the first visual characteristic of the representation of the physical environment at the respective location; and in accordance with a determination that the representation of the physical environment at the respective location at which the respective notification is displayed has a second set of values, different from the first set of values, for the first visual characteristic, the computer system displays the respective notification with a second visual appearance, different from the first visual appearance, that is based at least in part on the second set of values for the first visual characteristic of the representation of the physical environment at the respective location.

In some embodiments, a computer system displays, via the first display generation component, a first user interface object in a first view of a three-dimensional environment that corresponds to a first viewpoint of a user, wherein the first user interface object is displayed at a first position in the three-dimensional environment and has a first spatial relationship with the first viewpoint of the user. While displaying the first user interface object in the first view of the three-dimensional environment, the computer system, via the one or more input devices, first movement of a current viewpoint of the user from the first viewpoint to a second viewpoint of the user. In response to detecting the first movement of the current viewpoint of the user from the first viewpoint to the second viewpoint, the computer system: replaces display of the first view of the three-dimensional environment with display of a second view of the three-dimensional environment that corresponds to the second viewpoint of the user; in accordance with a determination that the first movement of the current viewpoint of the user from the first viewpoint to the second viewpoint does not meet first criteria and that the first user interface object is of a first type, displays the first user interface object in the second view of the three-dimensional environment, wherein the first user interface object is displayed at a second position, different from the first position, in the three-dimensional environment and has the first spatial relationship with the second viewpoint of the user; and in accordance with a determination that the first movement of the current viewpoint of the user from the first viewpoint to the second viewpoint does not meet the first criteria and that the first user interface object is of a second type different from the first type, forgoes displaying the first user interface object at the second position in the three-dimensional environment in the second view of the three-dimensional environment. The computer system detects via the one or more input devices, second movement of the current viewpoint of the user from the second viewpoint to a third viewpoint of the user. In response to detecting the second movement of the current viewpoint of the user from the second viewpoint to the third viewpoint, the computer system: replaces display of the second view of the three-dimensional environment with display of a third view of the three-dimensional environment that corresponds to the third viewpoint of the user and in accordance with a determination that the second movement of the current viewpoint of the user from the second viewpoint to the third viewpoint meets the first criteria, displays the first user interface object in the third view of the three-dimensional environment, wherein the first user interface object is displayed at a third position, different from the first position and the second position, in the three-dimensional environment and has the first spatial relationship with the third viewpoint of the user, irrespective of whether the first user interface object is of the first type or the second type.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a block diagram illustrating an operating environment of a computer system for providing XR experiences in accordance with some embodiments.

FIG. 2 is a block diagram illustrating a controller of a computer system that is configured to manage and coordinate a XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7K illustrate example techniques for displaying a plurality of affordances for accessing system functions of a computer system, in accordance with some embodiments.

FIGS. 7L-7Q illustrate example techniques for displaying content associated with a first notification, in accordance with some embodiments.

FIGS. 7R-7X illustrate example techniques for displaying a first user interface that includes an affordance for joining a communication session, in accordance with some embodiments.

FIG. 7Y-7AF illustrate example techniques for initiating displaying of an environment-locked user interface from a head-locked user interface, in accordance with some embodiments.

FIG. 7AG-7AM illustrate exemplary regions for triggering display of one or more user interface elements, in accordance with some embodiments.

FIG. 7AN-7AT illustrate exemplary contextual user interfaces that are displayed when different context criteria are met, in accordance with some embodiments.

FIG. 7AU-7AZ illustrate exemplary methods for dismissing indications of notifications, in accordance with some embodiments.

FIG. 7BA-7BJ illustrate exemplary methods for displaying and interacting with previously received notifications, in accordance with some embodiments.

FIG. 7BK-7BR illustrate example methods for moving, hiding, and redisplaying user interface objects in accordance with movement of the viewpoint of the user, in accordance with some embodiments.

FIG. 8 is a flow diagram of methods of displaying a plurality of affordances for accessing system functions of a computer system, in accordance with various embodiments.

FIG. 9 is a flow diagram of methods of displaying content associated with a first notification, in accordance with various embodiments.

FIG. 10 is a flow diagram of methods of displaying a first user interface that includes an affordance for joining a communication session, in accordance with various embodiments.

FIGS. 11A-11B are flow diagrams of methods of initiating display of an environment-locked user interface from a head-locked user interface, in accordance with various embodiments.

FIG. 12 is a flow diagram of methods for initiating display of a user interface in response to detecting that a user’s attention is directed to a respective region of a three-dimensional environment, in accordance with various embodiments.

FIG. 13 is a flow diagram of methods for displaying and interacting with contextual user interfaces, in accordance with some embodiments.

FIG. 14 is a flow diagram of methods for dismissing indications of notifications, in accordance with various embodiments.

FIG. 15 is a flow diagram of methods for displaying and interacting with previously received notifications in a notification history user interface, in accordance with various embodiments.

FIGS. 16A-16B are flow diagrams of methods for moving, hiding, and redisplaying user interface objects in accordance with movement of the viewpoint of the user, in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system displays a plurality of affordances for performing system functions (e.g., system settings such as audio volume, a centralized notifications user interface, a search function, a virtual assistant) of the computer system in response to a user directing a gaze input to a first user interface object (e.g., a system control indicator) and if the gaze input satisfies attention criteria with respect to the first user interface object (e.g., is maintained long enough). Conditionally displaying a set of affordances for accessing system functions of the computer system based on whether the user is sufficiently paying attention to the first user interface object used to trigger display of the plurality of affordances reduces the number of inputs needed to access (e.g., provides a shortcut to) the system functions without otherwise cluttering the three-dimensional environment with visual controls (e.g., by displaying a single less intrusive element that provides the user with visual feedback about where to look to bring up the plurality of affordances, without continuously displaying the plurality of affordances).

In some embodiments, if an event for a notification satisfies timing criteria (e.g., occurred recently, within a threshold amount of time), the computer system displays content associated with the notification in response to a gaze input directed to the first user interface object. If an event for a notification does not satisfy the timing criteria, in response to a gaze input directed to the first user interface object, the computer system displays the plurality of affordances for accessing system functions without displaying the content associated with the notification. Conditionally displaying content of a notification about a triggering event based on whether the event occurred recently enough allows the user to control whether the notification is displayed, based on whether the user gazes at the first user interface object, and causes the computer system to automatically and timely display information and/or controls that are more likely to be relevant to a current context of the computer system.

In some embodiments, if the computer system has received a request to join a communication session, and the request remains active, in response to a gaze input directed to the first user interface object, the computer system displays a user interface that includes an affordance for joining the communication session. If no request to join a communication session is active, in response to a gaze input directed to the first user interface object, the computer system displays the plurality of affordances for accessing system functions without displaying a user interface with an affordance for joining a communication session. Conditionally displaying the user interface that includes an affordance for joining a communication session that is actively being requested allows the user to control whether to view the request, based on whether the user gazes at the first user interface object, and causes the computer system to automatically and timely display information and/or controls that are likely to be more relevant to a current context of the computer system (e.g., by allowing the user to respond more quickly to an active request or by simply displaying the system controls).

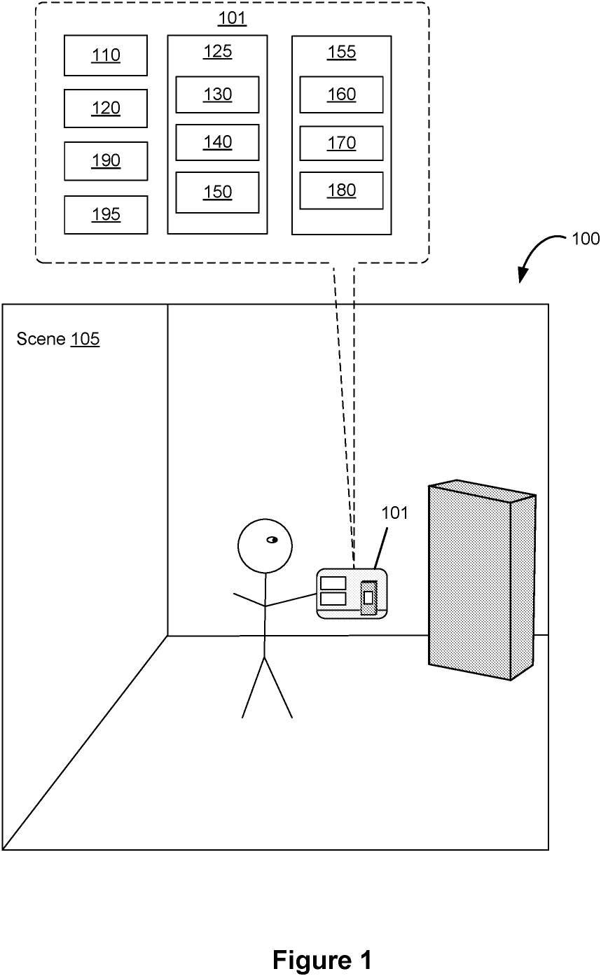

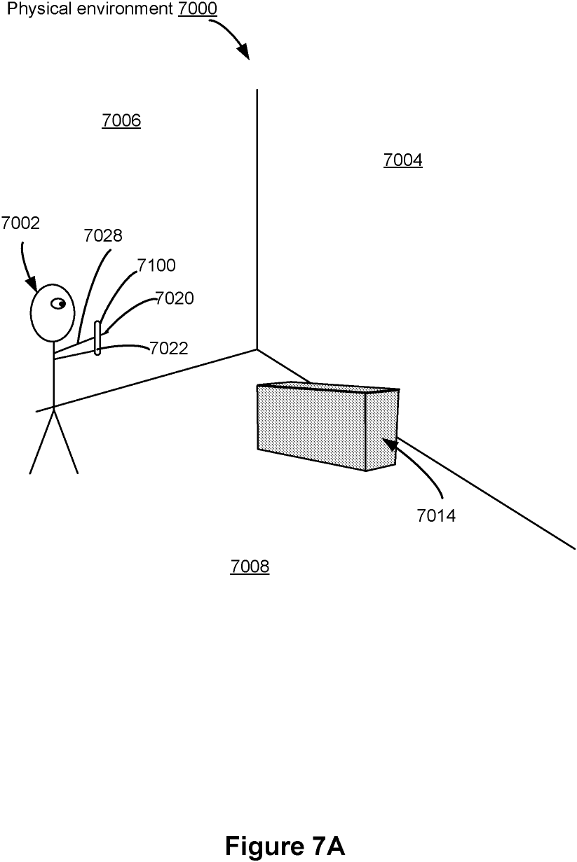

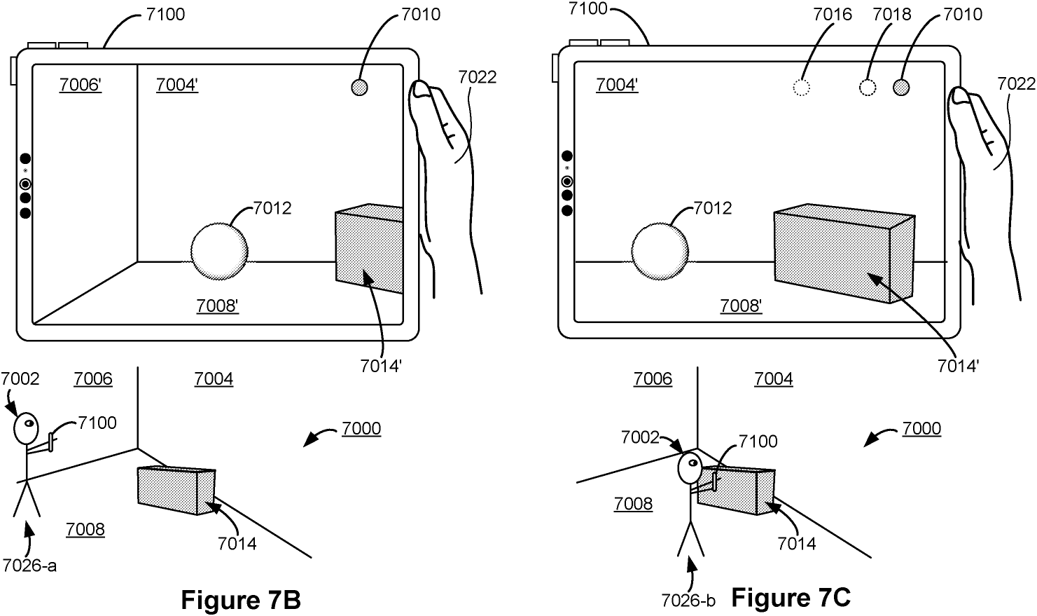

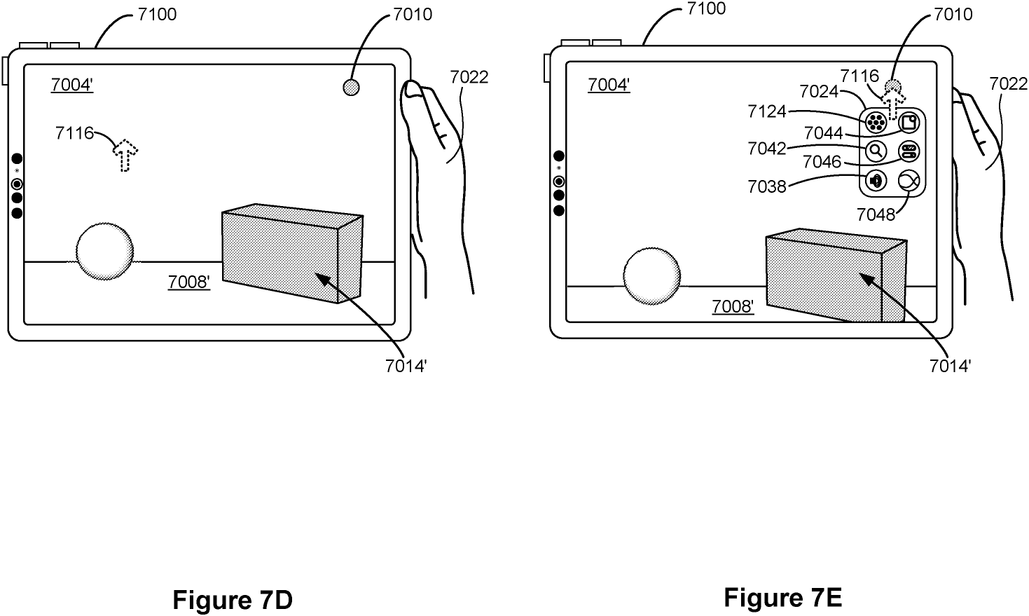

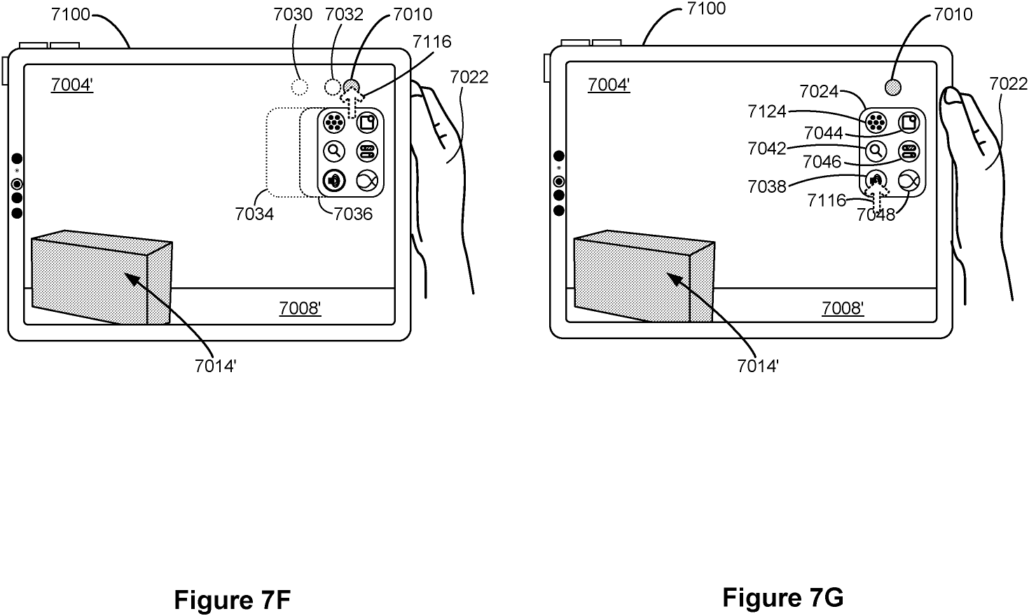

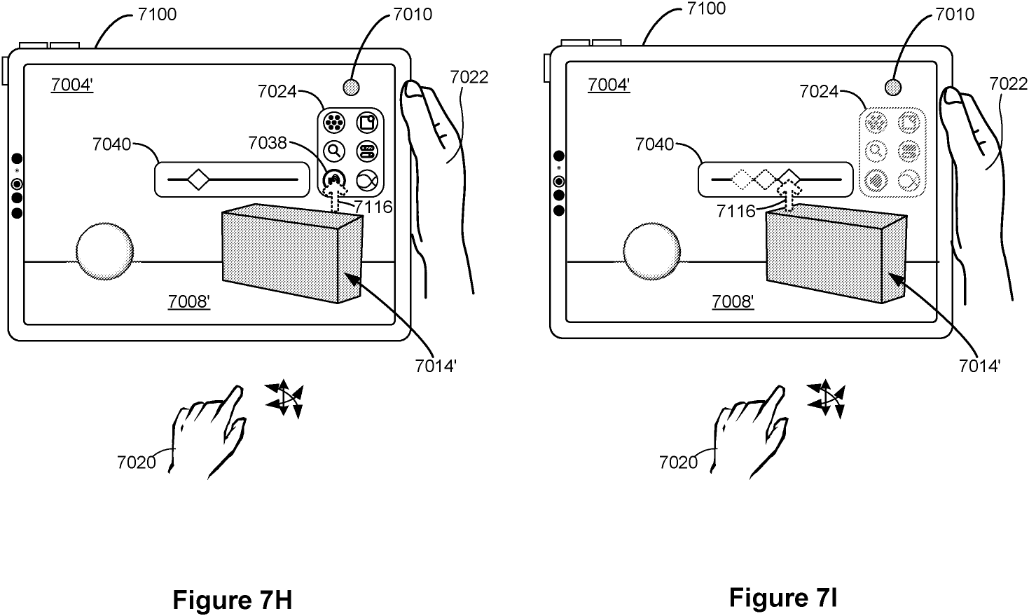

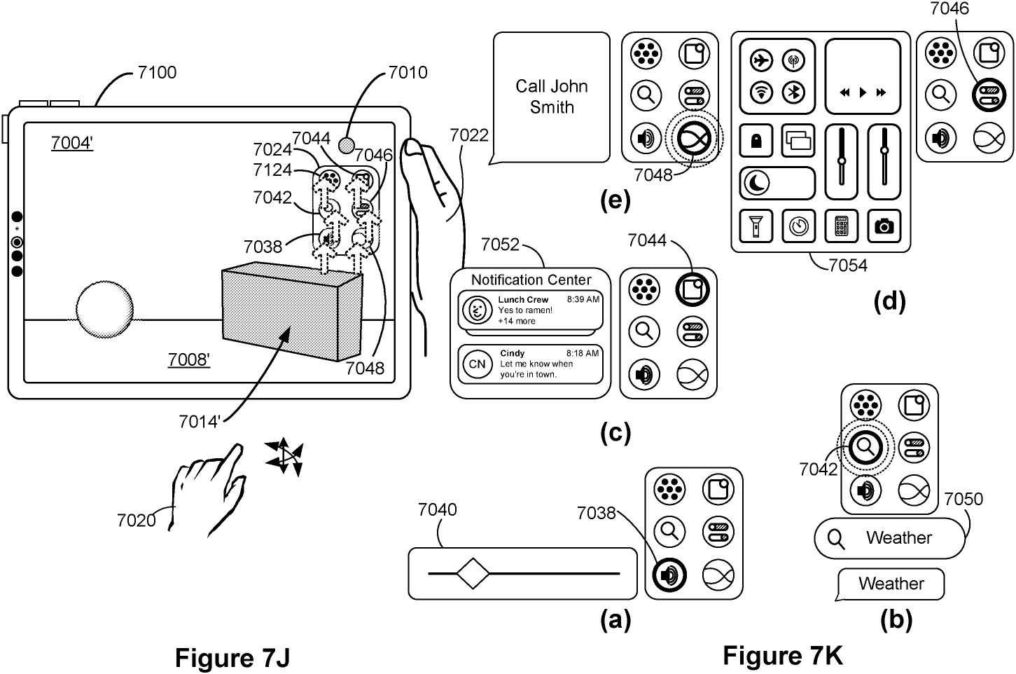

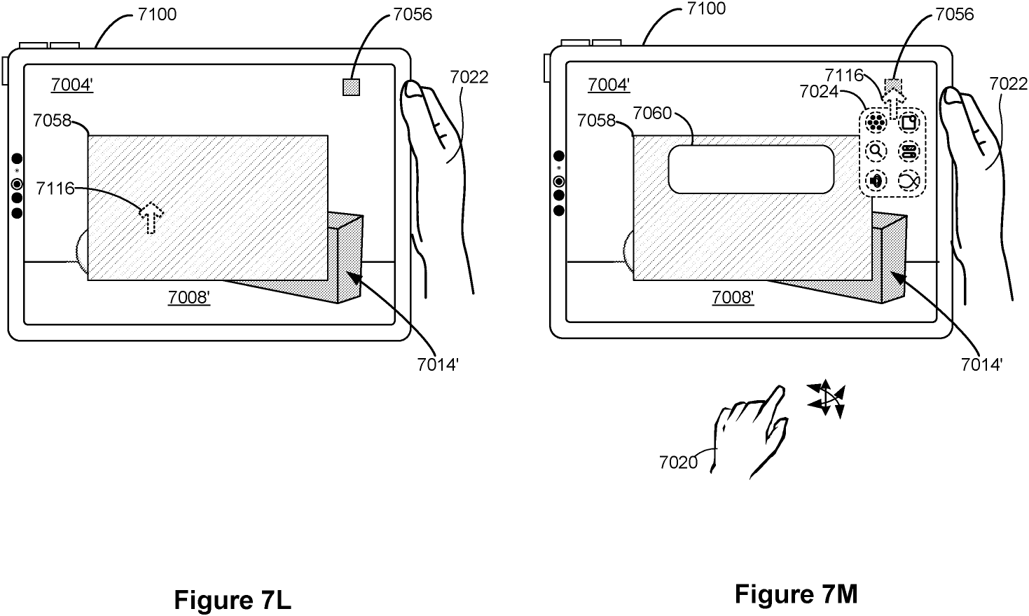

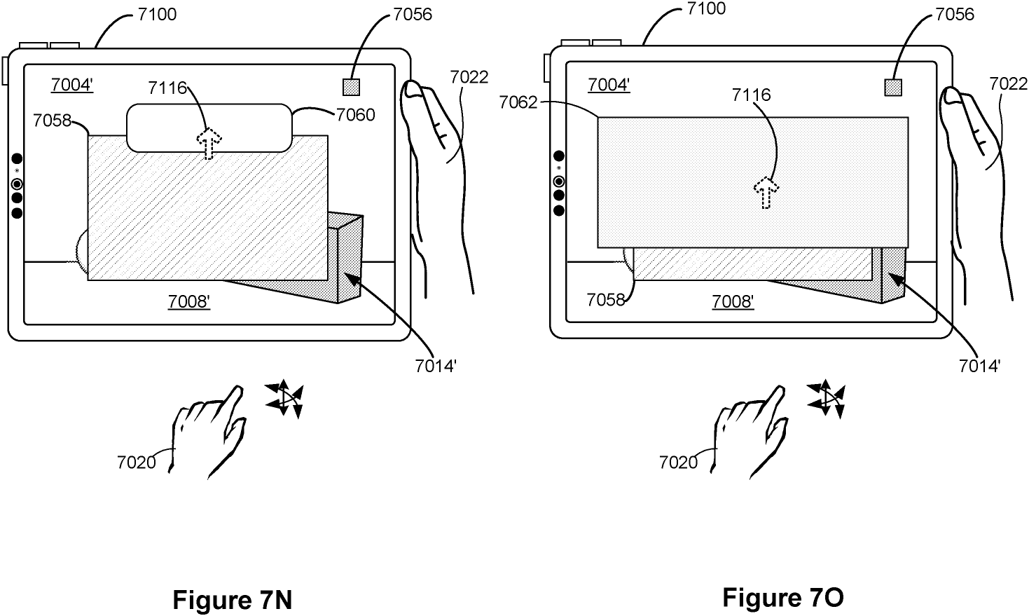

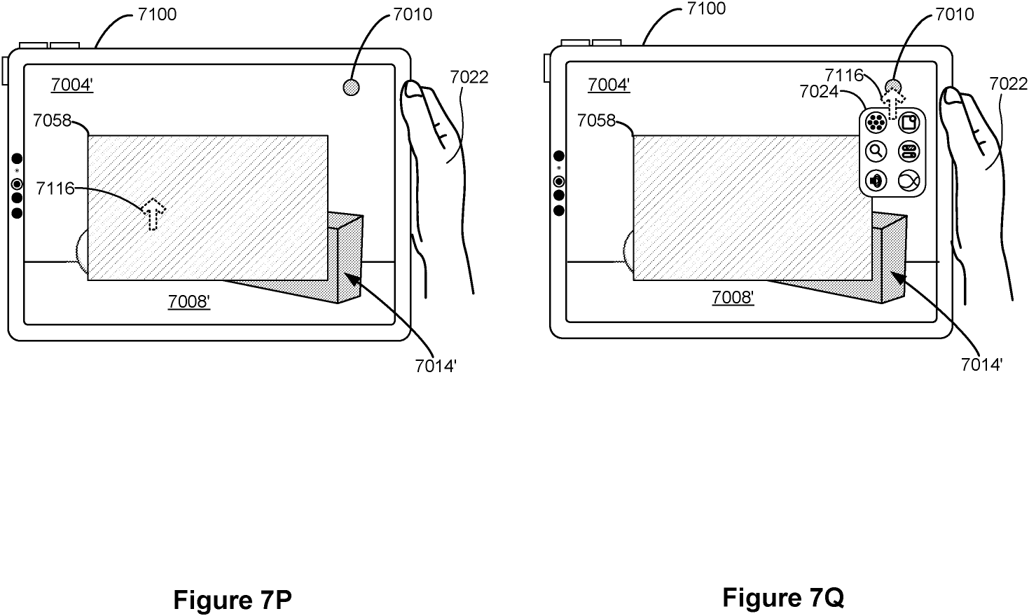

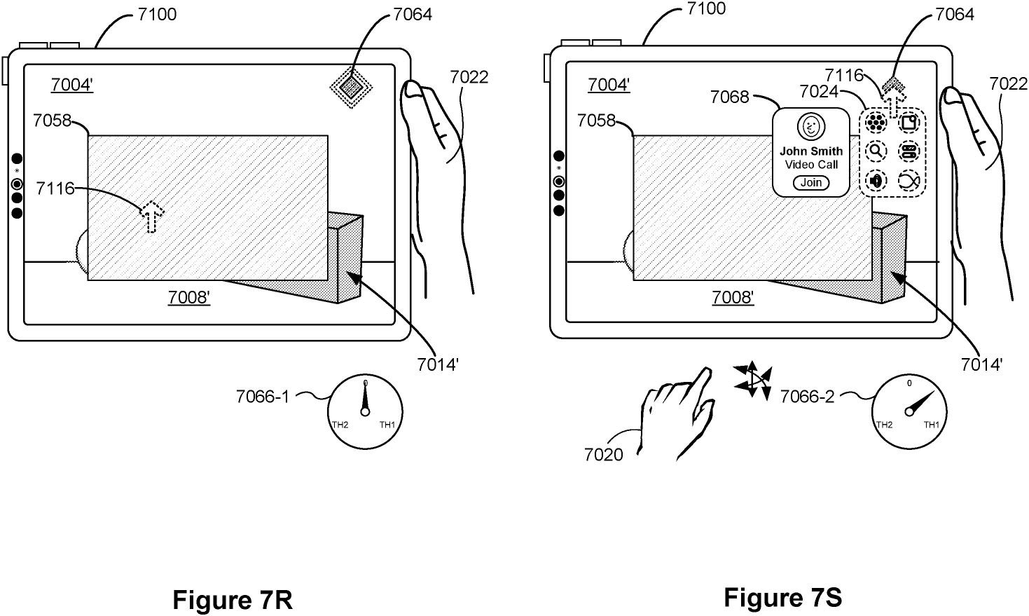

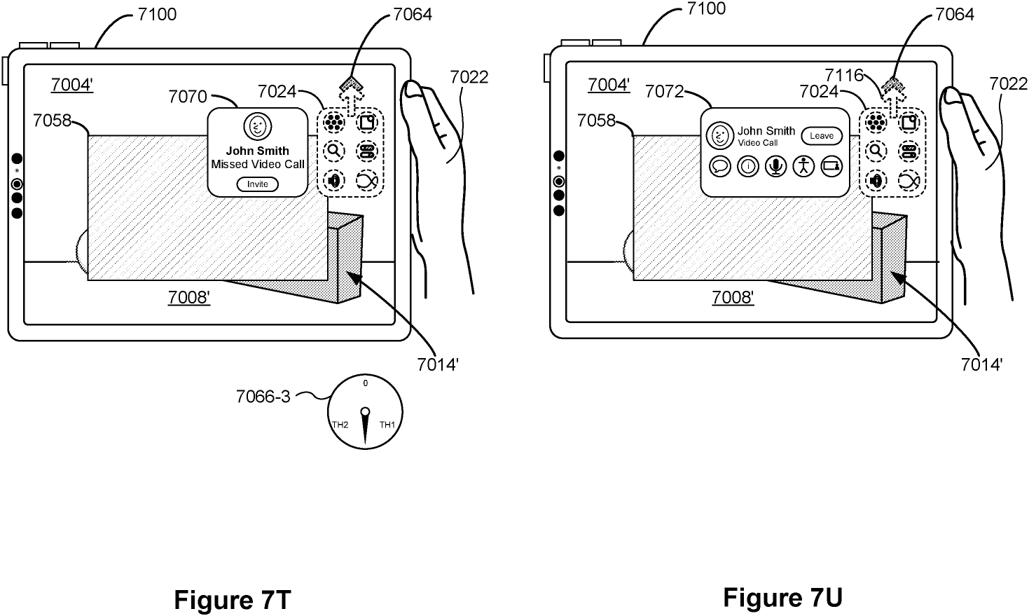

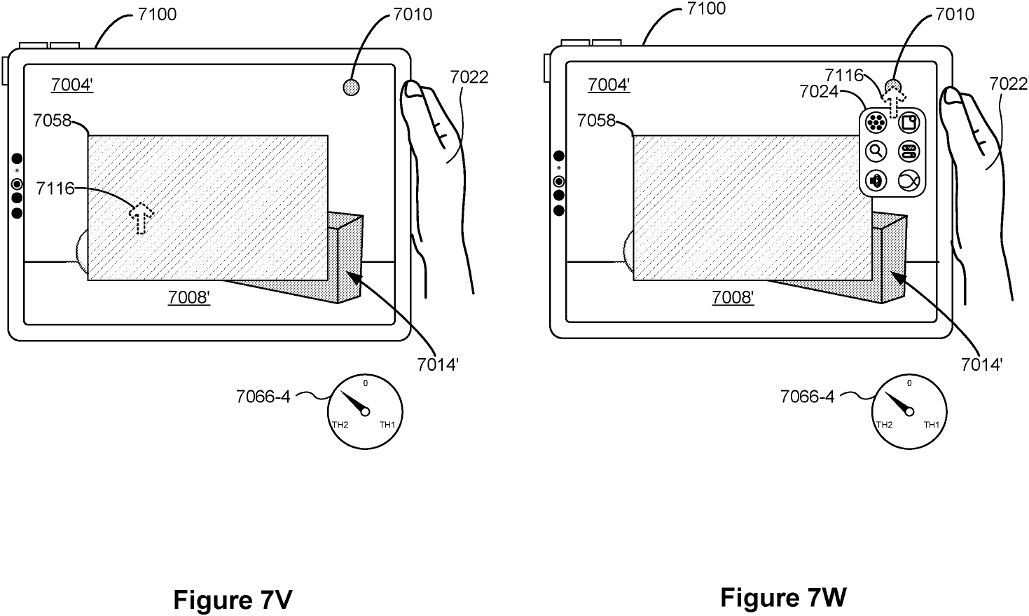

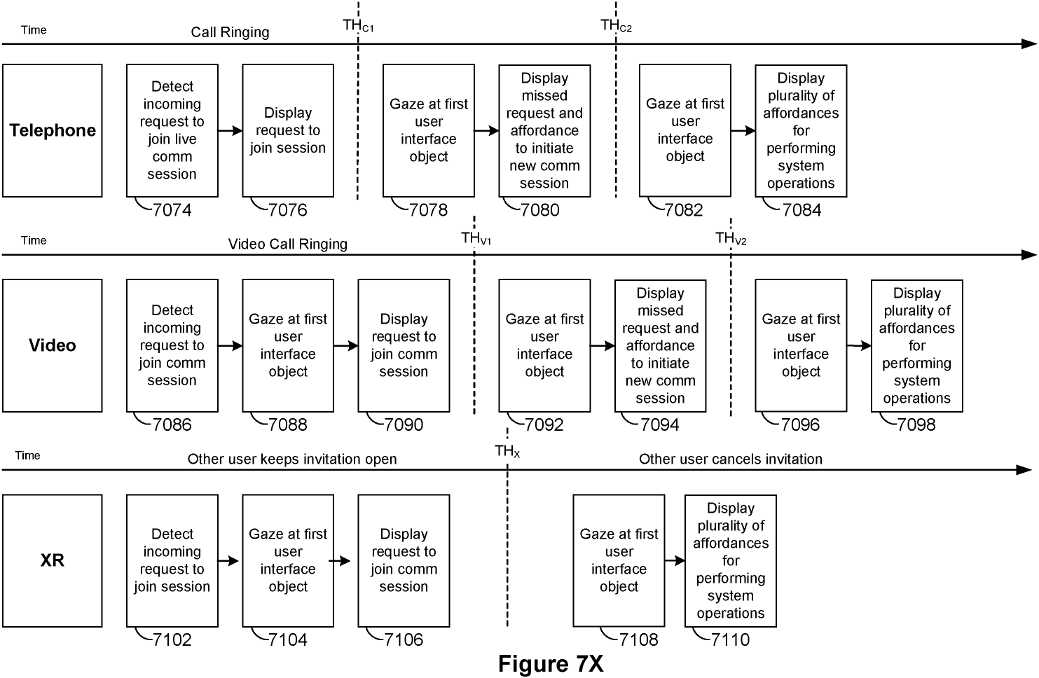

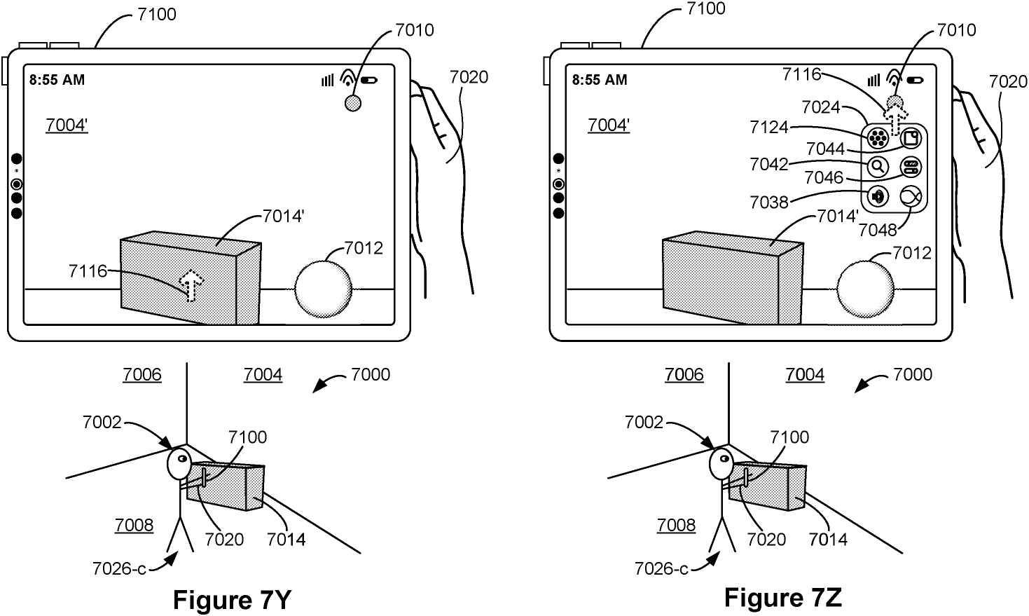

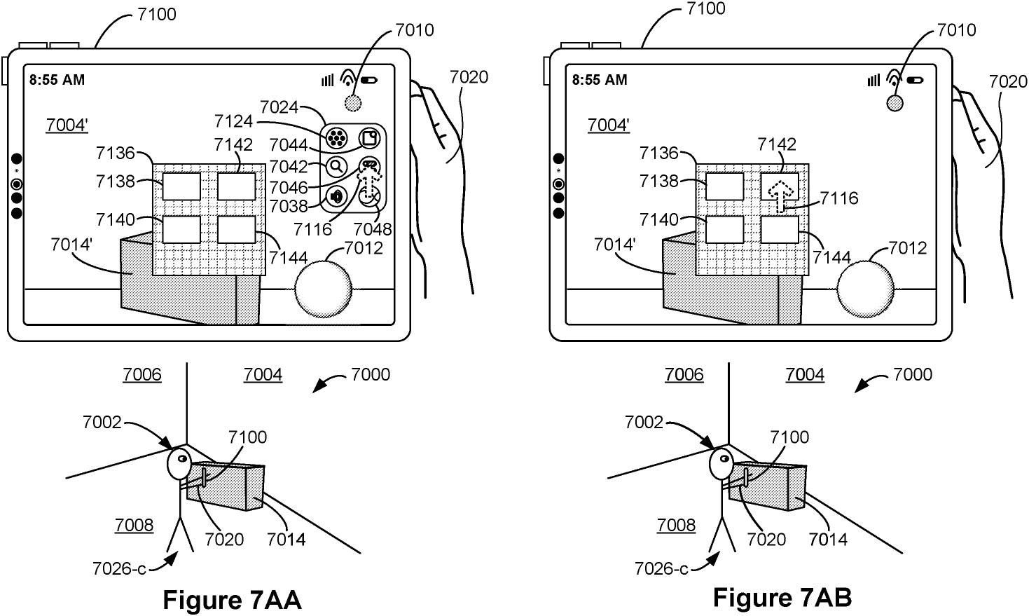

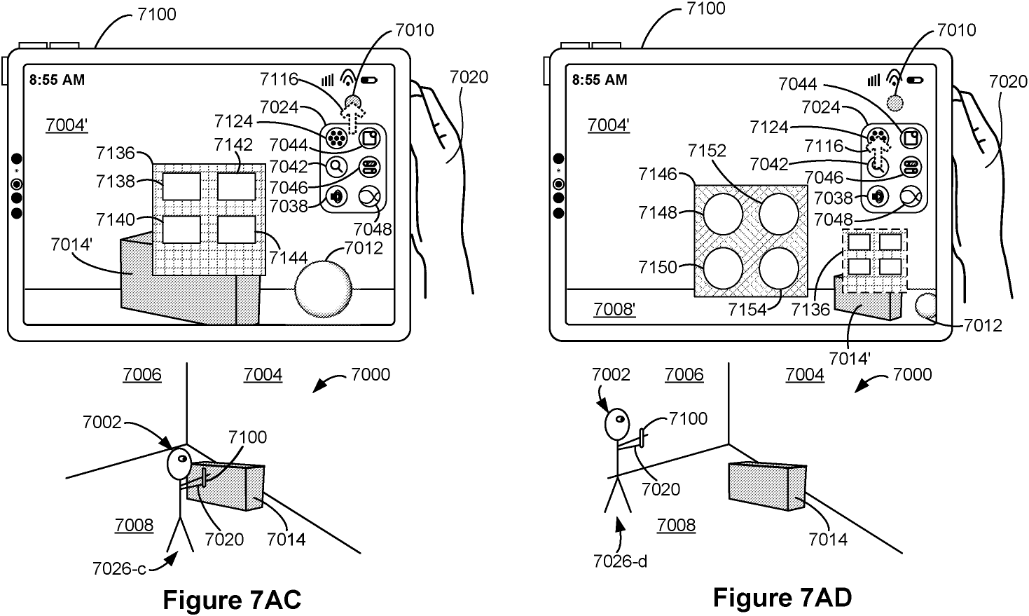

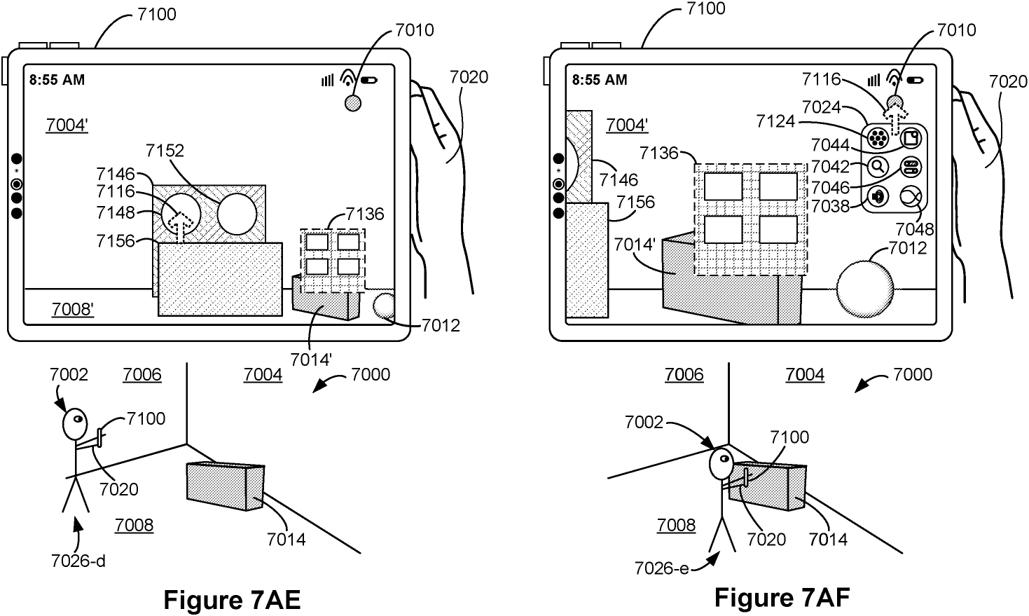

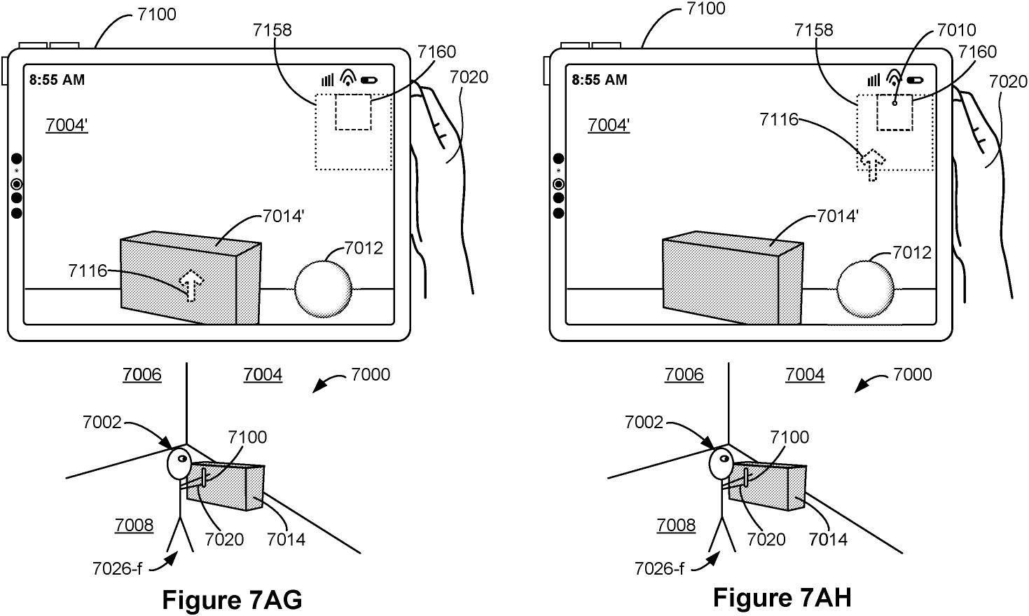

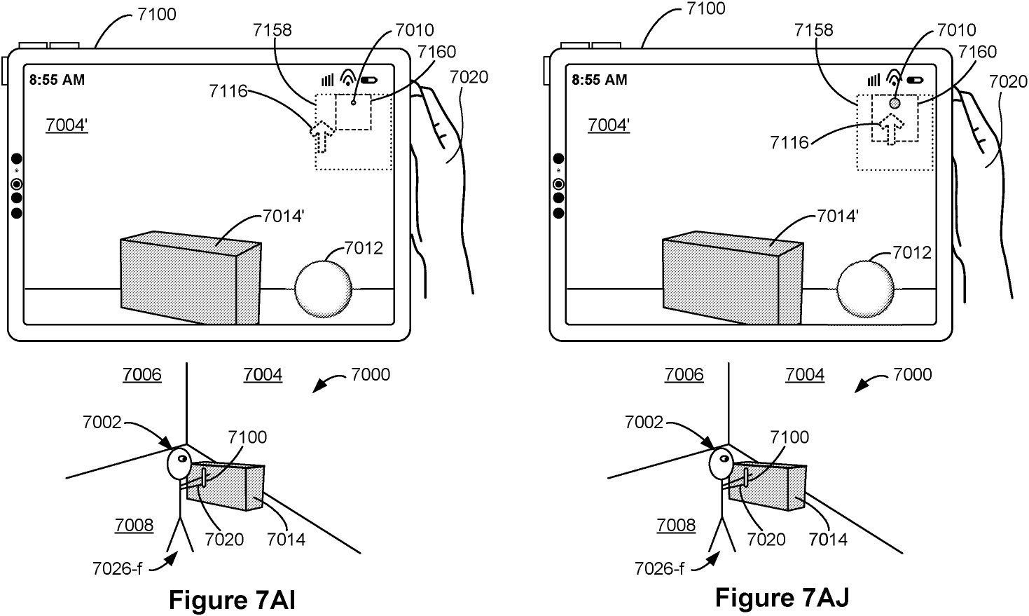

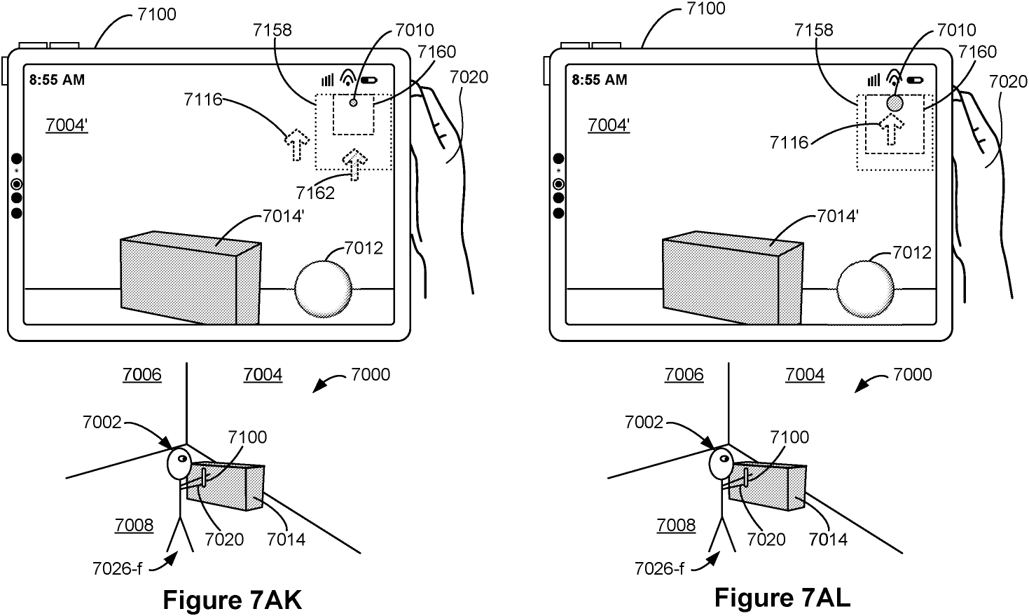

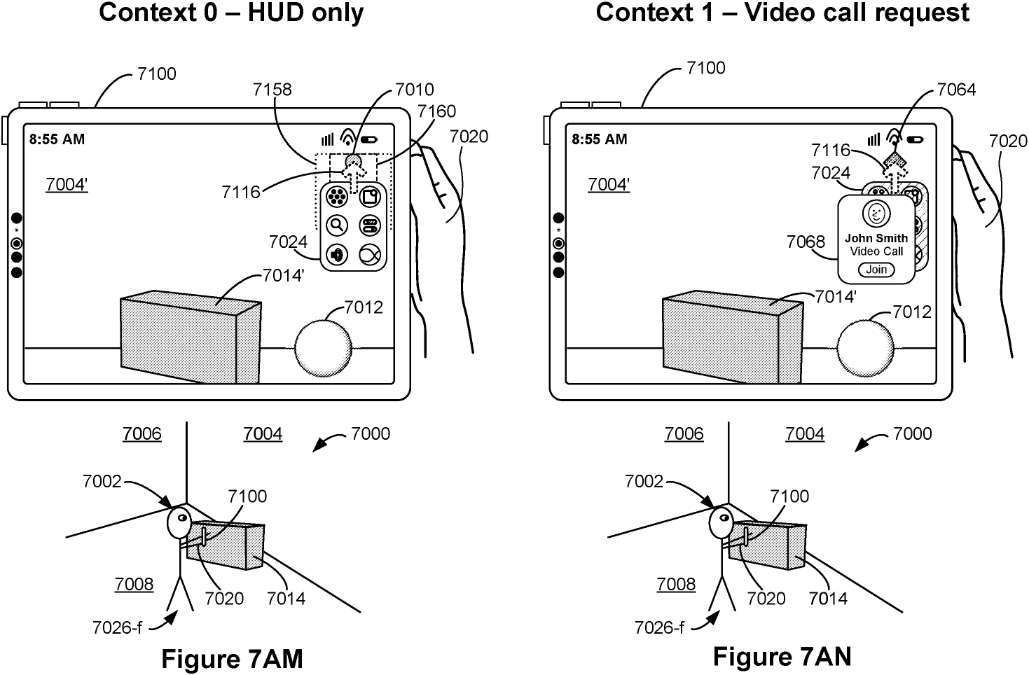

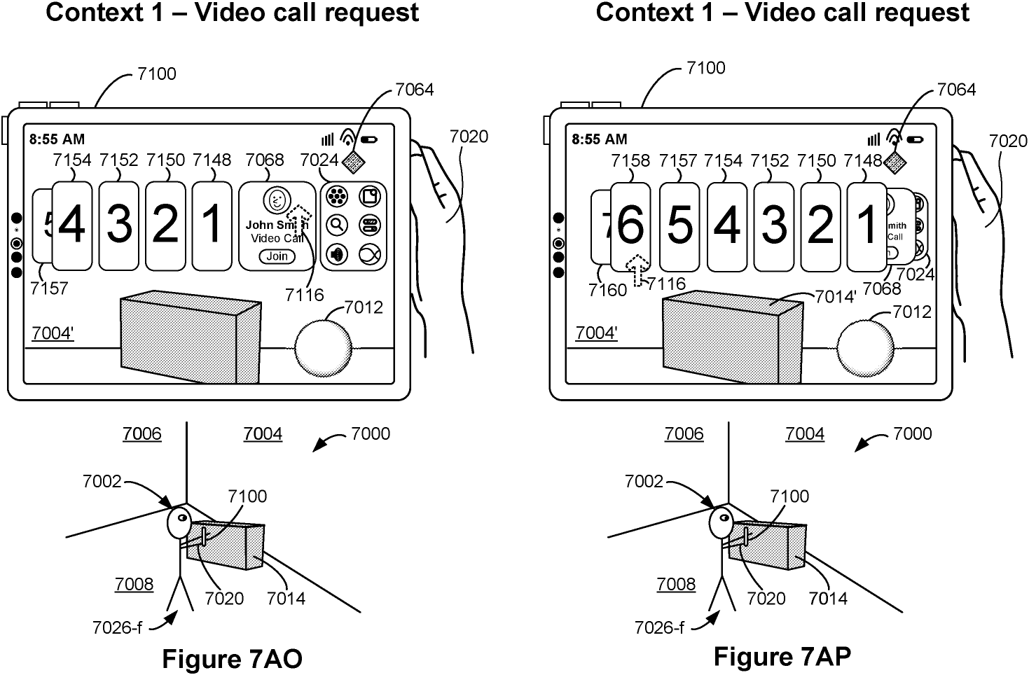

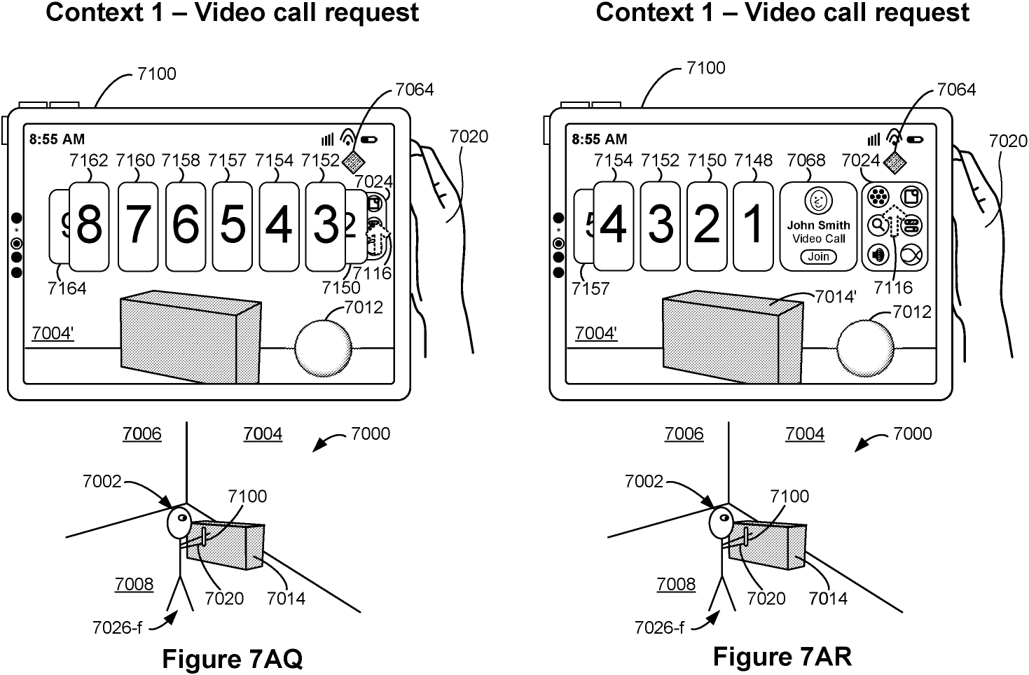

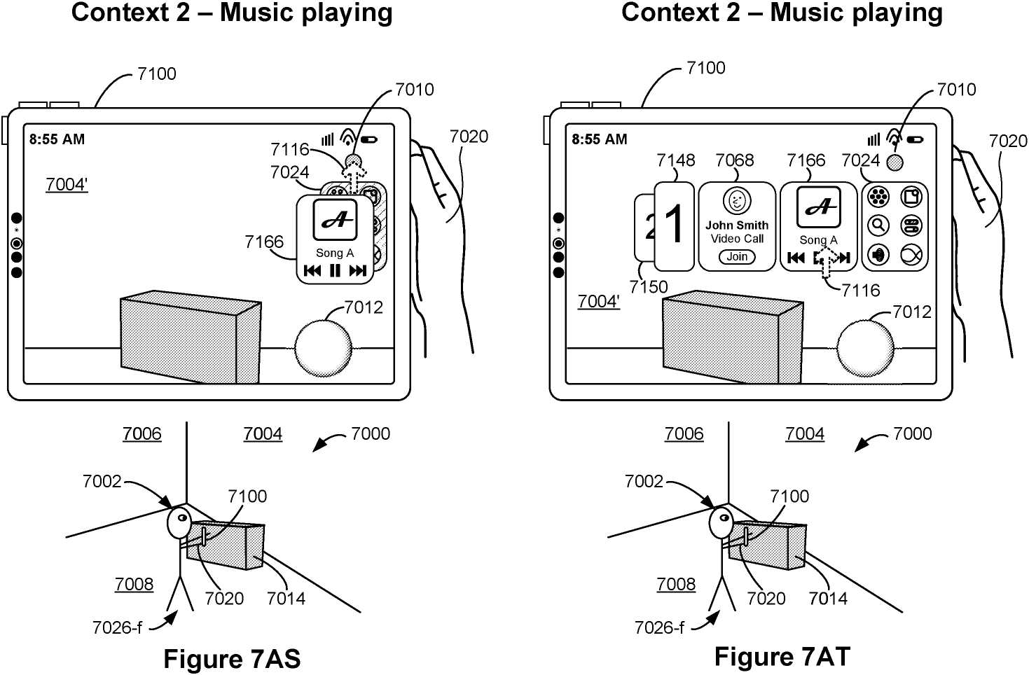

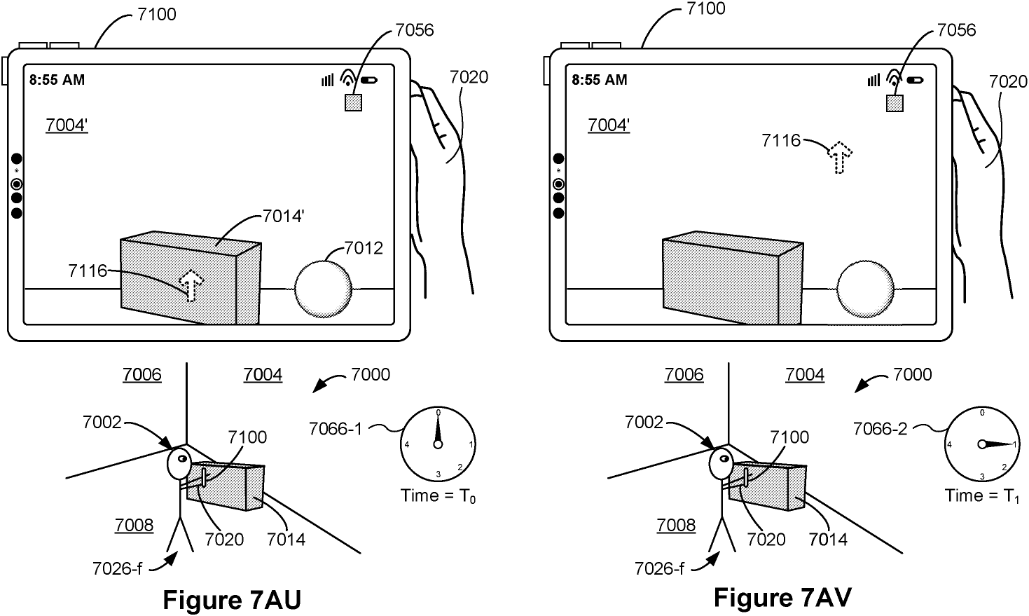

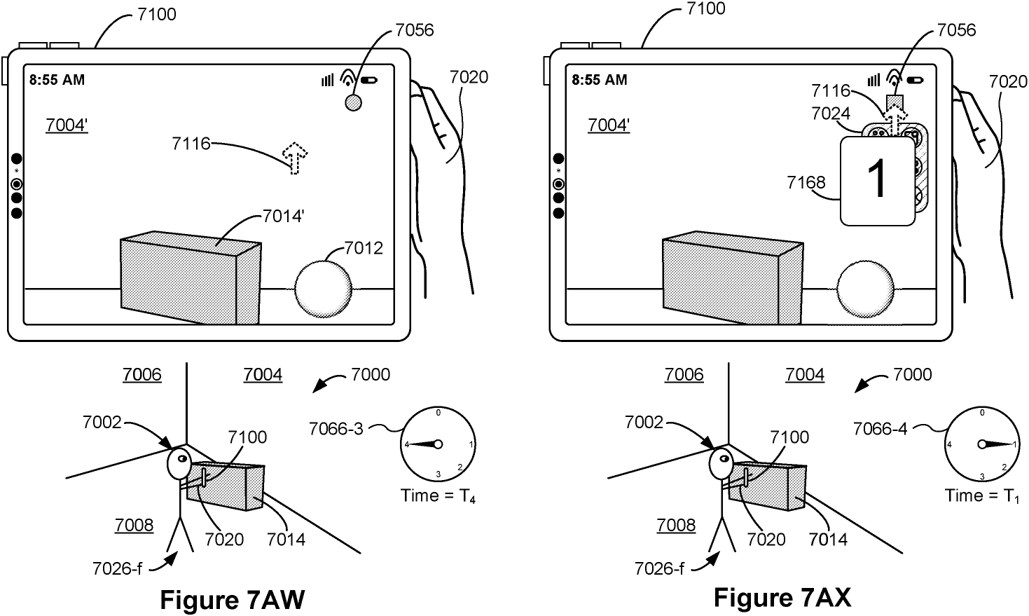

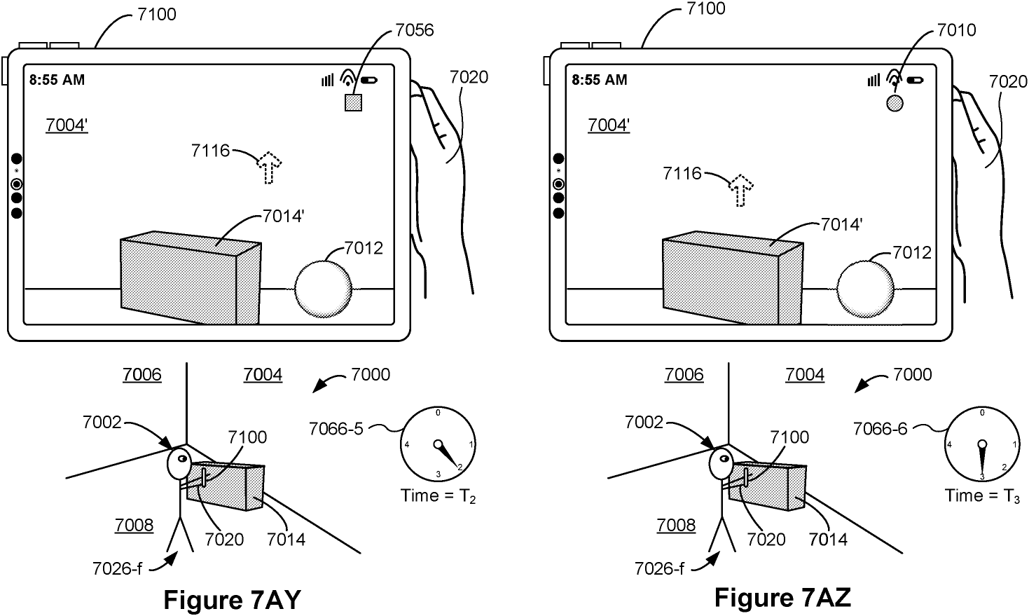

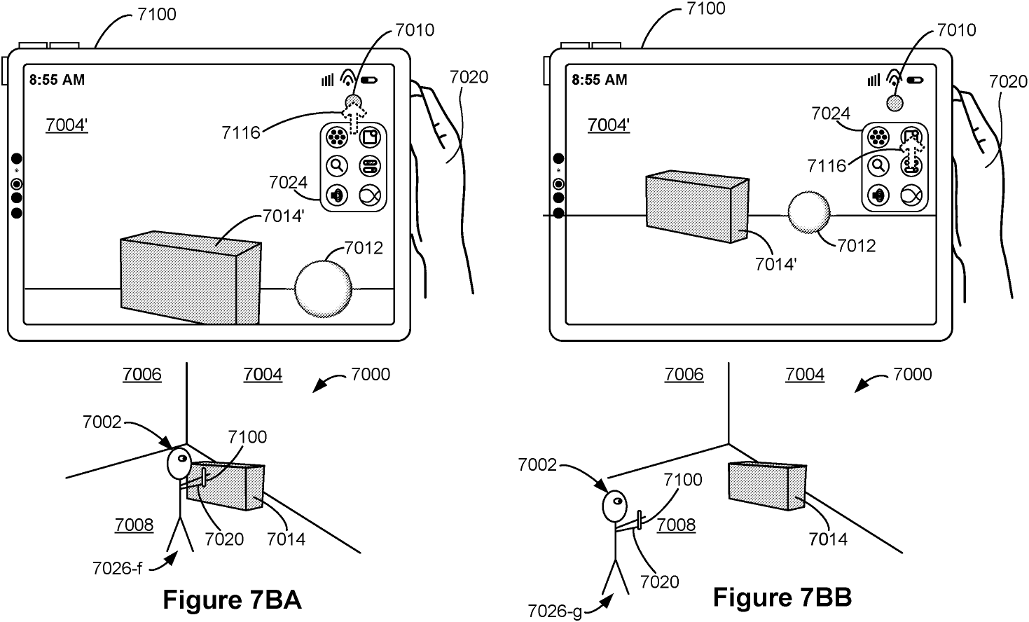

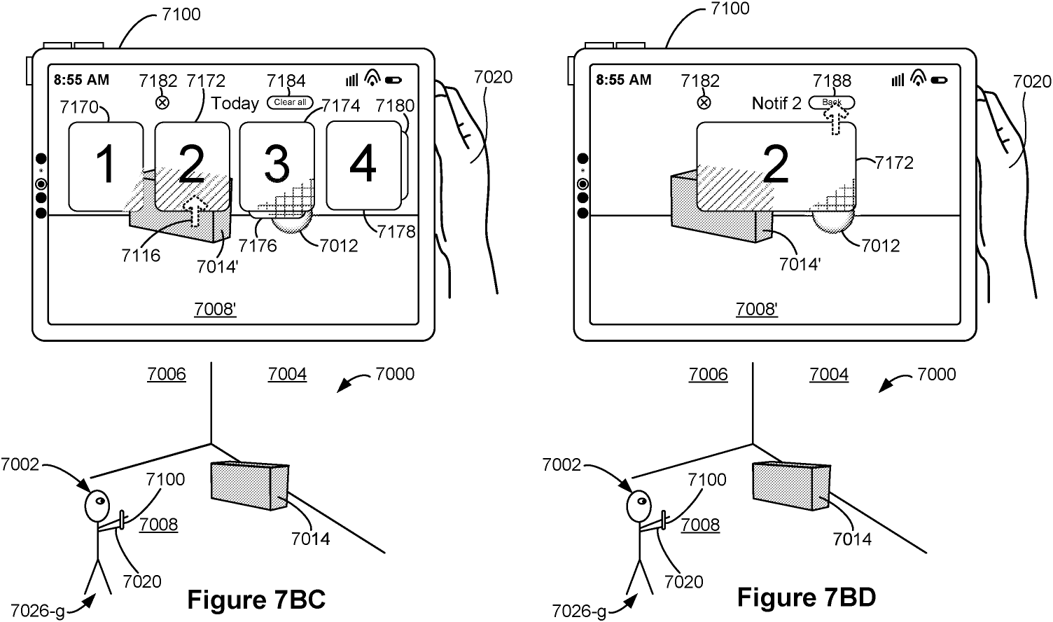

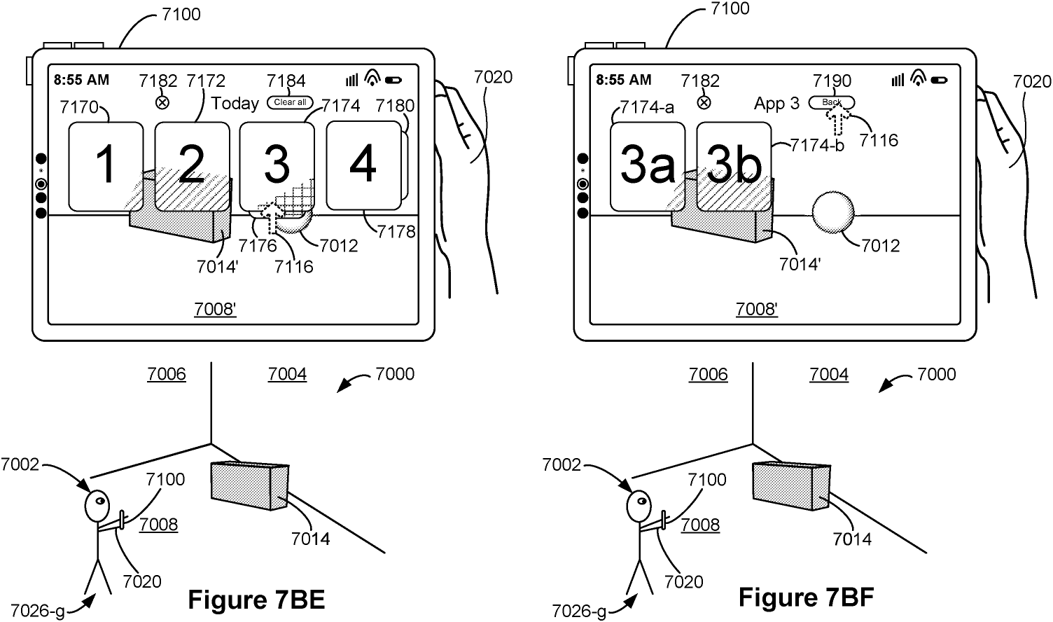

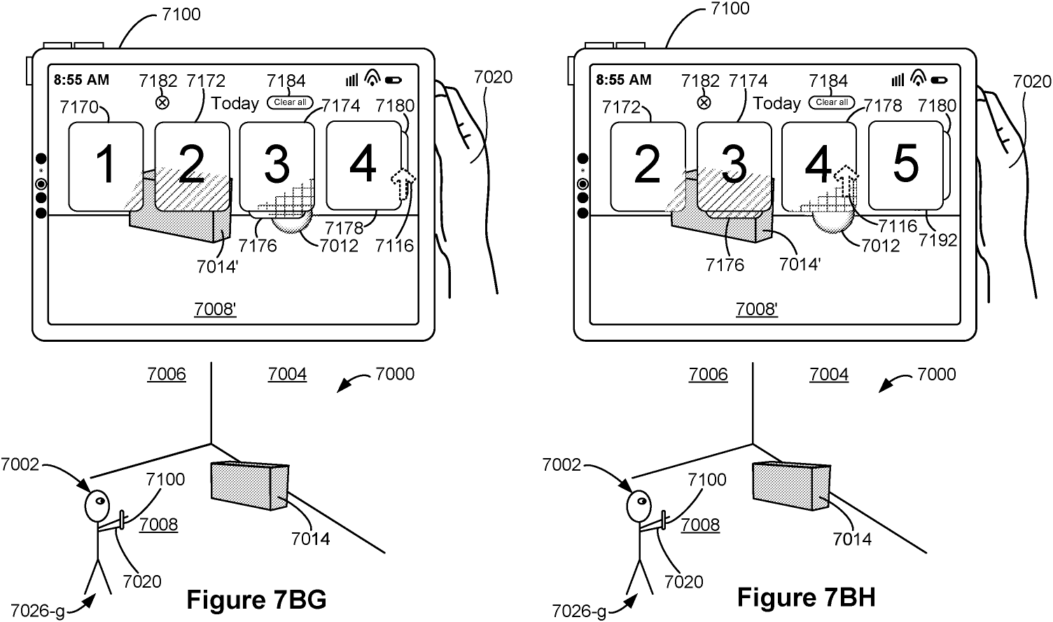

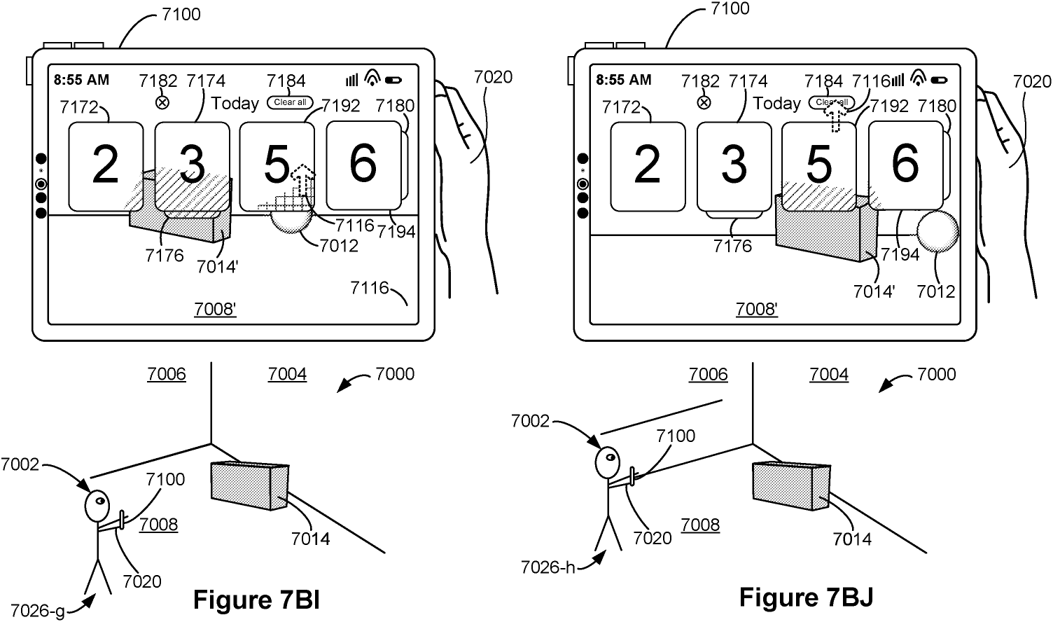

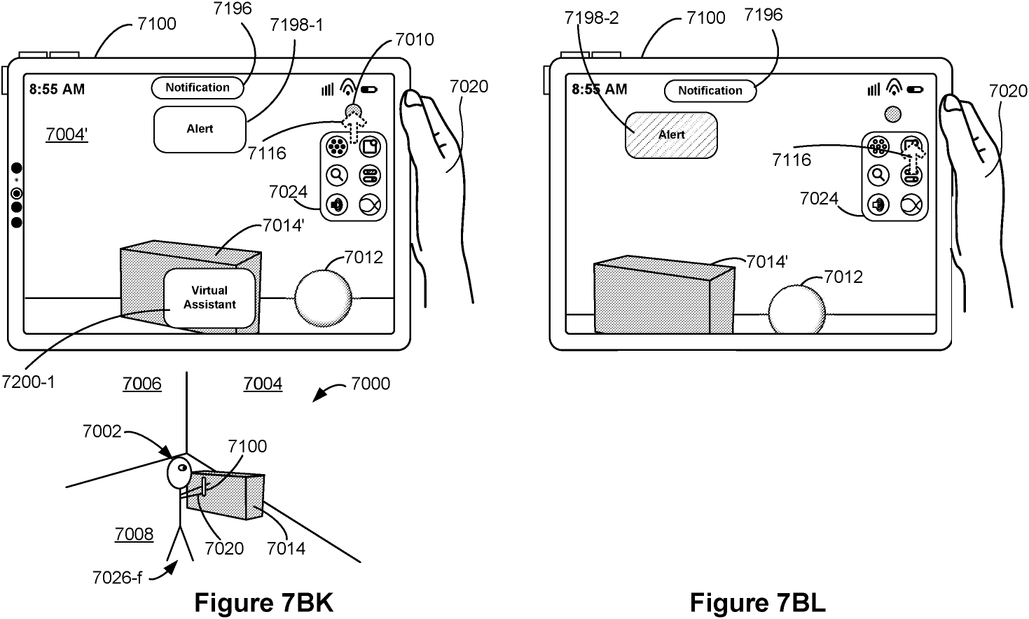

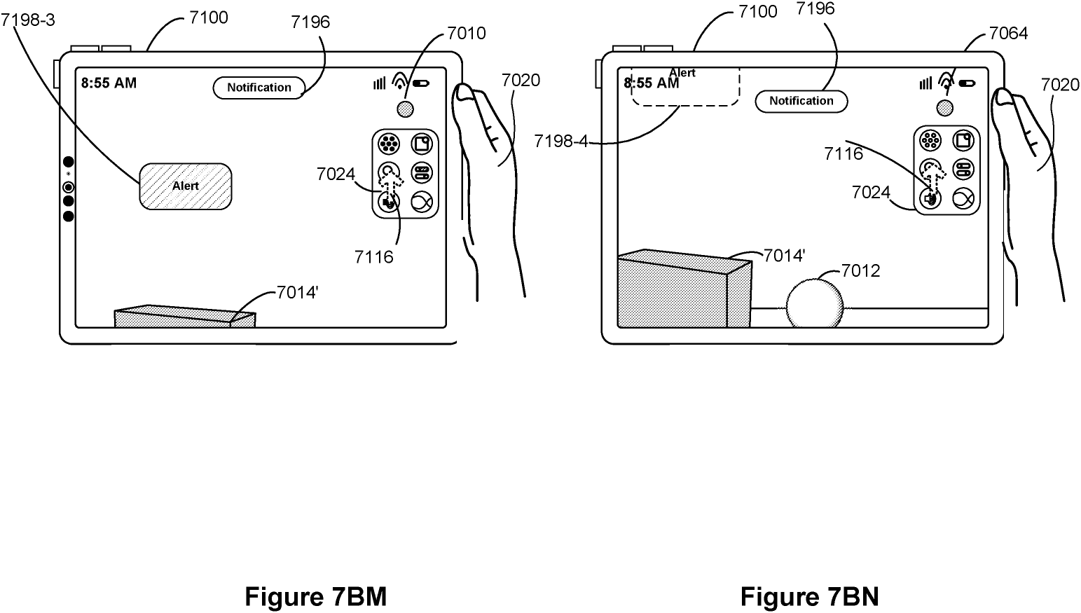

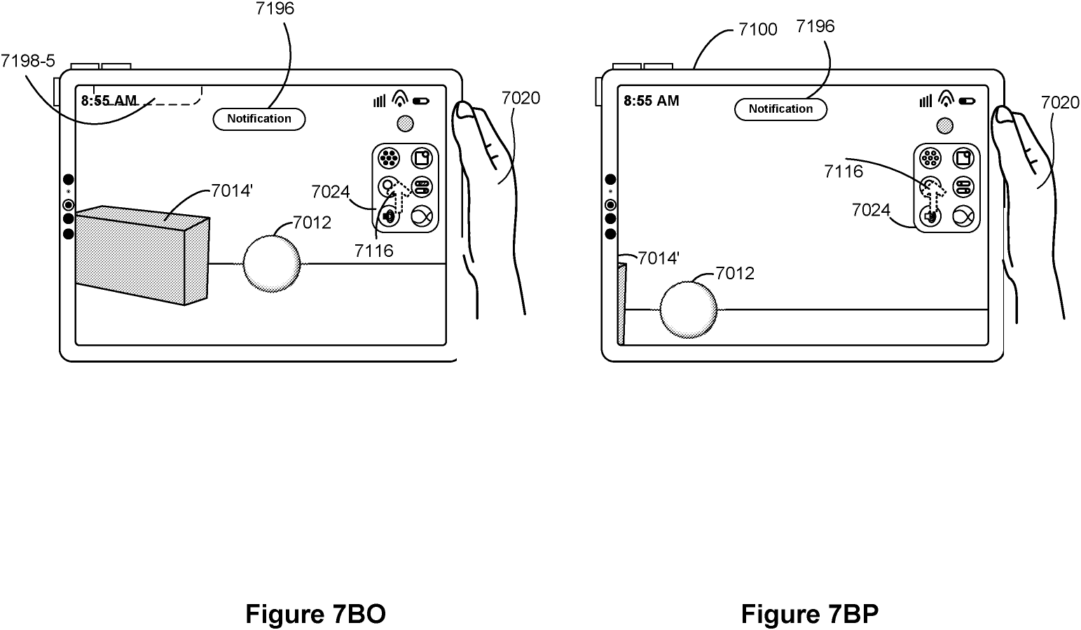

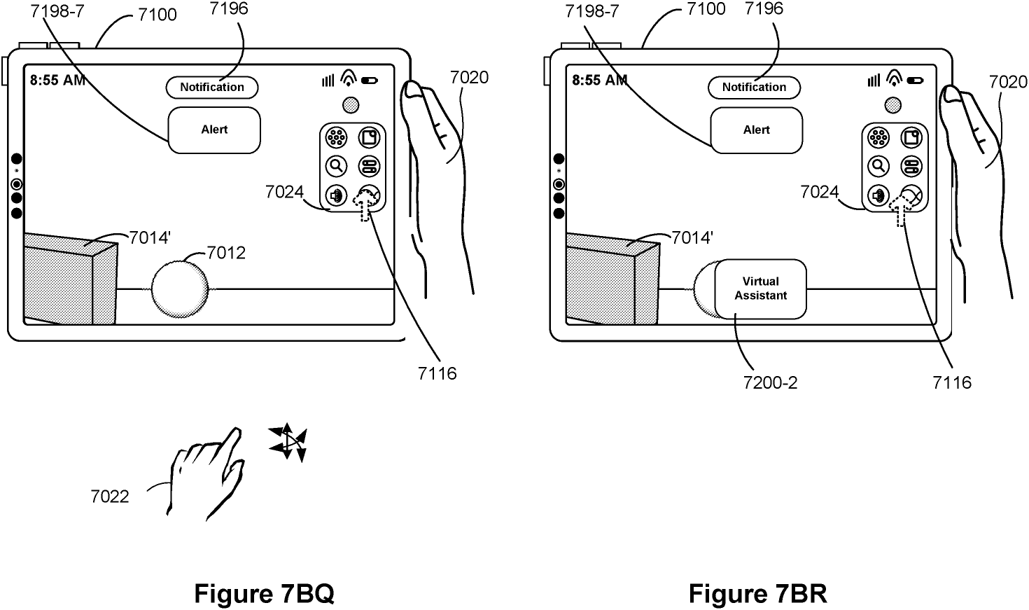

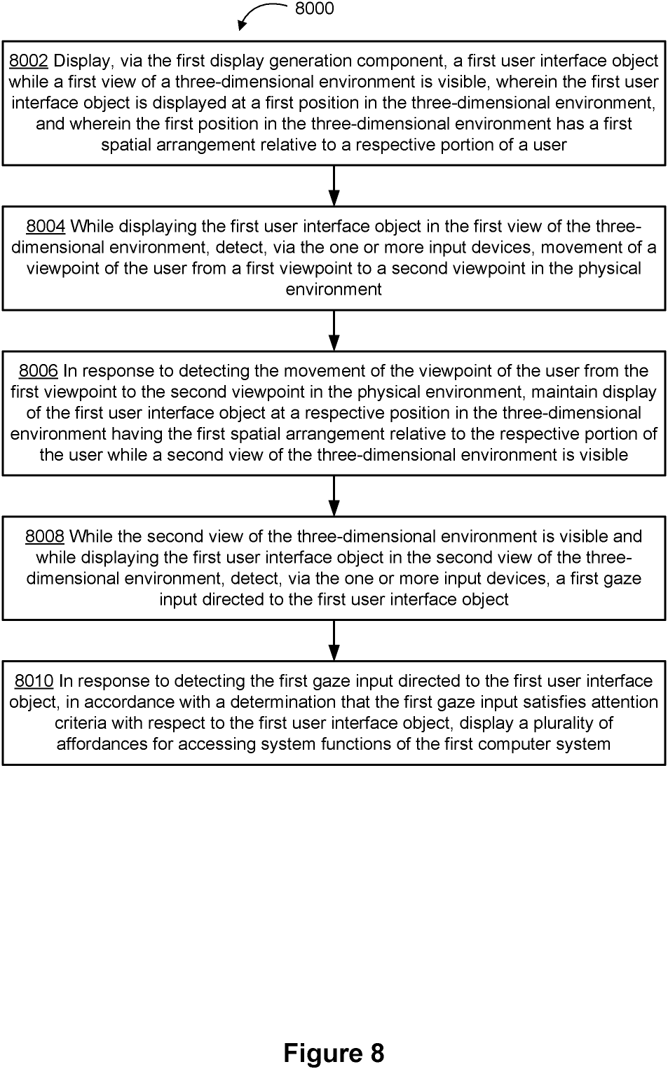

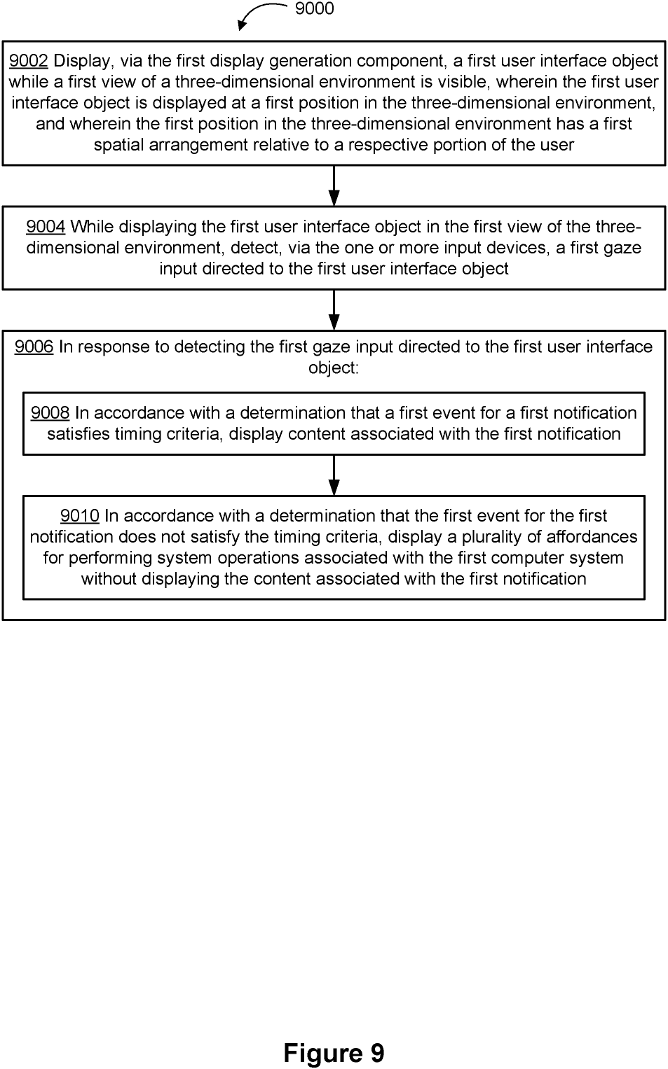

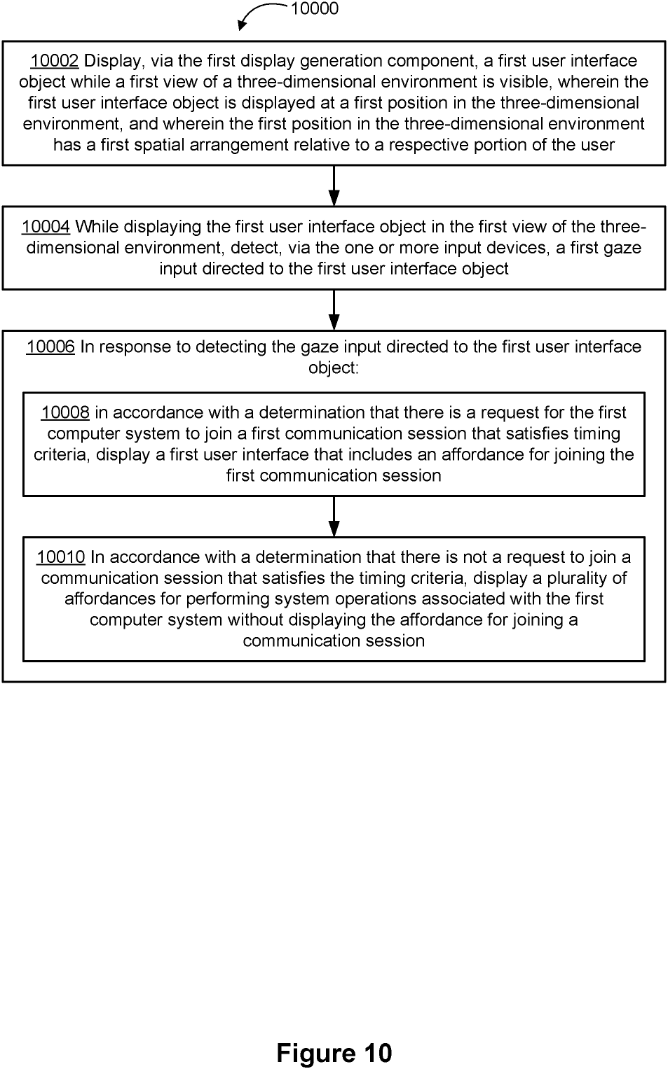

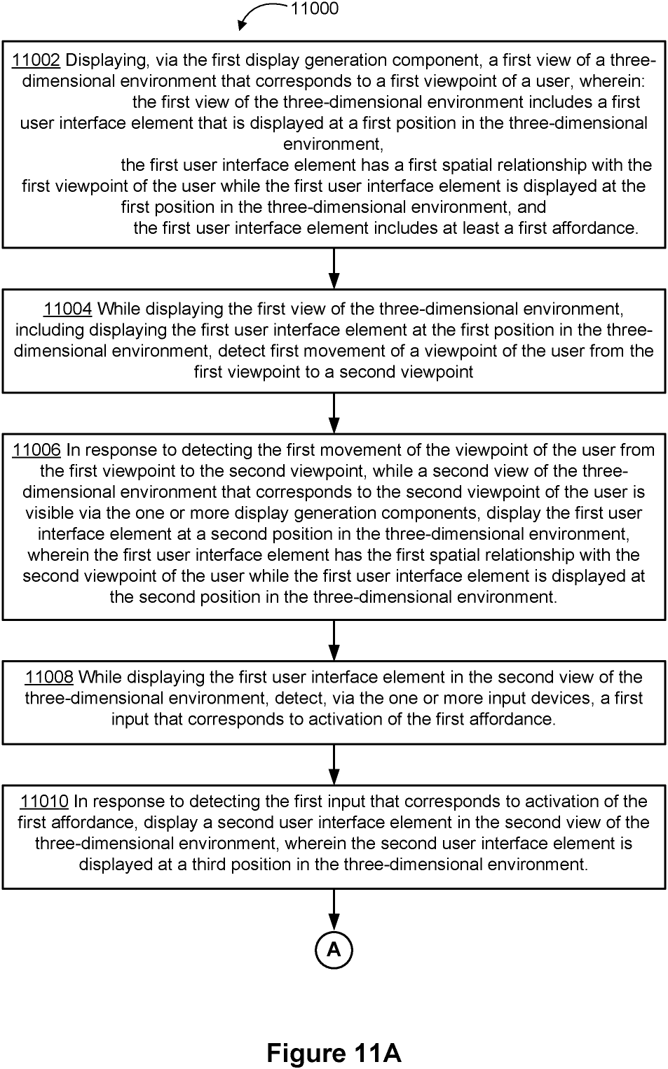

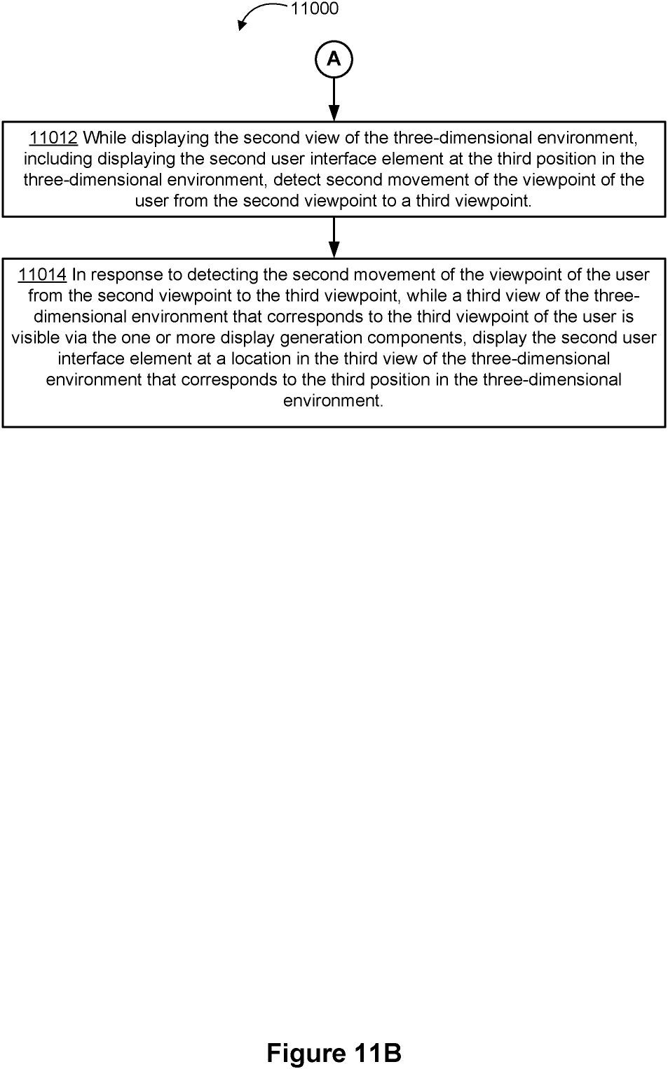

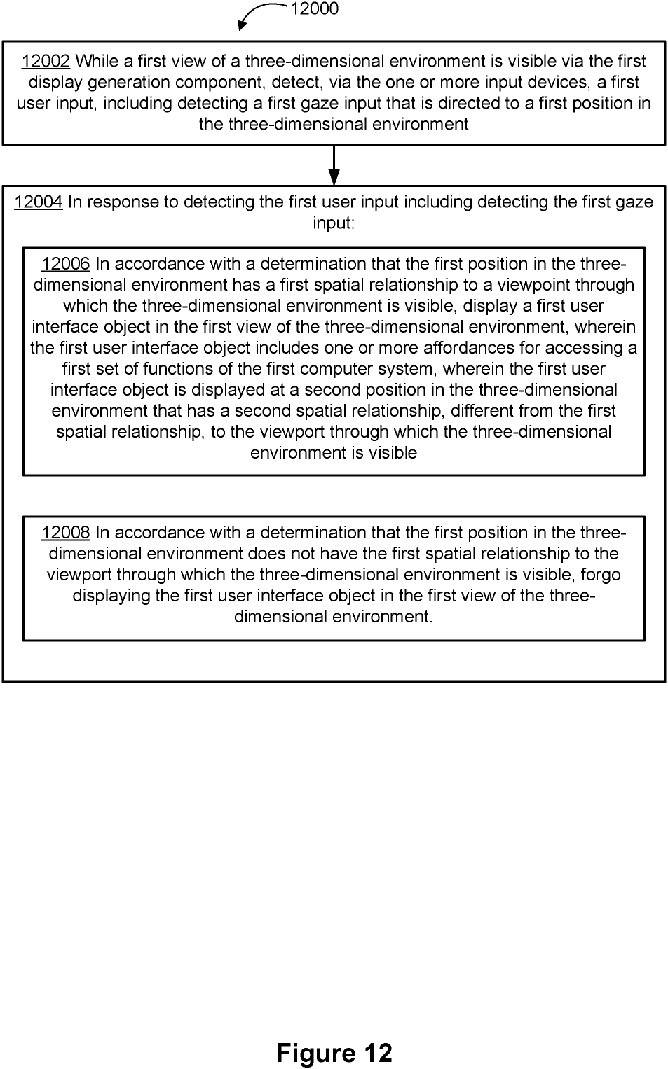

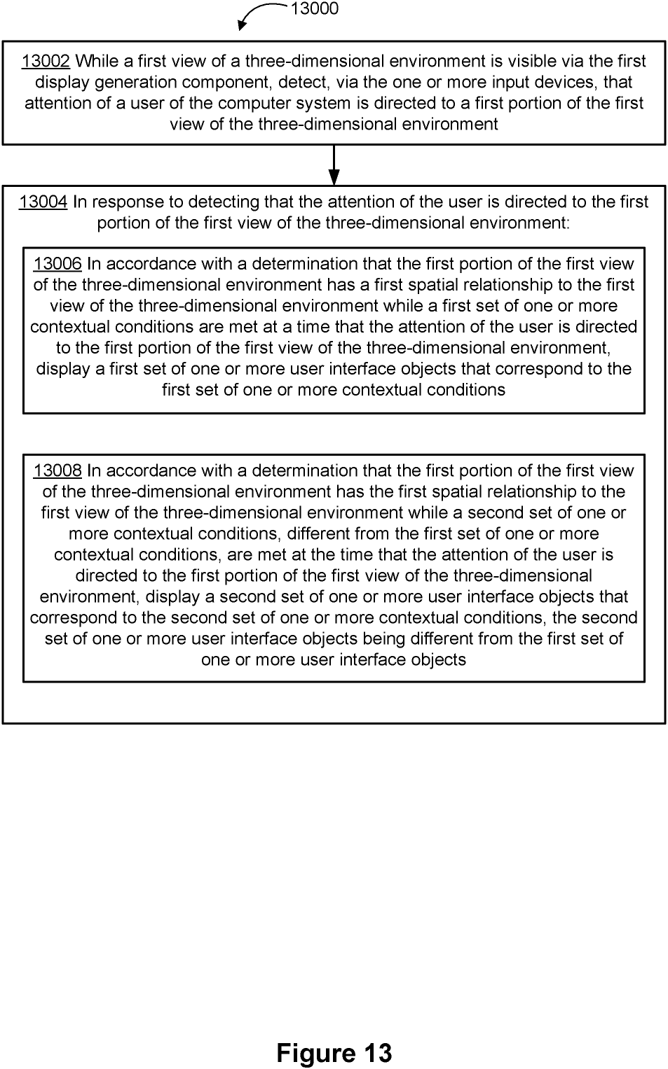

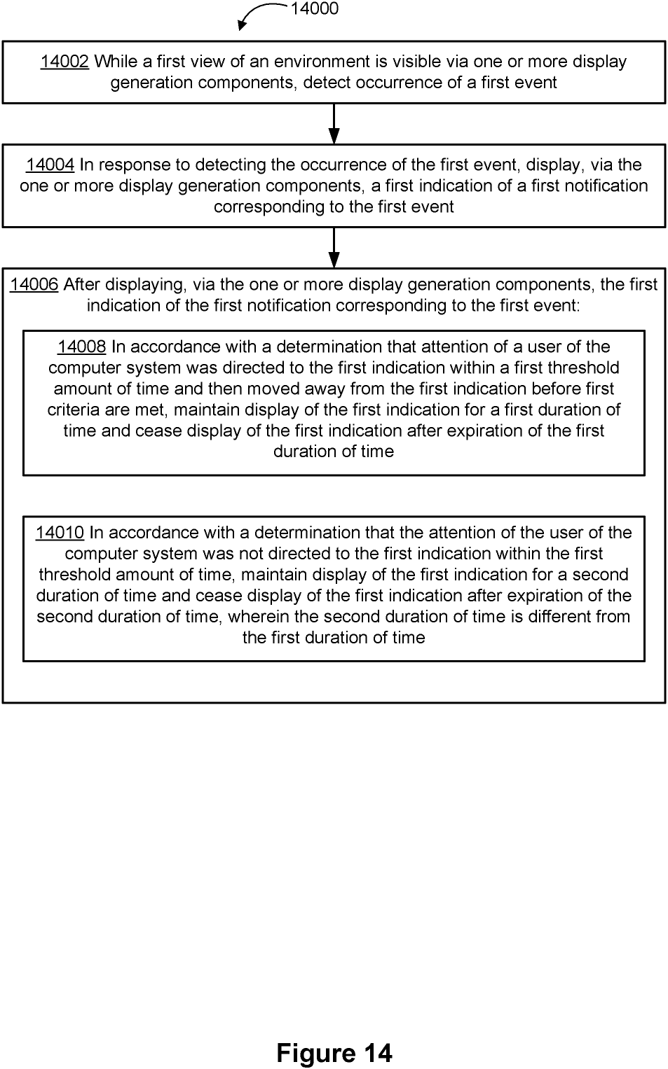

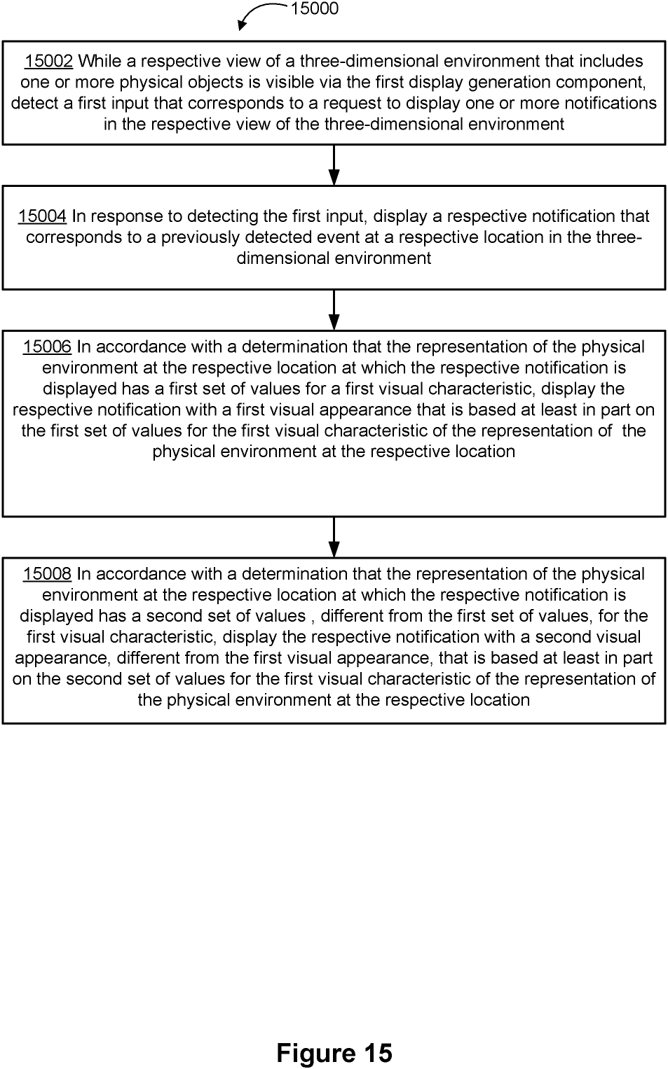

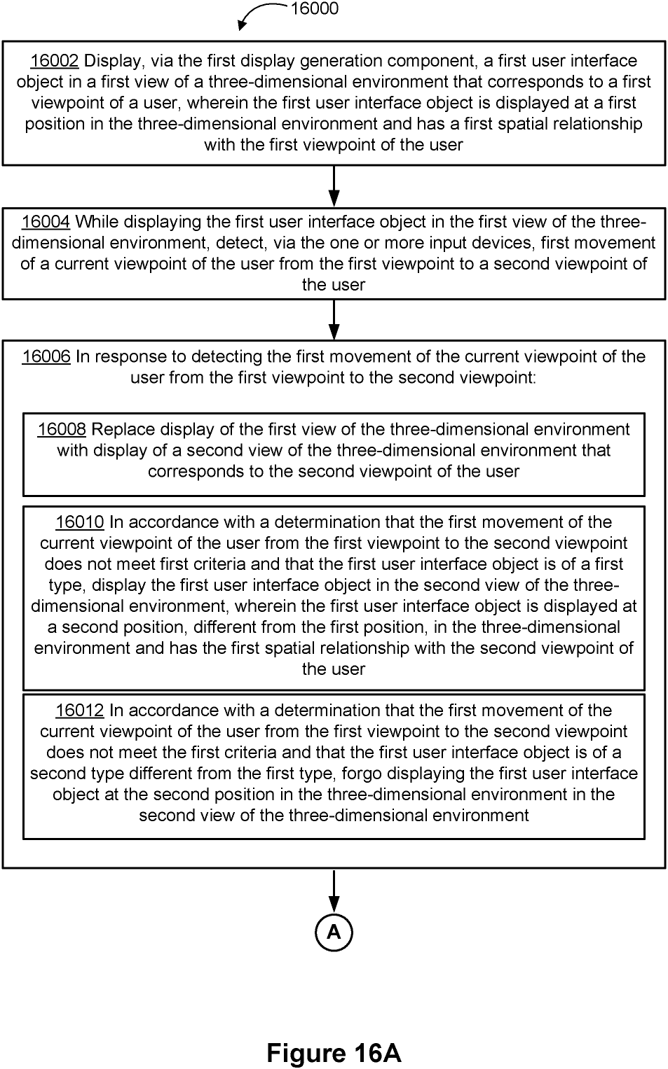

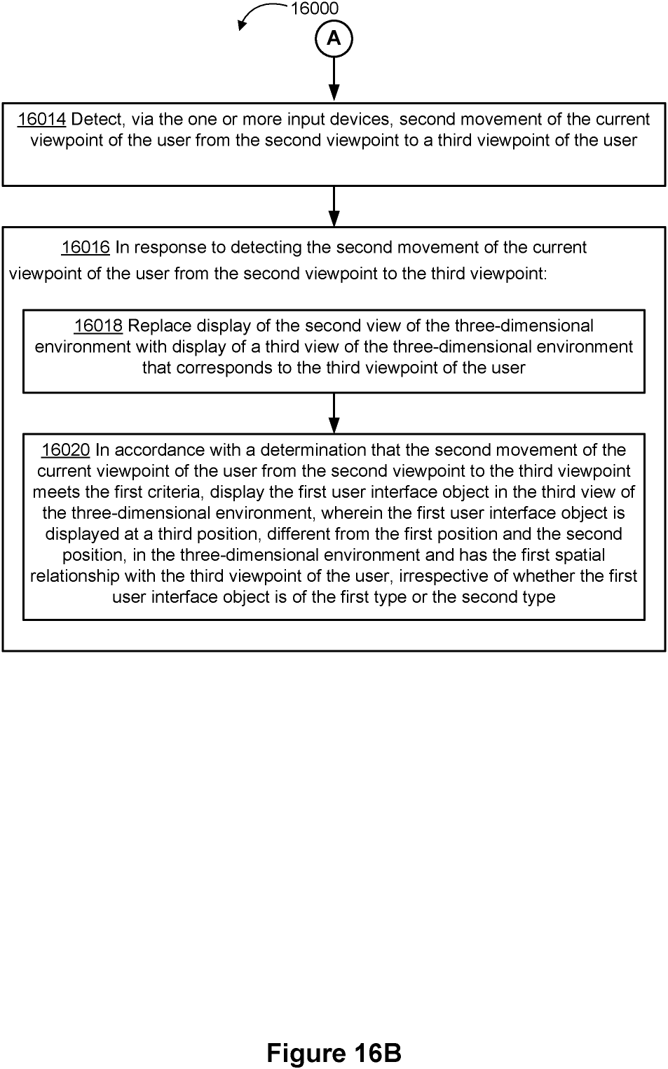

FIGS. 1-6 provide a description of example computer systems for providing XR experiences to users. FIGS. 7A-7K illustrate example techniques for displaying a plurality of affordances for accessing system functions of a first computer system, in response to detecting a first gaze input directed to a first user interface object, and in accordance with a determination that the first gaze input satisfies attention criteria with respect to the first user interface object, in accordance with some embodiments. FIGS. 7L-7Q illustrate example techniques for displaying content associated with a first notification, in response to detecting a first gaze input directed to a first user interface object, in accordance with a determination that a first event for the first notification satisfies timing criteria, in accordance with some embodiments. FIGS. 7R-7X illustrate example techniques for displaying a first user interface that includes an affordance for joining a communication session, in accordance with some embodiments. FIG. 7Y-7AF illustrate example techniques for initiating displaying of an environment-locked user interface from a head-locked user interface, in accordance with some embodiments. FIG. 7AG-7AM illustrate exemplary regions for triggering display of one or more user interface elements, in accordance with some embodiments. FIG. 7AN- 7AT illustrate exemplary contextual user interfaces that are displayed when different context criteria are met, in accordance with some embodiments. FIG. 7AU-7AZ illustrate exemplary methods for dismissing indications of notifications, in accordance with some embodiments. FIG. 7BA-7BJ illustrate exemplary methods for displaying and interacting with previously received notifications, in accordance with some embodiments. FIG. 7BK- 7BR illustrate example methods for moving, hiding, and redisplaying user interface objects in accordance with movement of the viewpoint of the user, in accordance with some embodiments. FIG. 8 is a flow diagram of methods of displaying a plurality of affordances for accessing system functions of a first computer system, in response to detecting a first gaze input directed to a first user interface object, and in accordance with a determination that the first gaze input satisfies attention criteria with respect to the first user interface object, in accordance with various embodiments. FIG. 9 is a flow diagram of methods of displaying content associated with a first notification, in response to detecting a first gaze input directed to a first user interface object, in accordance with a determination that a first event for the first notification satisfies timing criteria, in accordance with various embodiments. FIG. 10 is a flow diagram of methods of displaying a first user interface that includes an affordance for joining a communication session, in response to detecting a first gaze input directed to a first user interface object, and in accordance with a determination that there is a request for the first computer system to join a first communication session that satisfies timing criteria, in accordance with various embodiments. FIGS. 11A-11B are flow diagrams of methods of initiating display of an environment-locked user interface from a head-locked user interface, in accordance with various embodiments. FIG. 12 is a flow diagram of methods for initiating display of a user interface in response to detecting that a user’s attention is directed to a respective region of a three-dimensional environment, in accordance with various embodiments. FIG. 13 is a flow diagram of methods for displaying and interacting with contextual user interfaces, in accordance with some embodiments. FIG. 14 is a flow diagram of methods for dismissing indications of notifications, in accordance with various embodiments. FIG. 15 is a flow diagram of methods for displaying and interacting with previously received notifications in a notification history user interface, in accordance with various embodiments. FIGS. 16A-16B are flow diagrams of methods for moving, hiding, and redisplaying user interface objects in accordance with movement of the viewpoint of the user, in accordance with some embodiments. FIG. 7A-7BR are used to illustrate various aspects of the processes described with respect to FIGS. 8-16, in accordance with some embodiments.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing a XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person’s physical motions, or representations thereof, are tracked, and, in response, one or more characteristics of one or more virtual objects simulated in the XR environment are adjusted in a manner that comports with at least one law of physics. For example, a XR system may detect a person’s head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person’s presence within the computer-generated environment, and/or through a simulation of a subset of the person’s physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user’s head (e.g., the viewpoint of the user is at least a portion of the field-of-view of the user when the user is looking straight ahead); thus, the viewpoint of the user remains fixed even as the user’s gaze is shifted, without moving the user’s head. In embodiments where the computer system has a display generation component (e.g., a display screen) that can be repositioned with respect to the user’s head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user’s head facing north), continues to be displayed in the upper left corner of the viewpoint of the user, even as the viewpoint of the user changes to a second orientation (e.g., with the user’s head facing west). In other words, the location and/or position at which the viewpoint-locked virtual object is displayed in the viewpoint of the user is independent of the user’s position and/or orientation in the physical environment. In embodiments in which the computer system is a head-mounted device, the viewpoint of the user is locked to the orientation of the user’s head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user’s head is turned to the right) so that the tree is now left-of-center in the viewpoint of the user (e.g., the tree’s position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user’s hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movment of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintian a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

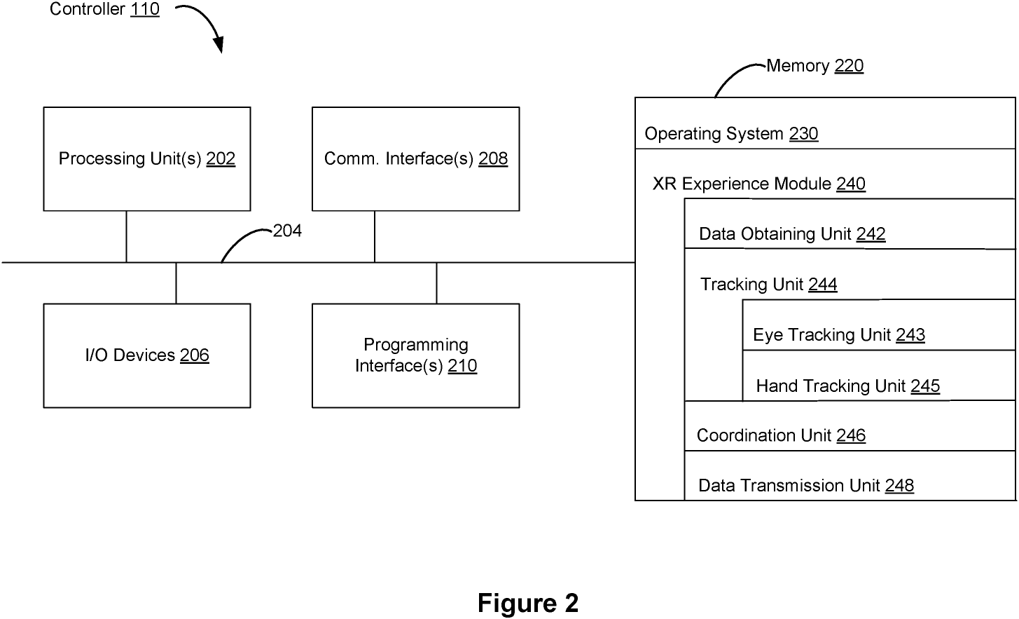

Hardware: There are many different types of electronic systems that enable a person to sense and/or interact with various XR environments. Examples include head-mounted systems, projection-based systems, heads-up displays, vehicle windshields having integrated display capability, windows having integrated display capability, displays formed as lenses designed to be placed on a person’s eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person’s eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person’s retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

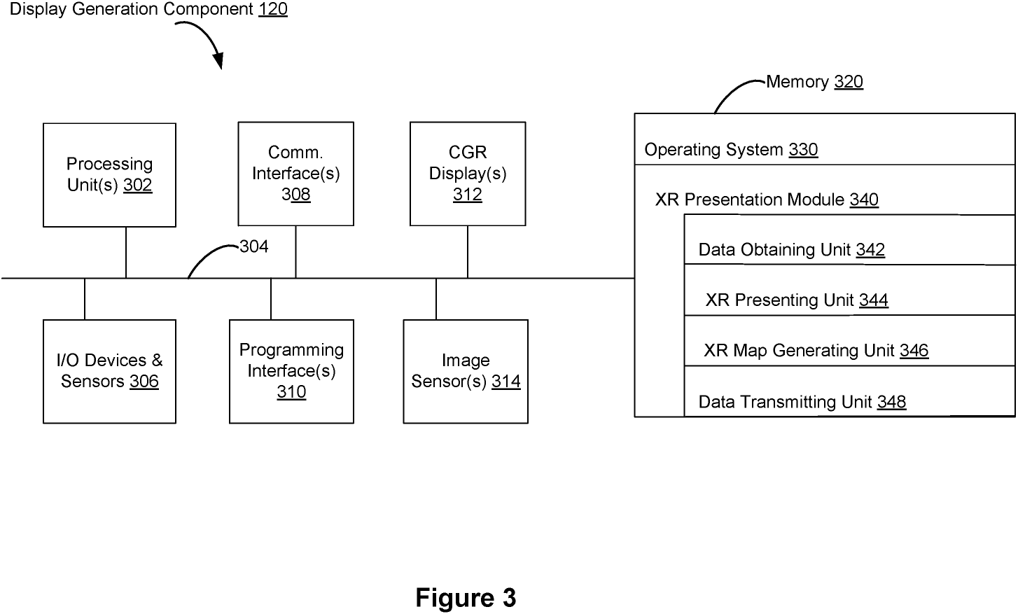

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides a XR experience to the user while the user is virtually and/or physically present within the scene 105.

In some embodiments, the display generation component is worn on a part of the user’s body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user’s body (e.g., the user’s eye(s), head, or hand)) could similarly be implemented with an HMD where the movement is caused by movement of the HMD relative to the physical environment (e.g., the scene 105 or a part of the user’s body (e.g., the user’s eye(s), head, or hand)).

While pertinent features of the operating environment 100 are shown in FIG. 1, those of ordinary skill in the art will appreciate from the present disclosure that various other features have not been illustrated for the sake of brevity and so as not to obscure more pertinent aspects of the example embodiments disclosed herein.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

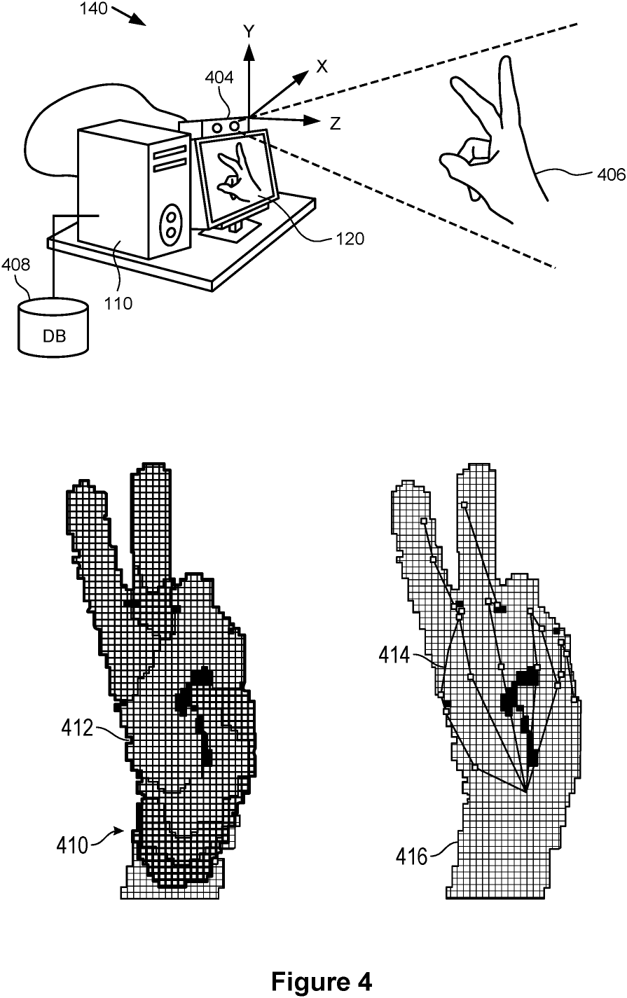

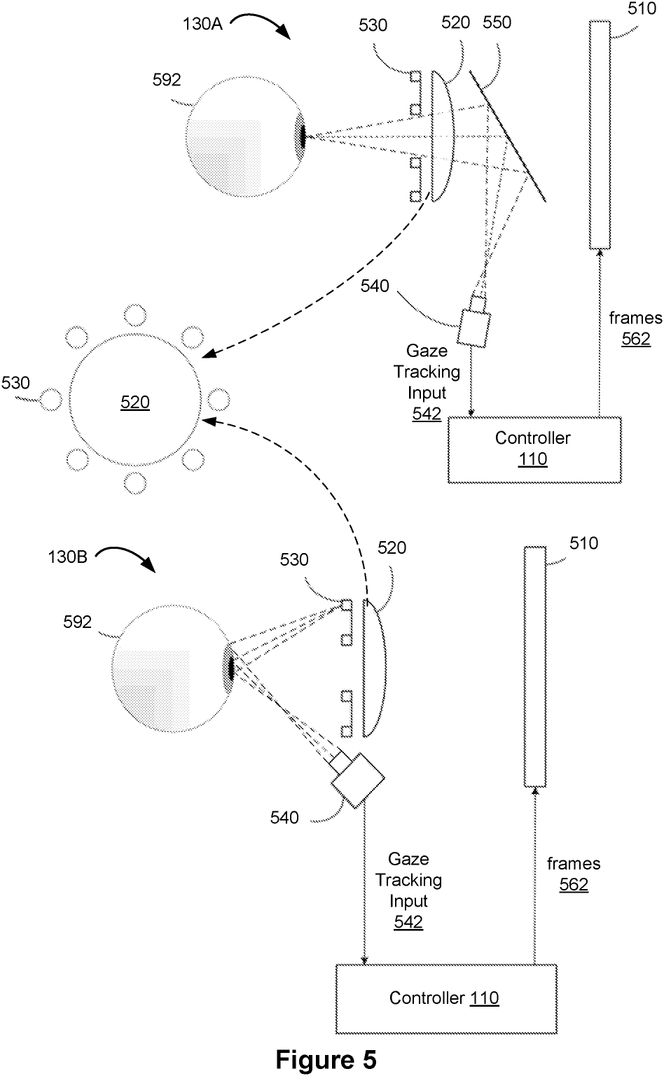

In some embodiments, the tracking unit 242 is configured to map the scene 105 and to track the position/location of at least the display generation component 120 with respect to the scene 105 of FIG. 1, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user’s hands, and/or motions of one or more portions of the user’s hands with respect to the scene 105 of FIG. 1, relative to the display generation component 120, and/or relative to a coordinate system defined relative to the user’s hand. The hand tracking unit 244 is described in greater detail below with respect to FIG. 4. In some embodiments, the eye tracking unit 243 is configured to track the position and movement of the user’s gaze (or more broadly, the user’s eyes, face, or head) with respect to the scene 105 (e.g., with respect to the physical environment and/or to the user (e.g., the user’s hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transistor (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user’s hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1) is controlled by hand tracking unit 244 (FIG. 2) to track the position/location of one or more portions of the user’s hands, and/or motions of one or more portions of the user’s hands with respect to the scene 105 of FIG. 1 (e.g., with respect to a portion of the physical environment surrounding the user, with respect to the display generation component 120, or with respect to a portion of the user (e.g., the user’s face, eyes, or head), and/or relative to a coordinate system defined relative to the user’s hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user’s body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user’s environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user’s hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user’s hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user’s hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user’s body through the air including motion of the user’s body relative to an absolute reference (e.g., an angle of the user’s arm relative to the ground or a distance of the user’s hand relative to the ground), relative to another portion of the user’s body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user’s body (e.g., a tap gesture that includes movement of a hand in a predetermined pose by a predetermined amount and/or speed, or a shake gesture that includes a predetermined speed or amount of rotation of a portion of the user’s body).

In some embodiments, input gestures used in the various examples and embodiments described herein include air gestures performed by movement of the user’s finger(s) relative to other finger(s) or part(s) of the user’s hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user’s body through the air including motion of the user’s body relative to an absolute reference (e.g., an angle of the user’s arm relative to the ground or a distance of the user’s hand relative to the ground), relative to another portion of the user’s body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user’s body (e.g., a tap gesture that includes movement of a hand in a predetermined pose by a predetermined amount and/or speed, or a shake gesture that includes a predetermined speed or amount of rotation of a portion of the user’s body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user’s attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user’s finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user’s hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user’s hand is not at the position that corresponds to the position of the user interface object in the three-dimensional environment while detecting the user’s attention (e.g., gaze) on the user interface object. For example, for direct input gesture, the user is enabled to direct the user’s input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user’s input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a respective time period) succession of each other. For example, the user performs a first pinch input (e.g., a pinch input or a long pinch input), releases the first pinch input (e.g., breaks contact between the two or more fingers), and performs a second pinch input within a respective time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user’s hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user’s second hand moves from the first position to the second position in the air while the user continues the pinch input with the user’s first hand. In some embodiments, an input gesture that is an air gesture includes inputs (e.g., pinch and/or tap inputs) performed using both of the user’s two hands. For example, the input gesture includes two (e.g., or more) pinch inputs performed in conjunction with (e.g., concurrently with, or within a respective time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user’s two hands). In some embodiments, movement between the user’s two hands (e.g., to increase and/or decrease a distance or relative orientation between the user’s two hands)

In some embodiments, a tap input (e.g., directed to a user interface element) performed as an air gesture includes movement of a user’s finger(s) toward the user interface element, movement of the user’s hand toward the user interface element optionally with the user’s finger(s) extended toward the user interface element, a downward motion of a user’s finger (e.g., mimicking a mouse click motion or a tap on a touchscreen), or other movement of the user’s hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user’s head and above the user’s waist and extended out from the body by at least 15, 20, 25, 30, or 50 cm), and/or based on whether the hand has moved in a particular manner (e.g., moved toward a region in front of the user above the user’s waist and below the user’s head or moved away from the user’s body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user, user inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user’s body, and/or relative to a physical environment of the user, and/or other hardware input device controls, wherein the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1). In some embodiments, the eye tracking device 130 is controlled by the eye tracking unit 243 (FIG. 2) to track the position and movement of the user’s gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user’s eyes to thus provide 3D virtual views to the user. For example, a head-mounted display generation component may include left and right optical lenses (referred to herein as eye lenses) located between the display and the user’s eyes. In some embodiments, the display generation component may include or be coupled to one or more external video cameras that capture video of the user’s environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user’s eyes. The eye tracking cameras may be pointed towards the user’s eyes to receive reflected IR or NIR light from the light sources directly from the eyes, or alternatively may be pointed towards “hot” mirrors located between the user’s eyes and the display panels that reflect IR or NIR light from the eyes to the eye tracking cameras while allowing visible light to pass. The eye tracking device 130 optionally captures images of the user’s eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device- specific calibration process may be an automated calibration process or a manual calibration process. A user-specific calibration process may include an estimation of a specific user’s eye parameters, for example the pupil location, fovea location, optical axis, visual axis, eye spacing, etc. Once the device-specific and user- specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user’s face for which eye tracking is performed, and an illumination source 530 (e.g., IR or NIR light sources such as an array or ring of NIR light-emitting diodes (LEDs)) that emit light (e.g., IR or NIR light) towards the user’s eye(s) 592. The eye tracking cameras 540 may be pointed towards mirrors 550 located between the user’s eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user’s eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user’s point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user’s current gaze direction, and is not intended to be limiting. As an example use case, the controller 110 may render virtual content differently based on the determined direction of the user’s gaze. For example, the controller 110 may generate virtual content at a higher resolution in a foveal region determined from the user’s current gaze direction than in peripheral regions. As another example, the controller may position or move virtual content in the view based at least in part on the user’s current gaze direction. As another example, the controller may display particular virtual content in the view based at least in part on the user’s current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user’s eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., light sources 530 (e.g., IR or NIR LEDs), mounted in a wearable housing. The light sources emit light (e.g., IR or NIR light) towards the user’s eye(s) 592. In some embodiments, the light sources may be arranged in rings or circles around each of the lenses as shown in FIG. 5. In some embodiments, eight light sources 530 (e.g., LEDs) are arranged around each lens 520 as an example. However, more or fewer light sources 530 may be used, and other arrangements and locations of light sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user’s face. In some embodiments, two or more NIR cameras 540 may be used on each side of the user’s face. In some embodiments, a camera 540 with a wider field of view (FOV) and a camera 540 with a narrower FOV may be used on each side of the user’s face. In some embodiments, a camera 540 that operates at one wavelength (e.g., 850 nm) and a camera 540 that operates at a different wavelength (e.g., 940 nm) may be used on each side of the user’s face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

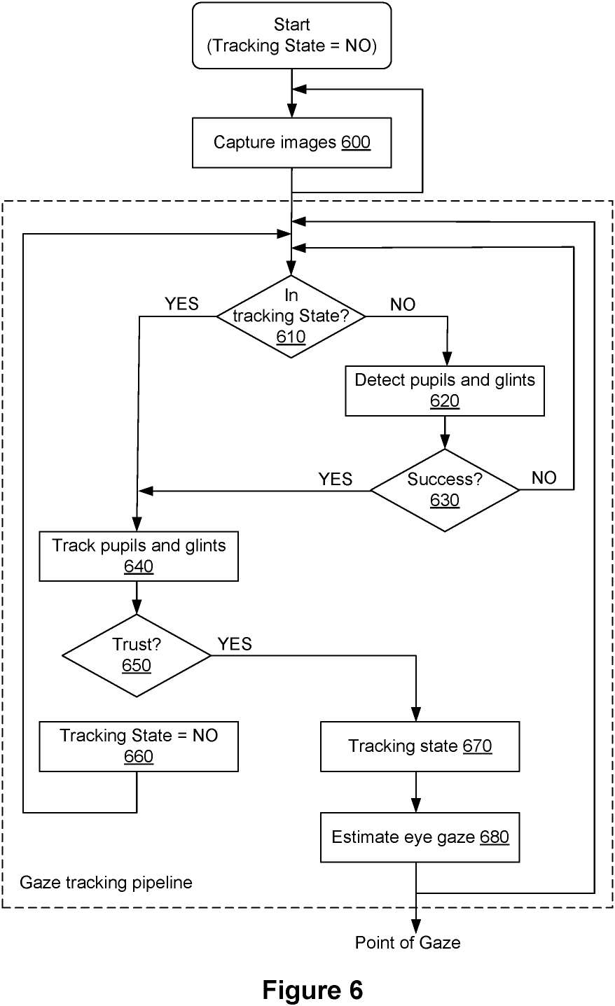

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1 and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user’s left and right eyes. The captured images are then input to a gaze tracking pipeline for processing beginning at 610. As indicated by the arrow returning to element 600, the gaze tracking system may continue to capture images of the user’s eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user’s pupils and glints in the images. At 630, if the pupils and glints are successfully detected, then the method proceeds to element 640. Otherwise, the method returns to element 610 to process next images of the user’s eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user’s eyes. At 650, if the results are trusted, then the method proceeds to element 670. At 670, the tracking state is set to YES (if not already YES), and the pupil and glint information is passed to element 680 to estimate the user’s point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### USER INTERFACES AND ASSOCIATED PROCESSES

Attention is now directed towards embodiments of user interfaces (“UI”) and associated processes that may be implemented on a computer system, such as a portable multifunction device or a head-mounted device, in communication with a display generation component, one or more input devices, and optionally one or cameras.

FIG. 7A-7AF include illustrations of three-dimensional environments that are visible via a display generation component (e.g., a display generation component 120) and interactions that occur in the three-dimensional environments caused by user inputs directed to the three-dimensional environments and/or inputs received from other computer systems and/or sensors. In some embodiments, the portion of the three-dimensional environment that is visible to the user via the display generation component is referred to as a viewport (e.g., a virtual viewport that corresponds to a portion of the three-dimensional environment that is visible to a user of the device when viewing the three-dimensional environment via a display generation component). In some embodiments, an input is directed to a virtual object within a three-dimensional environment by a user’s gaze detected in the region occupied by the virtual object, or by a hand gesture performed at a location in the physical environment that corresponds to the region of the virtual object. In some embodiments, an input is directed to a virtual object within a three-dimensional environment by a hand gesture that is performed (e.g., optionally, at a location in the physical environment that is independent of the region of the virtual object in the three-dimensional environment) while the virtual object has input focus (e.g., while the virtual object has been selected by a concurrently and/or previously detected gaze input, selected by a concurrently or previously detected pointer input, and/or selected by a concurrently and/or previously detected gesture input). In some embodiments, an input is directed to a virtual object within a three-dimensional environment by an input device that has positioned a focus selector object (e.g., a pointer object or selector object) at the position of the virtual object. In some embodiments, an input is directed to a virtual object within a three-dimensional environment via other means (e.g., voice and/or control button). In some embodiments, an input is directed to a representation of a physical object or a virtual object that corresponds to a physical object by the user’s hand movement (e.g., whole hand movement, whole hand movement in a respective posture, movement of one portion of the user’s hand relative to another portion of the hand, and/or relative movement between two hands) and/or manipulation with respect to the physical object (e.g., touching, swiping, tapping, opening, moving toward, and/or moving relative to). In some embodiments, the computer system displays some changes in the three-dimensional environment (e.g., displaying additional virtual content, ceasing to display existing virtual content, and/or transitioning between different levels of immersion with which visual content is being displayed) in accordance with inputs from sensors (e.g., image sensors, temperature sensors, biometric sensors, motion sensors, and/or proximity sensors) and contextual conditions (e.g., location, time, and/or presence of others in the environment). In some embodiments, the computer system displays some changes in the three-dimensional environment (e.g., displaying additional virtual content, ceasing to display existing virtual content, and/or transitioning between different levels of immersion with which visual content is being displayed) in accordance with inputs from other computers used by other users that are sharing the computer-generated environment with the user of the computer system (e.g., in a shared computer-generated experience, in a shared virtual environment, and/or in a shared virtual or augmented reality environment of a communication session). In some embodiments, the computer system displays some changes in the three-dimensional environment (e.g., displaying movement, deformation, and/or changes in visual characteristics of a user interface, a virtual surface, a user interface object, and/or virtual scenery) in accordance with inputs from sensors that detect movement of other persons and objects and movement of the user that may not quality as a recognized gesture input for triggering an associated operation of the computer system.

In some embodiments, a three-dimensional environment that is visible via a viewport provided by a display generation component described herein is a virtual three-dimensional environment that includes virtual objects and content at different virtual positions in the three-dimensional environment without a representation of the physical environment. In some embodiments, the three-dimensional environment is a mixed reality environment that displays virtual objects at different virtual positions in the three-dimensional environment that are constrained by one or more physical aspects of the physical environment (e.g., positions and orientations of walls, floors, surfaces, direction of gravity, time of day, and/or spatial relationships between physical objects). In some embodiments, the three-dimensional environment is an augmented reality environment that includes a representation of the physical environment. In some embodiments, the representation of the physical environment includes respective representations of physical objects and surfaces at different positions in the three-dimensional environment, such that the spatial relationships between the different physical objects and surfaces in the physical environment are reflected by the spatial relationships between the representations of the physical objects and surfaces in the three-dimensional environment. In some embodiments, when virtual objects are placed relative to the positions of the representations of physical objects and surfaces in the three-dimensional environment, they appear to have corresponding spatial relationships with the physical objects and surfaces in the physical environment. In some embodiments, the computer system transitions between displaying the different types of environment (e.g., transitions between presenting a computer-generated environment or experience with different levels of immersion, and/or adjusting the relative prominence of audio/visual sensory inputs from the virtual content and from the representation of the physical environment) based on user inputs and/or contextual conditions.

In some embodiments, the display generation component includes a pass-through portion in which the representation of the physical environment is displayed. In some embodiments, the pass-through portion of the display generation component is a transparent or semi-transparent (e.g., see-through) portion of the display generation component revealing at least a portion of physical environment surrounding and within the field of view of a user. For example, the pass-through portion is a portion of a head-mounted display or heads-up display that is made semi-transparent (e.g., less than 50%, 40%, 30%, 20%, 15%, 10%, or 5% of opacity) or transparent, such that the user can see through it to view the real world surrounding the user without removing the head-mounted display or moving away from the heads-up display. In some embodiments, the pass-through portion gradually transitions from semi-transparent or transparent to fully opaque when displaying a virtual or mixed reality environment. In some embodiments, the pass-through portion of the display generation component displays a live feed of images or video of at least a portion of physical environment captured by one or more cameras (e.g., rear facing camera(s) of a mobile device or associated with a head-mounted display, or other cameras that feed image data to the computer system). In some embodiments, the one or more cameras point at a portion of the physical environment that is directly in front of the user’s eyes (e.g., behind the display generation component relative to the user of the display generation component). In some embodiments, the one or more cameras point at a portion of the physical environment that is not directly in front of the user’s eyes (e.g., in a different physical environment, or to the side or behind the user).

In some embodiments, when displaying virtual objects at positions that correspond to locations of one or more physical objects in the physical environment (e.g., at positions in a virtual reality environment, a mixed reality environment, or an augmented reality environment), at least some of the virtual objects are displayed in place of (e.g., replacing display of) a portion of the live view (e.g., a portion of the physical environment captured in the live view) of the cameras. In some embodiments, at least some of the virtual objects and content are projected onto physical surfaces or empty space in the physical environment and are visible through the pass-through portion of the display generation component (e.g., viewable as part of the camera view of the physical environment or through the transparent or semi-transparent portion of the display generation component). In some embodiments, at least some of the virtual objects and virtual content are displayed to overlay a portion of the display and blocks the view of at least a portion of the physical environment visible through the transparent or semi-transparent portion of the display generation component.

In some embodiments, the display generation component displays different views of the three-dimensional environment in accordance with user inputs or movements that change the virtual position of the viewpoint of the currently displayed view of the three-dimensional environment relative to the three-dimensional environment. In some embodiments, when the three-dimensional environment is a virtual environment, the viewpoint moves in accordance with navigation or locomotion requests (e.g., in-air hand gestures, and/or gestures performed by movement of one portion of the hand relative to another portion of the hand) without requiring movement of the user’s head, torso, and/or the display generation component in the physical environment. In some embodiments, movement of the user’s head and/or torso, and/or the movement of the display generation component or other location sensing elements of the computer system (e.g., due to the user holding the display generation component or wearing the HMD), relative to the physical environment cause corresponding movement of the viewpoint (e.g., with corresponding movement direction, movement distance, movement speed, and/or change in orientation) relative to the three-dimensional environment, resulting in corresponding change in the currently displayed view of the three-dimensional environment. In some embodiments, when a virtual object has a respective spatial relationship relative to the viewpoint (e.g., is anchored or fixed to the viewpoint, and/or maintains its spatial relationship to the viewport through which the three-dimensional environment is visible), movement of the viewpoint relative to the three-dimensional environment would cause movement of the virtual object relative to the three-dimensional environment while the position of the virtual object in the field of view and/or viewport is maintained (e.g., the virtual object is said to be head locked). In some embodiments, a virtual object is body-locked to the user, and moves relative to the three-dimensional environment when the user moves as a whole in the physical environment (e.g., carrying or wearing the display generation component and/or other location sensing component of the computer system), but will not move in the three-dimensional environment in response to the user’s head movement alone (e.g., the display generation component and/or other location sensing component of the computer system rotating around a fixed location of the user in the physical environment). In some embodiments, a virtual object is, optionally, locked to another portion of the user, such as a user’s hand or a user’s wrist, and moves in the three-dimensional environment in accordance with movement of the portion of the user in the physical environment, to maintain a spatial relationship between the position of the virtual object and the virtual position of the portion of the user in the three-dimensional environment. In some embodiments, a virtual object is locked to a portion of a field of view provided by the display generation component (e.g., has a fixed spatial relationship to a viewport through which the three-dimensional environment is visible, and/or has a fixed spatial relationship to the viewpoint of the user), and moves in the three-dimensional environment in accordance with the movement of the field of view inside the viewport, irrespective of movement of the user that does not cause a change of the field of view inside the viewport.

In some embodiments, as shown in FIGS. 7A-7X, the views of a three-dimensional environment sometimes do not include representation(s) of a user’s hand(s), arm(s), and/or wrist(s). In some embodiments, the representation(s) of a user’s hand(s), arm(s), and/or wrist(s) are included in the views of a three-dimensional environment. In some embodiments, the representation(s) of a user’s hand(s), arm(s), and/or wrist(s) are included in the views of a three-dimensional environment as part of the representation of the physical environment provided via the display generation component. In some embodiments, the representations are not part of the representation of the physical environment and are separately captured (e.g., by one or more cameras pointing toward the user’s hand(s), arm(s), and wrist(s)) and displayed in the three-dimensional environment independent of the currently displayed view of the three-dimensional environment. In some embodiments, the representation(s) include camera images as captured by one or more cameras of the computer system(s), or stylized versions of the arm(s), wrist(s) and/or hand(s) based on information captured by various sensors). In some embodiments, the representation(s) replace display of, are overlaid on, or block the view of, a portion of the representation of the physical environment. In some embodiments, when the display generation component does not provide a view of a physical environment, and provides a completely virtual environment (e.g., no camera view and no transparent portion), real-time visual representations (e.g., stylize representations or segmented camera images) of one or both arms, wrists, and/or hands of the user are, optionally, still displayed in the virtual environment. In some embodiments, if a representation of the user’s hand is not provided in the view of the three-dimensional environment, the position that corresponds to the user’s hand is optionally indicated in the three-dimensional environment, e.g., by the changing appearance of the virtual content (e.g., through a change in translucency and/or simulated reflective index) at positions in the three-dimensional environment that correspond to the location of the user’s hand in the physical environment. In some embodiments, the representation of the user’s hand or wrist is outside of the currently displayed view of the three-dimensional environment while the virtual position in the three-dimensional environment that corresponds to the location of the user’s hand or wrist is outside of the current field of view provided via the display generation component; and the representation of the user’s hand or wrist is made visible in the view of the three-dimensional environment in response to the virtual position that corresponds to the location of the user’s hand or wrist being moved within the current field of view due to movement of the display generation component, the user’s hand or wrist, the user’s head, and/or the user as a whole.

FIGS. 7A-7K illustrate examples of displaying a plurality of affordances for accessing system functions of a computer system in response to detecting a first gaze input, directed to a first user interface object, that satisfies attention criteria with respect to the first user interface object. FIG. 8 is a flow diagram of an exemplary method 8000 for displaying the plurality of affordances for accessing system functions of the computer system in response to detecting the first gaze input, directed to the user interface object, that satisfies the attention criteria with respect to the first user interface object. The user interfaces in FIGS. 7A-7K are used to illustrate the processes described below, including the processes in FIG. 8.

FIG. 7A illustrates a physical environment 7000 that includes a user 7002 interacting with a computer system 7100. The user 7002 has two hands, hand 7020 and hand 7022. Also shown is the user’s left arm 7028, which is connected to the user’s left hand 7020. The physical environment 7000 includes a physical object 7014, and physical walls 7004 and 7006. The physical environment 7000 further includes a physical floor 7008. As shown in the examples in FIGS. 7A-7X, the display generation component of computer system 7100 is a touch screen held by user 7002. In some embodiments, the display generation component of computer system 7100 is a head-mounted display worn on user 7002′s head (e.g., what is shown in FIGS. 7A-7X as being visible via the display generation component of computer system 7100 corresponds to the user 7002′s field of view when wearing a head-mounted display). In some embodiments, the display generation component is a standalone display, a projector, or another type of display. In some embodiments, the computer system is in communication with one or more input devices, including cameras or other sensors and input devices that detect movement of the user’s hand(s), movement of the user’s body as whole, and/or movement of the user’s head in the physical environment. In some embodiments, the one or more input devices detect the movement and the current postures, orientations, and positions of the user’s hand(s), face, and/or body as a whole. In some embodiments, user inputs are detected via a touch-sensitive surface or touchscreen. In some embodiments, the one or more input devices include an eye tracking component that detects location and movement of the user’s gaze. In some embodiments, the display generation component, and optionally, the one or more input devices and the computer system, are parts of a head-mounted device that moves and rotates with the user’s head in the physical environment, and changes the viewpoint of the user in the three-dimensional environment provided via the display generation component. In some embodiments, the display generation component is a heads-up display that does not move or rotate with the user’s head or the user’s body as a whole, but, optionally, changes the viewpoint of the user in the three-dimensional environment in accordance with the movement of the user’s head or body relative to the display generation component. In some embodiments, the display generation component is optionally moved and rotated by the user’s hand relative to the physical environment or relative to the user’s head, and changes the viewpoint of the user in the three-dimensional environment in accordance with the movement of the display generation component relative to the user’s head or face or relative to the physical environment.

FIG. 7B illustrates a first view of a three-dimensional environment visible to user 7002 via the computer system 7100 (e.g., a virtual three-dimensional environment, an augmented reality environment, a pass-through view of a physical environment, or a camera view of a physical environment), which includes an indicator 7010 of system function menu. For example, the indicator 7010 is a dot, a graphical object, or other type of indications of a reactive region for trigging display of the system function menu that includes affordances corresponding to one or more system functions, in accordance with some embodiments. The view of the three-dimensional environment shown in FIG. 7B is visible to user 7002 via computer system 7100 in accordance with user 7002 being at location 7026-a in physical environment 7000. In some embodiments, the three-dimensional environment is a virtual three-dimensional environment without a representation of a physical environment 7000. In some embodiments, the three-dimensional environment is a mixed reality environment that is a virtual environment that is augmented by sensor data corresponding to the physical environment. In some embodiments, the three-dimensional environment is an augmented reality environment that includes one or more virtual objects and a representation of at least a portion of a physical environment (e.g., representations 7004′, 7006′ of walls, representation 7008′ of a floor, and/or representation 7014′ of a physical object). In some embodiments, the representation of the physical environment includes a camera view of the physical environment. In some embodiments, the representation of the physical environment includes a view of the physical environment through a transparent or semitransparent portion of the computer system or of the first display generation component.

In some embodiments, the indicator 7010 of system function menu is displayed in a periphery region (e.g., within a threshold distance (e.g., 0.5 mm, 1 cm, 2 cm, 5 cm, or any threshold distance between 0 and 5 cm) of an edge) of a viewport provided by the first display generation component through which the three-dimensional environment is visible (e.g., relative to a field of view of a user using the first display generation component). As shown in FIG. 7B, the indicator 7010 of system function menu is displayed is a periphery region of a top edge of the display of the computer system 7100. In embodiments where the display generation component of computer system 7100 is a head-mounted display, the indicator 7010 of system function menu would be displayed in a peripheral region of a field of view of the user’s eyes while looking at the three-dimensional environment via the display generation component. In some embodiments, the indicator 7010 of system function menu has a default appearance (e.g., a grey indicator of system function menu). In some embodiments, the appearance of the indicator 7010 of system function menu changes depending on one or more sets of criteria (e.g., in accordance with a determination that a first event for a first notification satisfies timing criteria, the indicator 7010 of system function menu has a first appearance (e.g., as described in further detail below, with reference to FIGS. 7L-7Q), and/or in accordance with a determination that there is a request for the computer system to join a first communication session that satisfies timing criteria, the indicator 7010 of system function menu has a second appearance (e.g., as described in further detail below, with reference to FIGS. 7R-7X). In some embodiments, the indicator 7010 of system function menu is translucent, or otherwise has an appearance that is based at least in part on a portion of the three-dimensional environment (e.g., based on representations of the surrounding physical environment (e.g., real-world content) and/or on computer-generated virtual content) over which the indicator 7010 of system function menu is displayed. In FIG. 7B, for example, indicator 7010 of system function menu has an appearance that is based on the appearance of wall 7004′ (e.g., which is “underlying” or “behind” indicator 7010 of system function menu in the three-dimensional environment).

In some embodiments, the indicator 7010 of system function menu continues to be displayed, even if the user interacts with other user interfaces, user interface objects, and/or user interface elements in the three-dimensional environment. For example, the indicator 7010 of system function menu continues to be displayed even if the user’s attention is directed at a virtual object 7012. The user can interact with or manipulate the virtual object 7012 (e.g., with the user’s gaze, air gestures, and/or verbal inputs), and the computer system 7100 will continue to display the indicator 7010 of system function menu. In some embodiments, the indicator 7010 of system function menu is visually deemphasized (e.g., dimmed and/or blurred) when the user interacts with other user interfaces, user interface objects, and/or user interface elements (e.g., to avoid distracting the user while the user’s attention (e.g., gaze) is directed to other user interface elements).

In some embodiments, the indicator 7010 of system function menu is displayed while a user’s attention satisfies proximity criteria with respect to the indicator 7010 of system function menu, and the indicator 7010 of system function menu ceases to be displayed in response to detecting that a user’s attention does not satisfy the proximity criteria with respect to the indicator 7010 of system function menu. For example, if the user’s attention moves to the center of the display generation component of the computer system 7100, the computer system 7100 ceases to display the indicator 7010 of system function menu. In some embodiments, after ceasing to display the indicator 7010 of system function menu, the indicator 7010 of system function menu is redisplayed in response to the user’s attention again satisfying the proximity criteria (e.g., in response to detecting that the user’s attention returns to a location near the indicator 7010 of system function menu (e.g., as shown in FIG. 7D)).

In FIG. 7C, the user 7002 has moved from the first location 7026-a (as shown in FIG. 7B) to a new location 7026-b in the physical environment 7000. As shown in FIG. 7C, a second view of the three-dimensional environment that reflects the new location of the user 7002 is visible via the computer system 7100. For example, the virtual object 7012 (e.g., a virtual ball) is shown at a different position (e.g., is shifted to the left relative to the computer system 7100 in FIG. 7B), and the entirety of the object 7014′ (e.g., a representation of physical object 7014) is now visible. In contrast to virtual object 7012 and object 7014′, the indicator 7010 of system function menu maintains the same spatial relationship relative to the viewpoint of the user (e.g., remains in the same position on the screen of the display generation component, maintains the same spatial relationship to the viewport through which the three-dimensional environment is visible, and/or the same position within the user’s field of view via a head-mounted display, also referred to as “viewpoint-locked”). In some embodiments, the indicator 7010 of system function menu exhibits “lazy follow” behavior. For example, the location 7016 in FIG. 7C reflects the prior position (in FIG. 7B) of the indicator 7010 of system function menu in the three-dimensional environment, and the location 7018 reflects an intermediate position of the indicator 7010 of system function menu (e.g., as indicator 7010 of system function menu is displayed as moving from the location 7016 to the location of indicator 7010 of system function menu in FIG. 7C more slowly than the movement of the viewpoint of the user, as the user 7002 moves from the location 7026-a to the new location 7026-b).

In some embodiments, the indicator 7010 of system function menu changes appearance as the indicator 7010 of system function menu moves from the location 7016 to the location 7018, and/or from the location 7018 to the final position shown in FIG. 7C. In some embodiments, the indicator 7010 of system function menu fades out, becomes blurred, or is otherwise visually obscured as the indicator 7010 of system function menu moves from the location 7016 to the location 7018, and/or from the location 7018 to the position shown in FIG. 7C. In some embodiments, the indicator 7010 of system function menu ceases to be displayed during the movement of the user (e.g., that moves the user’s viewpoint), and is redisplayed (e.g., at the location shown in FIG. 7C) after the movement of the user (e.g., the user’s viewpoint).

FIG. 7D illustrates the user’s attention 7116 (e.g., which is also sometimes referred to as “the user’s gaze”). In FIG. 7E, the user’s attention 7116 is directed to the indicator 7010 of system function menu (e.g., the user gazes at the indicator 7010 of system function menu). If the user 7002′s gaze satisfies attention criteria, the computer system 7100 displays a system function menu 7024 which includes one or more affordances for triggering corresponding system functions. In some embodiments, the user’s gaze satisfies attention criteria when the user gazes at (e.g., the user’s attention 7116 is directed to) the location of the indicator 7010 of system function menu for a threshold amount of time (e.g., at least 0.1, 0.2, 0.5, 1, 2, 5, 10, 30, or 60 seconds). In some embodiments, the user’s gaze satisfies attention criteria when the user gazes (e.g., the user’s attention 7116 is directed) within a first region (e.g., a first region defined to be within or substantially within a visible region surrounding the indicator 7010 of system function menu) in a view of the three-dimensional environment for a threshold amount of time (e.g., 0.1, 0.2, 0.5, 1, 2, 5, 10, 30, or 60 seconds). In some embodiments, the user’s gaze satisfies the attention criteria when the user gazes at (e.g., the user’s attention 7116 is directed to) the indicator 7010 of system function menu and brings a hand into a specified configuration (e.g., a ready state configuration) or performs a specified hand gesture (e.g., an air gesture such as an air tap or an air pinch, or another selection input). The indicator 7010 of system function menu is also sometimes called a “system control indicator,” in that the indicator 7010 of system function menu indicates a location in the user’s field of view with which the user can interact (e.g., gaze at) to trigger display of the system function menu 7024 (and/or display of other user interface elements, as described herein). In contrast, in FIG. 7D, the user’s attention 7116 is not directed to the indicator 7010 of system function menu (e.g., and has not been directed to the indicator 7010 of system function menu recently enough and/or long enough to satisfy attention criteria), so system function menu 7024 is not displayed.

The system function menu 7024 includes a plurality of affordances for accessing system functions of the computer system 7100. For example, as shown in FIG. 7E, the system function menu 7024 includes a home affordance 7124 (e.g., for accessing one or more applications of the computer system 7100, for initiating a communication session with one or more contacts stored in memory of the computer system 7100, and/or for initiating display of a virtual environment), a volume affordance 7038 for adjusting a volume setting of the computer system 7100, a search affordance 7042 for searching content stored on the computer system 7100 (e.g., documents, photos, media files, and/or applications) and/or content from the internet (e.g., internet search results), a notification affordance 7044 for displaying a plurality of notifications (e.g., notifications recently received or generated by the computer system 7100), a control affordance 7046 for accessing additional settings of the computer system 7100 (e.g., for less frequently used settings that are not displayed in the system function menu 7024), and a virtual assistant affordance 7048 for invoking and accessing functions of a virtual assistant. In some embodiments, the system function menu 7024 includes different affordances from what is shown in FIG. 7E (e.g., additional affordances, fewer affordances, and/or some affordances replaced with other affordances associated with different system functions). In some embodiments, the system function menu 7024 is at least partially customizable, such that the user can add one or more affordances to the system function menu 7024 and/or remove one or more of the affordances (e.g., shown in FIG. 7E) from the system function menu 7024. User interactions with the affordances in the system function menu 7024 are described below in further detail, with respect to FIGS. 7J and 7K. In some embodiments, the system function menu 7024 includes status information about the computer system 7100 (e.g., Wi-Fi connection status, cellular connection status, a current time, and/or battery charge state), in addition to the plurality of affordances for accessing system functions of the computer system 7100.

In some embodiments, the system function menu 7024 is displayed within a threshold distance (e.g., within 0.5 cm, 1 cm, 2 cm, or 5 cm) of the indicator 7010 of system function menu. In some embodiments, the system function menu 7024 is displayed with a respective spatial relationship to (e.g., directly below, directly above, to the right of, or to the left of, or other required spatial relationships) the indicator 7010 of system function menu. In some embodiments, the system function menu 7024 is displayed on top of other visible user interfaces in a respective view of the three-dimensional environment. For example, if an application launching user interface and/or application user interface is displayed (e.g., prior to displaying the system function menu 7024, and at least partially overlapping the region over which system function menu 7024 would be displayed), the system function menu 7024 when invoked is displayed over at least a portion of the application launching user interface and/or application user interface. In some embodiments, the system function menu 7024 is displayed so as to appear closer to a viewpoint of the user than the application launching user interface and/or application user interface (e.g., because the system function menu 7024 is displayed over at least a portion of the application launching user interface and/or application user interface, and/or because the system function menu 7024 appears larger than the application launching user interface and/or application user interface).

In some embodiments, displaying the system function menu 7024 includes displaying an animated transition (e.g., of the system function menu 7024 appearing). For example, the animated transition may include an animation of the system function menu 7024 expanding downward from the indicator 7010 of system function menu. Alternately, or in addition, the animated transition may include an animation of the system function menu 7024 gradually appearing or fading into view. In some embodiments, the animated transition that is displayed depends on a position of the indicator 7010 of system function menu. For example, if the indicator 7010 of system function menu is instead displayed near the left edge of the display generation component, the animated transition optionally includes an animation of the system function menu 7024 expanding outward from the indicator 7010 of system function menu toward the right. More generally, the animated transition optionally includes an animation of the system function menu 7024 expanding out from the indicator 7010 of system function menu (e.g., toward a center of the view of the three-dimensional environment that is visible). In some embodiments, the indicator 7010 of system function menu is visually deemphasized (e.g., dimmed, faded, grayed out, and/or blurred) or not displayed while the system function menu 7024 is displayed, as indicated in FIG. 7E by the dotted outline of indicator 7010 of system function menu.

In some embodiments, as shown in FIG. 7F, the system function menu 7024 exhibits lazy follow behavior. In particular, FIG. 7F illustrates example embodiments in which the system function menu 7024 and the indicator 7010 of system function menu both exhibit lazy follow behavior. In some embodiments, the lazy follow behavior of the indicator 7010 of system function menu is different from the lazy follow behavior of the system function menu 7024. For example, FIG. 7F shows that as indicator 7010 of system function menu moves over time from indicator position 7030 to indicator position 7032 to the current position of indicator 7010 of system function menu in FIG. 7F, system function menu 7024 moves (e.g., over the same period of time) from system function menu position 7034 to system function menu position 7036 to the current position of system function menu 7024 in FIG. 7F, respectively. Indicator positions 7030 and 7032 are closer to the current position of indicator 7010 of system function menu in FIG. 7F than system function menu positions 7034 and 7036 are to the current position of system function menu 7024 in FIG. 7F, indicating that indicator 7010 of system function menu follows the viewpoint of the user more closely (e.g., more quickly) than the system function menu 7024.

In some embodiments, the computer system 7100 ceases to display the system function menu 7024 when (e.g., in response to detecting that) the user’s gaze no longer satisfies the attention criteria (e.g., the user’s attention 7116 is no longer directed to the indicator 7010 of system function menu or the system function menu 7024). In some embodiments, the system function menu 7024 may remain displayed for a time (e.g., a number of seconds, optionally accounting for lazy follow behavior so as to allow the system function menu 7024 to finish settling into a new viewpoint-locked position) even after the user’s gaze no longer satisfies the attention criteria, and may remain displayed if the user’s gaze subsequently satisfies the attention criteria again (e.g., within a threshold amount of time of ceasing to satisfy the attention criteria). For example, in embodiments where the indicator 7010 of system function menu exhibits lazy follow behavior, the system function menu 7024 may remain displayed even if the user’s gaze does not continuously remain directed to the indicator 7010 of system function menu (e.g., the user’s gaze does not precisely track the indicator 7010 of system function menu) as the viewpoint of the user moves (e.g., as the user moves a touchscreen device or turns their head while wearing a head-mounted display).

FIG. 7G illustrates the user’s attention 7116 directed to a volume affordance 7038 that is included in the system function menu 7024. In some embodiments, as shown in FIG. 7H, in response to detecting the user’s attention 7116 directed to the volume affordance 7038, the computer system 7100 changes an appearance of the volume affordance 7038 (e.g., highlights the volume affordance 7038, increases a thickness of the border of the volume affordance 7038, adds a selection outline to the volume affordance 7038, changes a color of the volume affordance 7038, and/or changes a size of the volume affordance 7038), to indicate that the volume affordance 7038 is selected for further user interaction. In some embodiments, the computer system 7100 changes the appearance of the volume affordance 7038 in response to detecting that the user’s hand is in a ready state configuration. In some embodiments, the computer system 7100 changes the appearance of the volume affordance 7038 in response to detecting both that the user’s attention 7116 is directed to the volume affordance 7038 and that the user’s hand is in the ready state configuration. In some embodiments, the computer system 7100 does not change the appearance of the volume affordance 7038 (e.g., irrespective of whether the user’s attention 7116 is directed to the volume affordance 7038 and/or the user’s hand is in the ready state configuration).

In some embodiments, in response to detecting that the user’s attention 7116 is directed to the volume affordance 7038, the computer system 7100 outputs additional content associated with the volume affordance 7038 (e.g., a description of a volume setting associated with the volume affordance 7038, instructions for adjusting the volume setting associated with the volume affordance 7038, and/or a current value of the volume setting associated with the volume affordance 7038), which is sometimes referred to as a “tool tip.” In some embodiments, the tool tip is displayed after a delay (e.g., of 1 second, 5 seconds, or any threshold time between 0 and 10 seconds) in response to detecting that the user’s attention 7116 is directed to the volume affordance 7038. In some embodiments, the tool tip is displayed adjacent to (e.g., immediately above, immediately below, to the left of, or to the right of) the volume affordance 7038. In some embodiments, the tool tip is displayed partially overlaid over at least a portion of the volume affordance 7038 (and/or other affordances in the system function menu 7024).

FIG. 7H also illustrates that, in response to detecting an activation input directed to the volume affordance 7038, the computer system displays a system space 7040. In some embodiments, detecting the activation input includes detecting that the user’s attention 7116 is directed to the volume affordance 7038. In some embodiments, detecting the activation input includes detecting an input performed by user 7002 (e.g., as indicated by hand 7020 shown with movement arrows in FIG. 7H), while volume affordance 7038 is selected (e.g., based on the user 7002′s attention 7116 being directed to the volume affordance 7038). Examples of an input performed by user 7002 include an air gesture (e.g., an air pinch gesture or an air tap gesture), a tap gesture on a touch-sensitive surface, a button press or other switch input, and/or a voice command. Because the activation input was directed to the volume affordance 7038, the system space 7040 is a system space for adjusting a volume setting of the computer system 7100. In some embodiments, the system space 7040 that is displayed changes depending on the respective affordance associated with the system space 7040 that was activated from system function menu 7024. For example, if the user’s attention 7116 were instead directed to the control affordance 7046, the system space 7040 would be a system space with a control panel user interface rather than a system space for adjusting a volume setting of the computer system 7100. Examples of different system spaces displayed in response to activation of different affordances in system function menu 7024 are described in more detail herein with reference to FIG. 7K. In some embodiments, system space 7040 or additional controls that are displayed based on interaction with the system function menu are displayed with a respective spatial arrangement relative to the system function menu (e.g., to the left, to the right, above, or below the system function menu) and are optionally displayed adjacent to the system function menu (e.g., less than a threshold distance away from the system function menu but not overlapping the system function menu, where the threshold distance is less than half, less than a quarter, less than an eighth, of a height and/or width of the system function menu).

In some embodiments, the system space 7040 remains displayed while the user’s attention is directed to the system space 7040, the volume affordance 7038, or the indicator 7010 of system function menu. In some embodiments, the system space 7040 ceases to be displayed in response to the user’s attention 7116 moving away from the volume affordance 7038 or the system space 7040. In some embodiments, the system space 7040 ceases to be displayed a threshold amount of time (e.g., 0.1, 0.2, 0.5, 1, 2, 5, 10, 30, or 60 seconds) after the user’s attention has moved away from the volume affordance 7038 or the system space 7040 (e.g., to avoid ceasing to display the system space 7040 if the user did not intend to dismiss the system space 7040, for example if the user were briefly distracted, or to account for hardware limitations (e.g., a camera of the computer system 7100 temporarily losing focus of the user due to movement of the camera and/or changes in environmental lighting), for less than the threshold amount of time).

In some embodiments, if the system space 7040 is already displayed (e.g., in response to detecting an activation input directed to the volume affordance 7038), and the computer system 7100 detects that the user’s attention shifts to another affordance (e.g., the control affordance 7046 or any other affordance in system function menu 7024), the computer system 7100 ceases to display the system space 7040 and displays a new system space for the other affordance (and optionally replaces display of the system space 7040 with the system space for the other affordance). In some embodiments, the system space for the other affordance is displayed in response to another activation input while the user’s attention is directed to the other affordance.

In some embodiments, while the system space 7040 is displayed, in response to detecting the user’s attention directed to the system function menu 7024, the system space 7040 is visually deemphasized (e.g., dimmed, faded, and/or blurred). While the system space 7040 is displayed, in response to detecting the user’s attention directed to the system space 7040, the system function menu 7024 is visually deemphasized (and, optionally, the system space 7040 ceases to be visually deemphasized). In some embodiments, the indicator 7010 of system function menu is visually deemphasized (e.g., dimmed, faded, and/or blurred), or not displayed, when the user 7002 is gazing at or interacting with system function menu 7024 or system space 7040.

In some scenarios, the computer system 7100 displays an application launching user interface (e.g., a home user interface, optionally including one or more affordances corresponding respectively to one or more applications that can be launched on computer system 7100). In some embodiments, the indicator 7010 of system function menu is displayed while the application launching user interface is displayed, and the application launching user interface remains displayed while system function menu 7024 is displayed in response to user interaction with indicator 7010 of system function menu as described herein (e.g., prior to displaying the system space 7040). In some such embodiments, in response to detecting the activation input directed to the volume affordance 7038, as described herein with reference to FIG. 7H, the computer system 7100 replaces display of the application launching user interface with display of the system space 7040 (e.g., by ceasing to display the application launching user interface and displaying the system space 7040).

In some scenarios, the computer system 7100 displays an application user interface prior to displaying the system space 7040 (e.g., concurrently with indicator 7010 of system function menu and/or system function menu 7024). In response to detecting the activation input directed to the volume affordance 7038, the computer system 7100 displays the system space 7040 overlaid on at least a portion of the application user interface.

As shown in FIG. 7I, in response to detecting an interaction input (e.g., a gaze input, a hand gesture, or a combined gaze and hand gesture) directed to the system space 7040, and in particular to the slider, the computer system 7100 adjusts the volume of the computer system 7100 in accordance with movement of the interaction input. In some embodiments, the interaction input includes a gaze input (e.g., as the user’s gaze shifts to the right, the volume level of the computer system 7100 is increased). In some embodiments, the interaction input includes the user’s gaze in conjunction with an air gesture (e.g., a pinch, or a pinch and drag). In some embodiments, the volume of the computer system 7100 is adjusted in accordance with movement of a hand gesture (e.g., drag gesture or swipe gesture) of the user’s hand 7020. In some embodiments, a first air gesture (e.g., an air pinch gesture or an air tap gesture) activates the volume affordance 7038, and a second air gesture (e.g., a second air pinch gesture or air tap gesture in combination with a change in position of the user’s hand 7020 from a first position to a second position) adjusts the slider of the system space 7040. In some embodiments, while the user maintains the first air gesture that activates the volume affordance 7038, a change in position of the user’s hand 7020 adjusts the slider of the system space 7040.

In some embodiments, the system space 7040 includes a plurality of sliders for adjusting volumes for the computer system 7100. For example, the system space 7040 includes a first slider for adjusting a volume associated with application (e.g., the volume for content or media within an application user interface, or the volume of notifications associated with applications), a second slider for adjusting a volume associated with people/contacts (e.g., the volume for audio calls, video calls, and AR/VR communication sessions with other users), and a third slider for adjusting a volume associated with environments (e.g., a volume for AR or VR experiences). In some embodiments, the computer system 7100 determines the active context (e.g., an application user interface is being displayed and/or the attention of the user is directed to an application user interface; there is an active communication session; and/or an AR or VR experience is active) and displays a single slider for adjusting the volume for the active context. In some embodiments, the computer system 7100 determines there is no active context (e.g., no application user interface is displayed, no communication sessions are active, and no AR/VR experiences are active), and displays the plurality of sliders for adjusting volumes for different contexts (e.g., the three contexts described above).

FIG. 7J illustrates user interactions (e.g., a user performing a respective activation input, such as by gazing at and/or performing a gesture) directed to the different affordances in the system function menu 7024. FIG. 7K shows example system spaces (e.g., user interfaces) associated with, and displayed in response to activation of, the affordances in the system function menu 7024. In some embodiments, a respective system space is displayed in response to detecting that the user’s attention (e.g., optionally, in combination with an air gesture and/or verbal input) is directed to a respective affordance of the plurality of affordances in the system function menu 7024.

FIG. 7K(a) shows the system space 7040, which is associated with the volume affordance 7038 and displayed in response to detecting an activation input directed to the volume affordance 7038, as described herein with reference to FIGS. 7H-7I. While FIG. 7K(a) shows a single slider (e.g., for adjusting a volume level of the computer system 7100), in some embodiments, the system space 7040 includes additional sliders for adjusting related settings of the computer system 7100 (e.g., equalizer controls, separate volume controls for two or more speakers of the computer system 7100, and/or spatial audio controls). In some embodiments, the system space 7040 includes one or more dials, sliders, and/or buttons for adjusting settings of the computer system 7100 (e.g., in addition to and/or instead of the single slider shown in FIG. 7K(a)). In some embodiments, system space 7054 or additional controls that are displayed based on interaction with the system function menu are displayed with a respective spatial arrangement relative to the system function menu (e.g., to the left, to the right, above, or below the system function menu) and are optionally displayed adjacent to the system function menu (e.g., less than a threshold distance away from the system function menu but not overlapping the system function menu, where the threshold distance is less than half, less than a quarter, less than an eighth, of a height and/or width of the system function menu).

FIG. 7K(b) shows a system space 7050 that is displayed in response to detecting an activation input directed to the search affordance 7042, and that includes a text field for text entry. In some embodiments, the text field of the system space 7050 displays text of a search term or search query entered by the, such as text associated with (e.g., transcribed from) a detected verbal input from the user (e.g., as shown by the speech bubble with the term “Weather” in FIG. 7K(b)). In some embodiments, the search affordance 7042 provides visual feedback (e.g., as shown by the dotted circles around search affordance 7042 in FIG. 7K(b)) as the user 7002 is speaking. In some embodiments, the visual feedback varies based on at least one characteristic (e.g., volume, speed, and/or length) of the verbal input (e.g., the dotted circles in FIG. 7K(b) change size in accordance with a volume of the detected verbal input). In some embodiments, system space 7050 or additional controls that are displayed based on interaction with the system function menu are displayed with a respective spatial arrangement relative to the system function menu (e.g., to the left, to the right, above, or below the system function menu) and are optionally displayed adjacent to the system function menu (e.g., less than a threshold distance away from the system function menu but not overlapping the system function menu, where the threshold distance is less than half, less than a quarter, less than an eighth, of a height and/or width of the system function menu).

In some embodiments, the text field of the system space 7050 updates in real time (e.g., as the user 7002 is speaking). In some embodiments, the text field of the system space 7050 displays the text of the detected verbal input only after (e.g., in response to) detecting completion of the verbal input (and optionally after detecting that the user 7002 has stopped speaking for a threshold amount of time). In some embodiments, in response to detecting (e.g., completion of) the verbal input, the computer system 7100 automatically performs one or more functions (e.g., an Internet search, an application search, a document or file search, or other content search) associated with the verbal input. In some embodiments, the computer system 7100 performs the one or more functions associated with the verbal input in response to detecting a first portion of the verbal input, and continues to perform the one or more functions while the verbal input continues (e.g., the search is continually updated as additional portions of the verbal input are detected). For example, the computer system 7100 performs a search function in response to detecting the verbal input (e.g., presenting search results for the word “Weather” in FIG. 7K(b)), and continues to update the search results as the verbal input continues (e.g., as the verbal input continues to add the word “Cupertino,” computer system 7100 presents updated search results for the term “Weather Cupertino”).

FIG. 7K(c) shows a system space 7052, a notification center that is displayed in response to detecting an activation input directed to the notification affordance 7044. In some embodiments, the system space 7052 includes a plurality of notifications (e.g., recently generated or received notifications). In some embodiments, the notifications that appear in the system space 7052 can be configured by the user. For example, the user can configure the system space 7052 to only display notifications within a certain amount of time (e.g., the past 30 minutes, the past hour, or the past 12 hours), the user can configure the system space 7052 to display notifications only from selected applications (e.g., permitting display of notifications from a messaging application and/or an e-mail application, while suppressing display of notifications from other applications), and/or the user can configure how the notifications in the system space 7052 are displayed (e.g., grouped by application, grouped by contact, and/or grouped by particular time window (e.g., received between 9 AM and 5 PM)). In some embodiments, system space 7052 or additional controls that are displayed based on interaction with the system function menu are displayed with a respective spatial arrangement relative to the system function menu (e.g., to the left, to the right, above, or below the system function menu) and are optionally displayed adjacent to the system function menu (e.g., less than a threshold distance away from the system function menu but not overlapping the system function menu, where the threshold distance is less than half, less than a quarter, less than an eighth, of a height and/or width of the system function menu).

FIG. 7K(d) shows a system space 7054, a control panel that is displayed in response to detecting an activation input directed to the control affordance 7046. In some embodiments, the system space 7054 includes one or more affordances, such as sliders, buttons, dials, toggles, and/or other controls, for adjusting additional system settings of the computer system 7100 (e.g., additional system settings that do not appear in system function menu 7024 itself). In some embodiments, the system space 7054 includes an affordance for transitioning the computer system 7100 to an airplane mode, an affordance for enabling or disabling a cellular function of the computer system 7100, an affordance for enabling or disabling a Wi-Fi function of the computer system 7100, and/or an affordance for enabling or disabling a Bluetooth function of the computer system 7100. In some embodiments, the system space 7054 includes a slider for adjusting a brightness of a display of the computer system 7100. In some embodiments, the system space 7054 includes one or more controls associated with hardware functions of the computer system 7100 (e.g., a flashlight function, and/or a camera function) and/or one or more controls associated with software functions of the computer system 7100 (e.g., an alarm function, a timer function, a clock function, and/or a calculator function). In some embodiments, system space 7054 includes one or more affordances for controlling system settings of the computer system 7100 that are also accessible using another affordance in system function menu 7024. For example, system space 7054 optionally includes a slider for adjusting an output volume level of the computer system 7100, which is analogous to the slider in system space 7040 that can also be accessed using volume affordance 7038 in system function menu 7024 (as described herein with reference to FIGS. 7H-7I and 7K(a)). In some embodiments, system space 7054 or additional controls that are displayed based on interaction with the system function menu are displayed with a respective spatial arrangement relative to the system function menu (e.g., to the left, to the right, above, or below the system function menu) and are optionally displayed adjacent to the system function menu (e.g., less than a threshold distance away from the system function menu but not overlapping the system function menu, where the threshold distance is less than half, less than a quarter, less than an eighth, of a height and/or width of the system function menu).

In some embodiments, for a respective affordance in system function menu 7024, no system space is displayed in response to an activation input directed to the respective affordance. For example, as shown in FIG. 7K(e), the computer system 7100 does not display a system space associated with the virtual assistant affordance 7048. In some embodiments, the computer system 7100 displays visual feedback to visually emphasize the virtual assistant affordance 7048 upon activation, for example by highlighting, displaying a selection outline around, enlarging, and/or animating the affordance, in place of displaying a system space associated with the virtual assistant affordance 7048. In some embodiments, the computer system 7100 displays visual feedback to indicate that a verbal input to the virtual assistant is being detected, as shown by the dotted circles around the virtual assistant affordance 7048 in FIG. 7K(e) indicating detection of the voice command shown by the speech bubble with the phrase “Call John Smith”. In some embodiments, in response to detecting completion of a verbal input, the virtual assistant associated with the virtual assistant affordance 7048 automatically performs one or more functions associated with the verbal input (e.g., executes the voice command).

In some embodiments, a system space that is displayed in response to activation of an affordance in system function menu 7024 (e.g., any of the system spaces shown in FIG. 7K(a)-7K(d)) is displayed over at least a portion of the system function menu 7024 (e.g., to give focus to and increase visibility of the system space). In some embodiments, the computer system 7100 displays an animated transition of an invoked system space (e.g., any of the system spaces shown in FIG. 7K(a)-7K(d)) expanding outward (e.g., and downward, according to the FIG. 7J example) from system function menu 7024, or more specifically from the associated affordance in system function menu 7024 that was activated to invoke the system space. For example, the computer system 7100 displays an animated transition of the system space 7040 expanding from the volume affordance 7038 to cover at least a portion of the system function menu 7024.

Additional descriptions regarding FIGS. 7A-7K are provided below in reference to method 8000 described with respect to FIGS. 7A-7K, among other Figures and methods described herein.

FIGS. 7L-7Q illustrate examples of displaying content associated with a first notification, in response to detecting a first gaze input directed to a first user interface object, in accordance with a determination that a first event for the first notification satisfies timing criteria. FIG. 9 is a flow diagram of an exemplary method 9000 for displaying content associated with a first notification, in response to detecting a first gaze input directed to a first user interface object, in accordance with a determination that a first event for the first notification satisfies timing criteria. The user interfaces in FIGS. 7L-7Q are used to illustrate the processes described below, including the processes in FIG. 9.

As shown in the examples in FIGS. 7L-7Q, content that is visible via a display generation component of computer system 7100 is displayed on a touch screen held by user 7002. In some embodiments, the display generation component of computer system 7100 is a head-mounted display worn on user 7002′s head (e.g., what is shown in FIGS. 7L-7Q as being visible via the display generation component of computer system 7100 corresponds to the user 7002′s field of view when wearing a head-mounted display). FIG. 7L illustrates an exemplary user interface object 7056 (e.g., a notification indicator 7056), when there is a first event for a first notification that satisfies timing criteria (e.g., to inform the user 7002 about a notification recently received or generated at computer system 7100). For example, the user interface object 7056 is displayed when the computer system 7100 has recently received a text message from another user (and optionally generated a notification corresponding to the recently received text message). FIG. 7L illustrates the user interface object 7056 with a different appearance (e.g., a square shape) from the indicator 7010 of system function menu (e.g., described above with reference to FIGS. 7A-7K). The indicator 7010 of system function menu (e.g., a first appearance, optionally a default appearance, of the system control indicator) is displayed when a notification has not been recently received (e.g., the first event for the first notification does not satisfy the timing criteria), and the user interface object 7056 is displayed (e.g., in place of the indicator 7010 of system function menu, as a second appearance or an alternate appearance of the system control indicator) when a notification has been recently received (e.g., the first event for the first notification satisfies the timing criteria). In some embodiments, the user interface object 7056 has an appearance that indicates an application associated with the first notification (e.g., the user interface object 7056 appears as the application icon for a messaging application in which a text message was recently received). In some such embodiments, the user interface object 7056 optionally includes different indications for different applications (e.g., when the first notification is associated with a first application, the user interface object 7056 has a first appearance that indicates the first application, and when the first notification is associated with a second application, the user interface object 7056 has a second appearance (different from the first appearance) that indicates the second application (different from the first application)). In some embodiments, the user interface object 7056 is displayed with the appearance that is indicative of an application associated with the first notification, but ceases to be displayed with that appearance (e.g., and is instead displayed with a default appearance, such as the appearance of the indicator 7010 of system function menu), after a threshold amount of time (e.g., 5 seconds, 10 seconds, 30 seconds, or 1 minute) has elapsed (e.g., since occurrence, generation, or detection of the first event for the first notification).

In some scenarios, the computer system displays other user interfaces, such as a user interface 7058, in the three-dimensional environment. In some scenarios, the user interface 7058 is an application user interface. In some scenarios, the user interface 7058 is an application launching user interface (e.g., a home user interface).

In response to detecting a first gaze input directed to the user interface object 7056, as shown by the user’s attention 7116 directed to the user interface object 7056 in FIG. 7M (e.g., in contrast to FIG. 7L in which the user’s attention 7116 is directed to user interface 7058 instead), the computer system 7100 displays notification content 7060 (e.g., message content for a notification of a message received in a messaging application, and/or event information for a notification of a calendar event in a calendar application). In some embodiments, the notification content 7060 includes additional information associated with the notification (e.g., a time stamp of the first event for the first notification, and/or an application associated with the first notification). In some embodiments, notification content 7060 represents a preview or excerpt of information associated with the received notification (e.g., showing part of a received text message or key event information for a received calendar invitation), and the user can further interact with notification content 7060, as described herein, to view additional (e.g., more complete) information about and/or additional context for the received notification.

In some embodiments, the notification content 7060 is displayed over a portion of the user interface 7058 (and/or over other displayed user interfaces in the view of the three-dimensional environment). In some embodiments, the notification content 7060 is displayed within a threshold distance (e.g., 0.5 cm, 1 cm, 2 cm, or 5 cm) of the user interface object 7056. In some embodiments, the notification content 7060 is displayed with a respective spatial relationship to (e.g., directly below, directly above, to the right of, or to the left of) the user interface object 7056. In some embodiments, the notification content 7060 is displayed closer to a viewpoint of the user than other user interface objects such as user interface 7058 (e.g., to simulate being “on top” of other user interface elements, relative to the viewpoint of the user).

In some embodiments, the notification content 7060 is displayed concurrently with the user interface object 7056. In some embodiments, as indicated by the dashed outline of user interface object 7056 in FIG. 7M, the user interface object 7056 is visually deemphasized or ceases to be displayed when (and/or while) the notification content 7060 is displayed. In some embodiments, displaying the notification content 7060 includes displaying an animated transition (e.g., of the notification content 7060 appearing). For example, the animated transition may include an animation of the notification content 7060 expanding downward from the user interface object 7056. Alternately, or in addition, the animated transition may include an animation of the notification content 7060 gradually getting bigger and/or fading into view. In some embodiments, the animated transition that is displayed depends on a position of the user interface object 7056. For example, if the user interface object 7056 is instead displayed near the left edge of the display generation component, the animated transition optionally includes an animation of the notification content 7060 expanding outward from the user interface object 7056 towards the right edge of the display generation component.

The dashed outline of the system function menu 7024 in FIG. 7M illustrates that, in some embodiments, the system function menu 7024 is displayed concurrently with the notification content 7060 and optionally with the user interface object 7056 in response to detecting the first gaze input directed to the user interface object 7056 (e.g., optionally, the system function menu 7024 is invoked using an input directed to the system control indicator whether it has the appearance of indicator 7010 of system function menu, as described above with reference to FIGS. 7A-7K, or the appearance of notification indicator 7056). In some such embodiments, the notification content 7060 is displayed within a threshold distance (e.g., 0.5 cm, 1 cm, 2 cm, or 5 cm) of the system function menu 7024 (e.g., instead of within a threshold distance of the user interface object 7056, or in addition to being displayed within a greater threshold distance (e.g., relative to embodiments in which the system function menu 7024 is not displayed) of the user interface object 7056). In some such embodiments, the notification content 7060 is optionally displayed with a respective spatial relationship to (e.g., directly below, directly above, to the right of, or to the left of) the system function menu 7024 and/or the user interface object 7056. In other embodiments, the notification content 7060 is displayed without displaying the system function menu 7024 (e.g., as shown in FIG. 7N). In some embodiments, the computer system 7100 initially displays notification content 7060 in response to the first gaze input without displaying the system function menu 7024. After displaying the notification content 7060 in response to the first gaze input, and in response to detecting that the user’s gaze continues to be directed to the user interface object 7056 (e.g., for a threshold amount of time (e.g., 0.1, 0.2, 0.5, 1, 2, 5, 10, 30, or 60 seconds), the computer system 7100 displays system function menu 7024 as well (e.g., in addition to and concurrently with the notification content 7060). In some such embodiments, the threshold distance and/or the respective spatial relationship of the notification content 7060 to the user interface object 7056 changes (e.g., as the system function menu 7024 is added, the placement of the notification content 7060 is updated to accommodate any threshold distance and/or respective spatial relationship requirements of the system function menu 7024 relative to the user interface object 7056 and/or relative to the notification content 7060). For example, if notification content 7060 is initially displayed in response to a gaze input directed to user interface object 7056 (e.g., that meets timing criteria for displaying notification content 7060), with notification content 7060 positioned relative to user interface object 7056 as shown in FIG. 7N, and if system function menu 7024 is added after additional timing criteria are met by the gaze input directed to user interface object 7056, notification content 7060 is optionally moved so as to be positioned relative to user interface object 7056 and system function menu 7024 as shown in FIG. 7M (e.g., to accommodate displaying system function menu 7024 closer to user interface object 7056 than notification content 7060 to user interface object 7056).

In some embodiments, the computer system 7100 switches between display of the notification content 7060 and the system function menu 7024 in response to successive gaze inputs directed to the user interface object 7056. In response to detecting the first gaze input directed to the user interface object 7056, the computer system 7100 displays the notification content 7060. After displaying the notification content 7060, the user gazes away from the user interface object 7056 (and optionally, the notification content 7060 ceases to be displayed). After gazing away from the user interface object 7056, the user’s gaze returns to the user interface object 7056, and in response, the computer system 7100 displays the system function menu 7024 (e.g., without displaying the notification content 7060). If the user repeats this process (e.g., looks away from the user interface object 7056, then looks back at the user interface object 7056), the computer system 7100 displays (e.g., redisplays) the notification content 7060 (e.g., without displaying the system function menu 7024). This allows the user to switch between displaying the notification content 7060 and the system function menu 7024 without cluttering the displayed user interface (e.g., occupying too much of the user’s field of view with concurrent display of the notification content 7060 and the system function menu 7024).

In some embodiments, the computer system 7100 switches between display of the notification content 7060 and additional notification content (e.g., for a second event for a second notification that also satisfies the timing criteria). In some such embodiments, the computer 7100 optionally switches between display of the notification content 7060, the additional notification content, and the system function menu 7024 (e.g., cycles through these different user interfaces) in response to successive gaze inputs to the user interface object 7056 (e.g., the displayed user interface may change each time the user looks away from, then back at, the user interface object 7056).

In some embodiments, the user’s attention 7116 is directed to the notification content 7060, as shown in FIG. 7N. In some embodiments, the user performs a user input (e.g., an air gesture (e.g., an air tap or an air pinch) or a touch input) while gazing at the notification content 7060. In some embodiments, the user input includes a pinch and drag gesture. In some embodiments, the computer system performs different functions depending on a characteristic of the user input (e.g., a direction, speed, and/or amount of movement of the drag portion of a pinch and drag gesture). For example, in response to a pinch and drag towards the user (e.g., towards the viewpoint of the user), the computer system 7100 launches an application, and displays an application user interface 7062, for an application associated with the notification, as shown in FIG. 7O. In another example, in response to a pinch and drag downward (e.g., relative to the view displayed on the display generation component, towards the representation of the floor 7008′ as shown in FIG. 7N), the computer system 7100 ceases to display (e.g., dismisses) the notification content 7060 (e.g., as shown when transitioning from FIG. 7N directly to FIG. 7P).

In some embodiments, the user interface object 7056, the notification content 7060, the system function menu 7024, and/or the application user interface 7062 follow the viewpoint of the user 7002 as the viewpoint of the user 7002 moves (e.g., as the user moves a touchscreen device or turns their head while wearing a head-mounted display) (e.g., one or more are viewpoint-locked). In some embodiments, the follow behavior of the user interface object 7056, the notification content 7060, the system function menu 7024, and/or the application user interface 7062 is lazy follow behavior. In some embodiments, the user interface object 7056 has lazy follow behavior. In some embodiments, the follow behavior of the user interface object 7056 is the same as the lazy follow behavior of the indicator 7010 of system function menu as described above with reference to FIGS. 7A-7K (e.g., the lazy follow behavior of the system control indicator is the same regardless of whether a first event for a first notification satisfies timing criteria and thus regardless of whether the system control indicator has the appearance of indicator 7010 of system function menu or the appearance of user interface object 7056). In some embodiments, the follow behavior of the indicator 7010 of system function menu (e.g., a default appearance of the first user interface object), which as described herein is optionally lazy follow behavior, is different from the follow (e.g., lazy follow) behavior of the user interface object 7056 (e.g., the user interface object 7056, which is displayed when a first event for a first notification satisfies timing criteria, follows the user’s viewpoint more (or less) closely than does the indicator 7010 of system function menu).

In some embodiments, the user interface object 7056 has different follow (e.g., lazy follow) behavior than the system function menu 7024 (e.g., similar to how the indicator 7010 of system function menu optionally has different follow behavior from the system function menu 7024, as described above, and as shown in FIG. 7F). In some embodiments, the system function menu 7024 has different follow behavior from the notification content 7060. In some embodiments, the notification content 7060 has different follow behavior from the application user interface 7062. In some embodiments, the follow behavior of the user interface object 7056 is different from the follow behavior of the notification content 7060. In some embodiments, the user interface object 7056, the notification content 7060, the system function menu 7024, and the application user interface 7062 each have distinct follow (e.g., lazy follow) behavior (e.g., with respect to each other user interface element that exhibits follow behavior). Optionally, one user interface element (e.g., application user interface 7062) is world-locked and thus (e.g., by not exhibiting viewpoint-following behavior) exhibits different follow behavior from another element that exhibits viewpoint-following behavior.

In some embodiments, the computer system 7100 ceases to display the notification content 7060 when (e.g., in response to detecting that) the user’s attention 7116 is no longer directed to the user interface object 7056 (or the notification content 7060). In some embodiments, the notification content 7060 may remain displayed for a respective period of time (e.g., a number of seconds, optionally accounting for lazy follow behavior) even after the user’s attention 7116 is no longer directed to the user interface object 7056 (or notification content 7060), and remains displayed if the user’s attention 7116 is subsequently directed back to the user interface object 7056 (or the notification content 7060) (e.g., the respective time period is restarted when the user’s attention 7116 returns to the user interface object 7056 before the expiration of the respective time period). In some such embodiments, the notification content 7060 ceases to be displayed if the computer system 7100 detects that the user’s attention 7116 is no longer directed to the user interface object 7056 (or the notification content 7060), and has not returned to the user interface object 7056 (or the notification content 7060) within the respective period of time. In some embodiments, after the notification content 7060 ceases to be displayed, in response to the user’s attention 7116 subsequently being directed to the user interface object 7056 (e.g., while the first event for the first notification satisfies the timing criteria), the computer system 7100 redisplays the notification content 7060.

For example, in embodiments where the user interface object 7056 (and/or notification content 7060) exhibit(s) lazy follow behavior, the notification content 7060 may remain displayed even if the user’s attention 7116 does not continuously remain directed to the user interface object 7056 (or the notification content 7060). This is advantageous, for example, so that the user’s attention 7116 does not need to precisely track the user interface object 7056 (or the notification content 7060) while the user (and/or the viewpoint of the user) is moving in order for the notification content 7060 to remain displayed, thus preventing situations where the notification content 7060 ceases to be displayed due to the user’s attention 7116 having moved away for too long and the user must perform another gaze input directed to the user interface object 7056 in order to redisplay the notification content 7060.

After the first event for the first notification no longer satisfies the timing criteria (e.g., the notification is no longer considered recent enough), the user interface object 7056 returns to a default appearance (e.g., as shown by the indicator 7010 of system function menu in FIGS. 7P and 7Q). FIG. 7P illustrates an example transition from FIG. 7L, after the threshold amount of time has elapsed since the first event for the first notification occurred. As shown in FIG. 7Q, if, while the system control indicator is displayed with the default appearance (e.g., the system control indicator appears as indicator 7010 of system function menu), the user’s attention 7116 is directed to the system control indicator, the computer system 7100 displays the system function menu 7024 (e.g., the computer system 7100 behaves as described above with reference to FIGS. 7A-7K), and does not display the notification content 7060 (e.g., because the notification corresponding to the notification content 7060 is no longer recent, although in some embodiments, the user may access the content associated with the notification through the notification affordance 7044 of the system function menu 7024, as described above with reference to FIG. 7K(c)).

In some embodiments, the user interface object 7056 returns to the default appearance (e.g., appears instead as the indicator 7010 of system function menu in FIGS. 7P and 7Q) after the computer system 7100 displays the notification content 7060. In some embodiments, the user interface object 7056 returns to the default appearance after the notification content 7060 ceases to be displayed (e.g., the user dismisses display of the notification content 7060). FIG. 7P also illustrates an example transition from FIG. 7N, in response to user 7002 dismissing notification content 7060.

Additional descriptions regarding FIGS. 7L-7Q are provided below in reference to method 9000 described with respect to FIGS. 7L-7Q, among other Figures and methods described herein.

FIGS. 7R-7X illustrate examples of displaying a first user interface that includes an affordance for joining a communication session. FIG. 9 is a flow diagram of an exemplary method 9000 for displaying a first user interface that includes an affordance for joining a communication session. The user interfaces in FIGS. 7R-7X are used to illustrate the processes described below, including the processes in FIG. 9.

As shown in the examples in FIGS. 7R-7X, content that is visible via a display generation component of computer system 7100 is displayed on a touch screen held by user 7002. In some embodiments, the display generation component of computer system 7100 is a head-mounted display worn on user 7002′s head (e.g., what is shown in FIGS. 7R-7X as being visible via the display generation component of computer system 7100 corresponds to the user 7002′s field of view when wearing a head-mounted display). FIG. 7R illustrates an exemplary user interface object 7064 (e.g., a communication session indicator), when there is a request for the computer system 7100 to join a communication session that satisfies timing criteria. For example, the user interface object 7064 is displayed in response to the computer system 7100 receiving a request for the computer system 7100 to join a communication session (e.g., a phone call, a video call, and/or a shared virtual experience). In some embodiments, the communication session request satisfies the timing criteria if less than a threshold amount of time TH1 (e.g., 5 seconds, 10 seconds, 20 seconds, 30 seconds, 1 minute, 2 minutes, or any threshold time between 0 and 2 minutes, and which may vary depending on the type of communication session requested) has elapsed since the request was first received, while the request remains active (e.g., the initiating user has not canceled the request). Timer 7066-1 in FIG. 7R indicates a time t=0 at which the communication session request is received. FIG. 7R illustrates the user interface object 7064 with a diamond shape, to differentiate the user interface object 7064 from the indicator 7010 of system function menu (e.g., as described above with reference to FIGS. 7A-7K) and from the user interface object 7056 (e.g., as described above with reference to FIGS. 7L-7Q). User interface object 7064 represents a different appearance (e.g., a third appearance) of the system control indicator than indicator 7010 of system function menu (e.g., a first, optionally default appearance) and user interface object 7056 (e.g., a second appearance).

In some embodiments, the user interface object 7064 is displayed if a request for the computer system 7100 to join a communication session satisfies first timing criteria (e.g., the communication session request has been active for less than a threshold amount of time), the user interface object 7056 is displayed if a first event for a first notification satisfies second timing criteria (e.g., different from the first timing criteria) (e.g., timing criteria as described herein with reference to FIGS. 7L-7Q), and the indicator 7010 of system function menu is displayed if there is neither a request for the computer system 7100 to join a communication session that satisfies the first timing criteria, nor a first event for a first notification that satisfies the second timing criteria. In some embodiments, if there is both a request for the computer system 7100 to join a communication session that satisfies the first timing criteria, and a first event for a first notification that satisfies the second timing criteria, the user interface object 7064 is displayed (e.g., because an incoming communication session request is considered more urgent than an incoming notification). In some embodiments, the user interface object 7056 is displayed instead. In some embodiments, the user can configure the computer system 7100 to display either the user interface object 7064 (e.g., to prioritize alerts for incoming communication session requests), or the user interface object 7056 (e.g., to prioritize alerts for notifications), based on the user’s preference.

In some embodiments, the user interface object 7064 has an appearance that includes an indication of an application associated with the request for the computer system 7100 to join the communication session (e.g., the user interface object 7064 appears as the application icon for an application associated with the communication session). In some such embodiments, the user interface object 7064 optionally includes different indications for different types of communication sessions (e.g., a phone call, a video call, and/or a shared virtual experience). In some embodiments, the user interface object 7064 has an appearance that indicates a user associated with the request (e.g., the user that initiated the request) for the computer system 7100 to join the communication session (e.g., as a name, initials, a username, an avatar, a photograph, and/or the like of the initiating user).

In some embodiments, in accordance with a determination that a request for the computer system 7100 to join a communication session satisfies timing criteria, the user interface object 7064 has a different color (e.g., is green, or another color) than when the request to join the communication session no longer satisfies the timing criteria. In some embodiments, the user interface object 7064 has a different shape (e.g., as compared to the indicator 7010 of system function menu) in addition to, or instead of, having the different color. In some embodiments, in accordance with a determination that a request for the computer system 7100 to join a communication session satisfies timing criteria, the user interface object 7064 displays an animation (e.g., is animated). For example, the user interface object 7064 bounces up and down, the border of the user interface object 7064 pulses, the user interface object 7064 changes in size, and/or the user interface object 7064 rotates. In some embodiments, the animation is displayed in combination with an audio output (e.g., a beep, a series of tones (e.g., that is optionally repeated), and/or a ring tone). In some embodiments, the animation is displayed without any corresponding audio output.

If the user’s attention 7116 is directed to the user interface object 7064 while a request for the computer system 7100 to join a communication session satisfies timing criteria (e.g., as indicated by timer 7066-2 (FIG. 7S), showing that the current time is before a time threshold TH1), the computer system 7100 displays an incoming call user interface 7068 for joining the communication session, as shown in FIG. 7S. The user interface 7068 includes an affordance for joining the communication session (e.g., as shown by the “Join” affordance in the user interface 7068), and optionally also includes an indication of a user (e.g., a name and avatar of user “John Smith”) associated with the request for the computer system 7100 to join the communication session, and/or additional information regarding the communication session (e.g., the type of communication session, a listing of one or more other users active in the communication session, and/or contact information associated with the one or more other users active in the communication session).

In some embodiments, the user interface 7068 is displayed within a threshold distance (e.g., 0.5 cm, 1 cm, 2 cm, or 5 cm) of the user interface object 7064. In some embodiments, the user interface 7068 is displayed with a respective spatial relationship to (e.g., directly below, directly above, to the right of, to the left of, or other required spatial relationships) the user interface object 7064. In some embodiments, the user interface 7068 is displayed over at least a portion of other visible user interfaces in a respective view of the three-dimensional environment (e.g., as shown in FIG. 7S, where the user interface 7068 is displayed over a portion of the user interface 7058).

The dashed outline of user interface object 7064 in FIG. 7S indicates that, in some embodiments, user interface object 7064 remains displayed while user interface 7068 is displayed, whereas in some embodiments, user interface object 7064 is visually deemphasized (e.g., faded, grayed out, blurred, and/or scaled down) or ceases to be displayed while user interface 7068 is displayed. Similarly, the dashed outline of the system function menu 7024 in FIG. 7S illustrates that, in some embodiments, the system function menu 7024 is displayed concurrently with the user interface 7068 and optionally with the user interface object 7064 in response to detecting the first gaze input directed to the user interface object 7064 (e.g., optionally, the system function menu 7024 is invoked using an input directed to the system control indicator whether it has the appearance of indicator 7010 of system function menu, as described above with reference to FIGS. 7A-7K, or the appearance of user interface object 7064). In some such embodiments, the user interface 7068 is displayed within a threshold distance (e.g., 0.5 cm, 1 cm, 2 cm, or 5 cm) of the system function menu 7024 (e.g., instead of within a threshold distance of the user interface object 7064, or in addition to being displayed within a greater threshold distance (e.g., relative to embodiments in which the system function menu 7024 is not displayed) of the user interface object 7064). In some such embodiments, the user interface 7068 is optionally displayed with a respective spatial relationship to (e.g., directly below, directly above, to the right of, or to the left of) the system function menu 7024 and/or the user interface object 7064. In other embodiments, the user interface 7068 is displayed without displaying the system function menu 7024. In some embodiments, in response to the user 7002 gazing at the user interface object 7064, the computer system 7100 initially displays the user interface 7068 without displaying the system function menu 7024. After displaying the user interface 7068, and in response to detecting that the user’s attention 7116 continues to be directed to the user interface object 7064 (e.g., for a threshold amount of time (e.g., 0.1, 0.2, 0.5, 1, 2, 5, 10, 30, or 60 seconds)), the computer system 7100 displays system function menu 7024 as well (e.g., in addition to and concurrently with the user interface 7068). In some such embodiments, the threshold distance and/or the respective spatial relationship of the user interface 7068 to the user interface object 7064 changes (e.g., as the system function menu 7024 is added, the placement of the user interface 7068 is updated to accommodate any threshold distance and/or the spatial relationship requirements of the system function menu 7024 relative to the user interface object 7064 and/or relative to the user interface 7068).

In some embodiments, displaying the user interface 7068 includes displaying an animated transition (e.g., of the user interface 7068 appearing). For example, the animated transition may include an animation of the user interface 7068 expanding downward from the user interface object 7064. Alternately, or in addition, the animated transition may include an animation of the user interface 7068 gradually getting bigger and/or fading into view. In some embodiments, the animated transition depends on a position of the user interface object 7064. For example, if the user interface object 7064 is instead displayed near the left edge of the display generation component, the animated transition optionally includes an animation of the user interface 7068 expanding outward from the user interface object 7064 towards the right edge of the display generation component.

In some embodiments, the user interface object 7064, the system function menu 7024, and/or the user interface 7068 follow the viewpoint of the user 7002 as the viewpoint of the user 7002 moves (e.g., one or more are viewpoint-locked). In some embodiments, the follow behavior of the user interface object 7064, the system function menu 7024, and/or the user interface 7068 is lazy follow behavior. In some embodiments, the user interface object 7064, the system function menu 7024, and/or the user interface 7068 exhibit distinctive follow (e.g., lazy follow) behavior from each other (e.g., follow a viewpoint of the user more or less closely than another user interface element).

In some embodiments, after displaying the user interface 7068, the computer system 7100 ceases to display the user interface 7068 in response to the user 7002 dismissing user interface 7068 (e.g., by no longer gazing at the user interface object 7064 or the user interface 7068) or after displaying the user interface 7068 for a threshold amount of time. After the user interface 7068 ceases to be displayed, the user interface object 7064 optionally returns to a default appearance (e.g., the appearance of the indicator 7010 of system function menu), indicating that the user has viewed the request to join the communication session (e.g., FIG. 7V illustrates an example transition from FIG. 7S). In some embodiments, if the user interface object 7064 was displayed with an appearance that indicates a user (e.g., the user that initiated the request) associated with the request for the computer system 7100 to join the communication session (before the attention 7116 is directed to the user interface object 7064), when the computer system 7100 ceases to display the user interface 7068, the default appearance of the user interface object 7064 does not indicate the user associated with the request (e.g., user interface object 7064 reverting to a default appearance includes user interface object 7064 ceasing to indicate a user who initiated the communication session request). In some embodiments, as long as the request to join the communication session satisfies the timing criteria, the user can redisplay the user interface 7068 by redirecting the user’s attention 7116 to the user interface object 7064.

In some embodiments, if the user’s attention 7116 is not directed to the user interface object 7064 before the request for the computer system 7100 to join the communication session expires (e.g., before the initiating user cancels the communication session request) and/or no longer satisfies the timing criteria (e.g., more than a threshold amount of time TH1 has elapsed since the request was first received), the computer system 7100 forgoes displaying the user interface 7068 for joining the communication session (e.g., even in response to the user’s attention 7116 being directed to the user interface object 7064). As shown in FIG. 7T, an example transition from FIG. 7R in response to detecting the user’s attention 7116 directed to the user interface object 7064 at a time after a threshold amount of time TH1 has elapsed since first receiving the communication session request, as indicated by timer 7066-3 showing that the current time is after the threshold time TH1 (e.g., and before a second threshold amount of time TH2 has elapsed since the communication session request expired), the computer system 7100 displays a missed call user interface 7070 for initiating a communication session (e.g., for calling back a user associated with the initial request for the computer system 7100 to join the communication session). In some embodiments, the user interface 7070 is displayed in accordance with a determination that the user’s attention 7116 is directed to the user interface object 7064 within a threshold amount of time (e.g., 5 seconds, 10 seconds, 20 seconds, 30 seconds, 60 seconds, or any threshold time between 0 and 60 seconds) of receiving the request for the computer system 7100 to join the communication session (e.g., threshold TH2), yet after a different threshold amount of time (e.g., threshold TH1) during which the incoming call can be answered (e.g., which would result in incoming call user interface 7068 being displayed as shown in FIG. 7S). In some embodiments, if the user’s attention 7116 is not directed to the user interface object 7064 within the threshold amount of time (e.g., threshold TH2), then the user interface 7070 is not displayed, even if the user subsequently directs the user’s attention 7116 to the user interface object 7064. One of ordinary skill in the art will readily appreciate that the time thresholds may be defined in multiple ways such that prompt interaction with the user interface object 7064 results in display of the incoming call user interface 7068, whereas delayed interaction with the user interface object 7064 results in display of the missed call user interface 7070 (e.g., such as with both time thresholds being measured relative to a time corresponding to receipt of the communication session request, with the time threshold TH2 occurring after the time threshold TH1, or having the time threshold TH2 be measured relative to a time the communication session request became inactive (e.g., due to reaching the time threshold TH1 or due to the requesting user cancelling the request)), and optionally, as described in further detail herein, even more delayed interaction with the user interface object 7064 after it has reverted to the default appearance of indicator 7010 of system function menu results in display of system function menu 7024 without an incoming, missed, or ongoing call user interface.

For example, if the communication session request for the computer system 7100 lasts for 1 minute, and the user’s attention 7116 is directed to the user interface object 7064 within that 1 minute, then the computer system 7100 displays the user interface 7068 for joining the communication session (e.g., as shown in FIG. 7S). If the user’s attention 7116 is not directed to the user interface object 7064 within that 1 minute, the request expires (e.g., times out automatically, not necessarily due to the initiating user canceling the request). If, however, the user’s attention 7116 is directed to the user interface object 7064 within 30 seconds of the request expiring, then computer system 7100 displays the user interface 7070 for initiating a second communication session (e.g., to call back the user whose earlier request to join a communication session was missed). If the user does not direct the user’s attention 7116 to the user interface object 7064 within 30 seconds of the initial request expiring (e.g., more than 1 minute and 30 seconds of total time have passed since the initial request was received), the computer system 7100 does not display the user interface 7070 (e.g., even if the user’s attention 7116 is directed to the user interface object 7064), and instead, if the user’s attention 7116 is directed to the user interface object 7064, displays the system function menu 7024 in response (without displaying the user interface 7068 nor the user interface 7070).

In the example shown in FIG. 7T, the user interface 7070 includes an “Invite” affordance (e.g., for calling back the user that sent the initial communication session request and optionally inviting one or more other users to join the new communication session) and an indication (e.g., the text “Missed Video Call”) that the request for the computer system 7100 to join the communication session was not viewed in time (e.g., within a threshold amount of time TH1 since receiving the request). In some embodiments, the user interface 7070 also includes an indication of the user (e.g., the name and avatar of user “John Smith”) associated with the missed request for the computer system 7100 to join the communication session, and/or additional information regarding the missed request (e.g., the type of communication session, and/or contact information associated with one or more other users associated with the communication session for the missed request). In some embodiments, the user interface 7070 is concurrently displayed with the system function menu 7024 (e.g., as shown in FIG. 7T), and/or with the user interface object 7064. In some embodiments, the display characteristics (e.g., displayed location, spatial relationships to other user interface elements, displayed animation(s), and/or follow behavior) of the user interface 7070 are analogous to those of the user interface 7068 described above.

FIG. 7U illustrates an example transition from FIG. 7S. As shown in FIG. 7U, if the user activates the “Join” affordance in the user interface 7068 (FIG. 7S), the computer system 7100 displays a call control user interface 7072. In some embodiments, if the user activates the “Invite” affordance in the user interface 7070 (FIG. 7T), the computer system 7100 displays the call control user interface 7072 (e.g., even before another user joins the communication session), and optionally the user interface object 7064 has the color associated with an active communication session request that satisfies timing criteria (e.g., the user interface object 7064 is green), even though the user 7002 initiated the communication session (e.g., as opposed to having received a request to join a communication session ). In some embodiments, the same call control user interface 7072 is displayed regardless of how the user 7002 joins a communication session (e.g., either by joining via a request from another user, or by initiating a communication session).

FIG. 7U also illustrates an example transition from FIG. 7T. In some embodiments, if the user 7002 of the computer system 7100 initiates the communication session (e.g., by activating the “Invite” affordance of the user interface 7070 as shown in FIG. 7T), and another user (e.g., another user that received a request to join the communication session when the “Invite” affordance was activated, such as the user whose call was missed (FIG. 7T)) joins the communication session, the computer system 7100 displays a visual representation of the other user (e.g., an avatar, a profile picture). In some embodiments, the displaying of the visual representation of the other user includes displaying an animated transition (e.g., the visual representation fades into view, and/or the visual representation appears to expand out from the user interface object 7064, from the user interface 7070, or from another displayed user interface element).

The call control user interface 7072 includes a plurality of affordances for accessing functions of the active communication session. For example, the call control user interface 7072 includes any combination of the following: a messaging affordance (e.g., for launching a separate application (e.g., a text messaging application) for communicating with one or more other users in the communication session and/or viewing previous communications (e.g., conversation transcripts) with one or more other users in the communication session; an information affordance for displaying additional information about the communication session (e.g., a list of users in the communication session, and/or an indication of the duration of the communication session); a microphone affordance (e.g., for muting or unmuting the user 7002 in the communication session); a session history affordance (e.g., for displaying shared content that was previously shared between one or more users in the communication session); a sharing affordance (e.g., for sharing content with other users in the communication session and/or displaying one or more shared content items that were previously shared (e.g., with the other users in the communication session)); and/or an exit affordance (e.g., labeled “Leave,” for removing the user from the communication session and/or for ending the communication session for all users).

In some embodiments, the call control user interface 7072 is concurrently displayed with the system function menu 7024, and/or with the user interface object 7064 (e.g., as shown in FIG. 7U). In some such embodiments, when the user’s attention 7116 is directed to the call control user interface 7072, the system function menu 7024 (and/or the user interface object 7064) is/are optionally visually deemphasized (e.g., blurred out or faded), while the call control user interface 7072 is displayed with default visual emphasis. When the user’s attention 7116 is directed to the system function menu 7024 (or the user interface object 7064), the call control user interface 7072 is optionally visually deemphasized (e.g., blurred out or faded), whereas the system function menu 7024 (or the user interface object 7064) is displayed with the default visual emphasis.

In some embodiments, the display characteristics (e.g., displayed location, spatial relationships to other user interface elements, displayed animation(s), and/or follow or lazy follow behavior), of the call control interface 7072 are analogous to those of the user interface 7068 and/or the user interface 7070 described above.

In some embodiments, the call control user interface 7072 includes an affordance for switching between different representations of one or more users in the communication session (e.g., a profile picture, a two-dimensional image of the user, the user’s name, and/or the user’s initials). In some embodiments, the affordance is used to switch between displaying a realistic likeness of the user (e.g., which may be two- or three-dimensional, including for example an image of the user, a video or video stream of the user, and/or an avatar that looks like the user’s and/or is animated based on the user’s movements) and an abstract likeness or abstract representation of the user (e.g., the user’s name, the user’s initials, and/or an image that is not based on the user’s likeness). For example, if a respective user’s avatar is displayed when the affordance for switching between the realistic likeness and abstract likeness is activated, the respective user’s avatar is replaced by the abstract likeness. If the abstract likeness is displayed when the affordance for switching between the realistic likeness and abstract likeness is activated, the abstract likeness is replaced by the respective user’s avatar. In some embodiments, the call control user interface 7072 includes an affordance for switching between different visual representations of one or more users in the communication session (e.g., switching between one or more of an avatar, a three-dimensional character, an icon, a profile picture, a user’s name, and a user’s initials).

In some embodiments, the computer system 7100 ceases to display the call control user interface 7072 when (e.g., in response to detecting that) the user’s attention 7116 is no longer directed to the user interface object 7064 (or the call control user interface 7072). In some embodiments, the call control user interface 7072 remains displayed for a respective period of time (e.g., 1 second, 5 seconds, or a time period accounting for lazy follow behavior) even after the user’s attention 7116 is no longer directed to the user interface object 7064 (or the call control user interface 7072), and remains displayed if the user’s attention 7116 is subsequently directed back to the user interface object 7064 (or the call control user interface 7072) (e.g., the respective time period is restarted when the user’s attention 7116 returns to the user interface object 7064 before the expiration of the respective time period. In some such embodiments, the call control user interface 7072 ceases to be displayed if the computer system 7100 detects that the user’s attention 7116 is no longer directed to the user interface object 7064 (or the call control user interface 7072), and has not returned to the user interface object 7064 (or the user interface 7072) within the respective period of time, and the user interface object 7064 remains displayed, or is redisplayed if the user interface object 7064 was not displayed when the computer system 7100 ceased to display the call control user interface 7072 (e.g., so that the call control user interface 7072 can be redisplayed when the user’s attention 7116 is subsequently directed to the user interface object 7072). In some embodiments, after the call control user interface 7072 ceases to be displayed, if the user’s attention 7116 subsequently is directed to the user interface object 7064 while the computer system 7100 is still in the communication session, the computer system 7100 redisplays the call control user interface 7072 in response. While this behavior is described above with reference to the call control user interface 7072, this behavior optionally also pertains to the user interface 7068 and/or user interface 7070, which may be displayed concurrently with, or instead of, the call control user interface 7072.

In some embodiments, the user interface object 7064, system function menu 7024, the incoming call user interface 7068, the missed call user interface 7070, and/or the call control user interface 7072 are head-locked virtual objects (e.g., viewpoint-locked virtual objects as described herein). In some embodiments, when the viewpoint of the user changes (e.g., the user turns and/or moves to a new position in the three-dimensional environment, such that the view of the three-dimensional environment changes), the user interface object 7064 moves in tandem with the system function menu 7024, the incoming call user interface 7068, the missed call user interface 7070, and/or the call control user interface 7072, if displayed (e.g., such that the system function menu 7024, the incoming call user interface 7068, the missed call user interface 7070, and/or the call control user interface, if displayed, maintain respective required spatial relationships with the user interface object 7064, as described herein). In some embodiments, the system function menu 7024, the incoming call user interface 7068, the missed call user interface 7070, and/or the call control user interface 7072 move in tandem with each other (e.g., if the system function menu 7024 and the call control user interface 7072 are concurrently displayed, the system function menu 7024 moves in tandem with the call control user interface 7072, such that the call control user interface 7072 maintains a respective spatial relationship with the system function menu 7024 (e.g., in an analogous manner to maintaining a respective spatial relationship with the user interface object 7064)).

In some embodiments, after the request for the computer system 7100 to join the communication session no longer satisfies the timing criteria (e.g., the request to join the communication session expires or times out), the user interface object 7064 returns to a default appearance (e.g., as shown by the indicator 7010 of system function menu in FIGS. 7V and 7W). For example, FIGS. 7V and 7W show system control indicator appearing as indicator 7010 of system function menu, after expiration of the communication session request of FIG. 7R (e.g., FIG. 7V illustrates an example transition from FIG. 7R). In some embodiments, the system control indicator appears as indicator 7010 of system function menu after both the threshold amount of time TH1 has first elapsed (e.g., a time period in which interaction with the system control indicator would result in display of the incoming call user 7068 of FIG. 7S) and then the threshold amount of time TH2 has elapsed (e.g., a time period in which interaction with the system control indicator would result in display of the missed call user interface 7070 of FIG. 7T) (e.g., a total amount of time TH1+TH2 has elapsed since the communication session request was first received). In some embodiments, the user interface object 7056 returns to the default appearance (e.g., appears instead as the indicator 7010 of system function menu in FIGS. 7V and 7W) after the computer system 7100 leaves a communication session (e.g., leaves a communication session that was joined via the “Join” affordance of incoming call user interface 7068 in FIG. 7S and optionally during which the call control user interface 7072 of FIG. 7U was displayed). As shown in FIGS. 7V and 7W, if the user’s attention 7116 is directed to the indicator 7010 of system function menu (e.g., after the expiration of both the time period for invoking the incoming call user interface and the time period for invoking the missed call user interface), the computer system 7100 displays the system function menu 7024 (e.g., the computer system 7100 behaves as described above with reference to FIGS. 7A-7K), and does not display the user interface 7068, nor the user interface 7070, nor the call control user interface 7072) because there are no pending requests to join a communication session and because the computer system 7100 is not in an active communication session.

In some embodiments, the computer system 7100 switches between display of the user interface 7068, the system function menu 7024, and optionally, one or more additional user interface elements (e.g., the notification content 7060 described above with reference to FIGS. 7L-7Q, if both a request to join a communication session satisfies first timing criteria, and a first event for a first notification satisfies second timing criteria), for example in response to successive gaze inputs directed to the system control indicator. One of ordinary skill will readily appreciate that the descriptions below, which are made with reference to the incoming call user interface 7068, apply analogously to the missed call user interface 7070 (e.g., if the user has missed a request to join the communication session yet is still within a time period TH2 as described with reference to FIG. 7T, while the first event for the first notification satisfies second timing criteria as described herein with reference to FIGS. 7L-7Q), and/or the call control user interface 7072 (e.g., if the user joins the communication session while the first event for the first notification satisfies the second timing criteria).

In an example scenario in which both a request to join a communication session satisfies first timing criteria (e.g., was received less than a time TH1 ago, as described herein with reference to FIG. 7S), and a first event for a first notification satisfies second timing criteria, in response to detecting a first gaze input directed to the system control indicator, the computer system 7100 displays the user interface 7068 (e.g., as described herein with reference to FIGS. 7R-7S) (e.g., without displaying the notification content 7060 or the system function menu 7024). As described herein with reference to FIG. 7R, the system control indicator may have an appearance that indicates an incoming call or alternatively an application associated with the first notification, based on relative priorities of the alerts and/or on user preference. After displaying the user interface 7068, the user gazes away from (e.g., directs the user’s attention away from) the system control indicator (and optionally, the system control indicator ceases to be displayed). After gazing away from the system control indicator, the user’s gaze returns to the system control indicator, and in response, the computer system 7100 displays the notification content 7060 (e.g., without displaying the user interface 7068 or the system function menu 7024). After displaying the notification content 7060, the user gazes away from the system control indicator (and optionally, the notification content 7060 ceases to be displayed). After gazing away from the system control indicator, the user’s gaze returns to the system control indicator, and in response, the computer system 7100 displays the system function menu 7024 (e.g., without displaying the notification content 7060 or the user interface 7068). This marks the end of one cycle of the user interface elements (e.g., beginning with the user interface 7068 and ending with the system function menu 7024). If the user repeats this process (e.g., looks away from the system control indicator, then looks back at the system control indicator), the computer system 7100 starts a new cycle, displaying the user interface elements in the same order (e.g., the user interface 7068, then the notification content 7060, and then the system function menu 7024, in response to successive gaze inputs). This allows the user to switch between displaying the user interface 7068, the notification content 7060, and the system function menu 7024 without cluttering the displayed user interface (e.g., occupying too much of the user’s field of view with concurrent display of multiple user interface elements such as the notification content 7060 and the system function menu 7024).

In some embodiments, the computer system 7100 switches between display of the user interface 7068 and another request to join a communication session (e.g., a second request to join a second communication session that also satisfies the timing criteria). In some such embodiments, the computer 7100 optionally switches between display of the user interface 7068, and a second user interface for joining the second communication session (e.g., an analogous but distinct user interface that includes a representation of a different user who initiated the request for the second communication session), and the system function menu 7024 (e.g., the displayed user interface element may change each time the user looks away from, then back at, the user interface object 7064).

FIG. 7X illustrates example timing for persistence of a request to join a communication session (e.g., how long a request is active before timing out), based on the type of communication session, in accordance with some embodiments. FIG. 7X further illustrates concepts described above with reference to FIGS. 7A-7W, particularly FIGS. 7R-7W. In FIG. 7X, the horizontal axis is a time axis, with time progressing from left to right.

For telephone communication sessions (e.g., telephone calls), in step 7074, the computer system 7100 (e.g., initially) detects an incoming request to join the telephone communication session. Before a first time threshold TH_{C1} since first receiving the telephone communication session request (e.g., while a request to join a telephone call is ringing), the request to join the telephone communication session satisfies timing criteria. As shown in step 7076, in response to detecting the incoming request to join the telephone communication session, the computer system 7100 displays a request to join the telephone communication session (e.g., incoming call user interface 7068 (FIG. 7S)). In some embodiments, the request to join the telephone communication session is displayed (and optionally remains displayed) while the current time is before TH_{C1}, regardless of whether the user’s gaze is directed to the user interface object 7064 (FIG. 7R) (or more generally, the system control indicator) or not (e.g., the incoming call user interface 7068 of FIG. 7S would also be displayed in the scenario illustrated in FIG. 7R, even though in FIG. 7R, user 7002′s gaze is not directed to the user interface object 7064).

After time TH_{C1}, the request to join the telephone communication session no longer meets the timing criteria (e.g., the request has timed out). At step 7078, the current time is after TH_{C1}, but is before a second time threshold TH_{C2}. If the user gazes at the user interface object 7064 between time threshold TH_{C1} and time threshold TH_{C2}, as in step 7078, the computer system 7100 displays in response a missed call user interface (e.g., the user interface 7070 (FIG. 7T)) that indicates a missed request to join the telephone communication session and includes an affordance for initiating a second communication session (e.g., a new communication session), as in step 7080.

If the user gazes at the user interface object 7064 as in step 7082, because the current time is after both TH_{C1} and TH_{C2}, the request to join the telephone communication session does not satisfy the timing criteria (e.g., the amount of time since receiving the request is not less than TH_{C1}), and the gaze input is not detected within the threshold amount of time since receiving the request (e.g., the amount of time since receiving the request is not less than TH_{C2}). Thus, in response to detecting the gaze input of step 7082, and as shown in step 7084, the computer system 7100 does not display an incoming call user interface nor a missed call user interface, and instead displays the system function menu 7024 (e.g., that includes a plurality of affordances for performing system operations associated with the computer system 7100, as described herein for example with reference to FIGS. 7V-7W).

For video communication sessions (e.g., video calls), in step 7086, the computer system 7100 (e.g., initially) detects an incoming request to join the video communication session. Before a first time threshold TH_{V1} since first receiving the video communication session request (e.g., while a request to join a video call is ringing), the request to join the video communication session satisfies timing criteria. If, as shown in step 7088, the user’s gaze is directed to the user interface object 7064 before time threshold TH_{V1}, then, in response to detecting the user’s gaze directed to the user interface object 7064 (e.g., and because the current time is before TH_{V1}), the computer system 7100 displays an incoming call user interface (e.g., the user interface 7068 (FIG. 7S)) that includes an affordance for joining the video communication session, as in step 7090.

After time TH_{V1}, the request to join the video communication session no longer meets the timing criteria (e.g., the request has timed out). At step 7092, the current time is after TH_{V1}, but is before a second time threshold TH_{V2}. If the user gazes at the user interface object 7064 between time threshold TH_{V1} and time threshold TH_{V2}, as in step 7092, the computer system 7100 displays in response a missed call user interface (e.g., the user interface 7070 (FIG. 7T)) that indicates a missed request to join the video communication session and includes an affordance for initiating a second communication session (e.g., a new communication session), as in step 7094.

If the user gazes at the user interface object 7064 as in step 7096, because the current time is after both TH_{V1} and TH_{V2}, the request to join the video communication session does not satisfy the timing criteria (e.g., the amount of time since receiving the request is not less than TH_{V1}), and the gaze input is not detected within the threshold amount of time since receiving the request (e.g., the amount of time since receiving the request is not less than TH_{V2}). Thus, in response to detecting the gaze input of step 7096, and as shown in step 7098, the computer system 7100 does not display an incoming call user interface nor a missed call user interface, and instead displays the system function menu 7024. As used herein, “video communication session” or “video call” refers to videotelephony protocols or to telephony protocols for which video is supported yet can be enabled or disabled by the user (e.g., within the same telephony service, the user may choose between videotelephony and audio-only telephony, or turn off their own and/or another user’s video). As used herein, “telephone communication session” or “telephone call” refers to audio-only telephony (e.g., including some cellular and Internet telephony) for which video is not supported. One of ordinary skill will readily appreciate that audio-only calls over videotelephony protocols may instead be considered “telephone calls” rather than “video calls.”

For extended reality (XR) communication sessions, in step 7102, the computer system 7100 detects an incoming request to join the XR communication session. Before a time threshold THx since first receiving the XR communication session request (e.g., while the requesting user keeps the invitation to join the XR communication session open), the request to join the XR communication session satisfies timing criteria. If, as shown in step 7104, the user’s gaze is directed to the system control indicator (e.g., the user interface object 7064 (FIG. 7R)) before time threshold THx, then, in response to detecting the user’s gaze directed to the user interface object 7064 (e.g., and because the current time is before THx), the computer system 7100 displays an incoming call user interface (e.g., the user interface 7068 (FIG. 7S)) that includes an affordance for joining the XR communication session, as in step 7106.

After time THx, the request to join the XR communication session no longer meets the timing criteria (e.g., the request has timed out). If the user gazes at the user interface object 7064 after time threshold THx, as in step 7108, the computer system 7100 displays the system function menu 7024, as in step 7110. In the example shown in FIG. 7X, XR communication session requests are associated with a single time threshold THₓ, before which an incoming call user interface is displayed, and after which the system function menu 7024, not a missed call user interface, is displayed. In some embodiments, there is a period of time, after the time threshold THx and before a second time threshold, during which the computer system displays a missed call user interface for the XR communication session request (e.g., the user interface 7070 (FIG. 7T)) in response to a gaze input at the user interface object 7064, in an analogous fashion to steps 7078-7080 described above with reference to telephone calls, and steps 7092-7094 described above with reference to video calls.

In some embodiments, video communication requests are more persistent than telephone communication requests, in that an incoming video call rings longer than an incoming phone call. This is shown visually in FIG. 7X by TH_{V1} being further along the time axis than TH_{C1} (e.g., TH_{V1} is after (to the right of) THC1). In some embodiments, requests to join XR communication sessions stay active as long as the requesting user keeps the invitation open (e.g., the request does not automatically time out, but must be manually cancelled by the requesting user). Accordingly, FIG. 7X illustrates example scenarios in which an XR communication session request is more persistent than the requests to join telephone or video communication sessions, in that the time threshold THx is the furthest along the time axis (e.g., THx is after (to the right of) both TH_{C1} and TH_{V1}), as a result of the requesting user keeping the XR communication session request pending past the time out thresholds for phone and video calls. One of ordinary skill will readily appreciate that the time threshold THx may be variable (e.g., earlier than the time threshold TH_{C1} and/or TH_{V1}) based on when a requesting user decides to cancel the XR communication session request, and that other embodiments are possible in which XR communication session requests time out automatically (e.g., similar to phone and video calls), before or after the time threshold TH_{C1} and/or the time threshold TH_{V1}. In some embodiments, a request to join a telephone communication session is the least persistent (e.g., as indicated in FIG. 7X, TH_{C1} is the lowest/earliest (leftmost) time threshold) yet the most prominently displayed (e.g., in that the request to join the telephone communication session is displayed regardless of whether the user’s gaze is directed towards the system control indicator or not).

Additional descriptions regarding FIGS. 7R-7X are provided below in reference to method 10000 described with respect to FIGS. 7R-7X, among other Figures and methods described herein.

FIG. 7Y-7AF illustrate examples of initiating display of an environment-locked user interface from a head-locked user interface. FIGS. 11A-11B are flow diagrams of an exemplary method 11000 for initiating display of an environment-locked user interface from a head-locked user interface. The user interfaces in FIG. 7Y-7AF are used to illustrate the processes described below, including the processes in FIGS. 11A-11B. For ease of discussion, FIG. 7Y-7AF illustrate user interaction with specific affordances that initiate display of specific user interfaces, but the descriptions below are generally applicable to any suitable affordance (e.g., which, when selected, initiates display of a respective user interface), in accordance with some embodiments.

FIG. 7Y illustrates the physical environment 7000 that includes the user 7002 interacting with the computer system 7100. The user 7002 is located at a location 7026-c in the physical environment 7000.

In some embodiments (e.g., as described above with reference to FIG. 7B), the indicator 7010 of system function menu is displayed at a periphery region of the top center of the display of the computer system 7100. In some embodiments, (e.g., as in FIG. 7Y), the indicator 7010 of system function menu is displayed at a periphery region of a top right corner of the display of the computer system 7100 (e.g., at a periphery region of both the top edge and the right edge of the computer system 7100). It will be understood that, in some embodiments, the indicator 7010 of system function menu is displayed at an alternative periphery region of the display of the computer system 7100.

In FIG. 7Z, the user’s attention 7116, is directed to the indicator 7010 of system function menu. In some embodiments, if the user attention 7116 satisfies attention criteria (e.g., the user 7002′s attention is continuously directed to the indicator 7010 of system function menu for a threshold amount of time, or the user 7002′s attention is directed to the indicator 7010 of system function menu while the user 7002 performs a required gesture (e.g., bringing a hand into a specified configuration, or performing an air gesture such as an air tap or an air pinch)), the computer system 7100 displays the system function menu 7024. While some features of the system function menu 7024 are different (e.g., the system function menu 7024 has a different appearance, a different set of affordances, and a different location in FIG. 7Z, as compared to FIGS. 7H-7W), other previously described features of the system function menu 7024 (e.g., features described above with reference to FIGS. 7A-7X) remain applicable to the system function menu 7024.

In some embodiments, the system function menu 7024 includes a plurality of affordances for accessing system functions of the computer system 7100. For example, as shown in FIG. 7Z, the system function menu 7024 includes the home affordance 7124 (e.g., for accessing one or more applications of the computer system 7100, for initiating a communication session with one or more contacts stored in memory of the computer system 7100, and/or for initiating display of a virtual environment), along with the search affordance 7042, the volume affordance 7038, the notification affordance 7044, the control affordance 7046, and the virtual assistant affordance 7048 (e.g., which correspond to affordances of the exemplary system function menu described with reference to FIG. 7E above). In some embodiments, the system function menu 7024 includes different affordances from what is shown in FIG. 7AC (e.g., additional affordances, fewer affordances (e.g., as in the system function menu of FIG. 7E), and/or with some affordances replaced with other affordances associated with different functions of the computer system 7100).

In FIG. 7AA, the user’s attention 7116, is directed to the control affordance 7046. In response to detecting that the user’s attention 7116 satisfies selection criteria (e.g., optionally the same as, or different from, the attention criteria described above for displaying the system function menu 7024), the computer system 7100 displays a user interface 7136 (e.g., concurrently with the system function menu 7024) associated with the control affordance 7046 (e.g., user interface 7136 is a controls user interface). In some embodiments, the user interface 7136 includes affordances 7138, 7140, 7142, and 7144, for interacting with the user interface 7136, and/or accessing or adjusting settings of the user interface 7136 (e.g., a position, a brightness or other display characteristic, and/or content of the user interface 7136) and/or of the computer system 7100 (e.g., accessing additional system settings of the computer system 7100 that are not included in the system function menu 7024), and/or for displaying other user interfaces (e.g., additional content associated with the user interface 7136, an application user interface, and/or a user interface for adjusting a setting of the computer system 7100).

In some embodiments, user selection of a respective one of the affordances displayed in the system function menu 7024 (e.g., the home affordance 7124, the search affordance 7042, the volume affordance 7038, the notification affordance 7044, the control affordance 7046, the virtual assistant affordance 7048 and/or any other affordance) causes the computer system 101 to display a corresponding user interface for the selected affordance. For example, the user interface 7136 is a home user interface (e.g., as described in greater detail below, with reference to FIG. 7AD) that is displayed in response to detecting user selection of the home affordance 7124.

In some embodiments, the user interface 7136 is a search user interface for performing a search operation (e.g., if the user’s attention is directed to the search affordance 7042, rather than the control affordance 7046). In some embodiments, the user interface 7136 includes a search bar that provides visual feedback regarding the search term. In some embodiments, the user 7002 inputs a search term with a verbal input (e.g., and at least one input device of the one or more input devices of the computer system 7100 is a microphone configured to detect verbal inputs). In some embodiments, the user 7002 enters the search term by gazing at the search bar displayed in the user interface 7136 (e.g., the computer system 7100 detects the user’s attention directed to the search bar, and determines that the user 7002 intends to perform a search function), and/or performs a verbal input (e.g., speaking aloud the desired search term). In some embodiments, the search bar updates in real time, as the user performs the verbal input (e.g., each spoken word of the search term is displayed in the search bar as the user finishes speaking the word).

In some embodiments, the user interface 7136 includes a virtual keyboard (e.g., optionally in addition to the search bar), and the user 7002 manually inputs a search term, in the search bar, using the virtual keyboard. In some embodiments, the user 7002 enters the search term either through a verbal input, or through the virtual keyboard. In some embodiments, the user 7002 enters the search term through a combination of input devices (e.g., the user begins entering the search term through a verbal input, and edits and/or completes the search term through the virtual keyboard, or vice-versa).

In some embodiments, the user interface 7136 is a user interface for adjusting a volume setting of the computer system 7100 (e.g., in response to detecting that the user’s gaze is directed to the volume affordance 7038, rather than the control affordance 7046). In some embodiments, the user interface 7136 includes one or more controls (e.g., a volume slider, a dial, and/or one or more buttons) for adjusting volume settings of the computer system 7100.

In some embodiments, the user interface 7136 is a notification user interface for displaying content from one or more notifications received by the computer system 7100 (e.g., in response to detecting that the user’s attention is directed to the notification affordance 7044, rather than the control affordance 7046).

In some embodiments, the user interface 7136 is a system user interface for accessing additional system settings of the computer system 7100 that are not included in the system function menu 7024. For example, the affordances 7138, 7140, 7142, and/or 7144 of the user interface 7136 allow the user to access and/or adjust different settings for the computer system 7100 (e.g., optionally corresponding to settings that are not accessible or adjustable directly from the system function menu 7024).

In FIG. 7AB, the user’s attention 7116, is directed to the affordance 7142 of the user interface 7136. In some embodiments, in response to detecting that the user is interacting with a user interface element other than a user interface element displayed in the system function menu 7024, and/or that the user’s attention is no longer directed to the indicator 7010 of system function menu or the system function menu 7024, the computer system 7100 ceases to display the system function menu 7024. In some embodiments, the system function menu 7024 remains displayed, but with a reduced prominence (e.g., is partially blurred, dimmed, or otherwise visually deemphasized) to reflect that the user’s attention (e.g., based on gaze) is not directed to the system function menu 7024, and to reduce the risk of the system function menu 7024 interfering with visibility as the user interacts with other user interface elements that are displayed outside of the system function menu 7024. In some embodiments, as illustrated by FIG. 7AC, in response to detecting that the user’s attention 7116, has returned to the indicator 7010 of system function menu, the computer system 7100 redisplays the system function menu 7024.

In FIG. 7AD, the user 7002 moves to a new location 7026-d in the physical environment 7000. In some embodiments, after moving to the new location, a different view of the physical environment 7000 (e.g., as compared to the view of the physical environment 7000 that is visible in FIG. 7Z-7AC), is visible (e.g., via the viewport provided by the display generation component of the computer system 7100), in accordance with the movement of the user 7002 from the third location 7026-c to the new location 7026-d (e.g., such that the viewpoint of the user is updated). For example, the user 7002 has moved farther away from the physical object 7014 (e.g., and closer to the physical wall 7006 and farther from the physical wall 7004), such that, in the view of the physical environment that is visible via display generation component of the computer system 7100, the representation 7014′ of the physical object 7014 is displayed with a smaller size (e.g., as compared to the size of the representation 7014′ in FIG. 7AC) and with a different relative location compared to the user (e.g., is farther to the right in the view of the three dimensional environment that is visible in FIG. 7AD, than in the view of the three dimensional environment that is visible in FIG. 7AC). For example, representations of physical objects are displayed with respective sizes that correspond to the updated physical size of the object as perceived by the user as a physical distance between the physical object and the user changes.

In some embodiments, one or more virtual objects (e.g., that are optionally locked, or anchored, to the three-dimensional environment) are displayed with a simulated size that corresponds to a distance between where the virtual object is located in the three-dimensional environment relative to the user’s current position. For example, the virtual object 7012 and the user interface 7136 are both environment-locked (e.g., also referred to herein as anchored to a position in the three-dimensional environment), and as the user moves to the new location 7026-d, the virtual object 7012 and the user interface 7136 are displayed with a smaller size (e.g., as compared to their respective sizes in FIG. 7AC) and new locations (e.g., are farther to the right in the view of the portion of the three dimensional environment that is currently visible in FIG. 7AD than in the view of the three dimensional environment that is visible in FIG. 7AC), in the view of the three dimensional environment that is visible in FIG. 7AD to reflect an increased simulated distance and change in position between the virtual object 7012 and the user 7002.

In some embodiments, the system function menu 7024 is not environment-locked, and is instead head-locked, such that the system function menu 7024 has the same size (e.g., as compared to the size of the system function menu 7024 in FIG. 7AC) and is at the same location even as the user changes a physical location in the physical enbvironment 7000. In some embodiments, the system function menu 7024 has the same size and is at the same location regardless of the physical location of the user 7002 (e.g., the user can move to any location in the physical environment 7000, and the system function menu 7024 will be displayed with the same size and location as shown in FIGS. 7AC and 7AD, or another size and/or location). A head-locked system function menu 7024 allows the user 7002 to easily interact with the system function menu 7024, regardless of the location of the user 7002, whereas, if the system function menu 7024 were instead environment-locked, the user 7002 could move to a location in the physical environment corresponding to a location where the system function menu 7024 is no longer visible (e.g., the user 7002 turns 180 degrees from the orientation shown in FIG. 7AC), or where the system function menu 7024 is so small (e.g., far away) that the user cannot feasibly interact with the system function menu elements of the system function menu 7024.

In FIG. 7AD, the user’s attention 7116, is directed to the home affordance 7124. In response to detecting that the user’s attention 7116 satisfies selection criteria (e.g., optionally the same, or different, selection criteria described above with reference to FIG. 7AA), the computer system 7100 displays a user interface 7146 (e.g., which is optionally, a home user interface) that corresponds to home affordance 7124. In some embodiments, the user interface 7146 includes affordances 7148, 7150, 7152, and 7154. In some embodiments, displaying the user interface 7146 optionally includes ceasing to display the user interface 7136 (e.g., the user interface 7146 replaces the user interface 7136), which is represented by the dashed outline of the user interface 7136 in FIG. 7AD-7AF.

In some embodiments, the affordances 7148, 7150, 7152, and 7154 correspond to respective applications of the computer system 7100 (e.g., the affordances are application icons and/or other representations of applications), and the user interacts with a respective affordance corresponding to a respective application to launch an application user interface for the respective application (e.g., by opening the application and/or displaying a new application window for the application). In some embodiments, the affordances 7148, 7150, 7152, and 7154 correspond to respective contacts for respective other users (e.g., the affordances are user avatars, contact information, telephone numbers, user IDs, or entity names), stored in the memory of the computer system 7100, and the user 7002 interacts with a respective affordance corresponding to a respective contact to initiate a communication session with the contact (e.g., another user associated with another computer system distinct from computer system 7100). In some embodiments, the affordances 7148, 7150, 7152, and 7154 correspond to respective virtual environments (e.g., different AR environments, different VR environments, different AR experiences, and/or different VR experiences), and the user 7002 interacts with a respective affordance corresponding to a respective virtual environment to initiate display of the respective virtual environment in the three-dimensional environment.

In some embodiments, the user interface 7146 includes different groups of affordances (e.g., a first group of affordances for launching application user interfaces, a second group of affordances for initiating communication session with other users, and/or a third group of affordances for initiating display of different virtual environments). In some embodiments, different groups of affordances are displayed in the user interface 7146 in different contexts (e.g., not every affordance is always displayed, and/or not every group of affordances is always displayed). In some embodiments, the user 7002 switches between different groups of affordances (e.g., by performing an air gesture (e.g., an air tap or an air pinch), by interacting with a specific affordance for switching between groups of affordances, and/or by interacting with a respective affordance for displaying a respective group of affordances). In some embodiments, the user interface 7146 includes additional affordances (e.g., in addition to, or instead of, the affordances 7148, 7150, 7152, and 7154), and the user 7002 scrolls between display of the additional affordances in the user interface 7146 (e.g., by performing an air gesture, such as an air tap or an air pinch). In some embodiments, the user 7002 performs a first type of air gesture (e.g., a tap gesture) to switch between different groups of affordances, and the user 7002 performs a second type of air gesture (e.g., a pinch and drag gesture) to scroll display of affordances (e.g., optionally within a displayed group of affordances).

In some embodiments, affordances of the user interface 7146 that are within a threshold distance from (e.g., proximate to, near, and/or next to) a specific boundary (or boundaries) of the user interface 7146 are displayed with different visual characteristics (e.g., are displayed with a degree of fading or blurring or other visual deemphasis) than affordances that are outside of the threshold distance. In some embodiments, the specific boundary (or boundaries) of the user interface 7146 near which affordances are displayed with different visual characteristics is associated with a direction in which display of the affordances of the user interface 7146 can be scrolled. For example, if the user 7002 can scroll display of the affordances of the user interface 7146 in an upward and/or downward directions, the affordances (e.g., affordances 7150 and 7154) near the lower boundary (and/or the upper boundary) of the user interface 7146 are displayed with a degree of fading or blurring. In some embodiments, the user 7002 can scroll display of the affordances of the user interface 7146 in a leftward (and/or rightward direction), and affordances (e.g., affordances 7152 and 7154) near the right boundary (and/or the left boundary) of the user interface 7146 are displayed with a degree of fading or blurring. In some embodiments, affordances that are within the threshold distance from any of a plurality of boundaries (e.g., an upper and lower boundary, a left and right boundary, an upper and right boundary, a lower and left boundary, an upper and left boundary, or a lower and right boundary, or another combination of boundaries, of the user interface 7146) are displayed with the different visual characteristics (e.g., visual deemphasis). In some embodiments, the boundary (or boundaries) are not straight edges (e.g., the user interface 7146 is circular in shape, and affordances near the outer boundary of the circle are displayed with the different visual characteristics, while affordances closer to the center of the user interface 7146 are not displayed with the different visual characteristics). In some embodiments, optionally only a portion, less than all, of an affordance that is proximate to the specific boundary of the user interface 7146 is displayed with the different visual characteristics (e.g., a lower portion of the affordances 7150 and 7154 is displayed as faded or blurred, while an upper portion of the affordances 7150 and 7154 is displayed without fading or blurring (e.g., with the same, or different, visual characteristics as the affordances 7148 and 7152).

In some embodiments, the visual characteristics of the affordances that are within the threshold distance from the specific boundary of the user interface 7146 vary in accordance with the distance from the specific boundary. For example, lower portions of affordances 7150 and 7154 (e.g., that are closest to the lower boundary of the user interface 7146) are displayed with a first degree (e.g., a high degree) of blurring or fading, upper portions of the affordances 7150 and 7154 are displayed with a second degree of blurring or fading (e.g., not blurred or faded at all), and portions of the affordances 7150 and 7154 between the lower and upper portions of the affordances 7150 and 7154 are displayed with a third degree of blurring or fading (optionally an intermediate level of blurring or fading between the first degree and the second degree) (e.g., less blurred or faded than the lower portions, but more blurred or faded than the upper portions, of the affordances 7150 and 7154).

In some embodiments, affordances of the user interface 7146 that are within a threshold distance from a simulated boundary (or boundaries) of the user interface 7146 are displayed with different visual characteristics (e.g., are displayed with a degree of fading or blurring) than affordances that are outside of the threshold distance from the simulated boundary. For example, if the user interface 7146 had a circular shape, the simulated boundary could be a right “edge” of the user interface 7146 (even though the user interface 7146 itself has no corresponding boundary), and affordances near the 2 o′clock, 3 o′clock, and 4 o′clock positions are displayed with the different visual characteristics (e.g., and optionally, the affordances near the 3 o′clock position are displayed with a greater change in the visual characteristic (e.g., more blurring or fading) than the affordances near the 2 o′clock and 4 o′clock positions).

In some embodiments, the visual characteristics include a simulated thickness (e.g., an affordance with a high level of simulated thickness appears more, or fully, three-dimensional, whereas an affordance with a low level of simulated thickness appears flatter or more two-dimensional).

FIG. 7AE illustrates the user’s attention 7116, directed to the affordance 7148 of the user interface 7146. In response to detecting that the user’s gaze satisfies selection criteria (e.g., optionally the same as the attention criteria described above for displaying the system function menu 7024, and/or the same as the selection criteria for displaying the user interface 7136 or the user interface 7146), the computer system 7100 displays a user interface 7156 that is associated with affordance 7148.

In some embodiments, the user interface 7156 is an application user interface (e.g., the affordance 7148 is an application icon, and the user launches the application user interface 7156 by selecting the affordance 7148). In some embodiments, the user interface 7156 includes controls for a phone call or a virtual reality session, and/or is a user interface that includes video for a video call or other communication session, with another user (e.g., the affordance 7148 is a user avatar, and the user 7002 initiates a communication session with the other user via the affordance 7148). In some embodiments, the user interface 7156 is associated with (e.g., is, or is an element of) a virtual environment (e.g., the three-dimensional environment displayed on the display of the computer system 7100).

FIG. 7AF illustrates that movement of the user 7002 to a new location 7026-e (e.g., which, in some embodiments, is the same as the location 7026-c) in the physical environment 7000. A different view of the physical environment 7000 (e.g., optionally the same view as in FIG. 7Y-7AC) is visible (e.g., via the viewport provided by the display generation component of the computer system 7100), in accordance with the movement of the user 7002 from the location 7026-d to the location 7026-e. Based on the movement of the user 7002, the sizes of the representation 7014′ of the physical object 7014, the virtual object 7012, and the user interface 7136 are displayed with the same respective sizes in the view of the three dimensional environment that is visible in FIG. 7AC (e.g., at their “original” sizes prior to any movement of the user 7002).

For example, like the user interface 7136 described above, the user interface 7146 (and/or the user interface 7156) is also environment-locked. In response to the user 7002′s movement to the location 7026-e, the user interface 7146 (and optionally, the user interface 7156) have a different size and position in the view of the three dimensional environment that is visible via the viewport provided by the display generation component of the computer system 7100. In FIG. 7AF, based on the location 7026-e (relative to the location 7026-d), the user interface 7146 and the user interface 7156 have a larger size, and are displayed farther to the right of the user’s current view of the three dimensional environment that is visible in FIG. 7AF (e.g., as compared to the sizes and positions of the user interface 7146 and the user interface 7156 in the view of the three dimensional environment that is visible in FIG. 7AE).

The user’s attention 7116, is directed to the indicator 7010 of system function menu, and in response to the user’s attention 7116 satisfying attention criteria (e.g., the same attention criteria described above with reference to FIG. 7Z) with respect to the indicator 7010 of system function menu, the system function menu 7024 is displayed. As explained above, in some embodiments, the system function menu 7024 is head-locked, and thus the system function menu 7024 remains displayed with the same size and/or at the same location with respect to the user’s current view (e.g., a same size and/or location as the system function menu 7024 in FIG. 7AC when the user was previously at the third location 7026-c, and as in FIG. 7AD when the user moved to the location 7026-d).

Additional descriptions regarding FIG. 7Y-7AF are provided below in reference to method 11000 described with respect to FIG. 7Y-7AF, among other Figures and methods described herein.

FIG. 7AG-7AM illustrate exemplary regions for triggering display of one or more user interface elements. FIG. 12 is a flow diagrams of an exemplary method 12000 for initiating display of a user interface in response to detecting that a user’s attention is directed to a respective region in the three-dimensional environment. The user interfaces in FIG. 7AG-7AM are used to illustrate the processes described below, including the processes in FIG. 12.

FIG. 7AG illustrates two exemplary regions, region 7158 and region 7160, for triggering display of one or more user interface elements (e.g., indicator 7010 of system function menu, as shown in FIG. 7A).

In some embodiments, region 7158 and region 7160 are not visible (e.g., as indicated by the dotted outlines for region 7158 and region 7160 in FIG. 7AG), and the dotted outlines in FIG. 7AG-7AM are visual representations of where region 7158 and region 7160 would be on the display of the computer system 7100.

In some embodiments, region 7158 is larger than region 7160. In some embodiments, region 7158 includes region 7160 (e.g., region 7160 is a sub-region for region 7158). In some embodiments, region 7158 and region 7160 are viewpoint-locked regions and exhibit analogous behavior to the indicator 7010 of system function menu and/or the system function menu 7024, as described above with reference to FIGS. 7A-7D and/or FIGS. 7E-7G.

In some embodiments, one or both of region 7158 and region 7160 have a different shape than the substantially square shape shown in FIG. 7AG. Other exemplary shapes include polygonal shapes (e.g., a triangle, a non-square rectangle, or an irregular polygon), a circular or elliptical shape, or an irregular shape (e.g., to avoid overlap with other displayed user interface elements).

In FIG. 7AG, the user’s attention 7116 is not directed to either region 7158 or region 7160, and no user interface object or user interface element is displayed within region 7158 or region 7160. In some embodiments, if the user’s attention 7116 is not directed to either region 7158 or region 7160, but the user’s attention 7116 is directed to a displayed user interface (e.g., an application-launch user interface, an application user interface, or a system space) (e.g., in conjunction with an air gesture (e.g., an air tap or an air pinch), an input from a hardware controller, and/or a verbal input), the computer system performs an operation corresponding to the displayed user interface (e.g., launches and application, performs an application-specific operation, or adjusts a system setting for the computer system 7100).

In FIG. 7AH, the user’s attention 7116 is directed to a location within region 7158 (but not region 7160). In response to detecting that the user’s attention 7116 is directed to region 7158, the computer system 7100 displays the indicator 7010 of system function menu. In some embodiments, the computer system 7100 displays the indicator 7010 of system function menu in response to detecting that the user’s attention 7116 has been directed to the location within region 7158 for a threshold amount of time (e.g., 0.1, 0.2, 0.5, 1, 2, or 5 seconds). In some embodiments, as shown in FIG. 7AH, the indicator 7010 of system function menu is initially displayed with a smaller size (e.g., relative to the “normal” or steady state size of the indicator 7010 of system function menu in FIG. 7A). The indicator 7010 of system function menu provides visual feedback to the user that the computer system 7100 has detected the user’s attention directed to region 7158. The indicator 7010 of system function menu also provides a hint (e.g., visual feedback or indication) that the user’s attention 7116 is near the (smaller) region 7160 and/or that further user interactions (e.g., access to the system function menu 7024, via the full-sized indicator 7010 of system function menu, as shown in FIG. 7E, and/or as described in further detail below with reference to FIG. 7AM) are available (e.g., via region 7160 and/or the indicator 7010 of system function menu).

In some embodiments, the computer system 7100 displays (e.g., concurrently with the indicator 7010 of system function menu) instructions (e.g., text-based instructions, visual or pictorial instructions) for expanding the indicator 7010 of system function menu and/or invoking the system function menu 7024 (e.g., via one or more inputs as described below with reference to FIG. 7AI-AM). In some embodiments, the instructions are nonvisual (e.g., aural) instructions. In some embodiments, the computer system 7100 provides multiple forms of instructions (e.g., visual and audio instructions). In some embodiments, the instructions are persistently displayed until the user’s attention is directed to the displayed instructions. In some embodiments, after the user’s attention is directed to the displayed instructions, the computer system detects that the user’s attention moves away from the displayed instructions (e.g., for a threshold amount of time, such as 0.1, 0.2, 0.5, 1, 2, 5, or 10 seconds), and in response, the computer system 7100 ceases to display the instructions. In some embodiments, the instructions are provided before the user has successfully displayed the indicator 7010 of system function menu (e.g., at the full size, as in FIG. 7A or FIG. 7AM) and/or invoked the system function menu 7024, and instructions are not provided again afterwards (e.g., to avoid unnecessary repetition and distraction to the user, if the user is already familiar with how to invoke the system function menu 7024).

In some embodiments, the indicator 7010 of system function menu is not displayed if it would overlap with an existing user interface element. For example, if the user interface 7136 (FIG. 7AA) is displayed at a location in the upper left of the display (e.g., that would overlap with the location of the indicator 7010 of system function menu in FIG. 7AH), the indicator 7010 of system function menu is not displayed. As the user interface 7136 includes affordances 7138, 7140, 7142, and 7144 which are interactable user interface elements, simultaneous display of the indicator 7010 of system function menu in addition to the affordances of the user interface 7136 may create a scenario where it is difficult for a user to accurately interact with user interface elements (e.g., via gaze inputs or other inputs that include gaze components), which is avoided by forgoing display of the indicator 7010 of system function menu when another user interface would overlap with the indicator 7010 of system function menu (and/or the indicator 7010 of system function menu would be displayed over a another user interface).

In some embodiments, the indicator 7010 of system function menu is viewpoint-locked (e.g., similarly to region 7158 and region 7160), and has analogous behavior as described with reference to, and as shown in, FIGS. 7B-7D.

In some embodiments, the location of the indicator 7010 of system function menu is selected at least in part based on a position of the user relative to the computer system 7100. In some embodiments, the indicator 7010 of system function menu is displayed in a consistent region (e.g., upper right corner, or another region consistently chosen by the computer system) of the display of the computer system 7100, but the exact location of the indicator 7010 of system function menu varies within the region (e.g., the exact location of the indicator 7010 of system function menu can be up to a threshold distance away from a respective default position), based at least in part on the position of the user relative to the computer system 7100. In some embodiments, the computer system 7100 may include one or more cameras (or other sensors) for tracking a position of the user, for determining the orientation (e.g., an amount of tilt and/or rotation) of the computer system 7100 relative to the user.

For example, if the computer system 7100 is a handheld device, the computer system 7100 detects that the orientation of the computer system 7100 is not exactly aligned with the user (e.g., when the user holds only the right side of the computer system 7100 (relative to the user’s view) with only the user’s right hand, a horizontal axis of the computer system 7100 (that would normally run from the left to the right of the user’s view) is slightly rotated (e.g., runs from a slightly lower left to a slightly higher right, in the user’s view) due to the weight of the computer system 7100 and the lack of support (e.g., via the user’s left hand) on the left side of the computer system 7100). The computer system 7100 displays the indicator 7010 of system function menu at an adjusted location (e.g., closer to the top edge and/or the right edge of the computer system 7100), in accordance with some embodiments.

In some embodiments, the computer system 7100 is a head-mounted display (HMD), and the computer system 7100 accommodates for how the device is worn by the user. For example, the computer system 7100 may be oriented differently for different users, due to differences in the physical characteristics of each user (e.g. different sizes and positions of each user’s ears, eyes and/or nose), asymmetry of a user’s physical features (e.g., ears that have slightly different heights, eyes that have different sizes, and/or an eyeline that is not perfectly horizontal), or other external factors (e.g., the presence of earphones/headphones, glasses, or other accessories that are worn on or around the user’s head). For example, the computer system 7100 detects that the head-mounted display sits lower on the user’s face than another user (or lower than a default or average height), and the computer system 7100 displays the indicator 7010 of system function menu at an adjusted location (e.g., closer to the top edge of the computer system 7100).

Displaying the indicator 7010 of system function menu at an adjusted location allows the indicator 7010 of system function menu to be displayed at a consistent location (e.g., relative to the user) even if the computer system 7100 is not “perfectly” aligned with the user (e.g., no tilt or rotation relative to the user), and also maintains the indicator 7010 of system function menu at a consistent location through minor movement of the computer system 7100 (e.g., due to unsteadiness of the user’s hand(s)). In some embodiments, the adjusted location of the indicator 7010 of system function menu is within a threshold distance (e.g., 0.5 mm, 1 mm, 2 mm, 5 mm, or 1 cm) of a respective location (e.g., the center point of a respective upper right portion of the display of the computer system 7100). If the adjusted location of the indicator 7010 of system function menu would require the indicator 7010 of system function menu to be displayed at a location that is greater than the threshold distance, the computer system 7100 forgoes displaying the indicator 7010 of system function menu at the adjusted location (e.g., because the adjusted location would require the indicator 7010 of system function menu to be displayed somewhere beyond the physical boundary of the display of the computer system 7100, or because the indicator 7010 of system function menu cannot be easily interacted with at the adjusted location (e.g., the indicator 7010 of system function menu would be displayed at a location that is uncomfortable for the user to interact with, and/or the indicator 7010 of system function menu would be displayed at a location where other user interface elements commonly appear (e.g., somewhere near the center portion of the display of the computer system 7100) and/or other user interface elements are already displayed. Instead of displaying the indicator 7010 of system function menu at the adjusted location is beyond the threshold distance from the respective location, the computer system 7100 instead displays a visual indication to the user (e.g., instructions for correcting the orientation and/or position of the computer system 7100 relative to the user, which would allow the indicator 7010 of system function menu to be displayed at a location that is within the threshold distance of the respective location).

In some embodiments, if the location of the indicator 7010 of system function menu is adjusted (e.g., the indicator 7010 of system function menu is displayed at the adjusted location as described above), the system function menu 7024 is also adjusted by the same amount (e.g., in the same direction(s)). In some embodiments, if the location of the indicator 7010 of system function menu is adjusted (e.g., the indicator 7010 of system function menu is displayed at the adjusted location as described above), other user interface elements (e.g., the user interface 7058 in FIG. 7L, the application user interface 7062 in FIG. 70, the user interface 7136 in FIG. 7AA, and/or the user interface 7146 in FIG. 7AD) are adjusted by the same amount (e.g., and the same direction(s)). In some embodiments, if the location of the indicator 7010 of system function menu is adjusted, the system function menu 7024 is adjusted by the same amount (e.g., and in the same direction(s)), but other user interface elements are not adjusted (e.g., are displayed in normal or default positions such that only the indicator 7010 of system function menu and the system function menu 7024 are adjusted).

In FIG. 7AI, the user’s attention 7116 remains directed to a location in region 7158, but outside region 7160, and the indicator 7010 of system function menu remains at the same size (as in FIG. 7AH), in accordance with some embodiments. Maintaining the size of the indicator 7010 of system function menu at the same size as in FIG. 7AH, provides visual feedback to the user that the computer system 7100 has detected the user’s attention directed to region 7158, but that no further progress (e.g., towards displaying the full-sized indicator 7010 of system function menu and/or the system function menu 7024) has been detected (e.g., the attention of the user has not been directed to a location within region 7160).

In FIG. 7AJ, the user’s attention 7116 is now directed to a location within region 7160, and the computer system 7100 displays the indicator 7010 of system function menu with an intermediate size (e.g., an intermediate size that is between the size of the indicator 7010 of system function menu as shown in FIG. 7AI, and the size of the indicator 7010 of system function menu as shown in FIG. 7A (or FIG. 7AL-7AM as described in further detail below)). In some embodiments, the computer system 7100 displays an animation of the indicator 7010 of system function menu expanding (e.g., from the size of the indicator 7010 of system function menu in FIG. 7AI to the size of the indicator 7010 of system function menu in FIG. 7AJ). In some embodiments, region 7160 also increases in size (e.g., optionally, proportionally to the increase in size of the indicator 7010 of system function menu). In some embodiments, region 7160 increases in size, but remains a subregion of region 7158.

In some embodiments, region 7160 expands in a manner that is at least partially symmetrical with respect to the indicator 7010 of system function menu. For example, as shown in FIG. 7AJ, region 7160 expands symmetrically towards the left and right of the indicator 7010 of system function menu, in addition to expanding downward relative to the indicator 7010 of system function menu. In some embodiments, region 7160 expands in a manner that is at least partially asymmetrical. For example, in FIG. 7AJ, region 7160 does not expand upwards relative to the indicator 7010 of system function menu (e.g., to avoid overlap with existing user interface elements, such as the display indicators above the indicator 7010 of system function menu on the display of the computer system 7100). In some embodiments, region 7160 expands uniformly around the indicator 7010 of system function menu (e.g., the indicator 7010 of system function menu is centered in region 7160, and region 7160 expands such that the indicator 7010 of system function menu remains centered in region 7160).

In FIG. 7AK, the user’s attention 7116 moves away from region 7160 (and region 7158), and the indicator 7010 of system function menu begins to shrink (e.g., because the user’s attention 7116 is no longer within region 7158 or region 7160). In some embodiments, the indicator 7010 of system function menu shrinks if the user’s attention 7116 is outside both region 7158 and region 7160. In some embodiments, the user’s attention 7162 (illustrated as a shaded arrow to differentiate from the user’s attention 7116) is within region 7158, but outside region 7160, and the indicator 7010 of system function menu beings to shrink (e.g., the indicator 7010 of system function menu beings to shrink if the attention of the user is not directed to a location within region 7160, even if the attention of the user is still directed to a location within region 7158).

In some embodiments, while the user’s attention 7116 is outside region 7158 (and/or region 7160), the indicator 7010 of system function menu shrinks at a continuous rate. In some embodiments, the indicator 7010 of system function menu shrinks at a different rate (e.g., faster than or slower than) as compared to the rate of expansion while the user’s attention 7116 is within region 7160. In some embodiments, the indicator 7010 of system function menu begins to shrink after the user’s attention 7116 is outside region 7158 (and/or region 7160) for a threshold amount of time (e.g., 0.1, 0.2, 0.5, 1, 2, 5, 10, 30, or 60 seconds), which prevents the indicator 7010 of system function menu from shrinking if the attention of the user is temporarily redirected from region 7158 (and/or region 7160) (e.g., if the user is momentarily distracted by something in the real world or virtual environment/three-dimensional environment). While the user’s attention 7116 is outside region 7158 (and/or region 7160) and before the threshold amount of time has passed, the indicator 7010 of system function menu is maintained at a respective size (e.g., the size of the indicator 7010 of system function menu when the user’s attention 7116 moved away from region 7160). In some embodiments, if the user’s attention 7116 returns to region 7160 before the threshold amount of time has passed, the indicator 7010 of system function menu resumes expanding.

In FIG. 7AL, the user’s attention 7116 returns to a location within region 7160. While the user’s attention 7116 continues to be directed to a location within region 7160, the indicator 7010 of system function menu continues to expand, until it reaches a maximum size (as shown in FIG. 7AL, in which the indicator 7010 of system function menu has the same size as the indicator 7010 of system function menu in FIGS. 7A-7G), in accordance with some embodiments.

In FIG. 7AM, the user’s attention is directed to the (full-sized) indicator 7010 of system function menu, and in response, the computer system 7100 displays the system function menu 7024. In some embodiments, the indicator 7010 of system function menu and the system function menu 7024 are analogous to, and have the same characteristics and behaviors, as the indicator 7010 of system function menu and the system function menu 7024 described above with reference to FIG. 7A-7AF).

In some embodiments, the indicator 7010 of system function menu is not displayed (e.g., in any of FIG. 7AG-7AM), and the computer system 7100 displays the system function menu 7024 in response to detecting that the user’s attention 7116 is directed to a location in region 7160 (e.g., the location occupied by the indicator 7010 of system function menu in FIG. 7AM), or any location in region 7160 (e.g., and optionally, region 7158 instead has a size that is approximately the same as the full size of the indicator 7010 of system function menu). In some embodiments, the indicator 7010 of system function menu is displayed (e.g., as described above with reference to FIG. 7AG-7AM) if the user 7002 has not interacted with the indicator 7010 of system function menu and/or the system function menu 7024 before (e.g., the first time the system function menu 7024 is displayed), and optionally is not displayed again after the system function menu 7024 is displayed for the first time (e.g., to avoid cluttering the display of the computer system with the indicator 7010 of system function menu when the user 7002 already knows how to access the system function menu 7024 (e.g., by directing the user’s attention 7116 to region 7160 and/or the location in region 7160 where the indicator 7010 of system function menu is shown in FIG. 7AM)).

In some embodiments, where the indicator 7010 of system function menu is not displayed (e.g., or not subsequently displayed, after the first time the system function menu 7024 is displayed), the computer system 7100 displays (e.g., or redisplays) the system function menu 7024 when the user’s attention 7116 is directed to region 7160 and/or the location in region 7160 where the indicator 7010 of system function menu is shown in FIG. 7AM, for a threshold amount of time (e.g., instead of displaying the indicator 7010 of system function menu expanding in size, as described with reference to FIG. 7AG-7AM, the computer system 7100 detects that the user’s attention 7116 remains directed to the location within region 7160 for a threshold amount of time (e.g., 0.05, 0.1, 0.2, 0.5 seconds, 1 second, 2 seconds, or 5 seconds, which is optionally the same amount of time as it would take the indicator 7010 of system function menu to expand to its full size in FIG. 7AG-7AM).

In some embodiments, the location of the system function menu 7024 is selected at least in part based on a position of the user relative to the computer system 7100 (e.g., in an analogous fashion to the indicator 7010 of system function menu, as described above with reference to FIG. 7AH). In some embodiments, the indicator 7010 of system function menu and the system function menu 7024 are displayed with adjusted positions (e.g., and with the same amount of adjustment), and other user interface elements are not adjusted (e.g., displayed at normal or default positions).

With respect to FIG. 7AJ, in some embodiments, while the user’s attention 7116 is directed to region 7160 (or the indicator 7010 of system function menu) and before the full-sized indicator 7010 of system function menu is displayed, the user can perform a gesture (e.g., an air gesture, such as an air tap or an air pinch, as described herein) to display the full-sized indicator 7010 of system function menu and/or the system function menu 7024 (e.g., the user can skip from FIG. 7AJ straight to FIG. 7AL or FIG. 7AM) without having to wait for the indicator 7010 of system function menu to expand to its full size (e.g., the sequence described above with reference to FIG. 7AH-7AL), optionally, concurrently with displaying the system function menu 7024 (e.g., as shown in FIG. 7AM). In some embodiments, the gesture is performed while the user’s attention 7116 remains directed to region 7160 (or the indicator 7010 of system function menu). This allows for more efficient interaction with the computer system 7100, as the user can display the system function menu 7024 without having to wait for the indicator 7010 of system function menu to expand (e.g., as described above with reference to FIG. 7AH-7AL), and without risk of the attention of the user accidentally wandering away from region 7160 (e.g., due to distractions or eye fatigue). In some embodiments, the indicator 7010 of system function menu displayed at the full size (e.g., at the size shown in FIG. 7AL), without displaying the system function menu 7024, in response to the user’s gesture (e.g., the gesture skips from FIG. 7AJ to FIG. 7AL). In some embodiments (e.g., where the indicator 7010 of system function menu is not displayed, or only displayed before the system function menu 7024 is initially displayed for the first time), in response to detecting the user’s gesture, the computer system 7100 displays the system function menu 7024 (e.g., without and/or instead of displaying the indicator 7010 of system function menu).

In some embodiments, while the system function menu 7024 is displayed, the user speaks a verbal input, and the computer system 7100 performs a function associated with the spoken verbal input. For example, the system function menu 7024 includes an affordance associated with a virtual assistant of the computer system 7100, and the user can speak a verbal input instructing the virtual assistant to perform a function of the computer system 7100 (e.g., as described in further detail above, with reference to FIG. 7K(e)); and/or the system function menu 7024 includes an affordance associated with a search function, and the user can speak a verbal input with a search term to be searched by the computer system 7100 (e.g., as described in further detail above, with reference to FIG. 7K(b)). In some embodiments, the computer system 7100 displays a visual indication corresponding to the verbal input (e.g., text corresponding to the verbal input), for example, as shown in FIG. 7K(b).

In some embodiments, the user’s attention 7116 can be directed to portions of the user interface other than the particular affordance for the virtual assistant or search function (e.g., the indicator 7010 of system function menu, or other portions of the system function menu 7024), and the computer system 7100 determines the appropriate function to perform based on the verbal input. For example, if the verbal input matches a list of functions of the virtual assistant, the computer system 7100 performs a function corresponding to a respective function of the list of functions corresponding to the verbal input. If the verbal input does not match any function in the list of functions of the virtual assistant, the computer system 7100 instead performs a search function based on the verbal input.

In some embodiments, the user’s attention 7116 is directed away from the system function menu 7024 (e.g., and/or the indicator 7010 of system function menu, and/or region 7160), and in response, the computer system ceases to display the system function menu 7024. In some embodiments, the computer system ceases to display the system function menu 7024 in response to detecting that the user’s attention 7116 is not directed to the system function menu 7024 (and/or the indicator 7010 of system function menu, and/or region 7160) for a threshold amount of time (e.g., 0.1, 0.2, 0.5, 1, 2, 5, 10, 30, or 60 seconds). This allows the user’s attention to briefly wander (e.g., due to external distractions and/or eye fatigue) without accidentally ceasing to display the system function menu 7024.

In some embodiments (e.g., where the system function menu 7024 is displayed in response to detecting that the user’s attention 7116 is directed to region 7160), the computer system 7100 ceases to display the system function menu 7024 in response to detecting that the user’s attention 7116 is directed to a location outside the larger region 7158. In some embodiments, the computer system 7100 maintains display of the system function menu 7024 while the user’s attention remains directed to a location within region 7160 (and/or region 7158).

In some embodiments, after ceasing to display the system function menu 7024, the computer system detects that the user’s attention 7116 returns to the indicator 7010 of system function menu (e.g., or a location within region 7160), and in response, the computer system redisplays the system function menu 7024.

Additional descriptions regarding FIG. 7AG-7AM are provided below in reference to method 12000 described with respect to FIG. 12, among other Figures and methods described herein.

FIG. 7AN-7AT illustrate exemplary contextual user interfaces that are displayed when different context criteria are met. FIG. 13 is a flow diagrams of an exemplary method 13000 for displaying and interacting with contextual user interfaces. The user interfaces in FIG. 7AN-7AT are used to illustrate the processes described below, including the processes in FIG. 13.

In some embodiments, if the user’s attention 7116 is not directed to the indicator 7010 of system function menu (e.g., or a region such as region 7160 in FIG. 7AM), the computer system 7100 does not display any contextual user interface (e.g., contextual user interfaces are not displayed without user interaction (e.g., a user input directed to a user interface object and/or region of the display).

In some embodiments, the computer system 7100 displays different content (e.g., different user interfaces, or different content within the same user interface) in different contexts. In FIG. 7AM, no specific context criteria are met (Context 0). In FIG. 7AN- 7AR first context criteria are met (Context 1). In FIG. 7AS-7AT, second context criteria (e.g., different from the first context criteria) are met (Context 2).

In FIG. 7AM, no context criteria are met (Context 0). When the user’s attention 7116 is directed to the indicator 7010 of system function menu, the computer system 7100 displays the system function menu 7024 (e.g., default content that is displayed when no specific context criteria are met), in accordance with some embodiments.

In FIG. 7AN, the first context criteria are met (e.g., a video call request is active for the computer system 7100 (e.g., as described in further detail above, with reference to FIGS. 7R-7U)). FIG. 7AN includes the user interface object 7064 (described above with reference to FIGS. 7R-7U) in place of the indicator 7010 of system function menu, because a video call request is active for the computer system 7100. When the user’s attention 7116 is directed to the user interface object 7064, the computer system displays the incoming call user interface 7068 (e.g., first content, different from the default content), in accordance with some embodiments. The incoming call user interface 7068 includes a “Join” affordance, and in response to detecting a user input directed to the “Join” affordance, the computer system 7100 connects to the communication session corresponding to the incoming call. In some embodiments, the call user interface 7068 includes one or more additional affordances (e.g., an affordance for dismissing the incoming call user interface, without connecting to a communication session) for performing other functions corresponding to the incoming call user interface 7068.

In some embodiments, the system function menu 7024 (e.g., the default content) is at least partially displayed (e.g., concurrently with the incoming call user interface 7068). In some embodiments, if the system function menu 7024 is concurrently displayed with the incoming call user interface 7068, the system function menu 7024 is displayed with a lower level of prominence than the incoming call user interface 7068 (e.g., the system function menu 7024 is displayed dimmer than, blurrier than, more occluded or obscured than, and/or smaller than the incoming call user interface 7068). In FIG. 7AN, this reduced level of prominence is represented by the shading (e.g., diagonal stripes) of the system function menu 7024. In some embodiments, the system function menu 7024 includes status information about the computer system 7100 (e.g., Wi-Fi connection status, cellular connection status, a current time, and/or battery charge state), in addition to the plurality of affordances for accessing system functions of the computer system 7100. In some embodiments, the status information about the computer system 7100 is displayed in response to detecting that the user’s attention 7116 is directed to the user interface object 7064, but is displayed distinct from (e.g., in a separate user interface object, or in a region that is separate from) the system function menu 7024 (e.g., so that display of the status information about the computer system 7100 can be maintained, even if the system function menu 7024 is no longer displayed and/or no longer fully visible, for example, as the computer system navigates through available contextual user interfaces as described in further detail below).

In some embodiments, the computer system 7100 displays additional content items, in addition to the incoming call user interface 7068 (and/or system function menu 7024). In FIG. 7AO, for example, the user’s attention 7116 is directed to the incoming call user interface 7068. In response to detecting that the user’s attention 7116 is directed to the incoming call user interface 7068 (e.g., in combination with an air gesture, such as an air tap or an air pinch, or another selection input), the computer system 7100 displays the notifications 7148, 7150, 7152, 7154, and 7156. In some embodiments, the computer system 7100 displays some content items of the one or more additional content items (e.g., the notification 7157 in FIG. 7AO) with reduced prominence (e.g., a smaller size and partially occluded by the notification 7154). In some embodiments, the computer system displays a subset of all available content items (e.g., due to size limitations of the display of the computer system 7100).

In some embodiments, the computer system 7100 displays a visual indication that other additional content items are available (e.g., the smaller size of the notification 7157 indicates that other notification content is available for display, but not currently displayed). In some embodiments, the visual indication that other additional content items are available is displayed with a reduced level of prominence (e.g., further from the viewpoint of the user, with a lower brightness, with a lower opacity, and/or with a higher degree of blur effect) as compared to the additional content items (e.g., the notification 7157 has a smaller size, and appears behind, the notification 7154). In some embodiments, one or more of the additional content items are displayed in place of (e.g., replace display of) the incoming call user interface 7068). In some embodiments, one or more of the additional content items are concurrently displayed with the incoming call user interface 7068.

In some embodiments, while displaying the additional content items, the computer system 7100 detects occurrence of an event (e.g., corresponding to a new notification), and the computer system 7100 displays a new notification corresponding to the event (e.g., optionally, at the location where the notification 7148 is displayed at in FIG. 7AO, with each other notification shifting one position to the left (e.g., the notification 7148 is displayed at the location of the notification 7150 in FIG. 7AO, the notification 7157 ceases to be displayed, and the notification 7154 is displayed with a smaller size (e.g., the same size as the notification 7157 in FIG. 7AO)).

In some embodiments, one or more contextual user interfaces (e.g., the incoming call user interface 7068 and/or the additional content items in FIG. 7AO) are viewpoint-locked (e.g., exhibit similar behavior to the indicator 7010 of system function menu and/or the system function menu 7024, as described with reference to, and shown in, FIGS. 7B-7D and 7E-7G).

In some embodiments, the computer system 7100 displays up to a threshold number (e.g., a maximum number) of additional content items (and/or total user interface objects). For example, the threshold number is six total user interface objects, so in FIG. 7AO, the computer system displays the system function menu 7024, the incoming call user interface 7068, and four notifications 7148, 7150, 7152, and 7154. The computer system 7100 displays the visual indication (e.g., the smaller notification 7157) to indicate that additional content items are available for display, but not currently displayed (e.g., due to the maximum number of user interface objects being met), in accordance with some embodiments.

In some embodiments, the user 7002 can display additional content associated with a specific contextual user interface, by directing the user’s attention 7116 to the specific contextual user interface and performing a first type of user input (e.g., a first type of air gesture, input via a hardware controller, and/or verbal input). For example, if the user’s attention 7116 is directed to the incoming call user interface 7068 and the user performs the first type of user input, the computer system 7100 displays additional information regarding the communication session corresponding to the incoming call user interface 7068 (e.g., contact information for the contact “John Smith” and/or other contacts or users who are active in the communication session), optionally in an expanded version of the incoming call user interface 7068, in accordance with some embodiments. If the user’ attention 7116 is directed to a notification 7148 and the user performs the first type of user input, the computer system 7100 displays additional notification content for the notification 7148, in accordance with some embodiments. In some embodiments, the computer system ceases to display other contextual user interfaces (e.g., other than the contextual user interface that the user’s attention is directed to) in response to detecting a user input of the first type.

FIG. 7AP illustrates display of other additional content items (e.g., a second subset of available content items different from the subset shown in FIG. 7AO), in accordance with some embodiments. In some embodiments, the computer system 7100 displays the other additional content items in response to detecting that the user’s attention 7116 is directed to a location corresponding to the visual indication that the other additional content items are available (e.g., the smaller notification 7157 in FIG. 7AO). In some embodiments, the computer system 7100 displays the other additional content items in response to detecting that the user’s attention 7116 is directed to a location that is within a threshold distance of an edge of the display of the computer system 7100 (e.g., the user’s attention 7116 is within a threshold distance of the left edge of the display of the computer system 7100, while the user’s attention 7116 is at the location shown in FIG. 7AP), or a location that is beyond a threshold distance of a center point (or region) of the display (e.g., the user’s attention 7116 is beyond a threshold distance of the notifications 7148 and 7150 in FIG. 7AO, which are displayed in a center region of the display of the computer system 7100). In some embodiments, the computer system 7100 displays the other additional content items in response to detecting a scrolling input (e.g., an air pinch and drag gesture, or a swipe gesture, that includes movement in a first direction, optionally in conjunction with a gaze input directed to one of the previously described locations with reference to the user’s attention 7116).

In some embodiments, the computer system 7100 navigates through (e.g., scrolls display of) the displayed additional content items (e.g., to display the other additional content items) in a first direction that corresponds to where the user’s attention 7116 is detected relative to the center point/region of the display of the computer system 7116 (e.g., the first direction is leftward in FIG. 7AP, because the user’s attention 7116 is to the left of the center point/region of the display of the computer system 7100).

In some embodiments, as shown in FIG. 7AQ, the computer system 7100 continues navigating through display of the additional content items (e.g., to display a third subset of available content items that is different from the second subset of available content items in FIG. 7AP, and the subset of available content items in FIG. 7AO).

In some embodiments, the computer system 7100 navigating through the displayed additional content items in a second direction (e.g., opposite the first direction) in response to detecting that the user’s attention 7116 has moved to a different location (e.g., a location to the right of the center point/region, such as a location over the system function menu 7024, as shown in FIG. 7AQ), allowing the user to reverse the navigation direction (e.g., by adjusting where the user’s attention is directed). For example, as shown in FIG. 7AQ, the user’s attention 7116 is directed to a location to the right of the notifications 7156 and 7158. In response, as shown in FIG. 7AR, the computer system 7100 navigates through display of the available content items in the second direction, and the notifications 7158, 7160, 7162, and 7164 cease to be displayed (e.g., are scrolled off the display). The computer system displays (or redisplays) the notifications 7148, 7150, 7152, 7154, and 7156, the incoming call user interface 7068, and the system function menu 7024).

In some embodiments, the user can perform a respective gesture (e.g., an air gesture, such as an air tap or an air pinch, or another selection input) in order to quickly return to the earlier (or earliest) displayed user interface elements. For example, in FIG. 7AQ, the user’s attention 7116 is directed to the (partially visible) system function menu 7024 and the user performs a respective air gesture. In response, as shown in FIG. 7AR, the computer system 7100 displays the user interface elements in FIG. 7AR (e.g., without requiring the user to wait as the computer system 7100 navigates through user interface elements, such as navigating through the notifications 7158, 7160, 7162, and 7164 off the display, displaying (e.g., redisplaying) the incoming call user interface 7068 on the display, and navigating to (e.g., moving) the system function menu 7024 into full view (e.g., without being partially overlayed or occluded by other user interface elements). In some embodiments, the respective gesture is an air gesture (e.g., an air tap or an air pinch) performed in combination with a gaze component (e.g., gazing at the system function menu 7024, or an edge region of the displayed content items).

FIG. 7AS illustrates an alternative to FIG. 7AN, where the second context criteria are met (e.g., music is playing on the computer system 7100). When the user’s attention 7116 is directed to the indicator 7010 of system function menu, the computer system displays a music user interface 7166 (e.g., that includes media playback controls, such as a play affordance, a pause affordance, a next or fast forward affordance, and/or a previous or rewind affordance). In some embodiments, in response to detecting a user input directed to a respective media playback controls, the computer system 7100 performs a function associated with the respective media control (e.g., plays a current song, pauses a currently playing song, skips to the next song, fast-forwards through the currently playing song, navigates to a previous song, or rewinds through a currently playing song).

In some embodiments, multiple context criteria are met. For example, second context criteria are met because music is playing on the computer system 7100, and simultaneously, first context criteria are met because a video call request is also active for the computer system 7100. In some embodiments, when multiple context criteria are met, the computer system 7100 determines the appropriate content to display based on a respective priority order. For example, in the respective priority order, the second context has a higher priority than the first context. When music is playing on the computer system 7100 and a video call request is also active for the computer system 7100, the computer system 7100 displays the music user interface 7166 in response to detecting the user’s attention 7116 directed to the indicator 7010 of system function menu, because the second context (e.g., a context in which music is playing) has a higher priority than the first context (e.g., a context in which the computer system is receiving an active video call request), in accordance with some embodiments.

In some embodiments, the respective priority order is determined based on a state of the device when the user’s attention 7116 is directed to the indicator 7010 of system function menu (or a user interface object that replaces the indicator 7010 of system function menu, such as the user interface object 7064 of FIGS. 7R-7U, or the user interface object 7056 of FIGS. 7L-7O, if applicable). For example, in FIG. 7AM, no pending requests to join a communication session and no activities are active for the computer system 7100, so the computer system prioritizes display of the system function menu 7024 when the user’s attention 7116 is directed to the indicator 7010 of system function menu, in accordance with some embodiments. In FIG. 7AN, a pending request to join a communication session is active, so the computer system 7100 prioritizes display of the incoming call user interface 7068 when the user’s attention 7116 is directed to the user interface object 7064, in accordance with some embodiments. In FIG. AS, an activity is active (e.g., music is playing) on the computer system 7100, so the computer system 7100 prioritizes displaying the music user interface 7166 for the activity, when the user’s attention 7116 is directed to the indicator 7010 of system function menu, in accordance with some embodiments.

In some embodiments, the computer system 7100 provides a preview corresponding to contextual user interfaces that are available for display. For example, the user interface object 7064 (e.g., in FIG. 7R) is a preview of the incoming call user interface 7068 (e.g., a preview that indicates that the incoming call user interface 7068 will be displayed if the user directs the user’s attention to the user interface object 7064), in accordance with some embodiments. In some embodiments, if a preview is displayed, the contextual user interface corresponding to the preview is prioritized above other contextual user interfaces available for display (e.g., and while the system function menu 7024 is the lowest priority user interface for display, if no preview is displayed, and the user’s attention is directed to the indicator 7010 of system function menu, the computer system 7100 displays the system function menu 7024 (e.g., the lowest priority user interface, because no other contextual user interfaces were previewed and/or are available for display)).

In some embodiments, the respective priority order is determined based at least in part on time (e.g., a time when a particular contextual user interface/content was generated or first displayed). In some embodiments, the contextual user interfaces are ordered in reverse temporal order (e.g., the newest contextual user interfaces have a higher priority). In some embodiments, the respective priority order determines the order of different categories of contextual user interfaces, and within each category, the contextual user interfaces of the same category are ordered by time (e.g., in reverse temporal order).

Some exemplary categories of contextual user interfaces include: (1) a notification category that includes the notifications 7148, 7150, 7152, 7154, 7156, 7158, 7160, 7162, and 7164 (of FIG. 7AO-7AQ); (2) a requests category (e.g., for incoming call/video call requests or other incoming communication requests,) that includes the incoming call user interface 7068; and (3) an activities category (e.g., corresponding to ongoing events or current states of the computer system 7100) that includes the music user interface 7166, in accordance with some embodiments. As illustrated in FIG. 7AT, the activities category has a higher priority than the requests category, and the requests category has a higher priority than the notifications category (e.g., and the system function menu 7024 has the lowest priority), but in other embodiments, the different categories can have any suitable priority. In some embodiments, the respective priority order (e.g., the priority order of the different categories) is configurable by the user (e.g., the user can set the priority level for each category of contextual user interfaces), and in some embodiments, the respective priority order is partially configurable by the user (e.g., some priority levels for some categories cannot be modified by the user). In some embodiments, the user can partially configure the respective priority order (the user can set the priority level for some, but not all, categories) and the computer system 7100 applies a default priority order for any unconfigured categories.

In some embodiments, as shown in FIG. 7AT, the computer system 7100 concurrently displays user interfaces corresponding to multiple contexts. For example, while music is playing on the computer system 7100 and a video call request is also active for the computer system 7100, the computer system displays the music user interface 7166 when the user’s attention 7116 is directed to the indicator 7010 of system function menu, and the incoming call user interface 7068 is displayed as one of the additional content items (e.g., the additional content items described above with reference to FIG. 7AO-7AR), in accordance with some embodiments.

In some embodiments, the indicator 7010 of system function menu is replaced by an appropriate user interface object (e.g., the user interface object 7064 of FIGS. 7R-7U, or the user interface object 7056 of FIGS. 7L-7O), depending on which context criteria are met. In some embodiments, where multiple context criteria are met, the computer system 7100 determines the appropriate indicator (e.g., of system function menu, of a notification, and/or of an incoming communication request) or user interface object (e.g., the user interface object 7064 of FIGS. 7R-7U, and/or the user interface object 7056 of FIGS. 7L-7O) to display based on the same priority order used to determine what content to display, in accordance with some embodiments.

While FIG. 7AM-7AT illustrate three exemplary contextual user interfaces (the system function menu 7024, the incoming call user interface 7068, and the music user interface 70166), the computer system 7100 can display any suitable user interface (e.g., depending on the corresponding context), in accordance with various embodiments. Other possible examples of contextual user interfaces include user interfaces that indicate a status of the computer system 7100 (e.g., a user interface that indicates there is an active call in progress, a user interface that indicates that a guest mode of the computer system 7100 is active, a user interface that indicates that a full screen mode of the computer system 7100 is active, a user interface that indicates the computer system 7100 is currently recording the screen (e.g., display) activity, a user interface that indicates that the display of the computer system 7100 is currently being mirrored (e.g., shared) on or with another computer system, a user interface that indicates that a specific mode (e.g., a Do Not Disturb mode, a reading mode, a driving mode, and/or a travel or other motion-based mode) of the computer system 7100 is active, and/or a user interface corresponding to media content (e.g., audio content, music content, and/or video content) that is playing (or currently paused) on the computer system 7100. In some embodiments, a respective contextual user interface include one or more affordances for performing operations corresponding to the respective contextual user interface (e.g., an accept and/or decline affordance for joining or dismissing a communication session, affordances for activating and/or deactivating a full screen mode/screen-mirroring mode/Do Not Disturb mode/reading mode/driving mode/travel or motion-based mode, or media control affordances for media content that is playing on the computer system 7100).

Other possible examples of contextual user interfaces include application-related user interfaces, such as notifications, a user interface corresponding to a wireless sharing protocol (e.g., to transfer and/or share data with other computer systems), and/or a user interface displaying application function progress (e.g., a download progress for an active download, or update progress for an update of an application of the computer system 7100). In some embodiments, the computer system 7100 displays contextual user interfaces for a plurality of distinct applications (e.g., with one or more of the contextual user interfaces being displayed as additional content, for example, as shown in FIG. 7AP). For example, the notifications 7154, 7156, and 7158 in FIG. 7AP could each be notifications for three distinct applications (e.g., but notifications 7150, 7152, and 7154 are notifications for the same application). In some embodiments, the computer system 7100 displays contextual user interfaces that include at least one application-related user interface and at least one system-related user interface (e.g., the notifications 7148, 7150, 7152, 7154, and 7156 in FIG. 7AO are application-related user interfaces displayed concurrently with the system function menu 7024, a system-related user interface).

In some embodiments, in response to detecting that the user’s attention 7116 is no longer directed to one of the contextual user interfaces and/or the indicator 7010 of system function menu (e.g., for a threshold amount of time, such as 1 second, 2 seconds, or 5 seconds), the computer system ceases to display the contextual user interfaces. In some embodiments, the computer system 7100 ceases to display the contextual user interfaces in response to detecting a respective air gesture (e.g., in combination with a gaze input), a touch gesture, an input provided via a controller, and/or a voice command. In some embodiments, the computer system 7100 ceases to display the contextual user interfaces in response to detecting a user input that includes movement in a respective direction. For example, if the user input continues to move towards the right of the display of the computer system 7100 in FIG. 7AO, the computer system 7100 ceases to display the contextual user interfaces (e.g., because there are no additional user interfaces available for display beyond the system function menu 7024 (e.g., to the right of the system function menu 7024), but the user input continues to move in the rightward direction), in accordance with some embodiments.

Additional descriptions regarding FIG. 7AN-7AT are provided below in reference to method 13000 described with respect to FIG. 13, among other Figures and methods described herein.

FIG. 7AU-7AZ illustrate exemplary methods for dismissing indications of notifications. FIG. 14 is a flow diagrams of an exemplary method 14000 for dismissing indications of notifications. The user interfaces in FIG. 7AU-7AZ are used to illustrate the processes described below, including the processes in FIG. 14.

FIG. 7AU illustrates that at an initial time T₀ (depicted by the timer 7066-1), the user interface object 7056 is displayed (e.g., in place of the indicator 7010 of system function menu, as shown in FIG. 7A or FIG. 7AL) to inform the user 7002 about occurrence of an event. In some embodiments, the event corresponds to a notification recently received or generated at the computer system 7100 (e.g., as described above with reference to FIGS. 7L-7O). In some embodiments, a different user interface object is displayed (e.g., in place of the indicator 7010 of system function menu, or as an alternative appearance of the indicator 7010 of system function menu), depending on the relevant context (e.g., the user interface object 7056 is displayed if when the event is receiving (e.g., and/or generating) a notification, and the user interface object 7064 described above with reference to FIGS. 7R-7U is displayed if the event is receiving a communication request (e.g., a request for a telephone call, a VoIP call, a video conference call, or a copresence request for an AR or VR session) that is active for the computer system). In some embodiments, a different indicator (e.g., or the indicator 7010 of system function menu, the user interface object 7056, and/or the user interface object 7064) is displayed if the event is a change in state of an application (e.g., occurrence of an error, a request for user input, termination of a process, and/or other change in a state of the application). In some embodiments, a different indicator (e.g., or the indicator 7010 of system function menu, the user interface object 7056, and/or the user interface object 7064) is displayed if the event is a change in state of the computer system (e.g., battery charging completed, system update started or pending, low power mode started or ended, network connectivity started or interrupted, DND mode started or ended, and/or other changes in the system status or operation mode of the computer system 7100).

In some embodiments, some types of notifications (e.g., “system alerts” as referred to herein) do not cause the user interface object 7056 to be displayed. For example, system alerts relating to battery levels, object avoidance, and/or other users joining active communication sessions, do not cause the user interface object 7056 to be displayed (e.g., because the content of the system alert is time critical and/or high importance). In some embodiments, system alerts are displayed below the indicator 7010 of system function menu. In some embodiments, instead of displaying the user interface object 7056 (or another analogous user interface object at the same position as the user interface object 7056 in FIG. 7AU), and the computer system 7100 instead displays another visual indication for the system alert (e.g., at a different location, such as immediately below or to the left of, the location of the user interface object 7056 in FIG. 7AU).

In some embodiments, system alerts can be dismissed by directing the user’s attention to the system alert, and then directing the user’s attention away from the system alert. In some embodiments, system alerts are dismissed when the system function menu 7024 is displayed (e.g., if the user’s attention 7116 is directed to the indicator 7010 of system function menu). In some embodiments, the system alerts are concurrently displayed with the system function menu 7024 (e.g., if the user’s attention 7116 is directed to the indicator 7010 of system function menu), but the system alerts are dismissed if the user’s attention 7116 is directed to the system function menu 7024. In some embodiments, system alerts automatically disappear (e.g., are automatically dismissed) after a respective amount of time (e.g., 0.1, 0.2, 0.5, 1, 2, 5, 10, or 30 seconds, or a longer amount of time such as 1 minute, 5 minutes, or 10 minutes). In some embodiments, system alerts do not appear in the notification center (e.g., the notification center as described above with reference to FIG. 7K(c), or other user interfaces for accessing recently or previously received notifications), and optionally, dismissed system alerts are accessed through other user interfaces (e.g., a notification history user interface described below with reference to FIG. 7BA-7BJ).

In some embodiments, the user of the computer system 7100 can access one or more functions and/or settings of the computer system 7100 via a system alert (e.g., a system alert for battery level includes an affordance for accessing the battery settings of the computer system 7100). In some embodiments, the system alert includes one or more selectable options for performing operations corresponding to the system alert (e.g., or an event corresponding to the system alert). In some embodiments, the one or more selectable options for performing operations overlaps with (e.g., are the same as, or share functionality with) the one or more functions and/or settings of the computer system 7100.

FIG. 7AV illustrates that at a first time T₁ (depicted by the timer 7066-2) that is after the initial time T₀, the user’s attention 7116 has not been directed to the user interface object 7056, and the computer system 7100 maintains display of the user interface object 7056.

FIG. 7AW illustrates that at a second time T₄ (depicted by the time 7066-3), the indicator 7010 of system function menu is redisplayed (e.g., replaces display of the user interface object 7056) at the second time T₄, as the user’s attention 7116 was not directed to the user interface object 7056 before the second time T₄ (e.g., the user’s attention 7116 in FIG. 7AU and FIG. 7AV was never directed to the user interface object 7056, and the user’s attention 7116 was not directed to the user interface object 7056 between FIG. 7AV and FIG. AW (e.g., as shown by the user’s attention 7116 being in the same location in FIG. 7AW as in FIG. 7AU)).

FIG. 7AX-7AZ illustrate an alternative timeline to FIG. 7AV-7AW. In contrast to FIG. 7AU, in FIG. 7AX, at the first time T1 (depicted by the timer 7066-4), the user’s attention 7116 is directed to the user interface object 7056, and in response, the computer system displays a user interface 7168. In some embodiments, the user interface 7168 is a notification (e.g., the user interface 7168 is the same as the notification content 7060 described above with reference to FIGS. 7M and 7N). In some embodiments, the user interface 7168 is displayed in response to detecting the user’s attention 7116 has been directed to the user interface object 7056 for a threshold amount of time (e.g., 0.05, 0.1, 0.2, 0.5, 1,2, 5, 10, 30, or 60 seconds).

In some embodiments, the user interface 7168 is displayed at the same location as the system function menu 7024 (e.g., but the system function menu 7024 is not concurrently displayed with the user interface 7168). In some embodiments, the user interface 7168 is displayed concurrently with the system function menu 7024. In some embodiments, the user interface 7168 is displayed as partially overlapping, obscuring, or occluding the system function menu 7024 (e.g., as shown in FIG. 7AX). In some embodiments, the user interface 7168 is initially displayed without displaying the system function menu 7024, and if the user’s attention 7116 continues to be directed to the user interface object 7056, the system function menu 7024 is concurrently displayed with the user interface 7168 (e.g., after a threshold amount of time, such as 1 second, 2 seconds, or 5 seconds, as described above with reference to FIG. 7M). FIG. 7AX shows the system function menu 7024 with shading to indicate that the system function menu 7024 is optionally displayed. In some embodiments, the user interface 7168 is concurrently displayed with other contextual user interfaces (e.g., one or more of the user interfaces described above with reference to FIG. 7AM-7AT, such as the notification 7148, 7150, 7152, 7154, 7156, 7158, 7160, 7162, the user interface 7068, and/or the user interface 7166), depending on whether or not the corresponding criteria (e.g., for displaying a respective user interface) is met (e.g., at the time when the user’s attention is directed to the user interface object 7056 (e.g., which triggers display of the user interface 7168), or while the user interface 7168 is displayed).

In some embodiments, while the user interface 7168 is displayed, the computer system 7100 displays additional content (e.g., additional notification content not visible in FIG. 7AX) (e.g., graphical, textual objects, and/or control objects) associated with the user interface 7168. In some embodiments, the additional content is displayed in response to detecting that the user’s attention 7116 continues to be directed to the user interface 7168 (e.g., for a second threshold amount of time such as 1 second, 2 seconds, 5 seconds, 10 seconds, 30 seconds, or 1 minute, after the user interface 7168 is displayed (e.g., after the threshold amount of time described above for triggering display of the user interface 7168). In some embodiments, the additional content is displayed in response to an air gesture (e.g., an air tap or an air pinch) (e.g., in combination with detecting that the user’s attention is directed to the user interface 7168). In some embodiments, the user interface 7168 is replaced with the additional content. In some embodiments, the user interface 7168 expands or transforms to display the additional content.

For example, the user interface 7168 includes first notification content associated with a recently received notification, and the additional content includes second notification content associated with the recently received notification that is different from the first notification content. In some embodiments, the user interface 7168 includes a preview of notification content (e.g., less than all of the notification content) and the additional content includes the full notification content (e.g., an “expanded” version of the notification that includes all the notification content). In some embodiments, the additional content is (e.g., concurrently) displayed with one or more of the contextual user interfaces described above with reference to FIG. 7AN-7AT).

FIG. 7AY illustrates that at a time T₂ (depicted by the timer 7066-5) that is after the time T₁, the user’s attention 7116 is no longer directed to the user interface object 7056 (e.g., or the user interface 7168). In response, the computer system 7100 ceases to display the user interface 7168. In some embodiments, the computer system 7100 ceases to display the user interface 7168 after the user’s attention 7116 is no longer directed to the user interface object for a threshold amount of time (e.g., 0.1, 0.2, 0.5, 1, 2, 5, 10, 30, or 60 seconds). In some embodiments, if the user’s attention 7116 is redirected to the user interface object 7056 (e.g., or the user interface 7168) before the threshold amount of time, the computer system 7100 maintains display of the user interface 7168. This time buffer helps reduce the risk of the computer system 7100 incorrectly ceasing to display the user interface 7168).

FIG. 7AZ illustrates that at a time T₃ (depicted by the timer 7066-6) that is after the time T₂, the indicator 7010 of system function menu is redisplayed (e.g., replaces the user interface 7168, and/or the user interface object 7168 transforms into the indicator 7010 of system function menu).

In some embodiments, after the computer system 7100 ceases to display the user interface 7168, the user’s attention returns to the user interface object 7056 within a threshold amount of time (e.g., before the time T₃), and the computer system 7100 redisplays the user interface 7168 (e.g., and/or the user interface object 7056). After the threshold amount of time (e.g., at the time T₃ or later), if the user’s attention is directed to the indicator 7010 of system function menu (which is now displayed in place of the user interface object 7056), the computer system 7100 does not redisplay the user interface 7168, and optionally displays (or redisplays) the system function menu 7024 and/or any relevant contextual user interfaces (e.g., as described above with reference to FIG. 7AN-7AT). In some embodiments, after the computer system 7100 ceases to display the user interface 7168, the user’s attention returns to the area where the user interface 7168 was previously displayed, and within a threshold amount of time (e.g., before the time T₃), and the computer system 7100 redisplays the user interface 7168.

In some embodiments, after the time T₃, the user can access the previously displayed user interface 7168 (e.g., and/or content of the user interface 7168) through other means (e.g., through one or more user interfaces for displaying recent notifications, or previously received notifications). For example, if the user interface 7168 was a notification, the user can access a notification history user interface of the computer system 7100, by first invoking the system function menu 7024 (e.g., by directing the user’s attention 7116 to the indicator 7010 of system function menu in FIG. 7AM, and/or the region 7160 as described above with reference to FIG. 7AG-7AM (e.g., for displaying the indicator 7010 of system function menu)) and activating the notification affordance 7044 of the system function menu (e.g., as described above with reference to FIG. 7K(c) and FIG. 7BA-7BJ).

Additional descriptions regarding FIG. 7AU-7AZ are provided below in reference to method 14000 described with respect to FIG. 14, among other Figures and methods described herein.

FIG. 7BA-7BJ illustrate exemplary methods for displaying and interacting with previously received notifications. FIG. 15 is a flow diagrams of an exemplary method 15000 for displaying and interacting with previously received notifications in a notification history user interface. The user interfaces in FIG. 7BA-7BJ are used to illustrate the processes described below, including the processes in FIG. 15.

FIG. 7BA illustrates that the user’s attention 7116 is directed to the indicator 7010 of system function menu, and in response, the computer system 7100 displays the system function menu 7024. The system function menu 7024 includes a notifications affordance 7044 (e.g., the notifications affordance 7044 as described above with reference to FIG. 7K(c)). In some embodiments, the system function menu 7024 also includes one or more recently received notifications (e.g., notifications for events that satisfy timing criteria, such as notifications that were generated within a threshold amount of time (e.g., 5 minutes, 10 minutes, 30 minutes, 1 hour, 2 hours, 5 hours, 12 hours, or 24 hours) from the current time). The user can navigate through the one or more recently received notifications (e.g., the one or more recently received notifications are displayed vertically, and the user can navigate through the notifications by scrolling the notifications up or down; or the one or more recently received notifications are displayed horizontally, and the user can navigate through the notifications by scrolling left or right). In some embodiments, the user can only navigate through the one or more recently received notifications in one direction (e.g., only down, or only up, but not both up and down).

FIG. 7BB illustrates that while the system function menu 7024 is displayed, the user’s attention 7116 is directed to the notifications affordance 7044 (e.g., in combination with an air gesture (e.g., an air tap or an air pinch), an input via a hardware controller, and/or a verbal input).

FIG. 7BC illustrates that in response to detecting the user’s attention 7116 is directed to the notifications affordance 7044 (e.g., in combination with an air gesture (e.g., an air tap or an air pinch), an input via a hardware button, and/or a verbal input), the computer system 7100 displays a notification history user interface that includes notification content for notifications of the computer system 7100. The notification content includes content from a notification 7170, a notification 7172, a group 7174, and a notification 7178. In some embodiments, the notification 7170, the notification 7172, the group 7174, and the notification 7178 are (e.g., or represent) notifications that were previously generated and/or displayed by the computer system 7100, and/or that were automatically saved and/or dismissed by the computer system or the user of the computer system 7100. In some embodiments, the notifications 7170, 7172, 7174, and 7178 are notifications that satisfy timing criteria (e.g., are notifications that were generated within a threshold amount of time (e.g., 5 minutes, 10 minutes, 30 minutes, 1 hour, 2 hours, 5 hours, or 12 hours) from the current time).

In some embodiments, notification content is grouped by application. For example, the notification 7170 is a notification for a first application (e.g., Application 1), the notification 7172 is a notification for a second application (e.g., Application 2, which is different than Application 1), the group 7174 is a representative notification for a group of notifications for a third application (e.g., Application 3, which is different from Application 1 and Application 2), and the notification 7178 is a notification for a fourth application (e.g., Application 4, which is different from Application 1, Application 2, and Application 3).

In some embodiments, multiple notifications for a single application are grouped together (e.g., and represented as a “stack” of notifications). For example, an indication 7176 appears below (e.g., and behind) the group 7174 for the third application, indicating that there is at least one other notification for the third application that is not currently shown (e.g., fully shown on the display of the computer system 7100 in FIG. BC).

In some embodiments, the notification content includes notifications for up to a maximum number of different applications. For example, in FIG. 7BC, the notification content includes notifications for four applications (e.g., Applications 1-4). An indicator 7180 is displayed to the right (e.g., and behind) the notification 7180, indicating that there are additional notifications (e.g., for applications other than Applications 1-4) that can be displayed (e.g., accessed through one or more user inputs, such as those described in further detail below with reference to FIG. 7BH).

In some embodiments, the notifications 7170, 7172, 7174, and 7178 have an appearance that is at least partially based on the physical and/or virtual environment that is displayed behind the notifications 7170, 7172, 7174, and 7178. For example, the representation 7014′ of the physical object 7014 is displayed behind the notifications 7170 and 7172 (e.g., the notifications 7170 and 7172 are displayed in front of, or on top of, the representation 7014′ in the view of the user 7002). The lower right corner of the notification 7170 occludes the representation 7014′, and so the lower right corner of the notification 7170 is displayed with a different appearance (e.g., as shown by the shading the lower right corner of the notification 7170 in FIG. 7BG) than the portions of the notification 7170 that do not occlude the representation 7014′. Similarly, a bottom portion of the notification 7172 occludes the representation 7014′, and is displayed with a different appearance (e.g., the same or similar appearance as the lower right corner of the notification 7170) than the portions of the notification 7172 that do not occlude the representation 7014′.

In some embodiments, the different appearance is a different brightness (e.g., the lower right corner appears lighter or darker than the portions of the notification 7170 and/or the notification 7172 that do not occlude the representation 7014′). In some embodiments, the different appearance is a different color (e.g., the lower right corner has a different color than the portions of the notification 7170 and/or the notification 7172 that do not occlude the representation 7014′). In some embodiments, the different appearances are based at least in part on a visual characteristic of the representation 7014′ (e.g., the different appearance is a different color, and the different color is selected based on the color(s) of the portion of the representation 7014′ that is occluded by the notification 7170 and/or the notification 7172).

A bottom portion of the group 7174 occludes the representation 7014′, and so the bottom portion of the group 7174 is also displayed with a different appearance than other portions of the group 7174. In some embodiments, the lower right corner of the notification 7170 and the bottom portion of the group 7174 have the same appearance (e.g., the same darkness and/or the same color).

The group 7174 occludes the virtual object 7012, and so the lower right corner of the group 7174 is displayed with a different appearance (e.g., darker than and/or a different color than) than other portions of the group 7174. In some embodiments, the lower right corner of the group 7174 is displayed with a different appearance (e.g., darker than) than the other portions of the group 7174, and the different appearance is also different from the appearance of the lower right corner of the group 7174 (e.g., the lower right corner of the group 7174 is displayed with an appearance that is not as dark as the bottom portion of the notification 7172 and/or the lower right corner of the notification 7170 (e.g., because the representation 7014′ has a darker appearance than the virtual object 7012)). In some embodiments, the difference in darkness between the lower right corner of the group 7174 and the bottom portion of the notification 7172 and/or the lower right corner of the notification 7170 is proportional to the difference in darkness between the virtual object 7012 and the representation 7014′.

In some embodiments, the different appearance is a different brightness (e.g., the lower right corner appears lighter or darker than the portions of the group 7174 that do not occlude the virtual object 7012). In some embodiments, the different appearance is a different color (e.g., the lower right corner has a different color than the portions of the group 7174 that do not occlude the virtual object 7012). In some embodiments, the different appearances are based at least in part on a visual characteristic of the virtual object 7012 (e.g., the different appearance is a different color, and the different color is selected based on the color(s) of the portion of the virtual object 7012 that is occluded by the group 7174).

In FIG. 7BC, the user’s attention 7116 is directed to the notification 7172 (e.g., in combination with an air gesture (e.g., an air tap or an air pinch) and/or input via hardware button). In response, as shown in FIG. 7BD, the computer system 7100 displays an expanded version of the notification 7172, in accordance with some embodiments. In some embodiments, the notification 7172 (in FIG. 7BC) is a preview of notification content (e.g., displays less than all available notification content), and the expanded version of the notification 7172 includes all of the available notification content.

FIG. 7BD also illustrates that the expanded version of the notification 7172 also has an appearance that reflects the physical and/or virtual elements displayed behind the expanded version of the notification 7172, in accordance with some embodiments. The lower left corner of the expanded version of the notification 7172 occludes the representation 7014′, and is displayed with a similar appearance to (e.g., the same appearance as) the bottom half of the notification 7172 in FIG. 7BC. The lower right corner of the expanded version of the notification 7172 occludes the virtual object 7012, and is displayed with a similar appearance to (e.g., the same appearance as) the lower right corner of the group 7174 in FIG. 7BC, in accordance with some embodiments.

The computer system 7100 also displays the affordance 7182, as well as a “Back” affordance 7188, in accordance with some embodiments. In response to detecting that the user’s attention 7116 is directed to the “Back” affordance 7188 (e.g., in combination with an air gesture such as an air tap or an air pinch or another selection gesture), and as shown in FIG. 7BE, the computer system 7100 redisplays the notification history user interface (e.g., FIG. 7BE and FIG. 7BE show the same notification history user interface in the same state and/or with the same appearance), in accordance with some embodiments.

In some embodiments, the computer system 7100 displays an expanded version of the notification 7170 (or the notification 7178), in response to detecting that the user’s attention 7116 is directed to the notification 7170 (or the notification 7178), in a similar fashion as described above with reference to the notification 7172.

In response to detecting that the user’s attention 7116 is directed to the group 7174, and as shown in FIG. 7BF, the computer system 7100 displays a notification 7174-a and a notification 7174-b, both of which correspond to the third application (e.g., Application 3), and both of which are represented by the group 7174 (e.g., in FIGS. 7BC and 7BE), in accordance with some embodiments. In some embodiments, the group 7174 displays at least a portion of content of the notification 7174-a (e.g., the group 7174 includes a preview of the notification content of the notification 7174-a). In some embodiments, the group 7174 displays at least a portion of content of the notification 7174-a and at least a portion of content of the notification 7174-b.

In some embodiments, only notifications corresponding to the third application (e.g., Application 3) are displayed (e.g., in FIG. 7BF, the notification 7170 corresponding to the first application, the notification 7172 corresponding to the second application, and the notification 7178 corresponding to the fourth application, are not displayed, because those notifications correspond to applications that are different from the third application).

In some embodiments, the notification 7174-a and the notification 7174-b are displayed (in FIG. 7BF) at the same locations as the notification 7170 and the notification 7172 in FIG. 7BE, respectively. In some embodiments, the notification 7174-a and the notification 7174-b are displayed (in FIG. 7BF) are displayed with the same visual appearance as the notification 7170 and the notification 7172 in FIG. 7BE (e.g., because they appear the in the same locations, which occlude the representation 7014′ in the same way).

In some embodiments, the computer system 7100 displays additional notifications corresponding to the third application (Application 3). In some embodiments, the computer system 7100 displays up to a maximum number of notifications (e.g., a maximum of four notifications) for the third application. In some embodiments, the maximum number of notifications for the third application is the same as the maximum number of notifications for the notification history user interface (e.g., the maximum as described above with reference to FIG. 7BC). In some embodiments, if more than the maximum number of notifications are available for display, the computer system 7100 displays an indication of the additional notifications (e.g., in an analogous manner to the indicator 7180 described above with reference to FIG. 7BC).

In response to detecting that the user’s attention 7116 is directed to a “Back” affordance 7190, and as shown in FIG. 7BG, the computer system 7100 redisplays the notification history user interface, in accordance with some embodiments.

In response to detecting that the user’s attention 7116 is directed to a location that is near the right edge of the display of the computer system 7100, and as shown in FIG. 7BH, the computer system 7100 scrolls display of notification content in the notification history user interface, in accordance with some embodiments. In some embodiments, the user’s attention 7116 is directed to the indicator 7180. In some embodiments, the user’s attention 7116 is directed to a respective region that extends from the right edge of the display (e.g., a region extending by a threshold amount of distance, such as 0.5 mm, 1 cm, 2 cm, 5 cm, from the right edge of the display). In some embodiments, the user’s attention 7116 is directed to the notification 7178.

In FIG. 7BH, the notification 7170 is no longer displayed (e.g., has been scrolled off the display of the computer system 7100). The notification 7172 scrolls to the left, to the position previously occupied by the notification 7170 (e.g., in FIG. 7BG, prior to scrolling), and is displayed with the same appearance as the notification 7170 in FIG. 7BG (e.g., the appearance of the notification 7170 changes to reflect the new position of the notification 7170, based on the physical and virtual environment behind the notification 7170), in accordance with some embodiments.

The group 7174 scrolls to the left, to the position previously occupied by the notification 7172 (e.g., in FIG. 7BG, prior to scrolling), and is displayed with the same appearance as the notification 7172 in FIG. 7BG, in accordance with some embodiments. The notification 7178 scrolls to the left, to the position previously occupied by the group 7174 (e.g., in FIG. 7BG, prior to scrolling), and is displayed with the same appearance as the group 7174 in FIG. 7BG, in accordance with some embodiments.

A notification 7192 for a fifth application (e.g., Application 5, which is different from Applications 1-4) is displayed at the location previously occupied by the notification 7178 (e.g., in FIG. 7BG, prior to scrolling), in accordance with some embodiments. The indicator 7180 remains displayed (e.g., behind the notification 7180) to indicate that additional notifications can be displayed, in accordance with some embodiments.

In some embodiments, an indicator (e.g., similar to the indicator 7180, but flipped along the horizontal axis) is displayed behind the notification 7172 to indicate that the notification 7170 has been scrolled off the display. In some embodiments, the notification 7170 can be redisplayed (e.g., the notifications can be scrolled to the right), for example, in response to detecting that the user’s attention is directed to a location that is near the right edge of the display of the computer system 7100 (or any of the alternatives discussed above with reference to the user’s attention in FIG. 7BG, but applied to the left edge instead of the right edge, or the notification 7172 instead of the notification 7178).

In FIG. 7BH, the user’s attention 7116 is directed to the notification 7178. In response to detecting that the user’s attention 7116 is directed to the notification 7178, optionally in conjunction with an air gesture (e.g., an air tap or an air pinch, or another gesture or input, such as activation of a hardware button of the computer system 7100), the computer system 7100 ceases to display the notification 7178, in accordance with some embodiments.

FIG. 7BI shows that the notification 7178 is no longer displayed. The notification 7192 is displayed in the location that the notification 7178 was previously displayed at (in FIG. 7BH), and a new notification 7180 for a sixth application (e.g., an Application 6, different from Applications 1-5) is displayed. The indicator 7180 remains displayed to indicate that additional notifications, which are not currently displayed, are available for display (e.g., by dismissing and/or ceasing to display one or more currently displayed notifications, as described above for the notification 7178 in FIG. 7BH). In some embodiments, if no additional notifications are available for display (e.g., the computer system 7100 has only received and/or generated notifications for six applications), then the indicator 7180 ceases to be displayed.

In some embodiments, the user 7002 performs an analogous input (e.g., directing the user’s attention 7116 to a notification or group, and performing an air gesture such as an air tap or an air pinch, as described above with reference to FIG. 7BH), with the user’s attention directed to a group representation of multiple notifications (e.g., the group 7174, which represents two notifications 7174-a and 7174-b). In response to detecting the user input directed to the group representation, the computer system 7100 ceases to display (e.g., dismisses) a first notification represented by the group representation (e.g., the group 7174), in accordance with some embodiments. For example, if the user input was directed to the group 7174, the computer system 7100 would cease to display notification content (e.g., a preview of notification content) corresponding to the notification 7174-a, and optionally, would update display of the group 7174 to include notification content (e.g., a preview of) the notification 7174-b (e.g., because the notification 7174-b is the “next” notification in the group 7174), in accordance with some embodiments. In some embodiments, this process can be repeated multiple times (e.g., to dismiss each notification represented by a group representation, in sequence). In some embodiments, if the group representation is displaying content for only a single notification (e.g., because other notifications previously represented by the group representation have been dismissed), the computer system 7100 does not display the indicator 7176 (or an analogous indicator 7176 for indicating the group representation represents multiple notifications), because the group representation now represents only a single (e.g., remaining) notification. In some embodiments, once the group representation represents only a single remaining notification, the group representation can be dismissed with analogous behavior to individual notifications (e.g., as described above with reference to dismissing the notification 7178, in FIG. 7BH).

In some embodiments, even if the group representation represents multiple notifications, the entire group representation (e.g., the group 7174, in its entirety) is dismissed in response to detecting user input directed to the group representation. In some embodiments, the computer system 7100 ceases to display a first notification represented by the group 7174 if the user input meets first criteria (e.g., is a first type of input, such as an air gesture (e.g., an air tap or an air pinch)), and the computer system 7100 ceases to display the group representation (e.g., all notifications represented by the group 7174) if the user input meets second criteria different from the first criteria (e.g., is a second type of input, different from the first input). In some embodiments, the second criteria are an extension of the first criteria (e.g., the first criteria are met if the user’s attention is directed to the group representation for a first threshold amount of time, and the second criteria are met if the user’s attention remains directed to the group representation for a second threshold amount of time that is longer than the first threshold amount of time (where both the first threshold amount of time and the second threshold amount of time are measured from the same starting point (e.g., a time when the computer system 7100 first detects that the user’s attention is directed to the group representation)).

In some embodiments, a group representation for a group of notifications includes, optionally in a peripheral region of and/or around a representative notification of the group, an affordance for dismissing an individual notification (e.g., the representative notification for the group, or the top notification of the group that is currently displayed) and/or an affordance for dismissing the entire group of notifications. In response to detecting that the user’s attention is directed to the affordance for dismissing individual notification (e.g., in combination with an air gesture (e.g., an air tap or an air pinch), an input via a hardware controller, and/or a verbal input), the computer system 7100 ceases to display an individual notification (e.g., the current notification representing the group of notifications) (e.g., and optionally displays another notification of the group of notifications, as the representative notification for the group of notifications). In response to detecting that the user’s attention is directed to the affordance for dismissing the entire group of notifications (e.g., in combination with an air gesture (e.g., an air tap or an air pinch), an input via a hardware controller, and/or a verbal input), the computer system 7100 ceases to display the group representation (e.g., and all notifications represented by the group representation), in accordance with some embodiments.

FIG. 7BJ illustrates that the computer system 7100 also displays an affordance 7182 for ceasing to display the notification history user interface (e.g., without dismissing any notifications in the notification history user interface, such that the notifications shown in FIG. 7BJ can be redisplayed (e.g., by repeating the inputs described above with reference to FIGS. 7BA and 7BB)), and a “Clear All” affordance 7184 for dismissing notifications (e.g., dismissing some or all of the notifications) in the notification history user interface (e.g., and the dismissed notifications are not subsequently redisplayed if the user 7002 performs the user input(s) to display the notification history user interface), in accordance with some embodiments.

FIG. 7BJ also illustrates that, in some embodiments, the notifications in the notification history user interface are viewpoint-locked. In FIG. 7BI, the user 7002 is located at a location 7026-g in the physical environment. In FIG. 7BJ, the user 7002 moves to a location 7026-h in the physical environment. The computer system 7100 updates the view of the three-dimensional environment (e.g., including representations of physical objects such as the representation 7014′, representations of the physical environment, and/or virtual elements, such as the virtual object 7012) to reflect the change in the position of the user 7002 (e.g., because the physical change in position of the user 7002 in the physical environment also changes the viewpoint of the user in the three-dimensional environment, and/or the view of the three-dimensional environment presented through the viewport provided by the display generation component). For example, in FIG. 7BJ, the representation 7014′ and the virtual object 7012 appear further to the right, in the view of the three-dimensional environment, as compared to FIG. 7BI.

As shown in FIG. 7BJ, the computer system 7100 also updates the appearance of each displayed notification or group, in accordance with some embodiments. For example, the group 7174 in FIG. 7BI occludes the representation 7014′, but does not occlude the representation 7014′ or the virtual object 7012 in FIG. 7BJ, so the computer system 7100 displays the group 7174 with an appearance based at least in part on the appearance of a representation of the physical wall 7004, which is displayed behind the group 7174 in FIG. 7BJ (e.g., an appearance that is the same as the appearance of the notification 7178 in FIG. 7BC, which does not occlude the representation 7014′ or the virtual object 7012, or any other physical or virtual object other than the representation of the physical wall 7004), in accordance with some embodiments. The notification 7192 occludes the virtual object 7012 in FIG. 7BI, but occludes the representation 7014′ in FIG. 7BJ, so the computer system 7100 displays the notification 7192 with a different appearance in FIG. 7BJ (e.g., an appearance similar to the group 7174 in FIG. 7BI, based on an amount and manner in which the respective notification occludes the representation 7014′), in accordance with some embodiments. The notification 7194 did not occlude any physical or virtual object in FIG. 7BI (e.g., and is displayed with a default appearance), but occludes the representation 7014′ in FIG. 7BJ, so the computer system 7100 displays the notification, in accordance with some embodiments. In some embodiments, the computer system 7100 updates the appearance of the displayed notifications and groups while the user 7002 moves from the location 7026-g to the location 7026-h. In some embodiments, the computer system 7100 updates the appearances of the displayed notifications and groups after respective time thresholds (e.g., every 0.01, 0.02, 0.05, 0.1, 0.2, 0.5, 1, or 2 seconds) are met. In some embodiments, the computer system 7100 updates the appearances of the displayed notifications and groups after respective time thresholds are met after (e.g., in response to detecting that) the computer system 7100 detects that the computer system 7100 is substantially stationary (e.g., the user 7002 moves the computer system 7100 by less than a threshold amount during a threshold time period).

In some embodiments, the notifications and groups in the notification history user interface are environment-locked, and do not move in accordance with movement of the user (e.g., or changes to the viewpoint of the user). For example, the notifications and groups in FIG. 7BI maintain the same spatial relationship to the representation 7014′ and the virtual object 7012, regardless of the movement of the user 7002 and/or the computer system 7100, in accordance with some embodiments.

In some embodiments, the notifications and groups in the notification user interface cannot be manually positioned by the user (e.g., the computer system 7100 determines the locations of the notifications and groups in the notification user interface, and those locations cannot be modified by the user 7002 (e.g., via gaze inputs, air gestures, and/or movement)). In some embodiments, the notifications and groups in the notification user interface cannot be manually positioned by the user, regardless of whether the notifications and groups are viewpoint-locked or environment-locked.

Additional descriptions regarding FIG. 7BA-7BJ are provided below in reference to method 15000 described with respect to FIG. 15, among other Figures and methods described herein.

FIG. 7BK-7BR illustrate exemplary methods for moving, hiding and redisplaying user interface objects in accordance with some embodiments. In FIG. 7BK- 7BR, different criteria are used for displaying different types of user interface objects as the viewpoint of the user moves and the currently displayed view of the three-dimensional environment changes. FIGS. 16A-16B are flow diagrams of an exemplary method 16000 for hiding and redisplaying user interface objects in accordance with movement of a viewpoint of a user, in accordance with some embodiments. The user interfaces in FIG. 7BK-7BR are used to illustrate the processes described below, including the processes described with respect to FIGS. 16A-16B.

FIG. 7BK illustrates a plurality of user interface objects (e.g., user interface objects corresponding to different system functions and/or applications), including notification 7196, alert 7198-1, virtual assistant 7200-1 and system function menu 7024. In some embodiments, notification 7196 is displayed in response to occurrence of an event associated with an application that is executing on the computer system. In some embodiments, alert 7198-1 is a system alert that is displayed automatically in accordance with detection of a change in a respective system status (e.g., low battery, system update available, Bluetooth connection change, or other system function alert). In some embodiments, virtual assistant 7200-1 is displayed in response to a user input invoking the virtual assistant, for example, a voice command and/or a user input directed to a button to invoke the virtual assistant. In some embodiments, system function menu 7024 is displayed in response to detecting the user’s attention directed to the indicator of system function menu (e.g., indicator 7010), as described above with reference to FIG. 7B.

In some embodiments, a respective type of user interface objects has a corresponding hiding behavior, such that one or more of the user interface objects automatically, without user input, cease to be displayed in accordance with respective hiding criteria being met. For example, notification 7196 continues to be displayed until a threshold amount of time has passed (e.g., 30 seconds, 1 minute, 5 minutes, or another amount of time), and, after the threshold amount of time has passed, notification 7196 automatically ceases to be displayed, and/or notification 7196 continues to be displayed until the user interacts with (e.g., directs the user’s attention to) the notification 7196. In some embodiments, alert 7198-1 continues to be displayed until a user input is detected for dismissing the alert 7198-1. In some embodiments, system function menu 7024 continues to be displayed while the user’s attention is directed to (e.g., or in an area around) system function menu 7024, and automatically ceases to be displayed in accordance with a determination that the user’s attention is not directed to system function menu 7024, as described above. In some embodiments, the user interface object for virtual assistant 7200-1 is displayed for a threshold amount of time (e.g., 20 seconds, 1 minute, or another amount of time) before automatically ceasing to be displayed, is displayed until the user has interacted with (e.g., and/or dismisses) the virtual assistant, and/or is displayed until the user moves (e.g., and/or changes the user’s viewpoint by a threshold amount). In some embodiments, after ceasing to be displayed in the three-dimensional environment, user interface objects of the different types are optionally redisplayed at a same or a different position in the three-dimensional environment, in accordance with respective redisplay criteria being met.

In some embodiments, a respective type of user interface objects has a corresponding follow behavior such that one or more of the user interface objects automatically, without user input, moves and follows the movement of the user and/or movement of the viewpoint of the user, in accordance with respective criteria being met. In some embodiments, different types of objects have different behaviors with respect to whether and/or how to move in accordance with movement of the user and/or movement of the viewpoint of the user. For example, in some embodiments, objects of a first type exhibit a continuous follow behavior, objects of a second type exhibit a delayed follow behavior, objects of a third type do not follow but instead are dismissed when certain movement of the user or viewpoint thereof is detected and are redisplayed in response to an explicit reinvocation input, and other objects (e.g., objects not of the first, second or third type) are world-locked and do not follow or get dismissed from the three-dimensional environment in response to movement of the user or viewpoint thereof. In some embodiments, during movement of the user and/or viewpoint thereof, a user interface object exhibiting a continuous follow behavior is always within a currently displayed view of the three-dimensional environment, while a user interface object exhibiting a delayed follow behavior may cease to be visible in the currently displayed field of view (e.g., the user interface object has not moved or has not caught up with the movement of the viewpoint), and the user interface object is displayed in the currently displayed view of the three-dimensional environment after the viewpoint has stopped moving (e.g., moved less than a threshold amount in a unit of time) for at least a threshold amount of time, in accordance with respective redisplay criteria being met. In some embodiments, not all of the user interface objects described herein are displayed concurrently. In some embodiments, user interface objects of a subset of the different types of user interface objects are concurrently displayed in the same view of the three-dimensional environment, and exhibit different behaviors in accordance with the movement of the user or viewpoint thereof. For example, although FIG. 7BK illustrates notification 7196, alert 7198-1, virtual assistant 7200-1 and system function menu 7024 in a same view, in some embodiments, a subset, less than all, of the user interface objects are concurrently displayed.

It will be understood that although the user interface objects in FIG. 7BK are displayed at respective positions within the current view of the three dimensional environment, the user interface objects may be displayed at other respective positions in the current view. For example, system function menu 7024 is shown as displayed in the upper right area of the current view, but could also (e.g., or instead) be displayed in a middle and/or top area of the current view, or in another portion of the current view. Similarly, notification 7196 and/or alert 7198-1, in some embodiments, are displayed at different portions of the current view (e.g., next to and/or extending from system function menu 7024, on another edge of the current view, or elsewhere in the three dimensional environment).

It will also be understood that while the examples below describe certain types of user interface objects having particular movements and/or follow behaviors, in some embodiments, the user interface objects (e.g., and/or other user interface objects) may have a different type of movement and/or follow behavior in a different embodiment. For example, in the examples described below, notification 7196 is described as being of the first type of user interface object, and thus having a continuous follow behavior, but could also (e.g., or instead) be considered a different type of user interface object, and thus have a different follow behavior described herein in accordance with some embodiments. For example, notification 7196 is optionally assigned as a second type of user interface object that corresponds to a delayed follow behavior, wherein the notification 7196 is dismissed or hidden and, is optionally respawned in another view (e.g., the settled view).

In some embodiments, the first type of the plurality of types of user interface objects corresponds to user interface objects that have the continuous follow behavior. For example, user interface objects of the first type continue to be displayed in the current view of the user as the user moves or otherwise changes the user’s current viewpoint of the three dimensional environment. In some embodiments, user interface objects of the first type include one or more of a system function menu (e.g., system function menu 7024, or other system function menus), notifications for a plurality of applications (e.g., including notification 7196, and/or other notifications), and closed captions (e.g., textual description or transcription displayed for media content playing back in an application window).

In some embodiments, different categories of user interface objects of the first type have different manners of continuous follow behavior. For example, notification 7196 and system function menu 7024 are both user interface objects of the first type that have continuous follow behavior (e.g., and optionally continuously follow the user’s viewpoint in different manners). For example, how closely a respective user interface object of the first type follows the movement of the viewpoint of the user is based on the category of the user interface object. For example, the amount of movement and/or rate of movement of notification 7196 and system function menu 7024 (e.g., and/or for other user interface objects in the first category, such as closed captions) are different from each other, for the same movement of the viewpoint of the user in the three-dimensional environment, as described below. In some embodiments, the criteria for triggering the initiation of the continuous follow behavior are optionally different for different categories of user interface objects that exhibit the continuous follow behavior. For example, the computer system optionally implements different distance, angle, and/or speed requirements different categories of the user interface objects exhibiting the continuous follow behavior to start following the viewpoint in response to the movement of the viewpoint. In some embodiments, different categories of user interface objects that exhibit continuous follow behavior also have different simulated movement characteristics (e.g., simulated inertia, movement paths, delay distance, delay time, catchup rate, and other characteristics).

In some embodiments, a respective user interface object (e.g., and/or a respective category of user interface object) of the first type is assigned a damping factor that defines a rate at which the respective user interface object follows (e.g., and/or lags behind) the user’s movements that change the user’s viewpoint. For example, in FIG. 7BL, system function menu 7024 is maintained at a same position relative to the viewpoint of the user (e.g., maintaining its spatial relationship to the currently displayed view of the three-dimensional environment, and to the field of view provided via the display generation component), while notification 7196 lags behind (e.g., is displayed to the left relative to its position in FIG. 7BK), as notification 7196 is slower (e.g., has a larger damping factor) to follow the movement of the current viewpoint of the user than system function menu 7024 (e.g., which has a smaller damping factor). In some embodiments, notification 7196 moves at a slower rate than the movement of the current viewpoint of the user and thus appears to lag behind the movement of the viewpoint of the user. In some embodiments, notification 7196 continues to move (e.g., at the slower rate) until it reaches a same position relative to the currently displayed view of the three-dimensional environment it had when notification 7196 was displayed in FIG. 7BK. For example, in FIG. 7BL, notification 7196 is displayed to the left of the center of the current view, and continues to shift to the right until it is displayed in a top-center of the current view again.

In FIG. 7BL, the user 7002 moves to a new location in the physical environment 7000. In some embodiments, after moving to the new location, a different view of the physical environment 7000 (e.g., as compared to the view of the physical environment 7000 that is visible in FIG. 7BK), is visible (e.g., via the display generation component of the computer system 7100), in accordance with the movement of the user 7002 (e.g., such that the viewpoint of the user is updated). For example, the user 7002 has moved closer and to the right of the physical object 7014 (e.g., and closer to the physical wall 7006), such that, in the view of the physical environment that is visible via display generation component of the computer system 7100, the representation 7014′ of the physical object 7014 is seen with a larger size (e.g., as compared to the size of the representation 7014′ in FIG. 7BK) and with a different relative location compared to the viewpoint of the user (e.g., is farther to the right in the view of the three dimensional environment that is shown in FIG. 7BL, than in the view of the three dimensional environment that is shown in FIG. 7BK).

In some embodiments, FIG. 7BK-7BP illustrate changes in the viewpoint of the user before the viewpoint has settled at a particular location (e.g., in FIG. 7BQ). For example, the movements of the viewpoint described with reference to FIG. 7BK-7BP are unsettled movements, before the viewpoint has settled at a fixed position. In some embodiments, the system determines that the viewpoint of the user has settled at a fixed position in accordance with a determination that the user has maintained a same view for a threshold amount of time (e.g., 0.1, 0.2, 0.5, 1, 2, or 5 seconds, or another amount of time). In some embodiments, the viewpoint of the user is considered unsettled in accordance with a determination that the user’s movements are above a threshold rate (e.g., the user is moving quickly and causing the viewpoint to change). In some embodiments, the viewpoint of the user is determined as settled at a fixed viewpoint if the user’s movements above a threshold rate come to a sudden stop (e.g., the user quickly turns the user’s head and/or torso before pausing movement). For example, if the user’s movement is continuous and unsettled, the user interface objects are displayed with different follow and/or movement behaviors until the user’s movement settles, at which point the user interface objects are optionally redisplayed at their initial positions (e.g., in FIG. 7BK, before the user’s movement begins) relative to the view of the three-dimensional environment that corresponds to the settled viewpoint of the user.

FIG. 7BL illustrates virtual object 7012, which is world-locked, in accordance with some embodiments. Virtual object 7012 does not have a follow behavior (e.g., the position of virtual object 7012, relative to the three dimensional environment, does not update in accordance with detected movement of the user’s viewpoint). For example, virtual object 7012 is not of the first, second or third type of objects that have a follow behavior. As such, virtual object 7012 appears at a same location within the three dimensional environment even as the user’s viewpoint changes (e.g., if the user looks away, virtual object 7012 does not move to stay in the user’s field of view, and if the user looks back, virtual object 7012 is maintained at a same position in the three dimensional environment as it appeared before the user looked away). For example, one or more other virtual objects, such as virtual application windows in the three dimensional environment, are world-locked such that, if the user turns away from an application window, the application window does not follow the user’s updated viewpoint, but if the user turns back to the one or more application windows, the one or more application windows appear to remain at the same positions in the three dimensional environment.

FIG. 7BL further illustrates the follow behavior of alert 7198-2. In some embodiments, alert 7198 (e.g., shown as alert 7198-1 through alert 7198-7) is an example of a user interface object of the second type, whereby user interface objects of the second type have a delayed follow behavior (e.g., also referred to herein as respawn behavior). For example, user interface objects of the second type optionally are maintained at a same position (e.g., and are optionally visually deemphasized and/or cease to be displayed) in the three dimensional environment while the movement of the viewpoint is unsettled, and the user interface objects of the second type respawn at a new position in the three dimensional environment, to appear at a same position relative to the currently displayed view of the three-dimensional environment when the user’s viewpoint is settled.

In some embodiments, user interface objects of the second type include one or more of a setup user interface (e.g., that is displayed to setup the computer system and optionally includes one or more controls for settings/preferences and/or informational tips to navigate the computer system during an initial setup process), a system alert (e.g., alert 7198-1, or other alerts related to system status changes or alerts that require the user’s attention or input in order to be dismissed), and a media player window that plays back media content (e.g., a mini media player window that has a reduced set of controls as compared to a regular media player window) that displays media content. In some embodiments, the media player window (e.g., mini media player window) is concurrently displayed with an application window (e.g., that is world-locked), at a size that is smaller than the application window (e.g., the media player is a miniature window that continues to playback media content as the user’s viewpoint changes), such that, in response to the user changing viewpoints, and upon the user settling at a current viewpoint, the media player window is respawned at a same position relative to the user’s current viewpoint without updating (e.g., respawning) a position of the application window (e.g., the application window remains at a same position in the three dimensional environment). In some embodiments, the mini media player window may appear as overlaid on top of other content and windows in the three-dimensional environment, even as the user interacts with the other content and/or windows.

In some embodiments, user interface objects of the second type demonstrate delayed follow behavior, but different categories of the user interface objects of the second type optionally exhibit different delayed follow behaviors. For example, a system alert is an example of user interface objects in a first category of the second type of user interface objects, and the system alert ceases to be displayed while the user’s viewpoint changes (e.g., before the user’s viewpoint settles), while alert 7198-2 (e.g., which is in a second category of the second type of user interface objects) is faded and/or blurred while the user’s viewpoint changes, and the media player window (e.g., which is in a third category of the second type of user interface objects) optionally fades and/or blurs out by a different amount than alert 7198-2.

In some embodiments, the different user interface objects of the second type are respawned at different times based on when the user settles at the new viewpoint, as described below with respect to FIG. 7BQ. For example, for alert 7198-1, the user’s viewpoint is determined as settled in accordance with a determination that the user’s viewpoint satisfies first criteria (e.g., having less than a first threshold amount of movement within a unit of time, for at least a first threshold amount of time), while another category of user interface objects, such as a mini media player window, has different criteria (e.g., having less than a second threshold amount of movement within a unit of time, for at least a second threshold amount of time) for determining that the user’s viewpoint is settled (e.g., and thus respawns before or after the alert 7198-1 respawns).

For example, in FIG. 7BK-7BL, in response to the user’s viewpoint changing, alert 7198-1 is visually deemphasized (e.g., blurred, faded, increased in translucency, shrinks, and/or disappears) without moving in the three-dimensional environment to follow the movement of the user’s viewpoint. For example, alert 7198-2 is displayed at a same position in the three dimensional environment (e.g., above representation of physical object 7014′) as the viewpoint of the user changes (e.g., while notification 7196 updates its position to follow the movement of the user’s viewpoint).

In some embodiments, the user interface object for virtual assistant 7200-1 is an example of the third type of user interface objects (e.g., dismissed user interface objects) that do not exhibit a follow behavior, but when re-invoked by an explicit user input, appear at a new position within the currently displayed view of the three-dimensional environment. For example, the user interface object for virtual assistant 7200-1 optionally ceases to be displayed as the user’s viewpoint moves, and is not redisplayed upon the user’s viewpoint settling in FIG. 7BQ. In some embodiments, virtual assistant 7200-1 is instead redisplayed in a currently displayed view of the three-dimensional environment in response to detecting a user input to invoke the virtual assistant (e.g., not in response to detecting the user’s viewpoint is settled), as described with reference to FIG. 7BQ-7BR. In some embodiments, additional and/or alternative user interface objects are considered to be of the third type of user interface objects. For example, a home user interface that includes indications of applications that the user is enabled to launch from the home user interface is included in the third type of user interface objects. In some embodiments, the user interface objects of the third type include a notification center user interface object (e.g., that displays a list of notifications that have been saved or that have not been explicitly dismissed by a user), an expanded notification (e.g., a notification that displays additional notification content and/or controls compared to notification 7196, optionally displayed in response to a user’s gaze directed to the notification for at least a threshold amount of time), a control center user interface for accessing one or more system settings and/or controls, and/or a virtual keyboard.

In some embodiments, as the user’s viewpoint continues to change, for example in FIG. 7BM-7BN, alert 7198-3 and/or alert 7198-4 are displayed with a greater amount of visual deemphasis (e.g., and/or optionally cease to be displayed completely). For example, as the movement of the viewpoint continues in FIG. 7BN, in some embodiments, alert 7198-3 gradually fades and/or increases an amount of visual deemphasis over time (e.g., before the user’s viewpoint settles), as illustrated by the change in fill pattern of alert 7198-3 to the dashed outline of alert 7198-4.

In some embodiments, as the user continues to move in the physical environment, and the viewpoint of the user continues to change (e.g., and has not yet settled), alert 7198-4 is displayed with more visual deemphasis and/or optionally ceases to be displayed. For example, in FIGS. 7BN and 7BO, in some embodiments, alert 7198-5 is optionally not displayed.

FIG. 7BO further illustrates notification 7196 continuing to be displayed, while shifting in position (e.g., at a slower rate than the movement of the viewpoint of the user according to the damping factor of notification 7196) to be displayed at a same relative position in the currently displayed view of the three-dimensional environment, as illustrated in FIG. 7BP. Similarly, system function menu 7024 also follows the movement of the user’s viewpoint. In some embodiments, system function menu 7024 has a smaller damping factor (e.g., a factor corresponding to how closely a user interface object follows the movement of the user) than the damping factor of notification 7196. As such, system function menu 7024 appears to be maintained at a same position, relative to the currently displayed view of the three-dimensional environment, despite how much and/or how quickly the user’s current viewpoint moves (e.g., as the user moves the display generation component in the physical environment).

FIG. 7BP illustrates that the position of alert 7198-5 is no longer within the currently displayed view of the three-dimensional environment, such that alert 7198-5 is no longer displayed in the currently displayed view of the three-dimensional environment, in accordance with some embodiments.

FIG. 7BQ illustrates that the user’s viewpoint has settled at a respective position in the three-dimensional environment. In some embodiments, the user’s viewpoint is determined to be settled in accordance with a determination that the user’s viewpoint is maintained at a fixed position (e.g., or at an approximately fixed position) with less than a threshold amount of movement for a unit of time, for at least a threshold amount of time. In some embodiments, the user’s viewpoint is determined to be settled in accordance with a determination that the user’s viewpoint is no longer moving above a threshold rate of movement (e.g., the user’s viewpoint is considered unsettled while the user’s viewpoint changes faster than the threshold rate of movement).

In some embodiments, in response to determining that the user’s viewpoint is settled, as illustrated in FIG. 7BQ, one or more user interface objects of the second type, such as alert 7198-7, are redisplayed, also referred to as respawned, at a same position relative to the currently displayed view of the three-dimensional environment as the position of alert 7198-1 before the change in the user’s viewpoint was detected. For example, alert 7198-7 is redisplayed under notification 7196 in a top-center portion of the currently displayed view. In some embodiments, the user interface objects of the first type (e.g., notification 7196 and/or system function menu 7024) are also displayed at a same position relative to the currently displayed view of the three-dimensional environment as their respective positions before the change in the user’s viewpoint was detected.

In some embodiments, a second user interface object of the second type, such as a media player window (e.g., a mini media player window, or a pinned object or always-on-top object) is displayed in the view of the three-dimensional environment illustrated in FIG. 7BK. For example, the media player window is optionally displayed in a lower right corner of the display illustrated in FIG. 7BK. In some embodiments, because the media player window is a user interface object of the second type (e.g., but a different category of the second type than system alert 7198-1), while the movement of the user is not settled at a fixed position (e.g., as described with reference to FIG. 7BL-7BP), the media player window is visually deemphasized (e.g., in a same or in a different manner (e.g., deemphasized by a different degree, using a different set of display properties, and/or with a different rate) than the visual deemphasis of alert 7198-2). In some embodiments, upon the viewpoint of the user settling (e.g., for alert 7198-7) in FIG. 7BQ, the media player window optionally is not redisplayed at the same time. In some embodiments, the media player window is redisplayed after distinct settle criteria, different from the settle criteria of alert 7198-7, have been met. Thus, in FIG. 7BQ, alert 7198-7 is redisplayed in response to detecting that the viewpoint of the user has met settle criteria for alert 7198-7 (e.g., a first category of the second type of user interface objects), and media player window is redisplayed (e.g., at a same position relative to the currently displayed view, such as in a lower right corner of the currently displayed view) only after the settle criteria for the media player window (e.g., a second category of the second type of user interface object) is met. For example, the settle criteria for the media player window require that the user’s viewpoint is fixed for a threshold amount of time (e.g., a longer amount of time) that is different than the amount of time required to satisfy the settle criteria for alert 7198-7, in accordance with some embodiments.

In some embodiments, redisplaying alert 7198-1 upon determining that the viewpoint of the user is settled in FIG. 7BQ includes displaying an animated transition to move alert 7198-7 into its displayed position. For example, alert 7198-7 is displayed as moving (e.g., from its previous position in the three dimensional environment illustrated in FIG. 7BK to its position in FIG. 7BQ) with one or more characteristics of movement, including an angle at which the alert 7198-1 is displayed relative to the user’s viewpoint and/or an amount of movement up, down, left, right, forward and/or backward. In some embodiments, a user interface object in the second category of user interface objects of the second type (e.g., a media player window, or another user interface object) is displayed with a different animated transition than the user interface objects in the first category (e.g., alert 7198-7). For example, the media player window is displayed with a different angle and/or with a different amount of movement up, down, left, right, forward and/or backward while it is redisplayed upon determining that the settle criteria for the media player window have been met. In some embodiments, the angle and/or amount of movement of the respective user interface object is based on the position of the respective user interface object before the user’s viewpoint moves and the viewpoint of the user at the time the viewpoint is determined as settled (e.g., based on the settle criteria for the respective user interface object). For example, the user interface object moves at an angle and/or by an amount to travel between its initial position in the three dimensional environment before the viewpoint moves and its position in the three dimensional environment after the viewpoint has settled.

In some embodiments, user interface objects of the third type (e.g., virtual assistant 7200-2, or another user interface object) are not redisplayed in response to detecting that the user’s viewpoint is settled. For example, in FIG. 7BQ, the user interface object for virtual assistant 7200-2 is not displayed. In some embodiments, user interface objects of the third type are displayed (e.g., and/or redisplayed) in response to a user input explicitly invoking the respective user interface object. For example, in FIG. 7BQ, a user input is detected (e.g., as the user gazes at an icon for a virtual assistant (e.g., in the system function menu 7024, or in another portion of the environment), indicated by user’s attention 7116), such as a tap input, an air tap input, a gaze and pinch input, or another type of input, that corresponds to a request to invoke the virtual assistant. In some embodiments, in response to detecting the user input, the user interface object for virtual assistant 7200-2 is displayed, as illustrated in FIG. 7BR. In some embodiments, the user interface object for virtual assistant 7200-2 is displayed in a same position relative to the currently displayed view (e.g., as shown in FIG. 7BR) as the user interface object for virtual assistant 7200-2 was previously displayed (e.g., shown in FIG. 7BK). For example, virtual assistant 7200-2 is displayed in a bottom center of the current view (e.g., or at another position in the current view), in some embodiments.

In some embodiments, the different types of user interface objects described above (e.g., first type having continuous follow behavior, second type having delayed follow behavior, and third type not having follow behavior) are associated with different criteria for dismissing the respective user interface object. For example, a respective user interface object is associated with a respective safe zone based on the type of user interface objects to which the respective user interface object belongs (e.g., wherein the dismiss criteria is based at least in part on whether the user’s viewpoint has a location that corresponds to an area within the safe zone and/or outside of the safe zone). In some embodiments, the respective safe zone of a user interface object is based on a head position (e.g., or position of another body part, such as a torso position) of the user and/or based on the current view when the respective user interface object is initially displayed (e.g., spawned into the current view). For example, the initial position at which virtual assistant 7200-2 is spawned (e.g., in a bottom center of the view) is used to define the safe zone for virtual assistant 7200-2, including, for example, a U-shaped area of the three dimensional environment that includes virtual assistant 7200-2.

In some embodiments, while the user’s viewpoint has a location that corresponds to a portion of the three dimensional environment that is within the safe zone for the user interface object, the user interface object does not move its position within the three dimensional environment. In some embodiments, if the user’s viewpoint has a location that is outside of the safe zone, the user interface object is subject to the continuous follow, delayed follow, and/or dismiss behavior described above with reference to FIG. 7BK-7BR.

In some embodiments, the safe zone for the third type of user interface objects is an area that comprises a U-shape, or another irregular shape (e.g., as opposed to a spherical shape, a box shape, or other regular shapes). For example, while the user’s current viewpoint has a location that corresponds to an area that is within the safe zone of the third user interface object (e.g., within a U-shaped area defined relative to virtual assistant 7200-2), virtual assistant 7200-2 is not dismissed in response to detecting the user’s head has turned to a position within the safe zone. For example, if the U-shaped area spans to the left and right of virtual assistant 7200-2, if the user’s head turns to the right and/or left such that the user’s viewpoint is directed to the U-shaped area, virtual assistant 7200-2 remains at its position (e.g., as if world-locked), whereby the user is enabled to approach and/or interact with (e.g., using touch inputs or other inputs) virtual assistant 7200-2. In some embodiments, in response to detecting that the user’s current viewpoint has a location that corresponds to an area that is outside the safe zone of the third user interface object (e.g., outside of a U-shaped area defined relative to virtual assistant 7200-2), virtual assistant 7200-2 is dismissed, as described with reference to FIG. 7BL (e.g., and is not redisplayed until an invocation input requesting the virtual assistant is detected).

In some embodiments, while the viewpoint of the user is in an area within the respective safe zone for the respective user interface object (e.g., a user interface object of the first and/or second type), the respective user interface object does not follow the movement of the user’s viewpoint (e.g., the user interface object is not displayed with continuous and/or delayed follow behavior). As such, while the user’s viewpoint has a location that corresponds to an area within the safe zone, alert 7198-1 and notification 7196 do not follow the user’s viewpoint (e.g., and appear world-locked). In some embodiments, if the user’s viewpoint has a location that corresponds to an area outside of the respective safe zone for the respective type of user interface object, the respective user interface object (e.g., alert 7198-1 and/or notification 7196) is displayed with the follow behaviors described above with reference to FIG. 7BK-7BQ. In some embodiments, the safe zone of a user interface object of the first type is a different size and/or shape than the safe zone of a user interface object of the third type. For example, the safe zones for the first type and/or the second type of user interface objects are smaller than the safe zone for the third type of user interface object. In some embodiments, the shape and size of the safe zone are selected or changed by the computer system in accordance with the location of the gaze or where the user’s attention is directed, e.g., at a given time, and/or an average over a period of time.

Additional descriptions regarding FIG. 7BK-7BR are provided below in reference to method 16000 described with respect to FIGS. 16A-16B, among other Figures and methods described herein.

FIG. 8 is a flow diagram of an exemplary method 8000 for displaying a plurality of affordances for accessing system functions of a first computer system, in response to detecting a first gaze input directed to a first user interface object, and in accordance with a determination that the first gaze input satisfies attention criteria with respect to the first user interface object, in accordance with some embodiments. In some embodiments, the method 8000 is performed at a computer system (e.g., computer system 101 in FIG. 1) (which is sometimes referred to as “the first computer system”) that is in communication with a display generation component (e.g., display generation component 120 in FIGS. 1, 3, and 4) (e.g., a heads-up display, a display, a touchscreen, or a projector) and one or more input devices (e.g., a touch screen, a camera, and/or a microphone). In some embodiments, the computer system optionally includes one or more cameras (e.g., a camera (e.g., color sensors, infrared sensors, and/or other depth-sensing cameras) that points towards the user (e.g., to detect the gaze of the user) and/or a camera that points forward (e.g., to facilitate displaying elements of the physical environment captured by the camera). In some embodiments, the method 8000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 8000 are, optionally, combined and/or the order of some operations is, optionally, changed.

Conditionally displaying (e.g., based on the attention criteria) the plurality of affordances for accessing system functions of a computer system in response to detecting the user’s attention directed to the first user interface object reduces the number of inputs needed to access system functions of the computer system without cluttering the user interface with additional displayed controls, in accordance with some embodiments.

The computer system displays (8002), via the first display generation component, a first user interface object (e.g., indicator 7010 of system function menu (FIG. 7B), user interface object 7056 (FIG. 7L), or user interface object 7064 (FIG. 7R)) while a first view of a three-dimensional environment is visible, wherein the first user interface object is displayed at a first position in the three-dimensional environment, and wherein the first position in the three-dimensional environment has a first spatial arrangement relative to a respective portion of a user (or, alternatively, relative to a viewport or virtual viewport through which a view of the three-dimensional environment that is visible or available for viewing by the user, that optionally has a viewport boundary that corresponds to a boundary of one or more display generation components and/or a boundary of how much of the three-dimensional environment is visible to the user without a change in the viewpoint of the user). In some embodiments, the respective portion of the user (or a portion of a body of the user) is fixed relative to a viewport through which the three-dimensional environment is visible when the display generation component that determines the viewport through which the three-dimensional environment is visible is worn on the body of the user.

While displaying the first user interface object in the first view of the three-dimensional environment, the computer system detects (8004), via the one or more input devices, movement of a viewpoint of the user from a first viewpoint to a second viewpoint in the physical environment. In response to detecting the movement of the viewpoint of the user from the first viewpoint to the second viewpoint in the physical environment, the computer system maintains (8006) display of the first user interface object at a respective position in the three-dimensional environment having the first spatial arrangement relative to the respective portion of the user (or, alternatively, relative to the viewport through which the three-dimensional environment is visible) while a second view of the three-dimensional environment is visible (e.g., the second view is different from the first view). In some embodiments, the first user interface object is maintained at a respective position in the three-dimensional environment having the first spatial arrangement relative to the viewpoint of the user (or alternatively, relative to the viewport through which the three-dimensional environment is visible). In some embodiments, the first user interface object is maintained at the first location on, or relative to, the first display generation component that is independent of the contents of the first view of the three-dimensional environment. For example, as the viewpoint of user 7002 changes from FIG. 7B to FIG. 7C, indicator 7010 of system function menu is moved so as to be maintained in the top center region of the viewport through which the three-dimensional environment is visible (or of the display of computer system 7100).

While the second view of the three-dimensional environment is visible and while displaying the first user interface object in the second view of the three-dimensional environment, the computer system detects (8008), via the one or more input devices, a first gaze input directed to the first user interface object. In response to detecting the first gaze input directed to the first user interface object, and in accordance with a determination that the first gaze input satisfies attention criteria with respect to the first user interface object, the computer system displays (8010) a plurality of affordances for accessing system functions (e.g., performing system operations) of the first computer system (e.g., a volume control, a search affordance, a notification center, a control panel, and/or a virtual assistant). For example, as shown in and described herein with reference to FIG. 7E, system function menu 7024 is displayed in response to user 7002 gazing at indicator 7010 of system function menu. In some embodiments, in accordance with a determination that the user input does not satisfy the attention criteria with respect to the first user interface object, the computer system forgoes displaying the plurality of affordances for accessing system functions of the first computer system. For example, as shown in and described herein with reference to FIG. 7D, system function menu 7024 is not displayed if user 7002′s gaze does not satisfy attention criteria.

In some embodiments, the computer system detects that the first gaze input is directed to a first region in the second view of the three-dimensional environment, wherein the first region corresponds to the position of the first user interface object in the second view of the three-dimensional environment (e.g., the first region is defined to be within or substantially within a visible region surrounding the first user interface object in the second view of the three-dimensional environment), and the computer system detects that the first gaze input is directed to the first region for at least a first amount of time (e.g., 500 milliseconds, 700 milliseconds, 1 second, or two seconds). In some embodiments, the first region encompasses one or more locations in the second view of the three-dimensional environment that are within a threshold distance (e.g., 0.5 mm, 1 cm, 2 cm, 5 cm, or any threshold distance between 0 and 5 cm) of the first user interface object. In some embodiments, detecting the first gaze input directed to the first user interface object includes determining that the first gaze input remains directed to one or more locations within the first region for at least the first amount of time (e.g., without being directed to any location outside of the first region during the first amount of time). For example, as described above with reference to FIG. 7E, in some embodiments the user’s gaze satisfies attention criteria when the user gazes, for at least a threshold amount of time (e.g., 0.1, 0.2, 0.5, 1, 2, 5, 10, 30, or 60 seconds), within a first region (e.g., a first region defined to be within or substantially within a visible region surrounding the indicator 7010 of system function menu) in a view of the three-dimensional environment. Displaying a plurality of affordances for accessing system functions of the first computer system in response to detecting a gaze input that remains directed to a specific region in the view of the three-dimensional environment for at least a threshold amount of time reduces the number of inputs needed to access system functions of the first computer system without cluttering the user interface (UI) with additional displayed controls and without accidentally triggering interactions with the specific region.

In some embodiments, the first user interface object is translucent and has an appearance that is based on at least a portion of the three-dimensional environment over which the first user interface object is displayed. In some embodiments, the portion of the three-dimensional environment over which the first user interface object is displayed includes a representation of a physical environment in a field of view of one or more cameras of the first computer system (e.g., real world content). In some embodiments, the portion of the three-dimensional environment over which the first user interface object is displayed includes computer-generated content (e.g., virtual content not corresponding to the physical environment, such as virtual content other than a representation of the physical environment captured by one or more cameras of the first computer system). For example, as described above with reference to FIG. 7B, in some embodiments, indicator 7010 of system function menu is translucent. Displaying the first user interface object as translucent and with an appearance that is based on at least a portion of the three-dimensional environment over which the first user interface object enables the first user interface object to be displayed with minimal impact on the three-dimensional environment, thereby providing improved visual feedback about the user’s real and/or virtual surroundings, and reducing the need for additional inputs (e.g., in order to dismiss the first user interface object, for improved visibility).

In some embodiments, the computer system: displays the first user interface object with a first appearance at the first position in the three-dimensional environment, wherein the first appearance of the first user interface object at the first position is based at least in part on a characteristic of the three-dimensional environment at the first position in the first view of the three-dimensional environment (e.g., the first user interface is translucent and has a first appearance based on the physical environment or virtual content that is behind the first user interface object in the first view of the three-dimensional environment). In some embodiments, in response to detecting the input that corresponds to movement of the viewpoint of the user from the first viewpoint to the second viewpoint in the three-dimensional environment, the computer system displays the first user interface object with a respective appearance (e.g., different from the first appearance) at the respective position in the three-dimensional environment that has the first spatial arrangement relative to the respective portion of the user, wherein the respective appearance of the first user interface object at the respective position is based at least in part on a characteristic of the three-dimensional environment at the respective position (e.g., after movement of viewpoint of the user, the first user interface object has a respective appearance based on the physical environment or virtual content that is behind the first user interface object in the second view of the three-dimensional environment, which in some cases is different from the first appearance due to the movement of the viewpoint and differences in the three-dimensional environment between the previous and current locations of the first user interface object). For example, as described above with reference to FIG. 7B, in some embodiments, the first user interface object has an appearance that is based at least in part on a portion of the three-dimensional environment over which the indicator 7010 of system function menu is displayed. Displaying the first user interface object with an appearance that is based at least in part on a characteristic of the three-dimensional environment at the current position of the first user interface object in the three-dimensional environment provides improved visual feedback about the position of the computer system in the three-dimensional environment.

In some embodiments, the computer system displays the first user interface object with a first level of prominence at the first position in the three-dimensional environment. In some embodiments, maintaining display of the first user interface object at the respective position in the three-dimensional environment having the first spatial arrangement relative to the respective portion of the user (or alternatively, having the first spatial arrangement relative to the viewport through which the three-dimensional environment is visible) while the second view of the three-dimensional environment is visible includes: displaying the first user interface object with a second level of prominence, different from the first level of prominence (e.g., the second level of prominence is less prominent or visually deemphasized relative to the first level of prominence), during the movement of the viewpoint of the user from the first viewpoint to the second viewpoint in the three-dimensional environment; and displaying the first user interface object with the first level of prominence at the respective position in the three-dimensional environment that has the first spatial arrangement relative to the respective portion of the user. In some embodiments, the first user interface object ceases to be displayed (e.g., fades out entirely, instead of being displayed with the second level of prominence) during the movement of the viewpoint of the user from the first viewpoint to the second viewpoint in the three-dimensional environment, and the first user interface object is displayed (e.g., after the movement of the viewpoint of the user from the first viewpoint to the second viewpoint in the three-dimensional environment, while the viewpoint of the user remains substantially at or within a threshold range of the second viewpoint (e.g., within the lazy follow threshold)) with the first level of prominence at the respective position in the three-dimensional environment that has the first spatial arrangement relative to the respective portion of the user. This is described above, for example, in the description of FIG. 7C, where in some embodiments, the indicator 7010 of system function menu fades out, becomes blurred, or is otherwise visually obscured as the indicator 7010 of system function menu moves from the location 7016 to the location 7018, and/or from the location 7018 to the final position shown in FIG. 7C. Displaying the first user interface object with a second level of prominence, different from the first level of prominence, during the movement of the viewpoint of the user from the first viewpoint to the second viewpoint in the three-dimensional environment, provides improved visual feedback regarding movement of the viewpoint of the user.

In some embodiments, while the first user interface object has a first appearance (e.g., an appearance that indicates that there is no notification that satisfies the timing criteria), the computer system detects that a first event for a first notification satisfies timing criteria (e.g., a notification has been generated within a threshold amount of time (e.g., 5 seconds, 10 seconds, 20 seconds, 30 seconds, 60 seconds, or any threshold time between 0 and 60 seconds)). In some embodiments, in response to detecting that the first event for the first notification satisfies timing criteria, the computer system changes an appearance of the first user interface object from the first appearance to a second appearance, wherein the second appearance includes an indication of a respective application associated with the first notification. This is shown, for example, in FIG. 7L, where the user interface object 7056 has a different appearance than the indicator 7010 of system function menu. This is also described above with reference to FIG. 7B, and described in greater detail with reference to FIG. 7L, where in some embodiments, the user interface object 7056 has an appearance that is indicative an application associated with the first event for the first notification (e.g., the user interface object 7056 appears as the application icon for a messaging application associated with the recently received text message). Changing an appearance of the first user interface object, in response to a recently generated notification, to indicate an application associated with the recent notification provides feedback about a state of the computer system.

In some embodiments, in accordance with a determination that the first notification is associated with a first application, the second appearance includes an indication of the first application, and in accordance with a determination that the first notification is associated with a second application different from the first application, the second appearance includes an indication of the second application. This is described above, for example, in the description of FIG. 7L, where in some embodiments, the user interface object 7056 optionally includes different indications for different applications (e.g., when the first event for the first notification is associated with a first application, the user interface object 7056 has a first appearance that includes an indication of a first application, and when the first event for the first notification is associated with a second application, the user interface object 7056 has a second appearance (different from the first appearance) that includes an indication of a second application (different from the first application)). Changing an appearance of the first user interface object from the first appearance to a second appearance that indicates which of multiple different applications is associated with the first notification provides feedback about a state of the computer system.

In some embodiments, the computer system displays, via the first display generation component, a second user interface object (e.g., an affordance, an application icon, or an interactive object) while the first view of the three-dimensional environment is visible. While displaying the first user interface object in the first view of the three-dimensional environment, the computer system detects, via the one or more input devices, a first user input (e.g., an air gesture (e.g., an air tap or an air pinch), a gaze input, a verbal input, and/or a combination of a gaze input, hand gesture, and/or verbal input) interacting with the second user interface object. In some embodiments, the second user interface object is a virtual object, and the first user input interacts with the second user interface object by changing a size, position, and/or orientation of the second user interface object. In some embodiments, the second user interface object is an affordance, and the first user input interacts with the second user interface object by activating the second user interface object. In some embodiments, the second user interface object is a user interface object (e.g., a slider or a dial) for adjusting a value (e.g., for a setting) of the first computer system, and the first user input interacts with the second user interface object by moving (e.g., moving a slider, or rotating a dial) the second user interface object. In some embodiments, while detecting the first user input interacting with the second user interface object, the computer system maintains display of the first user interface object at the respective position in the three-dimensional environment having the first spatial arrangement relative to the respective portion of the user while the first view of the three-dimensional environment is visible (e.g., the first user interface object continues to be displayed even when the user interacts with the second user interface object (e.g., another user interface object or control)). This is described above, for example, in the description of FIG. 7B, where in some embodiments, the indicator 7010 of system function menu continues to be displayed, even as the user interacts with other user interfaces, user interface objects, and/or user interface elements, such as system function menu 7024, system space 7038,, user interface 7058, notification content 7060, application user interface 7062, incoming call user interface 7068, missed call user interface 7070, or call control user interface 7072. Maintaining display of the first user interface object during user interaction with a second user interface object reduces the number of inputs needed at any point to interact with the first user interface object (e.g., the user does not need to provide additional user inputs to redisplay the first user interface object after interacting with another user interface object).

In some embodiments, the computer system displays the first user interface object at a second position in the second view of the three-dimensional environment. The computer system detects, via the one or more input devices, an input that corresponds to movement of the viewpoint of the user from a second viewpoint to a third viewpoint in the three-dimensional environment. In some embodiments, in response to detecting the input that corresponds to movement of the viewpoint of the user from the second viewpoint to the third viewpoint in the three-dimensional environment: in accordance with a determination that the movement of the viewpoint of the user from the second viewpoint to the third viewpoint does not satisfy a threshold amount (e.g., threshold angle (e.g., 5 degrees, 10 degrees, 25 degrees, 45 degrees, 90 degrees, 120 degrees, or any threshold angle between 0 and 120 degrees) and/or distance (e.g., 1 cm, 2 cm, 5 cm, 10 cm, 50 cm, 1 meter, 5 meters, or any threshold distance between 0 and 5 meters)) of movement, the computer system maintains display of the first user interface object at the second position in the three-dimensional environment (e.g., such that the first user interface object no longer has the first spatial arrangement relative to the respective portion of the user); and in accordance with a determination that the movement of the viewpoint of the user from the second viewpoint to the third viewpoint satisfies the threshold amount of movement, the computer system ceases to display the first user interface object at the second position in the three-dimensional environment, and the computer system displays the first user interface object at a third position in the three-dimensional environment, wherein the third position in the three-dimensional environment has the first spatial arrangement relative to the respective portion of the user (e.g., relative to the third viewpoint of the user). In some embodiments, the first user interface object is displayed at the same location on, or relative to, the first display generation component that is independent of the contents of the first view of the three-dimensional environment (e.g., the first and second locations are the same location on, or relative to, the first display generation component that is independent of the contents of the first view of the three-dimensional environment). This is shown in FIG. 7C, for example, where the dotted circles at the positions 7016 and 7018 illustrate the lazy follow behavior of the indicator 7010 of system function menu that would occur in response to the viewpoint of user 7002 moving more than a threshold amount from the viewpoint shown in FIG. 7B. In contrast, in response to the viewpoint of the user 7002 moving less than the threshold amount from the viewpoint shown in FIG. 7B, indicator 7010 of system function menu would remain displayed at the same location in the three-dimensional environment as shown in FIG. 7B (and optionally, in accordance with the movement of the viewpoint of the user 7002, indicator 7010 of system function menu would be displayed at a different location relative to the display of computer system 7100). Maintaining the position of the first user interface object in the three-dimensional environment if the viewpoint of the user does not move more than a threshold amount, and moving the first user interface object with the viewpoint of the user if the viewpoint of the user moves more than the threshold amount, reduces motion sickness by reducing the movement of computer-generated user interface objects in the three-dimensional environment during small changes in user viewpoint, and provides improved visual feedback about the amount of movement of the viewpoint of the user.

In some embodiments, the computer system displays an animated transition of the plurality of affordances for accessing system functions of the first computer system expanding downward from the first user interface object (e.g., in response to the first gaze input directed to the first user interface object and in accordance with the determination that the first gaze input satisfies the attention criteria with respect to the first user interface object). In some embodiments, after displaying the animated transition of the plurality of affordances for accessing system functions of the first computer system expanding downward from the first user interface object, the computer system ceases to display the first user interface object. In some embodiments, the computer system concurrently displays the animated transition of the plurality of affordances for accessing system functions of the first computer system expanding downward from the first user interface object, and an animated transition of the first user interface object (e.g., fading out of view, and/or collapsing upward/downward/inward). In some embodiments, the plurality of affordances for accessing system functions of the first computer system are displayed (e.g., remain displayed) below (e.g., immediately below, within a threshold distance (e.g., 0.5 mm, 1 cm, 2 cm, 5 cm, or any threshold distance between 0 and 5 cm) of) the location of first user interface object before the first user interface object ceased to be displayed. This is described above, for example, in the description of FIG. 7E, where in some embodiments, displaying the system function menu 7024 includes displaying an animated transition, and the animated transition includes an animation of the system function menu 7024 expanding downward from the indicator 7010 of system function menu. Displaying an animated transition of the plurality of affordances for accessing system functions of the first computer system expanding downward from the first user interface object, provides improved visual feedback that the first gaze input satisfies the attention criteria with respect to the first user interface object.

In some embodiments, the computer system displays an animated transition of the plurality of affordances for accessing system functions of the first computer system gradually appearing (e.g., fading in, and/or expanding) (e.g., in response to the first gaze input directed to the first user interface object and in accordance with the determination that the first gaze input satisfies the attention criteria with respect to the first user interface object). This is described above, for example, in the description of FIG. 7E, where in some embodiments, displaying the system function menu 7024 includes displaying an animated transition. Displaying an animated transition of the plurality of affordances for accessing system functions of the first computer system gradually appearing provides improved visual feedback that the first gaze input satisfies the attention criteria with respect to the first user interface object.

In some embodiments, while displaying the plurality of affordances for accessing system functions of the first computer system, the computer system detects that the first gaze input no longer satisfies the attention criteria with respect to the first user interface object, and in some embodiments, in response to detecting that the first gaze input no longer satisfies the attention criteria with respect to the first user interface object, the computer system ceases to display the plurality of affordances for accessing system functions of the first computer system. In some embodiments, the attention criteria require that the first gaze input be directed to the first user interface object (e.g., the attention criteria require that the user be gazing or looking at the first user interface object), and the first gaze input ceases to satisfy the attention criteria if the user looks away from the first user interface object. This is described above, for example, in the description of FIGS. 7D and 7E, where in some embodiments, the computer system 7100 ceases to display the system function menu 7024 when (e.g., in response to detecting that) the user’s gaze no longer satisfies the attention criteria (e.g., the user’s gaze is no longer directed to the indicator 7010 of system function menu or the system function menu 7024). Ceasing to display the plurality of affordances for accessing system functions of the first computer system, in response to detecting that the first gaze input no longer satisfies the attention criteria with respect to the first user interface object, provides additional control options without cluttering the UI with additional displayed controls (e.g., additional displayed controls for displaying and/or ceasing to display the plurality of affordances for accessing system functions of the first computer system) by reducing the number of inputs needed to dismiss the displayed control options.

In some embodiments, the first position is in a periphery region (e.g., is within a threshold distance (e.g., 0.5 mm, 1 cm, 2 cm, 5 cm, or any threshold distance between 0 and 5 cm) of an edge) of the first display generation component (e.g., relative to a field of view of a user using the first display generation component, such as a user’s field of view while wearing a head-mounted display). This is shown in FIG. 7B, for example, where the indicator 7010 of system function menu is displayed in a periphery region (e.g., within a threshold distance of a top edge, or an upper limit of the user’s field of view) of the first display generation component. Displaying the first user interface object in a periphery region of the first display generation component provides additional control options without cluttering the UI with additional and intrusively displayed controls.

In some embodiments, the computer system detects, via the one or more input devices, a verbal input by the user. In some embodiments, in response to detecting the verbal input by the user, in accordance with a determination that the verbal input is detected while the user’s gaze is directed to a respective affordance of the plurality of affordances for accessing system functions of the first computer system (e.g., the user gazes at the respective affordance and speaks a voice command) (e.g., and in accordance with a determination that the respective affordance can be voice activated), the computer system performs a function associated with the respective affordance. In some embodiments, in accordance with a determination that the respective affordance is not voice activatable, the function associated with the respective affordance is not performed in response to detecting the verbal input (e.g., even if the verbal input is detected while the user’s gaze is directed to the respective affordance). In accordance with a determination that the verbal input is detected while the user’s gaze is directed to a first affordance of the plurality of affordances for accessing system functions of the first computer system (e.g., the user gazes at the first affordance and speaks a voice command) (e.g., and in accordance with a determination that the first affordance can be voice activated), performing a first function associated with the first affordance. In accordance with a determination that the verbal input is detected while the user’s gaze is directed to a second affordance, different from the first affordance, of the plurality of affordances for accessing system functions of the first computer system (e.g., the user gazes at the second affordance and speaks a voice command) (e.g., and in accordance with a determination that the second affordance can be voice activated), performing a second function associated with the second affordance, where the second function is different from the first function (e.g., performing a system search operation instead of providing a voice input to a virtual assistant). This is shown in FIGS. 7K(b) and 7K(e), for example, where the user activates the search affordance 7042 and the virtual assistant affordance 7048, respectively, with a voice input. Performing a function associated with a respective affordance, in response to detecting the verbal input by the user, and in accordance with a determination that the verbal input is detected while the user’s gaze is directed to the respective affordance of the plurality of affordances for accessing system functions of the first computer system, reduces the number and extent of inputs needed to perform operations on the computer system by enabling verbal interaction with a displayed control as an alternative to or in addition to gesture-based inputs.

In some embodiments, while detecting the verbal input by the user, the computer system displays a first visual indication (e.g., highlighting of the respective affordance, and/or displaying an animation associated with the respective affordance) corresponding to the verbal input by the user (e.g., while the user is speaking) (e.g., indicative of verbal input being detected). In some embodiments, displaying the first visual indication includes, in accordance with a determination that attention of the user is directed to a first affordance, displaying the first visual indication with respect to (e.g., by changing an appearance of the first affordance and/or displaying a visual indication over or near the first affordance) the first affordance (e.g., and not with respect to a second affordance), and in accordance with a determination that attention of the user is directed to a second affordance, displaying the first visual indication with respect to (e.g., by changing an appearance of the second affordance and/or displaying a visual indication over or near the second affordance) the second affordance (e.g., and not with respect to the first affordance). This is shown in FIGS. 7K(b) and 7K(e), for example, where the dotted circles around the search affordance 7042 and virtual assistant affordance 7048, respectively, and the text “Weather” in the text field (e.g., search bar) of system space 7050 (FIG. 7K(b)) illustrate visual feedback while a user is speaking. Displaying a first visual indication corresponding to the verbal input, while detecting the verbal input by the user, provides improved visual feedback that the verbal input has been detected (and, optionally, continues to be detected).

In some embodiments, the computer system displays text corresponding to the verbal input by the user (e.g., the respective affordance is for accessing a search function of the first computer system, and the computer system displays text corresponding to a spoken search term or query in a search bar or text entry field displayed adjacent to (e.g., immediately below) the first user interface object; optionally the search bar or text entry field is displayed in response to one or more inputs directed to the respective affordance). This is shown in FIG. 7K(b), for example, where the text “Weather” is displayed in the text field of the system space 7050, and which corresponds to the verbal input by the user (as shown by the speech bubble with “Weather”). Displaying text corresponding to the verbal input by the user, while detecting the verbal input by the user, provides improved visual feedback regarding the verbal input, which also helps prevent the computer system from performing unintended functions, for example if the search term that the computer system detects and displays does not match the search term spoken by the user.

In some embodiments, the computer system displays the first visual indication with a characteristic value, wherein the characteristic value (e.g., highlighting, size, and/or opacity) is based at least in part on an audio level (e.g., a volume, frequency, and/or tone) of the verbal input by the user (e.g., the first visual indication changes appearance as the volume of the verbal input by the user changes). This is described above, for example, in the descriptions of FIGS. 7K(b) I 7K(e), where in some embodiments, the visual feedback varies based on at least one characteristic (e.g., volume, speed, and/or length) of the verbal input (e.g., the dotted circles in FIG. 7K(b) change size in accordance with a volume of the detected verbal input). Displaying the first visual indication with a characteristic value that is based at least in part on an audio level of the verbal input by the user, provides improved visual feedback that the verbal input has been detected (and, optionally, continues to be detected).

In some embodiments, the computer system detects, via the one or more input devices, a first hand gesture (e.g., an air gesture, such as an air tap or an air pinch, or another selection input) by the user. In some embodiments, in response to detecting the first hand gesture by the user, and in accordance with a determination that the first hand gesture by the user is detected while the user’s gaze is directed to a respective affordance of the plurality of affordances for accessing system functions of the first computer system (e.g., the user performs the hand gesture while gazing at the respective affordance), the computer system performs a function associated with the respective affordance (e.g., displaying a system user interface for a system function that is accessed via the respective affordance). In some embodiments, the system functions of the first computer system include one or more of: a volume control function, a search function, a function for displaying notifications received by the first computer system (e.g., a notification center function), a function for displaying a user interface (e.g., a control panel user interface) that includes a plurality of selectable user interface elements for controlling additional system functions of the first computer system, and/or a virtual assistant function. This is shown in FIG. 7J, for example, where the arrows near the user’s hand 7020, in conjunction with the dotted lines originating from the user’s eye, illustrate a combination of gaze input and air gesture. Performing a function associated with the respective affordance in response to a combination of gaze input and air gesture provides additional control options without cluttering the UI with additional displayed controls (e.g., additional displayed controls for functions accessed via a voice command, and/or additional displayed controls for selecting a respective affordance of the plurality of affordances for accessing system functions of the first computer) and improves the accuracy of user input compared to gaze input alone (e.g., which might result in accidentally triggered interactions with the computer system) or gesture input alone, thereby reducing input mistakes and unintended outcomes.

In some embodiments, the computer system displays a respective affordance of the plurality of affordances with a first appearance. The computer system detects, via the one or more input devices, a change in configuration of the user’s hand (e.g., into a ready state configuration). In some embodiments, in response to detecting the change in configuration of the user’s hand, and in accordance with a determination that the user’s hand meets first criteria, the computer system displays the respective affordance with a second appearance different from the first appearance. In some embodiments, the first appearance provides visual feedback that the user’s hand does not meet the first criteria, and the second appearance provides visual feedback that the user’s hand meets the first criteria. For example, the respective affordance with the second appearance has a different size, moves closer to or further from the viewpoint of the user (e.g., along a z-axis), is changed in thickness (e.g., z-axis height), has a thicker (or thinner) border, and/or has a different color, compared to the respective affordance with the first appearance. In some embodiments, the respective affordance with the second appearance has a shadow, has a glow (e.g., has increased brightness and/or appears to emit light), and/or is animated, while the respective affordance with the first appearance does not.

In some embodiments, displaying the plurality of affordances for accessing system functions of the first computer system includes: in accordance with a determination that the user’s hand is in a ready state configuration, displaying a first affordance of the plurality of affordances with first appearance; and in accordance with a determination that the user’s hand is not in the ready state configuration, displaying the first affordance with a second appearance that is different from the first appearance. In some embodiments, for a second affordance of the plurality of affordances, the appearance of the second affordance changes in response to detecting the change in the configuration of the user’s hand and in accordance with the determination that the user’s hand meets the first criteria. In some embodiments, displaying the respective affordance with the second appearance includes: in accordance with a determination that the user’s attention is directed to a first affordance when the user’s hand meets the first criteria, changing the first affordance from the first appearance to the second appearance (e.g., without changing one or more other affordances from the first appearance to the second appearance) and in accordance with a determination that the user’s attention is directed to a second affordance when the user’s hand meets the first criteria, changing the second affordance from the first appearance to the second appearance (e.g., without changing one or more other affordances, such as the first affordance, from the first appearance to the second appearance). In some embodiments, if the attention of the user shifts from a first affordance to a second affordance while the user’s hand meets the first criteria, the first affordance shifts from the second appearance to the first appearance and the second affordance shifts from the first appearance to the second appearance. For example, as described herein with reference to FIGS. 7G-7H, the border of the volume affordance 7038 is in some embodiments increased in response to detecting the user’s hand 7020 is in the ready state configuration. Changing the appearance of a respective affordance in response to detecting a change in configuration of the user’s hand to meet first criteria (e.g., indicating readiness to provide further input) indicates which user interface element is selected for further interaction.

In some embodiments, the computer system displays a second affordance of the plurality of affordances for accessing system functions of the first computer system with a third appearance. The computer system detects, via the one or more input devices, a change in position of the user’s hand. In some embodiments, in response to detecting the change in position of the user’s hand, and in accordance with a determination that the user’s hand meets the first criteria, the computer system maintains display of the second affordance with the third appearance. In some embodiments, in accordance with a determination that the user’s hand does not meet the first criteria, the computer system displays the second affordance with the third appearance (e.g., the second affordance is displayed with the third appearance without regard to whether the user’s hand meets the first criteria) (e.g., concurrently with displaying the first affordance with the second appearance different from the first appearance in response to detecting the change in position of the user’s hand such that the user’s hand meets the first criteria). This is described above, for example, with reference to FIGS. 7G-7H, where in some embodiments, the computer system 7100 does not change the appearance of the volume affordance 7038 (e.g., irrespective of whether the user’s gaze is directed to the volume affordance 7038 and/or the user’s hand is in the ready state configuration). Displaying a respective affordance without changing its appearance in response to detecting a change in configuration of the user’s hand to meet the first criteria may indicate that interaction with the respective affordance (e.g., a specific affordance that the user is gazing at) requires additional input or a different type or combination of inputs, or that the respective affordance is not configured for gesture-based input.

In some embodiments, after (e.g., while) displaying the plurality of affordances for accessing system functions of the first computer system, the computer system detects, via the one or more input devices, a second gaze input directed to a respective affordance of the plurality of affordances for accessing system functions of the first computer system. In some embodiments, in response to detecting the second gaze input directed to the respective affordance, the computer system displays additional content associated with the respective affordance (e.g., a description of setting(s) associated with the respective affordance, instructions for adjusting the setting(s) associated with the respective affordance, and/or one or values associated with the setting(s) associated with the respective affordance). In some embodiments, the additional content associated with the respective affordance is displayed after a delay (e.g., 1 second, 5 seconds, 10 seconds, or any threshold amount of time between 0 and 10 seconds). In some embodiments, in response to detecting that the second gaze input is no longer directed to the respective affordance, the computer system ceases to display the additional content associated with the respective affordance). This is described above, for example, with reference to FIG. 7H, where in some embodiments, in response to detecting the user’s gaze directed to the volume affordance 7038, the computer system 7100 displays additional content associated with the volume affordance 7038 (e.g., a “tool tip,” such as a description of a volume setting associated with the volume affordance 7038, instructions of adjusting the volume setting associated with the volume affordance 7038, and/or a current value of the volume setting associated with the volume affordance 7038). Displaying additional content associated with the respective affordance, in response to detecting the second gaze input directed to the respective affordance, reduces the number of inputs needed to access additional information about displayed user interface elements and provides additional control options without cluttering the UI with additional displayed controls (e.g., additional displayed controls for displaying the additional content associated with the respective affordance).

In some embodiments, the computer system detects, via the one or more input devices, a second user input to activate a first affordance of the plurality of affordances for accessing system functions of the first computer system. In some embodiments, in response to detecting the second user input to activate the first affordance of the plurality of affordances for accessing system functions of the first computer system, the computer system displays a first system user interface for a respective system function of the first computer system (e.g., associated with the first affordance). This is shown in FIG. 7H, for example, where in response to detecting the user’s gaze directed to the volume affordance 7038, the computer system displays a system space 7040. In some embodiments, each affordance of the plurality of affordances for accessing system functions of the first computer system is associated with distinct system functions of the first computer system, and thus with distinct system user interfaces. In some embodiments, the first system user interface is a notifications user interface that includes one or more notifications (e.g., recent notifications received or generated within a threshold amount of time (e.g., 5 seconds, 10 seconds, 20 seconds, 30 seconds, 60 seconds, or any threshold time between 0 and 60 seconds), optionally arranged in a scrolling list), a settings user interface that includes one or more controls for system properties such as display brightness, volume, degree of immersion, media playback controls, communications controls (e.g., Bluetooth, Wi-Fi, and/or cellular controls), or the like. Displaying a first system user interface for a respective system function of the first computer system, in response to detecting activation of the corresponding first affordance of the plurality of affordances for accessing system functions of the first computer system, reduces the number of inputs needed to access additional control options without cluttering the UI with additional displayed controls when not needed.

In some embodiments, while displaying the first system user interface, the computer system detects, via the one or more input devices, a third user input to activate a second affordance, different from the first affordance, of the plurality of affordances for accessing system functions of the first computer system. In some embodiments, in response to detecting the third user input to activate the second affordance of the plurality of affordances for accessing system functions of the first computer system, the computer system displays a second system user interface, different from the first system user interface, for a respective system function of the first computer system (e.g., associated with the second affordance), and the computer system ceases to display the first system user interface (e.g., associated with the first affordance). In some embodiments, the computer system replaces display of the first system user interface with display of the second system user interface. This is described above, for example, in the description of FIG. 7H where in some embodiments, if the system space 7040 is already displayed (e.g., in response to detecting the user’s gaze directed to the volume affordance 7038), and the computer system 7100 detects the user’s gaze shifts to another affordance (e.g., the control affordance 7046, or another affordance in system function menu 7024), the computer system 7100 ceases to display the system space 7040 and displays a new system space for the other affordance (optionally in place of the system space 7040). Ceasing to display the first system user interface and displaying a different second system user interface, in response to detecting activation of a different affordance of the plurality of affordances for accessing system functions of the first computer system, causes the computer system to automatically dismiss the first system user interface when the user interacts with a different system user interface (e.g., the user does not need to perform an additional user input to dismiss the first system user interface besides the input to interact with the different system user interface).

In some embodiments, while displaying the first system user interface (e.g., concurrently with displaying the plurality of affordances for accessing system functions), and in accordance with a determination that the user’s gaze is directed to the plurality of affordances for accessing system functions of the first computer system, the computer system visually deemphasizes (e.g., by blurring, fading, and/or shrinking) the first system user interface (e.g., relative to the plurality of affordances for accessing system functions). This is described above, for example, in the description of FIG. 7H, where in some embodiments, while the system space 7040 is displayed (concurrently with the system function menu 7024), in response to detecting the user’s gaze directed to the system function menu 7024, the system space 7040 is visually deemphasized (e.g., faded or blurred out). Visually deemphasizing the first system user interface, in accordance with a determination that the user’s gaze is directed to the plurality of affordances for accessing system functions of the first computer system, provides improved visual feedback regarding which user interface element the computer system detects that the user is gazing at, and accordingly which user interface element is currently in focus and selected for further interaction.

In some embodiments, while displaying the plurality of affordances for accessing system functions of the first computer system (e.g., concurrently with displaying the first system user interface), and in accordance with a determination that the user’s gaze is directed to the first system user interface, the computer system visually deemphasizes (e.g., blurring, fading, and/or shrinking) the plurality of affordances for accessing system functions of the first computer system (e.g., relative to the first system user interface). This is described above, for example, in the description of FIG. 7H, where in some embodiments, while the system space 7040 is displayed (concurrently with the system function menu 7024), in response to detecting the user’s gaze directed to the system space 7040, the system function menu 7024 is visually deemphasized. Visually deemphasizing the plurality of affordances for accessing system functions of the first computer system, in accordance with a determination that the user’s gaze is directed to the first system user interface, provides improved visual feedback regarding which user interface element the computer system detects that the user is gazing at, and accordingly which user interface element is currently in focus and selected for further interaction.

In some embodiments, the computer system displays, via the first display generation component, an application launching user interface (e.g., a home user interface) in the three-dimensional environment (e.g., the second user input is detected while the application launching user interface is displayed). In some such embodiments, displaying the first system user interface includes replacing display of the application launching user interface with display of the first system user interface (e.g., ceasing to display the application launching user interface). This is described above, for example, with reference to FIG. 7H, where in some embodiments, in response to detecting the user’s gaze directed to the volume affordance 7038, the computer system 7100 replaces display of the application launching user interface with display of the system space 7040. Replacing display of the application launching user interface with display of the first system user interface, in response to detecting the second gaze input directed to the respective affordance corresponding to the first system user interface, reduces the number of inputs needed to dismiss the application launching user interface and display the first system user interface.

In some embodiments, before detecting the second user input to activate the first affordance of the plurality of affordances for accessing system functions of the first computer system, the computer system displays, via the first display generation component, an application user interface in the three-dimensional environment (e.g., the second user input is detected while the application user interface is displayed). In some such embodiments, displaying the first system user interface includes displaying the first system user interface over (and/or in front of) the application user interface. This is described above, for example, in the description of FIG. 7H, where in some embodiments, in response to detecting the activation input directed to the volume affordance 7038, the computer system 7100 displays the system space 7040 overlaid over at least a portion of the application user interface. Displaying the first system user interface over the application user interface, reduces the number of inputs needed to return to the application user interface (e.g., as the application user interface does not cease to be displayed) and avoids dismissing and then redisplaying the application user interface during what are typically brief interactions with the plurality of affordances for accessing system functions, thereby reducing motion sickness.

In some embodiments, the computer system detects, via the one or more input devices, a fourth user input that activates a respective affordance of the plurality of affordances for accessing system functions of the first computer system. In some embodiments, in response to detecting the fourth user input that activates the respective affordance of the plurality of affordances for accessing system functions of the first computer system, the computer system displays a respective system user interface for adjusting a respective setting of the first computer system (e.g., changing a volume setting, changing a brightness setting, and/or changing a level of immersion). This is shown in FIG. 7H, for example, where a fourth user input (e.g., an activation input that includes for example a gaze input and/or air gesture) activates the volume affordance 7038, and in response, the computer system 7100 displays a system space 7040 for adjusting a volume setting of the computer system 7100. This is also shown in FIGS. 7J-7K, for example, where a fourth user input (e.g., a gaze input and/or air gesture) activates a respective affordance in the system function menu 7024 for accessing different system functions of computer system 7100. Displaying a respective system user interface for adjusting a respective setting of the first computer system, in response to detecting the fourth user input that activates the respective affordance of the plurality of affordances for accessing system functions of the first computer system, provides additional control options without cluttering the UI with additional displayed controls (e.g., the controls for adjusting respective settings of the first computer system) when not needed.

In some embodiments, the computer system displays the respective system user interface for adjusting the respective setting of the first computer system over at least a portion of one or more of the plurality of affordances. For example, as described above with respect to FIG. 7K, in some embodiments, a system space such as any of the system spaces shown in FIG. 7K(a)-7K(d) is displayed over at least a portion of the system function menu 7024. Displaying the respective system user interface for adjusting the respective setting of the first computer system over at least a portion of one or more of the plurality of affordances provides improved visual feedback about which user interface is in focus, by displaying the respective system user interface more prominently than the plurality of affordances.

In some embodiments, the fourth user input to activate the respective affordance of the plurality of affordances for accessing system functions of the first computer system is a first air pinch gesture. While displaying the respective system user interface for adjusting a respective setting of the first computer system, the computer system detects, via the one or more input devices, a second air pinch gesture (e.g., after releasing the first air pinch gesture), and (e.g., followed by) a change in position of the user’s hand from a first position to a second position (e.g., lateral movement in three-dimensional space, such as an air drag gesture, while the two or more fingers of the user’s hand are in contact with one another). In some embodiments, in response to detecting the second air pinch gesture and the change in position of the user’s hand from the first position to the second position, the computer system adjusts the respective setting of the first computer system in accordance with the change in position of the user’s hand. In some embodiments, adjusting the respective setting of the first computer system includes adjusting the respective setting by an amount based on the amount of movement of the user’s hand. In some embodiments, movement of the user’s hand in a first direction (e.g., toward the right, and/or upward) increases the respective setting, and movement of the user’s hand in another direction (e.g., opposite the first direction, such as toward the left, and/or downward) decreases the respective setting. In some embodiments, the computer system displays a visual indication (e.g., in the respective system user interface, and/or in a user interface displayed concurrently with the respective system user interface and/or the plurality of affordances for accessing system functions of the first computer system) that the respective setting of the first computer system is being adjusted. For example, as described herein with reference to FIGS. 7H-7I, in some embodiments a first air pinch gesture (e.g., in FIG. 7H) activates the volume affordance 7038, and a second air pinch gesture (e.g., in FIG. 7I) and a change in position of the user’s hand 7020 from a first position to a second position (e.g., a drag gesture or a swipe gesture) (e.g., in FIG. 7I), the computer system 7100 adjusts a volume setting of the computer system 7100 in accordance with the change in position of the user’s hand (e.g., as reflected in the movement of the slider of the system space 7040, shown in FIG. 7I). Adjusting the respective setting of the first computer system in response to detecting a second air pinch gesture and a change in position of the user’s hand, separately from displaying the respective system user interface for adjusting the respective setting in response to a separately first air pinch gesture, gives the user more precise control and provides corresponding visual feedback during the interaction for adjusting the respective setting of the first computer system.

In some embodiments, the fourth user input that activates the respective affordance of the plurality of affordances for accessing system functions of the first computer system includes a third air pinch gesture, and (e.g., followed by) a change in position of the user’s hand from a first position to a second position (e.g., lateral movement in three-dimensional space). In some embodiments, the respective system user interface for adjusting a respective setting of the first computer system is displayed in response to detecting the third air pinch gesture. In some embodiments, in response to detecting the change in position of the user’s hand from the first position to the second position, the first computer system adjusts the respective setting of the first computer system in accordance with the (e.g., amount of) change in position of the user’s hand. In some embodiments, adjusting the respective setting of the first computer system includes adjusting the respective setting by an amount based on the amount of movement of the user’s hand. In some embodiments, the computer system displays a visual indication (e.g., in the respective system user interface, and/or in a user interface displayed concurrently with the respective system user interface and/or the plurality of affordances for accessing system functions of the first computer system) that the respective setting of the first computer system is being adjusted. This is described herein with reference to FIGS. 7H-7I, for example, where the user maintains the first air pinch gesture (e.g., that activates the volume affordance 7038 in FIG. 7H), and the first air pinch gesture (e.g., in combination with a change in position of the user’s hand 7020 from a first position to a second position) also adjusts the slider of the system space 7040 (e.g., as reflected in the movement of the slider of the system space 7040 in FIG. 7H). Displaying the respective system user interface for adjusting a respective setting of the first computer system in response to detecting the third air pinch gesture, and adjusting the respective settings of the computer system in accordance with changes in position of the user’s hand (e.g., immediately after and while maintaining the third air pinch gesture), reduces the number of inputs needed to adjust the respective setting of the first computer system (e.g., as the third air pinch gesture and the change in position of the user’s hand can both be performed in a single motion, allowing the user to both activate the respective affordance and begin adjusting the respective setting of the computer system in the single motion).

In some embodiments, the computer system displays the plurality of affordances for accessing system functions of the first computer system at a first simulated distance from the viewpoint of the user, wherein the first simulated distance is less than a simulated distance of other user interface objects from the viewpoint of the user (e.g., the first user interface object and/or the plurality of affordances is always displayed “on top” of other user interfaces and/or user interface objects, such that the first user interface object and/or the plurality of affordances is always visible, regardless of what other user interfaces and/or user interface objects are displayed via the first display generation component). In some embodiments, the plurality of affordances is displayed overlaid on at least a portion of the other, further user interface objects in the respective (e.g., currently displayed) view of the three-dimensional environment. This is shown in FIG. 7M, for example, where the system function menu 7024 is (optionally) displayed over a portion of the user interface 7058, with the simulated distance from the system function menu 7024 to the viewpoint of the user being less than the simulated distance from the user interface 7058 to the viewpoint of the user. This is also described above in the description of FIG. 7D, where in some embodiments, the system function menu 7024 is displayed closer to a viewpoint of the user. Displaying the plurality of affordances for accessing system functions of the first computer system at a first simulated distance from the viewpoint of the user that is less than a simulated distance of other user interface objects from the viewpoint of the user provides improved visual feedback that gives visual prominence to the plurality of affordances for accessing system functions when displayed and selected for further interaction.

In some embodiments, the computer system displays a plurality of system status indicators that include information about a status of the system (e.g., Wi-Fi connection status, cellular connection status, a current time, and/or battery charge state). In some embodiments, the plurality of system status indicators are displayed proximate to (e.g., immediately above, immediately below, immediately to the right or left of) the plurality of affordances for accessing system functions of the first computer system. This is described above, for example, in the description of FIG. 7D, where in some embodiments, the system function menu 7024 includes status information about the computer system 7100 (e.g., Wi-Fi connection status, cellular connection status, a current time, and/or battery charge state), in addition to the plurality of affordances for accessing system functions of the computer system 7100. Displaying a plurality of affordances for accessing system functions of the first computer system, and displaying a plurality of system status indicators that include information about a status of the system, reduces the number of inputs needed to access the relevant system function(s) of the first computer system and/or adjust relevant settings of the computer system (e.g., the user does not need to perform additional inputs to individually check each relevant status of the system, and then the input(s) for accessing system functions of the first computer system and/or adjusting settings of the first computer system).

In some embodiments, the first user interface object that is displayed while the first view of the three-dimensional environment is visible is displayed while (e.g., and in accordance with a determination that) a third gaze input satisfies first proximity criteria with respect to the first user interface object. While displaying the first user interface object, the computer system detects that the third gaze input ceases to satisfy the first proximity criteria with respect to the first user interface object, and in some embodiments, in response to detecting that the third gaze input ceases to satisfy the first proximity criteria with respect to the first user interface object (e.g., the user’s gaze is directed to a location in the respective view of three-dimensional environment that is greater than a threshold distance (e.g., 0.5 cm, 1 cm, 2 cm, 5 cm, 10 cm, 50 cm, 1 meter, 5 meters, or any threshold distance between 0 and 5 meters) from the first user interface object), the computer system ceases to display the first user interface object. In some embodiments, ceasing to display the first user interface object includes displaying an animated transition (e.g., of the first user interface object fading out of view). This is described above, for example, in the description of FIG. 7B, where in some embodiments, the indicator 7010 of system function menu ceases to be displayed in response to detecting that a user’s gaze does not satisfy proximity criteria with respect to the indicator 7010 of system function menu. Ceasing to display the first user interface object, in response to detecting that the third gaze input ceases to satisfy the first proximity criteria with respect to the first user interface object, provides additional control options without cluttering the UI with additional displayed controls (e.g., additional displayed controls for ceasing to display the first user interface object and/or for toggling display of the first user interface object), by causing the computer system to automatically dismiss the first user interface object when not needed.

In some embodiments, while the first user interface object is not displayed, (e.g., after ceasing to display the first user interface object) the computer system detects a fourth gaze input that satisfies second proximity criteria with respect to a location at which the first user interface object was previously displayed. In some embodiments, in response to detecting the fourth gaze input that satisfies the second proximity criteria with respect to the location at which the first user interface object was previously displayed (e.g., the user’s gaze is directed to a location in the respective view of three-dimensional environment that is within the threshold distance from the location at which the first user interface object was previously displayed), the computer system displays (e.g., redisplays) the first user interface object. In some embodiments, the second proximity criteria are the same as the first proximity criteria (e.g., the first proximity criteria described above, with reference to ceasing to display the first user interface object in response to detecting that a third gaze input ceases to satisfy the first proximity criteria with respect to the first user interface object). In some embodiments, the second proximity criteria are different from the first proximity criteria (e.g., to add hysteresis, so as to reduce the risk of unintentionally ceasing to display and/or redisplaying the first user interface object when the user’s gaze is near a threshold distance associated with the first and/or second proximity criteria, for example by setting a first threshold distance for satisfying the first proximity criteria to be greater than a second threshold distance for satisfying the second proximity criteria). In some embodiments, redisplaying the first user interface object includes displaying an animated transition (e.g., of the first user interface object fading into view). For example, the first user interface object is displayed in the top center of the field of view of the respective view of the three-dimensional environment (e.g., the top center of a display of the display generation component or of the user’s field of view). When the user looks towards the center of the field of view, the first user interface object ceases to be displayed, and optionally fades out of view. When the user looks upwards towards the top center of the field of view, the first user interface object is redisplayed, and optionally fades into view. This is described above, for example, in the description of FIG. 7B, where after ceasing to display the indicator 7010 of system function menu, the computer system 7100 then detects that the user’s gaze returns to a location near the indicator 7010 of system function menu (e.g., as shown in FIG. 7D), and in response, the computer system 7100 redisplays the indicator 7010 of system function menu. Displaying (or redisplaying) the first user interface object, in response to detecting the fourth gaze input that satisfies the second proximity criteria with respect to the location at which the first user interface object was previously displayed, enables toggling display of the first user interface object (e.g., dismissing and redisplaying the first user interface object) to be performed without displaying additional controls.

In some embodiments, prior to displaying the first user interface object at the first position in the three-dimensional environment, the computer system detects, via the one or more input devices, a fifth gaze input directed to a second region in the first view of the three-dimensional environment, wherein the second region has a first spatial relationship to the first view of the three-dimensional environment (e.g., the second region is a respective portion of (e.g., an upper left corner, a top center portion, a lower right corner, a peripheral region, and/or another portion) of the field of view provided via the first display generation component that has been consistently associated with displaying the first user interface object, and/or the second region is represented in a respective portion of the respective view (e.g., the first view, or another currently displayed view) of the three-dimensional environment that corresponds to the current viewpoint of the user) as a reactive region for a gaze input that corresponds to a request to display the first user interface object. In response to detecting the fifth gaze input directed to the second region in the first view of the three-dimensional environment, the computer system displays the first user interface object at the first position in the three-dimensional environment while the first view of the three-dimensional environment is visible. For example, in FIG. 7AG, the indicator 7010 of system function menu is not displayed. In FIG. 7AH, in response to detecting that the user’s attention 7116 is directed to the region 7158, the computer system 7100 displays the indicator 7010 of system function menu (e.g., at the first position in the three-dimensional environment). Displaying the first user interface object at the first position in the three-dimensional environment in response to detecting a fifth gaze input directed to the second region in the first view of the three-dimensional environment that has a first spatial relationship to the first view of the three-dimensional environment, provides improved visual feedback to the user (e.g., improved visual feedback that the computer system detects the user’s attention is directed to the first position).

In some embodiments, displaying the first user interface object at the first position in the three-dimensional environment in response to detecting the fifth gaze input directed to the second region in the first view of the three-dimensional environment includes: while the fifth gaze input is directed to the second region, displaying the first user interface object with a first size (e.g., an initial size or an intermediate size); and after displaying the first user interface object with the first size and while the fifth gaze input is directed to the second region, displaying the first user interface object with a second size (e.g., an intermediate size or a final, steady state size) that is larger than the first size. In some embodiments, the first user interface object is displayed at the first size when the fifth gaze input is maintained in the second region for at least a first threshold amount of time, and is displayed with increasing sizes after the fifth gaze input is maintained in the second region for more than the first threshold amount of time, until a second threshold amount of time is reached and the first user interface object is displayed with a steady state size. In some embodiments, if the user’s attention ceases to be directed to the second region before the first threshold amount of time is reached, the first computer system forgoes displaying the first user interface object. In some embodiments, if the user’s attention ceases to be directed to the second region before the second threshold amount of time is reached, the first computer system displays the first user interface object and then ceases to display the first user interface object (e.g., forgoes displaying the first user interface object with the steady state size). In some embodiments, the first computer system displays an animated transition between the first size and the second size (e.g., an animated transition of the first user interface object expanding from the first size to the second size) in accordance with the amount of time that the fifth gaze input has remained in the second region. For example, in FIG. 7AH, the indicator 7010 of system function menu is displayed at a first (e.g., smaller) size. In FIG. 7AJ, the indicator 7010 of system function menu is displayed a second (e.g., larger) size, in response to detecting that the user’s attention 7116 is directed to the region 7160. Displaying the first user interface object at the first position in the three-dimensional environment at a first size in response to detecting a fifth gaze input directed to the second region in the first view of the three-dimensional environment that has a first spatial relationship to the first view of the three-dimensional environment, and displaying the first user interface object with a second size larger than the first size, after displaying the first user interface object with the first size and while the fifth gaze input is directed to the second region, provides improved visual feedback to the user (e.g., improved visual feedback that the computer system detects the user’s attention is directed to the first position, and/or improved visual feedback that additional functions are available if the user continues to direct the fifth gaze input to the second region).

In some embodiments, while a respective view of the three-dimensional environment is visible and while the first user interface object is not displayed in the respective view of the three-dimensional environment, the computer system detects, via the one or more input devices, a sixth gaze input directed to a respective region in the respective view of the three-dimensional environment. In response to detecting the sixth gaze input directed to the respective region in the respective view of the three-dimensional environment: in accordance with a determination that the respective view is the first view corresponding to the first viewpoint of the user, and that the respective region has the first spatial relationship to the first view of the three-dimensional environment, the computer system displays the first user interface object in the first view of the three-dimensional environment; and in accordance with a determination that the respective view is the second view corresponding to the second viewpoint of the user, and that the respective region has the first spatial relationship to the second view of the three-dimensional environment, the computer system displays the first user interface object in the second view of the three-dimensional environment. In some embodiments, in response to detecting the sixth gaze input directed to the respective region in the respective view of the three-dimensional environment, in accordance with a determination that the respective region does not have the first spatial relationship to the respective view of the three-dimensional environment, forgoing displaying the first user interface object in the respective view of the three-dimensional environment (e.g., irrespective of whether the respective view is the first view, the second view, or another view of the three-dimensional environment that corresponds to another viewpoint of the user). In some embodiments, the respective region is viewpoint locked and has a fixed spatial relationship to the current field of view provided via the first display generation component, as the respective view of the three-dimensional environment that is visible in the field of view of the first display generation is updated in accordance with the movement of the current viewpoint of the user. For example, as described with reference to FIG. 7AG, in some embodiments, the region 7158 and the region 7160 are viewpoint-locked. Displaying the first user interface object in the first view of the three-dimensional environment, in accordance with a determination that the respective view is the first view corresponding to the first viewpoint of the user and that the respective region has the first spatial relationship to the first view of the three-dimensional environment, and displaying the first user interface object in the second view of the three-dimensional environment, in accordance with a determination that the respective view is the second view corresponding to the second viewpoint of the user and that the respective region has the first spatial relationship to the second view of the three-dimensional environment, reduces the number of user inputs needed to display the plurality of affordances for accessing system functions of the first computer system (e.g., the user does not need to perform additional user inputs to adjust and/or move the respective region (e.g., to display the first user interface object, and subsequently, the plurality of affordances), for different views of the three-dimensional environment (e.g., if the displayed view of the three-dimensional environment changes or is updated due to movement of the user in the physical environment and/or movement of the viewpoint of the user in the three-dimensional environment)).

In some embodiments, during a first period of time (e.g., a period of time immediately after a system reset, an initialization, a restart, and/or one or more other state changes of the first computer system) before the first user interface object is displayed in response to a user input that corresponds to a request to display the first user interface object (e.g., the first gaze input that is directed to a respective region of the currently displayed view of the three-dimensional environment that has the first spatial relationship to the currently displayed view of the three-dimensional environment, where the first gaze input meets stability criteria and duration criteria, and/or is detected in conjunction with a first air gesture (e.g., an air pinch gesture, an air tap gesture, or another type of gesture)): the computer system persistently displays (e.g., automatically, without requiring an explicit request via a user input) the first user interface in one or more views of the three-dimensional environment (e.g., while the same view is maintained, or while the view is updated through a series of changes of the viewpoint); while persistently displaying (e.g., automatically, without requiring an explicit request via a user input) the first user interface in one or more views of the three-dimensional environment (e.g., while the same view is maintained, or while the view is updated through a series of changes of the viewpoint), the computer system detects a sixth gaze input directed to the first user interface object; and in response to detecting the sixth gaze input directed to the first user interface object while the first user interface object is persistently displayed in the one or more views of the three-dimensional environment, the computer system ceases to display the first user interface object (e.g., after a threshold amount of time, such as 1 second, 5 seconds, 10 seconds, or 30 seconds, that the sixth gaze input is maintained on the first user interface object). In some embodiments, the first user interface object remains displayed for an extended period of time when the first computer system starts and the first user interface object is displayed for the first time since the first computer system starts or is first initialized, and the first user interface object is dismissed when the first computer system detects the user looks at the first user interface object for the first time. After that, the first computer system displays the first user interface object in response to the user’s request (e.g., via a gaze input directed to the first region of the currently displayed view of the three-dimensional environment) and ceases to display the first user interface object in response to detecting that the user’s attention is no longer directed to first user interface object and/or the plurality of affordances for accessing system functions of the first computer system. For example, as described with reference to FIG. 7AM, in some embodiments, the indicator 7010 of system function menu is displayed (e.g., as described above with reference to FIG. 7AG-7AM) if the user 7002 has not interacted with the indicator 7010 of system function menu and/or the system function menu 7024 before (e.g., the first time the system function menu 7024 is displayed), and optionally is not displayed again after the system function menu 7024 is displayed for the first time (e.g., to avoid cluttering the display of the computer system with the indicator 7010 of system function menu when the user 7002 already knows how to access the system function menu 7024 (e.g., by directing the user’s attention 7116 to the region 7160 and/or the location in the region 7160 where the indicator 7010 of system function menu is shown in FIG. 7AM)). Persistently displaying the first user interface in one or more views of the three-dimensional environment, and ceasing to display the first user interface object in response to detecting the sixth gaze input directed to the first user interface object while the first user interface object is persistently displayed in the one or more views of the three-dimensional environment, enables the computer system to display the first user interface object (e.g., and provide visual feedback regarding how to display the plurality of affordances for accessing system functions of the first computer system) only when needed (e.g., after the first user interface object has been displayed an initial time, and after the user’s attention has been directed to the first user interface object (e.g., and triggered display of the plurality of affordances for accessing system functions of the first computer system), the computer system does not need to continue displaying the first user interface object (e.g., because the computer system has already instructed the user on how to display the plurality of affordances for accessing system functions of the first computer system).

In some embodiments, in response to detecting the sixth gaze input directed to the first user interface object while the first user interface object is persistently displayed in the one or more views of the three-dimensional environment, the computer system displays visual guidance regarding how to redisplay the first user interface object (e.g., after the first user interface object ceases to be displayed in response to the second gaze input) in a respective view of the three-dimensional environment. For example, as described with reference to FIG. 7AH, the computer system 7100 displays (e.g., concurrently with the indicator 7010 of system function menu) instructions (e.g., text-based instructions, visual or pictorial instructions) for expanding the indicator 7010 of system function menu and/or invoking the system function menu 7024 (e.g., via one or more inputs as described below with reference to FIG. 7AI-AM). Displaying visual guidance regarding how to redisplay the first user interface object in a respective view of the three-dimensional environment, provides improved visual feedback to the user (e.g., improved visual feedback regarding how to redisplay the first user interface object).

In some embodiments, while displaying the visual guidance, the computer system detects that user attention was directed to the visual guidance (e.g., for a threshold amount of time, such as 5 seconds, 10 seconds, 15 seconds, or 30 seconds) before moving away from the visual guidance, wherein the first computer system ceases to display the first user interface object in response to detecting that the user attention has moved outside of the respective region that has the first spatial relationship to the respective view of the three-dimensional environment (e.g., the first view, the second view, or another view of the three-dimensional environment that corresponds to the current viewpoint of the user) (e.g., in accordance with a determination that the user’s gaze has moved away from the respective region for triggering display of the first user interface object, and optionally, has stayed outside of the respective region for at least a threshold amount of time without returning to the respective region). In some embodiments, the first computer system also ceases to display the visual guidance, e.g., in response to detecting that the user attention has moved outside of the respective region that has the first spatial relationship to the respective view of the three-dimensional environment (e.g., before, along with, or after ceasing to display the first user interface object). For example, as described with reference to FIG. 7AH, in some embodiments, the instructions are persistently displayed until the user’s attention is directed to the displayed instructions. In some embodiments, after the user’s attention is directed to the displayed instructions, the computer system detects that the user’s attention moves away from the displayed instructions (e.g., for a threshold amount of time, such as 1 second, 2 seconds, 5 seconds, or 10 seconds), and in response, the computer system 7100 ceases to display the instructions. Ceasing to display the first user interface object in response to detecting that the user attention has moved outside of the respective region that has the first spatial relationship to the respective view of the three-dimensional environment, enables the computer system to provide improved visual feedback to the user (e.g., improved visual feedback regarding how to redisplay the first user interface object), without needing to always display the first user interface object (thereby increasing the user’s visibility of the real and/or virtual environment).

In some embodiments, while detecting a respective gaze input directed to the first user interface object (e.g., the first gaze input that is directed to the first user object after the first user interface object is displayed in response to an earlier gaze input on the second region of the first view, or a gaze input that is directed to the second region (e.g., the fifth gaze input mentioned earlier) and that triggers the display of the first user interface object), the computer system increases a size of the first user interface object (e.g., from the final, steady state size to an even larger size, to indicate progress toward displaying the plurality of affordances for accessing system functions). In accordance with a determination that the respective gaze input meets the attention criteria with respect to the first user interface object (e.g., the first gaze input that is detected on the first user interface object for at least a third threshold amount of time, or the fifth gaze input has moved onto the first user interface object after triggering display of the first user interface object, and has been maintained on the first user interface object for at least a fourth threshold amount of time (e.g., the time threshold for triggering display of the system function menu 7024 of FIG. AM), the first computer system displays the plurality of affordances for accessing system functions of the first computer system after increasing the size of the first user interface object. In some embodiments, in accordance with a determination that the respective gaze input does not meet the attention criteria and that the respective gaze input ceases to be maintained on the first user interface object (e.g., the fifth gaze input moves outside of the second region before the attention criteria are met), the first computer system ceases to display the first user interface object and forgoes displaying the plurality of affordances for accessing system functions of the first computer system. In some embodiments, in accordance with a determination that the respective gaze input does not meet the attention criteria and that the respective gaze input ceases to be maintained on the first user interface object (e.g., the fifth gaze input remains in the second region but away from the first user interface object before the attention criteria are met), the first computer system reduces the size of the first user interface object and forgoes displaying the plurality of affordances for accessing system functions of the first computer system. In some embodiments, the first computer system displays an animated transition of the first user interface object expanding into the plurality of affordances for accessing system functions of the first computer system, in accordance with a determination that the attention criteria are met by the respective gaze input. In some embodiments, the size of the first user interface object provides visual feedback regarding the progress towards and/or away from displaying the affordances for accessing system functions of the first computer system, as the respective gaze input remains on or moves away from the first user interface object. For example, in FIG. 7AG-7AL, the indicator 7010 of system function menu increases in size (e.g., as long as the user’s attention is directed to the region 7160 and/or the indicator 7010 of system function menu itself). In FIG. 7AM, after displaying the indicator 7010 of system function menu (e.g., at its full size), the computer system 7100 displays the system function menu 7024 in response to detecting that the user’s attention 7116 is directed to the indicator 7010 of system function menu. Increasing a first size of the first user interface object while detecting a respective gaze input directed to the first user interface object, and displaying the plurality of affordances for accessing system functions of the first computer system after increasing the size of the first user interface object, in accordance with a determination that the respective gaze input meets the attention criteria with respect to the first user interface object, provides improved visual feedback to the user (e.g., improved visual feedback that the user’s gaze input meets (or in the process of meeting) the attention criteria, and that the plurality of affordances for accessing system functions of the first computer system will be displayed if the user’s gaze input meets the attention criteria (e.g., the user’s attention remains directed to the first user interface object).

In some embodiments, the first computer system determines that the first gaze input satisfies the attention criteria in accordance with a determination that the first gaze input is maintained on the first user interface object for at least a first amount of time (e.g., an amount of time set by a dwell timer that is started when the first gaze input is detected on the first user interface object), or in accordance with a determination that a first gesture is detected in conjunction with the first gaze input maintained on the first user interface object, before the first gaze input has been maintained on the first user interface object for at least the first amount of time. For example, in some embodiments, if an air pinch gesture is detected before the first gaze input has been maintained on the first user interface object for the first amount of time, the first computer system displays the plurality of affordances right away, without waiting until the first amount of time has been reached. For example, as described with reference to FIGS. 7AJ and 7AM, while the user’s attention 7116 is directed to the region 7160 (or the indicator 7010 of system function menu) and before the full-sized the indicator 7010 of system function menu is displayed, the user can perform a gesture (e.g., an air gesture, such as an air tap or an air pinch, as described herein) to display the full-sized the indicator 7010 of system function menu and/or the system function menu 7024 (e.g., the user can skip from FIG. 7AJ straight to FIG. 7AL or FIG. 7AM) without having to wait for the indicator 7010 of system function menu to expand to its full size (e.g., the sequence described above with reference to FIG. 7AH-7AL), optionally, concurrently with displaying the system function menu 7024 (e.g., as shown in FIG. 7AM). Satisfying the attention criteria in accordance with a determination that the first gaze input is maintained on the first user interface object for at least a first amount of time, or in accordance with a determination that a first gesture is detected in conjunction with the first gaze input maintained on the first user interface object, before the first gaze input has been maintained on the first user interface object for at least the first amount of time, enables the computer system to efficiently display the plurality of affordances for accessing system functions of the computer system (e.g., the user does not need to wait for the first user interface object to expand before the computer system displays the plurality of affordances for accessing system functions of the computer system), which conserves battery power for the computer system while in operation (e.g., because the computer system does not expend unnecessary power displaying the expansion of the first user interface object, when not needed).

In some embodiments, aspects/operations of methods 8000, 9000, 10000, 11000, 12000, 13000, 14000, 15000, and 16000 may be interchanged, substituted, and/or added between these methods. For example, the first user interface object (e.g., system control indicator) in the method 8000 in some circumstances has a different appearance as described in the methods 9000-16000 below, and the user interface elements that are displayed (e.g., the plurality of affordances for accessing system functions of the first computer system) may be replaced by, or concurrently displayed with, other user interface elements (e.g., additional content associated with a notification, a user interface that includes an affordance for joining a communication session, and other user interface elements in the methods 9000-16000 below). For brevity, these details are not repeated here.

FIG. 9 is a flow diagram of an exemplary method 9000 for displaying content associated with a first notification, in response to detecting a first gaze input directed to a first user interface object, in accordance with a determination that a first event for the first notification satisfies timing criteria. In some embodiments, the method 9000 is performed at a computer system (e.g., computer system 101 in FIG. 1) (which is sometimes referred to as “the first computer system”) that is in communication with a display generation component (e.g., display generation component 120 in FIGS. 1, 3, and 4) (e.g., a heads-up display, a display, a touchscreen, or a projector) and one or more input devices (e.g., a touch screen, a camera, and/or a microphone). In some embodiments, the computer system optionally includes one or more cameras (e.g., a camera (e.g., color sensors, infrared sensors, and/or other depth-sensing cameras) that points towards the user (e.g., to detect the gaze of the user) and/or a camera that points forward (e.g., to facilitate displaying elements of the physical environment captured by the camera). In some embodiments, the method 9000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 9000 are, optionally, combined and/or the order of some operations is, optionally, changed.

Conditionally displaying content associated with the first notification or displaying the plurality of affordances for performing system operations associated with the first computer system based on whether the first notification occurred recently enough to meet timing criteria causes the computer system to automatically provide access to additional control options that are more likely to be relevant to a current context of the first computer system without displaying additional controls (e.g., controls that are less likely to be relevant to the current context and/or separate controls for displaying the content associated with the first notification, and for displaying the plurality of affordances for performing system operations associated with the first computer system).

The computer system displays, via the first display generation component, a first user interface object (e.g., indicator 7010 of system function menu (FIG. 7B) or user interface object 7056 (FIG. 7L)) while a first view of a three-dimensional environment is visible, wherein the first user interface object is displayed at a first position in the three-dimensional environment, and wherein the first position in the three-dimensional environment has a first spatial arrangement relative to a respective portion of the user (e.g., relative to a viewpoint of the user). In some embodiments, the first user interface object is displayed at a first location on, or relative to, the first display generation component that is independent of the contents of the first view of the three-dimensional environment.

While displaying the first user interface object in the first view of the three-dimensional environment, the computer system detects, via the one or more input devices, a first gaze input directed to the first user interface object. In response to detecting the first gaze input directed to the first user interface object: in accordance with a determination that a first event for a first notification satisfies timing criteria (e.g., the user directs his or her gaze to the first user interface object within a threshold amount of time after the first event for the first notification) (e.g., as described herein with reference to FIGS. 7L-7M), the computer system displays content associated with the first notification (e.g., notification content 7060 (FIG. 7M)); and in accordance with a determination that the first event for the first notification does not satisfy the timing criteria (e.g., as described herein with reference to FIGS. 7P-7Q), the computer system displays a plurality of affordances for performing system operations associated with the first computer system (e.g., a volume control, a search affordance, a notification center, a control panel, and/or a virtual assistant) (e.g., system function menu 7024 (FIG. 7Q)) without displaying the content associated with the first notification.

In some embodiments, while (e.g., after initially) displaying the content associated with the first notification (e.g., in response to detecting that the user’s gaze continues to be directed to the first user interface object), the computer system displays the plurality of affordances for performing system operations associated with the first computer system (e.g., concurrently with the content associated with the first notification). In some embodiments, the plurality of affordances is not displayed (e.g., initially) in response to the first gaze input directed to the first user interface object if the first event for the first notification satisfies the timing criteria, and the plurality of affordances is displayed in accordance with a determination that the user’s gaze continues to be directed to the first user interface object (and/or in response to detecting the user’s continued gaze directed to the first user interface object). This is described above, for example, in the description of FIG. 7M, where in some embodiments, the notification content 7060 is initially displayed without display of the system function menu 7024. After displaying the notification content 7060, and in response to detecting that the user’s gaze continues to be directed to the user interface object 7056 (e.g., for a threshold amount of time (e.g., 0.1, 0.2, 0.5, 1, 2, 5, 10, 30, or 60 seconds)), the computer system 7100 concurrently displays the notification content 7060 and the system function menu 7024 (e.g., as shown in FIG. 7M). Displaying the plurality of affordances for performing system operations associated with the first computer system in response to detecting sustained gaze input (e.g., a continuation of the first gaze input) directed to the first user interface object reduces the number of inputs needed to display the plurality of affordances for performing system operations associated with the first computer system (e.g., the user does not need to perform an additional input, after the first gaze input, to display the plurality of affordances for performing system operations associated with the first computer system).

In some embodiments, in accordance with the determination that the first event for the first notification satisfies the timing criteria (e.g., the user directs his or her gaze to the first user interface object within a threshold amount of time (e.g., 5 seconds, 10 seconds, 20 seconds, 30 seconds, 60 seconds, or any threshold time between 0 and 60 seconds) after the first event for the first notification), the first user interface object is displayed with a first appearance that indicates an application associated with the first notification (e.g., the first user interface object is or includes an icon of the associated application); and in accordance with the determination that the first event for the first notification does not satisfy the timing criteria, the first user interface object is displayed with a second appearance, different from the first appearance (e.g., the first user interface is a default indicator (e.g., of system function menu) that does not indicate the application associated with the first notification, and/or the first user interface has another appearance that does not indicate the application associated with the first notification). This is described above, for example, in the description of FIG. 7L, where the indicator 7010 of system function menu (e.g., a default appearance of the first user interface object) is displayed when the first event for the first notification does not satisfy the timing criteria, and the user interface object 7056 is displayed instead, optionally with an appearance that is indicative of an application associated with the first event for the first notification (e.g., the user interface object 7056 appears as the application icon for a messaging application associated with the recently received text message). In some embodiments, in accordance with the determination that a second event for a second notification satisfies the timing criteria. the first user interface is an indicator (e.g., of system function menu) that is or includes an icon for an (e.g., second) application, different from the application associated with the first notification, that is associated with a second notification. In some such embodiments, in accordance with the determination that a second event for a second notification does not satisfy the timing criteria (and optionally the first event for the first notification does not satisfy the timing criteria), the first user interface is an indicator (e.g., of system function menu) that does not indicate the application associated with the first or second notification (and/or the first user interface object has another appearance that does not indicate the application associated with the first or second notification). Displaying the first user interface object with a first appearance that indicates an application associated with the first notification if the first event for the first notification satisfies the timing criteria, and displaying the first user interface object with a different second appearance if the first event for the first notification does not satisfy the timing criteria, provides improved visual feedback about a state of the computer system (e.g., whether the first computer system has recently received a notification).

In some embodiments, in accordance with the determination that the first event for the first notification satisfies the timing criteria, the computer system ceases to display the first user interface object with the first appearance after a threshold amount of time has elapsed (e.g., since occurrence, generation, or detection of the first event for the first notification) (e.g., and subsequently redisplays the first user interface object with the second appearance after the threshold amount of time has elapsed). This is described above, for example, in the description of FIG. 7L, where in some embodiments, the user interface object 7056 is displayed with the appearance that is indicative of an application associated with the first event for the first notification, but ceases to be displayed with that appearance (e.g., and is instead displayed with a default appearance, such as the appearance of the indicator 7010 of system function menu), after a threshold amount of time (e.g., 5 seconds, 10 seconds, 30 seconds, or 1 minute) has elapsed (e.g., since occurrence, generation, or detection of the first event for the first notification), as described for example with reference to FIG. 7P. Ceasing to display the first user interface object with the first appearance after a threshold amount of time has elapsed causes the computer system to automatically cease notifying the user about an event that is no longer sufficiently recent, and to automatically revert the first user interface object to a less intrusive appearance.

In some embodiments, while displaying the plurality of affordances for performing system operations associated with the first computer system, the computer system detects, via the one or more input devices, an input that corresponds to movement of a viewpoint of the user from a first viewpoint to a second viewpoint in the three-dimensional environment (e.g., the first view of the three-dimensional environment is visible from the first viewpoint, and a second view of the three-dimensional environment is visible from the second viewpoint, the second view being different from the first view in accordance with the second viewpoint being different from the first viewpoint). In some embodiments, in response to detecting the input that corresponds to movement of the viewpoint of the user from the first viewpoint to the second viewpoint in the three-dimensional environment (e.g., and while a second view of the three-dimensional environment is visible), the computer system moves the first user interface object by a first amount in the three-dimensional environment, and in accordance with the movement of the viewpoint of the user (e.g., in accordance with a determination that the movement of the viewpoint is detected while displaying the first user interface object), and in accordance with a determination that the movement of the viewpoint is detected while displaying the plurality of affordances for performing system operations associated with the first computer system, the computer system moves the plurality of affordances for performing system operations associated with the first computer system by a second amount in the three-dimensional environment, and in accordance with movement of the viewpoint of the user, wherein the second amount is different from the first amount. For example, if the second amount is less than the first amount, then the first user interface follows the movement of the viewpoint of the user more closely than the plurality of affordances (e.g., during the movement of the viewpoint of the user). Alternatively, if the second amount is greater than the first amount, then the first user interface follows the movement of the viewpoint of the user less closely than the plurality of affordances (e.g., during the movement of the viewpoint of the user).

In some embodiments, the first user interface object and/or the plurality of affordances for performing system operations associated with the first computer system do not move if the movement of the viewpoint of the user does not exceed a threshold amount (e.g., 5 degrees, 10 degrees, 25 degrees, 45 degrees, 90 degrees, 120 degrees, or any threshold angle between 0 and 120 degrees, and/or distance of 1 cm, 2 cm, 5 cm, 10 cm, 50 cm, 1 meter, 5 meters, or any threshold distance between 0 and 5 meters) of movement (e.g., small, inadvertent movement or sway of the user’s hand(s) while holding the first computer system or of the user’s head while wearing a head-mounted display of the first computer system), whereas the first user interface object and/or the plurality of affordance for performing system operations associated with the first computer system move if the movement of the viewpoint of the user exceeds the threshold amount of movement (e.g., intentional movement to change the viewpoint of the user). In some embodiments, in accordance with a determination that the movement of the viewpoint of the user from the first viewpoint to the second viewpoint does not satisfy the threshold amount (e.g., angle and/or distance) of movement, the computer system maintains display of the first user interface object at the first position in the three-dimensional environment while a second view of the three-dimensional environment is visible (e.g., even though the first user interface object no longer has the first spatial arrangement relative to the respective portion of the user). In accordance with a determination that the movement of the viewpoint of the user from the first viewpoint to the second viewpoint satisfies the threshold amount of movement, the computer system maintains display of the first user interface object at a respective position in the three-dimensional environment having the first spatial arrangement relative to the respective portion of the user while the second view of the three-dimensional environment is visible.

In some embodiments, the plurality of affordances for performing system operations associated with the first computer system is displayed at a second position in the three-dimensional environment (e.g., in response to detecting the first gaze input directed to the first user interface object and optionally in accordance with the determination that the first event for the first notification does not satisfy the timing criteria), wherein the second position in the three-dimensional environment has a second spatial arrangement relative to the respective portion of the user. In accordance with a determination that the movement of the viewpoint of the user from the first viewpoint to the second viewpoint does not satisfy the threshold amount (e.g., angle and/or distance) of movement, the computer system maintains display of the plurality of affordances for performing system operations associated with the first computer system at the second position in the three-dimensional environment while the second view of the three-dimensional environment is visible (e.g., even though the plurality of affordances for performing system operations associated with the first computer system no longer have the second spatial arrangement relative to the respective portion of the user). In accordance with a determination that the movement of the viewpoint of the user from the first viewpoint to the second viewpoint satisfies the threshold amount of movement, the computer system maintains display of the plurality of affordances for performing system operations associated with the first computer system at a respective position in the three-dimensional environment having the second spatial arrangement relative to the respective portion of the user while the second view of the three-dimensional environment is visible.

This is described above, for example, in the description of FIG. 7N, where in some embodiments, the user interface object 7056 has different follow behavior than the system function menu 7024 (e.g., similar to how the indicator 7010 of system function menu optionally has different follow behavior from the system function menu 7024, as described above, and as shown in FIG. 7F). Moving the first user interface object by a first amount in the three-dimensional environment, and moving the plurality of affordances for performing system operations associated with the first computer system by a second amount different from the first amount, in response to detecting the input that corresponds to movement of the viewpoint of the user from the first viewpoint to the second viewpoint in the three-dimensional environment, provides improved visual feedback distinguishing different user interface elements and improved visual feedback regarding the movement of the viewpoint.

In some embodiments, the computer system detects, via the one or more input devices, an input that corresponds to movement of the viewpoint of the user from a first viewpoint to a second viewpoint in the three-dimensional environment. In some embodiments, in response to detecting the input that corresponds to movement of the viewpoint of the user from the first viewpoint to the second viewpoint in the three-dimensional environment, and in accordance with the determination that the first event for the first notification satisfies the timing criteria (e.g., the user directs his or her gaze to the first user interface object within a threshold amount of time (e.g., 5 seconds, 10 seconds, 20 seconds, 30 seconds, 60 seconds, or any threshold time between 0 and 60 seconds) after the first event for the first notification): the computer system displays the first user interface object with a first appearance that indicates an application associated with the first notification; and the computer system moves the first user interface object by a third amount in the three-dimensional environment, and in accordance with the movement of the viewpoint of the user.

In response to detecting the input that corresponds to movement of the viewpoint of the user from the first viewpoint to the second viewpoint in the three-dimensional environment, and in accordance with the determination that the first event for the first notification does not satisfy the timing criteria: the computer system displays the first user interface object with a second appearance, different from the first appearance (e.g., the appearance of the indicator 7010 of system function menu (FIG. 7P)); and the computer system moves the first user interface object by a fourth amount in the three-dimensional environment, and in accordance with the movement of the viewpoint of the user, wherein the fourth amount different from the third amount. For example, if the fourth amount is less than the third amount, then when the first event for the first notification satisfies the timing criteria (e.g., when the first user interface has the first appearance), the first user interface follows the movement of the viewpoint of the user more closely than when the first event for the first notification does not satisfy the timing criteria (e.g., when the first user interface has the second appearance) (e.g., during the movement of the viewpoint of the user). Alternatively, if the fourth amount is greater than the third amount, then when the first event for the first notification satisfies the timing criteria (e.g., when the first user interface has the first appearance), the first user interface follows the movement of the viewpoint of the user less closely than when the first event for the first notification does not satisfy the timing criteria (e.g., when the first user interface has the second appearance) (e.g., during the movement of the viewpoint of the user).

In some embodiments, the first user interface object does not move if the movement of the viewpoint of the user does not exceed a threshold amount of movement (e.g., 5 degrees, 10 degrees, 25 degrees, 45 degrees, 90 degrees, 120 degrees, or any threshold angle between 0 and 120 degrees, and/or distance of 1 cm, 2 cm, 5 cm, 10 cm, 50 cm, 1 meter, 5 meters, or any threshold distance between 0 and 5 meters) (e.g., small, inadvertent movement or sway of the user’s hand(s) while holding the first computer system or of the user’s head while wearing a head-mounted display of the first computer system), whereas the first user interface object moves if the movement of the viewpoint of the user exceeds the threshold amount of movement (e.g., intentional movement to change the viewpoint of the user). In some embodiments, in accordance with a determination that the movement of the viewpoint of the user from the first viewpoint to the second viewpoint does not satisfy the threshold amount (e.g., angle and/or distance) of movement, the computer system maintains display of the first user interface object at the first position in the three-dimensional environment while a second view of the three-dimensional environment is visible. In accordance with a determination that the movement of the viewpoint of the user from the first viewpoint to the second viewpoint satisfies the threshold amount of movement, the computer system maintains display of the first user interface object at a respective position in the three-dimensional environment having the first spatial arrangement relative to the respective portion of the user while the second view of the three-dimensional environment is visible.

This is described above, for example, in the description of FIG. 7N, where in some embodiments, the follow behavior of the indicator 7010 of system function menu (e.g., a default appearance of the first user interface) is different from the follow behavior of the user interface object 7056 (e.g., which has an appearance indicative of an application associated with the first event for the first notification). Moving the first user interface object by different amounts, in response to detecting an input that corresponds to movement of the viewpoint of the user from the first viewpoint to the second viewpoint in the three-dimensional environment based on whether the first event for the first notification satisfies the timing criteria or not provides improved visual feedback about a state of the device (e.g., whether the first computer system has recently received a notification) and enables displaying some user interface elements with more or less visual prominence (e.g., by following the user’s viewpoint more or less closely, respectively) than others.

In some embodiments, the computer system detects, via the one or more input devices, an input that corresponds to movement of the viewpoint of the user from a first viewpoint to a second viewpoint in the three-dimensional environment. In some embodiments, in response to detecting the input that corresponds to movement of the viewpoint of the user from the first viewpoint to the second viewpoint in the three-dimensional environment: in accordance with a determination that the movement of the viewpoint is detected while displaying the plurality of affordances for performing system operations associated with the first computer system, the computer system moves the plurality of affordances for performing system operations associated with the first computer system by a fifth amount in the three-dimensional environment, and in accordance with the movement of the viewpoint of the user; and in accordance with a determination that the movement of the viewpoint is detected while displaying the content associated with the first notification, the computer system moves the content associated with the first notification by a sixth amount in the three-dimensional environment in accordance with the movement of the viewpoint of the user, wherein the sixth amount is different from the fifth amount. For example, if the sixth amount is less than the fifth amount, then the plurality of affordances follows the movement of the viewpoint of the user more closely than the content associated with the first notification (e.g., for a given amount of movement of the viewpoint of the user, the notification content would move less from a prior position toward a new position corresponding to the current viewpoint of the user, and thus would follow the viewpoint of the user more slowly (less closely) than would the plurality of affordances). Alternatively, if the sixth amount is greater than the fifth amount, then the plurality of affordances follows the movement of the viewpoint of the user less closely than the content associated with the first notification (e.g., for a given amount of movement of the viewpoint of the user, the notification content would move more from a prior position toward a new position corresponding to the current viewpoint of the user, and thus would follow the viewpoint of the user faster (more closely) than would the plurality of affordances). This is described above, for example, in the description of FIG. 7N, where in some embodiments, the system function menu 7024 has different follow behavior from the notification content 7060.

In some embodiments, the plurality of affordances for performing system operations associated with the first computer system are concurrently displayed with the content associated with the first notifications. In some embodiments, the plurality of affordances for performing system operations associated with the first computer system and/or the content associated with the first notification do not move if the movement of the viewpoint of the user does not exceed a threshold amount of movement (e.g., 5 degrees, 10 degrees, 25 degrees, 45 degrees, 90 degrees, 120 degrees, or any threshold angle between 0 and 120 degrees, and/or distance of 1 cm, 2 cm, 5 cm, 10 cm, 50 cm, 1 meter, 5 meters, or any threshold distance between 0 and 5 meters) (e.g., small, inadvertent movement or sway of the user’s hand(s) while holding the first computer system or of the user’s head while wearing a head-mounted display of the first computer system), whereas the plurality of affordance for performing system operations associated with the first computer system and/or the content associated with the first notification move if the movement of the viewpoint of the user exceeds the threshold amount of movement (e.g., intentional movement to change the viewpoint of the user).

In some embodiments, the plurality of affordances for performing system operations associated with the first computer system is displayed at a second position in the three-dimensional environment (e.g., in response to detecting the first gaze input directed to the first user interface object and optionally in accordance with the determination that the first event for the first notification does not satisfy the timing criteria), wherein the second position in the three-dimensional environment has a second spatial arrangement relative to the respective portion of the user. In accordance with a determination that the movement of the viewpoint of the user from the first viewpoint to the second viewpoint does not satisfy the threshold amount (e.g., angle and/or distance) of movement, the computer system maintains display of the plurality of affordances for performing system operations associated with the first computer system at the second position in the three-dimensional environment while the second view of the three-dimensional environment is visible (e.g., even though the plurality of affordances for performing system operations associated with the first computer system no longer have the second spatial arrangement relative to the respective portion of the user). In accordance with a determination that the movement of the viewpoint of the user from the first viewpoint to the second viewpoint satisfies the threshold amount of movement, the computer system maintains display of the plurality of affordances for performing system operations associated with the first computer system at a respective position in the three-dimensional environment having the second spatial arrangement relative to the respective portion of the user while the second view of the three-dimensional environment is visible.

In some embodiments, the content associated with the first notification is displayed at a third position in the three-dimensional environment, wherein the third position in the three-dimensional environment has a third spatial arrangement relative to the respective portion of the user. In accordance with a determination that the movement of the viewpoint of the user from the first viewpoint to the second viewpoint does not satisfy the threshold amount (e.g., angle and/or distance) of movement, the computer system maintains display of the content associated with the first notification at the third position in the three-dimensional environment while the second view of the three-dimensional environment is visible (e.g., even though the content associated with the first notification no longer has the third spatial arrangement relative to the respective portion of the user). In accordance with a determination that the movement of the viewpoint of the user from the first viewpoint to the second viewpoint satisfies the threshold amount of movement, the computer system maintains display of the content associated with the first notification at a respective position in the three-dimensional environment having the third spatial arrangement relative to the respective portion of the user while the second view of the three-dimensional environment is visible.

Moving the plurality of affordances for performing system operations associated with the first computer system by a different amount in the three-dimensional environment than the content associated with the first notification, in accordance with a given amount of movement of the viewpoint of the user, provides improved visual feedback distinguishing different user interface elements and enables visually emphasizing some user interface elements (e.g., that are displayed as following the user’s viewpoint more closely) over others (e.g., that are displayed as following the user’s viewpoint less closely).

In some embodiments, the computer system maintains display of the first user interface object in the first view of the three-dimensional environment (e.g., while displaying the content associated with the first notification without displaying the plurality of affordances for performing system operations associated with the first computer system). This is shown in FIG. 7M, for example, where the user interface object 7056 is concurrently displayed with the notification content 7060 (and the dotted outline of the system function menu 7024, which includes a plurality of affordances for performing system operations associated with the first computer system, indicates that the system function menu 7024 is optionally not displayed in FIG. 7M). Displaying content associated with the first notification and maintaining display of the first user interface object in the first view of the three-dimensional environment reduces the number of inputs needed to display the plurality of affordances for performing system operations associated with the first computer system (e.g., the user does not need to perform additional inputs to first redisplay the first user interface object).

In some embodiments, while displaying the content associated with the first notification (e.g., without displaying the plurality of affordances for performing system operations associated with the first computer system), the computer system detects, via the one or more input devices, a second gaze input directed to the first user interface object. In some embodiments, in response to detecting the second gaze input directed to the first user interface object, the computer system optionally ceases to display the content associated with the first notification, and the computer system displays the plurality of affordances (e.g., the plurality of affordances described herein with reference to FIG. 7E) for performing system operations associated with the first computer system (e.g., a volume control, a search affordance, a notification center, a control panel, and/or a virtual assistant) without displaying the content associated with the first notification. This is described above, for example, in the description of FIG. 7M, where in response to detecting a first gaze input directed to the user interface object 7056, the computer system 7100 displays the notification content 7060. After displaying the notification content 7060, the user gazes away from the user interface object 7056 (and optionally, the notification content 7060 ceases to be displayed). After gazing away from the user interface object 7056, the user’s gaze returns to the user interface object 7056, and in response, the computer system 7100 displays the system function menu 7024 (e.g., without displaying the notification content 7060). Ceasing to display the content associated with the first notification and instead displaying the plurality of affordances for performing system operations associated with the first computer system, in response to detecting a gaze input directed to the first user interface object while displaying the content associated with the first notification, causes the first computer system to automatically (e.g., without requiring further user input) reduce clutter in the user interface when the user switches to interacting with a different user interface element.

In some embodiments, while displaying the plurality of affordances for performing system operations associated with the first computer system (e.g., without displaying the content associated with the first notification), the computer system detects, via the one or more input devices, a third gaze input directed to the first user interface object. In some embodiments, in response to detecting the third gaze input directed to the first user interface object, the computer system optionally ceases to display the plurality of affordances for performing system operations associated with the first computer system (e.g., a volume control, a search affordance, a notification center, a control panel, and/or a virtual assistant), and the computer system displays the content associated with the first notification. In some embodiments, ceasing to display the plurality of affordances and instead displaying the content associated with the first notification are performed in accordance with a determination that the first event for the first notification (e.g., still) satisfies the timing criteria. This is described above, for example, in the description of FIG. 7M, where if the user repeats this process (e.g., looks away from the user interface object 7056, then looks back at the user interface object 7056), the computer system 7100 displays (e.g., redisplays) the notification content 7060 (e.g., without displaying the system function menu 7024). Ceasing to display the plurality of affordances for performing system operations associated with the first computer system and instead displaying the content associated with the first notification, in response to detecting a gaze input directed to the first user interface while displaying the plurality of affordances for performing system operations associated with the first computer system, causes the first computer system to automatically (e.g., without requiring further user input) dismiss unneeded user interface elements when the user switches to interacting with a different user interface element.

In some embodiments, in response to detecting the first gaze input directed to the first user interface object, and in accordance with a determination that the first computer system is in an active communication session, the computer system displays a session user interface at a location with a respective relationship to (e.g., directly adjacent to, above, below, within a predefined threshold distance (e.g., 0.5 mm, 1 cm, 2 cm, 5 cm, or any threshold distance between 0 and 5 cm) of the plurality of affordances for performing system operations associated with the first computer system (e.g., in accordance with a determination that the plurality of affordances is displayed). In some embodiments, in accordance with the determination that the first event for the first notification satisfies the timing criteria and the determination that the first computer system is in the active communication session, the session user interface is displayed at a location with a respective relationship to the content associated with the first notification.

In some embodiments, the session user interface includes a plurality of affordances corresponding to the active communication session. For example, the plurality of affordances include affordances for: leaving the active communication session, displaying past communication information (e.g., previously received text messages) corresponding to one or more other users in the active communication session, displaying information about the active communication session (e.g., a list of users in the active communication session), muting or unmuting a microphone of the first computer system, displaying previously shared content (e.g., shared by and/or with one or more other users in the active communication session), displaying recently shared content (e.g., shared by and/or with one or more other users in the active communication session), and/or sharing content (e.g., photos, photo albums, Internet content, and/or a screen of the first computer system) with one or more other users in the active communication session.

This is shown in FIG. 7U, for example, where the computer system 7100 is in an active communication session, and the computer system 7100 displays the call control user interface 7072 (that optionally has a respective spatial relationship to the system function menu 7024, as described above with reference to FIG. 7U). Displaying a session user interface at a location with a respective relationship to the plurality of affordances for performing system operations associated with the first computer system, in accordance with a determination that the first computer system is in an active communication session, reduces the number of inputs needed to display the session user interface (e.g., the user does not need to perform additional inputs to display the session user interface) and/or access affordances corresponding to the active communication session (e.g., the user does not need to perform additional inputs to navigate to and/or display a respective affordance of the affordance corresponding to the active communication session) and provides feedback about a state of the device (e.g., current participation in an active communication session).

In some embodiments, while concurrently displaying the session user interface and the plurality of affordances for performing system operations associated with the first computer system, and in accordance with a determination that the user’s gaze is directed to the plurality of affordances for performing system operations associated with the first computer system, the computer system visually deemphasizes the session user interface (e.g., relative to the plurality of affordances for performing system operations associated with the first computer system). This is described above, for example, in the description of FIG. 7U, where in some embodiments, the call control user interface 7072 is concurrently displayed with the system function menu 7024, and when the user’s gaze is directed to the call control user interface 7072, the system function menu 7024 is optionally visually deemphasized (e.g., blurred out or faded). Visually deemphasizing the session user interface, in accordance with a determination that the user’s gaze is directed to the plurality of affordances for performing system operations associated with the first computer system, provides improved visual feedback about the detected focus of the user’s gaze and which user interface element is or will be the target of user interaction.

In some embodiments, while concurrently displaying the session user interface and the plurality of affordances for performing system operations associated with the first computer system, and in accordance with a determination that the user’s gaze is directed to the session user interface, the computer system visually deemphasizes (e.g., blurs, fades, and/or shrinks) the plurality of affordances for performing system operations associated with the first computer system (e.g., relative to the session user interface). This is described above, for example, in the description of FIG. 7U, where in some embodiments, the call control user interface 7072 is concurrently displayed with the system function menu 7024, and when the user’s gaze is directed to the system function menu 7024, the call control user interface 7072 is optionally visually deemphasized (e.g., blurred out and/or faded). Visually deemphasizing the plurality of affordances for performing system operations associated with the first computer system, in accordance with a determination that the user’s gaze is directed to the session user interface, provides improved visual feedback about the detected focus of the user’s gaze and which user interface element is or will be the target of user interaction.

In some embodiments, while displaying the content associated with the first notification, the computer system detects, via the one or more input devices, a first input directed to the content associated with the first notification. In some embodiments, in response to detecting the first input directed to the content associated with the first notification, the computer system launches a first application associated with the first notification, which including displaying, in the three-dimensional environment, a user interface of the first application that is associated with first notification. For example, the first notification is a notification of a received communication (e.g., email or text message), and launching the first application includes displaying a user interface of the first application with a view of the received communication (e.g., displaying the received email in an email application user interface, or displaying the received text message in the context of a conversation in a messages application user interface). In another example, the first notification is a reminder for a scheduled calendar event, and launching the first application includes displaying the calendar event information in a calendar application user interface. This is shown in FIGS. 7N-7O, for example, where in response to detecting a user input (e.g., a gaze input and/or air gesture, in FIG. 7N), the computer system 7100 displays an application user interface 7062 (for an application associated with the first event for the first notification that satisfies timing criteria) (FIG. 7O). Displaying a user interface of the first application that is associated with the first notification, in response to detecting the first input directed to the content associated with the first notification (which in turn was displayed in response to a gaze input directed to the first user interface object that indicated the occurrence of the first notification), reduces the number of inputs needed to navigate to the first application to further interact with (e.g., view more information about or reply to) the first notification.

In some embodiments, the computer system detects that the first input meets application launch criteria, and the application launch criteria require the first input include an air pinch and drag gesture, in order for the application launch criteria to be met. In some embodiments, the application launch criteria require that the air pinch and drag gesture be performed while the user’s gaze is directed to the first notification or to the content associated with the first notification). In some embodiments, the first input directed to the content associated with the first notification (e.g., in response to which the first application is launched) includes an air pinch and drag gesture, and is detected while the user’s attention (e.g., gaze) is directed to the content associated with the first notification. As described herein with reference to FIGS. 7N-7O, for example, the user input directed to notification content 7060 (FIG. 7N) that triggers display of an application user interface 7062 (for an application associated with the first event for the first notification that satisfies timing criteria) (FIG. 7O) optionally includes a gaze input and/or an air gesture such as an air pinch and drag gesture towards the viewpoint of the user. Displaying a user interface of the first application that is associated with the first notification, in response to detecting an air pinch and drag gesture, reduces the number and extent of inputs needed to further interact with and view additional context for the first notification.

In some embodiments, the computer system detects, via the one or more input devices, an input that corresponds to movement of the viewpoint of the user from a first viewpoint to a second viewpoint in the three-dimensional environment. In some embodiments, in response to detecting the input that corresponds to movement of the viewpoint of the user from the first viewpoint to the second viewpoint in the three-dimensional environment: in accordance with a determination that the movement of the viewpoint of the user from the first viewpoint to the second viewpoint is detected while displaying the content associated with the first notification, the computer system moves the content associated with the first notification by a seventh amount in the three-dimensional environment, and in accordance with the movement of the viewpoint of the user; and in accordance with a determination that the movement of the viewpoint of the user from the first viewpoint to the second viewpoint is detected while displaying the user interface of the first application that is associated with the first notification, the computer system moves the user interface of the first application that is associated with the first notification by an eighth amount in the three-dimensional environment, and in accordance with the movement of the viewpoint of the user, wherein the eighth amount is different from the seventh amount. For example, if the eighth amount is less than the seventh amount, then the content associated with the first notification follows the movement of the viewpoint of the user more closely than the user interface of the first application that is associated with the first notification (e.g., for a given amount of movement of the viewpoint of the user, the application user interface would move less from a prior position toward a new position corresponding to the current viewpoint of the user, and thus would follow the viewpoint of the user more slowly (less closely) than would the notification content). Alternatively, if the eighth amount is greater than the seventh amount, then the content associated with the first notification follows the movement of the viewpoint of the user less closely than the user interface of the first application that is associated with the first notification (e.g., for a given amount of movement of the viewpoint of the user, the application user interface would move more from a prior position toward a new position corresponding to the current viewpoint of the user, and thus would follow the viewpoint of the user faster (more closely) than would the notification content). This is described above, for example, in the description of FIG. 7N, where in some embodiments, the notification content 7060 (FIG. 7N) has different follow behavior from the application user interface 7062 (FIG. 7O).

In some embodiments, the plurality of affordances for performing system operations associated with the first computer system and/or the content associated with the first notification do not move if the movement of the viewpoint of the user does not exceed a threshold amount of movement (e.g., 5 degrees, 10 degrees, 25 degrees, 45 degrees, 90 degrees, 120 degrees, or any threshold angle between 0 and 120 degrees, and/or distance of 1 cm, 2 cm, 5 cm, 10 cm, 50 cm, 1 meter, 5 meters, or any threshold distance between 0 and 5 meters) (e.g., small, inadvertent movement or sway of the user’s hand(s) while holding the first computer system or of the user’s head while wearing a head-mounted display of the first computer system), whereas the plurality of affordance for performing system operations associated with the first computer system and/or the content associated with the first notification move if the movement of the viewpoint of the user exceeds the threshold amount of movement (e.g., intentional movement to change the viewpoint of the user).

In some embodiments, the content associated with the first notification is displayed at a third position in the three-dimensional environment, wherein the third position in the three-dimensional environment has a third spatial arrangement relative to the respective portion of the user. In accordance with a determination that the movement of the viewpoint of the user from the first viewpoint to the second viewpoint does not satisfy the threshold amount (e.g., angle and/or distance) of movement, the computer system maintains display of the content associated with the first notification at the third position in the three-dimensional environment while the second view of the three-dimensional environment is visible (e.g., even though the content associated with the first notification no longer has the third spatial arrangement relative to the respective portion of the user). In accordance with a determination that the movement of the viewpoint of the user from the first viewpoint to the second viewpoint satisfies the threshold amount of movement, the computer system maintains display of the content associated with the first notification at a respective position in the three-dimensional environment having the third spatial arrangement relative to the respective portion of the user while the second view of the three-dimensional environment is visible.

In some embodiments, the first application associated with the first notification is displayed at a fourth position in the three-dimensional environment, wherein the fourth position in the three-dimensional environment has a fourth spatial arrangement relative to the respective portion of the user. In accordance with a determination that the movement of the viewpoint of the user from the first viewpoint to the second viewpoint does not satisfy the threshold amount (e.g., angle and/or distance) of movement, the computer system maintains display of the first application associated with the first notification at the fourth position in the three-dimensional environment while the second view of the three-dimensional environment is visible (e.g., even though the first application associated with the first notification no longer has the fourth spatial arrangement relative to the respective portion of the user). In accordance with a determination that the movement of the viewpoint of the user from the first viewpoint to the second viewpoint satisfies the threshold amount of movement, the computer system maintains display of the first application associated with the first notification at a respective position in the three-dimensional environment having the fourth spatial arrangement relative to the respective portion of the user while the second view of the three-dimensional environment is visible.

Moving the content associated with the first notification by a different amount in the three-dimensional environment than the user interface of the first application that is associated with the first notification, in accordance with a given amount of movement of the viewpoint of the user, provides improved visual feedback distinguishing different user interface elements and enables visually emphasizing some user interface elements (e.g., that are displayed as following the user’s viewpoint more closely) over others (e.g., that are displayed as following the user’s viewpoint less closely).

In some embodiments, while displaying the content associated with the first notification, the computer system detects, via the one or more input devices, a second input that is directed to the content associated with the first notification and that meets dismissal criteria, wherein the dismissal criteria require the second input include an air pinch and drag gesture (optionally in conjunction with a gaze input directed to the content associated with the first notification), in order for the dismissal criteria to be met. In some embodiments, in response to detecting the second input, the computer system ceases to display the content associated with the first notification. In some embodiments, if the first user interface object was displayed with an appearance that indicates an application associated with the first notification prior to (and/or while) displaying the content associated with the first notification, the first user interface object is redisplayed with an appearance that does not indicate the application associated with the first notification in response to detecting the second input (e.g., to dismiss the content associated with the first notification). In some embodiments, while displaying the content associated with the first notification, and while the user’s attention (e.g., gaze) is directed to the content associated with the first notification, the computer system detects an air pinch and drag gesture, in response to which the computer system ceases to display the content associated with the first notification. This is described herein with reference to FIGS. 7N and 7P, for example, where in response to detecting a user input (e.g., gaze and/or air gesture, as in FIG. 7N), the computer system 7100 dismisses the notification content 7060 (e.g., as shown in FIG. 7P). This is also described above in the description of FIG. 7N, where in response to a pinch and drag downward (e.g., relative to the view displayed on the display generation component, towards the representation of the floor 7008′ as shown in FIG. 7N), the computer system 7100 ceases to display (e.g., dismisses) the notification content 7060 (e.g., transitioning from FIG. 7N directly to FIG. 7P). Ceasing to display the content associated with the first notification, in response to detecting an air pinch and drag gesture, enables the first notification to be dismissed without displaying additional controls.

In some embodiments, while displaying the content associated with the first notification, the computer system detects, via the one or more input devices, a third input (e.g., in conjunction with a gaze input directed to the content associated with the first notification) directed to the content associated with the first notification. In some embodiments, in response to detecting the third input directed to the content associated with the first notification: in accordance with a determination that the third input includes a first air gesture and movement of the user’s hand in a third direction (e.g., the third direction is the same as the first direction) during the first air gesture, the computer system launches a first application associated with the first notification (e.g., displaying a user interface of the first application that is associated with the first notification); and in accordance with a determination that the third input includes a second air gesture and, movement of the user’s hand in a fourth direction, different from the third direction (e.g., the fourth direction is the same as the second direction) during the second air gesture, the computer system ceases to display the content associated with the first notification (e.g., without launching the first application, and/or without displaying a user interface of the first application that is associated with the first notification). This is described herein with reference to FIGS. 7N-7P, where the computer system 7100 can launch an application (e.g., as shown in FIG. 7O), or cease to display the content associated with the first notification (e.g., as shown in FIG. 7P). This is also described above in the description of FIG. 7N, where in some embodiments, the computer system performs different functions depending on a characteristic of the user input (e.g., a direction, speed, and/or amount of movement of the drag portion of a pinch and drag gesture). For example, in response to a pinch and drag towards the user (e.g., towards the viewpoint of the user), the computer system 7100 launches an application, and displays an application user interface 7062, for an application associated with the notification (e.g., as shown in FIG. 7O). In response to a pinch and drag downward (e.g., relative to the view displayed on the display generation component, towards the representation of the floor 7008′ as shown in FIG. 7N), the computer system 7100 ceases to display (e.g., dismisses) the notification content 7060 (e.g., transitioning from FIG. 7N directly to FIG. 7P). Launching the first application associated with the first notification, or instead ceasing to display the content associated with the first notification, based on the direction of movement of an input directed to the content associated with the first notification enables different operations to be performed with respect to the first notification without displaying additional controls.

In some embodiments, in response to detecting the first gaze input directed to the first user interface object, and in accordance with the determination that the first event for the first notification satisfies the timing criteria, the computer system displays the plurality of affordances for performing system operations associated with the first computer system (e.g., the plurality of affordances for performing system operations associated with the first computer system described herein with reference to FIG. 7E) concurrently with displaying the content associated with the first notification. This is shown in FIG. 7M, for example, where the plurality of affordances for performing system operations associated with the first computer system (e.g., in the system function menu 7024) are concurrently displayed with the content associated with the first notification (e.g., the notification content 7060). Displaying the plurality of affordances for performing system operations associated with the first computer system concurrently with displaying the content associated with the first notification reduces the number of inputs needed to access and perform the corresponding system operations.

In some embodiments, in response to detecting the first gaze input directed to the first user interface object, and in accordance with the determination that the first event for the first notification satisfies the timing criteria, the content associated with the first notification is displayed without displaying the plurality of affordances for performing system operations associated with the first computer system. This is shown in FIG. 7M, for example, where the dotted lines of the system function menu 7024 indicate that in some embodiments, the content associated with the first notification (e.g., the notification content 7060) is displayed without displaying the system function menu 7024 and its plurality of affordances for performing system operations associated with the first computer system. Displaying the content associated with the first notification without displaying the plurality of affordances for performing system operations gives focus to the notification content without unnecessarily displaying additional controls.

In some embodiments, aspects/operations of methods 8000, 9000, 10000, 11000, 12000, 13000, 14000, 15000, and 16000 may be interchanged, substituted, and/or added between these methods. For example, the first user interface object (e.g., system control indicator, sometimes appearing as a notification indicator) in the method 9000 has characteristics of the first user interface object (e.g., system control indicator) in the methods 8000 and 10000-16000, and the user interface elements that are displayed (e.g., the additional content associated with a notification) may be replaced by, or concurrently displayed with, other user interface elements (e.g., the plurality of affordances for performing system operations associated with the first computer system, a user interface that includes an affordance for joining a communication session, and/or the user interface elements of the methods 8000, 10000-16000). For brevity, these details are not repeated here.

FIG. 10 is a flow diagram of an exemplary method 10000 for displaying a first user interface that includes an affordance for joining a communication session, in response to detecting a first gaze input directed to a first user interface object, and in accordance with a determination that there is a request for the first computer system to join a first communication session that satisfies timing criteria. In some embodiments, the method 10000 is performed at a computer system (e.g., computer system 101 in FIG. 1) (which is sometimes referred to as “the first computer system”) that is in communication with a display generation component (e.g., display generation component 120 in FIGS. 1, 3, and 4) (e.g., a heads-up display, a display, a touchscreen, or a projector) and one or more input devices (e.g., a touch screen, a camera, and/or a microphone). In some embodiments, the computer system optionally includes one or more cameras (e.g., a camera (e.g., color sensors, infrared sensors, and/or other depth-sensing cameras) that points towards the user (e.g., to detect the gaze of the user) and/or a camera that points forward (e.g., to facilitate displaying elements of the physical environment captured by the camera). In some embodiments, the method 10000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 10000 are, optionally, combined and/or the order of some operations is, optionally, changed.

Conditionally displaying a user interface that includes an affordance for joining a communication session and/or displaying the plurality of affordances for performing system operations associated with the first computer system, based on whether a request to join the communication session is active and meets timing criteria, enables access to additional control options relevant to a current context of the first computer system without displaying additional controls (e.g., separate controls for displaying the first user interface that includes an affordance for joining the first communication session, and for displaying the plurality of affordances for performing system operations associated with the first computer system).

The computer system displays, via the first display generation component, a first user interface object (e.g., indicator 7010 of system function menu (FIG. 7B) or user interface object 7064 (FIGS. 7R-7U)) while a first view of a three-dimensional environment is visible, wherein the first user interface object is displayed at a first position in the three-dimensional environment, and wherein the first position in the three-dimensional environment has a first spatial arrangement relative to a respective portion of the user (e.g., relative to a viewpoint of the user); In some embodiments, the first user interface object is displayed at a first location on, or relative to, the first display generation component that is independent of the contents of the first view of the three-dimensional environment. In some embodiments, the 3D environment is a virtual environment, video passthrough (e.g., based on a camera feed), or true passthrough of the physical environment surrounding or in view of the first computer system.

While displaying the first user interface object in the first view of the three-dimensional environment, the computer system detects, via the one or more input devices, a first gaze input directed to the first user interface object. In response to detecting the gaze input directed to the first user interface object: in accordance with a determination that there is a request for the first computer system to join a first communication session (e.g., a phone call, a video call, a shared computer-generated experience, and/or a shared virtual or augmented reality environment) that satisfies timing criteria (e.g., in accordance with a determination that the computer system has received a request for the computer system to join a first communication session less than a threshold amount of time before the user directs his or her attention to the first user interface object), the computer system displays a first user interface that includes an affordance for joining the first communication session (e.g., concurrently with display of the first user interface object) (e.g., incoming call user interface 7068 (FIG. 7S)); and in accordance with a determination that there is not a request to join a communication session that satisfies the timing criteria (e.g., in accordance with a determination that the computer system has not received any requests for the computer to join a communication session less than a threshold time before the user directs his or her attention to the first user interface object), the computer system displays a plurality of affordances for performing system operations associated with the first computer system (e.g., a volume control, a search affordance, a notification center, a control panel, and/or a virtual assistant) without displaying the affordance for joining a communication session (e.g., in FIG. 7W, system function menu 7024 is displayed without the incoming call user interface 7068 of FIG. 7S). In some embodiments, the request for the computer system to join a first communication session is a first event, and a request for the computer system to join a second communication session is a second event.

In some embodiments, in accordance with a determination that there is a request for the first computer system to join a first communication session (e.g., a phone call, a video call, a shared computer-generated experience, and/or a shared virtual or augmented reality environment) that satisfies the timing criteria (e.g., in accordance with a determination that the computer system has received a request for the computer system to join a first communication session less than a threshold amount of time (e.g., 5 seconds, 10 seconds, 20 seconds, 30 seconds, 60 seconds, or any threshold time between 0 and 60 seconds) before the user directs his or her attention to the first user interface object), the computer system displays the first user interface object with a first appearance (e.g., including one or more of a first color, a first shape, a user’s avatar, and/or an application icon); and in accordance with a determination that there is not a request to join a communication session that satisfies the timing criteria (e.g., in accordance with a determination that the computer system has not received any requests for the computer to join a communication session less than a threshold amount of time (e.g., 5 seconds, 10 seconds, 20 seconds, 30 seconds, 60 seconds, or any threshold time between 0 and 60 seconds) before the user directs his or her attention to the first user interface object), the computer system displays the first user interface object with a second appearance (e.g., different from the first appearance). For example, the user interface object 7064 in FIG. 7R (e.g., indicating an active communication session request being received), has a different appearance than the indicator 7010 of system function menu in FIG. 7V (e.g., a default appearance of the first user interface object, optionally indicating that no communication session or communication session request is active). Displaying the first user interface object with an appearance that indicates whether or not there is a request for the computer system to join a first communication session that satisfies the timing criteria provides feedback about a state of the computer system.

In some embodiments, displaying the first user interface object with the first appearance includes displaying the first user interface object with a first color, and displaying the first user interface object with the second appearance includes displaying the first user interface object with a second color different from the first color. This is described above, for example, in the description of FIG. 7R, where in some embodiments, in accordance with a determination that a request for the computer system 7100 to join a communication session satisfies timing criteria, the user interface object 7064 has a different color (e.g., is green). Displaying the first user interface object with a color that indicates whether or not there is a request for the computer system to join a first communication session that satisfies the timing criteria provides feedback about a state of the computer system.

In some embodiments, displaying the first user interface object with the first appearance includes displaying an animation of the first user interface object (e.g., an animation involving pulsing a border of the first user interface object, an animation that involves changing a color of the first user interface object, and/or an animation involving changing a shape of the first user interface object). This is described above, for example, in the description of FIG. 7R, where in some embodiments, in accordance with a determination that a request for the computer system 7100 to join a communication session satisfies timing criteria, the user interface object 7064 displays an animation. For example, the user interface object 7064 bounces up and down, the border of the user interface object 7064 pulses, the user interface object 7064 changes size, and/or the user interface object 7064 rotates. Animating the first user interface object to indicate that there is a request for the computer system to join a first communication session that satisfies the timing criteria provides feedback about a state of the computer system.

In some embodiments, in accordance with the determination that there is a request for the first computer system to join the first communication session (e.g., a phone call, a video call, a shared computer-generated experience, and/or a shared virtual or augmented reality environment) that satisfies the timing criteria (e.g., in accordance with a determination that the computer system has received a request for the computer system to join a first communication session less than a threshold amount of time (e.g., 5 seconds, 10 seconds, 20 seconds, 30 seconds, 60 seconds, or any threshold time between 0 and 60 seconds) before the user directs his or her attention to the first user interface object), the computer system displays the animation of the first user interface object without generating audio output (e.g., in conjunction with displaying the first user interface object with the first appearance). This is described above, for example, in the description of FIG. 7R, where in some embodiments, in accordance with a determination that a request for the computer system 7100 to join a communication session satisfies timing criteria, the user interface object 7064 displays an animation, and the animation is displayed without audio output. Displaying the animation of the first user interface object without generating audio output balances providing feedback about a state of the computer system with reducing intrusiveness of alerts.

In some embodiments, in accordance with a determination that there is a request for the first computer system to join a first communication session (e.g., a phone call, a video call, a shared computer-generated experience, and/or a shared virtual or augmented reality environment) that satisfies the timing criteria (e.g., in accordance with a determination that the first computer system has received a request for the computer system to join a first communication session less than a threshold amount of time (e.g., 5 seconds, 10 seconds, 20 seconds, 30 seconds, 60 seconds, or any threshold time between 0 and 60 seconds) before the user directs his or her attention to the first user interface object), the computer system displays a visual indication (e.g., a name, an avatar, and/or a profile picture) of a user associated with the request for the computer system to join the first communication session (e.g., the user that sent the request for the computer system to join the first communication session). In some embodiments, in accordance with a determination that there is a request for the computer system to join a first communication session (e.g., a phone call, a video call, a shared computer-generated experience, and/or a shared virtual or augmented reality environment) that satisfies timing criteria (e.g., in accordance with a determination that the computer system has received a request for the computer system to join a first communication session less than a threshold amount of time (e.g., 5 seconds, 10 seconds, 20 seconds, 30 seconds, 60 seconds, or any threshold time between 0 and 60 seconds) before the user directs his or her attention to the first user interface object), the visual indication is displayed as a portion of (or separate from, but within a threshold distance (e.g., 0.5 mm, 1 cm, 2 cm, 5 cm, or any threshold distance between 0 and 5 cm) of) the first user interface object. In some embodiments, the visual indication is displayed as a portion of the first user interface (e.g., in addition to being displayed as a portion of the first user interface object). This is described above, for example, in the description of FIG. 7R, where in some embodiments, the user interface object 7064 has an appearance that indicates a user associated with the request (e.g., the user that initiated the request) for the computer system 7100 to join the communication session. Displaying a visual indication of a user associated with the recently received request for the computer system to join the first communication session reduces the number of inputs needed for the user of the computer system to determine who is sending the communication session request.

In some embodiments, the computer system displays the visual indication (e.g., a name, an avatar, and/or a profile picture) of the user associated with the request for the first computer system to join the first communication session before detecting the first gaze input directed to the first user interface object that satisfies the timing criteria (e.g., the user that sent the request for the computer system to join the first communication session). In some embodiments, in accordance with a determination that there is a request for the computer system to join a first communication session (e.g., a phone call, a video call, a shared computer-generated experience, and/or a shared virtual or augmented reality environment) that satisfies timing criteria (e.g., in accordance with a determination that the computer system has received a request for the computer system to join a first communication session less than a threshold amount of time (e.g., 5 seconds, 10 seconds, 20 seconds, 30 seconds, 60 seconds, or any threshold time between 0 and 60 seconds) before the user directs his or her attention to the first user interface object), the visual indication is displayed as a portion of (or separate from, but within a threshold distance (e.g., 0.5 mm, 1 cm, 2 cm, 5 cm, or any threshold distance between 0 and 5 cm) of) the first user interface object. In some embodiments, the visual indication is displayed as a portion of the first user interface (e.g., in addition to being displayed as a portion of the first user interface object). In some embodiments, the visual indication of the user associated with the request for the computer system to join the first communication session is displayed for a threshold amount of time (e.g., and the computer system ceases to display the visual indication of the user associated with the request for the computer system to join the first communication session after the threshold amount of time).

After (e.g., while) displaying the first user interface that includes an affordance for joining the first communication session (e.g., concurrently with display of the first user interface object), the computer system detects that the user’s gaze is no longer directed to the first user interface object (e.g., and not directed to the first user interface). In some embodiments, in response to detecting that the user’s gaze is no longer directed to the first user interface object, the computer system displays the first user interface object with a third appearance (e.g., instead of the first appearance) (e.g., to provide visual feedback that the first user interface that includes an affordance for joining the first communication session was already displayed). In some embodiments, the third appearance is the same as the second appearance.

This is described above, for example, in the description of FIG. 7S, where after ceasing to display the user interface 7068, the user interface object 7064 returns to a default appearance (e.g., the appearance of the indicator 7010 of system function menu), which indicates that the user has already viewed the request to join the communication session (e.g., the example transition from FIG. 7S to FIG. 7V). In some embodiments, if the user interface object 7064 was displayed with an appearance that indicates a user (e.g., the user that initiated the request) associated with the request for the computer system 7100 to join the communication session (before the user’s gaze is directed to the user interface object 7064), when the computer system 7100 ceases to display the user interface 7068, the default appearance of the user interface object 7064 does not indicate the user associated with the request. Changing the appearance of the first user interface object, after the user has stopped directing attention to the first user interface object after triggering display of the first user interface that includes an affordance for joining the first communication session, causes the computer system to automatically dismiss (e.g., ignore) the incoming communication session request and provides feedback about a state of the computer system (e.g., that the incoming communication session request has already been acknowledged and the first user interface that includes the affordance for joining the first communication session has already been displayed).

In some embodiments, while displaying the first user interface object at the first position in the three-dimensional environment that has the first spatial arrangement relative to the respective portion of the user, the computer system detects, via the one or more input devices, an input that corresponds to movement of a viewpoint of the user from a first viewpoint (e.g., from which the first view of the three-dimensional environment is visible) to a second viewpoint in the three-dimensional environment. In some embodiments, in response to detecting the input that corresponds to movement of the viewpoint of the user from the first viewpoint to the second viewpoint in the three-dimensional environment, the computer system maintains display of the first user interface object at a respective position in the three-dimensional environment having the first spatial arrangement relative to the respective portion of the user while a second view of the three-dimensional environment is visible (e.g., the second view is visible from the second viewpoint, and the second view is different from the first view). In some embodiments, the first user interface object is maintained at a respective position in the three-dimensional environment having the first spatial arrangement relative to the viewpoint of the user. In some embodiments, the first user interface object is displayed at one or more successive positions in the three-dimensional environment as the viewpoint of the user moves such that one or more successive corresponding views of the three-dimensional environment become visible, each of the successive positions of the first user interface object having the first spatial arrangement relative to the respective portion of the user. In some embodiments, the first user interface object is maintained at the first location on, or relative to, the first display generation component that is independent of the contents of the first view of the three-dimensional environment. This is described above, for example, in the description of FIG. 7U, where in some embodiments, the user interface object 7064, system function menu 7024, the user interface 7068, the user interface 7070, and/or the call control user interface 7072 are head-locked virtual objects (e.g., viewpoint-locked virtual objects as described herein). Maintaining display of the first user interface object at a respective position in the three-dimensional environment having the first spatial arrangement relative to the respective portion of the user as the viewpoint of the user changes, reduces the number and extent of inputs needed to access the first user interface object to display the first user interface that includes an affordance for joining the first communication session and/or the plurality of affordances for performing system operations associated with the first computer system (e.g., the user does not need to perform additional inputs to move, display, and/or redisplay the first user interface object).

In some embodiments, in response to detecting the first gaze input directed to the first user interface object, in accordance with a determination that there is a request for the first computer system to join a first communication session (e.g., a phone call, a video call, a shared computer-generated experience, and/or a shared virtual or augmented reality environment) that satisfies the timing criteria (e.g., in accordance with a determination that the computer system has received a request for the computer system to join a first communication session less than a threshold amount of time (e.g., 5 seconds, 10 seconds, 20 seconds, 30 seconds, 60 seconds, or any threshold time between 0 and 60 seconds) before the user directs his or her attention to the first user interface object), the computer system concurrently displays the first user interface that includes an affordance for joining the first communication session (e.g., concurrently with display of the first user interface object) and the plurality of affordances for performing system operations associated with the first computer system (e.g., a volume control, a search affordance, a notification center, a control panel, and/or a virtual assistant). This is shown in FIG. 7S, for example, where the first user interface that includes the affordance for joining the first communication session (e.g., the incoming call user interface 7068), is concurrently displayed with the plurality of affordances for performing system operations associated with the first computer system (e.g., in the system function menu 7024, which in some embodiments is also displayed, as indicated). Concurrently displaying the first user interface that includes an affordance for joining the first communication session and the plurality of affordances for performing system operations associated with the first computer system, reduces the number of user inputs needed to access the first user interface that includes an affordance for joining the first communication session and the plurality of affordances for performing system operations associated with the first computer system (e.g., the user does not need to perform a first input to display the first user interface, and a second input to display the plurality of affordances).

In some embodiments, the first communication session is an augmented reality or virtual reality communication session (e.g., an extended reality (XR) communication session). This is shown in FIG. 7X, for example, where the communication session could be a telephone communication session, a video communication session, or an extended reality communication session (e.g., an augmented reality or virtual reality communication session). Displaying a first user interface that includes an affordance for joining the first communication session, in response to detecting the first gaze input directed to the first user interface object and in accordance with a determination that there is a request for the first computer system to join a first communication session, wherein the first communication session is an augmented reality or virtual reality communication session, provides additional control options without cluttering the UI with additional displayed controls (e.g., permanently displayed controls for joining the first communication session).

In some embodiments, the request for the first computer system to join the first communication session is received from a second user (e.g., different from a user of the computer system), and the first user interface is displayed in accordance with a determination that the first gaze input directed to the first user interface object is detected within a threshold amount of time (e.g., 5 seconds, 10 seconds, 20 seconds, 30 seconds, 60 seconds, or any threshold time between 0 and 60 seconds) of receiving the request for the first computer system to join the first communication session (e.g., in addition to the determination that the first event for the first notification satisfies the timing criteria). In accordance with a determination (e.g., made while displaying the first user interface) that the affordance for joining the first communication session is not activated within the threshold amount of time of receiving the request (e.g., the request for the computer system to join the first communication session expires (e.g., after a threshold amount of time)): the computer system ceases to display the first user interface that includes the affordance for joining the first communication session; the computer system displays a second user interface, the second user interface including a visual indication that the affordance for joining the first communication session was not activated within the threshold amount of time; and the computer system displays (e.g., as a portion of the second user interface, or otherwise concurrently with the second user interface) an affordance for initiating a second communication session with the second user (e.g., an affordance for sending, to the second user that initiated the request for the computer system to join the first communication session, a request to join a second communication session). This is shown in FIG. 7T, for example, where in accordance with a determination that the affordance for joining the first communication session is not activated within the threshold amount of time of receiving the request (e.g., in some cases because the communication session indicator was not gazed at within the threshold amount of time of receiving the request), the computer system ceases to display the first user interface that includes the affordance for joining the first communication session (e.g., the user interface 7068 is not shown in FIG. 7T), the computer system displays a second user interface that includes a visual indication that the affordance for joining the first communication session was not activated within the threshold amount of time (e.g., the “Missed Video Call” message in the user interface 7070), and the computer system displays an affordance for initiating a second communication session with the second user (e.g., the “Invite” affordance in the user interface 7070). Displaying a second user interface that includes a visual indication that the affordance for joining the first communication session was not activated within the threshold amount of time, and displaying an affordance for initiating a second communication session with the second user, reduces the number of user inputs needed to call back another user whose incoming call request was missed (e.g., the user does not need to perform additional inputs to navigate to an application for communication with the second user, or additional inputs to find the contact information for the second user).

In some embodiments, the computer system displays the second user interface (e.g., a missed call user interface) for a first threshold amount of time and ceases to display the second user interface after the first threshold amount of time (e.g., 5 seconds, 10 seconds, 20 seconds, 30 seconds, 60 seconds, or any threshold time between 0 and 60 seconds) has elapsed. This is shown in FIG. 7X, for example, where the time thresholds TH_{C2} and TH_{V2} (e.g., for telephone and video communication sessions, respectively) indicate the first threshold amount of time after which the computer system ceases to display the second user interface (e.g., the missed request and affordance to initiate a new communication session, as shown in the user interface 7070 of FIG. 7T) of steps 7080 and 7094. Displaying a missed call user interface for a first threshold amount of time and ceasing to display the missed call user interface after the threshold amount of time has elapsed causes the first computer system to automatically dismiss or ignore the missed call user interface after too much time has passed since receiving, and missing, the communication session request.

In some embodiments, in accordance with a determination that the first communication session is an augmented reality or virtual reality communication session (e.g., is initiated from another computer system that supports augmented reality and/or virtual reality communication sessions), the request for the first computer system to join the first communication session satisfies the timing criteria if the request was received less than a second threshold amount of time (e.g., 30 seconds, 60 seconds, or any threshold time between 21 and 60 seconds) before detecting the first gaze input directed to the first user interface object. In accordance with a determination that the first communication session is not an augmented reality or virtual reality communication session (e.g., neither an augmented reality nor virtual reality communication session, as in not an extended reality communication session, for example due to being initiated from another computer system that does not support augmented reality nor virtual reality communication sessions), the request for the first computer system to join the first communication session satisfies the timing criteria if the request was received less than a third threshold amount of time (e.g., 5 seconds, 10 seconds, 20 seconds, or any threshold time between 0 and 20 seconds) before detecting the first gaze input directed to the first user interface object, wherein the third threshold amount of time is less than the second threshold amount of time.

This is shown in FIG. 7X, for example, where the threshold THx (for XR communication sessions) is further along the time axis than the thresholds TH_{C1} (for telephone communication session requests) and TH_{V1} (for video communication session requests), indicating that requests to join XR communication sessions are more persistent (e.g., last longer) than requests to join other types of communication sessions (e.g., audio and/or video communication sessions). Setting a time limit for a user to interact with a non-augmented reality and non-virtual reality (non-AR/VR) communication session request (e.g., a request sent from a non-AR/VR-enabled computer system) to be shorter than the time limit for the user to interact with an augmented reality and/or virtual reality (AR/VR) communication session request (e.g., a request sent from an AR/VR-enabled computer system) causes the computer system to automatically allow AR/VR communication session requests to remain active longer than non-AR/VR requests, consistent with an increased likelihood that a user sending an AR/VR communication session request (or using an AR/VR system) will remain engaged with their computer system and will wait longer for a response than would a user sending a non-AR/VR communication session request (or using a non-AR/VR system).

In some embodiments, in accordance with a determination that the first communication session is an augmented reality or virtual reality communication session, the request for the first computer system to join the first communication session satisfies the timing criteria if the request was received less than a fourth threshold amount of time (e.g., 30 seconds, 60 seconds, or any threshold time between 21 and 60 seconds) before detecting the first gaze input directed to the first user interface object (e.g., the fourth threshold amount of time is the second threshold amount of time described above for requests for communication sessions that are augmented reality or virtual reality communication sessions). In accordance with a determination that the first communication session is a video or audio communication session (e.g., a video communication session request sent using a videotelephony protocol, whether the request is for a video call or an audio-only call with video disabled or turned off yet still supported by the videotelephony protocol), the request for the first computer system to join the first communication session satisfies the timing criteria if the request was received less than a fifth threshold amount of time (e.g., 5 seconds, 10 seconds, 20 seconds, or any threshold time between 0 and 20 seconds) before detecting the first gaze input directed to the first user interface object, wherein the fifth threshold amount of time is less than the fourth threshold amount of time (e.g., the fifth threshold amount of time is the third threshold amount of time of operation described above for requests for communication sessions that are not augmented reality or virtual reality communication sessions).

This is shown in FIG. 7X, for example, where the threshold THx is further along the time axis than the threshold TH_{V1} (for video communication sessions), indicating that requests to join XR communication sessions are more persistent (e.g., last longer) than requests to join video or audio communication sessions. Setting a time limit for a user to interact with a video or audio communication session request to be shorter than the time limit for the user to interact with an AR/VR communication session request causes the computer system to automatically allow AR/VR communication session requests to remain active longer than non-AR/VR requests including video and audio communication session requests, consistent with an increased likelihood that a user sending an AR/VR communication session request will remain engaged with their computer system and will wait longer for a response than would a user sending a video or audio communication session request.

In some embodiments, in accordance with a determination that the first communication session is a video communication session (e.g., that uses a videotelephony protocol, optionally without regard to whether video is disabled or turned off if video is supported by the videotelephony protocol (e.g., an audio-only call over the videotelephony protocol is optionally considered a “video communication session” as the term is used herein)), the request for the first computer system to join the first communication session satisfies the timing criteria if the request was received less than a sixth threshold amount of time (e.g., 20 seconds, 30 seconds, 60 seconds, or any threshold time between 11 and 60 seconds) before detecting the first gaze input directed to the first user interface object (e.g., the sixth threshold amount of time is the third threshold amount of time and/or the fifth threshold amount of time of operation described above for requests for communication sessions that are augmented reality or virtual reality communication sessions). In accordance with a determination that the first communication session is an audio communication session (e.g., that uses a communication protocol that does not support video, such as a telephone call), the request for the first computer system to join the first communication session satisfies the timing criteria if the request was received less than a seventh threshold amount of time (e.g., 5 seconds, 10 seconds, or any threshold time between 0 and 10 seconds) before detecting the first gaze input directed to the first user interface object, wherein the seventh threshold amount of time is less than the sixth threshold amount of time. In some embodiments, in accordance with the determination that the first communication session is an audio communication session (e.g., an audio-only communication session such as a phone call), the first user interface that includes the affordance for joining the first communication session is displayed before detecting the first gaze input directed to the first user interface object (e.g., a gaze input directed to the first user interface object is not required in order for the first user interface to be displayed).

This is shown in FIG. 7X, for example, where the threshold TH_{V1} (for video communication sessions) is further along the time axis than the threshold TH_{C1} (for telephone communication sessions), indicating that requests to join video communication sessions are more persistent (e.g., last longer) than requests to join audio communication sessions. Setting a time limit for a user to interact with an audio communication session request to be shorter than the time limit for the user to interact with a video communication session request causes the computer system to automatically allow video communication session requests to remain active longer than audio communication session requests, consistent with an increased likelihood that a user sending a video communication session request will remain engaged with their computer system and will wait longer for a response than would a user sending an audio communication session request (e.g., making a phone call).

In some embodiments, in accordance with a determination that the first communication session is an audio communication session (e.g., an audio-only communication session such as a phone call), the request for the first computer system to join the first communication session satisfies the timing criteria if the request was received less than an eighth threshold amount of time (e.g., 5 seconds, 10 seconds, or any threshold time between 0 and 10 seconds) before detecting the first gaze input directed to the first user interface object, and/or the first user interface that includes an affordance for joining the first communication session is displayed with a first level of prominence. In some embodiments, in accordance with a determination that the first communication session is not an audio communication session, the request for the first computer system to join the first communication session satisfies the timing criteria if the request was received less than a ninth threshold amount of time (e.g., 20 seconds, 30 seconds, 60 seconds, or any threshold time between 11 and 60 seconds) before detecting the first gaze input directed to the first user interface object, wherein the ninth threshold amount of time is greater than the eighth threshold amount of time (e.g., a request to join an audio communication expires more quickly than a request to join another type of communication session (e.g., video, virtual reality, and/or augmented reality)), and/or the first user interface that includes an affordance for joining the first communication session is displayed with a second level of prominence, wherein the second level of prominence is less than the first level of prominence (e.g., a request to join an audio communication session is displayed with greater prominence, but for a shorter duration, than requests to join other types of communication sessions). This is shown in FIG. 7X, for example, where the thresholds TH_{V1} (for video communication sessions) and THx (for XR communication sessions) are further along the time axis than the threshold TH_{C1} (for telephone communication sessions), indicating that requests to join audio communication sessions are less persistent than (e.g., do not last as long as) requests to join other types of communication sessions (e.g., video and/or XR communication sessions). As shown by steps 7074 and 7076, however, the user does not need to gaze at the first user interface object (e.g., communication session indicator) to trigger display of the request to join a telephone communication session, indicating that requests to join telephone communication sessions are displayed more prominently than other types of communication sessions (e.g., video and/or XR communication sessions), by being displayed even if the user is not directing attention to the first user interface object.

In some embodiments, the first user interface displayed with the second level of prominence is displayed with a smaller size (e.g., as an indicator (e.g., of system function menu) instead of a banner), in a less central portion of the user’s viewpoint (e.g., in an x-direction and/or y-direction), and/or at a position that appears further away (e.g., in a z-direction) from the viewpoint of the user, than when displayed with the first level of prominence. In some embodiments, the first user interface displayed with the second level of prominence is not animated (e.g., and is animated when displayed with the first level of prominence). In some embodiments, the first user interface is less persistent (e.g., easier to dismiss) when displayed with the second level of prominence than when displayed with the first level of prominence. For example, when displayed with the second level of prominence, the first user interface ceases to be displayed if the user’s attention is no longer directed to the first user interface. In contrast, when displayed with the first level of prominence, the first user interface continues to be displayed irrespective of the user’s attention (e.g., even if the user’s attention is not directed to the first user interface). In some embodiments, displaying the first user interface with the second level of prominence includes outputting less prominent audio (e.g., a discrete alert sound or tone), whereas displaying the first user interface with the first level of prominence includes outputting more prominent audio (e.g., continuous and/or repeated ringing).

Setting a time limit for a user to interact with an audio communication session request to be shorter than the time limit for the user to interact with other types of communication session requests and presenting the audio communication session request more prominently than other types of requests provides feedback indicating that audio communication session requests (e.g., phone calls) are more urgent than other types of communication session requests and reduces the number of inputs needed to establish audio communication sessions between users (e.g., by increasing the likelihood that the receiving user will notice the less persistent incoming audio communication session request before the request expires, thereby reducing the need for additional requests to be sent back and forth between users).

In some embodiments, in accordance with a determination that there is an active communication session (e.g., the first communication session, if the user of the first computer system activates the affordance for joining the first communication session), and in accordance with a determination that the user’s gaze is directed to the first user interface object, the computer system displays a third user interface that includes a plurality of affordances for performing operations associated with the active communication session (e.g., leaving the communication session, sending one or more requests to other users to join the communication session, and/or sharing content in the communication session), wherein the third user interface is displayed with a respective spatial arrangement (e.g., directly below, or other required spatial arrangement) relative to the first user interface object. In some embodiments, the third user interface is displayed while (e.g., as long as) the active communication session remains active. In some embodiments, the third user interface is displayed in response to detecting a gaze input directed to the first user interface object while the active communication session is active (e.g., as long as the computer system detects that the user’s gaze is directed to the first user interface object). This is described above, for example, in the description of FIG. 7U, where in some embodiments, the display characteristics (e.g., displayed location, spatial relationships to other user interface elements, displayed animation(s), and/or follow behavior), of the call control interface 7072 are analogous to those of the user interface 7068 and/or the user interface 7070 described above, and thus in some embodiments, the call control user interface 7072 has a respective spatial relationship to the user interface object 7064. Displaying a third user interface that includes a plurality of affordances for performing operations associated with the active communication session with a respective spatial arrangement relative to the first user interface object, particularly as the first user interface object moves with movement of the viewpoint of the user, causes the computer system to automatically display controls for the active communication session at a predictable position in the three-dimensional environment without requiring further user input to update or return to the location of the controls, which reduces the number and extent of inputs needed to perform operations associated with the active communication session.

In some embodiments, the computer system displays, via the first display generation component, the third user interface while the first view of the three-dimensional environment is visible, wherein the third user interface is displayed at a second position in the three-dimensional environment, and wherein the second position in the three-dimensional environment has a second spatial arrangement relative to the respective portion of the user (e.g., relative to a viewpoint of the user). In some embodiments, the third user interface is displayed at a second location on, or relative to, the first display generation component that is independent of the contents of the first view of the three-dimensional environment. In some embodiments, the 3D environment is a virtual environment, video passthrough (e.g., based on a camera feed), or true passthrough of the physical environment surrounding or in view of the first computer system.

While displaying the third user interface at the second position in the three-dimensional environment that has the second spatial arrangement relative to the respective portion of a user, the computer system detects, via the one or more input devices, an input that corresponds to movement of a viewpoint of the user from a first viewpoint to a second viewpoint in the three-dimensional environment. In some embodiments, in response to detecting the input that corresponds to movement of the viewpoint of the user from the first viewpoint to the second viewpoint in the three-dimensional environment, the computer system maintains display of the third user interface at a respective position in the three-dimensional environment having the second spatial arrangement relative to the respective portion of the user while a second view of the three-dimensional environment is visible (e.g., the second view is different from the first view). In some embodiments, the third user interface is maintained at a respective position in the three-dimensional environment having the second spatial arrangement relative to the viewpoint of the user. In some embodiments, the third user interface is maintained at the second location on, or relative to, the first display generation component that is independent of the contents of the first view of the three-dimensional environment.

This is described above, for example, in the description of FIG. 7U, where in some embodiments, the call control user interface 7072 is a head-locked virtual object (e.g., a viewpoint-locked virtual object as described herein). Maintaining display of the third user interface at a respective position in the three-dimensional environment having the second spatial arrangement relative to the respective portion of the user as the viewpoint of the user moves causes the computer system to automatically display controls for the active communication session at a consistent position (e.g., relative to the viewpoint of the user) without requiring further user input to update or return to the location of the controls, which reduces the number and extent of inputs needed to perform operations associated with the active communication session.

In some embodiments, the computer system displays, via the first display generation component, the third user interface at a respective position in the three-dimensional environment that has a second spatial arrangement relative to the first user interface object. While displaying the first user interface object concurrently with the third user interface in the first view of the three-dimensional environment, the computer system detects, via the one or more input devices, input that corresponds to movement of a viewpoint of the user from a first viewpoint to a second viewpoint in the three-dimensional environment. In some embodiments, in response to detecting the input that corresponds to movement of the viewpoint of the user from the first viewpoint to the second viewpoint in the three-dimensional environment, the computer system maintains display of the third user interface at a respective position in the three-dimensional environment having the second spatial arrangement relative to the first user interface object while a second view of the three-dimensional environment is visible. This is described above, for example, in the description of FIG. 7U, where in some embodiments, when the viewpoint of the user changes (e.g., the user moves to a new position in the three-dimensional environment, and/or the user turns such that the displayed view of the three-dimensional environment changes), the user interface object 7064 moves in tandem with the call control user interface 7072. Maintaining display of the third user interface at a respective position in the three-dimensional environment having the second spatial arrangement relative to the first user interface object while a second view of the three-dimensional environment is visible, in response to detecting the input that corresponds to movement of the viewpoint of the user from the first viewpoint to the second viewpoint in the three-dimensional environment, causes the computer system to automatically display the controls for the active communication session at a consistent position (e.g., relative to the viewpoint of the user) without requiring further user input to update or return to the location of the controls, which reduces the number and extent of inputs needed to perform operations associated with the active communication session.

In some embodiments, in accordance with the determination that there is the active communication session, and in accordance with the determination that the user’s gaze is directed to the first user interface object, the computer system displays, via the first display generation component, the plurality of affordances for performing system operations associated with the first computer system while the first view of the three-dimensional environment is visible, wherein the plurality of affordances for performing system operations associated with the first computer system are displayed at a third position in the three-dimensional environment, and wherein the third position in the three-dimensional environment has a third spatial arrangement relative to the third user interface (e.g., relative to a viewpoint of the user). In some embodiments, the plurality of affordances for performing system operations associated with the first computer system is displayed at a third location on, or relative to, the first display generation component that is independent of the contents of the first view of the three-dimensional environment. In some embodiments, the 3D environment is a virtual environment, video passthrough (e.g., based on a camera feed), or true passthrough of the physical environment surrounding or in view of the first computer system.

While displaying the plurality of affordances for performing system operations associated with the first computer system and the third user interface in the first view of the three-dimensional environment, the computer system detects, via the one or more input devices, an input that corresponds to movement of a viewpoint of the user from a first viewpoint to a second viewpoint in the three-dimensional environment. In some embodiments, in response to detecting the input that corresponds to movement of the viewpoint of the user from the first viewpoint to the second viewpoint in the three-dimensional environment, the computer system maintains display of the plurality of affordances for performing system operations associated with the first computer system at a respective position in the three-dimensional environment having the third spatial arrangement relative to the third user interface while a second view of the three-dimensional environment is visible (e.g., the second view is different from the first view). In some embodiments, the plurality of affordances for performing system operations associated with the first computer system is maintained at a respective position in the three-dimensional environment having the third spatial arrangement relative to the viewpoint of the user). In some embodiments, the plurality of affordances for performing system operations associated with the first computer system is maintained at the third location on, or relative to, the first display generation component that is independent of the contents of the first view of the three-dimensional environment.

This is described above, for example, in the description of FIG. 7U, where in some embodiments, while concurrently displayed, the system function menu 7024 moves in tandem with the call control user interface 7072, such that the call control user interface 7072 maintains a respective spatial relationship with the system function menu 7024 (e.g., in an analogous manner to maintaining a respective spatial relationship with the user interface object 7064). Maintaining display of the plurality of affordances for performing system operations associated with the first computer system at a respective position in the three-dimensional environment having the third spatial arrangement relative to the third user interface as the viewpoint of the user moves causes the computer system to automatically display the plurality of affordances for performing system operations associated with the first computer system and controls for the active communication session together and at a consistent position (e.g., relative to the viewpoint of the user).

In some embodiments, the computer system detects a user input that initiates a request, to a user of a second computer system (e.g., a user who is not currently participating in the active communication session), to join a communication session. While the request to join the communication session is active, and in accordance with a determination that the user’s gaze is directed to the first user interface object, the computer system displays a fourth user interface that includes a plurality of affordances for performing operations associated with the requested communication session (e.g., leaving the communication session (and/or cancelling the request to the other user to join the communication session), sending one or more requests to additional users to join the communication session, and/or sharing content in the communication session) at a respective location (e.g., directly below, or other required location) relative to the first user interface object. In some embodiments, the fourth user interface is displayed while (e.g., as long as) the active communication session remains active. In some embodiments, the fourth user interface is displayed in response to detecting a gaze input directed to the first user interface object while the active communication session is active (e.g., as long as the computer system detects that the user’s gaze is directed to the first user interface object). This is described above, for example, in the description of FIG. 7U, where in some embodiments, the call control user interface 7072 is displayed in response to user 7002 initiating the communication session (e.g., sending a communication session request to another user) and has a respective spatial relationship to the user interface object 7064. Displaying a fourth user interface that includes a plurality of affordances for performing operations associated with the requested communication session at a respective location relative to the first user interface object, in accordance with a determination that the user’s gaze is directed to the first user interface object, enables displaying controls for the requested communication session at a predictable position in the three-dimensional environment when the user is paying attention, which reduces the number and extent of inputs needed to perform operations associated with the communication session, and avoids unnecessarily displaying the controls when the user is not paying attention.

In some embodiments, while the request to join the communication session is active, and in accordance with a determination that the user’s gaze is no longer directed to the first user interface object, the computer system ceases to display the fourth user interface, while maintaining display of the first user interface object. This is described above, for example, in the description of FIG. 7U, where in some embodiments, the call control user interface 7072 ceases to be displayed if the computer system 7100 detects that the user’s gaze is no longer directed to the user interface object 7064 (or the call control user interface 7072), and has not returned to the user interface object 7064 (or the user interface 7072) within the respective period of time, and the user interface object 7064 remains displayed, or is redisplayed if not already displayed, in conjunction with the computer system 7100 ceasing to display the call control user interface 7072 (e.g., so that the call control user interface 7072 can be redisplayed if the user’s gaze is subsequently redirected to the user interface object 7064). Ceasing to display the fourth user interface, while maintaining display of the first user interface object, if the user’s gaze is no longer directed to the first user interface object, causes the computer system to automatically dismiss the communication session controls when the user stops paying attention to the communication session controls, so as to avoid unnecessarily displaying additional controls.

In some embodiments, after ceasing to display the fourth user interface, and while the request to join the communication session is active, the computer system detects, via the one or more input devices, a second gaze input directed to the first user interface object. In some embodiments, in response to detecting the second gaze input directed to the first user interface object, the computer system redisplays the fourth user interface. This is described above, for example, in the description of FIG. 7U where in some embodiments, after the call control user interface 7072 ceases to be displayed, the user’s gaze subsequently is directed to the user interface object 7064 (e.g., while the computer system 7100 is still in the communication session), and in response, the computer system 7100 redisplays the call control user interface 7072. Redisplaying the fourth user interface, in response to detecting the second gaze input directed to the first user interface object, causes the computer system to automatically display the communication session controls when the user is paying attention, which avoids unnecessarily displaying the controls when the user is not paying attention.

In some embodiments, while the request to join the communication session is active (e.g., before the user of the second computer system accepts the request to join the active communication session), the computer system displays an animation of the first user interface object (e.g., an animation that includes: the first user interface object changing color, the first user interface object changing shape, the first user interface object changing size, a border of the first user interface object pulsing (e.g., without changing a size of the first user interface object itself), the first user interface object fading in and out, and/or the first user interface object moving (e.g., up and down, side to side, and/or rotating)). This is described above, for example, in the description of FIG. 7U, where in some embodiments, if the user activates the “Invite” affordance in the user interface 7070 (e.g., as shown in FIG. 7T), the computer system 7100 displays the call control user interface 7072 (e.g., even before another user joins the communication session), and optionally the user interface object 7064 has the different color associated with an active communication session request (e.g., is green), even though the user initiated the communication session (e.g., as opposed to having received from another user a request for the first computer system to join a first communication session that satisfies timing criteria, as described above). Displaying an animation of the first user interface object while the request to join the communication session is active provides feedback about a state of the computer system (e.g., that there is a pending request to join a communication session).

In some embodiments, the computer system detects that the second computer system has joined the requested communication session. In some embodiments, in response to detecting that the second computer system has joined the requested communication session, the first computer system displays a visual representation of the user of the second computer system (e.g., an avatar of the user of the second computer system, and/or a profile picture of the user of the second computer system). This is described above, for example, in the description of FIG. 7U, where in some embodiments, if the user of the first computer system 7100 initiates the communication session (e.g., by activating the “Invite” affordance of the user interface 7070 as shown in FIG. 7T), and another user (e.g., another user that received a request to join the communication session when the “Invite” affordance was activated) joins the communication session, the computer system 7100 displays a visual representation of the other user (e.g., an avatar, and/or a profile picture). Displaying a visual representation of the user of the second computer system, in response to detecting that the second computer system has joined the requested communication session, provides improved visual feedback that the second computer system has joined the communication session, and improved visual feedback regarding the user of the second computer system, thereby providing feedback about a state of the first computer system (e.g., indicating acceptance of the initiated communication session request and current participation in an active communication session).

In some embodiments, the plurality of affordances for performing operations associated with the communication session (e.g., an active communication session, or a requested communication session, for which the plurality of affordances for performing communication session operations is displayed) include an affordance for toggling display of a visual representation (e.g., an avatar, a profile picture, a name, and/or initials) of a user (e.g., a user of a computer system other than the first computer system, and/or the user of the first computer system) in the communication session. The computer system detects an input directed to the affordance for toggling display of the visual representation of the user. In some embodiments, in response to detecting the input directed to the affordance for toggling display of the visual representation of the user: in accordance with a determination that the input directed to the affordance is detected while a first visual representation (e.g., a realistic likeness, such as a three-dimensional character, a two-dimensional image, an icon, and/or an avatar that is based on the user’s likeness) of a respective user is displayed, the computer system replaces display of the first visual representation of the respective user with a second visual representation (e.g., an abstract representation that is not based on the user’s likeness) of the respective user (e.g., replacing a two-dimensional image of the respective user or an avatar of the respective user with the user’s name, the user’s initials, and/or an image that is not based on the user’s likeness); and in accordance with a determination that the input directed to the affordance is detected while the second visual representation of the respective user is displayed, the computer system replaces display of the second visual representation of the respective user with the first visual representation of the respective user (e.g., replacing the user’s initials or the user’s name with an avatar of the respective user or a two-dimensional image of the respective user). This is described above, for example, in the description of FIG. 7U, where in some embodiments, the call control user interface 7072 includes an affordance for switching between a realistic likeness and an abstract likeness (e.g., from a realistic profile picture, or a two-dimensional image of the user, to the user’s name, or the user’s initials) of one or more users in the communication session. Toggling display of the visual representation of the respective user between a realistic likeness and an abstract representation of the user of the second computer system in the communication session provides improved visual feedback regarding who is participating in the communication session and provides the user with control over the amount of bandwidth being used by the communication session.

In some embodiments, while displaying the first user interface that includes the affordance for joining the first communication session, the computer system detects a third gaze input directed to the first user interface object (e.g., the third gaze input is detected after detecting movement of the user’s gaze away from the first user interface object after detecting the first gaze input). In some embodiments, in response to detecting the third gaze input directed to the first user interface object, the computer system displays the plurality of affordances for performing system operations associated with the first computer system without displaying the first user interface that includes the affordance for joining the first communication session. In some embodiments, after displaying the plurality of affordances for performing system operations associated with the first computer system without displaying the first user interface that includes the affordance for joining the first communication session, the first computer system detects that the user’s gaze is redirected to the first user interface object (e.g., after detecting movement of the user’s gaze away from the first user interface object after detecting the third gaze input). In response to detecting that the user’s gaze is redirected to the first user interface object (e.g., and in accordance with a determination that the request for the first computer system to join the first communication session satisfies the timing criteria), the first computer system ceases to display the plurality of affordances for performing system operations associated with the first computer system and redisplays the first user interface that includes the affordance for joining the first communication session.

In some embodiments, the computer system cycles through multiple user interfaces (e.g., a cycle that starts from the first user interface that includes the affordance for joining the first communication session, transitions to one or more intermediate user interfaces (e.g., a user interface that includes content associated with a first notification, as described herein with reference to FIGS. 7L-7Q), and ends with the plurality of affordances for performing system operations associated with the first computer system without displaying the first user interface that includes the affordance for joining the first communication session, or any other order of the multiple user interfaces), and each user interface in the cycle is displayed in response to detecting a respective gaze input directed to the first user interface object (e.g., replacing the previous user interface in the cycle, unless the previous user interface in the cycle already ceased to be displayed in accordance with the user’s gaze having already moved away from the first user interface object long enough). This is described above, for example, in the description of FIGS. 7V-7W, where in response to detecting the first gaze input directed to the user interface object 7064, the computer system 7100 displays the user interface 7068. After displaying the user interface object 7064, the user gazes away from the user interface object 7064 (and optionally, the user interface object 7064 ceases to be displayed). After gazing away from the user interface object 7064, the user’s gaze returns to the user interface object 7064, and in response, the computer system 7100 displays the notification content 7060 (e.g., without displaying the user interface 7068). After displaying the notification content 7060, the user gazes away from the user interface object 7064 (and optionally, the notification content 7060 ceases to be displayed). After gazing away from the user interface object 7056, the user’s gaze returns to the user interface object 7056, and in response, the computer system 7100 displays the system function menu 7024 (e.g., without displaying the notification content 7060 or the user interface 7068). Displaying the plurality of affordances for performing system operations associated with the first computer system instead of the first user interface that includes the affordance for joining the first communication session, in response to detecting the user’s gaze redirected to the first user interface object while displaying the first user interface that includes the affordance for joining the first communication session, reduces the number of inputs needed to switch between different sets of displayed controls (e.g., without concurrently displaying both the first user interface that includes the affordance for joining the first communication session and the plurality of affordances for performing system operations associated with the first computer system, or displaying additional controls for switching between display of the first user interface that includes the affordance for joining the first communication session and the plurality of affordances for performing system operations associated with the first computer system).

In some embodiments, aspects/operations of methods 8000, 9000, 10000, 11000, 12000, 13000, 14000, 15000, and 16000 may be interchanged, substituted, and/or added between these methods. For example, the first user interface object (e.g., system control indicator, sometimes appearing as a notification indicator) in the method 10000 has characteristics of the first user interface object (e.g., system control indicator) in the methods 8000-9000 and 11000-16000, and the user interface elements that are displayed (e.g., the additional content associated with a notification) may be replaced by, or concurrently displayed with, other user interface elements (e.g., the plurality of affordances for performing system operations associated with the first computer system, a user interface that includes an affordance for joining a communication session, and/or the user interface elements of the methods 8000-9000, and 11000-16000). For brevity, these details are not repeated here.

FIGS. 11A-11B are flow diagrams of an exemplary method 11000 for initiating display of an environment-locked user interface from a viewpoint-locked user interface. In some embodiments, the method 11000 is performed at a computer system (e.g., computer system 7100 and/or computer system 101) that is in communication with a first display generation component (e.g., a first display generation component of a two-sided display generation component, a heads-up display, a head-mounted display (HMD), a display, a touchscreen, a projector, a standalone display, and/or a display that is enclosed in the same housing as another display generation component of the same type or a different type) and one or more input devices (e.g., cameras, controllers, touch-sensitive surfaces, joysticks, buttons, gloves, watches, motion sensors, and/or orientation sensors). In some embodiments, the first display generation component is a display component facing the user and provides an XR experience to the user. In some embodiments, the first display generation component includes two or more display components (e.g., one set for each eye) that display slightly different images to form a stereoscopic view of the three-dimensional environment. In some embodiments, the first display generation component and a second display generation component form a two-sided display device (e.g., a two-sided HMD) that displays a first user interface on a first side corresponding to the first display generation component, and a second user interface on the second side corresponding to the second display generation component. In some embodiments, the second display generation component is a display component facing away from the user and toward an external environment of the user and optionally provides status information related to the first display generation component (e.g., displayed content and/or operational state) and/or the user (e.g., movement of the user’s eyes, and/or attention state of the user) to other users in the external environment. In some embodiments, the computer system is an integrated device with one or more processors and memory enclosed in the same housing as the first and the second display generation components and at least some of the one or more input devices. In some embodiments, the computer system includes a computing component (e.g., a server, a mobile electronic device such as a smart phone or tablet device, a wearable device such as a watch, wristband, or earphones, a desktop computer, or a laptop computer) that includes one or more processors and memory that is separate from the display generation component(s) and/or the one or more input devices. In some embodiments, the display generation component(s) and the one or more input devices are integrated and enclosed in the same housing.

Initiating display of an environment-locked user interface from a viewpoint-locked user interface allows the computer system to display relevant user interfaces at appropriate locations in a view of a three-dimensional environment. This helps increase a level of immersion of a user of the computer system, as the user is not exposed to unnecessary affordances (e.g., for displaying or ceasing to display certain user interface elements, and/or for moving user interface elements) and does not need to perform additional user inputs in order to display user interface elements at appropriate positions in the view of the three-dimensional environment.

The computer system displays (11002), via the first display generation component (e.g., a display generation component of the computer system 7100, in FIG. 7Z), a first view of a three-dimensional environment (e.g., the physical environment 7000 in FIG. 7Y-7AF) that corresponds to a first viewpoint of a user (e.g., a viewpoint of the user at the third location 7026-c, in FIG. 7Z), wherein: the first view of the three-dimensional environment includes a first user interface element (e.g., the system function menu 7024, in FIG. 7Z) that is displayed at a first position in the three-dimensional environment; the first user interface element has a first spatial relationship with the first viewpoint of the user (e.g., the first user interface element is viewpoint locked, and/or head locked) (alternatively, the first user interface element has a first spatial relationship with the viewport through which the three-dimensional environment is visible) while the first user interface element is displayed at the first position in the three-dimensional environment; and the first user interface element includes at least a first affordance (e.g., a selectable user interface element such as a button or menu option that corresponds to a selectable option for accessing a system function of the first computer system, launching an application, starting an immersive experience, and/or displaying a system user interface such as a home user interface, a universal search user interface, a notification-display user interface, and/or a multitasking user interface) (e.g., the control affordance 7046 in FIG. 7AA) . In some embodiments, the three-dimensional environment is a computer-generated environment that includes one or more virtual objects(e.g., the virtual object 7012, in FIG. 7Y-7AF) and, optionally, a representation of a physical environment surrounding the first display generation component (e.g., displaying a pure virtual environment with only virtual content (e.g., a VR view), or displaying a mixed reality environment including both virtual content and representations of the surrounding physical environment (e.g., an AR view of the surrounding physical environment of the computing system and/or display generation component)). In some embodiments, the representation of the physical environment is visible to the user through a transparent or semi-transparent portion of the first display generation component, or displayed as an image or camera feed capturing the physical environment. In some embodiments, the first user interface element is a virtual object that includes one or more affordances, such as one or more selectable, adjustable, and/or activatable control elements (e.g., menu options, buttons, icons, selectors, toggle buttons, check boxes, slider controls, and/or dials) that correspond to various operations performable by the computer system (e.g., operations such as launching an application, navigating to a system user interface (e.g., home user interface, search user interface, control panel user interface, notification user interface, and/or settings user interface), adjusting a setting of the computer system (e.g., volume, level of immersion, display brightness, network setting, DND setting, and/or other system settings), and/or navigating to an application user interface of a selected application or function (e.g., real-time communication, sharing, messaging, and/or emailing)). In some embodiments, the first user interface element is a system user interface element that is made available in a variety of contexts (e.g., when multiple applications and/or XR experiences are active and displayed in the three-dimensional environment, and/or when different applications and/or XR experiences are active and displayed in the three-dimensional environment), as opposed to only available in the context of a respective application or experience or a small set of related applications or experiences. In some embodiments, the first user interface element is a quick launch bar or dock that includes multiple selectable affordances for launching corresponding applications and/or XR experiences in the three-dimensional environment. In some embodiments, the first user interface element is displayed in the three-dimensional environment in response to a gaze input (e.g., as indicated by the user’s attention 7116, in FIG. 7Z) being detected in a first region of the field of view provided by the first display generation component (e.g., the top portion of the field of view, the top center portion of the field of view, the upper left corner of the field of view, or another system-selected or user-selected portion of the field of view) (e.g., a region corresponding to the indicator 7010 of system function menu, in FIG. 7Z) for a threshold amount of time. In some embodiments, the first user interface element is displayed in response to a gaze input being detected on a persistent indicator (e.g., an indicator (e.g., of system function menu) that is persistently display at or near the first region in the field of view) in the three-dimensional environment. In some embodiments, the first user interface element has a first spatial relationship with the first viewpoint of the user (e.g., the first user interface element is viewpoint locked, and/or head locked) while the first user interface element is displayed at the first position in the three-dimensional environment, where the first spatial relationship corresponds to a first distance and a first relative position between the viewpoint of the user and the first user interface element (e.g., the first user interface element is straight in front of the viewpoint, at a first angle above the horizon, or at a second angle left of the line of sight from the viewpoint) in the three-dimensional environment. In some embodiments, the computer system determines the position and/or orientation with which the first user interface element is to be displayed in the three-dimensional environment to consistently display the first user interface element with the first spatial relationship between the current viewpoint of the user and the first user interface element in response to detecting inputs that correspond to user’s requests for the display of the first user interface element.

While displaying the first view of the three-dimensional environment, including displaying the first user interface element at the first position in the three-dimensional environment (e.g., the first position in the three-dimensional environment has the first spatial relationship with the first viewpoint of the user, and/or the first user interface element displayed with a first orientation and the first position has the first spatial relationship with the first viewpoint), the computer system detects (11004) first movement of a viewpoint of the user from the first viewpoint to a second viewpoint (e.g., movement of the user 7002 from the third location 7026-c to the fourth location 7026-d, in FIG. 7AC-7AD). In some embodiments, the movement of the viewpoint of the user is accomplished by moving the first display generation component and/or the one or more cameras in the physical environment, and/or movement of the user (e.g., turning, walking, running, and/or tilting the head up or down) in the physical environment, that change the pose (e.g., position and/or facing direction) of the user relative to the three-dimensional environment.

In response to detecting the first movement of the viewpoint of the user from the first viewpoint to the second viewpoint (e.g., the spatial relationship between the viewpoint of the user and the three-dimensional environment changes as a result of the first movement), while a second view of the three-dimensional environment that corresponds to the second viewpoint of the user is visible via the one or more display generation components (e.g., the second view includes one or more virtual objects and, optionally, a representation of the physical environment that corresponds to the second viewpoint (e.g., a camera view, an image, and/or a view through a transparent or semitransparent portion of the first display generation component)), the computer system displays (11006) the first user interface element at a second position in the three-dimensional environment, wherein the first user interface element has the first spatial relationship with the second viewpoint of the user while the first user interface element is displayed at the second position in the three-dimensional environment (e.g., the first user interface element is viewpoint locked, and/or head locked; the spatial relationship between the first user interface element and the viewport through which the three-dimensional environment is visible does not change as a result of the movement of the viewpoint; and the spatial relationship between the first user interface element and the viewpoint does not change as a result of the first movement of the viewpoint) (e.g., the second position in the three-dimensional environment has the first spatial relationship with the second viewpoint of the user, and/or the first user interface element displayed with a second orientation and the second position has the first spatial relationship with the first viewpoint) (e.g., the system function menu 7024 is displayed with the same spatial relationship with the user’s viewpoint in both FIGS. 7AC and 7AD, despite movement of the user’s viewpoint from the third location 7026-c to the fourth location 7026-d). In some embodiments, the first user interface element has the first spatial relationship with the second viewpoint of the user (e.g., the first user interface element is viewpoint locked, and/or head locked; and/or the first user interface element has the first spatial relationship to the viewport through which the three-dimensional environment is visible) while the first user interface element is displayed at the second position in the three-dimensional environment, where the first spatial relationship corresponds to the first distance and the first relative position between the viewpoint of the user and the first user interface element in the three-dimensional environment (e.g., the first user interface element is straight in front of the viewpoint, at the first angle above the horizon, or at the second angle left of the line of sight from the viewpoint; and/or the first user interface element is in the top center of the viewport, at a first distance above the horizon in the viewport, or in the left edge region of the viewport). In some embodiments, the computer system determines the position and/or orientation with which the first user interface element is to be displayed in the three-dimensional environment to consistently display the first user interface element with the first spatial relationship between the current viewpoint of the user and the first user interface element (and/or with the first spatial relationship between the viewport and the first user interface element) in response to detecting inputs that correspond to user’s requests for the display of the first user interface element. In some embodiments, while the first movement of the viewpoint is in progress, the spatial relationship between the first user interface element and the current viewpoint (and/or the viewport through which the three-dimensional environment is visible), optionally, changes; and once the first movement of the viewpoint is completed, the first user interface element is displayed at the second position to restore the first spatial relationship between the first user interface element and the viewpoint in the three-dimensional environment (and/or restores the first spatial relationship between the first user interface element and the viewport through which the three-dimensional environment is visible).

While displaying the first user interface element in the second view of the three-dimensional environment (e.g., while displaying the first user interface element at the second position, with the first spatial relationship to the second viewpoint of the user and/or the viewport through which the three-dimensional environment is visible), the computer system detects (11008), via the one or more input devices, a first input that corresponds to activation of the first affordance (e.g., the first affordance is selected by a user input, such as an air tap or pinch in conjunction with a gaze input directed to the first affordance, a tap or pinch input at a location that corresponds to the position of the first affordance in the three-dimensional environment, or a gaze input directed to the first affordance detected in conjunction with a voice command to activate the first affordance) (e.g., the user’s attention 7116 is directed to the home affordance 7125 in FIG. 7AD).

In response to detecting the first input that corresponds to activation of the first affordance, the computer system displays (11010) a second user interface element (e.g., an application window, a modal user interface, a search user interface, a control panel user interface, a communication user interface, and/or a home user interface) in the second view of the three-dimensional environment, wherein the second user interface element is displayed at a third position in the three-dimensional environment (e.g., the second user interface element is the user interface 7146, which is displayed in response to detecting the user’s attention 7116 directed to the home affordance 7124, in FIG. 7AD). In some embodiments, the second user interface element corresponds to the respective affordance that is activated by the user’s input. For example, the first user interface element optionally includes respective affordances corresponding to a search user interface, a notification user interface, a control panel user interface, and a home user interface; and activation of a respective affordance causes display of the corresponding user interface in a world locked manner at the third position in the three-dimensional environment. In some embodiments, the second user interface element has a second spatial relationship with the second viewpoint of the user (e.g., the second spatial relationship is the same as the first spatial relationship, but the second spatial relationship is not maintained after the initial display of the second user interface element; or the second spatial relationship is different from the first spatial relationship) while second user interface element is displayed at the third position in the three-dimensional environment. In some embodiments, the second spatial relationship corresponds to a second distance and a second relative position between the viewpoint of the user and the second user interface element (e.g., the second user interface element is straight in front of the viewpoint, at a third angle above the horizon, or at a fourth angle left of the line of sight from the viewpoint) in the three-dimensional environment. In some embodiments, the second spatial relationship corresponds to a respective position of the second user interface element relative to the viewport through which the three-dimensional environment is visible (e.g., the second user interface element is in the top center region of the viewport, top left corner of the viewport, or in the left edge portion of the viewport). In some embodiments, the computer system determines the position and/or orientation with which the second user interface element is to be displayed in the three-dimensional environment to display the second user interface element based on one or more factors, such as the availability of unoccupied space in the second view, the current position of the viewpoint, the user’s preferred position, and/or the last displayed position of the second user interface element. The computer system does not maintain the second spatial relationship, but instead maintains the third position, and optionally, the orientation of the second user interface element, after the second user interface element is displayed at the third position in the three-dimensional environment (e.g., the second user interface element is world locked to the three-dimensional environment in position, and optionally in orientation as well).

While displaying the second view of the three-dimensional environment, including displaying the second user interface element at the third position in the three-dimensional environment (e.g., the third position in the three-dimensional environment has a second spatial relationship with the second viewpoint of the user, the third position in the three-dimensional environment has a second spatial relationship with the viewport through which the three-dimensional environment is visible, and/or the second user interface element displayed with a second orientation and the third position has the second spatial relationship with the second viewpoint) (e.g., in some embodiments, the first user interface element is displayed with a position and orientation that has the first spatial relationship with the second viewpoint and/or the viewport through which the three-dimensional environment is visible, or the first user interface element is no longer displayed in the second view of the three-dimensional environment), the computer system detects (11012) second movement of the viewpoint of the user from the second viewpoint to a third viewpoint (e.g., movement of the user 7002 from the fourth location 7026-d to the fifth location 7026-e, in FIG. 7AE-7AF). In some embodiments, the movement of the viewpoint of the user is accomplished by moving the first display generation component and/or the one or more cameras in the physical environment, and/or movement of the user (e.g., turning, walking, running, and/or tilting the head up or down) in the physical environment, that change the pose (e.g., position and/or facing direction) of the user relative to the three-dimensional environment.

In response to detecting the second movement of the viewpoint of the user from the second viewpoint to the third viewpoint (e.g., the spatial relationship between the viewpoint of the user and the three-dimensional environment changes as a result of the second movement), while a third view of the three-dimensional environment that corresponds to the third viewpoint of the user is visible via the one or more display generation components (e.g., the third view includes one or more virtual objects and, optionally, a representation of the physical environment that corresponds to the third viewpoint (e.g., a camera view, an image, and/or a view through a transparent or semitransparent portion of the first display generation component)), the computer system displays (11014) the second user interface element at a location in the third view of the three-dimensional environment that corresponds to the third position in the three-dimensional environment (e.g., the second user interface element is world locked to the three-dimensional environment during the movement of the viewpoint of the user) (e.g., the user interface 7146 is displayed at the same position in the three-dimensional environment in FIG. 7AE and FIG. 7AF, but appears closer to the viewpoint of the user (e.g., on the display of the computer system 7100) in FIG. 7AF due to the user 7002′s movement to the fifth location 7026-e). In some embodiments, while the second movement of the viewpoint is in progress, the spatial relationship between the second user interface element and the current viewpoint changes (and/or the spatial relationship between the second user interface element and the viewport through which the three-dimensional environment is visible changes). In some embodiments, the second user interface element is actively redrawn (e.g., with a different viewing perspective) at the third position in the currently displayed view of the three-dimensional environment to produce the illusion that the second user interface element is maintained at the third position, as the viewpoint changes from the second viewpoint to the third viewpoint as a result of the second movement of the viewpoint. In some embodiments, the first user interface element is displayed in the third view of the three-dimensional environment with a position and orientation to establish the first spatial relationship between the first user interface element and the third viewpoint. In some embodiments, the first user interface element is no longer displayed in the third view of the three-dimensional environment.

In some embodiments, the second user interface element is a search user interface that is configured to accept one or more search criteria from the user to perform a search. In some embodiments, while displaying the second user interface element, the computer system detects a first user input that includes one or more first search criteria. In some embodiments, in response to detecting the first user input that includes the one or more first search criteria, the computer system performs a first search in accordance with the one or more first search criteria (e.g., performing a search on the computer system, performing a system-level search beyond the scope of an individual application or experience, and/or performing a search on the Internet). In some embodiments, displaying the second user interface element includes displaying a search input field and, optionally, a soft keyboard in the search user interface displayed at the third position in the second view and the third view of the three-dimensional environment. In some embodiments, displaying the second user interface element includes displaying a voice input interface that accept one or more search criteria specified in the user’s speech input. In some embodiments, the search user interface accepts a drag and drop input that includes dragging and dropping a user interface element (e.g., text, document, image, webpage, a user’s avatar, an email address, a contact card, and/or a media item) from a portion of the three-dimensional environment that is outside of the search user interface (e.g., from a window and/or user interface of another application, and/or from a window of a communication session). In some embodiments, the search user interface includes application icons that corresponds to one or more applications and/or experiences, and/or avatars of one or more contacts of the user, that are automatically suggested by the computer system (e.g., based on the current context, based on the currently entered search criteria (e.g., full or partial search criteria), usage or search history).

For example, the space 7050 in FIG. 7K(b) is a search user interface for performing a search operation. For example, in the descriptions of FIGS. 7K(b) and 7AA, where the system space 7050 of FIG. 7K(b) and the user interface 7136 (of FIG. 7AA) are user interfaces for performing a search operation. Displaying a second user interface that is a search user interface in response to detecting the first input that corresponds to activation of the first affordance, and performing a first search in accordance with a first user input that includes one or more first search criteria, enables search functionality of the computer system without needing to permanently display additional controls (e.g., without needing to permanently display controls for accessing the search function), which augments the level of immersion while using the computer system by displaying user interface elements and controls only when needed.

In some embodiments, detecting the first user input that includes the one or more first search criteria includes detecting a first gaze input that is directed to the second user interface element in conjunction with (e.g., before, and/or within a threshold amount of time of) detecting a first speech input that includes the one or more first search criteria, and performing a first search in accordance with the one or more first search criteria includes performing (optionally, in accordance with a determination that the first gaze input meets stability requirement (e.g., less than a threshold amount of movement within a threshold amount of time) within the second user interface element, or within a first portion of the second user interface element) the first search in accordance with the one or more first search criteria included in the first speech input. In some embodiments, the first gaze input is directed to a portion of the search user interface that corresponds to a search input field (e.g., a search bar). In some embodiments, the first gaze input is directed to a microphone icon displayed in the search user interface. In some embodiments, the computer system displays a visual change in the search user interface in accordance with a determination that the first gaze input has met the stability requirement, and optionally, displays a prompt for the user to speak to provide the search criteria. In some embodiments, the first speech input includes a natural language search query or a sequence of one or more search keywords rendered in human speech. In some embodiments, the computer system displays or otherwise outputs one or more search results that are responsive to the search query and/or search keywords. In some embodiments, the search results include application icons for one or more applications, and/or experiences, representations of one or more users, and/or one or more documents, images, and/or past communications. In some embodiments, the computer system displays visual feedback while the first speech input of the user is detected (e.g., a search bar of the search user interface updates to display text corresponding to the first speech input), and optionally updates in real time (e.g., the displayed text in the search bar of the search user interface updates to display a new word of the spoken search query, after a new word is spoken as part of the first speech input).

For example, in the descriptions of FIGS. 7K(b) and 7AA, where the system space 7050 of FIG. 7K(b) and the user interface 7136 (of FIG. 7AA) are user interfaces for performing a search operation, and the user can input a search term with a verbal input. Displaying a second user interface that is a search user interface in response to detecting the first input that corresponds to activation of the first affordance, and performing a first search in accordance with a first user input that includes a first gaze input directed to the second user interface element in conjunction with a first speech input that includes one or more first search criteria, enables search functionality of the computer system without needing to display additional controls (e.g., additional controls such as a keyboard for entering text).

In some embodiments, displaying the second user interface element that includes the search user interface includes a keyboard that is configured to enter one or more textual search keywords into the search user interface. In some embodiments, the keyboard is also displayed at the third position in the three-dimensional environment (e.g., or at another position that is immediately adjacent to the third position), and in response to detecting the second movement of the viewpoint of the user from the second viewpoint to the third viewpoint while a third view of the three-dimensional environment that corresponds to the third viewpoint of the user is visible via the one or more display generation components, the keyboard is displayed at the third position in the three-dimensional environment (e.g., or the other position that is immediately adjacent to the third position). In some embodiments, the keys in the keyboard are selectively activated by a gaze input on a respective key that is provided in conjunction with a tap or pinch gesture in the air. In some embodiments, the keys in the keyboard are selectively activated by a tap or pinch gesture at a location that corresponds to a respective key.

For example, in the description of FIG. 7AA, in some embodiments, the user interface 7136 is a user interface for performing a search operation, and the user interface 7136 optionally includes a virtual keyboard that can be used to enter a search term. Displaying a second user interface that is a search user interface that includes a keyboard configured to enter one or more textual search keywords into the search user interface, in response to detecting the first input that corresponds to activation of the first affordance, and performing a first search in accordance with a first user input that includes one or more first search criteria, enables search functionality of the computer system without needing to permanently display additional controls (e.g., without needing to permanently display the keyboard configured to enter textual search keywords), which augments the level of immersion while using the computer system by displaying user interface elements and controls only when needed.

In some embodiments, the second user interface element includes representations of one or more notifications that have been received by the computer system. In some embodiments, the second user interface includes one or more notifications that are recently received and/or that have not been viewed by the user. In some embodiments, the second user interface includes a notification history interface that includes notifications that were previously displayed as new notifications and then stored in the notification history after a period of time or after a user has viewed and/or dismissed them. In some embodiments, the second user interface element includes multiple components, such as portions or all of a search user interface and portions or all of a notification user interface. In some embodiments, the second user interface element includes a single user interface, such as a search user interface or a notification user interface.

For example, the system space 7052 in FIG. 7K(c) is a notification user interface that includes content from one or more notifications received by the computer system 7100. For example, in the descriptions of FIGS. 7K(c) and 7AA, in some embodiments, the system space 7052 of FIG. 7K(c) and the user interface 7136 (of FIG. 7AA) are notification user interfaces that include content from one or more notifications received by the computer system 7100. Displaying a second user interface that includes representation of one or more notifications that have been received by the computer system, in response to detecting the first input that corresponds to activation of the first affordance, enables easy access to previously received notifications without needing to permanently display additional controls or permanently display the previously received notifications (e.g., the second user interface element with the previously received notifications, need not always displayed), which augments the level of immersion while using the computer system by displaying user interface elements and controls only when needed.

In some embodiments, the second user interface element includes at least a first icon corresponding to a first experience and a second icon corresponding to a second experience (e.g., the second user interface element is a home user interface that includes a plurality of application icons, which, when activated, cause the computer system to display respective applications corresponding to the plurality of application icons in the three-dimensional environment). In some embodiments, while displaying the second user interface element including the first icon and the second icon, the computer system detects a second user input directed to a respective icon of the first icon and the second icon (e.g., a gaze input directed to the first icon or the second icon, that is detected in conjunction with an air tap or air pinch gesture, or a tap or pinch gesture detected at a location that corresponds to the position of the first icon or the second icon in the three-dimensional environment). In some embodiments, in response to detecting the second user input directed to the respective icon and in accordance with a determination that the second user input is directed to the first icon, the computer system starts a first process to display the first experience in the three-dimensional environment. In some embodiments, in response to detecting the second user input directed to the respective icon and in accordance with a determination that the second user input is directed to the second icon, the computer system starts a second process to display the second experience in the three-dimensional environment. In some embodiments, the second user interface element is a home user interface includes a plurality of icons that correspond to a plurality of three-dimensional experiences in the three-dimensional environment (e.g., when activated, causes the system to display virtual sceneries, virtual worlds, and/or extended reality experiences). In some embodiments, the home user interface includes a plurality of icons that correspond to users, which, when activated, cause the computer system to display options for establishing communication sessions with the users in the three-dimensional environment. In some embodiments, the home user interface includes an initial user interface and one or more sub-level user interfaces that are displayed in response to interaction with user interface controls displayed in the initial user interface. In some embodiments, the primary user interface includes category icons for applications, experiences, and users, and optionally, a subset of frequently used application icons, experiences, and/or users; and the one or more sub-user interfaces display more application icons, icons for experiences, and representations of users, based on the selection of the category icons in the initial user interface. In some embodiments, the second user interface element includes multiple components, such as portions or all of a search user interface, portions or all of a notification user interface, and/or portions or all of a home user interface. In some embodiments, the second user interface element includes a single user interface, such as a search user interface, a notification user interface, or a home user interface.

For example, in the description of FIG. 7AD, in some embodiments, the user interface 7146 is a home user interface, which includes different affordances (e.g., application icons, user icons/user avatars, and/or icons corresponding to different virtual environments). Displaying a second user interface that includes at least a first icon corresponding to a first experience and a second icon corresponding to a second experience, in response to detecting the first input that corresponds to activation of the first affordance, enables easy access to different experiences without needing to permanently display additional controls (e.g., the second user interface element with the first and second icons need not always displayed), which augments the level of immersion while using the computer system by displaying user interface elements and controls only when needed.

In some embodiments, the first experience corresponds to a first application, and the second experience corresponds to a second application that is different from the first application. In some embodiments, displaying the first experience includes displaying an initial or default user interface of the first application in the three-dimensional environment; and displaying the second experience includes displaying an initial or default user interface of the second application in the three-dimensional environment. In some embodiments, the respective application user interface is displayed in a window of the respective application, and includes user interface elements that provide content and interactive functions of the respective application to the user. In some embodiments, the computer system ceases to display the second user interface element in response to detecting the second user input directed to the first icon or the second affordance and displaying the respective application user interface. In some embodiments, the respective application user interface is a world locked user interface in the three-dimensional environment.

For example, in the description of FIG. 7AD, in some embodiments, the user interface 7146 is a home user interface, which includes affordances that are application icons for launching application user interfaces for corresponding applications. Displaying a second user interface that includes at least a first icon corresponding to a first experience that corresponds to a first application and a second icon corresponding to a second experience that corresponds to a second application, in response to detecting the first input that corresponds to activation of the first affordance, enables easy access to different experiences corresponding to different applications without needing to permanently display additional controls (e.g., the second user interface element with the first and second icons need not always displayed, and/or the first and second icons are application icons, which need not be permanently displayed to access experiences corresponding to the respective applications), which augments the level of immersion while using the computer system by displaying user interface elements and controls only when needed.

In some embodiments, the first experience corresponds to a first other user (e.g., a first other user other than the user of the computer system), and the second experience corresponds to a second other user that is different than the first other user. In some embodiments, the second user interface element is the home user interface that includes respective representations of a plurality of users, which, when activated, cause the computer system to initiate respective communication sessions with the plurality of users. In some embodiments, the plurality of users are automatically selected by the system from a group of users that had communication with the user of the computer system in a recent period of time. In some embodiments, the plurality of users are automatically selected from a group of users that are stored in a contact list of the user of the computer system. In some embodiments, while displaying the second user interface element that includes the home user interface, the computer system detects user input that activates a first representation among the respective representations of the plurality of users (e.g., the third user input is a gaze input directed to the first representation detected in conjunction with an air tap or air pinch gesture, or a tap or pinch gesture detected at a location that corresponds to the position of the first representation in the three-dimensional environment); and in response to detecting the user input, the computer system initiates a first communication session with a first user that corresponds to the first representation. In some embodiments, initiating the first communication session includes displaying a plurality of selectable options that correspond to different communication protocols and/or applications (e.g., voice-only communication, video communication, extended reality communication, shared three-dimensional experience provided by a respective extended reality application, text messaging communication, email communication, and/or mixed modality communication involving two or more of the above), and establishing the communication session in accordance with the communication protocol and/or application that is selected by the user using the plurality of selectable options.

For example, in the description of FIG. 7AD, in some embodiments, the user interface 7146 is a home user interface, which includes affordances that are user avatars (e.g., or contact information, telephone numbers, user names, or entity names) for initiating a communication session with respective other users. Displaying a second user interface that includes at least a first icon corresponding to a first experience that corresponds to a first other user and a second icon corresponding to a second experience that correspond to a second other user, in response to detecting the first input that corresponds to activation of the first affordance, enables the user to efficiently initiate communication sessions with one or more users without needing to permanently display additional controls (e.g., the computer system need not permanently display the first and second icons), which augments the level of immersion while using the computer system by displaying user interface elements and controls only when needed.

In some embodiments, the first experience corresponds to a first virtual three-dimensional environment, and the second experience corresponds to a second virtual three-dimensional environment that is different from the first virtual environment. In some embodiments, the second user interface element includes respective representations of a plurality of computer-generated three-dimensional experiences (e.g., virtual environments, virtual augmentation of the physical environments (e.g., virtual offices, virtual scenery (e.g., park, ocean, seaside, mountain, forest, beach, urban, dawn, and/or night), virtual mood or ambiance based on virtual lighting, décor, and/or sounds, virtual geographic locations, three-dimensional movies, and/or three-dimensional games), interactive experiences in an virtual and/or augmented reality environment). In some embodiments, while displaying the second user interface element including the home user interface, the computer system detects a user input that activates a second representation of the respective representation of the plurality of computer-generated three-dimensional experiences; and in response to detecting the user input, the computer system displays a first computer-generated three-dimensional experience that corresponds to the second representation. In some embodiments, displaying the first computer-generated three-dimensional experience includes replacing display of an existing virtual environment (e.g., a virtual environment that was displayed prior to detecting the user input) with a new virtual environment that corresponds to the first computer-generated three-dimensional experience. In some embodiments, displaying the first computer-generated three-dimensional experience includes replacing display of some or all of the virtual objects and content displayed in the three-dimensional environment with new virtual objects and content that correspond to the first computer-generated three-dimensional experience.

For example, in the description of FIG. 7AD, in some embodiments, the user interface 7146 is a home user interface, which includes affordances that correspond to different virtual environments, and the user 7002 interacts with a respective affordance to initiate display of a respective virtual environment in the three-dimensional environment. Displaying a second user interface that includes at least a first icon corresponding to a first experience that corresponds to a first virtual three-dimensional environment and a second icon corresponding to a second experience that corresponds to a second virtual three-dimensional environment, in response to detecting the first input that corresponds to activation of the first affordance, enables easy access to different experiences corresponding to different virtual three-dimensional environments without needing to permanently display additional controls (e.g., the computer system need not permanently display the first and second icons), which augments the level of immersion while using the computer system by displaying user interface elements and controls only when needed.

In some embodiments, displaying the second user interface element includes displaying a first portion of the second user interface element without displaying one or more second portions of the second user interface element (e.g., the second user interface element includes multiple sections or pages, and only one section or page is displayed at a time) (e.g., the multiple portions of the second user interface element correspond to a search user interface, a notification user interface, a control panel user interface, and/or a home user interface; or the multiple portions of the second user interface element correspond to a page for application icons, a page for experiences, and a page for users). In some embodiments, the computer system optionally displays one category of objects (e.g., categories such as search-related objects, notification-related objects, system-control related objects, and/or home-related objects) in the second user interface element at a time. In some embodiments, the computer system optionally displays one main category of objects (e.g., in the central region of the second user interface element), and reveals a hint of other category of objects at the same time (e.g., on the sides or other peripheral region of the second user interface element, in a smaller size, or with reduced luminance, color, and/or opacity, as compared to the objects in the central portion of the second user interface element). In some embodiments, the computer system optionally displays a subset, less than all, of all icons of a respective category of icon at a given time. In some embodiments, while displaying the first portion of the second user interface element without displaying the one or more second portions of the second user interface element, the computer system detects a third user input. In some embodiments, in response to detecting the third user input and in accordance with a determination that the third user input meets first criteria (e.g., the third user input meets switching criteria or meets scrolling criteria), the computer system ceases to display the first portion of the second user interface element and displaying at least one of the one or more second portions of the second user interface element. In some embodiments, different portions of the second user interface element include different types of icons. For example, the first portion of the second user interface element includes application icons that activate experiences corresponding to different applications, a second portion of the second user interface element includes user icons that activate experiences corresponding to different other users, and/or a third portion of the second user interface element includes environment icons that activate experiences corresponding to different virtual environment. Performing the third user input allows the user to switch between displaying application icons and displaying user icons (and/or environment icons). In some embodiments, the different portions of the second user interface element include different subsets of the same type of icons, and scrolling or switching between the different portions causes display of the different subsets of a respective type of icons. In some embodiments, the one or more second portions of the second user interface element include a third portion of the second user interface element and a fourth portion of the second user interface element, and the computer system displays the third portion of the second user interface element in response to detecting the third user input that meets the first criteria, and in response to detecting a fourth user input that meets the first criteria (e.g., a fourth user input that is the same as the third user input), the computer system ceases to display the third portion of the second user interface element and displays the fourth portion of the second user interface element. In some embodiments. In some embodiments, the user can continue to perform user inputs that meet the first criteria to cycle between the different portions of the second user interface element (e.g., from the first portion to the third portion, from the third portion to the fourth portion, from the fourth portion to the first portion, and so on). In some embodiments, the user can perform a user input that meets second criteria different from the first criteria, to reverse the order through which the computer system displays the portions of the second user interface element. In some embodiments, the first criteria require that the third user input includes a swipe gesture in a first direction in order for the first criteria to be met, and the second criteria require that the (subsequent) user input includes a swipe gesture in a second direction that is opposite the first direction, in order for the second criteria to be met. In some embodiments, displaying the at least one of the one or more second portions of the second user interface element includes replacing display of the first portion of the second user interface element with said at least one of the second portions of the second user interface element in the second user interface element (e.g., in the central portion of the second user interface element). In some embodiments, the third user input that meets the first criteria is a navigation gesture in a first direction or a second direction, and the computer system navigates (e.g., switches or scrolls) to the next portion of the second user interface element in that first direction or second direction. As used herein, a “navigation gesture” can be any suitable navigation gesture (e.g., for navigating between different portions/sections of a user interface, or for navigating between different user interfaces). In some embodiments, the navigation gesture is a pinch and drag air gesture. In some embodiments, the navigation gesture is a gesture that activates an affordance (e.g., a left or right arrow affordance, or an affordance that includes text (e.g., “next,” “next section,” or analogous text)) for navigating between portions of the second user interface element. In some embodiments, the swipe gesture is a gaze gesture directed to a specific region (e.g., a left or right edge/boundary) of the second user interface element. In some embodiments, the computer system shifts the content displayed in the second user interface element to switch out the currently displayed portion of the second user interface element, and shift in the next portion of the second user interface element in the first direction or second direction. In some embodiments, the third user input that meets the switching criteria includes an air tap input or air pinch input directed to a respective category icon corresponding to a respective category of icons in the home user interface or a paging indicator corresponding to a page or section of the home user interface. In some embodiments, the third user input that meets the switching criteria includes a swipe input (e.g., air swipe, or swipe on a touch-sensitive surface) in the left and right direction (or alternatively, in the up and down direction) that causes the computer system to switch between displaying different categories of icons (e.g., icons for applications, experiences, and users) in the home user interface. In some embodiments, the third user input that meets the scrolling criteria includes an air tap or air pinch input detected in conjunction with a gaze input directed to a scrolling bar associated with the currently displayed category of icons and/or page of the second user interface element. In some embodiments, the third user input that meets the scrolling criteria includes a swipe input (e.g., air swipe, or swipe on a touch-sensitive surface) in the up and down direction (or alternatively, in the left and right direction) that causes the computer system scroll through the currently displayed category of icons or the currently displayed page or section of the second user interface element.

For example, in the description of FIG. 7AD, in some embodiments, the user interface 7146 includes different groups of affordances, and the user 7002 can navigate between the different groups of affordances (e.g., by performing an air gesture, such as an air tap or an air pinch, or another selection input, interacting with a specific affordance for switching between groups of affordances, and/or interacting with a respective affordance for a respective group of affordances). Ceasing to display the first portion of the second user interface element and displaying at least one of the one or more second portions of the second user interface element that were not displayed with the first portion of the second user interface element, in response to detecting the third user input that meets first criteria, allows for navigation between sections of the home user interface without displaying additional controls (e.g., additional controls for displaying the one or more second portions of the second user interface). This also augments the user’s level of immersion by reducing the size and/or number of displayed user interface elements by only displaying the relevant portion(s) of the second user interface (e.g., as needed).

In some embodiments, the second user interface element includes a home user interface. In accordance with the determination that the third user input meets the first criteria, the computer system ceases to display the first portion of the second user interface element and displays at least one of the one or more second portions of the second user interface element. In accordance with a determination that the third user input meets switching criteria (e.g., the third user input selects a respective category icon for a category of icons, and/or selects a page or section indicator displayed in the second user interface element; or the third user input is a swipe gesture in a first direction (e.g., up and down direction, or alternatively, left and right direction)), the computer system ceases to display a first section of the home user interface and displays a second section of the home user interface, wherein the first section of the home user interface and the second section of the home user interface correspond to different categories of icons selected from a first category corresponding to applications, a second category corresponding to computer-generated three-dimensional experiences, and a third category corresponding to users. In some embodiments, in response to detecting a first type of air gesture (e.g., a swipe gesture in a first direction (e.g., horizontal direction, left and right direction, or up and down direction)), or a combination of a gaze input on the home user interface and the first type of air gesture), the computer system switches between displaying different sections of the home user interface (e.g., applications, experiences, and users).

For example, in the description of FIG. 7AD, in some embodiments, the user interface 7146 is a home user interface that includes different groups of affordances, and the user 7002 can navigate between the different groups of affordances (e.g., by performing an air gesture, such as an air tap or an air pinch, or another selection input, interacting with a specific affordance for switching between groups of affordances, and/or interacting with a respective affordance for a respective group of affordances). Ceasing to display a first section of the home user interface and displaying a second section of the home user interface, in response to detecting the third user input that meets switching criteria, allows for navigation between sections of the home user interface without displaying additional controls (e.g., additional controls for navigating to the next (or a previous) section, or additional controls for navigating to a specific other section).

In some embodiments, in accordance with the determination that the third user input meets the first criteria, the computer system ceases to display the first portion of the second user interface element and displaying at least one of the one or more second portions of the second user interface element. In accordance with a determination that the third user input meets scrolling criteria (e.g., the third user input activates a scroll control in the home user interface; or the third user input is a swipe gesture in a second direction (e.g., left and right direction, or alternatively, up and down direction)) different from the switching criteria, the computer system scrolls through a currently displayed section of the home user interface (e.g., ceases to display a first portion of the currently displayed section of the home user interface and displays a second portion of the currently displayed section of the home user interface, wherein the first portion and the second portion of the currently displayed section of the home user interface include different subsets of the category of icons corresponding to the currently displayed section of the home user interface (e.g., different subsets of icons from the first category corresponding to applications, different subsets of icons from the second category corresponding to computer-generated three-dimensional experiences, or different subsets of icons from the third category corresponding to users). In some embodiments, in response to detecting a second type of air gesture (e.g., a swipe gesture in a second direction (e.g., vertical direction, up and down direction, or left and right direction)), or a combination of a gaze input on a scroll bar in the home user interface and the first type of air gesture), the computer system scrolls through different subsets of icons in the currently displayed section of the home user interface (e.g., applications, experiences, and users).

For example, in the description of FIG. 7AD, in some embodiments, the user 7002 can perform a first type of gesture to scroll display of affordances (e.g., within a particular group of affordances), and can perform a second type of gesture to switch between different groups of affordances. Ceasing to display a first section of the home user interface and displaying a second section of the home user interface, in accordance with a determination that the third user input meets switching criteria, and scrolling through a currently displayed section of the home user interface, in accordance with a determination that the third user input meets scrolling criteria different from the switching criteria, allows for seamless navigation between sections of the home user interface and for scrolling within a particular section of the home user interface, without displaying additional controls (e.g., specific controls for navigating between sections and specific controls for scrolling within a section, or additional controls for toggling between switching and scrolling functionality).

In some embodiments, the first portion of the second user interface element includes a first set of icons (e.g., application icons, icons for starting different experiences, icons corresponding to different users) and the at least one of the one or more second portion of the second user interface element includes a second set of icons (e.g., application icons, icons for starting different experiences, icons corresponding to different users) different from the first set of icons. The respective icons of the first set of icons are displayed with different values for a first visual property (e.g., size, color, luminance, opacity, thickness, degree of fading, degree of blurring, and/or visual depth) while the first portion of the second user interface element is displayed. The respective icons of the second set of icons are displayed with different values for a second visual property (e.g., size, color, luminance, opacity, thickness, degree of fading, degree of blurring, and/or visual depth) (e.g., same as the first visual property, or different from the first visual property) while the at least one of the one or more second portions of the second user interface element is displayed. For example, in some embodiments, when the application section of the home user interface is displayed, application icons that are displayed in the central region of the home user interface are displayed with larger sizes, greater luminance, greater opacity, greater three-dimensional thickness, less fading, less blurring, and/or smaller visual depth than application icons that are displayed closer to the edge of the home user interface. In some embodiments, when switching between different sections of the home user interface, as some icons move toward the central section of the home user interface, they become larger, brighter, more opaque, thicker, less faded, less blurred, and/or move closer to the viewpoint; and as other icons move away from the central section of the home user interface toward the edge of the home user interface, they become smaller, dimmer, less opaque, thinner, more faded, more blurred, and/or move farther away from the viewpoint.

For example, in the description of FIG. 7AD, in some embodiments, affordances of the user interface 7146 that are within a threshold distance from a specific boundary (or boundaries) of the user interface 7146 are displayed with different visual characteristics. Displaying respective icons of the first set of icons with different values for a first visual property, in the first portion of the second user interface and while the first portion of the second user interface element is displayed, and displaying respective icons of the second set of icons with different values for a second visual property, in one or more second portions of the second user interface and while the one or more second portions of the second user interface element is displayed, provides improved visual feedback regarding the location of different icons (e.g., smaller, dimmer, less opaque, thinner, more faded, more blurred, and/or more distant icons are visually identifiable as icons of the second set of icons, while larger, brighter, more opaque, less faded, less blurred, and/or closer icons are visually identifiable as icons of the first set of icons).

In some embodiments, the first set of icons includes at least a first icon in a central portion of the first portion of the second user interface element, and a second icon in a peripheral portion of the first portion of the second user interface element. In some embodiments, the first icon is displayed with a first value of the first visual property, the second icon is displayed with a second value of the first visual property, and the first value of the first visual property corresponds to more visual emphasis than the second value of the first visual property (e.g., the first value corresponds to a larger size, greater luminance, greater opacity, greater three-dimensional thickness, less fading, less blurring, and/or smaller visual depth than the second value of the first visual property). In some embodiments, the second set of icons includes at least a third icon in a central portion of the at least one of the second portions of the second user interface element, and a fourth icon in a peripheral portion of the at least one of the second portions of the second user interface element. In some embodiments, the third icon is displayed with a third value of the first visual property, the fourth icon is displayed with the fourth value of the first visual property, and the third value of the first visual property corresponds to more visual emphasis than the fourth value of the first visual property (e.g., the first value corresponds to a larger size, greater luminance, greater opacity, greater three-dimensional thickness, less fading, less blurring, and/or smaller visual depth than the second value of the first visual property).

For example, in the description of FIG. 7AD, affordances of the user interface 7146 that are within a threshold distance from a specific boundary (or boundaries) of the user interface 7146 are displayed with different visual characteristics, which can include applying a degree of fading or blurring to said affordances. Displaying a first icon in a central position of the first portion of the second user interface element with more visual emphasis than a second icon that is displayed in a peripheral portion of the first portion of the second user interface, provides improved visual feedback regarding the relative location of first and second icons (e.g., the visual emphasis of the first icon provides visual feedback that the first icon is displayed in a central portion of the first portion of the second user interface element, and the comparative lack of visual emphasis provides visual feedback that the second icon is displayed in a peripheral portion of the first portion of the second user interface element).

In some embodiments, the first icon (e.g., as a representative icon of icons in the central portion of the first portion of the second user interface element) is displayed with a greater thickness in a direction of visual depth in the three-dimensional environment than the second icon (e.g., as a representative icon of icons in the peripheral or edge portions of the first portion of the second user interface element). In some embodiments, the first icon (e.g., as a representative of icons in the central portion of the first portion of the second user interface element) is displayed at a smaller visual depth from the viewpoint of the user than the second icon (e.g., as a representative of icons in the peripheral or edge portions of the first portion of the second user interface element). In some embodiments, the first icon (e.g., as a representative of icons in the central portion of the first portion of the second user interface element) is displayed at a greater visual depth from the viewpoint of the user than the second icon (e.g., as a representative of icons in the peripheral or edge portions of the first portion of the second user interface element). In some embodiments, the icons in the first portion of the second user interface element are distributed on an invisible concave or convex surface (e.g., curving toward the viewpoint, or curving away from the viewpoint) in the three-dimensional environment, and the icons that are in the central portion of the field of view are displayed with greater thickness in the direction of visual depth than the icons that are in the peripheral or edge portions of the field of view (e.g., icons near the edge of the second user interface element or the field of view are flattened more and increasingly two-dimensional as their positions become farther away from the central region of the second user interface element or the field of view).

For example, in the description of FIG. 7AD, in some embodiments, affordances of the user interface 7146 that are within a threshold distance from a specific boundary (or boundaries) of the user interface 7146 are displayed with different simulated thicknesses (e.g., as compared to affordances that are not within the threshold distance from the specific boundary or boundaries). Displaying a first icon in a central position of the first portion of the second user interface element with a greater thickness in a direction of visual depth, as compared to a second icon that is displayed in a peripheral portion of the first portion of the second user interface, provides improved visual feedback regarding the relative location of first and second icons (e.g., the greater thickness of the first icon provides visual feedback that the first icon is displayed in a central portion of the first portion of the second user interface element, and the lesser thickness of the second icon provides visual feedback that the second icon is displayed in a peripheral portion of the first portion of the second user interface element).

In some embodiments, before displaying the first user interface element, including at least the first affordance, at the first position in the three-dimensional environment, the computer system displays a third user interface element at the fourth position (e.g., at or near the first position) in the three-dimensional environment (e.g., the third user interface element is a small icon or indicator (e.g., of system function menu) that moves with the viewpoint, e.g., remains in the top portion of the field of view, or is displayed in response to the user’s gaze in the top portion of the field of view), wherein the third user interface element does not include the first affordance (e.g., the third user interface element does not include any affordance, or the third user interface element does not include the affordances for triggering display of the system user interfaces, such as the home user interface, notification user interface, search user interface, multitasking user interface, and/or control panel user interface). In some embodiments, while displaying the third user interface element at the fourth position in the three-dimensional environment, the computer system detects a fourth user input that meets second criteria (e.g., the fourth user input includes a tap or pinch gesture directed to the third user interface element, optionally, while a gaze input is directed to the third user interface element; or the fourth user input is a gaze input directed to the third user interface element for at least a threshold amount of time). In some embodiments, in response to detecting the fourth user input that meets the second criteria, the computer system displays the first user interface element at the first position in the three-dimensional environment. In some embodiments, displaying the first user interface element at the first position in the three-dimensional environment, in response to detecting the fourth user input, includes displaying an animation of the first user interface element expanding outward from the third user interface element. In some embodiments, displaying the first user interface element at the first position in the three-dimensional environment, in response to detecting the fourth user input, includes replacing display of the third user interface element with display of the first user interface element. In some embodiments, the first user interface element and the third user interface element are concurrently displayed.

For example, in FIGS. 7D-7E and FIGS. 7Y-7Z, the system function menu 7024 is displayed in response to detecting a user input that meets specific criteria (e.g., a user input directed to the indicator 7010 of system function menu). Displaying a third user interface element, before displaying the first user interface element, and displaying the first user interface element in response to detecting a fourth user input that meets second criteria (e.g., a fourth input that is directed to the third user interface element), enables display of the first user interface element (e.g., and access to functionality associated with the first affordance of the first user interface element) without needing to display the first user interface element at all times (e.g., the third user interface element is a small and unobtrusive user interface element, while the first user interface element is a larger user interface element, which is only displayed when needed (e.g., when the user performs a user input directed to the third user interface element)), which improves the level of immersion while using the computer system by displaying user interface elements only when needed.

In some embodiments, the fourth user input that meets the second criteria includes a gaze input directed to the third user interface element (e.g., a gaze input that remains within a threshold distance of the third user interface element for more than a threshold amount of time). For example, in FIGS. 7D-7E and FIGS. 7Y-7Z, the system function menu 7024 is displayed in response to detecting a user input that meets specific criteria (e.g., a user input directed to the indicator 7010 of system function menu). For example, in the above descriptions of FIG. 7E and FIG. 7Z, in some embodiments, the specific criteria are met when the user 7002′s gaze is continuously directed to the indicator 7010 of system function menu (e.g., for a threshold amount of time). Displaying a third user interface element, before displaying the first user interface element, and displaying the first user interface element in response to detecting a fourth user input that includes a gaze input directed to the third user interface element, enables display of the first user interface element (e.g., and access to functionality associated with the first affordance of the first user interface element) without needing to display the first user interface element at all times (e.g., the third user interface element is a small and unobtrusive user interface element, while the first user interface element is a larger user interface element, which is only displayed when needed (e.g., when the user’s gaze is directed to the third user interface element)), which augments the level of immersion while using the computer system by displaying user interface elements only when needed.

In some embodiments, the fourth user input includes a hand gesture (e.g., an air gesture (e.g., an air tap or an air pinch), a tap gesture, a pinch gesture, and/or other gestures) performed in conjunction with (e.g., within a threshold amount of time before, within a threshold amount of time after, or concurrently with) a gaze input directed to the third user interface element. For example, in FIGS. 7D-7E and FIGS. 7Y-7Z, the system function menu 7024 is displayed in response to detecting a user input that meets specific criteria (e.g., a user input directed to the indicator 7010 of system function menu). For example, in the descriptions of FIG. 7E and FIG. 7Z above, in some embodiments, the specific criteria are met when the user 7002 gazes at the indicator 7010 of system function menu and brings a hand into a specified configuration (e.g., a ready state configuration). Displaying a third user interface element, before displaying the first user interface element, and displaying the first user interface element in response to detecting a fourth user input that includes a hand gesture performed in conjunction with a gaze input directed to the third user interface element, enables display of the first user interface element (e.g., and access to functionality associated with the first affordance of the first user interface element) without needing to display the first user interface element at all times (e.g., the third user interface element is a small and unobtrusive user interface element, while the first user interface element is a larger user interface element, which is only displayed when needed (e.g., when the user performs a hand gesture while the user’s gaze is directed to the third user interface element)), which augments the level of immersion while using the computer system by displaying user interface elements only when needed.

In some embodiments, the first user interface element includes a second affordance different from the first affordance. In some embodiments, while the second user interface element is at the third position in the three-dimensional environment (e.g., visible within the currently displayed view, or outside of the currently displayed view), the computer system displays the first user interface element at a fifth position in the three-dimensional environment (e.g., in response to a gaze input directed to the third user interface element, or a combination of a gaze input directed to the third user interface element and a pinch or tap gesture), wherein the first user interface element displayed at the fifth position (and with a respective orientation) has the first spatial relationship to the third viewpoint of the user (e.g., the first user interface element is viewpoint locked and moves with the viewpoint). In some embodiments, while the second user interface element is at the third position in the three-dimensional environment and while the first user interface element is displayed at the fifth position in the three-dimensional environment, the computer system detects a seventh user input that corresponds to activation of the second affordance. In some embodiments, in response to detecting the seventh user input that corresponds to activation of the second affordance, the computer system displays a fourth user interface element (e.g., a search user interface, a home user interface, a control panel user interface, a notification user interface, and/or a multitasking user interface, any of the user interfaces described herein that is different from the second user interface element) at a sixth position in the three-dimensional environment, wherein the fourth user interface element is different from the second user interface element. For example, in some embodiments. different user interfaces (e.g., system level user interfaces, application-level user interfaces, experiences, and/or communication user interfaces) are optionally displayed as world locked user interfaces in response to activation of respective affordances displayed in the first user interface element.

For example, in FIG. 7AC-7AD, while the user interface 7136 is visible in the view of the three-dimensional environment, the user can activate a second affordance (e.g., the home affordance 7124), and in response, the computer system displays the user interface 7146 (e.g., while optionally maintaining display of the user interface 7136). Displaying a fourth user interface element at a sixth position in the three-dimensional environment, in response to detecting the seventh user input that corresponds to activation of the second affordance, reduces the number of user inputs needed to display the appropriate user interface elements (e.g., the user does not need to perform additional user inputs to first cease display of the second user interface element).

In some embodiments, the seventh user input is detected while the first user interface element and the second user interface element are concurrently visible in a currently displayed view of the three-dimensional environment (e.g., the third view of the three-dimensional environment, the second view of the three-dimensional environment, or another view of the three-dimensional environment that corresponds to the current viewpoint of the user). For example, in FIG. 7AC-7AD, the system function menu 7024 is displayed concurrently with the user interface 7136, when the user’s gaze is detected at the location corresponding to the home affordance 7124 (e.g., which initiates display of the user interface 7146). Detecting the seventh user input while the first user interface element and the second user interface element are concurrently visible in a currently displayed view of the three-dimensional environment reduces the number of inputs needed to display the fourth user interface element (e.g., the user does not need to perform additional user inputs to redisplay first user interface element in order to activate the second affordance).

In some embodiments, the computer system ceases to display the second user interface element in response to detecting the seventh user input (e.g., replaces display of the second user interface element at the third position in the three-dimensional environment with display of the fourth user interface element at the third position in the three-dimensional environment; or ceases display of the second user interface element at the third position in the three-dimensional environment, and displays the fourth user interface element at the sixth position in the three-dimensional environment). In some embodiments, the fourth user interface element has properties (e.g., movement and/or appearance properties) and user interactions (e.g., activation, navigation, switching, and/or scrolling) analogous to those described herein with respect to the second user interface element, which are not repeated in the interest of brevity.

For example, in the description of FIG. 7AD above, in some embodiments, displaying the user interface 7146 includes ceasing to display the user interface 7136 (e.g., the user interface 7146 replaces the user interface 7136). Displaying a fourth user interface element different from the second user interface element and ceasing to display the second user interface element in response to detecting the seventh user input, in response to detecting the seventh user input, replaces display of the second user interface element with the fourth user interface element without requiring further user input (e.g., the user does not need to perform additional user inputs to manually cease display of the second user interface element).

In some embodiments, while displaying the first view of the three-dimensional environment, including displaying the first user interface element at the first position and displaying the second user interface element at the second position in the three-dimensional environment, the computer system detects third movement of the viewpoint of the user from the first viewpoint to a fourth viewpoint. In some embodiments, in response to detecting the third movement of the viewpoint of the user from the first viewpoint to the fourth viewpoint, the computer system displays a fourth view of the three-dimensional environment that corresponds to the fourth viewpoint of the user, and the computer system displays the first user interface element at a seventh position in the three-dimensional environment, wherein the first user interface element has the first spatial relationship with the fourth viewpoint of the user (e.g., the first user interface element is viewpoint locked, and/or head locked) while the first user interface element is displayed at the seventh position in the three-dimensional environment. The computer system displays the second user interface element at the second position in the three-dimensional environment (e.g., the second user interface element is world locked to the three-dimensional environment).

For example, in FIG. 7AE-7AF, the user interface 7136 and the user interface 7146 remain displayed at the same position in the three-dimensional environment (e.g., are environment-locked) while the indicator 7010 of system function menu (e.g., and the system function menu 7024, if it were to be continuously displayed during the user 7002′s movement from the location 7026-d to the location 7026-e) are displayed at respective positions in the three-dimensional environment that have the first spatial relationship with the fourth viewpoint of the user (e.g., the indicator 7010 of system function menu and the system function menu 7024 are head-locked/viewpoint-locked). Displaying the first user interface element at a seventh position in the three-dimensional environment that has the first spatial relationship with the fourth viewpoint of the user, and displaying the second user interface element at the second position in the three-dimensional environment, in response to detecting third movement of the viewpoint of the user from the first viewpoint to the fourth viewpoint, displays the respective user interface elements at the appropriate positions in the three-dimensional environment without requiring further user input (e.g., the user does not need to perform additional user inputs to reposition the first user interface element and/or the second user interface element each time the user moves).

In some embodiments, aspects/operations of methods 8000, 9000, 10000, 11000, 12000, 13000, 14000, 15000, and 16000 may be interchanged, substituted, and/or added between these methods. For example, the first user interface object (e.g., system control indicator) in the method 11000 in some circumstances has a different appearance as described in the methods 9000-10000, and 12000-16000, and the user interface elements that are displayed (e.g., the plurality of affordances for accessing system functions of the first computer system) may be replaced by, or concurrently displayed with, other user interface elements (e.g., additional content associated with a notification, a user interface that includes an affordance for joining a communication session, and other user interface elements in the methods 9000-10000, and 12000-16000). For brevity, these details are not repeated here.

FIG. 12 is a flow diagram of an exemplary method 12000 for initiating display of a user interface in response to detecting that a user’s attention is directed to a respective region in a three-dimensional environment. The method 12000 is performed at a computer system (e.g., computer system 7100 and/or computer system 101) that is in communication with a first display generation component (e.g., a first display generation component of a two-sided display generation component, a heads-up display, a head-mounted display (HMD), a display, a touchscreen, a projector, a standalone display, and/or a display that is enclosed in the same housing as another display generation component of the same type or a different type) and one or more input devices (e.g., cameras, controllers, touch-sensitive surfaces, joysticks, buttons, gloves, watches, motion sensors, and/or orientation sensors). In some embodiments, the first display generation component is a display component facing the user and provides an XR experience to the user. In some embodiments, the first display generation component includes two or more display components (e.g., one set for each eye) that display slightly different images to form a stereoscopic view of the three-dimensional environment. In some embodiments, the first display generation component and a second display generation component form a two-sided display device (e.g., a two-sided HMD) that displays a first user interface on a first side corresponding to the first display generation component, and a second user interface on the second side corresponding to the second display generation component. In some embodiments, the second display generation component is a display component facing away from the user and toward an external environment of the user and optionally provides status information related to the first display generation component (e.g., displayed content and/or operational state) and/or the user (e.g., movement of the user’s eyes, and/or attention state of the user) to other users in the external environment. In some embodiments, the computer system is an integrated device with one or more processors and memory enclosed in the same housing as the first and the second display generation components and at least some of the one or more input devices. In some embodiments, the computer system includes a computing component (e.g., a server, a mobile electronic device such as a smart phone or tablet device, a wearable device such as a watch, wristband, or earphones, a desktop computer, or a laptop computer) that includes one or more processors and memory that is separate from the display generation component(s) and/or the one or more input devices. In some embodiments, the display generation component(s) and the one or more input devices are integrated and enclosed in the same housing.

Displaying (e.g., based on the attention criteria) a first user interface object, in response to detecting a first user input that includes a first gaze input directed to a first position, and in accordance with a determination that the first position in the three-dimensional environment has a first spatial relationship to a viewport through which the three-dimensional environment is visible, and forgoing displaying the first user interface object in the first view of the three-dimensional environment, in accordance with a determination that the first position in the three-dimensional environment does not have the first spatial relationship to the viewport through which the three-dimensional environment is visible, reduces the number of inputs needed to access system functions of the computer system without cluttering the user interface with additional displayed controls, user interfaces, and/or user interface objects.

While a first view of a three-dimensional environment is visible via the first display generation component, the computer system detects (12002), via the one or more input devices, a first user input (e.g., a gaze input represented by the user’s attention 7116 in FIG. 7AM), including detecting a first gaze input that is directed to a first position (e.g., a position in the three-dimensional environment that is not currently occupied by any user interface object, or a position that does not include a user interface object that is responsive to the first user input, even if there are currently one or more objects that are not responsive to the first user input located at the position) in the three-dimensional environment (e.g., the user’s attention 7116 directed to a location in the region 7158, in FIG. 7AM).

In response to detecting (12004) the first user input including detecting the first gaze input, and in accordance with a determination that the first position in the three-dimensional environment has a first spatial relationship to a viewport (e.g., the display of the computer system 7100 in FIG. 7AM) through which the three-dimensional environment is visible (e.g., a determination that the first position is represented in a first region of the field of view provided by the first display generation component (e.g., in the upper left corner, top center region, lower right corner, peripheral region, or other preselected region of the field of view) (e.g., the region 7160 in FIG. 7AM, which is in the upper right corner of the display of the computer system 7100), while the first view of the three-dimensional environment is visible in the field of view), the computer system displays (12006) a first user interface object (e.g., the system function menu 7024 described with reference to FIGS. 7E and 7AM) in the first view of the three-dimensional environment, wherein the first user interface object includes one or more affordances for accessing a first set of functions of the first computer system (e.g., a first set of system functions, such as accessing a home user interface, a settings user interface, a notification center, or a control panel user interface, a digital assistance user interface), wherein the first user interface object is displayed at a second position in the three-dimensional environment that has a second spatial relationship, different from the first spatial relationship, to the viewport through which the three-dimensional environment is visible. In some embodiments, the second position is offset from the first position in a first direction (e.g., downward, upward, leftward, rightward). In some embodiments, the first position is a position inside a first region and the second position is a position inside a second region that is different from the first region. In some embodiments, when a user interface object is said to be displayed at a respective position, a characteristic point (e.g., center, top center, upper left corner, or another preselected point) on the user interface object is located at the respective position. In some embodiments, when a user interface object is said to be displayed at a respective position, a characteristic portion of the user interface object is aligned with a horizontal or vertical line that passes through the respective position. In some embodiments, the first user interface object is displayed at a position that is directly below the position of the first gaze input (e.g., when the first position is in the top center of the field of view). In some embodiments, the first user interface object is displayed at a position that is shifted toward the interior portion of the field of view relative to the position of the first gaze input (e.g., when the first position is in a peripheral region of the field of view).

In response to detecting the first user input including detecting the first gaze input, and in accordance with a determination that the first position in the three-dimensional environment does not have the first spatial relationship to the viewport through which the three-dimensional environment his visible (e.g., a determination that the first position is not represented in the first region of the field of view provided by the first display generation component (e.g., in the upper left corner, top center region, lower right corner, peripheral region, or other preselected region of the field of view), while the first view of the three-dimensional environment is visible in the field of view), the computer system forgoes (12008) displaying the first user interface object in the first view of the three-dimensional environment (e.g., in FIG. 7AG, the user’s attention 7116 is not directed to a location in the region 7158 or the region 7160, and the system function menu 7024 is not displayed). In some embodiments, the first user interface object is not displayed in the first view of the three-dimensional environment until a gaze input that is directed to a position that has the first spatial relationship to the first view of the three-dimensional environment has been detected. Not requiring a user interface object to be displayed persistently in the currently displayed view of the three-dimensional environment, and displaying the user interface object on demand based on whether a user input is directed at a first position in the field of view that has the first spatial relationship to the currently displayed view, helps to keep the field of view less cluttered and allows the user to view other content in the field of view more clearly.

In some embodiments, while the first user interface object is not visible in a currently displayed view (e.g., the first view or another view displayed after the first view) of the three-dimensional environment (e.g., after the first user interface object is dismissed from the first view of the three-dimensional environment), the computer system detects a first change of a viewpoint of a user from a first viewpoint associated with the first view of the three-dimensional environment to a second viewpoint associated with a second view of the three-dimensional environment (e.g., based on movement of at least a portion of the computer system and/or a movement of a portion of the user which is the basis for determining the viewpoint of the user). In response to detecting the first change in the viewpoint of the user, the computer system updates the currently displayed view of the three-dimensional environment in accordance with the first change in the viewpoint of the user, to display the second view of the three-dimensional environment; In some embodiments, the change in the current viewpoint of the user (e.g., from the first viewpoint to the second viewpoint) is accomplished by moving the first display generation component and/or the one or more cameras in the physical environment, and/or movement of the user (e.g., turning, walking, running, and/or tilting the head up or down) in the physical environment that change the pose (e.g., position and/or facing direction) of the user relative to the three-dimensional environment. While the second view of the three-dimensional environment is visible via the first display generation component, the computer system detects, via the one or more input devices, a second user input, including detecting a second gaze input that is directed to a third position, different from the first position, in the three-dimensional environment. In response to detecting the second user input including detecting the second gaze input and in accordance with a determination that the third position in the three-dimensional environment has the first spatial relationship to the viewport through which the three-dimensional environment is visible (e.g., a determination that the third position is represented in the first region of the field of view provided by the first display generation component (e.g., in the upper left corner, top center region, lower right corner, peripheral region, or other preselected region of the field of view), while the second view of the three-dimensional environment is visible in the viewport), the computer system displays the first user interface object in the second view of the three-dimensional environment, at a fourth position in the three-dimensional environment that has the second spatial relationship to the second view of the three-dimensional environment; and In some embodiments, the fourth position is offset from the third position in the second view in the same manner as how the second position is offset from the first position in the first view. In response to detecting the second user input including detecting the second gaze input and in accordance with a determination that the third position in the three-dimensional environment does not have the first spatial relationship to the viewport through which the three-dimensional environment is visible (e.g., a determination that the second position is not represented in the first region of the field of view provided by the first display generation component (e.g., in the upper left corner, top center region, lower right corner, peripheral region, or other preselected region of the field of view), while the second view of the three-dimensional environment is visible in the viewport), the computer system forgoes displaying the first user interface object in the second view of the three-dimensional environment. In some embodiments, the first user interface object is not displayed in the second view of the three-dimensional environment until a gaze input that is directed to a position that has the first spatial relationship to the second view of the three-dimensional environment has been detected.

For example, as described with reference to FIG. 7AG, in some embodiments, the region 7158 and the region 7160 are viewpoint-locked regions and exhibit analogous behavior to the indicator 7010 of system function menu and/or the system function menu 7024 (which are also viewpoint-locked, as described above with reference to, and as shown in, FIGS. 7A-7D and/or FIGS. 7E-7G). Displaying the first user interface object in the second view of the three-dimensional environment, at a fourth position that has the second spatial relationship to the second view in the three-dimensional environment, in accordance with a determination that a third position in the three-dimensional environment has a first spatial relationship to a viewport through which the three-dimensional environment is visible, and forgoing displaying the first user interface object in the second view of the three-dimensional environment, in accordance with a determination that the third position in the three-dimensional environment does not have the first spatial relationship to the viewport through which three-dimensional environment is visible, while the second view of the three-dimensional environment is visible, enables the computer system to display the first user interface object at a consistent position (e.g., regardless of what view of the three-dimensional environment is visible, a user can trigger display of the first user interface object by directing the user’s attention to a location that has the first spatial relationship to the viewport through which the current view of the three-dimensional is visible). This also reduced the number of user inputs needed to display the first user interface object in the second view of the three-dimensional environment (e.g., the user does not need to reposition another user interface object displayed at the first position in the first view, when the viewpoint of the user changes), and enables the computer system to display the first user interface object without needing to display additional controls (e.g., the computer system does not need to display another user interface object (e.g., that the user would need to constantly reposition or re-locate each time the viewpoint of the user changes) at the first position that the user must interact with to display the first user interface object).

In some embodiments, in response to detecting the first user input including detecting the first gaze input: in accordance with a determination that the first position in the three-dimensional environment does not have the first spatial relationship to the viewport through which the three-dimensional environment is visible (e.g., a determination that the first position is not represented in the first region of the field of view provided by the first display generation component (e.g., in the upper left corner, top center region, lower right corner, peripheral region, or other preselected region of the field of view), while the first view of the three-dimensional environment is visible in the viewport) and that a second user interface object, different from the first user interface object, occupies the first position in the three-dimensional environment, the computer system performs a respective operation that corresponds to the second user interface object. In some embodiments, the second user interface object is an application user interface of a respective application or an affordance within the application user interface, and the first computer system performs an operation within the respective application (e.g., including updating the content included in the application user interface, displaying additional user interface objects in the three-dimensional environment, ceasing to display the first user interface object, and other operations of the respective application)). In some embodiments, the second user interface object is an object that accepts the first user input as a valid or reacts to the first user input, and the first computer system performs the operation in accordance with the instructions associated with the second user interface object for the input type and characteristics of the first user input.

For example, as described with reference to FIG. 7AG, if the user’s attention 7116 is not directed to either the region 7158 or the region 7160, but the user’s attention 7116 is directed to a displayed user interface (e.g., an application-launch user interface, an application user interface, or a system space) (e.g., in conjunction with an air gesture (e.g., an air tap or an air pinch), an input from a hardware controller, and/or a verbal input), the computer system performs an operation corresponding to the displayed user interface (e.g., launches and application, performs an application-specific operation, or adjusts a system setting for the computer system 7100). Performing a respective portion that corresponds to the second user interface object, different from the first user interface object, in accordance with a determination that the first position in the three-dimensional environment does not have the first spatial relationship to the viewport through which the three-dimensional environment is visible and that the second user interface object occupies the first position in the three-dimensional environment, reduces the number of user inputs needed to interact with the second user interface object (e.g., the user does not need to perform additional user inputs to move and/or cease to display the first user interface object, which may otherwise obstruct or obscure the second user interface object).

In some embodiments, while the first view of the three-dimensional environment is visible and the first user interface object is not displayed in the first view of the three-dimensional environment, the computer system detects a third user input that includes a third gaze input that is directed to a fifth position in the three-dimensional environment (e.g., the third user input precedes the first user input, and optionally, the first user input is a continuation of the third user input (e.g., the gaze of the user moves from the fifth position to the first position)). In response to detecting the third user input that includes the third gaze input: in accordance with a determination that the fifth position in the three-dimensional environment is within a first region that includes a respective position having the first spatial relationship to the viewpoint through which the three-dimensional environment is visible (e.g., the first region includes the respective position for triggering display of the first user interface object and a respective area or volume surrounding the respective position (e.g., a rectangular area, a spherical volume, or other shapes, with respective boundaries relative to the respective position)), the computer system displays a third user interface object (e.g., a visual indicator (e.g., the indicator 7010 of system function menu of FIG. 7A and FIG. 7AM) that, when activated with a gaze input, causes the first computer system to display the first user interface object at the second position in the three-dimensional environment) at the respective position in the three-dimensional environment; and in accordance with ga determination that the fifth position in the three-dimensional environment is not within the first region that includes the respective position having the first spatial relationship to the viewport through which the three-dimensional environment is visible, the computer system forgoes displaying the third user interface object at the respective position in the three-dimensional environment. In some embodiments, once the third user interface object is displayed at the respective position that has the first spatial relationship to the viewport through which the three-dimensional environment is visible, the first computer system displays the first user interface object in response to detecting the first user input that includes the first gaze input that is directed to the respective position. In some embodiments, displaying the third user interface object is further in accordance with a determination that user interface objects associated with an application is not currently displayed at the fifth position in the three-dimensional environment. In accordance with a determination that a user interface object associated with an application is currently displayed at the fifth position in the three-dimensional environment, the first computer system forgoes displaying the third user interface object (e.g., the indicator 7010 of system function menu of FIG. 7A and FIG. 7AM) at the respective position that the respective position that has the first spatial relationship to the viewport through which the three-dimensional environment is visible. In some embodiments, the “third user interface object” described herein has the characteristics and/or behaviors of the indicator 7010 of system function menu or the “first user interface object” as describe with respect to FIGS. 7B-7D, and these characteristics and/or behaviors are not repeated herein in the interest of brevity.

For example, in FIG. 7AM, the user’s attention is directed to a location within the region 7158 (e.g., a location within the region 7160) (e.g., the location of the indicator 7010 of system function menu), and in response, the computer system 7100 displays the system function menu 7024. In FIGS. 7AK and 7AL, the user’s attention 7116 is not directed to the location within the region 7158 (e.g., in FIG. 7AK, the user’s attention 7116 is not directed to a location in the region 7158 at all; and in FIG. 7AL, the user’s attention 7116 is directed to a different location within the region 7158 that is different from the location of the indicator 7010 of system function menu), and so the system function menu 7024 is not displayed. Displaying a third user interface object at the respective position in the three-dimensional environment in accordance with a determination that the fifth position in the three-dimensional environment is within a first region that includes a respective position having the first spatial relationship to the viewport through which the three-dimensional environment is visible, and forgoing display of the third user interface object at the respective position in the three-dimensional environment in accordance with a determination that the fifth position in the three-dimensional environment is not within the first region that includes the respective position having the first spatial relationship to the viewport through which the three-dimensional environment is visible, provides improved visual feedback to the user (e.g., improved visual feedback that the computer system detects the user’s attention directed to the fifth position in the three-dimensional environment, and/or improved visual feedback that additional functionality and/or user interaction is possible).

In some embodiments, the first region includes a first subregion including the respective position that has the first spatial relationship to the viewpoint through which the three-dimensional environment is visible and a second subregion (e.g., a region surrounding the first subregion, or adjacent to the first subregion) that does not include the respective position. For example, in some embodiments, the first region is a rectangular region in the field of view that encloses a smaller circular region, where the gaze input directed to the rectangular region outside of the smaller circular region causes the first computer system to, optionally, display a visual indicator inside the smaller circular region, and a gaze input directed to the visual indicator or the smaller circular region (e.g., with, or without the visual indicator inside) causes the first computer system to display the first user interface object that includes the affordances for the set of functions. For example, in FIG. 7AH the first region includes a first subregion (e.g., the region 7160) that has the first spatial relationship to the first view of the three-dimensional environment, and a second subregion (e.g., the portions of the region 7158 that do not include the region 7160) that does not include the respective position (e.g., the position of the indicator 7010 of system function menu in FIG. 7AM). Displaying a third user interface object at the respective position in the three-dimensional environment in accordance with a determination that the fifth position in the three-dimensional environment is within a first region that includes a first subregion that includes the respective position that has the first spatial relationship to the viewport through which the three-dimensional environment is visible, and forgoing display of the third user interface object at the respective position in the three-dimensional environment in accordance with a determination that the fifth position in the three-dimensional environment is not within the first region that includes the respective position having the first spatial relationship to the viewport through which the three-dimensional environment is visible, provides improved visual feedback to the user (e.g., improved visual feedback that the computer system detects the user’s attention directed to the fifth position in the three-dimensional environment, and/or improved visual feedback that additional functionality and/or user interaction is possible).

In some embodiments, displaying the first user interface object at the second position in response to detecting the first user input including the first gaze input is further in accordance with a determination that the first gaze input is maintained within the first subregion for at least a first threshold amount of time (e.g., at the first position, on the second user interface object, and/or within a threshold distance of the first position). In some embodiments, if the first gaze input moves outside of the first subregion before the first threshold amount of time is reached, the first computer system does not display the first user interface object at the second position in the three-dimensional environment. In some embodiments, if the first gaze input moves outside of the first subregion before the first threshold amount of time is reached but the first computer system detects another confirmation gesture while the first gaze input is maintained on the first subregion, the first computer system still displays the first user interface object at the second position in the three-dimensional environment. For example, as described with reference to FIG. 7AH, in some embodiments, the computer system 7100 displays the indicator 7010 of system function menu in response to detecting that the user’s attention 7116 has been directed to the location within the region 7160 for a threshold amount of time (e.g., 0.1, 0.2, 0.5, 1, 2, 5, 10, 30, or 60 seconds). Displaying a third user interface object at the respective position in the three-dimensional environment in accordance with a determination that the fifth position in the three-dimensional environment is within a first region that includes a first subregion that includes the respective position that has the first spatial relationship to the viewport through which the three-dimensional environment is visible and in accordance with a determination that the first gaze input is maintained within the first subregion for at least a first threshold amount of time, and forgoing display of the third user interface object at the respective position in the three-dimensional environment in accordance with a determination that the fifth position in the three-dimensional environment is not within the first region that includes the respective position having the first spatial relationship to the viewport through which the three-dimensional environment is visible, provides improved visual feedback to the user (e.g., improved visual feedback that the computer system detects the user’s attention directed to the fifth position in the three-dimensional environment, and/or improved visual feedback that additional functionality and/or user interaction is possible).

In some embodiments, while the first user interface object is not visible in the first view of the three-dimensional environment (e.g., after the first user interface object is dismissed from the first view of the three-dimensional environment), the computer system detects, via the one or more input devices, a fourth user input, including detecting a fourth gaze input that is directed to the first subregion and that has not been maintained within the first subregion for at least the first threshold amount of time. In response to detecting the fourth user input including the fourth gaze input, and in accordance with a determination that a respective gesture meeting first criteria has been detected while the fourth gaze input is maintained in the first subregion, the computer system displays the first user interface object at the second position in the three-dimensional environment (e.g., if a pinch gesture is detected while the user gazes at the smaller region or the indicator (e.g., of system function menu), the first computer system displays the first user interface object before the first threshold amount of time is reached). In some embodiments, in response to detecting the fourth user input, in accordance with a determination that a respective gesture meeting the first criteria has not been detected while the fourth gaze input is maintained in the first subregion, the first computer system forgoes displaying the first user interface object at the second position in the three-dimensional environment before the third gaze input has been maintained in the first subregion for at least the first threshold amount of time. In some embodiments, the first position of the three-dimensional environment that has the first spatial relationship to the viewport through which the three-dimensional environment is visible while the viewport through which the three-dimensional environment is visible, is a representative of a respective position that has the first spatial relationship to the viewport through which the three-dimensional environment is visible; and the second position that has the second spatial relationship to the first view of the three-dimensional environment while the first view of the three-dimensional environment is visible, is a representative of a respective position that has the second spatial relationship to the viewport through which the three-dimensional environment is visible. The respective positions represented by the first position and the second position are updated as the currently displayed view is updated based on the changes in the viewpoint of the user. For example, as described with reference to FIG. 7AJ, while the user’s attention 7116 is directed to the region 7160 (or the indicator 7010 of system function menu), the user can perform a gesture (e.g., an air gesture, such as an air tap or an air pinch, or another selection input) to display system function menu 7024. Displaying the first user interface object at the second position in the three-dimensional environment in response to detecting the fourth user input and in accordance with a determination that a respective gesture meeting first criteria has been detected while the fourth gaze input is maintained in the first subregion, enables the computer system to display the first user interface object without displaying additional controls (e.g., additional controls for displaying the first user interface object and/or third user interface object).

In some embodiments, the first user interface object includes a respective system user interface (e.g., the system function menu 7024 of FIG. 7E and 7AM, and/or a menu that includes items that, when selected, causes the first computer system to perform and/or display user interfaces for one or more system functions) for accessing one or more system functions of the first computer system (e.g., the first user interface object is, or includes, respective affordances for accessing other system user interfaces such as a home user interface, a notification user interface, a search user interface, a multitasking user interface, and/or control panel user interface, as described above (e.g., with reference to FIGS. 7H-7I, FIG. 7K, and FIG. 7AA). In some embodiments, a system user interface refers to a user interface that is displayed and accessible in the three-dimensional environment, irrespective of the applications that are active in the three-dimensional environment. In some embodiments, the first user interface object described herein has the characteristics and/or behaviors of the system function menu 7024 or the object including the plurality of affordances for accessing system functions of the first computer system as describe with respect to FIGS. 7B-7G, and these characteristics and/or behaviors are not repeated herein in the interest of brevity. For example, in FIG. 7AM, the first user interface object is the system function menu 7024, which is the same system function menu 7024 described with reference to FIGS. 7E, 7J (e.g., showing user interaction with various affordances of the system function menu 7024), and 7 K (e.g.., showing functionality associated with the various affordance of the system function menu 7024). Displaying the first user interface object that includes a respective system user interface for accessing one or more system functions of the first computer system, in the second view of the three-dimensional environment, at a fourth position that has the second spatial relationship to the second view in the three-dimensional environment, in accordance with a determination that the third position in the three-dimensional environment has the first spatial relationship to the viewport through which three-dimensional environment is visible, enables the computer system to provide access to system functions without needing to display additional controls (e.g., additional controls for displaying the respective system user interface, or one or more affordances for accessing system functions of the computer system) and without needing to persistently display the first user interface object and/or the respective system user interface.

In some embodiments, while displaying the first user interface object, in the first view of the three-dimensional environment, at the second position in the three-dimensional environment that has the second spatial relationship to the first view of the three-dimensional environment, the computer system detects that user attention is no longer directed to the first user interface object (e.g., the first gaze input is no longer directed to and/or has moved away from the first position, the first subregion, and/or the first user interface object, in the three-dimensional environment). In response to detecting that the user attention is no longer directed to the first user interface object (e.g., for at least a threshold duration of time, such as 1 second, 5 seconds, 10 seconds, or 30 seconds), the computer system ceases to display the first user interface object in the first view of the three-dimensional environment. In some embodiments, the first view is a representative of a currently displayed view, and the behavior of the first computer system is analogous to what is described with respect to the first view, when another view is the currently displayed view of the three-dimensional environment. For example, this is described with reference to FIG. 7AM, where the computer system ceases to display the system function menu 7024 in response to detecting that the user’s attention 7116 is not directed to the system function menu 7024 (and/or the indicator 7010 of system function menu, and/or the region 7160) (e.g., for a threshold amount of time (e.g., 0.1, 0.2, 0.5, 1, 2, 5, 10, 30, or 60 seconds)). Ceasing to display the first user interface object in the first view of the three-dimensional environment in response to detecting that the user attention is no longer directed to the first user interface object, enables the computer system to cease to display the first user interface object without needing to display additional controls (e.g., additional controls for ceasing to display the first user interface object), and allows the user to easily display or cease displaying the first user interface object so that the first user interface object does not need to be persistently displayed (e.g., even when the first user interface object is not relevant).

In some embodiments, the determination that the first position in the three-dimensional environment has the first spatial relationship to the viewport through which the three-dimensional is visible environment includes a determination that the first position is within a first response region of a first size, and detecting that the attention of the user is no longer directed to the first position in the three-dimensional environment includes detecting that the user attention has moved from within the first response region (e.g., to within the second response region and then) to outside of a second response region of a second size that is different from (e.g., larger, or smaller) the first size. In some embodiments, the second response region encloses the first response region entirely or partially. In some embodiments, the first response region corresponds to the first region used to trigger the display of the first user interface object (e.g., the system function menu 7024 of FIG. 7E and FIG. 7AM, and/or system menu) and the second response region corresponds to the first subregion used to trigger display of the third user interface object (e.g., the indicator 7010 of system function menu of FIG. 7A and FIG. 7AM, and/or visual indicator), and the second response region is larger than the first response region. In some embodiments, the first response region corresponds to the first subregion used to trigger the display of the first user interface object (e.g., the system function menu 7024, and/or system menu), and the second response region is different from the first region (including the first sub-region and a second sub-region) used to trigger display of the third user interface object (e.g., the indicator 7010 of system function menu, and/or visual indicator), and has a different size and boundary from the first subregion and the first region. In some embodiments, a visual indicator is not displayed prior to displaying the first user interface object, and the first response region for triggering display of the first user interface object is a smaller response region than the second response region for maintaining continued display of the first user interface object. For example, as described with reference to FIG. 7AM, in some embodiments (e.g., where the system function menu 7024 is displayed in response to detecting that the user’s attention 7116 is directed to the region 7160), the computer system 7100 ceases to display the system function menu 7024 in response to detecting that the user’s attention 7116 is directed to a location outside the larger region 7158. Displaying a first user interface object in the first view of the three-dimensional environment, in response to detecting the first user input that includes the first gaze input directed to the first position in the three-dimensional environment and in accordance with a determination that the first position has a first spatial relationship to the viewport through which the three-dimensional environment is visible and that the first position is within a first response region of a first size, and ceasing to display the first user interface object in the first view of the three-dimensional environment in response to detecting that the user attention has moved from within the first response region to outside of a second response region of a second size different from the first size, enables the computer system to display and/or cease to display the first user interface object without needing to display additional controls (e.g., additional controls for ceasing to display the first user interface object), and allows the user to easily display or cease displaying the first user interface object so that the first user interface object does not need to be persistently displayed (e.g., even when the first user interface object is not relevant).

In some embodiments, while displaying the first user interface object in the first view of the three-dimensional environment, the computer system detects a fourth user input including detecting gaze input directed to a respective affordance of the one or more affordances for accessing the first set of functions of the first computer system in conjunction with detecting a first speech input from a user. In response to detecting the fourth user input, the computer system performs a respective operation corresponding to the respective affordance in accordance with the first speech input. In some embodiments, in accordance with a determination that the respective affordance is a first affordance, the first computer system performs a first operation corresponding to the first affordance in accordance with the first speech input; and in accordance with a determination that the respective affordance is a second affordance, the first computer system performs a second operation corresponding to the second affordance in accordance with the first speech input. In some embodiments, in response to detecting the first speech input, the computer system displays a visual indication corresponding to the detected speech input (e.g., the computer system displays one or more words corresponding to, or detected in, the speech input). In some embodiments, the computer system re-performs (or continues performing) the function of the first computer system corresponding to the respective affordance if (or as) the speech input continues. For example, if the function of the first computer system is a search function, the computer system performs the search function once a first word (e.g., “Apple”) of the speech input is detected (e.g., displays search results corresponding to the first word “Apple” of the speech input). If the computer system detects that the speech input continues (e.g., the user continues to speak/provide the verbal user input), the computer system updates the displayed search results to display results corresponding to the new/updated speech input (e.g., “Apple Park”). In some embodiments, the visual appearance of the respective appearance changes in accordance with various characteristics of the first speech input, e.g., changes in brightness, color, and other visual properties in accordance with the pitch, volume, and/or other characteristics of the speech input, as the speech input is received. For example, as described with reference to FIG. 7AM, the user can speak a verbal input, and the computer system 7100 performs a function associated with the spoken verbal input (e.g., the computer system 7100 can perform a search function based on a spoken search term). This is also described with reference to the search affordance 7042 in FIG. 7K(b) and the virtual assistant affordance 7048 in FIG. 7K(e), both of which allow for spoken inputs (e.g., and provide visual feedback regarding the detection of verbal inputs). Performing a respective operation corresponding to a respective affordance in accordance with a first speech input, in response to detecting a fourth input that includes a gaze input directed to a respective affordance for accessing a first set of functions of the first computer system in conjunction with detecting the first speech input, enables the computer system to perform the respective operation without needing to display additional controls (e.g., additional controls for entering content (e.g., a search term) corresponding to the first speech input) and/or reduces the number of user inputs needed to perform an operation (e.g., the user can verbally instruct a virtual assistant of the computer system to perform the operation, instead of performing additional user inputs to navigate to and/or perform the respective function (e.g., by displaying one or more additional user interface that include an affordance for performing the operation).

In some embodiments, performing the respective operation corresponding to the respective affordance in accordance with the first speech input includes, in accordance with a determination that the respective affordance is an affordance for accessing a virtual assistant function of the first computer system, performing an operation corresponding to instructions contained in the first speech input (e.g., as interpreted by a virtual assistant corresponding to the virtual assistant function of the first computer system).In some embodiments, the first speech input includes instructions for performing a search (e.g., includes a spoken search term for an Internet search, or a search of documents and/or media stored in memory of the computer system), and the virtual assistant performs the search and presents a plurality of search results corresponding to the search. In some embodiments, the first speech input includes instructions for launching one or more applications (e.g., a music application, a notetaking application, or an alarm/timer/clock application), and the virtual assistant launches the one or more applications, and optionally performs an additional functions associated with the one or more applications (e.g., plays a song corresponding to a spoken song name included in the first speech input, creates a note including spoken information included in the first speech input, sets an alarm or timer based on a spoken time/time period included in the first speech input). In some embodiments, the first speech input includes instructions for initiating a communication session (e.g., a phone call, a video call, or a shared XR experience) with one or more other users, and the virtual assistant initiates the communication session (e.g., with the one or more other users, based on one or more spoken names and/or contact identifiers, included in the first speech input). In some embodiments, the first speech input includes instructions for sending a text or email message, and the virtual assistant sends the text or email message (e.g., to one or more other users, based on one or more spoken names and/or contact identifiers, included in the first speech input) (e.g., including a spoken message included in the first speech input). In some embodiments, the first speech input includes instructions for adjusting one or more settings of the computer system, and the virtual assistant adjusts the one or more settings (e.g., based on a spoken setting and/or desired adjustment (e.g., increasing a brightness of the display, lowering a volume of the computer system, and/or setting a do-not-disturb setting of the computer system)). For example, as described with reference to FIG. 7AM, the user can speak a verbal input instructing a virtual assistant of the computer system 7100 to perform a function of the computer system 7100. This is also described with reference to the virtual assistant affordance 7048 in FIG. 7K(e), which describes the virtual assistant performing a function for calling a user contact (e.g., John Smith, as described with reference to FIG. 7K(e)). Performing a respective operation corresponding to a respective affordance in accordance with a first speech input, in response to detecting a fourth input that includes a gaze input directed to a respective affordance for accessing a first set of functions of the first computer system in conjunction with detecting the first speech input, in accordance with a determination that the respective affordance is an affordance for accessing a virtual assistant of the first computer system, enables the computer system to perform the respective operation without needing to display additional controls (e.g., additional controls for entering content (e.g., a search term) corresponding to the first speech input) and/or reduces the number of user inputs needed to perform an operation (e.g., the user can verbally instruct a virtual assistant of the computer system to perform the operation, instead of performing additional user inputs to navigate to and/or perform the respective function (e.g., by displaying one or more additional user interface that include an affordance for performing the operation).

In some embodiments, performing the respective operation corresponding to the respective affordance in accordance with the first speech input includes, in accordance with a determination that the respective affordance is an affordance for accessing a text entry function (e.g., a search function, messaging function, or other functions accepting textual inputs) of the first computer system that accepts text input (e.g., a search term that is searched when the computer system performs the search function), providing text converted from the first speech input as input to the text entry function (e.g., and optionally displays visual feedback regarding the speech user input (e.g., displays text corresponding to the one or more words detected in the verbal user input in a search field, or other field configured to receive text)). For example, as described with reference to FIG. 7AM, the user can speak a verbal input, and the computer system 7100 displays a visual indication corresponding to the verbal input (e.g., text corresponding to the verbal input), and performs a search function based on a verbal input. This is also described with reference to the virtual assistant affordance 7048 in FIG. 7K(b), which describes displaying a text field (e.g., the system space 7050 of FIG. 7K(b)), which displays text of a search term or search query spoken by the user (e.g., detected from a verbal input of the user). Providing text converted from the first speech input as input to the text entry function and performing a respective operation corresponding to a respective affordance in accordance with a first speech input, in response to detecting a fourth input that includes a gaze input directed to a respective affordance for accessing a first set of functions of the first computer system in conjunction with detecting the first speech input, and in accordance with a determination that the respective affordance is an affordance for accessing a text entry function of the first computer system that accepts text input, enables the computer system to perform the respective operation without needing to display additional controls (e.g., additional controls for entering content (e.g., a search term) corresponding to the first speech input).

In some embodiments, while displaying the first view of the three-dimensional environment via the first display generation component, the computer system determines a current spatial relationship between the first display generation component and a user (e.g., which affects the current spatial relationship between the field of view and the eyes of the user). In some embodiments, the display generation component is a head-mounted display that is worn with various positions and/or with orientations (e.g., angle, relative to the user’s eyes or face) on the user’s head. In some embodiments, the display generation component is a handheld device, a watch, or other electronic device worn on the wrist, arm, or hand that has various spatial relationships to the user or a particular portion of the user (e.g., the user’s eyes, hand, wrist, or other relevant portions). In some embodiments, the first display generation component is a heads-up display that is mounted at different angles and/or orientations relative to the user. The computer system adjusts criteria for determining whether the respective position has the first spatial relationship to the viewport through which the three-dimensional environment is visible in accordance with the current spatial relationship between the first display generation component and the user (e.g., using different criteria for different spatial relationships). In some embodiments, in a first scenario, the first display generation component has a third spatial relationship to the user, and in a second scenario, the first display generation component has a fourth spatial relationship to the user, wherein the fourth spatial relationship differs from the third spatial relationship by an offset amount (e.g., in terms of distance, angles, and/or orientation); the respective position that meets the criteria for having the first spatial relationship to the first view would appear in different portions of the field of view provided by the first display generation component, such that the user does not have to strain uncomfortably to look at the same position to invoke the first user interface object irrespective of how the first display generation component is placed relative to the user. In a more specific example where the first display generation component is a head-mounted display that can be worn and/or positioned different for different users (e.g., in order to achieve a light seal around the user’s eyes and/or face, and/or due to different physical features or geometry of different users’ faces). If the head-mounted display sits further out on the user’s nose, the display of the head-mounted display is lower, relative to the user’s eyes (e.g., as compared to if the head-mounted display sat at a position on the user’s nose that was closer to the user’s face). If a default first spatial relationship required the first position to be a first distance from a top edge of the display, the computer system accommodates for the user’s particular way of wearing the head-mounted display by adjusting the criteria for determining whether the respective position has the first spatial relationship to the field of view, and requiring the first position to be a second distance (e.g., that is less than the first distance) from the top edge of the display, in accordance with some embodiments. Stated differently, if the first spatial relationship required the user’s attention to be directed to a first reactive region in the displayed field of view of the three-dimensional environment by default, the computer system accommodates for the user’s particular way of wearing the head-mounted display by moving the first reactive region upwards (e.g., relative to the display of the display generation component itself). In some embodiments, the first reactive region is adjusted upwards, downwards, to the left, and/or to the right, depending on position of the computer system (e.g., how a head-mounted display is worn) relative to the body or eyes of the user who is in a position to view the three-dimensional environment via the display generation component. In some embodiments, the amount of adjustment is comparatively small (e.g., to accommodate for natural asymmetry of the user’s face). In some embodiments, the amount of adjustment is comparatively large (e.g., to accommodate intentional user choices regarding how the computer system is worn and/or positioned). For example, as described with reference to FIG. 7AH, the location of the indicator 7010 of system function menu is selected at least in part based on a position of the user relative to the computer system 7100 (e.g., the computer system 7100 is a HMD, and detects that the head-mounted display sits lower on the user’s face than another user (or lower than a default or average height), and the computer system 7100 displays the indicator 7010 of system function menu at an adjusted location (e.g., closer to the top edge of the display). Adjusting criteria for determining whether the respective position has the first spatial relationship to the viewport through which the three-dimensional environment is visible, in accordance with the current spatial relationship between the first display generation component and the user, automatically adjust the criteria for determining whether the respective position has the first spatial relationship without further user input (e.g., the user does not need to perform addition user input to adjust the criteria for determining whether the respective position has the first spatial relationship).

In some embodiments, in accordance with a determination that the current spatial relationship between the first display generation component and the user no longer meets alignment criteria (e.g., based on the determined current spatial relationship between the first display generation component and the user) (e.g., the computer system is located beyond a threshold distance from the user, the computer system is positioned with too large an angle relative to the user, a head-mounted display is worn too high, too low, or too far to the right or left, relative to the user’s eyes or face, and/or a head-mounted display tilts too far forwards or backwards (e.g., because the head-mounted display is worn too loosely on the user’s head)), the computer system displays a second visual indication that the current spatial relationship between the first display generation component and the user no longer meets the alignment criteria. In some embodiments, the second visual indication further instructs the user to change the current spatial relationship between the first display generation component and the user. In some embodiments, the first computer generated component forgoes displaying the first user interface object until the alignment criteria are met after adjustment to the current spatial relationship between the first display generation component and the user. For example, as described with reference to FIG. 7AH, if the adjusted location of the indicator 7010 of system function menu would require the indicator 7010 of system function menu to be displayed at a location that is greater than a threshold distance of a respective position, the computer system 7100 forgoes displaying the indicator 7010 of system function menu at the adjusted location, and instead displays a visual indication to the user (e.g., instructions for correcting the orientation and/or position of the computer system 7100 relative to the user, which would allow the indicator 7010 of system function menu to be displayed at a location that is within the threshold distance of the respective location). Displaying a second visual indication that the current spatial relationship between the first display generation component and the user no longer meets alignment criteria, provides improved visual feedback to the user (e.g., improved visual feedback regarding the current spatial relationship between the first display generation component and the user, and/or whether alignment criteria are met or not).

In some embodiments, displaying the first user interface object at the second position that has the second spatial relationship to the viewport through which the three-dimensional environment is visible includes adjusting criteria for establishing the second spatial relationship between the first user interface object and the viewport through which the three-dimensional environment is visible in accordance with the current spatial relationship between the first display generation component and the user (e.g., using different criteria for different spatial relationships between the first display generation component and the user).For example, as described with reference to FIG. 7AH, if the location of the indicator 7010 of system function menu is adjusted (e.g., the indicator 7010 of system function menu is displayed at the adjusted location as described above), the system function menu 7024 is also adjusted by the same amount (e.g., in the same direction(s)). Displaying the first user interface object at the second position that has the second spatial relationship to the viewport through which the three-dimensional environment is visible, including adjusting criteria for establishing the second spatial relationship between the first user interface object and the viewport through which the three-dimensional environment is visible, in accordance with the current spatial relationship between the first display generation component and the user, automatically displays the first user interface object at an appropriate location based on the current spatial relationship between the first display generation component and the user, without requiring further user input (e.g., the user does not need to perform additional user inputs to adjust the position of the first user interface object and/or adjust the criteria for establishing the second spatial relationship between the first user interface object and the viewport through which the three-dimensional environment is visible).

In some embodiments, the computer system displays one or more user interface objects in the first view of the three-dimensional environment, wherein the one or more user interface objects (e.g., the second user interface object, or other objects located at other positions in the three-dimensional environment) (e.g., application user interfaces, other system user interface objects, virtual background of the three-dimensional environment, and/or representations of physical objects in the physical environment) are different from the first user interface object (and different from the third user interface object (e.g., the indicator 7010 of system function menu of FIG. 7A and FIG. 7AM, or other visual indicators)), wherein respective positions of the one or more user interface objects in the first view of the three-dimensional environment do not change in accordance with a change to the current spatial relationship between the first display generation component and the user (e.g., the other user interface objects appear in the same position in the three-dimensional environment regardless of the current spatial relationship between the first display generation component and the user). For example, as described with reference to FIG. 7AH, if the location of the indicator 7010 of system function menu is adjusted, the system function menu 7024 is adjusted by the same amount (e.g., and in the same direction(s)), but other user interface elements are not adjusted (e.g., are displayed in normal or default positions such that only the indicator 7010 of system function menu and the system function menu 7024 are adjusted). Adjusting criteria for determining whether the respective position has the first spatial relationship to the viewport through which the three-dimensional environment is visible, in accordance with the current spatial relationship between the first display generation component and the user, and displaying one or more user interface object at respective position in the first view of the three-dimensional environment at respective positions that do not change in accordance with the change to the current spatial relationship between the first display component and the user, automatically adjust the criteria for determining whether the respective position has the first spatial relationship without further user input (e.g., the user does not need to perform addition user input to adjust the criteria for determining whether the respective position has the first spatial relationship), and reduces the number of user inputs needed to display the one or more user interface objects at appropriate locations (e.g., the user does not need to perform additional user inputs to adjust the locations of the one or more user interface objects each time the spatial relationship between the first display generation component and the user changes).

In some embodiments, at a first time, the one or more affordances for accessing the first set of functions of the first computer system include a first affordance for adjusting an audio level of the first computer system, and at a second time, different from the first time, the one or more affordances for accessing the first set of functions of the first computer system include a second affordance for adjusting an audio level of a first type of audio provided by the first computer system and a third affordance for adjusting an audio level of a second type of audio provided by the first computer system, wherein the second affordance and the third affordance are different from the first affordance. In some embodiments, the second affordance and the third affordance control context-specific audio settings. For example, the second affordance controls a volume for applications (e.g., application sounds, audio for media corresponding to an application, and/or application notifications), and the third affordance controls a volume for communications (e.g., phone calls, video calls, and/or AR/VR communication sessions with other users). In some embodiments, at the second time, the one or more affordances for accessing the first set of functions of the first computer also includes a fourth affordance (e.g., in addition to the second affordance and the third affordance). For example, the fourth affordance controls a volume for experiences (e.g., an AR or a VR experience). In some embodiments, at the first time, the first affordance controls the same context-specific settings, but controls only the respective setting for a respective setting (e.g., if an application user interface is displayed, the first affordance controls the volume for applications; if a communication session is active, the first affordance controls the volume for communication session; and while an AR or VR experience is active, the first affordance controls the volume for experiences). At the second time, no relevant context is active (e.g., no applications are open, no communication sessions are active, and no AR or VR experiences are active), or multiple relevant contexts are active, and so the second affordance, third affordance, and/or fourth affordance are displayed (e.g., to allow the user to adjust the relevant settings without first needing to trigger the appropriate context, or without affecting other active context(s)). In some embodiments, the first affordance controls more than one of the same context-specific settings (e.g., an application user interface is displayed and a communication session is active, so the first affordance controls the volume for both applications and communications (e.g., without controlling the volume for experiences)). In some embodiments, the first affordance controls all of the context-specific settings (e.g., the user can adjust the volume across multiple contexts without needing to individually adjust the second, third, and/or fourth affordances). For example, as described with reference to FIG. 7L, where in some embodiments, the computer system 7100 determines the active context (e.g., an application user interface is being displayed and/or the attention of the user is directed to an application user interface; there is an active communication session; and/or an AR or VR experience is active) and displays a single slider for adjusting the volume for the active context (e.g., and if the active context changes over time, the single slider for adjust the volume for the active context adjusts a contextually relevant volume based on what context applies at the current time). Displaying, at a first time, a first affordance for adjusting an audio level of the first computer system, and displaying, at a second time, a second affordance for adjusting an audio level of a first type of audio provided by the first computer system and a third affordance for adjusting an audio level of a second type of audio provided by the first computer system, wherein the second affordance and the third affordance are different from the first affordance, enables the computer system to display (e.g., and/or adjust) the appropriate affordances for adjusting audio levels (e.g., based on the appropriate time and/or context, such as displaying affordances for adjusting audio levels for currently active applications or communication session of the computer system, or audio levels that are otherwise contextually relevant based on a current state of the computer system).

In some embodiments, while displaying the third user interface object (e.g., the indicator 7010 of system function menu of FIG. 7A and FIG. 7AM, or other visual indicators that, when activated with a gaze input (e.g., with dwell, or in conjunction with a confirmation gesture), causes the first computer system to display the first user interface object) at the respective position in the three-dimensional environment that has the first spatial relationship to the viewport through which the three-dimensional environment is visible, the computer system detects, via the one or more input devices, a second change of the viewpoint of the user from the first viewpoint a third viewpoint (e.g., based on movement of at least a portion of the computer system and/or a movement of a portion of the user which is the basis for determining the viewpoint of the user). In response to detecting the second change in the viewpoint of the user, displaying the viewport through which the three-dimensional environment is visible and displaying the third user interface object at an updated position in the view of the three-dimensional environment that has the first spatial relationship to the viewport through which the three-dimensional environment is visible. In some embodiments, as the user continues to keep the gaze input on the third user interface object while the viewpoint changes and the third user interface object is visually locked to the current viewpoint of the user (e.g., maintaining the first spatial relationship to the currently displayed view, and remaining substantially stationary relative to the field of view), the first computer system displays the first user interface object when the gaze input has been maintained on the third user interface object for more than the first threshold amount of time, and/or when a confirmation gesture is detected in conjunction with the gaze input before the first threshold amount of time is reached. For example, as described with reference to FIG. 7AH, and as shown in FIGS. 7B-7D, in some embodiments, the indicator 7010 of system function menu is viewpoint-locked. Displaying the third user interface object at an updated position that has the first spatial relationship to the viewport through which the three-dimensional environment is visible, in response to detecting a second change of the viewpoint of the user from the first viewpoint associated with the first view of the three-dimensional environment to a third viewpoint associated with a third view of the three-dimensional environment, automatically displays the third user interface object at an appropriate position without requiring further user input (e.g., the user does not need to perform additional user inputs to adjust the position of the third user interface object each time the viewpoint of the user changes).

In some embodiments, the third user interface object (e.g., the indicator 7010 of system function menu of FIG. 7A and FIG. 7AM, and/or a visual indicator of the smaller region for invoking the first user interface object) is translucent and has an appearance that is based on at least a portion of the three-dimensional environment (e.g., based on representations of virtual objects and/or objects in the physical environment) over which the third user interface object is displayed. For example, as described above with reference to FIG. 7B, in some embodiments, indicator 7010 of system function menu is translucent. Displaying the third user interface object as translucent and with an appearance that is based on at least a portion of the three-dimensional environment over which the third user interface object is displayed, enables the third user interface object to be displayed with minimal impact on the three-dimensional environment, thereby providing improved visual feedback about the user’s real and/or virtual surroundings, and reducing the need for additional inputs (e.g., in order to dismiss the third user interface object, for improved visibility).

In some embodiments, while the three-dimensional environment is visible through the viewport, the computer system displays the third user interface object with a first appearance at a first indicator position in the three-dimensional environment, wherein the first appearance of the third user interface object at the first indicator position is based at least in part on a characteristic of the three-dimensional environment at the first indicator position in the viewport through which the three-dimensional environment is visible. In response to detecting a movement of the viewpoint of the user from the first viewpoint to the third viewpoint in the three-dimensional environment, the computer system displays the third user interface object with a respective appearance at a respective indicator position in the three-dimensional environment that has the first spatial relationship to the viewport through which the three-dimensional environment is visible, wherein the respective appearance of the first user interface object at the respective indicator position is based at least in part on a characteristic of the three-dimensional environment at the respective indicator position. For example, as described above with reference to FIG. 7B, in some embodiments, the first user interface object has an appearance that is based at least in part on a portion of the three-dimensional environment over which the indicator 7010 of system function menu is displayed. Displaying the third user interface object with an appearance that is based at least in part on a characteristic of the three-dimensional environment at the current position of the third user interface object in the three-dimensional environment provides improved visual feedback about the position of the computer system in the three-dimensional environment.

In some embodiments, displaying the first user interface object in response to detecting the first user input including the first gaze input, includes displaying an animated transition of the one or more affordances for accessing the first set of functions of the first computer system emerging from the third user interface object in a first direction (e.g., the system function menu 7024 expanding downward, upward, leftward, rightward from the indicator, and/or or expanding from a peripheral region of the field of view toward a central or interior region of the field of view, in FIG. 7E and/or FIG. 7AM). This is described above, for example, in the description of FIG. 7E, where in some embodiments, displaying the system function menu 7024 includes displaying an animated transition, and the animated transition includes an animation of the system function menu 7024 expanding downward from the indicator 7010 of system function menu. Displaying an animated transition of the one or more affordances for accessing the first set of functions of the first computer system emerging from the third user interface object in a first direction, provides improved visual feedback that the third gaze input is directed to a position within a first region that includes a respective position having the first spatial relationship to the viewport through which the three-dimensional environment is visible.

In some embodiments, displaying the first user interface object in response to detecting the first user input including the first gaze input, includes displaying an animated transition of the one or more affordances for accessing the first set of functions of the first computer system gradually appearing. This is described above, for example, in the description of FIG. 7E, where in some embodiments, displaying the system function menu 7024 includes displaying an animated transition. Displaying an animated transition of the one or more affordances for accessing the first set of functions of the first computer system gradually appearing provides improved visual feedback that the first gaze input satisfies the attention criteria with respect to the third user interface object.

In some embodiments, in response to detecting the first user input that includes the first gaze input, and in accordance with a determination that the first position in the three-dimensional environment has the first spatial relationship to the viewport through which the three-dimensional environment is visible (e.g., a determination that the first position is represented in a first region of the field of view provided by the first display generation component (e.g., in the upper left corner, top center region, lower right corner, peripheral region, or other preselected region of the field of view), while the viewport through which the three-dimensional environment is visible), the computer system displays an indication of the first user interface object (e.g., the indication is a smaller and/or more translucent version of the first user interface object, the indication is the indicator 7010 of system function menu of FIG. 7A and FIG. 7AM, and/or the indication is another visual indication) before displaying the first user interface object at the second position (e.g., the indication of the first user interface object grows in size and changes in appearance to transform into the first user interface object once the gaze input has been maintained at the first position for at least a first threshold amount of time). After displaying the indication of the first user interface object (and optionally in response to detecting the first user input that includes the first gaze input), in accordance with a determination that criteria for displaying the first user interface object is met by the first user input (e.g., the first gaze input has been maintained at the first position for at least the first threshold amount of time, or a confirmation gesture has been detected while the first gaze input is maintained in the first region), the computer system replaces the indication of the first user interface object with the first user interface object; and in accordance with a determination that criteria for displaying the first user interface object is not met by the first user input (e.g., the gaze has not been maintained at the first position for at least a first threshold amount of time, and/or a confirmation gesture is not detected before the first threshold amount of time is reached) and that the first gaze input has moved away from the first position that has the first spatial relationship with the viewport through which the three-dimensional environment is visible, the computer system ceases to display the indication of the third user interface object and forgoing display the third user interface object at the second position in the three-dimensional environment. For example, in some embodiments, the user can look away to cancel display of the system function menu 7024 (e.g., in FIG. 7E or FIG. 7AM), after an indication of the system function menu 7024 has been displayed in response to the user’s gaze at the first region or first position that has the first spatial relationship to the currently displayed field of view of the three-dimensional environment. For example, in FIG. 7AJ, the computer system displays the indicator 7010 of system function menu (e.g., which is an indication of the system function menu 7024), and in FIG. 7AK, the indicator 7010 of system function menu is displayed with a smaller size (e.g., because the user’s attention 7116 is no longer directed to the region 7160 and/or the indicator 7010 of system function menu) (e.g., and will eventually cease to be displayed if the user’s attention 7116 continues to no longer be directed to the region 7160 and/or the indicator 7010 of system function menu). In contrast, in FIG. 7AL-7AM, the user’s attention remains directed to the region 7160 and/or the indicator 7010 of system function menu, and the computer system displays the system function menu 7024 (e.g., and optionally, replaces display of the indicator 7010 of system function menu with display of the system function menu 7024). Ceasing to display the indication of the third user interface object, in response to detecting that the first gaze input no longer satisfies the attention criteria with respect to the first user interface object and forgoing display of the third user interface object, in accordance with a determination that criteria for displaying the first user interface object is not met by the first user input and that the first gaze input has moved away from the first position that has the first spatial relationship with the viewport through which the three-dimensional environment is visible, and replacing the indication of the first user interface object with the first user interface object in accordance with a determination that criteria for displaying the first user interface object is met by the first user input, provides additional control options without cluttering the UI with additional displayed controls (e.g., additional displayed controls for displaying and/or ceasing to display the first user interface object, and/or additional displayed controls for displaying and/or ceasing to display the indication of the third user interface object).

In some embodiments, the first position in the three-dimensional environment is in a periphery region of the viewport through which the three-dimensional environment is visible. For example, in FIG. 7AG, the region 7160 is in a periphery region (e.g., within a threshold distance of a top edge) of the viewport provided by the first display generation component. This is also shown in FIG. 7B, where the indicator 7010 of system function menu is displayed in a periphery region (e.g., within a threshold distance of a top edge) of the viewport provided by the first display generation component. Displaying the first user interface object in response to detecting the first gaze input directed to a first position that is a periphery region of the viewport through which the three-dimensional environment is visible provides additional control options without cluttering the UI with additional and intrusively displayed controls.

In some embodiments, while displaying the first user interface object including the one or more affordances for accessing the first set of functions of the first computer system, detecting a fifth user input including detecting gaze input directed to a respective affordance of the one or more affordances. In response to detecting the fifth user input: in accordance with a determination that the respective affordance is a first affordance corresponding to a first unction of the first computer system and that the fifth user input includes a gesture input that meets gesture criteria, the computer system performs the first function; in accordance with a determination that the respective affordance is the first affordance corresponding to the first function of the first computer system and that the fifth user input does not include a gesture input that meets the gesture criteria, the computer system forgoes performing the first function; and in accordance with a determination that the respective affordance is a second affordance corresponding to a second function of the first computer system and that the fifth user input does not include a gesture input that meets the gesture criteria, the computer system performs the second function. For example, in some embodiments, some affordances in the first user interface object require the user to gaze and use a hand gesture to activate, while others can be activated with gaze without requiring a corresponding gesture. For example, in some embodiments, affordances for opening the notification center, adjusting a volume, opening the control center, opening the settings, require a gaze input as well as a corresponding gesture to activate; while affordances for the home, contacts, and other functions are activated by gaze without a gesture. For example, as described with reference to FIG. 7J, in some embodiments, the computer system 7100 only displays certain system spaces if the computer system 7100 detects certain types of user inputs (e.g., a first system space requires that the user’s attention be directed to a first affordance in combination with an air gesture (e.g., an air tap or an air pinch), while a second system space requires that the user’s attention be directed to a second affordance in combination with a verbal input). Performing a first function in accordance with a determination that the respective affordance is a first affordance corresponding to a first function of the first computer system and that the fifth user input includes a gesture input that meets gesture criteria, forgoing performing the first function in accordance with a determination that the respective affordance is the first affordance corresponding to the first function of the first computer system and that the fifth user input does not include a gesture input that meets the gesture criteria, and performing a second function in accordance with a determination that the respective affordance is a second affordance corresponding to a second function of the first computer system and that the fifth user input does not include a gesture input that meets the gesture criteria, enables the computer system to perform an appropriate function (or forgo performing a function) without needing to display additional controls (e.g., a first control for performing the first function and a second control for performing the second function).

In some embodiments, while displaying the first user interface object including the one or more affordances for accessing the first set of functions of the first computer system, the computer system detects a change in pose of a first portion of the user (e.g., the user’s hand, the user’s fingers, or other portions of the user). In response to detecting the change in pose of the first portion of the user: in accordance with a determination that the change in pose of the first portion of the user results in a first type of pose (e.g., a ready state pose, raised, forming a pinch, thumb on the side of the index finger, and/or other ready state poses), the computer system changes an appearance of the respective affordance (e.g., highlighting (e.g., making it larger, moving it toward the user, making it brighter, and/or otherwise enhancing the visibility thereof) the respective affordance relative to its surroundings, including the environment and/or other affordances in the first user interface object); and in accordance with a determination that the change in pose of the first portion of the user does not result in the first type of pose, the computer system forgoes changing the appearance of the respective affordance. For example, as described with reference to FIGS. 7G-7H, the border of the volume affordance 7038 is increased (e.g., displayed with a thicker border) in response to detecting the user’s hand 7020 is in the ready state configuration. Changing the appearance of a respective affordance in response to detecting a change in pose of the first portion of the user provides improved visual feedback to the user (e.g., by indicating which user interface element is selected for further interaction).

In some embodiments, in response to detecting the change in pose of the first portion of the user, and in accordance with a determination that the change in pose of the first portion of the user results in the first type of pose (e.g., a ready state pose, raised, forming a pinch, thumb on the side of the index finger, and/or other ready state poses), the computer system forgoes changing an appearance of at least one affordance of the one or more affordances different from the respective affordance. For example, in FIG. 7H, the computer system 7100 does not change the appearance of the change the appearance of affordances other than the volume affordance 7038. Forgoing changing an appearance of at least one affordance of the one or more affordances different from the respective affordance in accordance with a determination that the change in pose of the first portion of the user results in the first type of pose, provides improved visual feedback to the user (e.g., by changing an appearance only for the respective affordance, to indicate which affordance the user is interacting with).

In some embodiments, while displaying the first user interface object including the one or more affordances for accessing the first set of functions of the first computer system, the computer system detects, via the one or more input devices, a sixth user input including gaze input directed to a respective affordance of the one or more affordances. In response to detecting the sixth user input directed to the respective affordance, the computer system displays (e.g., optionally, in accordance with a determination that the gaze input corresponding to the sixth user input has been maintained on the respective affordance for at least the first threshold amount of time) additional content associated with the respective affordance (e.g., a glyph, icon, and/or text showing the function that would be performed when the respective affordance is activated (e.g., with gaze and a gesture, and/or with a gaze and dwell)). This is described above, for example, with reference to FIG. 7H, where in some embodiments, in response to detecting the user’s gaze directed to the volume affordance 7038, the computer system 7100 displays additional content associated with the volume affordance 7038 (e.g., a “tool tip,” such as a description of a volume setting associated with the volume affordance 7038, instructions of adjusting the volume setting associated with the volume affordance 7038, and/or a current value of the volume setting associated with the volume affordance 7038). Displaying additional content associated with the respective affordance, in response to detecting the sixth user input directed to the respective affordance, reduces the number of inputs needed to access additional information about displayed user interface elements and provides additional control options without cluttering the UI with additional displayed controls (e.g., additional displayed controls for displaying the additional content associated with the respective affordance).

In some embodiments, while displaying the first user interface object, the computer system detects, via the one or more input devices, a seventh user input that activates a first affordance of the one or more affordances for accessing the first set of functions of the first computer system. In response to detecting the seventh user input (e.g., an air gesture (e.g., an air tap or an air pinch) detected in conjunction with a gaze input; an air gesture, a touch gesture, an input provided via a controller, a voice command, and/or other types of input) that activates the first affordance, the computer system displays a first system user interface for a first system function of the first computer system (e.g., a home user interface, a control user interface, a notification user interface, a settings user interface, and/or other types of system spaces) in the three-dimensional environment (e.g., in the center of the field of view, or in another portion of the field of view). For example, in FIG. 7K(c), the computer system 7100 displays the system space 7052 (e.g., a notification center or a notification history user interface) in response to detecting an activation input directed to the notification affordance 7044. In some embodiments, the system space 7052 is a notification history user interface (e.g., as shown in FIG. 7BC-7BJ). Displaying a first system user interface for a first system function of the first computer system, in response to detecting the seventh user input that activates the first affordance, reduces the number of inputs needed to access additional control options without cluttering the UI with additional displayed controls when not needed.

In some embodiments, while displaying the first user interface object and the first system user interface, the computer system detects, via the one or more input devices, an eighth user input that activates a second affordance, different from the first affordance, of the one or more of affordances for accessing the first set of functions of the first computer system. In response to detecting the eighth user input (e.g., an air gesture (e.g., an air tap or an air pinch) detected in conjunction with a gaze input; an air gesture, a touch gesture, an input provided via a controller, a voice command, and/or other types of input) that activates the second affordance, the computer system displays a second system user interface, different from the first system user interface, for a second system function of the first computer system, and the computer system ceases to display the first system user interface (e.g., replacing the first system user interface with the second system user interface at the display location of the first system user interface). This is described above, for example, in the description of FIG. 7H where in some embodiments, if the system space 7040 is already displayed (e.g., in response to detecting the user’s gaze directed to the volume affordance 7038), and the computer system 7100 detects the user’s gaze shifts to another affordance (e.g., the control affordance 7046, or another affordance in system function menu 7024), the computer system 7100 ceases to display the system space 7040 and displays a new system space for the other affordance (optionally in place of the system space 7040). Ceasing to display the first system user interface and displaying a second system user interface (different from the first system user interface), in response to detecting the eighth user input that activates the second affordance, causes the computer system to automatically dismiss the first system user interface when the user interacts with an affordance corresponding to a different system user interface and/or the different system user interface itself (e.g., the user does not need to perform an additional user input to dismiss the first system user interface besides the input to interact with the different system user interface).

In some embodiments, while displaying the first system user interface and the first user interface object, the computer system detects, via the one or more input devices, a ninth user input that includes a gaze input (e.g., optionally in combination with an air gesture (e.g., an air tap or an air pinch), a touch gesture, an input provided via a controller a voice command, and/or another type of input) directed to the first user interface object (e.g., that, optionally, activates a respective affordance after a dwell time). In response to detecting the ninth user input, the computer system changes one or more visual properties (e.g., blurring, dimming, darkening, reducing opacity and/or color saturation) of the first system user interface to reducing visual prominence of the first system user interface relative to the first user interface object. In some embodiments, changing the one or more visual properties of the first system user interface include reducing visual prominence of the first system user interface from a steady state appearance of the first system user interface. In some embodiments, changing the one or more visual properties of the first system user interface is accompanied by changing one or more visual properties of the first user interface object to increase the visual prominence of the first user interface object relative to its previous visual appearance (e.g., a steady state appearance or a visually obscured appearance). This is described above, for example, in the description of FIG. 7H, where in some embodiments, while the system space 7040 is displayed (concurrently with the system function menu 7024), in response to detecting the user’s gaze directed to the system function menu 7024, the system space 7040 is visually deemphasized (e.g., faded or blurred out, relative to the system function menu 7024). Changing one or more visual properties of the first system user interface to reduce visual prominence of the first system user interface relative to the first user interface object, in response to detecting the ninth user input, provides improved visual feedback regarding which user interface element the computer system detects that the user is gazing at, and accordingly which user interface element is currently in focus and selected for further interaction.

In some embodiments, while displaying the first system user interface and the first user interface object, the computer system detects, via the one or more input devices, a tenth user input that includes gaze input (e.g., optionally in combination with an air gesture (e.g., an air tap or an air pinch), a touch gesture, an input provided via a controller a voice command, and/or another type of input) directed to the first system user interface (e.g., the nine gaze input moved from the first user interface object or another portion of the three-dimensional environment to the first system user interface).In response to detecting the tenth user input, the computer system changes one or more visual properties (e.g., blurring, dimming, darkening, reducing opacity and/or color saturation) of the first user interface object to reduce visual prominence of the first user interface object relative to the first system user interface. In some embodiments, changing the one or more visual properties of the first user interface object include reducing visual prominence of the first user interface object from a steady state appearance of the first user interface object. In some embodiments, changing the one or more visual properties of the first user interface object is accompanied by changing one or more visual properties of the first system user interface to increase the visual prominence of the first system user interface relative to its previous visual appearance (e.g., a steady state appearance or a visually obscured appearance). This is described above, for example, in the description of FIG. 7H, where in some embodiments, while the system space 7040 is displayed (concurrently with the system function menu 7024), in response to detecting the user’s gaze directed to the system space 7040, the system function menu 7024 is visually deemphasized (e.g., relative to the system space 7040). Changing one or more visual properties of the first system user interface to reduce visual prominence of the first user interface object relative to the first system user interface, in response to detecting the tenth user input, provides improved visual feedback regarding which user interface element the computer system detects that the user is gazing at, and accordingly which user interface element is currently in focus and selected for further interaction.

In some embodiments, while displaying, via the first display generation component, an application launching user interface in the three-dimensional environment (e.g., a home user interface that includes a plurality of application icons (e.g., application icons for a messaging application, an email application, a meditation application, a video chat application, a word processing application, a gaming application, a browser application, and other user and system applications), which when selected, causes the first computer system to display corresponding applications in the three-dimensional environment) and the first user interface object, the computer system detects, via the one or more input devices, an eleventh user input (e.g., an air gesture (e.g., an air tap or an air pinch) detected in conjunction with a gaze input; an air gesture, a touch gesture, an input provided via a controller, a voice command, and/or other types of input) that activates a third affordance of the one or more of affordances for accessing the first set of functions of the first computer system. In response to detecting the eleventh user input that activates the respective affordance, the computer system displays a third system user interface for a third system function of the first computer system that corresponds to the third affordance, and the computer system ceases to display the application launching user interface (e.g., replacing the application launching user interface with the third system user interface at the display location of the third system user interface). For example, as described with reference to FIG. 7H, where in some embodiments, in response to detecting the user’s gaze directed to the volume affordance 7038, the computer system 7100 replaces display of the application launching user interface with display of the system space 7040 (e.g., by ceasing to display the application launching user interface and displaying the system space 7040). Displaying a third system user interface for a third system function of the first computer system that corresponds to the third affordance, and ceasing to display the application launching user interface, in response to detecting the eleventh user input that activates the respective affordance, reduces the number of inputs needed to cease displaying the application launching user interface and to display the third system user interface.

In some embodiments, while displaying, via the first display generation component, an application user interface in the three-dimensional environment (e.g., a user interface for a messaging application, an email application, a meditation application, a video chat application, a word processing application, a gaming application, a browser application, and other user applications, and optionally, system applications), which when selected, causes the first computer system to display corresponding applications in the three-dimensional environment) and the first user interface object, the computer system detects, via the one or more input devices, a twelfth user input (e.g., an air gesture (e.g., an air tap or an air pinch) detected in conjunction with a gaze input; an air gesture, a touch gesture, an input provided via a controller, a voice command, and/or other types of input) that activates a fourth affordance of the one or more of affordances for accessing the first set of functions of the first computer system. In response to detecting the twelfth user input that activates the respective affordance, the computer system displays a fourth system user interface for a fourth system function of the first computer system that corresponds to the fourth affordance, concurrently with the application user interface (e.g., overlaying or displayed side-by-side with the application user interface). For example, as described with reference to FIG. 7H, in some embodiments, in response to detecting the activation input directed to the volume affordance 7038, the computer system 7100 displays the system space 7040 overlaid over at least a portion of the application user interface. Displaying the fourth system user interface for a fourth system function of the first computer system that corresponds to the fourth affordance, concurrently with the application user interface, reduces the number of inputs needed to return to the application user interface (e.g., as the application user interface does not cease to be displayed) and avoids dismissing and then redisplaying the application user interface during what are typically brief interactions with the plurality of affordances for accessing system functions, thereby reducing motion sickness.

In some embodiments, while displaying, via the first display generation component, the first user interface object, the computer system detects, via the one or more input devices, a thirteenth user input (e.g., an air gesture (e.g., an air tap or an air pinch) detected in conjunction with a gaze input; an air gesture, a touch gesture, an input provided via a controller, a voice command, and/or other types of input) that activates a fifth affordance of the one or more of affordances for accessing the first set of functions of the first computer system. In response to detecting the twelfth user input that activates the fifth affordance, the computer system performs a respective operation that corresponds to activation of the fifth affordance (e.g., changing the volume, display brightness, level of immersion, and other settings of the first computer system and/or the three-dimensional environment). For example, in FIG. 7BB-7BC, the user’s attention 7116 is directed to the notification affordance 7044, and the computer system displays the notification history user interface (e.g., performs the operation corresponding to the notification affordance 7044). This is also shown in FIG. 7H, for example, where a fourth user input (e.g., an activation input that includes for example a gaze input and/or air gesture) activates the volume affordance 7038, and in response, the computer system 7100 displays a system space 7040 for adjusting a volume setting of the computer system 7100. This is also shown in FIGS. 7J-7K, for example, where a fourth user input (e.g., a gaze input and/or air gesture) activates a respective affordance in the system function menu 7024 for accessing different system functions of computer system 7100. Performing a respective operation that corresponds to activation of a fifth affordance, in response to detecting the twelfth user input that activates the fifth affordance, provides additional control options without cluttering the UI with additional displayed controls (e.g., the controls for performing the respective operation) when not needed.

In some embodiments, performing the respective operation includes displaying one or more controls for adjusting one or more settings of the first computer system (e.g., the fifth affordance expands to display the one or more controls), wherein the one or more controls are displayed overlaying at least a portion of the first user interface object (e.g., overlaying and visually obscuring one or more of the plurality of affordances other than the fifth affordance). For example, as described above with respect to FIG. 7K, in some embodiments, a system space such as any of the system spaces shown in FIG. 7K(a)-7K(d) is displayed over at least a portion of the system function menu 7024. Displaying one or more controls for adjusting one or more settings of the first computer system overlaying at least a portion of the first user interface object provides improved visual feedback about which user interface elements are in focus, by displaying the one or more controls more prominently than the first user interface object.

In some embodiments, detecting the thirteenth user input that activates the fifth affordance of the one or more of affordances for accessing the first set of functions of the first computer system includes detecting a pinch and release gesture (e.g., two fingers of a hand coming into contact with each other, and then moving apart from each other after less than a threshold amount of time remaining in contact with each other) that is directed to the fifth affordance (e.g., with a gaze input directed to or a cursor pointed at the fifth affordance, or a pinch gesture directly occurring at the location of the fifth affordance). While displaying the one or more controls for adjusting one or more settings of the first computer system (e.g., after detecting the release portion of the pinch and release gesture, and before a threshold amount of time has elapsed since the pinch and release gesture), the computer system detects a pinch and drag gesture (e.g., two fingers of a hand coming into contact with each other, and then moving together in a respective direction while remaining in contact with each other) that is directed to a first control of the one or more controls (e.g., with a gaze input directed to or a cursor pointed at the first control, or a pinch gesture directly occurring at the location of the first control). In response to detecting the pinch and drag gesture that is directed to the first control of the one or more controls, adjusting a first setting that corresponds to the first control in accordance with one or more characteristics of the pinch and drag gesture (e.g., the location, speed, movement direction, and/or duration of the pinch and drag gesture). For example, as described with reference to FIG. 7I, an air pinch gesture and a change in position of the user’s hand 7020 from a first position to a second position (e.g., a drag gesture or a swipe gesture), the computer system 7100 adjusts a volume setting of the computer system 7100 in accordance with the change in position of the user’s hand (e.g., as reflected in the movement of the slider of the system space 7040 in FIG. 7I). Adjusting a first setting of the first computer system that corresponds to the first control, in accordance with one or more characteristics of the pinch and drag gesture, in response to detecting the pinch and drag gesture, gives the user more precise control and provides corresponding visual feedback during the interaction for adjusting the respective setting of the first computer system.

In some embodiments, displaying the first user interface object in the first view of the three-dimensional environment includes displaying the first user interface object at a first simulated distance from the first viewpoint of the user, wherein the first simulated distance is less than respective simulated distances of one or more other user interface objects displayed in the first view of the three-dimensional environment (e.g., one or more application user interfaces, one or more windows, and/or other user interface objects currently displayed in the three-dimensional environment) from the first viewpoint of the user. For example, in FIG. 7M, the system function menu 7024 is (optionally) displayed over a portion of the user interface 7058, with the simulated distance from the system function menu 7024 to the viewpoint of the user being less than the simulated distance from the user interface 7058 to the viewpoint of the user. This is also described above in the description of FIG. 7D, where in some embodiments, the system function menu 7024 is displayed closer to a viewpoint of the user. Displaying the first user interface object at a first simulated distance from the viewpoint of the user that is less than respective simulated distances of one or more other user interface objects from the first viewpoint of the user, provides improved visual feedback that gives visual prominence to the first user interface object when displayed and selected for further interaction.

In some embodiments, the computer system displays a plurality of system status indicators that include information about a status of the first computer system, concurrently with displaying the first user interface object. In some embodiments, the system status indicators and the one or more affordances for accessing the set of functions of the first computer system are displayed in the same container object (e.g., the first user interface object). In some embodiments, the system status indicators and the one or more affordances for accessing the set of functions of the first computer system are displayed in separate container objects (e.g., the first user interface object does not include the status indicators). For example, as described with reference to FIG. 7AN, the system function menu 7024 includes status information about the computer system 7100 (e.g., Wi-Fi connection status, cellular connection status, a current time, and/or battery charge state), in addition to the plurality of affordances for accessing system functions of the computer system 7100. This is also described with reference to FIG. 7D, where the system function menu 7024 again includes status information about the computer system 7100 (e.g., Wi-Fi connection status, cellular connection status, a current time, and/or battery charge state), in addition to the plurality of affordances for accessing system functions of the computer system 7100. Displaying a plurality of system status indicators that include information about a status of the first computer system, concurrently with displaying the first user interface object, reduces the number of inputs needed to access the relevant system function(s) of the first computer system and/or adjust relevant settings of the computer system (e.g., the user does not need to perform additional inputs to individually check each relevant status of the system, and then the input(s) for accessing system functions of the first computer system and/or adjusting settings of the first computer system).

In some embodiments, the first user interface object is displayed while the first gaze input remains within a first level of proximity to the first user interface object. While displaying the first user interface object, the computer system detects that the first gaze input moves away from the first user interface object. In response to detecting that the first gaze input has moved away from the first user interface object (e.g., the user has looked down toward the center of the field of view, or moved the gaze to another object in the field of view): in accordance with a determination that the first gaze input is beyond the first level of proximity to the first user interface object, the computer system ceases to display the first user interface object; and in accordance with a determination that the first gaze input remains within the first level of proximity to the first user interface object, the computer system maintains display the first user interface object. For example, as described with reference to FIG. 7AM, in some embodiments (e.g., where the system function menu 7024 is displayed in response to detecting that the user’s attention 7116 is directed to the region 7160), the computer system 7100 ceases to display the system function menu 7024 in response to detecting that the user’s attention 7116 is directed to a location outside the larger region 7158. In some embodiments, the computer system 7100 maintains display of the system function menu 7024 while the user’s attention remains directed to a location within the region 7160 (and/or the region 7158). Ceasing to display the first user interface object in accordance with a determination that the first gaze input is beyond the first level of proximity to the first user interface object, and maintaining display the first user interface object in accordance with a determination that the first gaze input remains within the first level of proximity to the first user interface object, provides additional control options without cluttering the UI with additional displayed controls (e.g., additional displayed controls for ceasing to display the first user interface object and/or for toggling display of the first user interface object), by causing the computer system to automatically dismiss the first user interface object when not needed.

In some embodiments, after ceasing to display the first user interface object, the computer system detects that the first gaze input has moved back to the first position that has the first spatial relationship to the viewport through which the three-dimensional environment is visible. In response to detecting that the first gaze input has moved back to the first position, the computer system redisplays the first user interface object. For example, as described with reference to FIG. 7AM, after ceasing to display the system function menu 7024, the computer system detects that the user’s attention 7116 returns to the indicator 7010 of system function menu (e.g., or a location within the region 7160), and in response, the computer system redisplays the system function menu 7024. Redisplaying the first user interface object in response to detecting that the first gaze input has moved back to the first position, enables toggling display of the first user interface object (e.g., dismissing and redisplaying the first user interface object) without needing to display additional controls to displaying and ceasing to display the first user interface object.

In some embodiments, aspects/operations of methods 8000, 9000, 10000, 11000, 12000, 13000, 14000, 15000, and 16000 may be interchanged, substituted, and/or added between these methods. For example, the first user interface object (e.g., system control indicator) in the method 12000 in some circumstances has a different appearance as described in the methods 9000-11000, and 13000-16000, and the user interface elements that are displayed (e.g., the plurality of affordances for accessing system functions of the first computer system) may be replaced by, or concurrently displayed with, other user interface elements (e.g., additional content associated with a notification, a user interface that includes an affordance for joining a communication session, and other user interface elements in the methods 9000-11000, and 13000-16000). For brevity, these details are not repeated here.

FIG. 13 is a flow diagram of an exemplary method 13000 for displaying and interacting with contextual user interfaces. In some embodiments, the method 13000 is performed at a computer system (e.g., computer system 101 in FIG. 1) (which is sometimes referred to as “the first computer system”) that is in communication with a display generation component (e.g., display generation component 120 in FIGS. 1, 3, and 4) (e.g., a heads-up display, a display, a touchscreen, or a projector) and one or more input devices (e.g., a touch screen, a camera, and/or a microphone). In some embodiments, the computer system optionally includes one or more cameras (e.g., a camera (e.g., color sensors, infrared sensors, and/or other depth-sensing cameras) that points towards the user (e.g., to detect the gaze of the user) and/or a camera that points forward (e.g., to facilitate displaying elements of the physical environment captured by the camera). In some embodiments, the method 9000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 9000 are, optionally, combined and/or the order of some operations is, optionally, changed.

Displaying a first set of one or more user interface objects that correspond to a first set of one or more contextual conditions, and displaying a second set of one or more user interface objects that correspond to a second set of one or more contextual conditions, in response to detecting that the attention of the user is directed to a first portion of the first view of the three-dimensional environment, enables the computer system to automatically display different content (e.g., sets of one or more user interface objects) based on what contextual conditions are met at the time a user’s attention is directed to a portion of the first view of the three-dimensional environment. This reduces the number of user inputs needed to display contextually relevant content (e.g., the user does not need to manually navigate to contextually relevant content, and/or the user does not need to perform additional user inputs to select what content is (or is not) contextually relevant at the current time).

While a first view of a three-dimensional environment is visible via the first display generation component, the computer system detects (13002), via the one or more input devices, that attention of a user of the computer system is directed to a first portion of the first view of the three-dimensional environment (e.g., detecting a first gaze input that is directed to a first position in the three-dimensional environment; detecting a focus selector that is moved to the first position in the three-dimensional environment, and/or detecting other user inputs that indicate that the attention of the user has moved to the first position in the three-dimensional environment) (e.g., the user’s attention 7116 in FIG. 7AN is directed to a position corresponding to the user interface object 7064). In response to detecting (13004) that the attention of the user is directed to the first portion of the first view of the three-dimensional environment: in accordance with a determination that the first portion of the first view of the three-dimensional environment has a first spatial relationship to a viewport through which the three-dimensional environment is visible (e.g., the first portion of the first view is in a first region (e.g., in the peripheral region, in a top center region, in an upper left corner region, and/or another reactive region) of the first view that is reactive to user attention, and that is associated with displaying the system function menu 7024 described in FIG. 7E and FIG. 7AM, the system spaces of FIG. 7K, and/or saved notifications, live sessions, activities, updates, and alerts; and optionally, the first portion of the first view is not occupied by a user interface object (e.g., the system function menu 7024 described in FIG. 7E and 7AM, or the indicator 7010 of system function menu described in FIG. 7A and FIG. 7AM, a window, or other user interface objects) at the time that the user attention is directed to the first portion of the first view) while a first set of one or more contextual conditions are met at a time that the attention of the user is directed to the first portion of the first view of the three-dimensional environment (e.g., the first set of contextual conditions are met when a first set of notifications have been received, a first type of alert has been generated, and/or a first type of communication session is pending or active for the computer system) (optionally, in accordance with a determination that the user’s attention meets first criteria (e.g., stability-based and/or duration-based criteria) with respect to the first portion of the first view of the three-dimensional environment), the computer system displays (13006) a first set of one or more user interface objects (e.g., first application content, first notification content, first content associated with an active communication session, and/or media content, and/or user interface objects and controls associated with said content and/or applications) (e.g., the incoming call user interface 7068, and notifications 7148, 7150, 7152, and 7154, in FIG. 7AO) that correspond to the first set of one or more contextual conditions; and in accordance with a determination that the first portion of the first view of the three-dimensional environment has the first spatial relationship to the viewport through which the three-dimensional environment is visible (e.g., the first portion of the first view is in a first region (e.g., in the peripheral region, in a top center region, in an upper left corner region, and/or another reactive region) of the first view that is reactive to user attention, and that is associated with displaying the system function menu 7024 described in FIG. 7E and FIG. 7AM, the system spaces described in FIG. 7K, and/or saved notifications, live sessions, activities, updates, and alerts; and optionally, the first portion of the first view is not occupied by a user interface object (e.g., the system function menu 7024 described in FIG. 7E and FIG. 7AM, or the indicator 7010 of system function menu described in FIG. 7A and FIG. 7AM, a window, or other user interface objects) at the time that the user attention is directed to the first portion of the first view) while a second set of one or more contextual conditions, different from the first set of one or more contextual conditions, are met at the time that the attention of the user is directed to the first portion of the first view of the three-dimensional environment (e.g., the second set of contextual conditions are met when no notification has been received, a second type of alert, different from the first type of alert, has been generated, and/or a second type of communication session is pending or active for the computer system) (optionally, in accordance with a determination that the user’s attention meets the first criteria (e.g., stability-based and/or duration-based criteria) with respect to the first portion of the first view of the three-dimensional environment), the computer system displays (13008) a second set of one or more user interface objects (e.g., second application content, second notification content, second content associated with another type of active communication session, and/or second media content, and/or user interface objects and controls associated with said content and/or applications) (e.g., the music user interface 7166, the incoming call user interface 7068, and the notification 7148, in FIG. 7AT) that correspond to the second set of one or more contextual conditions, the second set of one or more user interface objects being different from the first set of one or more user interface objects.

In some embodiments, while the first set of user interface object and the second set of user interface objects are not visible in a currently displayed view (e.g., the first view, or a second view displayed after the first view (e.g., as a result of the movement of the first display generation component relative to a physical environment surrounding the first display generation component, and/or as a result of movement of the viewpoint of the user)) of the three-dimensional environment (e.g., optionally, while the system function menu 7024 described in FIG. 7E and FIG. 7AM, or the indicator 7010 of system function menu described in FIG. 7A and FIG. 7AM,is displayed in the first portion of the currently displayed view of the three-dimensional environment; or optionally, while the system function menu 7024 described in FIG. 7E and FIG. 7AM, or the indicator 7010 of system function menu described in FIG. 7A and FIG. 7AMare not displayed in the first portion of the currently displayed view of the three-dimensional environment), the computer system detects a first change of a viewpoint of the user (e.g., based on movement of at least a portion of the computer system (e.g., the display generation component, and/or the one or more cameras that provides the representation of the physical environment in the currently displayed view of the three-dimensional environment) and/or a shift in a virtual viewpoint of the user of the computer system relative to the three-dimensional environment) from a first viewpoint associated with the first view of the three-dimensional environment to a second viewpoint associated with a second view of the three-dimensional environment. In response to detecting the first change in the viewpoint of the user, the computer system updates the currently displayed view of the three-dimensional environment in accordance with the first change in the viewpoint of the user, to display the second view of the three-dimensional environment. In some embodiments, the change in the current viewpoint of the user (e.g., from the first viewpoint to the second viewpoint) is accomplished by moving the first display generation component and/or the one or more cameras in the physical environment, and/or movement of the user (e.g., turning, walking, running, and/or tilting the head up or down) in the physical environment that change the pose (e.g., position and/or facing direction) of the user relative to the three-dimensional environment. While the second view of the three-dimensional environment is visible via the first display generation component, the computer system detects, via the one or more input devices, that the attention of the user of the computer system is directed to a second portion of the second view of the three-dimensional environment (e.g., detecting a second gaze input that is directed to a second position in the three-dimensional environment; detecting a focus selector that is moved to the second position in the three-dimensional environment, and/or detecting other user inputs that indicate that the attention of the user has moved to the second position). In response to detecting that the attention of the user is directed to the second portion of the second view of the three-dimensional environment: in accordance with a determination that the second portion of the second view of the three-dimensional environment has the first spatial relationship to the viewport through which the three-dimensional environment is visible (e.g., the second portion of the second view is in a first region (e.g., in the peripheral region, in a top center region, in an upper left corner region, and/or another reactive region) of the second view that is reactive to user attention, and that is associated with displaying the system function menu 7024 described in FIG. 7E, the system spaces described in FIG. 7K, and/or saved notifications, live sessions, activities, updates, and alerts; and optionally, the second portion of the second view is not occupied by a user interface object (e.g., the system function menu 7024 described in FIG. 7E, or the indicator 7010 of system function menu described in FIG. 7A, a window, or other user interface objects) at the time that the user attention is directed to the second portion of the second view) while a third set of one or more contextual conditions (e.g., same as the first set of one or more contextual conditions, or different from the first set of one or more contextual conditions (e.g., while or after the first change in the viewpoint of the user, but before detecting that the attention of the user is directed to the second portion of the second view of the three-dimensional environment, the first set of one or more contextual conditions is no longer met)) are met at a time that the attention of the user is directed to the second portion of the second view of the three-dimensional environment (e.g., the third set of contextual conditions are met when a third set of notifications have been received, a third type of alert has been generated, and/or a third type of communication session is pending or active for the computer system) (optionally, in accordance with a determination that the user’s attention meets the first criteria (e.g., stability-based and/or duration-based criteria) with respect to the second portion of the second view of the three-dimensional environment), the computer system displays a third set of one or more user interface objects (e.g., third application content, third notification content, third content associated with an active communication session, and/or media content, and/or user interface objects and controls associated with said content and/or applications) that correspond to the third set of one or more contextual conditions (optionally, the third set of one or more user interface objects are the same as the first set of one or more user interface objects, if the third set of contextual conditions are the same as the first set of contextual conditions) (e.g., the third set of notifications, the third type of alert, and/or the third type of communication session takes priority or precedent over the first set of notifications, the first type of alert, and/or the first type of communication session (and optionally also the second set of notifications, the second type of alert, and/or the second type of communication session), and so the third set of one or more user interface objects is displayed (e.g., instead of the first set of one or more user interface objects and/or the second set of one or more user interface objects); and in accordance with the determination that the second portion of the second view of the three-dimensional environment has the first spatial relationship to the viewport through which the three-dimensional environment is visible (e.g., the second portion of the second view is in a first region (e.g., in the peripheral region, in a top center region, in an upper left corner region, and/or another reactive region) of the second view that is reactive to user attention, and that is associated with displaying the system function menu 7024 described in FIG. 7E, the system spaces described in FIG. 7K, and/or saved notifications, live sessions, activities, updates, and alerts; and optionally, the second portion of the second view is not occupied by a user interface object (e.g., the system function menu 7024 described in FIG. 7E, or the indicator 7010 of system function menu described in FIG. 7A, a window, or other user interface objects) at the time that the user attention is directed to the second portion of the second view) while a fourth set of one or more contextual conditions, different from the third set of one or more contextual conditions, are met at the time that the attention of the user is directed to the second portion of the second view of the three-dimensional environment (e.g., the fourth set of contextual conditions are met when no notification has been received, a fourth type of alert, different from the third type of alert, has been generated, and/or a fourth type of communication session is pending or active for the computer system) (optionally, in accordance with a determination that the user’s attention meets the first criteria (e.g., stability-based and/or duration-based criteria) with respect to the second portion of the second view of the three-dimensional environment), the computer system displays the fourth set of one or more user interface objects (e.g., fourth application content, fourth notification content, fourth content associated with an active communication session, and/or media content, and/or user interface objects and controls associated with said content and/or applications) that correspond to the fourth set of one or more contextual conditions (optionally, the fourth set of one or more user interface objects are the same as the second set of one or more user interface objects, if the fourth set of contextual conditions are the same as the second set of contextual conditions). In some embodiments, in a scenario where the third set of contextual conditions are different from the first set of contextual conditions, the third set of user interface objects are different from the first set of user interface objects. In some embodiments, in a scenario where the fourth set of contextual conditions are different from the second set of contextual conditions, the fourth set of user interface objects are different from the second set of user interface objects.

For example, as described with reference to FIG. 7AO, in some embodiments, one or more contextual user interfaces (e.g., the incoming call user interface 7068 and/or the additional content items in FIG. 7AO) are viewpoint-locked (e.g., exhibit similar behavior to the indicator 7010 of system function menu and/or the system function menu 7024, as described with reference to, and shown in, FIGS. 7B-7D and 7E-7G. Displaying a third set of one or more user interface objects that correspond to a third set of one or more contextual conditions, and displaying a fourth set of one or more user interface objects that correspond to a fourth set of one or more contextual conditions, in response to detecting that the attention of the user is directed to a second portion of a second view of the three-dimensional environment, enables the computer system to automatically display different content (e.g., sets of one or more user interface objects) based on what contextual conditions are met at the time a user’s attention is directed to a portion of the first view of the three-dimensional environment. This reduces the number of user inputs needed to display contextually relevant content (e.g., the user does not need to manually navigate to contextually relevant content, and/or the user does not need to perform additional user inputs to select what content is (or is not) contextually relevant at the current time).

In some embodiments, in response to detecting that the attention of the user is directed to the first portion of the first view of the three-dimensional environment, and in accordance with a determination that the first portion of the first view of the three-dimensional environment does not have the first spatial relationship to the viewport through which the three-dimensional environment is visible (e.g., the first portion of the first view is in a second region (e.g., outside of the peripheral region, outside of a top center region, outside of an upper left corner region, and/or outside of another reactive region) of the first view that is not reactive to user attention and/or that is not associated with displaying the system function menu 7024 described in FIG. 7E and FIG. 7AM, the system spaces described in FIG. 7K, and/or saved notifications, live sessions, activities, updates, and alerts, at the time that the user attention is directed to the first portion of the first view), the computer system forgoes display of the first set of one or more user interface objects while the first set of one or more contextual conditions are met at a time that the attention of the user is directed to the first portion of the first view of the three-dimensional environment, and forgoing display of the second set of one or more user interface objects while the first set of one or more contextual conditions are met at a time that the attention of the user is directed to the first portion of the first view of the three-dimensional environment. In some embodiments, whether or not a respective set of contextual conditions (e.g., the first set, second set, third set, and/or fourth set of contextual conditions) are met at a time when the attention of the user is directed to a respective portion of the currently displayed view of the three-dimensional environment, the computer system forgoes displaying the set of user interface objects (e.g., user interface objects that displays notifications, alerts, communication sessions, activities, updates, and/or other content and/or controls for a contextually relevant application or content) that corresponds to the respective set of contextual conditions, in accordance with a determination that the respective portion of the currently displayed view does not have the first spatial relationship to the currently displayed view of the three-dimensional environment. In some embodiments, while displaying the first set of one or more user interface objects (or the second set of one or more user interface objects), the computer system detects that the user’s attention is no longer directed to the first portion of the first view of the three-dimensional environment that has the first spatial relationship to viewport through which the three-dimensional environment is visible (or a portion of the currently displayed view that has the first spatial relationship to the viewport, after a change in the view and viewpoint), the computer system ceases to display the first set of one or more user interface objects (or the second set of one or more user interface objects). In some embodiments, prior to displaying the first set of one or more user interface objects (or the second set of one or more user interface objects), in accordance with a determination that the attention of the user of the computer system is not directed to the first portion of the first view of the three-dimensional environment, the computer system does not display (e.g., forgoes displaying) the first set of one or more user interface objects and the second set of one or more user interface objects, regardless of whether any contextual conditions are met (e.g., the first set of one or more user interface object, or the second set of one or more user interface objects, are only displayed if the attention of the user is directed to a portion of the first view of the three-dimensional environment that has the first spatial relationship to the viewport while the respective set of one or more contextual conditions are met.

For example, as described with reference to FIG. 7AN, if the user’s attention 7116 is not directed to the indicator 7010 of system function menu (e.g., or a region such as the region 7160 in FIG. 7AM), the computer system 7100 does not display any contextual user interface (e.g., contextual user interfaces are not displayed without user interaction (e.g., a user input directed to a user interface object and/or region of the display). Forgoing display of the first set of one or more user interface objects while the first set of one or more contextual conditions are met, in accordance with a determination that the first portion of the first view of the three-dimensional environment does not have the first spatial relationship to the viewport through which the three-dimensional environment is visible, enables the computer system to display the first set of one or more user interface objects without needing to display additional controls (e.g., additional controls for displaying and/or ceasing to display the first set of one or more user interface objects).

In some embodiments, while displaying the first set of one or more user interface objects (e.g., that has been displayed in response to detecting the user’s attention being directed to a portion of the currently displayed view that has the first spatial relationship to the currently displayed view (and/or to the viewport through which the three-dimensional environment is visible) while the first set of contextual conditions are met), the computer system detects a first user input (e.g., an air gesture (e.g., an air tap or an air pinch) detected in conjunction with a gaze input; an air gesture, a touch gesture, an input provided via a controller, a voice command, and/or other types of input) directed to a respective user interface object of the first set of one or more user interface object (e.g., the respective user interface object is a notification, an alert, an update for a subscribed activity, and/or other content or control relevant to the first set of contextual conditions). In response to detecting the first user input, the computer system performs a first operation corresponding to the respective user interface object. In some embodiments, while displaying another set of one or more user interface objects that has been displayed in response to detecting the user’s attention being directed to a portion of the currently displayed view that has the first spatial relationship to the currently displayed view (and/or to the viewport) while another set of contextual conditions are met, the computer system performs a different operation in response to a user input directed to a respective user interface object of the displayed set of user interface objects. In some embodiments, allowing different sets of user interface objects to be displayed based on the current context enables different operations to be available to be performed depending on the context. For example, some possible contexts include an event corresponding to a time-sensitive notification (e.g., marked urgent, determined as urgent based on its content, or determined as time-sensitive based on keywords in its content and/or how it has been sent (e.g., with a time-sensitive flag, repeated without a short period of time, and/or other conditions)), a current time being within a threshold time period before a scheduled flight (e.g., based on a boarding pass stored on the computer system), ongoing media playback, and a live event with time-sensitive updates (e.g., food delivery in progress, sports game that is in progress, a detected workout that is in progress). In some embodiments, if the context involves an urgent notification, the operation includes responding to the notification, dismissing the notification, and/or opening an application associated with the notification. In some embodiments, if the context involves an alert or request that requires the user’s input to be dismissed, the operation includes dismissing the alert, providing an affordance for receiving the user’s input, and/or providing an affordance to turn off the alert and/or changing the delivery mode of similar alerts and requests of the current alert and/or request. In some embodiments, if the context involves a scheduled flight or boarding pass, the operation includes displaying the corresponding boarding pass, and/or displaying flight information. In some embodiments, if the context is ongoing media playback, the operation includes pausing the media playback, rewind or fast forwarding, navigating between different available tracks, and/or adjusting a volume of the media playback. In some embodiments, if the context is food delivery in progress, the first operation includes displaying information regarding the delivery (e.g., estimated delivery time), contacting a delivery driver, and/or requesting customer support. In some embodiments, if the context is a live sports game with time-sensitive updates, the first operation includes displaying a score and/or displaying player information or statistics. In some embodiments, if the context is a detected workout in progress, the first operation includes displaying information corresponding to the detected workout (e.g., calories burned and/or other biometric data received from one or more sensors in communication with the computer system). For example, in FIG. 7AS, the respective user interface object is the music user interface 7166 that includes media playback controls (e.g., a play affordance, a pause affordance, a next or fast forward affordance, and/or a previous or rewind affordance). In response to detecting a user input directed to a respective media playback control, the computer system 7100 performs a function associated with the respective media control (e.g., plays a current song, pauses a currently playing song, skips to the next song, fast-forwards through the currently playing song, navigates to a previous song, or rewinds through a currently playing song). Performing a first operation corresponding to the respective user interface object, in response to detecting the first user input directed to the respective user interface object of the first set of one or more user interface objects, enables the computer system to allow user interaction with specific user interface objects without displaying additional controls (e.g., without needing to display individual controls for interacting with each user interface object of the first set of one or more user interface obj ects).

In some embodiments, performing, in response to detecting the first user input, the first operation corresponding to the respective user interface object includes: in accordance with a determination that the first user input is a first type of input and the respective user interface object includes first information (e.g., is a first type of notification, a second type of notification, a first type of alert, a second type of alert, a live activity of a first type, a live activity of a second type, a session of a first type, a session of a second type, a first type of system status, a second type of system status, a first type of system control, or a second type of system control), performing a respective operation corresponding to the first information; and in accordance with a determination that the first user input is the first type of input and the respective user interface object includes second information (e.g., is a first type of notification, a second type of notification, a first type of alert, a second type of alert, a live activity of a first type, a live activity of a second type, a session of a first type, a session of a second type, a first type of system status, a second type of system status, a first type of system control, or a second type of system control) different from the first information, performing a respective operation corresponding to the second information, wherein the respective operation corresponding to the second information is different from the respective operation corresponding to the first information. In some embodiments, the respective user interface object including the first information is a notification, and the respective operation corresponding to the first information includes opening a first application associated with the notification and displaying content of the notification in the first application, or presenting a reply user interface (e.g., in the first application) for responding to the notification. In some embodiments, the respective user interface object including the second information is an alert, and the respective operation corresponding to the second information includes opening a modal window displaying more details associated with the alert, and optionally, displaying one or more controls to dispose of the alert in different ways (e.g., dismiss, snooze, or disabling similar types of alerts for the future). In some embodiments, the respective user interface object includes a respective type of information includes information regarding a subscribed live activity (e.g., delivery, sports game, flight information, news feed, and/or other activities with time-sensitive updates), and the first operation corresponds to the type of subscribed live activity (e.g., providing estimated arrival time and/or means to contact the driver, getting playback of scoring moments and/or getting player statistics, providing checking-in options and suggested transportation means, displaying related news or subscribe additional news feeds, and/or other operations corresponding to the type of information and the content of information presented in the respective user interface object). In some embodiments, the respective user interface object includes a respective type of information includes information regarding a system status or system control (e.g., battery level, connection type, network connection status, music playback status and controls, volume status and control, mobile carrier status, DND mode (e.g., status and/or control), fight mode (e.g., status and/or control), silent mode (e.g., status and/or control), and/or other system status and system controls), and the first operation corresponds to viewing and changing the system status or adjusting the system controls (e.g., changing battery charging mode, changing operation mode based on battery status, changing network, media playback, volume, and/or other system operation modes). For example, as described with reference to FIG. 7AO, the user 7002 can display additional content associated with a specific contextual user interface, by directing the user’s attention 7116 to the specific contextual user interface and performing a first type of user input (e.g., a first type of air gesture, input via a hardware controller, and/or verbal input). For example, if the user’s attention 7116 is directed to the incoming call user interface 7068 and the user performs the first type of user input, the computer system 7100 displays additional information regarding the communication session corresponding to the incoming call user interface 7068 (e.g., contact information for the contact “John Smith” and/or other contacts or users who are active in the communication session), optionally in an expanded version of the incoming call user interface 7068. If the user’ attention 7116 is directed to a notification 7148 and the user performs the first type of user input, the computer system 7100 displays additional notification content for the notification 7148. Performing a respective operation corresponding to first information, in accordance with a determination that the first user input is a first type of input and the respective user interface object includes the first information, and performing a respective operation corresponding to the second information, that is different from the operation corresponding to the first information, in accordance with a determination that the first user input is the first type of input and the respective user interface object includes second information, different from the first information, enables the computer system to perform an appropriate operation depending on what information is included in the respective user interface object, without needing to display additional controls (e.g., a first control for performing the operation corresponding to the first information, and a second control for performing the operation corresponding to the second information).

In some embodiments, the first user input that is the first type of input includes a selection user input (e.g., a verbal input and/or an air gesture, such as an air tap or an air pinch) while the attention of the user is directed to the respective user interface object. For example, as described with reference to FIG. 7AO, the user 7002 can display additional content associated with a specific contextual user interface, by directing the user’s attention 7116 to the specific contextual user interface and performing a selection user input (e.g., a first type of user input, such as a first type of air gesture, input via a hardware controller, and/or verbal input). Performing a respective operation corresponding to first information, in accordance with a determination that the first user input is a first type of input that includes a selection user input while the attention of the user is directed to the respective user interface object and the respective user interface object includes the first information, and performing a respective operation corresponding to the second information, that is different from the operation corresponding to the first information, in accordance with a determination that the first user input is the first type of input that includes a selection user input while the attention of the user is directed to the respective user interface object and the respective user interface object includes second information, different from the first information, enables the computer system to perform an appropriate operation depending on what information is included in the respective user interface object, without needing to display additional controls (e.g., a first control for performing the operation corresponding to the first information, and a second control for performing the operation corresponding to the second information).

In some embodiments, performing the first operation corresponding to the respective user interface object includes, in accordance with a determination that the respective user interface object is a first notification, displaying additional information corresponding to first notification (e.g., opening an application associated with the first notification and displaying the notification content in the context of other content and functions in the application). In some embodiments, in addition to displaying the additional information corresponding to the first notification, the computer system ceases to display other user interface objects (e.g., other user interface objects that also correspond to the first set of contextual conditions, or user interface objects that correspond to other contextual conditions that are also present) that were displayed with the respective user interface objects. For example, as described with reference to FIG. 7AO, if the user’ attention 7116 is directed to a notification 7148 and the user performs the first type of user input, the computer system 7100 displays additional notification content for the notification 7148. In some embodiments, the computer system ceases to display other contextual user interfaces (e.g., other than the contextual user interface that the user’s attention is directed to) in response to detecting a user input of the first type. Displaying additional information corresponding to first notification, in accordance with a determination that the first user input is a first type of input and in accordance with a determination that the respective user interface object is a first notification, and performing a respective operation corresponding to the second information, that is different from the operation corresponding to the first information, in accordance with a determination that the first user input is the first type of input and the respective user interface object includes second information, different from the first information, enables the computer system to perform an appropriate operation depending on what information is included in the respective user interface object, without needing to display additional controls (e.g., a first control for displaying additional information corresponding to first notification, and a second control for performing the operation corresponding to the second information).

In some embodiments, performing, in response to detecting the first user input, the first operation corresponding to the respective user interface object includes: in accordance with a determination that the first user input is a user input of a second type (e.g., the user’s attention (e.g., as indicated by the user’s gaze, or the position of a user controlled focus selector) being directed to the system function menu 7024 described with reference to FIG. 7E and FIG. 7AM, or the indicator 7010 of system function menu described with reference to FIG. 7A and FIG. 7AM, or the reactive region associated with displaying the indicator 7010 of system function menu or the system function menu 7024, optionally, for at least a threshold amount of time, and, optionally, without an accompanying selection input) different from the user input of the first type, displaying one or more affordances for accessing a first set of functions of the computer system (e.g., the system function menu 7024 described above (e.g., with reference to FIG. 7E and FIG. 7AM), or affordances included in the system space 7054 (described above with reference to FIG. 7K(d)). In some embodiments, displaying the one or more affordances for accessing the first set of functions of the computer system is independent of whether the first set of one or more contextual conditions or the second set of one or more contextual conditions are present. For example, in FIG. 7AQ-7AR, the user performs a respective air gesture while the user’s attention 7116 is directed to the partially visible system function menu 7024 (in FIG. 7AQ), and in response, the computer system 7100 displays the system function menu 7024 (e.g., fully visible, as shown in FIG. 7AR). Displaying one or more affordances for accessing a first set of functions of the computer system, in response to detecting the first user input that is a user input of a second type, different for the user input of the first type, enables the computer system to perform different operations without needing to display additional controls (e.g., a first control for performing a respective operation corresponding to information included in the respective user interface object, and a second control for displaying the one or more affordances for accessing a first set of functions of the computer system).

In some embodiments, the first user input that is a user input of the second type include a gaze input directed to a first region of the first view of the three-dimensional environment (e.g., the first region of the first view has a first spatial relationship to the first viewpoint of the user, or the indicator 7010 of system function menu (e.g., as described above with reference to FIGS. 7A-7D) is displayed in the first region of the first view). For example, in FIGS. 7AQ-7AR, the user performs a respective air gesture while the user’s attention 7116 is directed to (e.g., while the user gazes at) the partially visible system function menu 7024 (e.g., a first region of the first view of the three-dimensional environment) in FIG. 7AQ, and in response, the computer system 7100 displays the system function menu 7024 (e.g., fully visible, as shown in FIG. 7AR). As described with reference to FIG. 7AR, in some embodiments, the respective gesture is an air gesture (e.g., an air tap or an air pinch) in combination with a gaze component (e.g., gazing at the system function menu 7024, or an edge region of the displayed content items). Displaying one or more affordances for accessing a first set of functions of the computer system, in response to detecting the first user input that is a user input of a second type that includes a gaze input directed to a first region of the first view of the three-dimensional environment, enables the computer system to perform different operations without needing to display additional controls (e.g., a first control for performing a respective operation corresponding to information included in the respective user interface object, and a second control for displaying the one or more affordances for accessing a first set of functions of the computer system).

The method of any of claims 47-51, wherein performing, in response to detecting the first user input, the first operation corresponding to the respective user interface object includes: in accordance with a determination that the first user input is a user input of a third type (e.g., different from the user input of the first type and the user input of the second type), displaying a first additional user interface object (e.g., or a plurality of additional user interface objects) different from the respective user interface object. In some embodiments, the user input of the third type is a scroll input, and additional user interface objects are scrolled into view in response to the user input of the third type. In some embodiments, the additional user interface objects are other objects that correspond to the current context (e.g., context that met the first set of context conditions, context that met the second set of contextual conditions, or other context meeting other sets of context conditions). In some embodiments, the respective user interface object is a first notification of a plurality of stacked notifications, and a user input of the third type directed to the respective user interface object expands the stacked notifications and displays one or more additional notification with the first notification. In some embodiments, the respective user interface object is a representative object of a plurality of similar objects arranged in a stack, and a user input of the third type directed to the respective user interface object expands the stack and displays one or more additional objects of the same type or related types as the respective user interface object. For example, in FIGS. 7AN and 7AO, the respective user interface object (e.g., the incoming call user interface 7067) in initially displayed in FIG. 7AN. Additional user interface objects (e.g., the notifications 7148, 7150, 7152, and 7154) are displayed in FIG. 7AO (e.g., in response to detecting the user’s attention 7116 directed to the incoming call user interface 7067, optionally in combination with an air gesture, such as an air tap or an air pinch). Another example is shown in FIGS. 7AO and 7AP, where in response to detecting the user’s attention 7116 is directed to a location corresponding to a visual indication that the other additional content items are available (e.g., the smaller notification 7157 in FIG. 7AO), the computer system 7100 navigates through (e.g., scrolls display of) the displayed user interface objects such that additional notifications 7156 and 7158 are displayed (e.g., and notification 7160 is partially displayed). Displaying a first additional user interface object different from the respective user interface object, in response to detecting the first user input that is a user input of a third type, enables the computer system to perform different operations without needing to display additional controls (e.g., a first control for performing a respective operation corresponding to information included in the respective user interface object, and a second control for displaying the one or more affordances for accessing a first set of functions of the computer system, and a third control for displaying the first additional user interface object), and without needing to display the additional user interface object in all contexts.

In some embodiments, displaying the first additional user interface object includes concurrently displaying the first additional user interface object with the respective user interface object (and, optionally, other user interface objects in the first set or second set of user interface objects that were displayed at the time when the user’s attention is directed to the first portion of the first view of the three-dimensional environment). For example, in FIG. 7AO, the respective user interface object (e.g., the incoming call user interface 7068) is concurrently displayed with additional user interface objects (e.g., the notifications 7148, 7150, 7152, and 7154). Concurrently displaying a first additional user interface object with the respective user interface object, in response to detecting the first user input that is a user input of a third type, enables the computer system to perform different operations without needing to display additional controls (e.g., a first control for performing a respective operation corresponding to information included in the respective user interface object, and a second control for displaying the one or more affordances for accessing a first set of functions of the computer system, and a third control for displaying the first additional user interface object), and without needing to display the additional user interface object in all contexts.

In some embodiments, displaying the first additional user interface object includes: in accordance with a determination that a total number of the first set of user interface objects (e.g., of the first or second set of one or more user interface objects) that are currently visible in the first view of the three-dimensional environment (e.g., those that were initially displayed in response to detecting the user’s attention being directed to the first portion of the first view) is fewer than a first threshold number, displaying the first additional user interface object while maintaining display of the first set of user interface objects in the first view of the three-dimensional environment; and in accordance with a determination that the total number of the first set of user interface objects (e.g., of the first or second set of one or more user interface objects) that are currently visible in the first view of the three-dimensional environment (e.g., those that were initially displayed in response to detecting the user’s attention being directed to the first portion of the first view) is greater than or equal to the first threshold number, displaying the first additional user interface object and removing display of at least one of the first set of user interface objects from the first view of the three-dimensional environment. In some embodiments, display of the user interface objects that correspond to the first set of contextual conditions is capped, such that no more than a threshold number (e.g., the first threshold number plus one) of user interface objects that correspond to the first set of contextual conditions are visible at a given time. If more objects are available for display, when an additional object is brought into view by a user input of the third type, another object that were displayed at the time of the user input ceases to be displayed (e.g., faded out partially or completely). For example, In FIG. 7AO, the first threshold number is six, and the computer system displays the system function menu 7024, the incoming call user interface 7068, and four notifications 7148, 7150, 7152, and 7154, for a total of six items. The smaller notification 7157 is a visual indication that additional content is available for display, and does not count towards the first threshold number. In FIG. 7AP, six notifications are displayed (e.g., notifications 7148, 7150, 7152, 7154, 7156, and 7158), while visual indications (e.g., the smaller notification 7160, and reduced size user interfaces 7024 and 7068) indicate that additional content is available for display (e.g., at full or normal size) but not currently displayed (e.g., at full or normal size), and do not count towards the first threshold number. Displaying the first additional user interface object while maintaining display of the first set of user interface object in the first view of the three-dimensional environment, in accordance with a determination that a total number of the first set of user interface objects that are currently visible in the first view of the three-dimensional environment is fewer than a first threshold number, and displaying the first additional user interface object and removing display of at least one of the first set of user interface objects from the first view of the three-dimensional environment, in accordance with a determination that the total number of the first set of user interface objects that are currently visible in the first view of the three-dimensional environment) is greater than or equal to the first threshold number, reduces the number of user inputs needed to display the first additional user interface object (e.g., the user does not need to perform additional user inputs in order to first remove one of the first set of user interface objects from the first view, in order to make room to display the first additional user interface object).

In some embodiments, displaying the first additional user interface object includes replacing display of the respective user interface object with the first additional user interface object. For example, as described with reference to FIG. 7AO, in some embodiments, one or more of the additional content items (e.g., the notifications 7148, 7150, 7152, and/or 7154) are displayed in place of (e.g., replace display of) the respective user interface object (e.g., the incoming call user interface 7068). Replacing display of the respective user interface object with display of a first additional user interface object, in response to detecting the first user input that is a user input of a third type, enables the computer system to perform different operations without needing to display additional controls (e.g., a first control for performing a respective operation corresponding to information included in the respective user interface object, and a second control for displaying the one or more affordances for accessing a first set of functions of the computer system, and a third control for displaying the first additional user interface object), and without needing to display the additional user interface object in all contexts.

In some embodiments, at a first time when the respective user interface object occupies a respective portion of the first view that is associated with user attention (e.g., a central portion of the field of view, a portion that has the user’s gaze or focus selector, and/or a portion that is highlighted or selected): the respective user interface object is displayed at a first distance from a first viewpoint of the user that corresponds to the first view of the three-dimensional environment; the first additional user interface object is displayed at a second distance, different from the first distance (e.g., less than the first distance, or greater than the first distance), from the first viewpoint of the user at the first time; and at a second time when the first additional user interface object is moved into the respective portion of the first view that is associated with user attention (e.g., a central portion of the field of view, a portion that has the user’s gaze or focus selector, and/or a portion that is highlighted or selected), and the respective user interface is not displayed in the respective portion of the first view that is associated with user attention (e.g., the first additional user interface object is scrolled into, and the respective user interface object or another user interface object is scrolled out of the first portion of the first view):the first additional user interface object is displayed at the first distance from the first viewpoint of the user (e.g., optionally, the respective user interface object is displayed at the second distance, or a third distance, from the first viewpoint of the user). In some embodiments, the respective user interface object is displayed to appear further from the viewpoint of the user once the first additional user interface object moves into the region associated with higher user attention (e.g., because the computer system determines that the first additional user interface object has a higher priority, or is more relevant (e.g., is the target of the attention of the user) and should be displayed with increased prominence (e.g., closer to the viewpoint of the user)). In some embodiments, the newly displayed user interface object moves to a z-position that is closer to the current viewpoint of the user, to gain the user’s attention; and as the user causes additional user interface objects to be displayed (e.g., with additional inputs of the third input type), the previously displayed user interface objects recede or fade out of view, and the newly displayed user interface object is displayed at the same z-position from the current viewpoint of the user. For example, in FIG. 7AO, the incoming call user interface 7068 is displayed at a first distance from the viewpoint of the user, and the notification 7157 is displayed at a second distance from the first viewpoint of the user that is different from the first distance (e.g., the notification 7157 appears smaller and further away from the viewpoint of the user, as compared to the incoming call user interface 7068). In FIG. 7AP, the notification 7157 has moved into a respective portion of the first view that is associated with the user’s attention (e.g., a central portion of the field of view) and the notification 7157 is displayed at the first distance (e.g., the same distance that the incoming call user interface 7068 appears at in FIG. 7AO) from the user (e.g., appears larger and closer to the user, as compared to FIG. 7AO). Displaying the respective user interface object at a first distance from a first viewpoint of the user at a first time, and displaying the first additional user interface object at the first distance from the first viewpoint of the user at a second time, provides improved visual feedback to the user (e.g., by visually emphasizing and/or consistently displaying user interface objects that are a focal point of the user’s attention at a consistent distance from the first viewpoint of the user).

In some embodiments, the first user input that is the input of the third type includes a scrolling input (e.g.., including movement of in a first direction (e.g., an air pinch and drag gesture, a swipe gesture, optionally detected in conjunction with a gaze directed to the first set of user interface objects)). For example, as described with reference to FIG. 7AP, in some embodiments, the computer system 7100 displays the other additional content items in response to detecting a scrolling input (e.g., an air pinch and drag gesture, or a swipe gesture, that includes movement in a first direction). Displaying a first additional user interface object different from the respective user interface object, in response to detecting the first user input that is a user input of a third type that includes a scrolling input, enables the computer system to perform different operations without needing to display additional controls (e.g., a first control for performing a respective operation corresponding to information included in the respective user interface object, and a second control for displaying the one or more affordances for accessing a first set of functions of the computer system, and a third control for displaying the first additional user interface object), and without needing to display the additional user interface object in all contexts.

In some embodiments, the first user input that is the input of the third type includes a gaze input (e.g., a gaze input directed to a respective region for a threshold amount of time, a gaze and dwell input directed to a target object or location, optionally, without detecting another type of input (e.g., a gesture, a voice command, or another type of input modality)). In some embodiments, the computer system responds to gaze, optionally, with time, location, and/or stability criteria, to trigger display of the first additional user interface object (e.g., the system function menu 7024 of FIG. 7E), without requiring other types of inputs from the user. In other words, gaze alone is sufficient to trigger display of the first additional user interface object, in some embodiments. For example, as described with reference to, and shown in, FIG. 7AP, the first user input includes directing the user’s attention to a location within a threshold distance of the left edge of the display of the computer system 7100 (e.g., and/or beyond a threshold distance of a center point (or region) of the display). As described with reference to FIG. 7AP. Displaying a first additional user interface object different from the respective user interface object, in response to detecting the first user input that is a user input of a third type that includes a gaze input, enables the computer system to perform different operations without needing to display additional controls (e.g., a first control for performing a respective operation corresponding to information included in the respective user interface object, and a second control for displaying the one or more affordances for accessing a first set of functions of the computer system, and a third control for displaying the first additional user interface object), and without needing to display the additional user interface object in all contexts.

In some embodiments, before displaying the first additional user interface object, the respective user interface object is displayed with a first level of visual prominence in the first view of the three-dimensional environment, and while displaying (e.g., with the first level of visual prominence, or another level of visual prominence higher than the first level of visual prominence) the first additional user interface object in the first view of the three-dimensional environment, the respective user interface object is displayed with a second level of visual prominence that is lower that the first level of prominence (e.g., the first set of user interface objects is displayed with reduced prominence, is dimmed, is blurred, or is no longer visible). While displaying the first additional user interface object, the computer system detects a second user input (e.g., an air gesture (e.g., an air tap or an air pinch) detected in conjunction with a gaze input; an air gesture, a touch gesture, an input provided via a controller, a voice command, and/or other types of input). In response to detecting the second user input, in accordance with a determination that the second user input corresponds to a request to display the respective user interface object, the computer system displays the respective user interface object with the first level of prominence (e.g., displaying the respective user interface object with an original level of prominence) (and optionally, ceasing to display the first additional user interface object, or displaying the first additional user interface object with a reduced level of visual prominence). For example, in FIGS. 7AQ and 7AR, the user’s attention 7116 is directed to the system function menu 7024 (in FIG. 7AQ), optionally in conjunction with an air gesture (e.g., an air tap or an air pinch), and in response, the computer system displays the system function menu 7024 (e.g., at the normal or default size, as shown in FIG. 7AR). This is also described with reference to FIG. 7AR, where in some embodiments, the user can perform a respective gesture (e.g., an air gesture, such as an air tap or an air pinch, or another selection input) in order to quickly return to the earlier (or earliest) displayed user interface elements. In some embodiments, the respective gesture is an air gesture (e.g., an air tap or an air pinch) in combination with a gaze component (e.g., gazing at the system function menu 7024, or an edge region of the displayed content items). Displaying the respective user interface object with a second level of prominence that is lower than a first level of prominence, while displaying the first additional user interface object in the first view of the three-dimensional environment, and displaying the respective user interface object with the first level of prominence in response to detecting, while displaying the first additional user interface object, a second user input that corresponds to a request to display the respective user interface object, provides improved visual feedback to the user (e.g., by increasing or decreasing a level of prominence of the respective user interface object in response to detecting different user inputs (e.g., which may result in different user interface objects, other than the respective user interface object, being displayed and/or being a focal point of the user’s attention)).

In some embodiments, while displaying the first set of one or more user interface objects (e.g., that has been displayed in response to detecting the user’s attention being directed to a portion of the currently displayed view that has the first spatial relationship to the currently displayed view while the first set of contextual conditions are met), the computer system detects a third user input (e.g., an air gesture (e.g., an air tap or an air pinch) detected in conjunction with a gaze input; an air gesture, a touch gesture, an input provided via a controller, a voice command, and/or other types of input). In response to detecting the third user input, and in accordance with a determination that the first user input is a user input of a fourth type (e.g., a swipe of the hand as a whole in the air, a tap on a close affordance associated with the first set of user interface objects) (e.g., different from the first type, second type, and third type), the computer system ceases to display the first set of one or more user interface objects (e.g., dismisses the set of user interface objects that is relevant to the first set of contextual conditions, without displaying or navigating to other user interface objects relevant to the first set of contextual conditions). In some embodiments, in accordance with a determination that the second set of user interface objects is displayed and in accordance with a determination that the first user input is a user input of the fourth type, the computer system ceases to display the second set of user interface objects (e.g., dismisses the set of user interface objects that is relevant to the second set of contextual conditions, without displaying or navigating to other user interface objects relevant to the second set of contextual conditions). In some embodiments, irrespective of which particular object in the first set of user interface object is the respective user interface object, the first set of user interface object as a whole is dismissed from the first view of the three-dimensional environment, in response to the user input of the fourth type. For example, as described with reference to FIG. 7AT, in response to detecting that the user’s attention is no longer directed to one of the contextual user interfaces (and/or the indicator 7010 of system function menu), the computer system ceases to display the contextual user interfaces. In some embodiments, the computer system 7100 ceases to display the contextual user interfaces in response to detecting a respective air gesture (e.g., in combination with a gaze input), a touch gesture, an input provided via a controller, and/or a voice command. Ceasing to display the first set of one or more user interface objects, in response to detecting the first user input that is a user input of a fourth type, enables the computer system to perform different operations without needing to display additional controls (e.g., a first control for performing a respective operation corresponding to information included in the respective user interface object, and a second control for displaying the one or more affordances for accessing a first set of functions of the computer system, a third control for displaying the first additional user interface object, and a fourth control for ceasing to display the first set of one or more user interface objects).

In some embodiments, the third user input that is an input of the fourth type includes a gaze input directed away from a region occupied by the first set of one or more user interface objects for at least a threshold amount of time (e.g., detecting the user’s attention being directed away from the system function menu 7024 of FIG. 7E and FIG. 7AM, or a displayed system space of FIG. 7K, for at least a threshold amount of time). For example, as described with reference to FIG. 7AT, in response to detecting that the user’s attention 7116 is no longer directed to one of the contextual user interfaces and/or the indicator 7010 of system function menu (e.g., for a threshold amount of time, such as 1 second, 2 seconds, or 5 seconds), the computer system ceases to display the contextual user interfaces. Ceasing to display the first set of one or more user interface objects, in response to detecting the first user input that is a user input of a fourth type that includes a gaze input directed away from a region occupied by the first set of one or more user interface objects for at least a threshold amount of time, enables the computer system to perform different operations without needing to display additional controls (e.g., a first control for performing a respective operation corresponding to information included in the respective user interface object, and a second control for displaying the one or more affordances for accessing a first set of functions of the computer system, a third control for displaying the first additional user interface object, and a fourth control for ceasing to display the first set of one or more user interface objects).

In some embodiments, the third user input that is an input of the fourth type includes movement in a first direction (e.g., a scrolling movement with an air pinch and drag gesture in a first direction, a swipe gesture in a first direction, or other movement in a first direction that is caused by the user). In some embodiments, the third user input is a scroll input in an upward direction. In some embodiments, the third user input is a scroll input in a downward direction. In some embodiments, the third user input causes the additional user interface objects corresponding to the first set of contextual conditions to come into view, and causes the first set of user interface objects to pushed out of the first view. This is described with reference to FIG. 7AT, the computer system 7100 ceases to display the contextual user interfaces in response to detecting a user input that includes movement in a respective direction. For example, if a user input continues to move towards the right of the display of the computer system 7100 in FIG. 7AO, the computer system 7100 ceases to display the contextual user interfaces (e.g., because there are no additional user interfaces available for display beyond the system function menu 7024 (e.g., to the right of the system function menu 7024), but the user input continues to move in the rightward direction). Ceasing to display the first set of one or more user interface objects, in response to detecting the first user input that is a user input of a fourth type that includes movement in a first direction, enables the computer system to perform different operations without needing to display additional controls (e.g., a first control for performing a respective operation corresponding to information included in the respective user interface object, and a second control for displaying the one or more affordances for accessing a first set of functions of the computer system, a third control for displaying the first additional user interface object, and a fourth control for ceasing to display the first set of one or more user interface objects).

In some embodiments, while displaying the first set of one or more user interface objects in the first view of the computer-generated environment (e.g., or another view that corresponds to the current viewpoint of the user), the computer system detects occurrence of a first event. In response to detecting occurrence of the first event, the computer system adds a new user interface object (e.g., a new notification or alert, an update to a subscribed event, or other object relevant to the first event) to the first set of one or more user interface objects (e.g., displaying the new user interface object in the same arrangement as the first set of one or more user interface objects, optionally, pushing one or more of the existing object in the first set of user interface objects outside of the current view), wherein the new user interface object corresponds to the first event. For example, as described with reference to FIG. 7AO, while displaying the additional content items, the computer system 7100 detects occurrence of an event (e.g., corresponding to a new notification), and the computer system 7100 displays a new notification corresponding to the event (e.g., optionally, at the location where the notification 7148 is displayed at in FIG. 7AO). Adding a new user interface object to the first set of one or more user interface objects, in response to detecting occurrence of a first event, wherein the first event is detected while displaying the first set of one or more user interface objects, reduces the number of user inputs needed to display the new user interface object that correspond to the first event (e.g., the user does not need to perform additional user inputs to refresh or update the displayed first set of one or more user interface objects in order to display the new user interface object in the first set of one or more user interface objects).

In some embodiments, in response to detecting that the attention of the user is directed to the first portion of the first view of the three-dimensional environment, and in accordance with a determination that the first portion of the first view has the first spatial relationship to the viewport through which the three-dimensional environment is visible, the computer system displays one or more indications of system status (e.g., a current date, a current time, a current battery level, a cellular signal strength, and/or wireless signal strength) for the computer system (e.g., regardless of which sets of contextual conditions are met, or whether any sets of contextual conditions are met at all). For example, as described with reference to FIG. 7AN, the system function menu 7024 includes status information about the computer system 7100 (e.g., Wi-Fi connection status, cellular connection status, a current time, and/or battery charge state), in addition to the plurality of affordances for accessing system functions of the computer system 7100. In some embodiments, the status information about the computer system 7100 is displayed in response to detecting that the user’s attention 7116 is directed to the user interface object 7064, but is displayed distinct from (e.g., in a separate user interface object, or in a region that is separate from) the system function menu 7024 (e.g., so that display of the status information about the computer system 7100 can be maintained, even if the system function menu 7024 is no longer displayed and/or no longer fully visible). Displaying one or more indications of system status for the computer system, in response to detecting that the attention of the user is directed to the first portion of the first view of the three-dimensional environment, and in accordance with a determination that the first portion of the first view has the first spatial relationship to the first view of the three-dimensional environment, provides improved visual feedback to the user (e.g., improved visual feedback regarding the state and/or status of the computer system).

In some embodiments, while displaying the first set of one or more user interface objects, and while displaying the one or more indications of system status for the computer system, the computer system detects a fourth user input (e.g., an air gesture (e.g., an air tap or an air pinch) detected in conjunction with a gaze input; an air gesture, a touch gesture, an input provided via a controller, a voice command, and/or other types of input). In response to detecting the fourth user input, the computer system scrolls the first set of one or more user interface objects (e.g., ceasing to display at least one user interface object of the first set of one or more user interface objects, displaying at least one user interface object of the first set of one or more user interface objects with a different level of prominence, and/or displaying at least one user interface object that corresponds to the first set of one or more contextual conditions, but was not previously visible), while maintaining display of the one or more indications of system status. For example, as described with reference to FIG. 7AN, the system function menu 7024 includes status information about the computer system 7100 (e.g., Wi-Fi connection status, cellular connection status, a current time, and/or battery charge state), in addition to the plurality of affordances for accessing system functions of the computer system 7100. In some embodiments, the status information about the computer system 7100 is displayed in response to detecting that the user’s attention 7116 is directed to the user interface object 7064, but is displayed distinct from (e.g., in a separate user interface object, or in a region that is separate from) the system function menu 7024 (e.g., so that display of the status information about the computer system 7100 can be maintained, even if the system function menu 7024 is no longer displayed and/or no longer fully visible, for example, as the computer system navigates through available contextual user interfaces). Scrolling the first set of one or more user interface objects while maintaining display of the one or more indications of system status, in response to detecting a fourth user input, reduces the number of user inputs needed to display the indications of system status (e.g., the user does not need to perform additional user inputs to redisplay the indications of system status when or while interacting with other user interfaces and/or user interface objects).

In some embodiments, while displaying the first set of user interface objects that correspond to the first set of contextual conditions, the computer system concurrently displays an indication of a second additional user interface object (e.g., an edge portion, a translucent and/or reduced representation, or some other indication) that corresponds to the first set of contextual conditions and that is available to be displayed (e.g., the second additional user interface object is partially occluded by the first set of one or more user interface objects). For example, in FIG. 7AO, the notification 7157 is an indication of a second additional user interface object (e.g., the notification 7157 in FIG. 7AP) that also corresponds to the first set of contextual conditions and that is available to be displayed (e.g., but is not displayed due to display size limitations). Another example is FIG. 7AP, where the notification 7160 is an analogous indication to the notification 7157 in FIG. 7AO, and where the user interface 7068 and/or system function menu 7024 are indications of additional content available for display (e.g., but are displayed when navigating in the opposite direction, as compared to the notification 7160). Concurrently displaying an indication of a second additional user interface object that corresponds to the first set of contextual conditions and that is available to be displayed, with the first set of one or more user interface objects, provides improved visual feedback to the user (e.g., improved visual feedback that a second additional user interface object is available to be displayed).

In some embodiments, while the first set of one or more user interface objects is displayed with a first level of visual prominence (e.g., with a first distance from the viewpoint of the user, a first brightness, first opacity, and/or first level of blur), the indication of the second additional user interface object is displayed with a second level of visual prominence (e.g., with a second distance from the viewpoint of the user, a second brightness, second opacity, and/or second level of blur) that is lower than the first level of visual prominence (e.g., the first set of one or more user interface objects is displayed in front of or on top of (e.g., in the view of three-dimensional environment) the second additional user interface object, and/or the second additional user interface object appears dimmer, more translucent or transparent, and/or blurrier than the first set of one or more user interface objects). For example, in FIG. 7AO, the notification 7157 is displayed a lower level of visual prominence than the user interface 7068 and the notifications 7148, 7150, 7152, and 7154 (e.g., the notification 7157 appears smaller than, and behind, the other contextual user interfaces). Concurrently displaying an indication of a second additional user interface object that corresponds to the first set of contextual conditions and that is available to be displayed, with a second level of visual prominence lower that a first level of visual prominence, with the first set of one or more user interface objects displayed with the first level of visual prominence, provides improved visual feedback to the user (e.g., improved visual feedback that a second additional user interface object is available to be displayed), and also assists the user in locating and identifying the currently displayed user interface objects (e.g., which are displayed with, and/or among, other user interface objects and/or visual indications or indicators).

In some embodiments, while the first set of one or more user interface objects is displayed with the first level of visual prominence (e.g., with a first distance from the viewpoint of the user, a first brightness, first opacity, and/or first level of blur) and the indication of the second additional user interface object is displayed with the second level of visual prominence (e.g., with a second distance from the viewpoint of the user, a second brightness, second opacity, and/or second level of blur) that is lower than the first level of prominence, the computer system detects a fifth input (e.g., an air gesture (e.g., an air tap or an air pinch) detected in conjunction with a gaze input; an air gesture, a touch gesture, an input provided via a controller, a voice command, and/or other types of input) directed to the indication of the second additional user interface object (e.g., a gaze input, a gaze and dwell input, a gaze input in conjunction with an air gesture (e.g., an air tap, or air pinch gesture)). In response to detecting the fifth user input directed to the indication of the second additional user interface object, the computer system displays the second additional user interface object with a third level of visual prominence, wherein the third level of visual prominence is greater than the second level of prominence. In some embodiments, the third level of visual prominence is the same as the first level of visual prominence. For example, in FIG. 7AP, the notification 7157 is displayed with the same level of prominence as the notifications 7148, 7150, 7152, 7154, and 7158, and this level of prominence is higher than the level of prominence that the notification 7157 was displayed with in FIG. 7AO (e.g., in FIG. 7AP, the notification 7157 has a larger size and is closer to the viewpoint of the user, as compared to FIG. 7AO). Displaying the second additional user interface object with a third level of visual prominence that is greater than the second level of prominence, in response to detecting a fifth user input directed to the indication of the second additional user interface object, automatically displays the second additional user interface object with an appropriate level of visual prominence without requiring additional user inputs (e.g., the user does not need to manually adjust the level of visual prominence for the second additional user interface object).

In some embodiments, displaying the first set of one or more user interface objects includes displaying content (e.g., user interface objects including information related to the current state and/or controls for modifying the current state) corresponding to (e.g., conveying the status, change in status, and/or other information of) the current state of the computer system (e.g., one or more ongoing sessions, such as real-time communication sessions (e.g., telephone calls, video conferences, and/or copresence or shared experiences in an AR or VR environment), vehicle navigation sessions, active guest mode, full-screen media playback mode, screen recording mode, screen mirroring mode, and/or other active and ongoing events or operation modes of the computer system). For example, as described with reference to FIG. 7AT (and FIG. 7AM-7AT generally), possible examples of contextual user interfaces include user interfaces that indicate a status of the computer system 7100 (e.g., a user interface that indicates there is an active call in progress, a user interface that indicates that a guest mode of the computer system 7100 is active, a user interface that indicates that a full screen mode of the computer system 7100 is active, a user interface that indicates the computer system 7100 is currently recording the screen (e.g., display) activity, a user interface that indicates that the display of the computer system 7100 is currently being mirrored (e.g., shared) on or with another computer system, a user interface that indicates that a specific mode (e.g., a Do Not Disturb mode, a reading mode, a driving mode, and/or a travel or other motion-based mode) of the computer system 7100 is active, and/or a user interface corresponding to media content (e.g., audio content, music content, and/or video content) that is playing (or currently paused) on the computer system 7100. Displaying a first set of one or more user interface objects, including content that corresponds to a current state of the computer system, that correspond to a first set of one or more contextual conditions, and displaying a second set of one or more user interface objects that correspond to a second set of one or more contextual conditions, in response to detecting that the attention of the user is directed to a first portion of the first view of the three-dimensional environment, enables the computer system to automatically display different content (e.g., sets of one or more user interface objects) based on what contextual conditions are met at the time a user’s attention is directed to a portion of the first view of the three-dimensional environment. This reduces the number of user inputs needed to display contextually relevant content (e.g., the user does not need to manually navigate to contextually relevant content, and/or the user does not need to perform additional user inputs to select what content is (or is not) contextually relevant at the current time).

In some embodiments, displaying the first set of one or more user interface objects includes displaying a first set of one or more affordances for performing operations corresponding to the first set of one or more contextual conditions (e.g., affordances for accepting/declining a real-time communication session, terminating or modifying a vehicle navigation session, ending or modifying an active guest mode, existing or pausing a full-screen media playback mode, ending or pausing a screen recording mode, ending, pausing, or reconfiguring a screen mirroring mode, and/or affordance for otherwise changing or terminating other active and ongoing events or operation modes). For example, as described with reference to FIG. 7AT (and FIG. 7AM-7AT generally), a respective contextual user interface include one or more affordances for performing operations corresponding to the respective contextual user interface (e.g., an accept and/or decline affordance for joining or dismissing a communication session, affordances for activating and/or deactivating a full screen mode/screen-mirroring mode/Do Not Disturb mode/reading mode/driving mode/travel or motion-based mode, or media control affordances for media content that is playing on the computer system 7100). Displaying a first set of one or more user interface objects, including a first set of one or more affordances for performing operations corresponding to a first set of one or more contextual conditions, that correspond to the first set of one or more contextual conditions, and displaying a second set of one or more user interface objects that correspond to the second set of one or more contextual conditions, in response to detecting that the attention of the user is directed to a first portion of the first view of the three-dimensional environment, enables the computer system to automatically display different content (e.g., sets of one or more user interface objects) based on what contextual conditions are met at the time a user’s attention is directed to a portion of the first view of the three-dimensional environment. This reduces the number of user inputs needed to display contextually relevant content (e.g., the user does not need to manually navigate to contextually relevant content, and/or the user does not need to perform additional user inputs to select what content is (or is not) contextually relevant at the current time).

In some embodiments, displaying the first set of one or more user interface objects includes displaying application content corresponding to a first application (e.g., content such as notifications, file transfers, and download progress corresponding to respective applications). For example, as described with reference to FIG. 7AT (and FIG. 7AM-7AT generally), possible examples of contextual user interfaces include application-related user interfaces, such as notifications, a user interface corresponding to a wireless sharing protocol (e.g., to transfer and/or share data with other computer systems), and/or a user interface displaying application function progress (e.g., a download progress for an active download, or update progress for an update of an application of the computer system 7100). Displaying a first set of one or more user interface objects, including application content corresponding to a first application, that correspond to a first set of one or more contextual conditions, and displaying a second set of one or more user interface objects that correspond to the second set of one or more contextual conditions, in response to detecting that the attention of the user is directed to a first portion of the first view of the three-dimensional environment, enables the computer system to automatically display different content (e.g., sets of one or more user interface objects) based on what contextual conditions are met at the time a user’s attention is directed to a portion of the first view of the three-dimensional environment. This reduces the number of user inputs needed to display contextually relevant content (e.g., the user does not need to manually navigate to contextually relevant content, and/or the user does not need to perform additional user inputs to select what content is (or is not) contextually relevant at the current time).

In some embodiments, the first set of one more user interface object includes two or more of: a first user interface object that includes first application content from the first application (e.g., notifications from the first application, file transfer for a file type associated with the first application, download progress for downloading the first application, and/or other content from the first application); a second user interface object that includes second application content from a second application different from the first application (e.g., notifications from the second application, file transfer for a file type associated with the second application, download progress for downloading the second application, and/or other content from the second application); and a third user interface object that includes system content (e.g., system alerts, system status indicators, and other system-related content that is not specific to a particular application installed on the system) corresponding to a current state of the computer system (e.g., charging status, low battery status, screen recording, privacy mode, DND mode, file sharing, file transfer, and network connectivity, peripheral device connectivity, and other system status and operation modes). For example, as described with reference to FIG. 7AT (and FIG. 7AM-7AT generally), the computer system 7100 displays contextual user interfaces for a plurality of distinct applications (e.g., with one or more of the contextual user interfaces being displayed as additional content, for example, as shown in FIG. 7AP). The notifications 7154, 7156, and 7158 in FIG. 7AP could each be notifications for three distinct applications (e.g., but notifications 7150, 7152, and 7154 are notifications for the same application). In some embodiments, the computer system 7100 displays contextual user interfaces that include at least one application-related user interface and at least one system-related user interface (e.g., the notifications 7148, 7150, 7152, 7154, and 7156 in FIG. 7AO are application-related user interfaces displayed concurrently with the system function menu 7024, a system-related user interface). Displaying a first set of one or more user interface objects that correspond to a first set of one or more contextual conditions, wherein the first set of one more user interface objects include two or more of a first user interface object including first application content from a first application, a second user interface object including second application content from a second application, and a third user interface object that includes system content corresponding to a current state of the computer system, and displaying a second set of one or more user interface objects that correspond to the second set of one or more contextual conditions, in response to detecting that the attention of the user is directed to a first portion of the first view of the three-dimensional environment, enables the computer system to automatically display different content (e.g., sets of one or more user interface objects) based on what contextual conditions are met at the time a user’s attention is directed to a portion of the first view of the three-dimensional environment. This reduces the number of user inputs needed to display contextually relevant content (e.g., the user does not need to manually navigate to contextually relevant content, and/or the user does not need to perform additional user inputs to select what content is (or is not) contextually relevant at the current time).

In some embodiments, displaying the first set of one or more user interface objects includes displaying the first set of one or more user interface objects with first prioritization of the first set of one or more user interface objects that is based on the first set of one or more contextual conditions, and displaying the second set of one or more user interface objects includes displaying the second set of one or more user interface objects with second prioritization of the second set of one or more user interface objects that is based on the second set of one or more contextual conditions. In other words, the user interface objects in the contextual user interface are prioritized based on a state of the computer system at a time when the contextual user interface was invoked. User interface objects can be prioritized in different ways. In some embodiments, prioritization includes an order of user interface objects (e.g., objects with higher priority are displayed in front of and/or on top of objects with lower priority) (e.g., objects are displayed in a list (e.g., with the same z-depth), and objects ranked higher in the list (e.g., towards the top of the list) are prioritized over objects that are lower in the list. In some embodiments, prioritization includes whether an object is displayed or not (e.g., objects that are prioritized are displayed, while objects that are not prioritized are not displayed). In some embodiments, prioritization includes relative visual prominences of the displayed objects (e.g., objects with higher priority are displayed with higher levels of visual prominence (e.g., brighter, with a different color, with thicker borders, with a larger size, with larger text, with bolded text, and/or with a different font) as compared to objects with lower priority, which are displayed with lower levels of visual prominence (e.g., dimmer, with thinner (or default sized) borders, with a smaller (or default) size, with smaller (or default) text, without bolded text, and/or with a default font). For example, as described with reference to FIG. 7AS, the respective priority order is determined based on a state of the device when the user’s attention 7116 is directed to the indicator 7010 of system function menu (or a user interface object that replaces the indicator 7010 of system function menu, such as the user interface object 7064 of FIGS. 7R-7U, or the user interface object 7056 of FIGS. 7L-7O, if applicable). In FIG. 7AO, no music is playing, and the computer system 7100 prioritizes display of the user interface 7068 over the notifications 7148, 7150, 7152, and 7154 (e.g., the user interface 7068 is initially displayed without notifications in FIG. 7AN, and the user interface 7068 is displayed at the “top” (e.g., towards the right) of the list of user interfaces that the user can navigate through, in FIG. 7AO). At a different time, such as in FIG. 7AS, music is playing, and the computer system prioritizes display of the contextual user interfaces differently (e.g., the music user interface 7166 is prioritized over the incoming call user interface 7068, and some notifications that were displayed in FIG. 7AO are not displayed in FIG. 7AT). Displaying a first set of one or more user interface objects with first prioritization that is based on a first set of one or more contextual conditions, and displaying a second set of one or more user interface objects with second prioritization based on the second set of one or more contextual conditions, automatically prioritizes displayed user interface objects without requiring further user input (e.g., the user does not need to perform additional user inputs to manually sort and/or order displayed user interface objects).

In some embodiments, prior to detecting that the attention of the user is directed to the first portion of the first view of the three-dimensional environment, the computer system displays a preview (e.g., an icon, an indicator, or other types of preview or hint) of a first user interface object of the first set of user interface objects (e.g., a first communication request or a first notification) (e.g., in the first portion of the first view of the three-dimensional environment, in the system function menu 7024 described with reference to FIG. 7E and FIG. 7AM, in the indicator 7010 of system function menu described with reference to FIG. A and FIG. 7AM, or in another portion of the first view), wherein the first user interface object corresponds to a notification or a request (e.g., notification generated by applications, messages, and/or communication requests for a telephone call, video call, copresence in AR or VR session). In accordance with a determination that the attention of the user is directed to the first portion of the first view of the three-dimensional environment after (e.g., in response to, and/or or within a first time window of) the preview of the first user interface object is displayed in the first view of the three-dimensional environment, the computer system prioritizes display of the first user interface object in the first set of user interface objects (e.g., highlighting the first user interface object; displaying the first user interface object in a center or top of the first set of user interface objects, when displaying the first set of user interface objects in response to detecting that the attention of the user is directed to the first portion of the first view of the three-dimensional environment; and/or displaying the first user interface object and not displaying at least some other objects in the first set of user interface objects). User interface objects can be prioritized in different ways. In some embodiments, prioritization includes an order of user interface objects (e.g., objects with higher priority are displayed in front of and/or on top of objects with lower priority) (e.g., objects are displayed in a list (e.g., with the same z-depth), and objects ranked higher in the list (e.g., towards the top of the list) are prioritized over objects that are lower in the list. In some embodiments, prioritization includes whether an object is displayed or not (e.g., objects that are prioritized are displayed, while objects that are not prioritized are not displayed). In some embodiments, prioritization includes relative visual prominences of the displayed objects (e.g., objects with higher priority are displayed with higher levels of visual prominence (e.g., brighter, with a different color, with thicker borders, with a larger size, with larger text, with bolded text, and/or with a different font) as compared to objects with lower priority, which are displayed with lower levels of visual prominence (e.g., dimmer, with thinner (or default sized) borders, with a smaller (or default) size, with smaller (or default) text, without bolded text, and/or with a default font). For example, in FIG. 7AN, there is a pending request to join a communication session, so the computer system 7100 displays the user interface object 7064 (e.g., as a preview of the request). The computer system 7100 prioritizes display of the incoming call user interface 7068 in response to detecting the user’s attention 7116 directed to the user interface object 7064 (e.g., over displaying the system function menu 7024). Prioritizing display of a first user interface object that corresponds to a notification or a request, in the first set of user interface objects, automatically prioritizes displayed user interface objects without requiring further user input (e.g., the user does not need to perform additional user inputs to manually sort and/or order displayed user interface objects).

In some embodiments, in accordance with a determination that the first set of user interface objects includes the first user interface object that corresponds to a first notification and includes a second user interface object that corresponds to a first request, the computer system prioritizes display of the second user interface object over display of the first user interface object (when displaying the first set of user interface objects in response to detecting that the attention of the user is directed to the first portion of the first view of the three-dimensional environment). User interface objects can be prioritized in different ways. In some embodiments, prioritization includes an order of user interface objects (e.g., objects with higher priority are displayed in front of and/or on top of objects with lower priority) (e.g., objects are displayed in a list (e.g., with the same z-depth), and objects ranked higher in the list (e.g., towards the top of the list) are prioritized over objects that are lower in the list. In some embodiments, prioritization includes whether an object is displayed or not (e.g., objects that are prioritized are displayed, while objects that are not prioritized are not displayed). In some embodiments, prioritization includes relative visual prominences of the displayed objects (e.g., objects with higher priority are displayed with higher levels of visual prominence (e.g., brighter, with a different color, with thicker borders, with a larger size, with larger text, with bolded text, and/or with a different font) as compared to objects with lower priority, which are displayed with lower levels of visual prominence (e.g., dimmer, with thinner (or default sized) borders, with a smaller (or default) size, with smaller (or default) text, without bolded text, and/or with a default font). For example, in FIG. 7AN, the incoming call user interface 7068 is prioritized over notifications (e.g., the notifications 7148, 7150, 7152, and 7154, 7156, 7158 and 7160, which are all available for display but are not displayed in FIG. 7AN). Prioritizing display of a second user interface object that corresponds to a first request, over display of a first user interface object that corresponds to a first notification, automatically prioritizes displayed user interface objects without requiring further user input (e.g., the user does not need to perform additional user inputs to manually sort and/or order displayed user interface objects).

In some embodiments, prior to detecting that the attention of the user is directed to the first portion of the first view of the three-dimensional environment, the computer system displays a preview (e.g., an icon, an indicator, or other types of preview or hint) of a third user interface object of the first set of user interface objects (e.g., a first activity) (e.g., in the first portion of the first view of the three-dimensional environment, in the system function menu 7024 described with reference to FIG. 7E and FIG. 7AM, in the indicator 7010 of system function menu described with reference to FIG. A and FIG. 7AM, or in another portion of the first view), wherein the third user interface object corresponds to an ongoing activity (e.g., a subscribed event or activity that generates time-sensitive updates, such as delivery, sports games, flight status, and/or news). In accordance with a determination that the attention of the user is directed to the first portion of the first view of the three-dimensional environment after (e.g., in response to, and/or or within a first time window of) the preview of the third user interface object is displayed in the first view of the three-dimensional environment, the computer system prioritizes display of the third user interface object in the first set of user interface objects (e.g., highlighting the second user interface object; displaying the second user interface object in a center or top of the first set of user interface objects, when displaying the first set of user interface objects in response to detecting that the attention of the user is directed to the first portion of the first view of the three-dimensional environment; and/or displaying the first user interface object and not displaying at least some other objects in the first set of user interface objects). User interface objects can be prioritized in different ways. In some embodiments, prioritization includes an order of user interface objects (e.g., objects with higher priority are displayed in front of and/or on top of objects with lower priority) (e.g., objects are displayed in a list (e.g., with the same z-depth), and objects ranked higher in the list (e.g., towards the top of the list) are prioritized over objects that are lower in the list. In some embodiments, prioritization includes whether an object is displayed or not (e.g., objects that are prioritized are displayed, while objects that are not prioritized are not displayed). In some embodiments, prioritization includes relative visual prominences of the displayed objects (e.g., objects with higher priority are displayed with higher levels of visual prominence (e.g., brighter, with a different color, with thicker borders, with a larger size, with larger text, with bolded text, and/or with a different font) as compared to objects with lower priority, which are displayed with lower levels of visual prominence (e.g., dimmer, with thinner (or default sized) borders, with a smaller (or default) size, with smaller (or default) text, without bolded text, and/or with a default font). For example, as described above with reference to FIG. 7AS, the computer system 7100 provides a preview corresponding to contextual user interfaces that are available for display and if a preview is displayed, the contextual user interface corresponding to the preview is prioritized above other contextual user interfaces available for display. For example, the user interface object 7064 (e.g., in FIG. 7R) is a preview of the incoming call user interface 7068 (e.g., a preview that indicates that the incoming call user interface 7068 will be displayed if the user directs the user’s attention to the user interface object 7064). Prioritizing display of a third user interface object that corresponds to an ongoing activity (e.g., over display of a first user interface object that corresponds to a first notification, and/or display of a second user interface object that corresponds to a first request), automatically prioritizes displayed user interface objects without requiring further user input (e.g., the user does not need to perform additional user inputs to manually sort and/or order displayed user interface objects).

In some embodiments, in accordance with a determination that no preview of a respective user interface object of the first set of user interface objects was displayed before (e.g., at the time that, and/or within a first time window of) the attention of the user is directed to the first portion of the first view of the three-dimensional environment, the computer system prioritizes display of a fourth user interface object that corresponds to a system control (e.g., volume control, display brightness control, network connectivity control, media playback controls, and other system controls) in the first set of user interface objects (e.g., highlighting the fourth user interface object; displaying the fourth user interface object in a center or top of the first set of user interface objects, when displaying the first set of user interface objects in response to detecting that the attention of the user is directed to the first portion of the first view of the three-dimensional environment; and/or displaying the first user interface object and not displaying at least some other objects in the first set of user interface objects). User interface objects can be prioritized in different ways. In some embodiments, prioritization includes an order of user interface objects (e.g., objects with higher priority are displayed in front of and/or on top of objects with lower priority) (e.g., objects are displayed in a list (e.g., with the same z-depth), and objects ranked higher in the list (e.g., towards the top of the list) are prioritized over objects that are lower in the list. In some embodiments, prioritization includes whether an object is displayed or not (e.g., objects that are prioritized are displayed, while objects that are not prioritized are not displayed). In some embodiments, prioritization includes relative visual prominences of the displayed objects (e.g., objects with higher priority are displayed with higher levels of visual prominence (e.g., brighter, with a different color, with thicker borders, with a larger size, with larger text, with bolded text, and/or with a different font) as compared to objects with lower priority, which are displayed with lower levels of visual prominence (e.g., dimmer, with thinner (or default sized) borders, with a smaller (or default) size, with smaller (or default) text, without bolded text, and/or with a default font). For example, in FIG. 7AM, no request to join an active communication session is pending (e.g., so no preview, such as the user interface object 7064 in FIG. 7AN is displayed), so the computer system 7100 prioritizes display of the system function menu 7024. Prioritizing display of a fourth user interface object that corresponds to a system control in the first set of user interface objects, in accordance with a determination that no preview of a respective user interface object of the first set of user interface objects was displayed before the attention of the user is directed to the first portion of the first view of the three-dimensional environment, automatically prioritizes displayed user interface objects without requiring further user input (e.g., the user does not need to perform additional user inputs to manually sort and/or order displayed user interface objects).

In some embodiments, in accordance with a determination that the first set of user interface objects include two or more user interface objects that correspond to notifications (and/or requests), the computer system prioritizes display of the two or more user interface objects that correspond to notification (and/or requests) in accordance with respective timestamps associated with the two or more user interface objects (e.g., listing them in chronological order or reverse chronological order). For example, for user older notifications can be assigned lower priority scores, such that the most recent notifications are displayed with the most prominence, while older notifications are displayed with reduced prominence. In some embodiments, notifications are assigned a second priority score (or a sub-priority score), for purposes of ordering notifications with respect to other notifications, while a (first) priority score (or actual priority score) determines how notification user interface objects (collectively) are ordered with respect to user interface objects of other types (e.g., user interface objects corresponding to communication requests, activities, or a plurality of affordances for accessing a first set of functions of the computer system). User interface objects can be prioritized in different ways. In some embodiments, prioritization includes an order of user interface objects (e.g., objects with higher priority are displayed in front of and/or on top of objects with lower priority) (e.g., objects are displayed in a list (e.g., with the same z-depth), and objects ranked higher in the list (e.g., towards the top of the list) are prioritized over objects that are lower in the list. In some embodiments, prioritization includes whether an object is displayed or not (e.g., objects that are prioritized are displayed, while objects that are not prioritized are not displayed). In some embodiments, prioritization includes relative visual prominences of the displayed objects (e.g., objects with higher priority are displayed with higher levels of visual prominence (e.g., brighter, with a different color, with thicker borders, with a larger size, with larger text, with bolded text, and/or with a different font) as compared to objects with lower priority, which are displayed with lower levels of visual prominence (e.g., dimmer, with thinner (or default sized) borders, with a smaller (or default) size, with smaller (or default) text, without bolded text, and/or with a default font). For example, as described with reference to FIG. 7AS, in some embodiments, the respective priority order is determined based at least in part on time (e.g., a time when a particular contextual user interface/content was generated or first displayed). In some embodiments, the contextual user interfaces are ordered in reverse temporal order (e.g., the newest contextual user interfaces have a higher priority). In some embodiments, the respective priority order determines the order of different categories of contextual user interfaces, and within each category, the contextual user interfaces of the same category are ordered by time (e.g., in reverse temporal order). Prioritizing display of two or more user interface objects that correspond to notifications in accordance with respective timestamps associated with the two or more user interface objects, automatically prioritizes displayed user interface objects without requiring further user input (e.g., the user does not need to perform additional user inputs to manually sort and/or order displayed user interface objects).

In some embodiments, in accordance with a determination that the first set of user interface objects include two or more user interface objects that correspond to requests, the computer system prioritizes display of the two or more user interface objects (e.g., displaying the two or more user interface objects above and/or on top of other user interface objects in the first set of user interface objects, displaying the two or more user interface objects while not displaying at least some other user interface objects in the first set of user interface objects, and/or displaying the two or more user interface objects with increased visual prominence relative to other user interface objects in the first set of user interface objects) that correspond to requests in accordance with preestablished prioritization for different types of requests (e.g., copresence requests are prioritized over video conference requests, and video conference requests are prioritized over voice-only communication requests). User interface objects can be prioritized in different ways. In some embodiments, prioritization includes an order of user interface objects (e.g., objects with higher priority are displayed in front of and/or on top of objects with lower priority) (e.g., objects are displayed in a list (e.g., with the same z-depth), and objects ranked higher in the list (e.g., towards the top of the list) are prioritized over objects that are lower in the list. In some embodiments, prioritization includes whether an object is displayed or not (e.g., objects that are prioritized are displayed, while objects that are not prioritized are not displayed). In some embodiments, prioritization includes relative visual prominences of the displayed objects (e.g., objects with higher priority are displayed with higher levels of visual prominence (e.g., brighter, with a different color, with thicker borders, with a larger size, with larger text, with bolded text, and/or with a different font) as compared to objects with lower priority, which are displayed with lower levels of visual prominence (e.g., dimmer, with thinner (or default sized) borders, with a smaller (or default) size, with smaller (or default) text, without bolded text, and/or with a default font). For example, as described with reference to FIG. 7AT, the activities category (which includes the music user interface 7166) has a higher priority than the requests category (which includes the incoming call user interface 7068), and the requests category has a higher priority than the notifications category (which includes the notifications 7148 and 7150). In FIG. 7AS, the computer system 7100 prioritizes display of the music user interface 7166 (e.g., over the incoming call user interface 7068, and notifications 7148 and 7150), because the activities category has a higher priority than requests or notifications. Prioritizing display of two or more user interface objects that correspond to requests in accordance with preestablished prioritization for different types of requests, automatically prioritizes displayed user interface objects without requiring further user input (e.g., the user does not need to perform additional user inputs to manually sort and/or order displayed user interface objects).

In some embodiments, aspects/operations of methods 8000, 9000, 10000, 11000, 12000, 13000, 14000, 15000, and 16000 may be interchanged, substituted, and/or added between these methods. For example, the first user interface object (e.g., system control indicator) in the method 13000 in some circumstances has a different appearance as described in the methods 9000-12000, and 14000-16000, and the user interface elements that are displayed (e.g., the plurality of affordances for accessing system functions of the first computer system) may be replaced by, or concurrently displayed with, other user interface elements (e.g., additional content associated with a notification, a user interface that includes an affordance for joining a communication session, and other user interface elements in the methods 9000-12000, and 14000-16000). For brevity, these details are not repeated here.

FIG. 14 is a flow diagram of an exemplary method 14000 for dismissing indications of notifications. In some embodiments, the method 14000 is performed at a computer system (e.g., computer system 101 in FIG. 1) (which is sometimes referred to as “the first computer system”) that is in communication with a display generation component (e.g., display generation component 120 in FIGS. 1, 3, and 4) (e.g., a heads-up display, a display, a touchscreen, or a projector) and one or more input devices (e.g., a touch screen, a camera, and/or a microphone). In some embodiments, the computer system optionally includes one or more cameras (e.g., a camera (e.g., color sensors, infrared sensors, and/or other depth-sensing cameras) that points towards the user (e.g., to detect the gaze of the user) and/or a camera that points forward (e.g., to facilitate displaying elements of the physical environment captured by the camera). In some embodiments, the method 9000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 9000 are, optionally, combined and/or the order of some operations is, optionally, changed.

Displaying a first indication of a first notification corresponding to a first event, and maintaining display of the first indication for a first duration of time and ceasing display of the first indication after expiration of the first duration of time, in accordance with a determination that attention of a user of the computer system was directed to the first indication within a first threshold amount of time and then moved away from the first indication before first criteria are met, and maintaining display of the first indication for a second duration of time and ceasing display of the first indication after expiration of the second duration of time different from the first duration of time, in accordance with a determination that the attention of the user of the computer system was not directed to the first indication within the first threshold amount of time, reduces the number of user inputs needed to cease display of the first indication after an appropriate amount of time (e.g., if the user’s attention is directed to the first indication within a first threshold amount of time, the first indication ceases to be displayed after a shorter amount of time (e.g., because the user’s attention was directed to the first indication and/or the user was able to view at least some content associated with the first notification); and if the user’s attention is not directed to the first indication within the first threshold amount of time, the first indication ceases to be displayed after a longer period amount of time (e.g., so that the user has time to direct the user’s attention to the first indication before the first indication ceases to be displayed)).

While a first view of an environment (e.g., a three-dimensional environment such as an AR, VR, or MR environment or a two-dimensional environment such as a user interface or desktop of a device) is visible via one or more display generation components, the computer system detects (14002) occurrence of a first event (e.g., a first event that triggers and/or causes display of a first notification). In response to detecting the occurrence of the first event, the computer system displays (14004), via the first display generation component, a first indication (e.g., an icon and/or a preview of at least a portion of notification content corresponding to the first notification) of a first notification corresponding to the first event (e.g., the user interface object 7056 in FIG. 7AU). After displaying (14006), via the first display generation component, the first indication of the first notification corresponding to the first event: in accordance with a determination that attention of a user of the computer system was directed to the first indication within a first threshold amount of time (e.g., 0.01, 0.05, 0.1, 0.2, 0.5, 1, 2, 5, 10, 30, 60 seconds, or another amount of time) (e.g., as shown in FIG. 7AX) and then moved away from the first indication before first criteria (e.g., criteria for displaying the notification, or interacting with the notification content) are met, maintaining (14008) display of the first indication for a first duration of time (e.g., the user’s attention did not meet the first criteria and did not cause the first notification to be displayed and did not cause the first indication to be dismissed right away) and ceasing display of the first indication after expiration of the first duration of time (e.g., the user interface object 7056 ceases to be displayed at a time T₃ in FIG. 7AZ, after the user’s attention was directed to the user interface object 7056 at a time T₁ in FIG. 7AX); and in accordance with a determination that the attention of the user of the computer system was not directed to the first indication within the first threshold amount of time (e.g., 5 seconds, 10 seconds, 30 seconds, 1 minute, or another amount of time), maintaining (14010) display of the first indication for a second duration of time and ceasing display of the first indication after expiration of the second duration of time, wherein the second duration of time is different from the first duration of time (e.g., the user interface object 7056 cease to be displayed at a time T4 in FIG. 7AW, and the user’s attention was not directed to the user interface object 7056 in FIG. 7AU-7AW).

In some embodiments, the second duration of time is longer than the first duration of time. For example, in FIG. 7AU-7AW, the user’s attention 7116 is not directed to the indicator 7056 (at any time during the sequence), and the computer system 7100 maintains display of the indicator 7056 for a second duration of time (e.g., from T0 in FIG. 7AU to T4 in FIG. 7AW) and ceases to display the indicator 7056 at the time T4 (in FIG. 7AW). In contrast, FIG. 7AX-7AZ, the user’s attention 7116 is directed to the indicator 7056 (e.g., at the time T1 in FIG. 7AX), and the computer system 7100 maintains display of the indicator 7056 for a first duration of time (e.g., from the time T1 in FIG. 7AX to the time T3 in FIG. 7AZ). The second duration of time (T0 to T4) is longer than the first duration of time (T1 to T3). Maintaining display of the first indication for a first duration of time and ceasing display of the first indication after expiration of the first duration of time, in accordance with a determination that attention of a user of the computer system was directed to the first indication within a first threshold amount of time and then moved away from the first indication before first criteria are met, and maintaining display of the first indication for a second duration of time that is longer that the first duration of time and ceasing display of the first indication after expiration of the second duration of time, in accordance with a determination that the attention of the user of the computer system was not directed to the first indication within the first threshold amount of time, reduces the number of user inputs needed to cease display of the first indication after an appropriate amount of time (e.g., if the user’s attention is directed to the first indication within a first threshold amount of time, the first indication ceases to be displayed after a shorter amount of time (e.g., because the user’s attention was directed to the first indication and/or the user was able to view at least some content associated with the first notification); and if the user’s attention is not directed to the first indication within the first threshold amount of time, the first indication ceases to be displayed after a longer period amount of time (e.g., so that the user has time to direct the user’s attention to the first indication before the first indication ceases to be displayed)).

In some embodiments, the occurrence of the first event includes at least one of receiving an incoming communication request (e.g., a request for a telephone call, a VoIP call, a video conference call, or a copresence request for an AR or VR session), occurrence of a change in a state of an application (e.g., occurrence of an error, a request for user input, termination of a process, and/or other change in a state of the application), or occurrence of a change in a state of the computer system (e.g., charging completed, system update started or pending, low power mode started or ended, network connectivity started or interrupted, DND mode started or ended, and/or other changes in the system status or operation mode of the computer system). For example, as described with reference to FIG. 7AU, the first event can include receiving (e.g. and/or generating) a notification, receiving a communication request, a changing is state of an application, or a change in state of the computer system 7100. Displaying a first indication of a first notification corresponding to the first event, wherein the first event includes at least one of receiving an incoming communication request, occurrence of a change in a state of an application, or occurrence of a change in a state of the computer system, provides improved visual feedback to the user (e.g., improved visual feedback regarding occurrence of the first event, and/or improved visual feedback that the first notification or content corresponding to the first notification is available for display).

In some embodiments, after displaying, via the first display generation component, the first indication of the first notification corresponding to the first event: in accordance with a determination that the attention of the user of the computer system was directed to the first indication and that the first criteria (e.g., criteria for displaying the notification, or interacting with the notification content) are met (e.g., the computer system detects that the attention of the user is directed to the first indication for a threshold amount of time, before the computer system ceases display of the first indication after expiration of the first or second duration of time; or the computer system detects an air gesture (e.g., an air tap or an air pinch) while the attention of the user is directed to the first indication, before the computer system ceases display of the first indication after expiration of the first or second duration of time), the computer system displays the first notification including first notification content. In some embodiments, the first indication of the first notification does not include notification content for the first notification, and the first notification content for the first notification includes a first amount of notification content for the first notification, and the indication of the first notification includes no notification content or less notification content than the first notification content. In some embodiments, the first indication of the first notification includes some content (e.g., an application name, an application icon, a contact name, and/or a subject line or title corresponding to the notification content) that is displayed whether or not the attention of the user is directed to the first indication and the first criteria are met (e.g., some content is always displayed while the first indication of the first notification is displayed), but the first indication of the first notification does not (e.g., does not always) include all notification content (e.g., does not include the first notification content). For example, as described with reference to FIG. 7AX, in some embodiments, the user interface 7168 (in FIG. 7AX) is a notification (and/or includes notification content), and is displayed in response to detecting the user’s attention 7116 has been directed to the user interface object 7056 for a threshold amount of time (e.g., 0.1, 0.2, 0.5, 1, 2, 5, 10, 30, or 60 seconds). Displaying the first notification including first notification content in accordance with a determination that the attention of the user of the computer system was directed to the first indication and that the first criteria are met, enables the computer system to display notification content without needing to display additional controls (e.g., additional controls for displaying the first notification, and/or additional controls for displaying a notifications user interface that includes the first notification), and without needing to constantly display the first notification content (e.g., which may interfere with the user’s view and/or ability to interact with user interface objects or user interfaces).

In some embodiments, the first notification including the first notification content is concurrently displayed with one or more user interface objects that correspond to a first set of one or more contextual conditions that were met at a time when the attention of the user is directed to the first indication. In some embodiments, the first indication is displayed at a location that has the first spatial relationship to the first view of the environment (e.g., a reactive region for triggering display of the system function menu 7024 of FIG. 7AM, the indicator 7010 of system function menu of FIG. 7AM, and/or the contextual user interface), in order for the first notification and the one or more user interface objects that correspond to the first set of one or more contextual conditions to be displayed in the first view of the environment. For example, in FIG. 7AX, the user interface 7168 is concurrently displayed with the system function menu 7024 (e.g., the same system function menu 7024 that appears in FIG. 7AM-7AT), which corresponds to a first set of one or more contextual conditions (e.g., as described above with reference to FIG. 7AM-7AT). Concurrently displaying the first notification content with one or more user interface objects that correspond to a first set of one or more contextual conditions that were met at a time when the attention of the user is directed to the first indication automatically displays contextually relevant user interface objects without requiring further user input (e.g., the user does not need to perform additional user inputs to display the one or more user interface objects that correspond to the first set of one or more contextual conditions).

In some embodiments, while displaying the first notification including the first notification content, the computer system detects a first user input that meets second criteria with respect to the first notification (e.g., a tap input on the first notification, a tap and hold input, a gaze input that remains on the first notification for a threshold amount of time, a gaze input detected in conjunction with an air pinch or air tap gesture, or another type of user input that corresponds to a request to expand the first notification (e.g., as opposed to opening an application associated with the first notification)). In response to detecting the first user input that meets the second criteria, the computer system expands the first notification to display at least some of the first notification content and additional content (e.g., graphical, textual objects and/or control objects) corresponding to the first notification that was not included in the first notification content. In some embodiments, the first notification includes a first amount of notification content for the first notification before being expanded, and the expanded first notification includes a second amount, greater than the first amount, of notification content for the first notification. In some embodiments, the first notification content for the first notification is a notification preview that includes some, but not all, notification content for the first notification, and the expanded first notification includes the full notification content. For example, as described with reference to FIG. 7AX, while the user interface 7168 is displayed, the computer system 7100 displays additional content (e.g., additional notification content not visible in FIG. 7AX) associated with the user interface 7168, in response to detecting that the user’s attention 7116 continues to be directed to the user interface 7168 (e.g., for a second threshold amount of time such as 1 second, 2 seconds, 5 seconds, 10 seconds, 30 seconds, or 1 minute, after the user interface 7168 is displayed), or in response to detecting an air gesture (e.g., such as an air tap or an air pinch, or another selection input, optionally, in combination with detecting that the user’s attention is directed to the user interface 7168). Displaying at least some of the first notification content and additional content corresponding to the first notification that was not included in the first notification content, in response to detecting the first user input that meets the second criteria with respect to the first notification, enables the computer system to display the appropriate amount of notification content (e.g., the first indication, the first notification content, or the additional content in addition to the first notification content) without needing to display all of the available notification content at all times (e.g., which conserves space in the view of the user, and avoids cluttering the view of the user while using the computer system).

In some embodiments, the second criteria include a first criterion (e.g., the first criterion is an only criterion of the second criteria, the first criterion is one of multiple joint criteria of the second criteria, or the first criterion is one of multiple alternative criteria of the second criteria) that requires the attention of the user to be (e.g., continuously) maintained on the first notification for at least a second threshold amount of time in order to be met. For example, as described with reference to FIG. 7AX, while the user interface 7168 is displayed, the computer system 7100 displays additional content (e.g., additional notification content not visible in FIG. 7AX) associated with the user interface 7168, in response to detecting that the user’s attention 7116 continues to be directed to the user interface 7168 (e.g., for a second threshold amount of time such as 1 second, 2 seconds, 5 seconds, 10 seconds, 30 seconds, or 1 minute, after the user interface 7168 is displayed). Displaying at least some of the first notification content and additional content corresponding to the first notification that was not included in the first notification content, in response to detecting the attention of the user is maintained on the first notification for at least a second threshold amount of time, enables the computer system to display the appropriate amount of notification content (e.g., the first indication, the first notification content, or the additional content in addition to the first notification content) without needing to display all of the available notification content at all times (e.g., which conserves space in the view of the user, and avoids cluttering the view of the user while using the computer system). This also enables the computer system to display different amounts of notification content without needing to display additional controls (e.g., additional controls for displaying the first notification content and/or the additional content).

In some embodiments, the second criteria include a second criterion (e.g., the second criterion is an only criterion of the second criteria, the second criterion is one of multiple joint criteria of the second criteria, or the second criterion is one of multiple alternative criteria of the second criteria) that requires that a user input directed to the first notification is of a first input type (e.g., an air pinch, a long tap, or a double tap) in order to be met. For example, as described with reference to FIG. 7AX, while the user interface 7168 is displayed, the computer system 7100 displays additional content (e.g., additional notification content not visible in FIG. 7AX) associated with the user interface 7168, in response to detecting an air gesture (e.g., such as an air tap or an air pinch, or another selection input, optionally, in combination with detecting that the user’s attention is directed to the user interface 7168). Displaying at least some of the first notification content and additional content corresponding to the first notification that was not included in the first notification content, in response to detecting that the user input directed to the first notification is a user input for a first type, enables the computer system to display the appropriate amount of notification content (e.g., the first indication, the first notification content, or the additional content in addition to the first notification content) without needing to display all of the available notification content at all times (e.g., which conserves space in the view of the user, and avoids cluttering the view of the user while using the computer system). This also enables the computer system to display different amounts of notification content without needing to display additional controls (e.g., additional controls for displaying the first notification content and/or the additional content).

In some embodiments, displaying the first indication of the first notification in response to detecting the occurrence of the first event includes displaying the first indication of the first notification at a first location in the environment, wherein the first location has a first spatial relationship to the first view of the environment. Prior to detecting the occurrence of the first event, the computer system detects that the attention of the user is directed to the first location (e.g., or a respective region that includes the first location) in first view of the environment. In response to detecting that the attention of the user is directed to the first location in the first view of the environment, the computer system displays a first user interface object at the first location in the first view of the environment. An example of the first user interface object is the indicator 7010 of system function menu described above (e.g., with reference to FIGS. 7A-7G), which a user can interact with (e.g., by gazing at, directed attention to, and/or performing an air gesture such as an air tap or an air pinch) to trigger display the system function menu 7024. In some embodiments, the indicator 7010 of system function menu is displayed at the first location in the three-dimensional environment prior to detecting the occurrence of the first event, and in response to detecting the occurrence of the first event, the first indication of the first notification replaces the indicator 7010 of system function menu (e.g., or the appearance of the indicator 7010 of system function menu changes to become, or transition into, the first indication of the first notification). In some embodiments, after ceasing display of the first indication of the first notification (e.g., after expiration of the first duration of time or the second duration of time), the computer system detects that the attention of the user is (again) directed to the first location in the three-dimensional environment, and in response, the computer system displays (e.g., redisplays) the first user interface object at the first location in the three-dimensional environment. For example, in FIG. 7AX, the user interface 7168 is displayed at a location in the view of the environment that is the same (or substantially the same) as the location where the system function menu 7024 is displayed (e.g., in FIG. 7AM) in response to detecting the user’s attention 7116 is directed to the indicator 7010 of system function menu. This is also indicated in FIG. 7AX itself, which shows that in some embodiments, the user interface 7168 is displayed on top of (e.g., overlapping) the system function menu 7024, which is optionally concurrently displayed with the user interface 7168. Displaying, prior to detecting occurrence of a first event and at a first location that has a first spatial relationship to a first view of the environment, a first user interface object, and displaying a first indication of a first notification at the first location, in response to detecting the occurrence of the first event, enables the computer system to display contextually relevant content with requiring further user input (e.g., the user does not need to manually cease display of, or manually move a position of, the first user interface object, in order to make room for display of the first indication).

In some embodiments, displaying the first indication of the first notification in response to detecting the occurrence of the first event includes displaying the first indication of the first notification at a first location in the first view of the environment. After ceasing display of the first indication (e.g., after expiration of the first duration of time or the second duration of time, and optionally, within a threshold amount of time of ceasing display of the first indication), the computer system detects that the attention of the user is directed to the first location. In response to detecting that the attention of the user is directed to the first location, the computer system displays a representation (e.g., e.g., the first indication, or the first notification that includes the first notification content) of the first notification (e.g., at the first location, or a location proximate to the first location). For example, as described with reference to FIG. 7AZ, in some embodiments the computer system redisplays the user interface 7168 and/or the user interface object 7056, if (e.g., in response to detecting that) the user’s attention returns to the user interface object 7056 within a threshold amount of time (e.g., before the time T3). Displaying a first user interface object at the location inf the first view of the environment, prior to detecting the occurrence of the first event and in response to detecting that the attention of the user is directed to the first location in the first view of the environment, and displaying the first indication of the first notification at the first location, in response to detecting the occurrence of the first event, enables the computer system to intuitively display content at a consistent location, and without needing to display additional controls (e.g., at different location each corresponding to different types of content). This also provides improved visual feedback to the user (e.g., prior to detecting occurrence of the first event, the computer system does not display the first indication, which indicates that the first user interface object can be accessed via a user input directed to the first location; in response to detecting occurrence of the first event, the computer system displays the first indication, indicating that the first notification content and/or additional content can be accessed via the user input directed to the first location (e.g., instead of displaying the first user interface object and/or concurrently with display of the first user interface object).

In some embodiments, in response to detecting that the attention of the user is directed to the first location, the computer system concurrently displays a first set of one or more user interface objects that correspond to a first set of one or more contextual conditions with the representation of the first notification (e.g., the representation of the first notification is the first notification that is displayed among other user interface objects (e.g., alerts, activities, and/or other notifications) in the first set of one or more user interface objects that correspond to the first set of one or more contextual conditions, or the representation of the first notification is the first indication of the first notification, and is redisplayed at the location of the indicator 7010 of system function menu (e.g., as shown in FIG. 7A and 7AM)). For example, as described with reference to FIG. 7AX, the user interface 7168 is concurrently displayed with other contextual user interfaces (e.g., one or more of the user interfaces described above with reference to FIG. 7AM-7AT, such as the notification 7148, 7150, 7152, 7154, 7156, 7158, 7160, 7162, the user interface 7068, and/or the user interface 7166), depending on whether or not the corresponding criteria (e.g., for displaying a respective user interface) is met (e.g., at the time when the user’s attention is directed to the user interface object 7056 (e.g., which triggers display of the user interface 7168), or while the user interface 7168 is displayed). Concurrently displaying a first set of one or more user interface objects that correspond to a first set of one or more contextual conditions with the representation of the first notification, enables the computer system to display contextually relevant information without further user input (e.g., the user does not need to perform additional user inputs to display the first set of one or more user interface objects that correspond to the first set of one or more contextual conditions, when the first set of one or more contextual conditions is met).

In some embodiments, displaying the first indication of the first notification in response to detecting the occurrence of the first event includes displaying the first indication of the first notification at a first location in the three-dimensional environment. After ceasing display of the first indication of the first notification after expiration of the first duration of time or the second duration of time, the computer system detects that the attention of the user is directed to the first location. In response to detecting that the attention of the user is directed to the first location: in accordance with a determination that the attention of the user was directed to the first location within a third threshold amount of time (e.g., 0.1, 0.2, 0.5, 1, 2, 5, 10, 30, 60 seconds, or another amount of time) of ceasing display of the first indication of the first notification, the computer system displays a representation (e.g., that includes notification content) of the first notification (e.g., the representation of the first notification is the first indication, or the first notification itself); and in accordance with a determination that the attention of the user was not directed to the first location within the third threshold amount of time of ceasing display of the first indication of the first notification, the computer system displays a second set of one or more user interface objects without displaying the representation of the first notification. In some embodiments, the second set of one or more user interface objects includes a plurality of affordances for accessing system functions of the computer system, such as the system function menu 7024; a contextually relevant user interface, such as the user interface 7068 for joining a communication session (e.g., if there is an active request to join a communication session; and/or a contextual user interface, as described above with reference to FIG. 7AS-7AT)). For example, as described with reference to FIG. 7AZ, after the computer system 7100 ceases to display the user interface 7168, the user’s attention returns to the user interface object 7056 within a threshold amount of time (e.g., before the time T3), and the computer system 7100 redisplays the user interface 7168 (e.g., and/or the user interface object 7056). After the threshold amount of time (e.g., at the time T3 or later), if the user’s attention is directed to the indicator 7010 of system function menu (which is now displayed in place of the user interface object 7056), the computer system 7100 does not redisplay the user interface 7168, and optionally displays (or redisplays) the system function menu 7024 and/or any relevant contextual user interfaces (e.g., as described above with reference to FIG. 7AN-7AT). Displaying a second set of one or more user interface objects without displaying the representation of the first notification, in accordance with a determination that the attention of the user was not directed to the first location within the third threshold amount of time of ceasing display of the first indication of the first notification; and displaying a representation of the first notification in accordance with a determination that the attention of the user was directed to the first location within a third threshold amount of time of ceasing display of the first indication of the first notification, after ceasing display of the first indication of the first notification after expiration of the first duration of time or the second duration of time, enables the computer system to display contextually relevant content without requiring further user input and without needing to display additional controls (e.g., within the third threshold amount of time, the first notification is contextually relevant and is displayed in response to detecting that the attention of the user is directed to the first location; after the third threshold amount of time, the first notification is not displayed and the second set of one or more user interface objects is displayed (e.g., because the second set of one or more user interface objects is contextually relevant), in response to detecting that that the attention of the user is directed to the first location).

In some embodiments, the second set of user interface objects includes one or more user interface objects that correspond to a respective set of one or more contextual conditions that are met at a time that the attention of the user was directed to the first location. For example, as described with reference to FIG. 7AZ, after the threshold amount of time (e.g., at the time T3 or later), if the user’s attention is directed to the indicator 7010 of system function menu (which is now displayed in place of the user interface object 7056), the computer system 7100 does not redisplay the user interface 7168, and optionally displays (or redisplays) the system function menu 7024 and/or any relevant contextual user interfaces (e.g., as described above with reference to FIG. 7AN-7AT). Displaying a second set of one or more user interface objects that includes one or more user interface objects that correspond to a respective set of one or more contextual conditions that are met at the time that the attention of the user was directed to the first location, without displaying the representation of the first notification, in accordance with a determination that the attention of the user was not directed to the first location within the third threshold amount of time of ceasing display of the first indication of the first notification; and displaying a representation of the first notification in accordance with a determination that the attention of the user was directed to the first location within a third threshold amount of time of ceasing display of the first indication of the first notification, after ceasing display of the first indication of the first notification after expiration of the first duration of time or the second duration of time, enables the computer system to display contextually relevant content without requiring further user input and without needing to display additional controls (e.g., within the third threshold amount of time, the first notification is contextually relevant and is displayed in response to detecting that the attention of the user is directed to the first location; after the third threshold amount of time, the first notification is not displayed and the one or more user interface objects that correspond to the respective set of one or more contextual conditions is displayed (e.g., because the respective set of one or more contextual conditions are met when the user’s attention is directed to the first location), in response to detecting that that the attention of the user is directed to the first location).

In some embodiments, the second set of user interface objects includes one or more affordances for accessing system functions of the computer system (e.g., the second set of user interface objects include system status indicators and controls that are displayed in the system function menu 7024). For example, as described with reference to FIG. 7AZ, after the threshold amount of time (e.g., at the time T3 or later), if the user’s attention is directed to the indicator 7010 of system function menu (which is now displayed in place of the user interface object 7056), the computer system 7100 does not redisplay the user interface 7168, and optionally displays (or redisplays) the system function menu 7024. Displaying a second set of one or more user interface objects that includes one or more affordances for accessing system functions of the computer system, without displaying the representation of the first notification, in accordance with a determination that the attention of the user was not directed to the first location within the third threshold amount of time of ceasing display of the first indication of the first notification; and displaying a representation of the first notification in accordance with a determination that the attention of the user was directed to the first location within a third threshold amount of time of ceasing display of the first indication of the first notification, after ceasing display of the first indication of the first notification after expiration of the first duration of time or the second duration of time, enables the computer system to display contextually relevant content without requiring further user input and without needing to display additional controls (e.g., within the third threshold amount of time, the first notification is contextually relevant and is displayed in response to detecting that the attention of the user is directed to the first location; after the third threshold amount of time, the first notification is not displayed and the one or more affordances for accessing system functions of the computer system are displayed (e.g., because the one or more affordances for accessing system functions of the computer system are contextually relevant, and/or because no other contextually relevant user interfaces are available for display), in response to detecting that that the attention of the user is directed to the first location).

In some embodiments, after ceasing display of the first indication of the first notification after expiration of the first duration of time or the second duration of time, the computer system detects a first request to display a notification user interface. In response to detecting the first request to display the notification user interface, the computer system displays the notification user interface, wherein the notification user interface includes a plurality of previously received notifications and the first notification. In some embodiments, the notification user interface includes the first notification even if the attention of the user was not directed to the first indication within the first threshold amount of time (e.g., and no additional content of the first notification, besides the first indication of the first notification, was ever displayed). For example, as described with reference to FIG. 7AZ, after the time T3, the user can access the previously displayed user interface 7168 (e.g., and/or content of the user interface 7168) through other means (e.g., through one or more user interfaces for displaying recent notifications, or previously received notifications). The user can access a notification history user interface of the computer system 7100, by first invoking the system function menu 7024 (e.g., by directing the user’s attention 7116 to the indicator 7010 of system function menu in FIG. 7AM, and/or the region 7160 as described above with reference to FIG. 7AG-7AM (e.g., for displaying the indicator 7010 of system function menu)) and activating the notification affordance 7044 of the system function menu 7024 (e.g., as described above with reference to FIG. 7K(c) and FIG. 7BA-7BJ). Displaying the notification user interface that includes a plurality of previously received notifications and the first notification, in response to detecting the first request to display the notification user interface after ceasing display of the first indication of the first notification after expiration of the first duration of time or the second duration of time, enables the computer system to display the first indication and/or content of the first notification during a first period of time, while preserving functionality for redisplaying the content of the first notification after the first period of time.

In some embodiments, detecting the first request to display the notification user interface includes detecting user interaction with a system user interface that has been displayed in response to detecting that the attention of the user is directed to a respective region of the first view of the environment. For example, in some embodiments, the system user interface is the system function menu 7024 described with reference to FIG. 7E and FIG. 7AM that includes one or more affordances for accessing system functions of the computer system. In some embodiments, the system user interface is displayed in response to detecting that the user’s attention is directed to a location in the first view of the three-dimensional environment that has the first spatial relationship to the first view of the three-dimensional environment. In some embodiments, detecting the user interaction with the system user interface includes selection of one of the affordances in the system user interface for displaying the notification history of the computer system. For example, as described with reference to FIG. 7AZ, the user can access a notification history user interface of the computer system 7100, by first invoking the system function menu 7024 (e.g., by directing the user’s attention 7116 to the indicator 7010 of system function menu in FIG. 7AM, and/or the region 7160 as described above with reference to FIG. 7AG-7AM (e.g., for displaying the indicator 7010 of system function menu)) and activating the notification affordance 7044 of the system function menu 7024 (e.g., as described above with reference to FIG. 7K(c) and FIG. 7BA-7BJ). Displaying the notification user interface that includes a plurality of previously received notifications and the first notification, in response to detecting user interface with a system user interface displayed in response to detecting that the attention of the user is directed to a respective region of the first view of the environment, after ceasing display of the first indication of the first notification after expiration of the first duration of time or the second duration of time, enables the computer system to display the first indication and/or content of the first notification during a first period of time, while preserving functionality for redisplaying the content of the first notification after the first period of time.

In some embodiments, the respective region of the first view of the environment is located at a first position in the environment that has a first spatial relationship to the first view of the environment. The computer system detects a change in a current viewpoint of the user from a first viewpoint corresponding to the first view of the environment, to a second viewpoint corresponding to a second view of the environment. In response to detecting the change in the current viewpoint of the user from the first viewpoint to the second viewpoint, the computer system updates a currently displayed view of the environment from the first view to the second view of the environment. While displaying the second view of the environment, the computer system detects that the attention of the user is directed to a respective region of the second view of the environment, wherein the respective region of the second view of the environment has the first spatial relationship to the second view of the environment. In some embodiments, the respective region of the first view of the environment is the same size as the respective region of the second view of the environment (e.g., the user can look to the same sized region in any respective view of the environment in order to trigger display of the notification user interface). In response to detecting that the attention of the user is directed to the respective region of the second view of the environment, the computer system displays the notification user interface (e.g., the system space 7052 that is a notification center in FIG. 7K(c), and/or the notification history user interface described with respect to FIG. 7BC-7BJ). For example, as described with reference to FIG. 7AG, the region 7158 and the region 7160 (e.g., and/or the indicator 7010 of system function menu and/or the system function menu 7024) are viewpoint-locked regions (and/or user interface objects and user interfaces), as described in greater detail with reference to FIGS. 7A-7D and FIGS. 7E-7G. Displaying the notification user interface that includes a plurality of previously received notifications and the first notification, in response to detecting that the attention of the user is directed to the respective region of the second view of the environment, while displaying the second view of the environment, in response to detecting the change in the current viewpoint of the user from the first viewpoint to the second viewpoint, enables the computer system to display the first indication and/or content of the first notification during a first period of time, while preserving functionality for redisplaying the content of the first notification after the first period of time, and reduces the number of user inputs needed to display the notification user interface (e.g., the user does not need to perform additional user inputs to move or relocate the respective region, when the viewpoint of the user changes).

In some embodiments, the first event is an event of a first type (e.g., events in applications that cause notifications to be generated by the applications, the applications including messaging applications, calendar application, email application, and other user applications that generate notifications, rather than temporary system alerts), and the first indication of the first notification corresponding to the first event is displayed at a first position in the environment (e.g., in a stack, below the system status indicators and indicator 7010 of system function menu (e.g., of FIG. 7A and FIG. 7AM)). The computer system detects, occurrence of a second event of a second type (e.g., events in the computer system that cause temporary system alerts to be generated by the computer system, the events including battery charging started/ended, obstacle detected in proximity to the user or in the user’s path when the user’s view is blocked by the display generation component, people joining or leaving a real-time communication session, and other transient alerts (e.g., informational only, or informational and actionable alerts) regarding changes in the status of the computer system) that is different from the first type. In response to detecting the occurrence of the second event, the computer system displays, at a second position in the environment different from the first position in the environment, a second indication of a first alert corresponding to the second event, wherein the first position is within a region for displaying notifications and the second position is within a region for displaying alerts. In some embodiments, the second indication for the first alert is concurrently displayed with the first indication for the first notification, and the second indication is displayed above, below, to the left of, or to the right of the first indication. In some embodiments, the second indication for the first alert is displayed while the first indication for the first notification is not displayed (e.g., before the first event is detected, or after the computer system ceases display of the first indication after the first duration of time or the second duration of time), the second indication is concurrently displayed with another user interface object (e.g., the indicator 7010 of system function menu) is displayed at the first position in the environment, and the second indication is displayed above, below, to the left of, or to the right of the other user interface object (e.g., but with the same spatial relationship to the first indication, in scenarios where the first indication would be displayed). In some embodiments, the second indication is displayed while no user interface elements are displayed at the first position in the environment, and the second indication is displayed at the second position in the environment (e.g., even though no user interface elements are displayed at the first position in the environment). In some embodiments, the region for displaying alerts is separate from the region for displaying notifications and other contextual user interface objects in the first view of the environment. For example, the region for displaying alerts is located at the location where the indicator 7010 of system function menu of FIG. 7A and FIG. 7AM is displayed or below the location of the indicator 7010 of system function menu, while the notifications and other contextual user interface objects are displayed below the region for displaying alerts. For example, as described with reference to FIG. 7AU, some types of notifications (e.g., system alerts relating to battery levels, object avoidance, and/or other users joining active communication sessions) do not cause the user interface object 7056 to be displayed (e.g., because the content of the system alert is time critical and/or high importance). In some embodiments, instead of displaying the user interface object 7056 (or another analogous user interface object at the same position as the user interface object 7056 in FIG. 7AU), and the computer system 7100 instead displays another visual indication for the system alert (e.g., at a different location, such as immediately below or to the left of, the location of the user interface object 7056 in FIG. 7AU). Displaying, at a second position in the environment different from the first position, a second indication of a first alert corresponding to the second event, in response to detecting occurrence of a second event of a second type, provides improved visual feedback to the user (e.g., the user can easily identify what type of event has occurred and/or corresponds to a displayed indicator, based off the position at which the indicator is displayed).

In some embodiments, the computer system ceases to display the second indication of the first alert corresponding to the second event (e.g., after expiration of a threshold amount of time that, optionally, is chosen based on whether the attention of the user has been detected on the second indication). After ceasing display of the second indication of the first alert corresponding to the second event, the computer system detects a second request (e.g., a gaze input directed to the notifications affordance 7044 in the system function menu 7024, as shown in FIG. 7BA; or a gaze input in conjunction with an air gesture (e.g., an air tap or an air pinch), an input via a controller, or a voice command (e.g., directed to the notifications affordance 7044)) to display a notification user interface (e.g., the notification user interface that includes the first notification and one or more other previously received notifications). In response to detecting the second request to display the notification user interface, the computer system displays the notification user interface, wherein the notification user interface includes one or more notifications corresponding to events of the first type, and wherein the notification user interface does not include alerts corresponding to events of the second type. For example, as described with reference to FIG. 7AU, system alerts do not appear in the notification center (e.g., the notification center as described above with reference to FIG. 7K(c), or other user interfaces for accessing recently or previously received notifications), and optionally, dismissed system alerts are accessed through other user interfaces (e.g., a notification history user interface described with reference to FIG. 7BA-7BJ). Displaying a notification user interface that includes one or more notifications corresponding to events of the first type, and that does not include alerts corresponding to events of the second type, in response to detecting the second request to display the notification user interface, automatically displays the appropriate content without requiring further user input (e.g., some content, such as alerts corresponding to events of the second type, are time-sensitive and do not benefit from being redisplayed at a later time, so the computer system does not display alerts corresponding to events of the second type in the notification user interface, and the user does not need to perform additional user inputs to remove or dismiss alerts corresponding to events of the second type from the notification user interface (e.g., to view and/or display other content that does benefit from being redisplayed, such as previously received notifications).

In some embodiments, while displaying the second indication of the first alert, the computer system detects that the attention of the user is directed to a respective region in the first view of the environment that includes a plurality of affordances for accessing system functions of the computer system (e.g., the user interface object 7056 in FIG. 7M, the user interface object 7064 in FIG. 7S, or a respective region that includes the regions occupied by the indicator 7010 of system function menu, the user interface object 7056, or the user interface object 7064). In response to detecting that the attention of the user is directed to the respective region that includes the plurality of affordances for accessing system functions of the computer system, the computer system ceases to display the second indication for the first alert. In some embodiments, the second indication is dismissed in response to detecting that the user’s attention is directed to the second indication and then moves away from the second indication. In some embodiments, the second indication is dismissed automatically after a period of time (e.g., 5 seconds, 10 seconds, 30 seconds, 1 minute, 2 minutes, 5 minutes, or 10 minutes) if the user’s attention is not detected on the second indication before a threshold amount of time is reached. In some embodiments, the amount of time it takes to dismiss the second indication automatically is chosen depending on whether user’s attention is detected on the second indication and then moved away, or the user’s attention was never detected on the second indication. For example, as described with reference to FIG. 7AU, in some embodiments, system alerts are dismissed when the system function menu 7024 is displayed (e.g., if the user’s attention 7116 is directed to the indicator 7010 of system function menu). In some embodiments, the system alerts are concurrently displayed with the system function menu 7024 (e.g., if the user’s attention 7116 is directed to the indicator 7010 of system function menu), but the system alerts are dismissed if the user’s attention 7116 is directed to the system function menu 7024. Ceasing to display the second indication for the first alert in response to detecting that the attention of the user is directed to a respective region that includes the plurality of affordances for accessing system functions of the computer system, reduces the number of user inputs needed to cease displaying the second indication of the first alert (e.g., the plurality of affordance for accessing system functions of the computer system includes an affordance for interacting with and/or responding to the first alert, and the computer system automatically ceases to display the second indication for the first alert once the user’s attention is directed to the respective region that includes the affordance (e.g., because the user can then interact with and/or respond to the first alert, removing the need and/or benefit to display the second indication for the first alert).

In some embodiments, the second indication of the first alert includes one or more selectable options for performing operations corresponding to the first alert or the second event (e.g., operations for adjusting one or more settings for the computer system, operations for accepting or rejection a recommended course of action, operations for dismissing the indication without changing settings of the computer system, or other contextual operations based on the content and/or triggering event corresponding to the second notification). In some embodiments, the computer system displays respective indications of respective alerts corresponding to respective events of the second type, and a respective indication of an alert corresponding to an event of the second type includes one or more options for performing operations corresponding to the alert. In some embodiments, different indications for different alerts corresponding to events of the second type include different options for performing operations corresponding to their respective alerts and/or events (e.g., the available options for performing operations depend on the content of the alert, or a characteristic of the triggering event). In some embodiments, the computer system detects a second user input directed to a respective selectable option (e.g., an option for dismissing the alert, an option for displaying additional information or content associated with the alert or event, or joining a real-time communication session associated with the alert or event) of the one or more selectable options, and in response to detecting the second user input, the computer system performs a respective operation (e.g., dismisses the alert, displays additional information or content, or joins the real-time communication session) that corresponds to the first alert or the second event. For example, as described with reference to FIG. 7AU, in some embodiments, the system alert includes one or more selectable options for performing operations corresponding to the system alert (e.g., or an event corresponding to the system alert).. In some embodiments, the user of the computer system 7100 can access one or more functions and/or settings of the computer system 7100 via a system alert (e.g., a system alert for battery level includes an affordance for accessing the battery settings of the computer system 7100), and in some embodiments, the one or more selectable options for performing operations overlaps with (e.g., are the same as, or share functionality with) the one or more functions and/or settings of the computer system 7100. Displaying, at a second position in the environment different from the first position, a second indication of a first alert corresponding to the second event that includes one or more selectable options for performing operations corresponding to the first alert or the second event, in response to detecting occurrence of a second event of a second type, reduces the number of user inputs needed to respond to and/or interact with the first alert or the second event (e.g., the user does not need to perform a first input to view and/or identify the first alert or the second event, and a second user input to navigate to the appropriate user interface(s) for performing operations corresponding to the first alert or the second event).

In some embodiments, aspects/operations of methods 8000, 9000, 10000, 11000, 12000, 13000, 14000, 15000, and 16000 may be interchanged, substituted, and/or added between these methods. For example, the first user interface object (e.g., system control indicator) in the method 14000 in some circumstances has a different appearance as described in the methods 9000-13000, and 15000-16000, and the user interface elements that are displayed (e.g., the plurality of affordances for accessing system functions of the first computer system) may be replaced by, or concurrently displayed with, other user interface elements (e.g., additional content associated with a notification, a user interface that includes an affordance for joining a communication session, and other user interface elements in the methods 9000-13000, and 15000-16000). For brevity, these details are not repeated here.

FIG. 15 is a flow diagram of an exemplary method 15000 for displaying and interacting with previously received notifications in a notification history user interface. In some embodiments, the method 15000 is performed at a computer system (e.g., computer system 101 in FIG. 1) (which is sometimes referred to as “the first computer system”) that is in communication with a display generation component (e.g., display generation component 120 in FIGS. 1, 3, and 4) (e.g., a heads-up display, a display, a touchscreen, or a projector) and one or more input devices (e.g., a touch screen, a camera, and/or a microphone). In some embodiments, the computer system optionally includes one or more cameras (e.g., a camera (e.g., color sensors, infrared sensors, and/or other depth-sensing cameras) that points towards the user (e.g., to detect the gaze of the user) and/or a camera that points forward (e.g., to facilitate displaying elements of the physical environment captured by the camera). In some embodiments, the method 9000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 9000 are, optionally, combined and/or the order of some operations is, optionally, changed.

Displaying a respective notification with a first visual appearance based at least in part on a first set of values for a first visual characteristic of a representation of the physical environment at the respective location at which the respective notification is displayed, in accordance with a determination that the representation of the physical environment at the respective location at which the respective notification is displayed has a first set of values for a first visual characteristic, and displaying the respective notification with a second visual appearance, different from the first visual appearance, that is based at least in part on the second set of values for the first visual characteristic of the representation of the physical environment at the respective location, in accordance with a determination that the representation of the physical environment at the respective location at which the respective notification is displayed has a second set of values, different from the first set of values, for the first visual characteristic, automatically displays the respective notification with the appropriate visual appearance without further user input (e.g., the user does not need to perform additional user inputs each time the viewpoint of the user changes), and also provides improved visual feedback regarding the user’s real and/or virtual surroundings (e.g., by accurately reflecting the physical environment at the respective location at which the respective notification is displayed).

While a respective view of a three-dimensional environment (e.g., an AR, VR, or MR environment that includes one or more physical objects and/or one or more virtual objects arranged in a three-dimensional arrangement) that includes one or more physical objects (e.g., the representation 7014′ in FIG. 7BA) is visible via the first display generation component (e.g., through a transparent or semi-transparent portion of the first display generation component, or in a camera view of the physical environment provided by the display of the first display generation component), the computer system detects (15002) a first input (e.g., an air gesture (e.g., an air tap or an air pinch) detected in conjunction with a gaze input; an air gesture, a touch gesture, an input provided via a controller, a voice command, and/or other types of input) that corresponds to a request to display one or more notifications (e.g., an input that is directed to the indicator 7010 of system function menu of FIG. 7A and FIG. 7AM, or the reactive region for the system function menu 7024 of FIG. 7E and FIG. 7AM, or the indicator 7010 of system function menu, or another input that corresponds to a request to redisplay previously displayed notifications in a notification user interface, or another input that corresponds to a request to display a notification that corresponds to an indication of the notification that has been displayed in the respective view) in the respective view of the three-dimensional environment. In response to detecting (15004) the first input, the computer system displays a respective notification (e.g., the notification 7170, 7172, 7176, or 7178, in FIG. 7BC) that corresponds to a previously detected event at a respective location in the three-dimensional environment (e.g., displaying the respective notification at a respective location in the three-dimensional environment, relative to other objects in the three-dimensional environment). In accordance with a determination that the representation of the physical environment at the respective location at which the respective notification is displayed has a first set of values for a first visual characteristic (e.g., due to the visual characteristics of a first set of objects (e.g., virtual and/or physical objects) and/or lighting (e.g., virtual and/or physical lighting) that can be seen in the line of sight of the user at the current viewpoint of the user), the computer system displays (15006) the respective notification with a first visual appearance (e.g., an appearance characterized by a first set of colors, brightness, saturation, tones, and/or spatial distributions of the above) that is based at least in part on the first set of values for the first visual characteristic (e.g., first colors, brightness, saturation, tone, and/or spatial distributions of the above) of the representation of the physical environment at the respective location (e.g., the portions of the notification 7170 that are displayed in front of and/or over the representation 7014′ have a different visual appearance as compared to other portions of the notification 7170). In accordance with a determination that the representation of the physical environment at the respective location at which the respective notification is displayed has a second set of values, different from the first set of values, for the first visual characteristic (e.g., due to the visual characteristics of a second set of objects (e.g., virtual and/or physical objects) and/or lighting (e.g., virtual and/or physical lighting) that can be seen in the line of sight of the user at the current viewpoint of the user, and/or due to changes in the appearances of the first set of objects that can be seen in the line of sight of the user at the current viewpoint of the user), the computer system displays (15008) the respective notification with a second visual appearance (e.g., an appearance characterized by a second set of colors, brightness, saturation, tones, and/or spatial distributions of the above), different from the first visual appearance, that is based at least in part on the second set of values for the first visual characteristic (e.g., second colors, brightness, saturation, tone, and/or spatial distributions of the above) of the representation of the physical environment at the respective location (e.g., the notification 7178 with different visual characteristics as compared to the notification 7170, because the representation of the physical environment at the respective locations behind the notification 7178 and the notification 7170 have different values for the first visual characteristic).

In some embodiments, while displaying the respective notifications, the computer system detects a first change in a current viewpoint of a user (e.g., based on movement of at least a portion of the computer system and/or a shift in a virtual viewpoint of the user of the computer system, based on movement of the user’s head or as a whole in the physical environment (e.g., while the user wears the display generation component on his head or over his eyes), and/or based on a request for locomotion that causes the viewpoint of the user to move (e.g., translate, pan, tilt, and rotate) inside the virtual three-dimensional environment) from a first viewpoint associated with the first view of the three-dimensional environment to a second viewpoint associated with a second view of the three-dimensional environment. In response to detecting the first change in the current viewpoint of the user, the computer system updates the respective view of the three-dimensional environment in accordance with the first change of the viewpoint of the user (e.g., from the first view to a second view corresponding to the second viewpoint, optionally, through a sequence of intermediate views corresponding to a sequence of intermediate viewpoints along the movement path of the current viewpoint); and the computer system updates a respective visual appearances of the respective notification in accordance with a change in the first visual characteristic of the representation of the physical environment at the respective location at which the respective notification is displayed (e.g., the respective location maintains its relationship with the field of view provided by the display generation component (e.g., the respective location at which the respective notification is displayed is optionally stationary relative to the currently displayed view, or the respective location at which the respective notification is displayed exhibits a lazy follow behavior relative to the currently displayed view)). In some embodiments, in response to detecting the change in the current viewpoint of the user, in accordance with a determination that the representation of the physical environment at the respective location at which the respective notification is displayed has a third set of values for the first visual characteristic (e.g., due to the visual characteristics of a third set of objects (e.g., virtual and/or physical objects) and/or lighting (e.g., virtual and/or physical lighting) that can be seen in the line of sight of the user at the current viewpoint of the user), the computer system displays the respective notification with a third visual appearance (e.g., an appearance characterized by a third set of colors, brightness, saturation, tones, and/or spatial distributions of the above) that is based at least in part on the third set of values for the first visual characteristic (e.g., third colors, brightness, saturation, tone, and/or spatial distributions of the above) of the representation of the physical environment at the respective location; and in accordance with a determination that the representation of the physical environment at the respective location at which the respective notification is displayed has a fourth set of values, different from the first set of values and the third set of values, for the first visual characteristic (e.g., due to the visual characteristics of a fourth set of objects (e.g., virtual and/or physical objects) and/or lighting (e.g., virtual and/or physical lighting) that can be seen in the line of sight of the user at the current viewpoint of the user, and/or due to changes in the appearances of the third set of objects that can be seen in the line of sight of the user at the current viewpoint of the user), the computer system displays the respective notification with a fourth visual appearance (e.g., an appearance characterized by a fourth set of colors, brightness, saturation, tones, and/or spatial distributions of the above), different from the first visual appearance and the third visual appearance, that is based at least in part on the fourth set of values for the first visual characteristic (e.g., second colors, brightness, saturation, tone, and/or spatial distributions of the above) of the representation of the physical environment at the respective location. For example, in FIGS. 7BI and 7BJ, the user 7002 moves from the location 7026-g to the location 7026-h, and the computer system 7100 updates the respective view of the three-dimensional environment (e.g., in FIG. 7BJ, the representation 7014′ and the virtual object 7012 appear further to the right, in the view of the virtual environment, as compared to FIG. 7BI) and updates the visual appearance of the notifications (e.g., the visual appearance of the notifications 7174, 7172, and 7180, and the visual appearance of the group 7174, are updated in FIG. 7BJ, in response to the movement of the user 7002 to the location 7026-h). Updating the respective view of the three-dimensional environment in accordance with a first change of the viewpoint of the user, and updating respective a visual appearances of the respective notification in accordance with a change in the first visual characteristic of the representation of the physical environment at the respective location at which the respective notification is displayed, automatically displays the respective notification with the appropriate visual appearance without further user input (e.g., the user does not need to perform additional user inputs each time the viewpoint of the user changes), and also provides improved visual feedback regarding the user’s real and/or virtual surroundings (e.g., by accurately reflecting the physical environment at the respective location at which the respective notification is displayed).

In some embodiments, the first visual characteristic is color; displaying the respective notification with the first visual appearance includes displaying the respective notification with a first set of background colors that is based at least in part on a first set of color values of the representation of the physical environment at the respective location; and displaying the respective notification with the second visual appearance includes displaying the respective notification with a second set of background colors, different from the first set of background colors, that is based at least in part on a second set of color values of the representation of the physical environment at the respective location. For example, in some embodiments, the respective notification representation is displayed on a partially translucent platter as the background of the notification content, where the partially translucent platter that takes on color(s) based on color(s) of the physical environment that is behind the respective notification. The partially translucent platter optionally reflects some visual aspects of the physical environment that is behind the respective notification (e.g., an approximate shape of an object behind the respective notification, or a brightness/darkness of an object and/or the physical environment behind the respective notification), in accordance with some embodiments. For example, as described above with reference to FIG. 7BC, the lower right corner of the notification 7170 has a different color than other portions of the notification 7170, and the different color is based on a color of the portion of the representation 7014′ that is occluded by the lower right corner of the notification 7170). Similarly, the lower portion of the notification 7172 has a different color than other portions of the group 7172, and the different color is based on a color of the portion of the representation 7014′ that is occluded by the lower portion of the notification 7172. Displaying the respective notification with a first set of background colors that is based at least in part on a first set of color values of the representation of the physical environment at the respective location while a first view of the three-dimensional environment is visible, and displaying the respective notification with a second set of background colors, different from the first set of background colors, that is based at least in part on a second set of color values of the representation of the physical environment at the respective location while a second view of the three-dimensional environment is visible, enables the respective notification to be displayed with minimal impact on the three-dimensional environment, thereby providing improved visual feedback about the user’s real and/or virtual surroundings, and reducing the need for additional inputs (e.g., in order to dismiss the respective notification, for improved visibility).

In some embodiments, the respective view of the three-dimensional environment includes one or more virtual objects (e.g., other user interface objects (e.g., user interfaces, controls, windows, and/or other user interface objects), virtual overlays, virtual lighting, virtual décor, or other virtual objects in the virtual or augmented reality environment); the respective location at which the respective notification is displayed is between a first location at which a respective virtual object is displayed and the viewpoint of the user; and the respective notification is displayed with a respective visual appearance that is based at least in part on a respective set of values for the first visual characteristic of the respective virtual object at the first location. For example, in some embodiments, if virtual objects are displayed (or the user transitions to a virtual environment from a physical environment or AR environment), the notification representations that are displayed on partially translucent platters can take on color(s) based on the color(s) of the virtual elements that are behind the notification representations. For example, as described above with reference to FIG. 7BC, the bottom portion of the group 7174 is displayed with a different appearance than other portions of the group 7174 that do not occlude the virtual object 7172, and the different appearance is based at least in part on a visual characteristic (e.g., a brightness and/or a color) of the virtual object 7172 (or the portion of the virtual object 7172 that is occluded by the bottom portion of the group 7174). Displaying the respective notification, at a respective location that is between the location of a respective virtual object and the viewpoint of the user, with a respective visual appearance that is based at least in part on a respective set of values for the first visual characteristic of the respective virtual object, enables the respective notification to be displayed with minimal impact on the three-dimensional environment, thereby providing improved visual feedback about the user’s real and/or virtual surroundings, and reducing the need for additional inputs (e.g., in order to dismiss the first user interface object, for improved visibility).

In some embodiments, the respective notification is one of a first group of notifications that correspond to a first group of detected events, and wherein the respective notification is displayed as a representative notification for the first group of notifications. In some embodiments, a representative notification is a notification that is the newest notification in a group of notifications that are received for the same type of event and/or the same application. In some embodiments, the representative notification is displayed with its notification content, and other notifications in the group are displayed as one or more indications behind or adjacent to the representative notification. In some embodiments, the group of notifications are stacked or are not all visible at the same time, and the representative notification is among a subset of the group of notifications that are currently visible. In some embodiments, in response to detecting the first input, the computer system displays a plurality of notifications corresponding to previously detected events at respective locations in the three-dimensional environments, and some (e.g., some but not all) notifications of the plurality of notifications are representative notifications that correspond to respective groups of detected events, while other notifications of the plurality of notifications each correspond to a single detected event that does not fall into the same group as other notifications. For example, in FIG. 7BE, the group 7174 is a notification of a first group of notifications (e.g., the notification 7174-a and the notification 7174-b, shown in FIG. 7BF), and is displayed as a representative notification for the first group of notifications. Displaying a respective notification as a representative notification for a first group of notifications that corresponds to a first group of detected events reduces the number of user inputs needed to interact with notifications corresponding to the first group of detected events (e.g., the respective notification “groups” the notifications corresponding to the first group of detected events in a single location, allowing the user to efficiently access notifications corresponding to the first group of notifications, without needing to manually navigate through other notifications that do not correspond to the first group of detected events.

In some embodiments, the first group of detected events corresponding to a first application (e.g., the first group of detected events are events generated by the first application, and does not include events generated by the computer system or other applications). The computer system displays, in the first view of the three-dimensional environment, a respective representative notification for a second group of notifications that correspond to a second group of events, wherein the second group of detected events corresponds to a second application different from the first application. For example, in some embodiments, if there are multiple notifications for detected events corresponding to a respective application (e.g., a first application, a second application, a third application, and so on), the multiple notifications are displayed as a group (e.g., a first group, a second group, a third group, and so on), with a subset (e.g., one, two, or another number less than all) of the multiple notifications displayed as representative notification(s) for the group of notifications for the respective application. In other words, the notifications are grouped by application, and the entire stack of the notifications for a respective group take on an appearance that is based at least in part on the visual characteristics of the environment behind the stack. For example, as described with reference to FIG. 7BC, the notification 7170 is a notification for a first application, the notification 7172 is a notification for a second application, the group 7174 is a representative notification for a group of notifications for the third application, and the notification 7178 is a notification for a fourth application (e.g., where the first, second, third, and fourth applications are all distinct applications). Displaying a respective notification as a representative notification for a first group of notifications that corresponds to a first group of detected events, where the first group of detected events corresponds to a first application, and displaying a representative notification for a second group of notifications that corresponds to a second group of detected events, where the second group of detected events correspond to a second application different from the first application, reduces the number of user inputs needed to interact with notifications corresponding to the first group of detected events and/or the second group of detected event (e.g., the respective notification “groups” the notifications corresponding to the first application in a single location, and the representative notification “groups” the notifications corresponding to the second application in another location, allowing the user to efficiently access notifications corresponding to the first and/or second applications, without needing to manually navigate through all available notifications)..

In some embodiments, while displaying the respective notification at the respective location in the three-dimensional environment, the computer system detects a second input that is directed to the respective notification (e.g., a gaze and dwell input, a gaze detected in conjunction with an air pinch gesture, a gaze detected in conjunction with an air pinch and drag gesture, an air pinch and hold gesture, a pinch and drag gesture, a tap gesture, and other types of input directed to the respective notification). In response to detecting the second input that is directed to the respective notification, the computer system performs a respective operation with respect to the respective notification (e.g., displaying more of the first group of notifications, clear the first group of notifications, scroll the notifications displayed concurrently with the respective notification, scrolling the first group of notifications that have been expanded, and other operations related to the respective notification or the group of notifications represented by the notification, or the notifications concurrently displayed with the respective notification). For example, in FIG. 7BE-7BF, the computer system displays more notifications (e.g., the notifications 7174-a and 7174-b) for the third application, in response to detecting that the user’s attention 7116 is directed to the group 7174 (e.g., which represents a group of notifications for the third application). As described with reference to FIG. 7BI, in response to detecting that the user’s attention is directed to a group representation of multiple notifications (e.g., the group 7174), the computer system ceases to display (E.g., dismisses) a first notification of the multiple notifications. Performing a respective operation with respect to the respective notification, in response to detecting the second input that is directed to the respective notification, reduces the number of inputs needed to perform the respective operation for the first group of notifications (e.g., because the user does not need to individually perform the respective operation for each notification in the first group of notifications).

In some embodiments, performing, in response to detecting the second input that is directed to the respective notification, the respective operation with respect to the respective notification includes: in accordance with a determination that the second input corresponds to a request to navigate through content to which the second input is directed (e.g., the second input is an air pinch and drag gesture detected when a gaze input is detected in the region occupied by notifications including the respective notification, or on the respective notification, or on the system function menu 7024 described with reference to FIG. 7E and FIG. 7AM(or a displayed system space described with reference to FIG. 7K) including notifications and other user interface objects such as alerts, sessions, and system controls, or the second input is another type of scroll input), navigating through a plurality of notifications including the respective notification, including moving one or more notifications that were concurrently visible with the respective notification out of the first view of the three-dimensional environment at a time of detecting the second input, moving the respective notification, and moving one or more notifications that were not concurrently visible with the respective notification into the first view of the three-dimensional environment (e.g., in accordance with a scroll direction specified by the second input, or in accordance with a default scroll direction). In some embodiments, the computer system displays up to a threshold number of notifications corresponding to previously detected events (e.g., there are 10 notifications corresponding to previously detected events, but the computer system displays only 4 of the 10 notifications) at a given moment. In some embodiments, the computer system displays the notifications of the plurality of notifications corresponding to events that are most recent in time (e.g., events that were detected and/or triggered at the most recent times), up to the threshold number of notifications (e.g., there are 10 notifications corresponding to previously detected events, but the computer system displays only 4 notifications corresponding to the 4 most recent events). In some embodiments, the plurality of notifications include notifications in the same group as the respective notification. In some embodiments, the plurality of notifications include representative notifications of different groups of notifications and notifications that are not in any group, where each group of notifications (e.g., a stack or set) is scrolled with its representative notification and is not expanded out into individual notifications in the group when the scrolling occurs. For example, in FIG. 7BG-7BH, in response to detecting that the user’s attention 7116 is directed to a location near the right edge of the display of the computer system 7100, the computer system 7100 navigates through the plurality of notifications by moving the notification 7170 (which is visible in FIG. 7BG) out of the first view of the three-dimensional environment, and moves the notification 7192 (which was not visible in FIG. 7BG) into the first view of the three-dimensional environment (e.g., as shown in FIG. 7BH). Navigating through a plurality of notifications including the respective notification, including moving one or more notifications that were concurrently visible with the respective notification out of the first view of the three-dimensional environment at a time of detecting the second input, moving the respective notification, and moving one or more notifications that were not concurrently visible with the respective notification into the first view of the three-dimensional environment, in response to detecting the second input that is directed to the respective notification, enables display of additional notifications without needing to display additional controls (e.g., additional controls for navigating through notifications, additional controls for ceasing to display some displayed notifications, and/or additional controls for displaying additional notifications).

In some embodiments, while navigating through of the plurality of notifications, the computer system changes respective visual appearances of the plurality of notifications (e.g., the plurality of notifications take on different sets of values for the first visual characteristic) based at least in part on a respective set of values for the first visual characteristic of respective portions of the three-dimensional environment that are behind the plurality of notifications relative to a current viewpoint of the user, as the plurality of notifications move through different portions of the three-dimensional environment. In some embodiments, the computer system displays an individual notification of the plurality of notifications with a respective visual appearance as described above with reference to the respective notification (e.g., changes in accordance with changes in the appearance of the physical objects/lighting, virtual objects/lighting, changes in accordance with relative movement between the notification and the viewpoint, and in accordance with relative movement between the notification and the three-dimensional environment). In some embodiments, the computer system continually updates the visual appearances of individual notifications in the plurality of notification while scrolling through the plurality of notifications. For example, in FIG. 7BG-7BH, the computer system 7100 navigates through the plurality of notifications, and changes the visual appearance of the notification 7172 (e.g., the notification 7172 in FIG. 7BH has the visual appearance of the notification 7170 in FIG. 7BG), the group 7174 (e.g., the group 7174 in FIG. 7BH has the visual appearance of the notification 7172 in FIG. 7BG), and the notification 7178 (e.g., the notification 7178 in FIG. 7BH has the visual appearance of the group 7174 in FIG. 7BG). Changing respective visual appearances of the plurality of notifications based at least in part on a respective set of values for the first visual characteristic of respective portions of the three-dimensional environment that are behind the plurality of notifications relative to a current viewpoint of the user, as the plurality of notifications move through different portions of the three-dimensional environment, enables the plurality of notifications to be displayed with minimal impact on the three-dimensional environment, thereby providing improved visual feedback about the user’s real and/or virtual surroundings, and reducing the need for additional inputs (e.g., in order to dismiss notifications of the first plurality of notifications for improved visibility, and/or to update the appearance of the first plurality of notifications to maintain or improve visibility of the user’s real and/or virtual surroundings).

In some embodiments, performing, in response to detecting the second input that is directed to the respective notification, the respective operation with respect to the respective notification includes: in accordance with a determination that the second input corresponds to a request to dismiss content to which the second input is directed (e.g., the second input is a wave of a hand of the user in the air, an air pinch gesture detected when a gaze input is detected on a “close” or “dismiss” affordance displayed adjacent to the respective notification or a plurality of notifications including the respective notification, or the user’s attention being directed to other regions of the environment outside of the region occupied by the notifications, or another type of scroll input), ceasing to display the respective notification (e.g., and any other notifications that are concurrently displayed with the respective notification). For example, as described with reference to FIG. 7BI, the computer system 7100 cases to display either a first notification (e.g., the notification 7174-a, in FIG. 7BF) of the group 7174, or the entire group 7174 (e.g., both the notification 7174-a and the notification 7174-b). Ceasing to display the respective notification in response to detecting the second input that is directed to the respective notification, enables the computer system to cease to display notifications without needing to display additional controls (e.g., additional controls for dismissing one or more notifications), and also reduces the number of user inputs needed to cease display of the appropriate notifications (e.g., in some embodiments, the respective notifications is a representative notification for the first group of notifications, and the entire first group of notifications ceases to be displayed).

In some embodiments, performing, in response to detecting the second input that is directed to the respective notification, the respective operation with respect to the respective notification includes: in accordance with a determination that the second input corresponds to a request to expand content to which the second input is directed (e.g., the second input is a pinch and hold gesture, a gaze and dwell input, an air tap gesture detected while the gaze input is detected on the respective notification, or another type of expansion input), displaying an expanded version of the respective notification, including additional content (e.g., additional text content not initially displayed, media content, contact information for a sender of a received message or communication, and/or attachments (e.g., associated with an email notification)) associated with the respective notification that was not included in the respective notification before the second input was detected (e.g., the respective notification includes preview content that is a subset of all available notification content for the respective notification, and the additional content associated with the respective notification includes some notification content that was not included in the preview content), wherein displaying the expanded version of the respective notification includes: in accordance with a determination that the respective notification is a first notification displayed at a first location in the respective view of the three-dimensional environment, displaying first additional content associated with the first notification (e.g., first notification content that was not included in the preview of content included in the respective notification) at the first location. In one example, the respective notification is a notification of a first message from a first sender, and includes an application icon for the messaging application, a portion of the textual content of the first message, the name of the sender, and the timestamp of the first message; and the expanded version of the respective notification includes additional content such as the entirety of the textual content of the first notification, a preview of an attachment (e.g., an image, an animated model, or other graphical or media objects), and one or more controls for performing respective operations associated with the first message (e.g., “reply”, “forward”, “playback”, “save” affordances). In another example, the respective notification is a notification of an online shopping application, and includes the application icon of the online shopping application, a status update for a purchase (“e.g., item shipped”, “item returned”, or “delivery expected at 3pm today”); and the expanded version of the respective notification includes description and images of the items in the order, tracking number of the delivery, and one or more coupons for future purchases. Displaying the expanded version of the respective notification includes: in accordance with a determination that the respective notification is a second notification displayed at a second location different from the first notification displayed at the first location in the respective view of the three-dimensional environment, displaying second additional content (e.g., second notification content that was not included in the preview of content included in the respective notification), different from the first additional content, associated with the second notification at the second location. In one example, the respective notification is a notification of a first email from a first sender, and includes an application icon for the email application, a subject heading of the first email, the name of the sender, and the timestamp of the first email; and the expanded version of the respective notification includes additional content such as an excerpt of the textual content of the first email, a preview of an attachment (e.g., a document, an image, an animated model, or other graphical or media objects), and one or more controls for performing respective operations associated with the first email (e.g., “view in application”, “reply”, “forward” affordances). In another example, the respective notification is a notification of a newsfeed application, and includes the application icon of the newsfeed and one or more headlines for one or more subscribed newsfeed; and the expanded version of the respective notification includes the one or more headlines with excerpts of the corresponding news, one or more thumbnail images corresponding to the one or more headlines, and one or more recommended news headlines and one or more controls for unsubscribe, find similar, or save the newsfeed. Other examples of notifications and their corresponding standard or expanded versions are possible, in accordance with various embodiments. For example, in FIG. 7BC-7BD, in response to detecting the user’s attention 7116 is directed to the notification 7172 (as shown in FIG. 7BC), the computer system 7100 displays an expanded version of the notification 7172 in FIG. 7BD (e.g., that includes additional content that was not displayed in the FIG. 7BC). The computer system 7100 can also display additional content for a different notification (e.g., the notification 7170 or the notification 7178), in response to detecting that the user’s attention is directed to the different notification (e.g., as described above with reference to FIG. 7BD). Displaying first additional content associated with the first notification in accordance with a determination that the respective notification is a first notification, and displaying second additional content, different from the first additional content, associated with the second notification in accordance with a determination that the respective notification is a second notification different from the first notification, enables appropriate additional content to be displayed without needing to permanently or persistently display the additional content (e.g., which increases the amount of space needed to display the first and/or second notification, and the first and/or second additional content, thereby reducing visibility of the real and/or virtual surrounds of the user, and cluttering the view of the user (e.g., which makes precise and accurate interaction with user interface objects in the view of the user more difficult)), and enables display of the additional content without needing to display additional controls (e.g., additional controls for displaying and/or ceasing to display the additional content).

In some embodiments, performing, in response to detecting the second input that is directed to the respective notification, the respective operation with respect to the respective notification includes: in accordance with a determination that the second input corresponds to a request to expand content to which the second input is directed (e.g., the second input is a pinch and hold gesture, a gaze and dwell input, an air tap gesture detected while the gaze input is detected on the respective notification, or another type of expansion input) and that the respective notification is a representative notification for a first group of notifications corresponding to a first type of detected events, displaying, concurrently with the respective notification, one or more additional notifications in the first group of notifications that were not displayed at a time when the second input was detected (e.g., if the respective notification is a representative notification for a stack of grouped notifications, the second input causes the stack to be expanded showing individual notifications in the stack); and In one example, the respective notification is a first notification for a first message from a first sender, and the first notification is a latest message for a group of messages from the first sender, and shown as the representative notification for the group of notifications that correspond to the messages received from the first sender; and in response to detecting the second input, the computer system displays respective notifications (e.g., the standard, unexpanded versions of the notifications) for the earlier messages from the first sender that were not initially displayed with the first notification for the first message. In another example, the respective notification is a first notification of a group of notifications for an online shopping application. The group of notifications correspond to a first purchase order made in the online shopping application and the first notification is a lasted notification among the group of notifications, and serves as the representative notification of the group of notifications. In response to detecting the second input, the computer system displays one or more earlier notifications in the group of notifications for the first purchase order, e.g., including notifications for “order confirmed,” “item shipped,” “delivery expected at 3pm today”, and “item delivered.” In another example, the respective notification is a notification of a first email from a first sender, and is a representative notification for a group of notifications for other emails received in the email application. In response to detecting the second input, the computer system displays the respective notifications for other emails received earlier in the email application, where the respective notifications include respective subject headings of the emails, the respective names of the senders, and the respective timestamps of the emails. In another example, the respective notification is a first notification of a newsfeed application, and is a representative notification for a group of notifications corresponding to the same news source, or the same category of news. In response to detecting the second input, the computer system displays multiple notifications in the group of notifications that correspond to other news headlines from the same news source or category of news. Other examples of notifications and their corresponding groups of notifications are possible, in accordance with various embodiments. The respective operation with respect to the respective notification includes: in accordance with a determination that the second input corresponds to a request to expand content to which the second input is directed (e.g., the second input is a pinch and hold gesture, a gaze and dwell input, an air tap gesture detected while the gaze input is detected on the respective notification, or another type of expansion input) and that the respective notification is an individual notification not part of a respective group of notifications, displaying an expanded version of the respective notification (e.g., replacing the standard, unexpanded version of the respective notification), including additional content (e.g., additional text content not initially displayed, media content, contact information for a sender of a received message or communication, and/or attachments (e.g., associated with an email notification)) associated with the respective notification that was not included in the respective notification at the time when the second input was detected. In one example, the respective notification is a notification of a first message from a first sender, and includes an application icon for the messaging application, a portion of the textual content of the first message, the name of the sender, and the timestamp of the first message; and the expanded version of the respective notification includes additional content such as the entirety of the textual content of the first notification, a preview of an attachment (e.g., an image, an animated model, or other graphical or media objects), and one or more controls for performing respective operations associated with the first message (e.g., “reply”, “forward”, “playback”, “save” affordances). In another example, the respective notification is a notification of an online shopping application, and includes the application icon of the online shopping application, a status update for a purchase (“e.g., item shipped”, “item returned”, or “delivery expected at 3pm today”); and the expanded version of the respective notification includes description and images of the items in the order, tracking number of the delivery, and one or more coupons for future purchases. In another example, the respective notification is a notification of a first email from a first sender, and includes an application icon for the email application, a subject heading of the first email, the name of the sender, and the timestamp of the first email; and the expanded version of the respective notification includes additional content such as an excerpt of the textual content of the first email, a preview of an attachment (e.g., a document, an image, an animated model, or other graphical or media objects), and one or more controls for performing respective operations associated with the first email (e.g., “view in application”, “reply”, “forward” affordances). In another example, the respective notification is a notification of a newsfeed application, and includes the application icon of the newsfeed and one or more headlines for one or more subscribed newsfeed; and the expanded version of the respective notification includes the one or more headlines with excerpts of the corresponding news, one or more thumbnail images corresponding to the one or more headlines, and one or more recommended news headlines and one or more controls for unsubscribe, find similar, or save the newsfeed. Other examples of notifications and their corresponding standard or expanded versions are possible, in accordance with various embodiments. For example, in FIG. 7BE-7BF, the user’s attention 7116 is directed to the group 7174 (e.g., a representation of a first group of notifications), and the computer system 7100 displays the notifications 7174-a and 7174-b (e.g., notifications in the first group of notifications). In FIG. 7BC-7BD, the user’s attention 7116 is directed to the notification 7172 (e.g., a single notification that does not represent a group of notifications), and the computer system 7100 displays the expanded version of the notification 7172 (e.g., that includes additional content associated with the notification 7172). Displaying, concurrently with the respective notification, one or more additional notifications in the first group of notifications that were not displayed at a time when the second input was detected, in response to detecting the second input that is directed to a respective notification that is an individual notification not part of a respective group of notifications, and displaying an expanded version of the respective notification, in response to detecting the second input that is directed to a respective notification that is an individual notification not part of a respective group of notifications, automatically performs an appropriate operation based on the type of respective notification, reducing the number of user inputs needed to display appropriate content, and without needing to display additional controls (e.g., a separate control for displaying one or more additional notifications, and a separate control for displaying an expanded version of the respective notification).

In some embodiments, performing, in response to detecting the second input that is directed to the respective notification, the respective operation with respect to the respective notification includes: in accordance with a determination that the second input corresponds to a request to expand content to which the second input is directed (e.g., the second input is a pinch and hold gesture, a gaze and dwell input, an air tap gesture detected while the gaze input is detected on the respective notification, or another type of expansion input) and that the respective notification is a representative notification for a first group of notifications corresponding to a first type of detected events: displaying, concurrently with the respective notification, one or more additional notifications in the first group of notifications that were not displayed at a time when the second input was detected (e.g., if the respective notification is a representative notification for a stack of grouped notifications, the second input causes the stack to be expanded showing individual notifications in the stack); and reducing visual prominence (e.g., darkening, making more translucent, reducing in size, and/or ceasing to display completely) of other notifications that were concurrently displayed with the respective notification at the time when the second input was detected (e.g., such that the notifications in the same group as the respective notification are more visually prominent in the environment). For example, in FIG. 7BE-7BF, in response to detecting that the user’s attention is directed to the group 7174, the computer system 7100 displays the notifications 7174-a and 7174-b, and reduces a visual prominence (e.g., including ceasing to display) of the notification 7170, the notification 7172, and the notification 7178. Concurrently displaying the respective notification and one or more additional notifications in the first group of notifications that were not displayed at a time when a second input was detected, and reducing visual prominence of other notifications that were concurrently displayed with the respective notification at the time when the second input was detected, in response to detecting the second input that is directed to the respective notification, displays appropriate content in a manner that enables the user to efficiently identify and locate the additional content that the user is interacting with (and/or requesting display of).

In some embodiments, performing, in response to detecting the second input that is directed to the respective notification, the respective operation with respect to the respective notification includes: in accordance with a determination that the second input corresponds to a request to dismiss content to which the second input is directed (e.g., the second input is a wave of a hand of the user in the air, an air pinch gesture detected when a gaze input is detected on a “close” or “dismiss” affordance displayed adjacent to the respective notification or a plurality of notifications including the respective notification, or the user’s attention being directed to other regions of the environment outside of the region occupied by the notifications, or another type of scroll input): reducing visual prominence (e.g., darkening, making more translucent, reducing in size, and/or ceasing to display completely) of the respective notification in the respective view of the three-dimensional environment; in accordance with a determination that the second input is directed to a first region relative to the respective notification (e.g., the first region is the location of a dismiss affordance displayed on or adjacent to the respective notification, or the first region is a top corner of the respective notification, or another portion of the respective notification) and that the respective notification is a representative notification for a first group of notifications corresponding to detected events of a first event type, increasing visual prominence (e.g., increasing visibility by increasing brightness, saturation, and opacity, increasing in size, and/or displaying if not previously visible) of a second notification, different from the respective notification, from the first group of notifications in the respective view of the three-dimensional environment (e.g., replacing display of the respective notification with display of a next notification in the first group of notification, or moving the respective notification to a less prominent position and moving the next notification to the more prominent position previously occupied by the respective notification); and in accordance with a determination that the second input is directed to a second region relative to the respective notification that is different from the first region (e.g., the second region is other portions of the respective notification outside of the first region, or the second region is another closing affordance displayed outside of the respective notification), and that the respective notification is the representative notification for the first group of notifications corresponding to detected events of the first event type, forgoing increasing the visual prominence (e.g., increasing visibility by increasing brightness, saturation, and opacity, increasing in size, and/or displaying if not previously visible) of another notification from the first group of notifications in the respective view of the three-dimensional environment, after ceasing displaying the respective notification (e.g., the whole first group of notifications is dismissed from the respective view). For example, as described with reference to FIG. 7BI, in some embodiments, a group representation includes an affordance for dismissing individual notifications and/or an affordance for dismissing the entire group of notifications. In response to detecting that the user’s attention is directed to the affordance for dismissing individual notifications (e.g., in combination with an air gesture (e.g., an air tap or an air pinch), an input via a hardware controller, and/or a verbal input), the computer system 7100 ceases to display an individual notification (e.g., the current notification representing the group of notifications) (e.g., and optionally displays another notification of the group of notifications, as the group representation of the group of notifications). In response to detecting that the user’s attention is directed to the affordance for dismissing the entire group of notifications (e.g., in combination with an air gesture (e.g., an air tap or an air pinch), an input via a hardware controller, and/or a verbal input), the computer system 7100 ceases to display the group representation (e.g., and all notifications represented by the group representation). Detecting a second input corresponding to a request to dismiss content to which the second input is directed, and in response to detecting the second input: reducing visual prominence of the respective notification; increasing a visual prominence of a second notification, different from the respective notification, from the first group of notifications, in accordance with a determination that the respective notification is a representative notification for the first group of notifications; and forgoing increasing the visual prominence of another notification from the first group of notifications, in accordance with a determination that the respective notification is the representation notification for the first group of notifications, causes the computer system to automatically display the appropriate content with the appropriate level of prominence, without the need for additional user inputs (e.g., the user does not need to perform additional user inputs to display the second notification from the first group of notifications, if the respective notification is a representation notification for the first group of notifications). This also allows the user to perform the same type of user input to dismiss notifications (e.g., whether or not they are representative notifications of groups of notifications or not), which reduces the risk of the user accidentally performing the wrong user input (e.g., because the user needs to perform a first type of inputs to dismiss a representative notification and display a second notification from the group of notifications, and a second type of input to dismiss a respective notification that is not a representative notification of a group of notifications, and also needs to know and/or determine whether or not the respective notification is or is not a representative notification of a group of notifications in order to perform the correct type of user input).

In some embodiments, while displaying the second notification at the respective location in the three-dimensional environment after reducing visual prominence of the respective notification in response to the second input, the computer system detects a third input that is directed to the second notification (e.g., a gaze and dwell input, a gaze detected in conjunction with an air pinch gesture, a gaze detected in conjunction with an air pinch and drag gesture, an air pinch and hold gesture, a pinch and drag gesture, a tap gesture, and other types of input directed to the second notification). In response to detecting the third input that is directed to the second notification, and in accordance with a determination that the third input corresponds to a request to dismiss content to which the third input is directed (e.g., the third input is a wave of a hand of the user in the air, an air pinch gesture detected when a gaze input is detected on a “close” or “dismiss” affordance displayed adjacent to the second notification or a plurality of notifications including the second notification, or another type of scroll input): the computer system reduces visual prominence (e.g., darkening, making more translucent, reducing in size, and/or ceasing to display completely) of the second notification in the respective view of the three-dimensional environment; in accordance with a determination that the third input is directed to the first region relative to the second notification (e.g., the first region is the location of a dismiss affordance displayed on or adjacent to the second notification, or the first region is a top corner of the second notification, or another portion of the second notification), the computer system increases visual prominence (e.g., increasing visibility by increasing brightness, saturation, and opacity, increasing in size, and/or displaying if not previously visible) of a third notification, different from the respective notification and the second notification, from the first group of notifications in the respective view of the three-dimensional environment (e.g., replacing display of the second notification with display of a next notification in the first group of notification, or moving the second notification to a less prominent position and moving the next notification to the more prominent position previously occupied by the second notification); and in accordance with a determination that the third input is directed to the second region relative to the second notification, the computer system forgoes increasing the visual prominence (e.g., increasing visibility by increasing brightness, saturation, and opacity, increasing in size, and/or displaying if not previously visible) of another notification from the first group of notifications in the respective view of the three-dimensional environment, after ceasing displaying the second notification (e.g., the whole first group of notifications is dismissed from the respective view). For example, as described with reference to FIG. 7BI, the computer system 7100 reduces a prominence (e.g., ceases to display) a first notification (e.g., the notification 7174-a) represented by the group representation, in response to detecting a user input directed to the group 7174. This process can be repeated (e.g., the computer system 7100 can reduce the prominence (e.g., cease to display) a second notification (e.g., the notification 7174-b) represented by the group representation (e.g., in response to detecting a subsequent user input directed to the group 7174). Detecting a third input corresponding to a request to dismiss content to which the third input is directed, and in response to detecting the third input: reducing visual prominence of the second notification; increasing a visual prominence of a third notification, different from the second notification, from the first group of notifications, in accordance with a determination that third input is directed to a first region relative to the second notification; and forgoing increasing the visual prominence of another notification from the first group of notifications, in accordance with a determination that the third input is directed to a second region relative to the second notification, causes the computer system to automatically display the appropriate content with the appropriate level of prominence, without the need for additional user inputs (e.g., the user does not need to perform additional user inputs to increase the prominence of the third notification from the first group of notifications).

In some embodiments, performing, in response to detecting the second input that is directed to the respective notification, the respective operation with respect to the respective notification includes: in accordance with a determination that the second input corresponds to a request to dismiss content to which the second input is directed (e.g., the second input is a wave of a hand of the user in the air, an air pinch gesture detected when a gaze input is detected on a “close” or “dismiss” affordance displayed adjacent to the respective notification or a plurality of notifications including the respective notification, or the user’s attention being directed to other regions of the environment outside of the region occupied by the notifications, or another type of scroll input): reducing visual prominence (e.g., darkening, making more translucent, reducing in size, and/or ceasing to display completely) of the respective notification in the respective view of the three-dimensional environment; in accordance with a determination that the second input is directed to a first region relative to the respective notification (e.g., the first region is the location of a dismiss affordance displayed on or adjacent to the respective notification, or the first region is a top corner of the respective notification, or another portion of the respective notification) and that the respective notification is a representative notification for a first group of notifications corresponding to detected events of a first event type, increasing visual prominence (e.g., increasing visibility by increasing brightness, saturation, and opacity, increasing in size, and/or displaying if not previously visible) of a third notification, different from the respective notification, from the first group of notifications in the respective view of the three-dimensional environment (e.g., replacing display of the respective notification with display of a next notification in the first group of notification, or moving the respective notification to a less prominent position and moving the next notification to the more prominent position previously occupied by the respective notification); and in accordance with a determination that the second input is directed to the first region relative to the respective notification (e.g., the first region is the location of a dismiss affordance displayed on or adjacent to the respective notification, or the first region is a top corner of the respective notification, or another portion of the respective notification) and that the respective notification is an individual notification not part of a group of notifications, forgoing increasing the visual prominence (e.g., increasing visibility by increasing brightness, saturation, and opacity, increasing in size, and/or displaying if not previously visible) of another notification in the respective view of the three-dimensional environment, after ceasing displaying the respective notification (e.g., the respective notification is dismissed from the respective view, and other notifications remain displayed in the respective view). For example, in FIG. 7BH, the user’s attention 7116 is directed the notification 7178, and the computer system 7100 ceases to display the notification 7178 in FIG. 7BI. As described with reference to FIG. 7BI, in some embodiments, the user 7002 performs an analogous input (e.g., directing the user’s attention 7116 to a notification or group, and performing an air gesture, such as an air tap or an air pinch, or another selection input, as described above with reference to FIG. 7BH), with the user’s attention directed to a group representation of multiple notifications (e.g., the group 7174, which represents two notifications 7174-a and 7174-b). In response to detecting the user input directed to the group representation, the computer system 7100 ceases to display (e.g., dismisses) a first notification represented by the group representation (e.g. if the user input was directed to the group 7174, the computer system 7100 would cease to display notification content (e.g., a preview of notification content) corresponding to the notification 7174-a, and optionally, would update display of the group 7174 to include notification content (e.g., a preview of) the notification 7174-b (e.g., because the notification 7174-b is the “next” notification in the group 7174)). Reducing visual prominence of the respective notification; increasing visual prominence of a third notification, different from the respective notification, from the first group of notifications, in accordance with a determination that the respective notification is a representative notification for a first group of notifications; and forgoing increasing the visual prominence of another notification, after ceasing displaying the respective notification, and in accordance with a determination that the respective notification is an individual notification not part of a group of notifications, automatically display the appropriate content with the appropriate level of prominence, without the need for additional user inputs (e.g., the user does not need to perform additional user inputs to increase the prominence of the third notification from the first group of notifications). This also allows the user to perform the same user input to reduce the prominence of (e.g., dismiss) notifications (e.g., whether or not they are representative notifications of groups of notifications or not), which reduces the risk of the user accidentally performing the wrong user input (e.g., because the user needs to perform a first type of inputs to dismiss the respective notification and display the third notification from the group of notifications, and a second type of input to dismiss the respective notification that is not a representative notification of a group of notifications, and also needs to know and/or determine whether or not the respective notification is or is not a representative notification of a group of notifications in order to perform the correct type of user input).

In some embodiments, performing, in response to detecting the second input that is directed to the respective notification, the respective operation with respect to the respective notification includes: in accordance with a determination that the second input corresponds to a request to dismiss content to which the second input is directed (e.g., the second input is a wave of a hand of the user in the air, an air pinch gesture detected when a gaze input is detected on a “close” or “dismiss” affordance displayed adjacent to the respective notification or a plurality of notifications including the respective notification, or the user’s attention being directed to other regions of the environment outside of the region occupied by the notifications, or another type of scroll input): in accordance with a determination that the second input is directed to the first region relative to the respective notification (e.g., the first region is the location of a dismiss affordance displayed on or adjacent to the respective notification, or the first region is a top corner of the respective notification, or another portion of the respective notification) and that the respective notification is an individual notification not part of a group of notifications, displaying a fourth notification at the respective location that was occupied by the respective notification at a time when the second input was detected. In some embodiments, the respective notification is replaced by another notification corresponding to a detected event that was not previously displayed. In some embodiments, the respective notification is replaced by another notification of the plurality of notifications that was concurrently visible with the respective notification at the time that the second input was detected. For example, before replacing display of the respective notification with the notification different from the respective notification, a plurality of notifications are displayed in a particular order (e.g., reverse chronological order), and the respective notification is replaced by a notification of the plurality of notifications that follows the respective notification in the particular order (e.g., is the next most recent notification), and the other displayed notifications adjust their positions to maintain the particular order (e.g., each remaining notification of the plurality of notifications that are older than the respective notification take the previous position of the notification immediately before the remaining notification to maintain the particular order), and optionally, a new notification that is not a notification of the plurality of notifications is displayed (e.g., in the previous position of the oldest notification of the plurality of notifications). For example, in FIG. 7BH-7BI, in response to detecting the user’s attention 7116 is directed to the notification 7178 (e.g., in conjunction with an air gesture, such as an air tap or an air pinch, or another selection input), the computer system 7100 ceases to display the notification 7178, and displays (in FIG. 7BI) the notification 7192 at the location previously occupied by the notification 7178 in FIG. 7BH. Displaying a fourth notification at the respective location that was occupied by the respective notification at a time when the second input was detected, in response to detecting a second input that corresponds to a request to dismiss content to which the second input is directed, automatically displays notifications (e.g., other than the respective notification) at appropriate locations, which reduces the number of user inputs needed to display notifications at appropriate locations (e.g., the user does not need to perform additional user inputs to move or adjust the location(s) of notifications after dismissing (e.g., ceasing to display) the respective notification).

In some embodiments, the respective notification is concurrently displayed with one or more other notifications that correspond to respective detected events (e.g., the respective notification and the one or more other notifications include representative notifications for one or more groups of notifications and/or individual notifications that do not belong to any group of notifications). While concurrently displaying the respective notification and the one or more other notifications that correspond to respective detected events, the computer system detects a third change in a current viewpoint of a user (e.g., based on movement of at least a portion of the computer system and/or a shift in a virtual viewpoint of the user of the computer system, based on movement of the user’s head or as a whole in the physical environment (e.g., while the user wears the display generation component on his head or over his eyes), and/or based on a request for locomotion that causes the viewpoint of the user to move (e.g., translate, pan, tilt, and rotate) inside the virtual three-dimensional environment) from a first viewpoint associated with the first view of the three-dimensional environment to a third viewpoint associated with a third view of the three-dimensional environment. In response to detecting the third change in the current viewpoint of the user: the computer system updates the respective view of the three-dimensional environment in accordance with the third change of the current viewpoint of the user (e.g., from the first view to the third view corresponding to the third viewpoint, optionally, through a sequence of intermediate views corresponding to a sequence of intermediate viewpoints along the movement path of the current viewpoint); and the computer system changes respective visual appearances of the respective notification and the one or more other notifications (e.g., the plurality of notifications take on different sets of values for the first visual characteristic) based at least in part on a respective set of values for the first visual characteristic of respective portions of the three-dimensional environment that are behind the respective notification and the one or more other notifications relative to the third viewpoint of the user (e.g., as the respective portions change due to the movement of the viewpoint). In some embodiments, the computer system displays an individual notification of the plurality of notifications with a respective visual appearance as described above with reference to the respective notification (e.g., changes in accordance with changes in the appearance of the physical objects/lighting, virtual objects/lighting, changes in accordance with relative movement between the notification and the viewpoint, and in accordance with relative movement between the notification and the three-dimensional environment). In some embodiments, the computer system continually updates the visual appearances of individual notifications in the plurality of notification while the viewpoint of the user moves in the three-dimensional environment relative to the respective notification and the one or more other notifications. For example, in FIG. 7BI-7BJ, the user 7002 moves from a location 7026-g to a location 7026-h (e.g., resulting in a change to the current viewpoint of the user). In response, the computer system 7100 updates the view of the three-dimensional environment in accordance with the change in viewpoint (e.g., in FIG. 7BJ, the representation 7014′ and the virtual object 7012 are displayed further to the right, as compared to their locations in FIG. 7BI, reflecting the movement of the user 7002), and the computer system 7100 updates the visual appearances of the notification 7172, the group 7174, the notification 7192, and the notification 7194 (e.g., the notification 7172 and the group 7174 no longer occlude the representation 7014′ and are displayed with a default appearance in FIG. 7BJ; the notification 7192 occluded the virtual object 7012 in FIG. 7BI and occludes the representation 7014′ in FIG. 7BJ, and so is displayed with a different visual appearance (e.g., for the bottom portion of the notification 7116); and the notification 7194 did not occlude any physical or virtual objects in FIG. 7BI, but occludes the representation 7014′ in FIG. 7BJ, and so is displayed with a different visual appearance (e.g., for the lower left corner of the notification 7194). Changing respective visual appearances of the respective notification and the one or more other notifications based at least in part on a respective set of values for the first visual characteristic of respective portions of the three-dimensional environment that are behind the respective notification and the one or more other notifications relative to the third viewpoint of the user, and updating the respective view of the three-dimensional environment in accordance with the third change of the current viewpoint of the user, reduces the number of user inputs needed to display the respective notification and the one or more other notifications with an appropriate appearance (e.g., the user does not need to perform additional user inputs to update the appearances of the respective notification and the one or more other notifications)) and provides improved visual feedback regarding the user’s real and/or virtual surroundings (e.g., that accurately reflect the relationship between the respective notification, the one or more other notifications, and the three-dimensional environment that is behind the respective notification and the one or more other notifications).

In some embodiments, the computer system maintains respective positions of the respective notification and the one or more other notifications in the three-dimensional environment while the current viewpoint of the user changes from the first viewpoint to the third viewpoint (e.g., the positions of the notifications are locked to the three-dimensional environment, and do not change with the movement of the viewpoint that corresponds to the currently displayed view of the three-dimensional environment). For example, as described with reference to FIG. 7BJ, the notifications and groups in the notification history user interface are environment-locked, and do not move in accordance with changes to the viewpoint of the user (e.g., maintain the same spatial relationship to the representation 7014′ and the virtual object 7012, regardless of how the user 7002 and/or the computer system 7100 move). Maintaining respective positions of the respective notification and the one or more other notifications in three-dimensional environment while the current viewpoint of the user changes from a first viewpoint to a third viewpoint, reduces the risk that the user accidentally moves the respective notification and/or one or more other notifications (e.g., due to small and/or temporary changes in the viewpoint of the user) and reduces the number of user inputs needed to display the respective notification and the one or more other notifications at appropriate locations (e.g., the user does not need to perform additional user inputs to change the location of the respective notification and the one or more other notifications any time the viewpoint of the user changes)..

In some embodiments, while concurrently displaying the respective notification and the one or more other notifications in the respective view of the three-dimensional environment, the computer system detects a fourth input (e.g., an air gesture (e.g., an air tap or an air pinch) detected in conjunction with a gaze input; an air gesture, a touch gesture, an input provided via a controller, a voice command, and/or other types of input) directed to at least one of the respective notification and the one or more other notifications. In response to detecting the fourth input, in accordance with a determination that the fourth input corresponds to a request to move content to which the fourth input is directed, the computer system constrains movement of the respective notification and the one or more other notifications that are concurrently displayed in the respective view of the three-dimensional environment, despite of the fourth input. In some embodiments, constraining the movement of the respective notification and the one or more other notifications include preventing movement of the respective notification and the one or more notifications completely, and ignoring the fourth input. In some embodiments, constraining the movement of the respective notification and the one or more other notifications include providing some visual feedback to the fourth input, such as moving at least one of the respective notification and the one or more notifications in accordance with the fourth input, but limit a range of the movement and/or restoring the moved notification(s) back to their original locations after the fourth input ends. For example, as described with reference to FIG. 7BI, in some embodiments, the notifications and groups in the notification user interface cannot be positioned by the user (e.g., the computer system 7100 determines the locations of the notifications and groups in the notification user interface, and those locations cannot be modified by the user 7002 via gaze inputs, air gestures, and/or movement). Constraining movement of the respective notification and the one or more other notifications that are concurrently displayed in the respective view of the three-dimensional environment, despite the fourth input directed to at least one of the respective notification and the one or more other notifications, reduces the risk that the user accidentally moves the respective notification and/or one or more other notifications (e.g., while attempting to interact with other user interfaces and/or user interface objects in the respective view three-dimensional environment).

In some embodiments, prior to detecting the first input, the computer system displays a system user interface (e.g., the system function menu 7024 described in FIG. 7E and 7AM, or the indicator 7010 of system function menu in FIGS. 7A and 7AM) in the respective view of the three-dimensional environment, wherein the system user interface includes one or more affordances for accessing system functions of the computer system, and wherein detecting the first input includes detecting an input directed to the system user interface (e.g., detecting selection of a first affordance of the one or more affordances in the system user interface (e.g., an affordance or control of the system user interface that, when selected, causes display of a notification user interface including one or more previously received notifications), and/or detecting scrolling of recent notifications pass a threshold). For example, in FIG. 7BB, the computer system 7100 displays the system function menu 7024 (e.g., prior to detecting the user’s attention 7116 is directed to the notification affordance 7044, which causes display of the notification history user interface, as shown in FIG. 7BC). This is also shown in FIG. 7K(c), which displays a system space 7052 which is a notification center. Displaying a system user interface that includes one or more affordances for accessing system functions of the computer system, prior to detecting the first input, and detecting that the first input is directed to the system user interface, enables the respective notification to be displayed from a consistent location (e.g., the system user interface), and allows the computer system to only display the system user interface (and the one or more affordances for accessing system functions of the computer system) when needed (e.g., specifically when the user is attempting to access a system function of the computer system), which improves visibility of the user’s real and/or virtual surroundings while the computer system is in use.

In some embodiments, the system user interface includes one or more recent notifications that correspond to respective detected events that satisfy timing criteria (e.g., detected events that were detected within a threshold amount of time (e.g., 5 seconds, 10 seconds, 30 seconds, 1 minute, 15 minutes, 30, minutes, 1 hour, 2 hours, or 5 hours)). For example, as described with reference to FIG. 7BC, the notifications 7170, 7172, 7174, and 7178 are notifications that satisfy timing criteria (e.g., are notifications that were generated within a threshold amount of time (e.g., 5 minutes, 10 minutes, 30 minutes, 1 hour, 2 hours, 5 hours, or 12 hours) from the current time). As described with reference to FIG. 7K(c), in some embodiments, the notification history user interface (e.g., that includes the notifications 7170, 7172, 7174, and 7178) is a system space (e.g., the system space 7052 of FIG. 7K(c)). Displaying the system user interface that includes one or more affordances for accessing system functions of the computer system, and that includes one or more recent notifications that correspond to respective detected events that satisfy timing criteria, reduces the number of user inputs needed to display notifications satisfying timing criteria (e.g., notifications satisfying timing criteria are displayed in the system user interface, and the user does not need to perform additional user inputs directed to one of the affordances for accessing system functions of the computer system in order to display the notifications satisfying timing criteria).

In some embodiments, the one or more recent notifications included in the system user interface are scrollable in a first direction (and are optionally not scrollable in a second direction) relative to the respective view of the three-dimensional environment, and the respective notification is concurrently displayed with one or more other notifications in the respective view of the three-dimensional environment, and the respective notification and the one or more other notifications are scrollable in a second direction, different from the first direction, relative to the respective view of the three-dimensional environment. For example, as described with reference to FIG. 7BA, in some embodiments, the system function menu 7024 also includes one or more recently received notifications (e.g., notifications for events that satisfy timing criteria, such as notifications that were generated withing a threshold amount of time (e.g., 5 minutes, 10 minutes, 30 minutes, 1 hour, 2 hours, 5 hours, 12 hours, or 24 hours) from the current time). The user can navigate through the one or more recently received notifications (e.g., the one or more recently received notifications are displayed vertically, and the user can navigate through the notifications by scrolling the notifications up or down. In the notification history user interface (e.g., as shown in FIG. 7BG-7BH), the user can navigate through notifications by scrolling notifications to the left (e.g., and optionally to the right), rather than up or down (e.g., as in the system function menu 7024). Displaying one or more notifications in the system user interface that are scrollable in a first direction, and concurrently displaying the respective notification with one or more other notifications, wherein the respective notification and the one or more other notifications are scrollable in a second direction different from the first direction, enables the computer system to display notifications in an appropriate and efficient manner (e.g., depending on the context). For example, the computer system displays the one or more notifications in the system user interface so that the user can quickly access notifications that satisfy timing criteria without further user input, and in this context, the computer system only scrolls the notifications in the first direction (e.g., as the user does not need to, or is not expected to, scroll notifications in the second direction). If the user performs additional user inputs (e.g., to display the respective notification and the one or more other notifications), the computer system allows for scrolling in the second direction (e.g., because the user performs additional user inputs, indicating that the user needs more, or different, control over how notifications are scrolled).

In some embodiments, the second input that is directed to the respective notification includes a gaze input that is directed to the respective notification (e.g., gaze that satisfies location and/or duration requirements, and/or in conjunction with an air gesture (e.g., an air tap or an air pinch), or other types of gestures or other types of inputs). For example, in FIG. 7BC, the second input that is directed to the respective notification (e.g., the notification 7172) includes a gaze input (e.g., as represented by the user’s attention 7116) that is directed to the notification 7172. Detecting the second input that is directed to the respective notification, wherein the first input includes a gaze input that is directed to the respective notification, allows the relevant functions to be performed without needing to display additional controls (e.g., additional controls for performing the relevant functions), and also allows the computer system to be operated in scenarios where other types of inputs (e.g., air gestures, inputs via a hardware controller, and/or verbal inputs) are not feasible or desirable (e.g., in closed spaces, or in contexts where other people who are not users of the computer system and/or interacting with the user or computer system are present).

In some embodiments, the second input that is directed to the respective notification includes an air gesture (e.g., an air tap or an air pinch). In some embodiments, the second input includes an air gesture (e.g., an air tap or an air pinch) that is detected while the computer system detects that the attention of the user is directed to the respective notification. In some embodiments, the second input is an air gesture that does not require any gaze component (e.g., the user can perform the second input, and the computer system will display the one or more notifications, regardless of where the attention of the user is directed). In some embodiments, the first input is an air gesture (e.g., an air tap or an air pinch) that is directly detected at the location of the respective notification. For example, as described above with reference to FIG. 7BC, the user’s attention 7116 is directed to the notification 7172 in combination with an air gesture (e.g., an air tap or an air pinch) and/or input via a hardware button of the computer system 7100). Detecting the second input that is directed to the respective notification, wherein the second input includes an air gesture (e.g., an air tap or an air pinch), reduces the risk of the user performing an incorrect function (e.g., gaze-only inputs increase the risk that the user will accidentally perform an undesired function because the user’s attention is accidentally and/or temporarily directed to the wrong locations and/or affordances, for functions that the user intends to perform).

In some embodiments, aspects/operations of methods 8000, 9000, 10000, 11000, 12000, 13000, 14000, 15000, and 16000 may be interchanged, substituted, and/or added between these methods. For example, the first user interface object (e.g., system control indicator) in the method 15000 in some circumstances has a different appearance as described in the methods 9000-14000, and 16000, and the user interface elements that are displayed (e.g., the plurality of affordances for accessing system functions of the first computer system) may be replaced by, or concurrently displayed with, other user interface elements (e.g., additional content associated with a notification, a user interface that includes an affordance for joining a communication session, and other user interface elements in the methods 9000-14000, and 16000). For brevity, these details are not repeated here.

FIGS. 16A-16B are flow diagrams of an exemplary method 16000 for moving, hiding and redisplaying user interface objects in accordance with movement of the viewpoint of the user, in accordance with some embodiments. In some embodiments, the method 16000 is performed at a computer system (e.g., computer system 101 in FIG. 1) (which is sometimes referred to as “the first computer system”) that is in communication with a display generation component (e.g., display generation component 120 in FIGS. 1, 3, and 4) (e.g., a heads-up display, a display, a touchscreen, or a projector) and one or more input devices (e.g., a touch screen, a camera, and/or a microphone). In some embodiments, the computer system optionally includes one or more cameras (e.g., a camera (e.g., color sensors, infrared sensors, and/or other depth-sensing cameras) that points towards the user (e.g., to detect the gaze of the user) and/or a camera that points forward (e.g., to facilitate displaying elements of the physical environment captured by the camera). In some embodiments, the method 9000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 16000 are, optionally, combined and/or the order of some operations is, optionally, changed.

The method (16000) relates to hiding and redisplaying different types of user interface elements. For example, one type of user interface element is continuously displayed for the user at a position within the three-dimensional environment based on the user’s current viewpoint of the three-dimensional environment, while another type of user interface element is visually deemphasized as the user moves around in the physical environment, thus changing the user’s viewpoint, and is redisplayed for the user after the user’s viewpoint has settled at a new view. Automatically deemphasizing and/or hiding, and redisplaying user interface objects at updated displayed locations based on the type of user interface object and based on whether the user’s current viewpoint is settled at a position or is still moving, provides real-time visual feedback as the user shifts their viewpoint to different portions of the three-dimensional environment and reduces a number of inputs needed to reinvoke a user interface object that follows the user’s viewpoint. Providing improved visual feedback to the user and reducing the number of inputs needed to perform an operation enhances the operability of the system and makes the user-system interface more efficient (e.g., by helping the user to provide proper inputs and reducing user mistakes when operating/interacting with the system) which, additionally, reduces power usage and improves battery life of the system by enabling the user to use the system more quickly and efficiently.

The computer system displays (16002), via the first display generation component, a first user interface object (e.g., a system user interface object such as a window, one or more system indicators (e.g., indicator 7010 of system function menu described with reference to FIG. 7B and method 8000), a user interface element that is accessible via a respective input that includes one or more controls for controlling one or more system functions (e.g., system function menu 7024, described with reference to FIG. 7D and method 8000), system controls, alerts, and/or session updates, an application user interface object such as a window, a modal user interface, a controller for one or more operations in an application, and/or one or more virtual objects in the environment) in a first view of a three-dimensional environment that corresponds to a first viewpoint of a user, wherein the first user interface object is displayed at a first position in the three-dimensional environment and has a first spatial relationship with the first viewpoint of the user. In some embodiments, the first user interface object is located in a first portion of the field of view provided by the first display generation component, and has a first distance, first orientation, and a first angle relative to the viewpoint of the user (e.g., as determined based on a pose (e.g., position and orientation) of the display generation component, a pose of a head or eyes of the user, a pose of one or more cameras that captures the physical environment represented in the three-dimensional environment). In some embodiments, the first user interface object has a second spatial relationship to the first view of the three-dimensional environment, where the second spatial relationship to the first view of the three-dimensional environment corresponds to the first spatial relationship to the first viewpoint of the user. For example, as described with reference to FIG. 7BK, a plurality of user interface objects (e.g., virtual user interface objects), including notification 7196, alert 7198-1, virtual assistant 7200-1 and system function menu 7024 are displayed.

While displaying the first user interface object in the first view of the three-dimensional environment, the computer system detects (16004), via the one or more input devices, first movement of a current viewpoint of the user from the first viewpoint to a second viewpoint of the user (e.g., change in viewpoint caused by the movement of the user’s head, user’s position as a whole, the display generation component, and/or the one or more cameras that captures the representation of the physical environment in the three-dimensional environment). For example, as described with reference to FIG. 7BK-7BL, the user 7002 moves to a new location in the physical environment.

In response to detecting the first movement of the current viewpoint of the user from the first viewpoint to the second viewpoint (16006), the computer system replaces (16008) display of the first view of the three-dimensional environment with display of a second view of the three-dimensional environment that corresponds to the second viewpoint of the user. For example, as described with reference to FIG. 7BL, in response to the user 7002 moving to a new location in the physical environment, a different view of the physical environment 7000 is visible to the user 7002 (e.g., such that the viewpoint of the user is updated).

In accordance with a determination that the first movement of the current viewpoint of the user from the first viewpoint to the second viewpoint does not meet first criteria (e.g., does not include a threshold amount of movement in a respective direction, the current viewpoint does not remain substantially stationary at the second viewpoint, and/or does not move the original position of the first user interface object outside of the current view of the three-dimensional environment) and that the first user interface object is of a first type (e.g., first category of objects, objects meeting a first set of conditions, objects having a first set of appearances, behaviors and/or functions), the computer system displays (16010) the first user interface object in the second view of the three-dimensional environment, wherein the first user interface object is displayed at a second position, different from the first position, in the three-dimensional environment and has the first spatial relationship with the second viewpoint of the user. For example, as described with reference to FIG. 7BL, the user’s viewpoint has not moved by at least a threshold amount, such that notification 7196 (e.g., a user interface object of the first type) continues to be displayed in the user’s current view illustrated in FIG. 7BL. In some embodiments, the first user interface object is maintained in the field of view provided via the first display generation component, and maintains the first spatial relationship to the current viewpoint of the user throughout the first movement of the current viewpoint of the user. In some embodiments, the first user interface object maintains the second spatial relationship to the second view of the three-dimensional environment, where the second spatial relationship to the second view of the three-dimensional environment corresponds to the first spatial relationship to the second viewpoint of the user.

In accordance with a determination that the first movement of the current viewpoint of the user from the first viewpoint to the second viewpoint does not meet the first criteria (e.g., does not include a threshold amount of movement in a respective direction, the current viewpoint does not remain substantially stationary at the second viewpoint, and/or does not move the original position of the first user interface object outside of the current view of the three-dimensional environment) and that the first user interface object is of a second type (e.g., second category of objects, objects meeting a second set of conditions, objects having a second set of appearances, behaviors and/or functions) different from the first type, the computer system forgoes (16012) displaying the first user interface object at the second position in the three-dimensional environment in the second view of the three-dimensional environment (e.g., the first user interface object no longer has the first spatial relationship with the current viewpoint of the user). For example, as described with reference to FIG. 7BL, the user’s viewpoint has not moved by at least a threshold amount, such that alert 7198-1 (e.g., a user interface object of the first type) continues to be displayed in the user’s current view at a same position relative to the three dimensional environment. In some embodiments, the first user interface object remains in the field of view provided via the first display generation component, and remains at the first position in the three-dimensional environment. In some embodiments, the first user interface object moves out of the field of view provided via the first display generation component when the first position in the three-dimensional environment is no longer visible in the current field of view of the display generation component. In some embodiments, when the movement of the viewpoint of the user does not meet the first criteria, the object of the first type is viewpoint locked (e.g., remains substantially stationary relative to the field of view provided by the first display generation component), and the object of the second type is world locked (e.g., remains substantially stationary relative to the three-dimensional environment, including the representations of physical objects and/or virtual objects in the three-dimensional environment that are substantially stationary).

The computer system detects (16014), via the one or more input devices, second movement of the current viewpoint of the user from the second viewpoint to a third viewpoint of the user (e.g., a continuation of the first movement of the current viewpoint or subsequent movement of the viewpoint and/or a movement that starts while displaying the second view of the three-dimensional environment that corresponds to the second viewpoint of the user) (e.g., a change in viewpoint caused by the continuing movement of the user’s head, user’s position as a whole, the display generation component, and/or the one or more cameras that captures the representation of the physical environment in the three-dimensional environment, after the first movement of the current viewpoint is completed). In some embodiments, the continuation of the first movement is movement that occurs within a threshold amount of time after the completion of the first movement of the current viewpoint. In some embodiments, the continuation of the first movement is movement that occurs without a substantial amount of time in which less that a threshold amount of movement has been made (e.g., without a substantial amount of rest or stationary period) after the first movement of the viewpoint. For example, as described with reference to FIG. 7BQ, the user’s viewpoint is settled.

In response to detecting the second movement of the current viewpoint of the user from the second viewpoint to the third viewpoint (16016), the computer system replaces (16018) display of the second view of the three-dimensional environment with display of a third view of the three-dimensional environment that corresponds to the third viewpoint of the user. In accordance with a determination that the second movement of the current viewpoint of the user from the second viewpoint to the third viewpoint meets the first criteria (e.g., includes the threshold amount of movement in a respective direction, the current viewpoint remains substantially stationary at the third viewpoint, and/or the original position of the first user interface object is outside of the current view of the three-dimensional environment), the computer system displays (16020) the first user interface object in the third view of the three-dimensional environment, wherein the first user interface object is displayed at a third position, different from the first position and the second position, in the three-dimensional environment and has the first spatial relationship with the third viewpoint of the user, irrespective of whether the first user interface object is of the first type or the second type. For example, as described with reference to FIG. 7BQ, user interface objects of the first type (e.g., notification 7196) and user interface objects of the second type (e.g., alert 7198-7) are displayed in the current viewpoint of the user (e.g., once the user has settled in FIG. 7BQ), at new respective positions in the three dimensional environment (e.g., to appear at a same position relative to the user’s current viewpoint). In some embodiments, when the first criteria are met by the continued movement of the current viewpoint, and the first user interface object is of the first object type, the first user interface object is maintained in the field of view provided via the first display generation component, and maintains the first spatial relationship to the current viewpoint of the user throughout continuation of the first movement of the current viewpoint of the user. In some embodiments, when the first criteria are met by the continued movement of the current viewpoint, and the first user interface object is of the second object type, the first user interface object ceases to remain at the first position in the three-dimensional environment, and is displayed at a new position in the updated field of view to have the first spatial relationship with the current viewpoint of the user. In some embodiments, the object of the second type remains in the field of view provided via the first display generation component throughout the first movement and the continuation of the first movement of the viewpoint (e.g., jumps from the first position to the third position in the three-dimensional environment when the first criteria are met). In some embodiments, the object of the second type ceases to be displayed for a period of time in which the first position is moved outside of the current field of view and before the first criteria are met by the continuation of the first movement of the viewpoint. In some embodiments, when the movement of the viewpoint of the user meets the first criteria, the first user interface object, regardless of whether it is an object of the first type or an object of the second type, is displayed at a new position that has the first spatial relationship with the current viewpoint of the user. In some embodiments, when there is an object of the first type and an object of the second type concurrently visible in the first view of the three-dimensional environment, both the object of the first type and the object of the second type will move to their respective new positions to maintain their respective spatial relationships with the current viewpoint of the user.

In some embodiments, user interface objects of the first type include a user interface element that is accessible via a respective input that includes one or more controls for controlling one or more system functions (e.g., as described with reference to system function menu 7024 and/or indicator 7010, and method 8000). For example, if the first user interface object is a user interface element that, when invoked (e.g., by a user input), displays one or more controls for controlling one or more system functions, the first user interface object is of the first type and continuously follows movement of the user’s viewpoint such that the first user interface object remains at a same position relative to the currently displayed view of the environment, and that the first user interface object has a predictable location in the field of view of the user whenever the user wishes to locate it despite of having moved/looked around in the environment. For example, as described with reference to FIG. 7BK, system function menu 7024 is a user interface object in the first category of the plurality of categories of user interface objects. In some embodiments, user interface objects in the first category of user interface objects, including system function menu 7024, exhibit continuous follow behavior and thus continue to be displayed (e.g., at or near a same position) in the current viewpoint of the user as the user’s viewpoint changes, as though system function menu 7024 is following the user’s viewpoint. Continuously displaying a heads-up display user interface element that displays a plurality of controls at a same position relative to the user, even as the user changes the user’s current viewpoint, provides the user with access to various controls for the computer system without requiring additional user input to access the controls.

In some embodiments, user interface objects of the first type include closed captions for concurrently played media content (e.g., audio file, movie, speech input, speech output, voice over, and/or instructions output in enhanced accessibility mode). For example, if the first user interface object includes closed captions for media content that is currently played in the three-dimensional environment, the first user interface object is of the first type and continuously follows movement of the user’s viewpoint such that the first user interface object remains at a same position relative to the currently displayed view of the environment and that the first user interface object has a predictable location in the field of view of the user whenever the user wishes to locate it despite of having moved/looked around in the environment. For example, as described with reference to FIG. 7BK, closed captions are displayed as a user interface object in the first category of the plurality of categories of user interface objects. In some embodiments, user interface objects in the first category of user interface objects, including closed captions, exhibit continuous follow behavior and thus continue to be displayed (e.g., at or near a same position) in the current viewpoint of the user as the user’s viewpoint changes, as though the closed captions are following the user’s viewpoint. Continuously displaying closed captions at a same position relative to the user, even as the user changes the user’s current viewpoint, reduces the number of inputs and the amount of display area needed for viewing feedback about a state of the device.

In some embodiments, user interface objects of the first type include notifications (e.g., a notification associated with an application of the computer system, optionally, not including notifications and alerts regarding overall system status that are generated by the operating system). For example, if the first user interface object is a notification generated by an application, the first user interface object is of the first type and continuously follows movement of the user’s viewpoint such that the user interface object(s) remain at a same position relative to the currently displayed view of the environment and that the first user interface object has a predictable location in the field of view of the user whenever the user wishes to locate it despite of having moved/looked around in the environment. For example, as described with reference to FIG. 7BK, notification 7196 is a user interface object in the first category of the plurality of categories of user interface objects. In some embodiments, user interface objects in the first category of user interface objects, including notification 7196, exhibit continuous follow behavior and thus continue to be displayed (e.g., at or near a same position) in the current viewpoint of the user as the user’s viewpoint changes, as though notification 7196 is following the user’s viewpoint. Continuously displaying a notification at a same position relative to the user, even as the user changes the user’s current viewpoint, reduces the number of inputs and the amount of display area needed for viewing feedback about a state of the device.

In some embodiments, prior to detecting the first movement of the current viewpoint of the user from the first viewpoint to the second viewpoint, the computer system displays a second user interface object, distinct from the first user interface object, in the first view of the three-dimensional environment, wherein the second user interface object is of the first type. For example, in some scenarios, two user interface objects of the first type are concurrently displayed in the first view of the three-dimensional environment. In some embodiments, the two user interface objects are different categories of objects of the first type. For example, the first user interface object is a notification while the second user interface object includes closed captions for concurrently played media content. For example, as described with reference to FIG. 7BK, user interface objects in the first category, such as notification 7196 and system function menu 7024 are concurrently displayed. In some embodiments, in response to detecting the first movement of the current viewpoint of the user from the first viewpoint to the second viewpoint: in accordance with a determination that the first movement of the current viewpoint of the user from the first viewpoint to the second viewpoint does not meet the first criteria and that the first user interface object is of the first type, the computer system: moves the first user interface object in a first manner, in accordance with the first movement of the current viewpoint of the user; and in accordance with a determination that the first movement of the current viewpoint of the user from the first viewpoint to the second viewpoint does not meet the first criteria and that the second user interface object is of the first type, the computer system: moves the second user interface object in a second manner, distinct from the first manner, in accordance with the first movement of the current viewpoint of the user; and displays the second user interface object in the second view of the three-dimensional environment, wherein the second user interface object is displayed at a new position in the three-dimensional environment, the new position having a similar (e.g., a same or substantially the same) spatial relationship with the second viewpoint as a previous position of the second user interface object has with the first viewpoint of the user before the first movement of the current viewpoint from the first viewpoint to the second viewpoint. For example, as described above with reference to FIG. 7BK, the computer system optionally implements different distance, angle, and/or speed requirements for different categories of the user interface objects exhibiting the continuous follow behavior to start following the viewpoint in response to the movement of the viewpoint. For example, both the first and second user interface objects are of the first type (e.g., that continuously follow the current viewpoint of the user), but the first and second user interface objects follow the current viewpoint of the user in different manners, such as with different speeds and/or amounts. For example, the notification moves at a first rate that closely matches the movement of the viewpoint of the user, while the closed captions move at a slower rate than the notification (e.g., while continuously following the viewpoint of the user as the user’s viewpoint moves). In some embodiments, the different categories of objects of the first type optionally start to follow the movement of the viewpoint with different starting inertia, but eventually all catch up with the movement of the viewpoint after a period of time during the movement of the viewpoint and/or when the movement of the viewpoint slows down or stops (e.g., satisfies settling criteria). For example, as described with reference to FIG. 7BK, user interface objects in the first category have different types of continuous follow behavior. For example, notification 7196 has a different continuous follow behavior than system function menu 7024. Automatically moving certain user interface objects in the three-dimensional environment to follow the user’s current viewpoint at different rates while the user moves in the physical environment, provides real-time visual feedback as the user moves around the physical environment and displays user interface objects at a convenient position such that the user is enabled to view and interact with the user interface objects even as the user moves in the physical environment, thereby providing improved visual feedback to the user.

In some embodiments, moving the first user interface object in the first manner in accordance with the first movement of the current viewpoint of the user includes moving the first user interface object with a first damping factor relative to the first movement of the current viewpoint of the user (e.g., the first user interface object follows the current viewpoint of the user at a first rate and/or with a first modifier (e.g., a first multiplier, and/or a first function of the movement of the viewpoint), relative to the movement of the viewpoint of the user). In some embodiments, the first damping factor defines the manner in which the first user interface object tracks the movement of the current viewpoint of the user. For example, a larger damping factor reduces and/or delays the movement of the first user interface object relative to the movement of the viewpoint of the user by a larger amount, as compared to a smaller damping factor. In some embodiments, different user interface objects are assigned different damping factors and may follow the viewpoint with different delays, rates, and/or simulated inertia. In some embodiments, moving the second user interface object in the second manner in accordance with the first movement of the current viewpoint of the user includes moving the second user interface object with a second damping factor, distinct from the first damping factor, relative to the first movement of the current viewpoint of the user (e.g., the second user interface object follows the current viewpoint of the user at a second rate and/or with a second modifier (e.g., a second multiplier, and/or a second function of the movement of the viewpoint), distinct from the first rate and/or the first modifier, relative to the movement of the viewpoint of the user). For example, as described with reference to FIG. 7BK, user interface objects in the first category are assigned different damping factors that define how the user interface object is displayed with continuous follow behavior. For example, notification 7196 has a higher damping factor than system function menu 7024, and thus notification 7196 appears to lag behind the movement of the user’s viewpoint more than system function menu 7024 (e.g., which is continuously displayed at a same position relative to the user’s viewpoint). Automatically moving certain user interface objects in the three-dimensional environment to follow the user’s current viewpoint with different damping factors for different types of user interface objects while the user moves in the physical environment, provides real-time visual feedback as the user moves around the physical environment and displays user interface objects at a convenient position such that the user is enabled to view and interact with the user interface objects even as the user moves in the physical environment, thereby providing improved visual feedback to the user.

In some embodiments, the user interface objects of the second type include a system setup user interface (e.g., a settings user interface that includes one or more options for selecting the system settings and/or preferences). For example, in some embodiments, if the first user interface object is a settings user interface, the first user interface object is of the second type and does not follow movement of the user’s viewpoint unless a threshold amount of movement of the viewpoint is detected. For example, as described with reference to FIG. 7BL, the second category of user interface objects that have delayed follow behavior, includes alert 7198, and/or one or more other types of user interface objects, such as a system setup user interface that is displayed to setup the computer system and optionally includes one or more controls for settings/preferences and/or informational tips to navigate the computer system. Visually deemphasizing a system setup user interface as the user changes the user’s current viewpoint, and respawning the system setup user interface at a same position relative to the user’s viewpoint once the user’s viewpoint has settled, reduces the number of inputs and the amount of display area needed for viewing feedback about a state of the device.

In some embodiments, user interface objects of the second type include a system alert (e.g., a notification associated with the operating system and/or the computer system (e.g., not an application of the computer system), an alert regarding a change in system status of the computer system, an alert that requires an explicit user input or attention in order to be dismissed). For example, in some embodiments, if the first user interface object is a system alert, the first user interface object is of the second type and does not follow movement of the user’s viewpoint unless a threshold amount of movement of the viewpoint is detected. For example, as described with reference to FIG. 7BL, the second category of user interface objects that have delayed follow behavior, includes alert 7198, which is visually deemphasized as the user’s viewpoint changes without settling, and is respawned (e.g., as illustrated in FIG. 7BQ) to a same position, in the user’s settled viewpoint, relative to the user’s viewpoint before the user’s viewpoint changed. Visually deemphasizing a system alert as the user changes the user’s current viewpoint, and respawning the system alert at a same position relative to the user’s viewpoint once the user’s viewpoint has settled, reduces the number of inputs and the amount of display area needed for viewing feedback about a state of the device.

In some embodiments, user interface objects of the second type include a media player for displaying currently played media content (e.g., audio file, movie, video, games, and/or other content for media consumption). In some embodiments, the media player is a miniature user interface window (e.g., having a size that is smaller than one or more application windows) that follows the viewpoint of the user. In some embodiments, the media player is a user interface of a display mode for media content that is optionally smaller than a user interface of a primary display mode, such as a full screen display mode, or a window display mode. In some embodiments, the media player including the media content is displayed concurrently with other active windows of the same application and/or other applications, and continues to playback the media content while the user interacts with the user interface objects of the same and/or other applications and/or the three-dimensional environment. In some embodiments, if the first user interface object is a media player with media playing back in it, the first user interface object is of the second type and does not follow movement of the user’s viewpoint unless a threshold amount of movement of the viewpoint is detected. For example, as described with reference to FIG. 7BL, the second category of user interface objects that have delayed follow behavior, includes alert 7198, and/or one or more other types of user interface objects, such as a media player window that displays media content. Visually deemphasizing a media player window as the user changes the user’s current viewpoint, and respawning the media player window at a same position relative to the user’s viewpoint once the user’s viewpoint has settled, reduces the number of inputs and the amount of display area needed for viewing feedback about a state of the device.

In some embodiments, prior to detecting the first movement of the current viewpoint of the user from the first viewpoint to the second viewpoint, the computer system displays a third user interface object, distinct from the first user interface object, in the first view of the three-dimensional environment, wherein the third user interface object is of the second type. For example, in some scenarios, one or more user interface objects of the first type are concurrently displayed with one or more user interface objects of the second type in the first view of the three-dimensional environment. In some embodiments, two user interface objects of the second type are different categories of objects of the second type. For example, the first user interface object is a system alert while the third user interface object includes a media player (e.g., a mini media player window, or a reduced version of the regular media player interface) or a settings user interface of the computer system. In some embodiments, in response to detecting the first movement of the current viewpoint of the user from the first viewpoint to the second viewpoint: in accordance with a determination that the first user interface object is of a first category of the second type, and that the first movement of the current viewpoint of the user from the first viewpoint to the second viewpoint does not meet the first criteria with respect to the first category of the second type, the computer system forgoes displaying the first user interface object at the second position in the three-dimensional environment in the second view of the three-dimensional environment. In some embodiments, in accordance with a determination that the third user interface object is of a second category, different from the first category, of the second type, and that the first movement of the current viewpoint of the user from the first viewpoint to the second viewpoint does not meet the first criteria with respect to the second category of the second type, the computer system forgoes displaying the third user interface object at a new position in the three-dimensional environment in the second view of the three-dimensional environment (e.g., the first user interface object and the third user interface object no longer have the same respective spatial relationships with the current viewpoint of the user). In some embodiments, the first user interface object and/or the third user interface object remain in the field of view provided via the first display generation component, and/or remain at their respective positions in the three-dimensional environment. In some embodiments, the first user interface object and/or the third user interface object move out of the field of view provided via the first display generation component when their respective positions in the three-dimensional environment are no longer visible in the current field of view of the display generation component. In some embodiments, when the movement of the viewpoint of the user does not meet the first criteria with respect to the respective sub-categories of the second type for the first user interface object and/or the third user interface object, the first and/or third user object are world locked (e.g., remains substantially stationary relative to the three-dimensional environment, including the representations of physical objects and/or virtual objects in the three-dimensional environment that are substantially stationary). In some embodiments, in response to detecting the second movement of the current viewpoint of the user from the second viewpoint to the third viewpoint: in accordance with a determination that the first user interface object is of the first category of the second type, that the first movement of the current viewpoint of the user from the first viewpoint to the second viewpoint meets the first criteria with respect to the first category of the second type (e.g., includes a first threshold amount of movement in a respective direction, the current viewpoint does not remains substantially stationary at the third viewpoint, and/or the original position of the first user interface object is not outside of the current view of the three-dimensional environment), and that the first movement of the current viewpoint of the user from the first viewpoint to the second viewpoint does not meet the first criteria with respect to the second category of the second type (e.g., does not include a second threshold amount of movement in a respective direction, the current viewpoint does not remain substantially stationary at the third viewpoint (e.g., if this is not a requirement for the first category of the second type), and/or the original position of the first user interface object is not outside of the current view of the three-dimensional environment (e.g., if this is not a requirement for the first category of the second type)), the computer system displays the first user interface object in the third view of the three-dimensional environment at the third position that has the first spatial relationship with the third viewpoint of the user without displaying the third user interface object in the third view of the three-dimensional environment at a new position that has a same spatial relationship with the third viewpoint as a previous position of the third user interface object has with the first viewpoint before the first and second movement of the current viewpoint of the user. In some embodiments, when the first criteria are met by the continued movement of the current viewpoint for the first category of object of the second type, the user interface objects of the first category of the second type cease to remain at their original positions in the three-dimensional environment, and is displayed at respective new positions in the updated field of view to have the original spatial relationships with the current viewpoint of the user. However, if the first criteria are not met by the same movement of the current viewpoint for the second category of object of the second type, the user interface objects of the second category of the second type continue to remain at their original positions in the three-dimensional environment until the movement of the viewpoint meet the first criteria with respect to the second category of the second type. In some embodiments, the first criteria are different from the first category and the second category of objects of the second type. In some embodiments, objects of the second type are displayed with delayed follow behavior (e.g., wherein objects of the second type are updated to move and/or follow the current viewpoint of the user after the user has moved by a threshold amount and/or settled at a particular viewpoint). In some embodiments, there are a plurality of categories of user interface objects of the second type wherein different categories of the user interface objects of the second type have different delayed follow behaviors (e.g., a first category is faded out and/or is animated as moving, a second category ceases to be displayed before being redisplayed in the settled view, or otherwise displayed with different follow behavior based on the category of the object)). For example, as described with reference to FIG. 7BQ, in some embodiments, the different categories of user interface objects in the second category have different settle criteria. For example, alert 7198-7 is redisplayed in FIG. 7BQ, while a media player window (e.g., also of the second type of object) is not redisplayed because the settle criteria for the media player window has not been met. Automatically redisplaying different categories of user interface objects of the second type at different times based on different settling criteria for each category of user interface object of the second type, provides real-time visual feedback as the user’s viewpoint settles at a fixed position in the three-dimensional environment, and reduces a number of inputs needed to relaunch the user interface object.

In some embodiments, in response to detecting the second movement of the current viewpoint of the user from the second viewpoint to the third viewpoint: in according with a determination that the first user interface object is of a first category of the second type, and that the second movement of the current viewpoint of the user from the second viewpoint to the third viewpoint meets the first criteria with respect to the first category of the second type, the computer system displays a first type of delayed follow behavior for the first user interface object before displaying the first user interface object at the third position in the three-dimensional environment; and in according with a determination that the first user interface object is of a second category, different from the first category, of the second type, and that the second movement of the current viewpoint of the user from the second viewpoint to the third viewpoint meets the first criteria with respect to the second category of the second type, the computer system displays a second type of delayed follow behavior, different from the first type of delayed follow behavior, for the first user interface object before displaying the first user interface object at the third position in the three-dimensional environment. For example, as described with reference to FIG. 7BL, in some embodiments, the different user interface objects in the second category each demonstrate delayed follow behavior, but optionally display different delayed follow behaviors. For example, a system alert user interface ceases to be displayed while the user’s viewpoint changes (e.g., before the user’s viewpoint settles), while alert 7198-2 is faded and/or blurred while the user’s viewpoint changes, and a media player window optionally fades and/or blurs out by a different amount than alert 7198-2. Differentiating between different categories of user interface objects of the second type by displaying different delayed follow behavior, provides real-time visual feedback as the user’s viewpoint changes in the three-dimensional environment, thereby providing improved visual feedback to the user.

In some embodiments, displaying the first type of delayed follow behavior for the first user interface object before displaying the first user interface object at the third position in the three-dimensional environment includes moving the first user interface object in a third manner (e.g., displayed with a first angle and/or with a first distance of movement up, down, left, right, forward and/or backward) to the third position in the third view of the three-dimensional environment; and displaying the second type of delayed follow behavior, different from the first type of delayed follow behavior, for the first user interface object before displaying the first user interface object at the third position in the three-dimensional environment includes moving the first user interface object in a fourth manner, distinct from the third manner, to the third position in the third view of the three-dimensional environment (e.g., displayed with a second angle and/or with a second distance of movement up, down, left, right, forward and/or backward). In some embodiments, if multiple user interface objects of the second type (e.g., multiple user interface objects of different categories of the second type, and/or with different starting spatial relationships to the current viewpoint before the movement of the viewpoint is detected) are concurrently displayed in the first view of the three-dimensional environment, the first criteria are met at different times during the movement of the viewpoint of the user (e.g., when the viewpoint of the user reaches different positions relative to the three-dimensional environment), and the multiple user interface objects execute different movements (e.g., with different movement angles, directions, speeds, and/or distances to catch up to their respective positions that have the same spatial relationship to the current viewpoint as before the movement of the viewpoint was detected) when the first criteria are met for the different user interface objects. For example, alert 7198-7 is displayed as moving (e.g., from its previous position in the three dimensional environment illustrated in FIG. 7BK to its position in FIG. 7BQ) with one or more characteristics of movement, including an angle at which the alert 7198-1 is displayed relative to the user’s viewpoint and/or an amount of movement up, down, left, right, forward and/or backward. In some embodiments, a user interface object in the second category of user interface objects of the second type (e.g., a media player window) is displayed with a different animated transition than the user interface objects in the first category (e.g., alert 7198-7). For example, the media player window is displayed with a different angle and/or with a different amount of movement up, down, left, right, forward and/or backward while it is redisplayed upon determining that the settle criteria for the media player window have been met. Automatically updating display of certain user interface objects by varying an angle and/or a distance of movement as the user moves the user’s current view, such that different user interface objects of the second type appear at different angles and/or move by different amounts compared to other user interface objects that are also displaying delayed follow behavior, provides real-time visual feedback as the user’s current view of the three-dimensional environment changes and provides the user with a greater awareness of the user’s movement relative to the user interface objects, thereby providing improved visual feedback to the user.

In some embodiments, the determination that the second movement of the current viewpoint of the user from the second viewpoint to the third viewpoint meets the first criteria with respect to the first category of the second type includes a determination that the third viewpoint has remained as the current viewpoint of the user for at least a first threshold amount of time; and the determination that the second movement of the current viewpoint of the user from the second viewpoint to the third viewpoint meets the first criteria with respect to the second category of the second type includes a determination that the third viewpoint has remained as the current viewpoint of the user for at least a first threshold amount of time, different from the first threshold amount of time. For example, in some embodiments, the current viewpoint of the user is required to have remained substantially unchanged for a respective amount of time (e.g., “settled” at a respective position for a threshold amount of time) before user interface objects of the second type start to follow and catch up to the movement of the viewpoint of the user (e.g., the user interface objects of the second type delay following the viewpoint of the user until the user has settled at a respective viewpoint). In some embodiments, the amount of settle time is different for different categories of the second type of object. For example, in some embodiments, when there are user interface objects belonging to different categories of the second type with different amount of required settlement time, after the current viewpoint of the user reaches the third viewpoint for a first amount of time, the first criteria are met for a first subset of the user interface objects that is of the first category of the second type, and as a result the first subset of user interface objects (and not other user interface objects of categories of the second type) are displayed at respective new positions to reestablish their respective spatial relationships with the third viewpoint; and at a later time, after the current point of the user has reached the third viewpoint for a second amount of time, the first criteria are met for a second subset of the user interface objects that is of the second category of the second type, and as a result, the second subset of user interface objects are displayed at respective new positions to reestablish their respective spatial relationships with the third viewpoint. For example, as described with reference to FIG. 7BQ, upon the viewpoint of the user settling (e.g., for alert 7198-7) in FIG. 7BQ, the media player window optionally is not redisplayed. In some embodiments, the media player window is redisplayed after distinct settle criteria, different from the settle criteria of alert 7198-7, have been met. Thus, in FIG. 7BQ, alert 7198-7 is redisplayed in response to detecting that the viewpoint of the user has met settle criteria for alert 7198-7 (e.g., a first category of the second type of user interface object), and media player window is redisplayed (e.g., at a same position relative to the user’s current viewpoint, such as in a lower right corner of the current view) only after the settle criteria for the media player window (e.g., a second category of the second type of user interface object) is met. Redisplaying different categories of the second type of user interface objects at different times by assigning different settle criteria to each category of the second type of user interface object, whereby the system automatically redisplays a respective user interface object based on satisfaction of the settle criteria, enables the user to access additional controls for certain user interface objects without cluttering the display other user interface objects until the settle criteria are met.

In some embodiments, prior to displaying the first user interface object at the third position in the third view of the three-dimensional environment in response to detecting the second movement of the current viewpoint of the user from the second viewpoint to the third viewpoint: in accordance with a determination that the first user interface object is of the second type (and, optionally, in accordance with a determination that the first criteria have not been met by the movement of the viewpoint up to this point in time), the computer system changes one or more visual properties of the first user interface object (e.g., fading out, making more translucent, darkening, dimming, ceasing to display, reducing in size, and/or otherwise making it less visually prominent than before) to visually deemphasize the first user interface object in a currently displayed view of the three-dimensional environment during at least a portion of the first movement and the second movement of the current viewpoint of the user; and in accordance with a determination that the first user interface object is of the first type (and, optionally, in accordance with a determination that the first criteria have not been met by the movement of the viewpoint up to this point in time), the computer system changes the one or more visual properties of the first user interface object in the currently displayed view of the three-dimensional environment during at least a portion of the first movement and the second movement of the current viewpoint of the user by less than the one or more visual properties of the first user interface object would be changed to visually deemphasize the first user interface object during at least a portion of the first movement and the second movement of the current viewpoint of the user if the object were an object of the second type (e.g., changing the one or more visual properties by a smaller amount and/or forgoing changing the one or more visual properties). In some embodiments, the first user interface object of the second type follows the viewpoint of the user with a delay and optionally fades out, blurs, ceases to be displayed, or is otherwise visually deemphasized for a period of time before the first criteria are met, e.g., as the viewpoint of the user moves and before the viewpoint settles. In contrast, in some embodiments, the first user interface object of the second type follows the viewpoint of the user with a delay and optionally fades out, blurs, ceases to be displayed, or is otherwise visually deemphasized for a period of time before the first criteria are met, e.g., as the viewpoint of the user moves and before the viewpoint settles. For example, in FIG. 7BL, alert 7198-2 is visually deemphasized (e.g., faded, blurred, ceased to be displayed, or otherwise deemphasized) as the user’s viewpoint changes, without changing a position of alert 7198-2 relative to the three dimensional environment (e.g., alert 7198-2 does not move with the user’s viewpoint). Automatically updating display of certain user interface objects by visually deemphasizing the certain user interface objects relative to other displayed virtual content, when the user is not paying attention to the certain user interface objects, provides real-time visual feedback as the user pays attention to different virtual content in the three-dimensional environment, thereby providing improved visual feedback to the user.

In some embodiments, changing the one or more visual properties of the first user interface object (e.g., fading out, making more translucent, darkening, dimming, ceasing to display, reducing in size, and/or otherwise making it less visually prominent than before) to visually deemphasize the first user interface object in the currently displayed view of the three-dimensional environment during at least a portion of the first movement and the second movement of the current viewpoint of the user, includes: while detecting the at least a portion of the first movement and the second movement of the current viewpoint of the user, updating (e.g., gradually increasing, increasing with a changing rate, and/or otherwise dynamically adjusting, optionally, in accordance with elapsed time, and/or movement distance and/or speed of the viewpoint) an amount of change in the one or more visual properties of the first user interface object relative to an original appearance of the first user interface object (e.g., the values of the one or more visual properties of the first user interface object at a time before the movement of the current viewpoint is detected), over a period of time (e.g., a finite amount of time that is visually noticeable by an average user, e.g., more than 1 second, 2 seconds, 5 seconds, or some other threshold amount of time) during the at least a portion of the first movement and the second movement of the current viewpoint of the user (e.g., during the second movement only, during the first movement only, or during a portion of the first movement and a portion of the second movement). For example, as described with reference to FIG. 7BM, alert 7198-2 is gradually visually deemphasized (e.g., faded, blurred, ceased to be displayed, or otherwise deemphasized) to a greater degree as the user’s viewpoint changes over time. Gradually increasing the amount of visual deemphasis of the first user interface object of the second type as the user’s viewpoint changes over time causes the device to automatically make the user’s current viewpoint more prominent relative to the user interface object, thereby providing improved visual feedback about the user’s real and/or virtual surroundings, and reducing the need for additional inputs (e.g., in order to dismiss the first user interface object of the second type, for improved visibility) while the user changes the user’s viewpoint.

In some embodiments, the determination that the second movement of the current viewpoint of the user from the second viewpoint to the third viewpoint meets the first criteria includes a determination the current viewpoint of the user has less than a threshold amount of movement for at least a respective threshold amount of time (e.g., the viewpoint has remained substantially stationary, while the current viewpoint is the third viewpoint) (e.g., the respective amount of time is a first threshold amount of time for a first category of the second type, a second threshold amount of time for a second category of the second type, or a same threshold amount of time for different categories of the second type). In some embodiments, the first user interface object remains at its original position before it is displayed at the third position in the third view of the three-dimensional environment after the current viewpoint has settled at the position of the third viewpoint for the threshold amount of time with less than the threshold amount movement. In some embodiments, the first user interface object ceases to be displayed or is displayed with an altered appearance of less visual prominence before it is redisplayed at the third position in the third view of the three-dimensional environment after the current viewpoint has settled at the position of the third viewpoint for the threshold amount of time with less than the threshold amount movement. For example, as described with reference to FIG. 7BQ, the one or more user interface objects of the second type, such as alert 7198-7, are redisplayed, also referred to as respawned, at a same position relative to the user’s viewpoint as the position of alert 7198-1 before the change in the user’s viewpoint was detected only after determining that the user’s viewpoint is settled (e.g., at a relatively fixed location). Automatically delaying redisplay of the first user interface object of the second type until the user’s viewpoint has been settled to a fixed location enables the first user interface object to be displayed with minimal impact on the three-dimensional environment while the user is still changing the user’s viewpoint, thereby providing improved visual feedback about the user’s real and/or virtual surroundings, and reducing the need for additional inputs (e.g., in order to dismiss the first user interface object of the second type, for improved visibility) while the user changes the user’s viewpoint.

In some embodiments, in response to detecting at least a portion of the first movement and the second movement of the current viewpoint of the user (e.g., movement from the first viewpoint to the second viewpoint, to an intermediate viewpoint between the first viewpoint and the second viewpoint, or to another intermediate viewpoint between the second viewpoint and the third viewpoint, movement from the first viewpoint to the third viewpoint, or movement from an intermediate viewpoint between the second and third viewpoints to the third viewpoint), in accordance with a determination that the at least a portion of the first movement and the second movement of the current viewpoint of the user meet second criteria (e.g., different from the first criteria) (e.g., second criteria include criteria based on distance, user’s attention, spatial relationship between the first user interface object and the viewpoint, and/or spatial relationship between the first user interface object and the currently displayed view, and/or related timing or duration of one or more the above) and that the first user interface object is of a third type, different from the first type and the second type, the computer system ceases display of the first user interface object. In some embodiments, in response to detecting at least a portion of the first movement and the second movement of the current viewpoint of the user, in accordance with a determination that the at least a portion of the first movement and the second movement of the current viewpoint of the user does not meet the second criteria, and that the first user interface object is of the third type, maintaining display of the first user interface object. In some embodiments, after ceasing display of the first user interface object: in response to detecting the second movement of the current viewpoint of the user: in accordance with a determination that the second movement of the current viewpoint meets the first criteria and that the first user interface object is of the third type, forgoes displaying the first user interface object in the third view of the three-dimensional environment. In some embodiments, after ceasing display of the first user interface object, in response to detecting the second movement of the current viewpoint of the user, in accordance with a determination that the second movement of the current viewpoint of the user does not meet the first criteria, and that the first user interface object is of the third type, forgoing displaying the first user interface object in the third view (e.g., after the first user interface object has ceased to be displayed, it is not redisplayed in response to the second movement that meets the first criteria). For example, in some embodiments, user interface objects of the third type do not follow the viewpoint of the user. In some embodiments, user interface objects of the first type continuously follow the viewpoint of the user, user interface objects of the second type follow the viewpoint of the user with a delay (e.g., after the viewpoint is settled, or after a threshold amount of movement of the viewpoint has been detected, and/or other conditions related to the movement of the viewpoint, time, and spatial relationships between the object, the field of view, and/or the viewpoint), and objects of the third type ceases to be displayed (e.g., is closed or dismissed) after the movement of the viewpoint is started, and is optionally displayed in response to a subsequent user input that corresponds to an explicit request to redisplay the user interface object at a new position. For example, as described with reference to FIG. 7BK, the user interface object for virtual assistant 7200-1 ceases to be displayed in response to detecting a change in the user’s viewpoint in FIG. 7BL, and even upon the user’s viewpoint settling in FIG. 7BQ, the user interface object for virtual assistant 7200-1 is not automatically redisplayed at the user’s settled viewpoint. Automatically ceasing display of the first user interface object of the third type in response to detecting a change in the user’s viewpoint, without automatically redisplaying the first user interface object when the user’s viewpoint settles, reduces the number of inputs needed to dismiss the first user interface object of the third type.

In some embodiments, while displaying the third view of the three-dimensional environment, the computer system detects a user input that corresponds to a request to display a user interface object of the third type; and in response to detecting the user input that corresponds to a request to display a user interface object of the third type, in accordance with a determination that the first user interface object is of the third type and that the first user interface object has ceased to be displayed during the at least a portion of the first movement and the second movement of the current viewpoint of the user, redisplays the first user interface object in the third view of the three-dimensional environment (e.g., optionally at a same position relative to the current viewpoint of the user in the third view of the three-dimensional environment). In some embodiments, in response to detecting the user input that corresponds to the request to display a user interface object of the third type, in accordance with a determination that the first user interface object is not of the third type, the computer system forgoes displaying the first user interface object in the third view of the three-dimensional environment. In some embodiments, in response to detecting the user input that corresponds to the request to display a user interface object of the third type, in accordance with a determination that the first user interface object is of the third type, and that the first user interface object is currently displayed in the third view of the three-dimensional environment, the computer system maintains display of the first user interface object in the third view of the three-dimensional environment. In some embodiments, in response to detecting a user input that does not correspond to a request to display a user interface object of the third type, in accordance with a determination that the first user interface object is of the third type and that the first user interface object has ceased to be displayed during the at least a portion of the first movement and the second movement of the current viewpoint of the user, the computer system forgoes redisplaying the first user interface object in the third view of the three-dimensional environment. For example, as described with reference to FIG. 7BQ-7BR, the user interface object for virtual assistant 7200-2 is redisplayed in the user’s current view in response to detecting a user input that invokes the virtual assistant. In some embodiments, the invocation input is a button press, a voice invocation, and/or selection of a text entry field (e.g., which causes a keyboard to automatically be displayed). Displaying the first user interface object of the third type in response to a user input to invoke the first user interface object provides the user with access to additional control options without cluttering the user interface by maintaining the first user interface object in the user’s view when the control is not needed.

In some embodiments, user interface objects of the third type includes one or more instances of a control center user interface (e.g., that enables the user to control one or more settings and/or one or more quick-access functions), a notification user interface that displays one or more previously received notifications (e.g., a user interface element that displays notifications that have been saved, if any), an expanded version of a notification (e.g., the system optionally expands a notification from a reduced or normal version to an expanded version that includes additional notification content of the notification and/or additional controls in response to a user gaze input directed to the reduced or normal version of the notification), a home user interface (e.g., that displays one or more application icons or other system functions), a keyboard, and/or a virtual assistant, respectively. For example, as described with reference to FIG. 7BK, the third category of user interface objects includes one or more of a control center, a notification center, an expanded notification, a home user interface, a keyboard and/or virtual assistant 7200-1. Displaying a respective user interface object to perform a respective system function of the computer system, such as accessing a control center, a notification center, an expanded notification, a home user interface, a keyboard, or a virtual assistant, in response to detecting an invocation input for accessing the respective system function of the first computer system, reduces the number of inputs needed to access additional control options without cluttering the UI with additional displayed controls when not needed.

In some embodiments, in response to detecting the at least a portion of the first movement and the second movement of the current viewpoint of the user (e.g., movement from the first viewpoint to the second viewpoint, to an intermediate viewpoint between the first viewpoint and the second viewpoint, or to another intermediate viewpoint between the second viewpoint and the third viewpoint, movement from the first viewpoint to the third viewpoint, or movement from an intermediate viewpoint between the second and third viewpoints to the third viewpoint): in accordance with a determination that the at least a portion of the first movement and the second movement of the current viewpoint of the user meets third criteria, the computer system ceases display of the first user interface object, wherein: the second criteria include a requirement that a viewpoint of the user move outside of a second region (e.g., a safe zone in which movement of the viewpoint of the user will not cause the first user interface object to disappear) of the three-dimensional environment in order for the third criteria to be met; the third criteria include a requirement that a viewpoint of the user move outside of a third region (e.g., a safe zone in which movement of the viewpoint of the user will not cause the first user interface object to disappear) of the three-dimensional environment in order for the third criteria to be met; and the third region has a different size and/or shape than the second region. In some embodiments, in response to detecting the at least a portion of the first movement and the second movement of the current viewpoint of the user, in accordance with a determination that the at least a portion of the first movement and the second movement of the current viewpoint does not meet the third criteria, the computer system maintains display of the first user interface object. For example, in some embodiments, objects of different types and optionally different categories (e.g., the second type, different categories of the second type, the third type, and/or different categories of the third type) have different safe zones (e.g., a safe viewing zone to view a respective user interface object) in which movement of the viewpoint do not cause the objects to cease to be displayed. In other words, while the user’s viewpoint is in the safe zone for a respective object of the second type or the third type, the user interface object continues to be displayed; and if the user’s viewpoint is outside of the safe zone for a respective object, the user interface object ceases to be displayed (optionally, before it is redisplayed when the first criteria are met, or when it is redisplayed in response to an explicit user input, depending on whether the object is an object of the second type, or an object of the third type). In some embodiments, the third type of user interface object has a safe zone that includes the user interface object, such that the user is enabled to approach (e.g., get close to) the user interface object and optionally interact with the user interface object through direct manipulation using a gesture at the location of the user interface object. For example, while the user and/or the user’s viewpoint is within the safe zone, the first user interface object is maintained in the display at a same position within the three dimensional environment (e.g., without regard to the movement of a current viewpoint of the user), and while the user and/or the user’s viewpoint is outside of the safe zone, the first user interface object is redisplayed in front of the user (e.g., with the same spatial relationship relative to the view of the three-dimensional environment corresponding to the current viewpoint of the user). In some embodiments, the safe zone is defined relative to the position of the first user interface object (e.g., as a U-shape with the first user interface object located in the bottom portion of the U-shape, a rectangular box with the first user interface object located at the center of the rectangular box, or other irregular shapes with the first user interface object located inside or outside). For example, as described with reference to FIG. 7BR, in some embodiments a safe zone is assigned to each type of user interface object, whereby, while the user’s current viewpoint has a location that corresponds to an area of the three dimensional environment that includes the safe zone, the user interface object (e.g., virtual assistant 7200-2) is not dismissed, and if the user’s current viewpoint is directed outside of the area of the three dimensional environment that includes the safe zone, the user interface object is dismissed in accordance with the behavior of the third type of user interface object (e.g., as described with reference to FIG. 5BK). Automatically determining whether to dismiss or continue displaying a user interface object based on the type of user interface object and based on whether the user’s current viewpoint has a location that corresponds to a safe zone, reduces a number of inputs required for a user to manually dismiss the user interface object when the user is outside of the safe zone, and provides access to additional controls by maintaining the user interface object while the user’s current viewpoint has a location that corresponds to the safe zone.

In some embodiments, the third region is larger than the second region (e.g., user interface objects of the third type have a larger safe zone than the user interface objects of the second type). For example, as described with reference to FIG. 7BR, in some embodiments a safe zone for the third type of user interface object (e.g., virtual assistant 7200-2) is larger than the safe zone for the first and/or second type of user interface object. Providing a different sized safe zone for certain types user interface objects than other types of user interface objects, whereby the system automatically dismisses or continues displaying a respective user interface object based on whether the user’s current viewpoint has a location that corresponds toa safe zone, reduces a number of inputs required for a user to manually dismiss the user interface object when the user is outside of the safe zone, and provides the user with access to additional controls by maintaining the user interface object while the user’s current viewpoint has a location that corresponds to the safe zone.

In some embodiments, the third region has a different shape from the second region. (e.g., irregular shapes (e.g., a U-shape, a shape other than a circle, square, or rectangle) that are based on the shape and/or nature of the user interface object, and optionally, based on the posture of the user and how the user is viewing the three-dimensional environment (e.g., reclined, sitting, or standing)). For example, as described with reference to FIG. 7BR, in some embodiments a safe zone for the third type of user interface object (e.g., virtual assistant 7200-2) is an irregular shape, such as a U-shape. Providing a different shaped safe zone for certain types user interface objects than other types of user interface objects, whereby the system automatically dismisses or continues displaying a respective user interface object based on whether the user’s current viewpoint has a location that corresponds toa safe zone, enables the user to access additional controls for a first type of user interface object without cluttering the display with a third type of user interface object when the user moves outside of the safe zone.

In some embodiments, the third region extends to a location that is close enough to the location of the first user interface object in the three-dimensional environment (e.g., the third region extends to, is near, or encompasses the first user interface object) to enable the user to provide inputs (e.g., direct inputs) to a location in the three-dimensional environment at which the first user interface object is located. For example, as described with reference to FIG. 7BR, in some embodiments a safe zone for the third type of user interface object (e.g., virtual assistant 7200-2) includes the user interface object such that the user is enabled to approach and/or interact with the user interface object, without the user interface object being dismissed, while the user’s current viewpoint has a location that corresponds to the safe zone. Providing a safe zone that includes the user interface object, such that the user is enabled to approach and interact with the user interface object without automatically moving the user interface object, provides additional control options for the user while the user’s current viewpoint has a location that corresponds to the safe zone.

In some embodiments, aspects/operations of methods 8000, 9000, 10000, 11000, 12000, 13000, 14000, 15000, and 16000 may be interchanged, substituted, and/or added between these methods. For example, the first user interface object (e.g., system control indicator) in the method 16000 in some circumstances has a different appearance as described in the methods 9000-15000, and the user interface elements that are displayed (e.g., the plurality of affordances for accessing system functions of the first computer system) may be replaced by, or concurrently displayed with, other user interface elements (e.g., additional content associated with a notification, a user interface that includes an affordance for joining a communication session, and other user interface elements in the methods 9000-15000). For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user’s health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user’s general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In another example, users can select not to provide data for customization of services. In yet another example, users can select to limit the length of time data is maintained or entirely prohibit the development of a customized service. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can generated by inferring preferences based on non-personal information data or a bare minimum amount of personal information, such as the content being requested by the device associated with a user, other non-personal information available to the service, or publicly available information.

What is claimed is:

1-136. (canceled)

137. A method, including:
at a first computer system that is in communication with a first display generation component and one or more input devices:
while a first view of a three-dimensional environment is visible via the first display generation component, detecting, via the one or more input devices, a first user input, including detecting a first gaze input that is directed to a first position in the three-dimensional environment; and
in response to detecting the first user input including detecting the first gaze input:
in accordance with a determination that the first position in the three-dimensional environment has a first spatial relationship to a viewport through which the three-dimensional environment is visible, displaying a first user interface object in the first view of the three-dimensional environment, wherein the first user interface object includes one or more affordances for accessing a first set of functions of the first computer system, wherein the first user interface object is displayed at a second position in the three-dimensional environment that has a second spatial relationship, different from the first spatial relationship, to the viewport through which the three-dimensional environment is visible; and
in accordance with a determination that the first position in the three-dimensional environment does not have the first spatial relationship to the viewport through which the three-dimensional environment is visible, forgoing displaying the first user interface object in the first view of the three-dimensional environment.

138. The method of claim 137, including:
while the first user interface object is not visible in a currently displayed view of the three-dimensional environment, detecting a first change of a viewpoint of a user from a first viewpoint associated with the first view of the three-dimensional environment to a second viewpoint associated with a second view of the three-dimensional environment; and
in response to detecting the first change in the viewpoint of the user, updating the currently displayed view of the three-dimensional environment in accordance with the first change in the viewpoint of the user, to display the second view of the three-dimensional environment;
while the second view of the three-dimensional environment is visible via the first display generation component, detecting, via the one or more input devices, a second user input, including detecting a second gaze input that is directed to a third position, different from the first position, in the three-dimensional environment; and
in response to detecting the second user input including detecting the second gaze input:
in accordance with a determination that the third position in the three-dimensional environment has the first spatial relationship to the viewport through which the three-dimensional environment is visible, displaying the first user interface object in the second view of the three-dimensional environment, at a fourth position in the three-dimensional environment that has the second spatial relationship to the second view of the three-dimensional environment; and
in accordance with a determination that the third position in the three-dimensional environment does not have the first spatial relationship to the viewport through which the three-dimensional environment is visible, forgoing displaying the first user interface object in the second view of the three-dimensional environment.

139. The method of claim 137, including:
in response to detecting the first user input including detecting the first gaze input:
in accordance with a determination that the first position in the three-dimensional environment does not have the first spatial relationship to viewport through which the three-dimensional environment is visible and that a second user interface object, different from the first user interface object, occupies the first position in the three-dimensional environment, performing a respective operation that corresponds to the second user interface object.

140. The method of claim 138, including:
while the first view of the three-dimensional environment is visible and the first user interface object is not displayed in the first view of the three-dimensional environment, detecting a third user input that includes a third gaze input that is directed to a fifth position in the three-dimensional environment;
in response to detecting the third user input that includes the third gaze input:
in accordance with a determination that the fifth position in the three-dimensional environment is within a first region that includes a respective position having the first spatial relationship to the viewport through which the three-dimensional environment is visible, displaying a third user interface object at the respective position in the three-dimensional environment; and
in accordance with a determination that the fifth position in the three-dimensional environment is not within the first region that includes the respective position having the first spatial relationship to the viewport through which the three-dimensional environment is visible, forgoing displaying the third user interface object at the respective position in the three-dimensional environment.

141. The method of claim 140, wherein:
the first region includes a first subregion including the respective position that has the first spatial relationship to the viewport through which the three-dimensional environment is visible and a second subregion that does not include the respective position.

142. The method of claim 141, wherein displaying the first user interface object at the second position in response to detecting the first user input including the first gaze input is further in accordance with a determination that the first gaze input is maintained within the first subregion for at least a first threshold amount of time.

143. The method of claim 142, including:
while the first user interface object is not visible in the first view of the three-dimensional environment, detecting, via the one or more input devices, a fourth user input, including detecting a fourth gaze input that is directed to the first subregion and that has not been maintained within the first subregion for at least the first threshold amount of time; and
in response to detecting the fourth user input including the fourth gaze input:
in accordance with a determination that a respective gesture meeting first criteria has been detected while the fourth gaze input is maintained in the first subregion, displaying the first user interface object at the second position in the three-dimensional environment.

144. The method of claim 137, wherein the first user interface object includes a respective system user interface for accessing one or more system functions of the first computer system.

145. The method of claim 137, including:
while displaying the first user interface object, in the first view of the three-dimensional environment, at the second position in the three-dimensional environment that has the second spatial relationship to the first view of the three-dimensional environment, detecting that user attention is no longer directed to the first position in the three-dimensional environment; and
in response to detecting that the user attention is no longer directed to the first position in the three-dimensional environment, ceasing to display the first user interface object in the first view of the three-dimensional environment.

146. The method of claim 145, wherein:
the determination that the first position in the three-dimensional environment has the first spatial relationship to the viewport through which the three-dimensional environment is visible includes a determination that the first position is within a first response region of a first size; and
detecting that the user attention is no longer directed to the first position in the three-dimensional environment includes detecting that the user attention has moved from within the first response region to outside of a second response region of a second size that is different from the first size.

147. The method of claim 137, including:
while displaying the first user interface object in the first view of the three-dimensional environment, detecting a fourth user input including detecting gaze input directed to a respective affordance of the one or more affordances for accessing the first set of functions of the first computer system in conjunction with detecting a first speech input from a user; and
in response to detecting the fourth user input, performing a respective operation corresponding to the respective affordance in accordance with the first speech input.

148. The method of claim 147, wherein performing the respective operation corresponding to the respective affordance in accordance with the first speech input includes:
in accordance with a determination that the respective affordance is an affordance for accessing a virtual assistant function of the first computer system, performing an operation corresponding to instructions contained in the first speech input.

149. The method of claim 147, wherein performing the respective operation corresponding to the respective affordance in accordance with the first speech input includes:
in accordance with a determination that the respective affordance is an affordance for accessing a text entry function of the first computer system that accepts text input, providing text converted from the first speech input as input to the text entry function.

150. The method of claim 137, including:
while displaying the first view of the three-dimensional environment via the first display generation component, determining a current spatial relationship between the first display generation component and a user; and
adjusting criteria for determining whether the respective position has the first spatial relationship to the viewport through which the three-dimensional environment is visible in accordance with the current spatial relationship between the first display generation component and the user.

151. The method of claim 150, including:
in accordance with a determination that the current spatial relationship between the first display generation component and the user no longer meets alignment criteria, displaying a second visual indication that the current spatial relationship between the first display generation component and the user no longer meets the alignment criteria.

152. The method of claim 150, wherein displaying the first user interface object at the second position that has the second spatial relationship to the viewport through which the three-dimensional environment is visible includes:
adjusting criteria for establishing the second spatial relationship between the first user interface object and the viewport through which the three-dimensional environment is visible in accordance with the current spatial relationship between the first display generation component and the user.

153. The method of claim 150, including:
displaying one or more user interface objects in the first view of the three-dimensional environment, wherein the one or more user interface objects are different from the first user interface object, wherein respective positions of the one or more user interface objects in the first view of the three-dimensional environment do not change in accordance with a change to the current spatial relationship between the first display generation component and the user.

154. The method of claim 137, wherein:
at a first time, the one or more affordances for accessing the first set of functions of the first computer system include a first affordance for adjusting an audio level of the first computer system; and
at a second time, different from the first time, the one or more affordances for accessing the first set of functions of the first computer system include a second affordance for adjusting an audio level of a first type of audio provided by the first computer system and a third affordance for adjusting an audio level of a second type of audio provided by the first computer system, wherein the second affordance and the third affordance are different from the first affordance.

155. The method of claim 140, including:
while displaying the third user interface object at the respective position in the three-dimensional environment that has the first spatial relationship to the viewport through which the three-dimensional environment is visible, detecting, via the one or more input devices, a second change of the viewpoint of the user from the first viewpoint a third viewpoint; and
in response to detecting the second change in the viewpoint of the user, displaying the viewport through which the three-dimensional environment is visible and displaying the third user interface object at an updated position in the three-dimensional environment that has the first spatial relationship to the viewport through which the three-dimensional environment is visible.

156. The method of claim 155, wherein the third user interface object is translucent and has an appearance that is based on at least a portion of the three-dimensional environment over which the third user interface object is displayed.

157. The method of claim 155, further including:
while the three-dimensional environment is visible through the viewport, displaying the third user interface object with a first appearance at a first indicator position in the three-dimensional environment, wherein the first appearance of the third user interface object at the first indicator position is based at least in part on a characteristic of the three-dimensional environment at the first indicator position in the viewport through which the three-dimensional environment is visible; and
in response to detecting a movement of the viewpoint of the user from the first viewpoint to the third viewpoint in the three-dimensional environment, displaying the third user interface object with a respective appearance at a respective indicator position in the three-dimensional environment that has the first spatial relationship to the viewport through which the three-dimensional environment is visible, wherein the respective appearance of the first user interface object at the respective indicator position is based at least in part on a characteristic of the three-dimensional environment at the respective indicator position.

158. The method of claim 155, wherein displaying the first user interface object in response to detecting the first user input including the first gaze input, includes displaying an animated transition of the one or more affordances for accessing the first set of functions of the first computer system emerging from the third user interface object in a first direction.

159. The method of claim 155, wherein displaying the first user interface object in response to detecting the first user input including the first gaze input, includes displaying an animated transition of the one or more affordances for accessing the first set of functions of the first computer system gradually appearing.

160. The method of claim 155, including:
in response to detecting the first user input that includes the first gaze input:
in accordance with a determination that the first position in the three-dimensional environment has the first spatial relationship to the viewport through which the three-dimensional environment is visible:
displaying an indication of the first user interface object before displaying the first user interface object at the second position; and
after displaying the indication of the first user interface object;
in accordance with a determination that criteria for displaying the first user interface object is met by the first user input, replacing the indication of the first user interface object with the first user interface object; and
in accordance with a determination that criteria for displaying the first user interface object is not met by the first user input and that the first gaze input has moved away from the first position that has the first spatial relationship with the viewport through which the three-dimensional environment is visible, ceasing to display the indication of the third user interface object and forgoing display the third user interface object at the second position in the three-dimensional environment.

161. The method of claim 137, wherein the first position in the three-dimensional environment is in a periphery region of the viewport through which the three-dimensional environment is visible.

162. The method of claim 137, including:
while displaying the first user interface object including the one or more affordances for accessing the first set of functions of the first computer system, detecting a fifth user input including detecting gaze input directed to a respective affordance of the one or more affordances; and
in response to detecting the fifth user input:
in accordance with a determination that the respective affordance is a first affordance corresponding to a first function of the first computer system and that the fifth user input includes a gesture input that meets gesture criteria, performing the first function; and
in accordance with a determination that the respective affordance is the first affordance corresponding to the first function of the first computer system and that the fifth user input does not include a gesture input that meets the gesture criteria, forgoing performing the first function; and
in accordance with a determination that the respective affordance is a second affordance corresponding to a second function of the first computer system and that the fifth user input does not include a gesture input that meets the gesture criteria, performing the second function.

163. The method of claim 137, including:
while displaying the first user interface object including the one or more affordances for accessing the first set of functions of the first computer system, detecting a change in pose of a first portion of the user; and
in response to detecting the change in pose of the first portion of the user:
in accordance with a determination that the change in pose of the first portion of the user results in a first type of pose, changing an appearance of a respective affordance of the one or more affordances; and
in accordance with a determination that the change in pose of the first portion of the user does not result in the first type of pose, forgoing changing the appearance of the respective affordance.

164. The method of claim 163, including:
in response to detecting the change in pose of the first portion of the user:
in accordance with a determination that the change in pose of the first portion of the user results in the first type of pose, forgoing changing an appearance of at least one affordance of the one or more affordances different from the respective affordance.

165. The method of claim 137, including:
while displaying the first user interface object including the one or more affordances for accessing the first set of functions of the first computer system, detecting, via the one or more input devices, a sixth user input including gaze input directed to a respective affordance of the one or more affordances; and
in response to detecting the sixth user input directed to the respective affordance, displaying additional content associated with the respective affordance.

166. The method of claim 137, further including:
while displaying the first user interface object, detecting, via the one or more input devices, a seventh user input that activates a first affordance of the one or more affordances for accessing the first set of functions of the first computer system; and
in response to detecting the seventh user input that activates the first affordance, displaying a first system user interface for a first system function of the first computer system in the three-dimensional environment.

167. The method of claim 166, including:
while displaying the first user interface object and the first system user interface, detecting, via the one or more input devices, an eighth user input that activates a second affordance, different from the first affordance, of the one or more of affordances for accessing the first set of functions of the first computer system; and
in response to detecting the eighth user input that activates the second affordance:
displaying a second system user interface, different from the first system user interface, for a second system function of the first computer system; and
ceasing to display the first system user interface.

168. The method of claim 166, including:
while displaying the first system user interface and the first user interface object, detecting, via the one or more input devices, a ninth user input that includes a gaze input directed to the first user interface object; and
in response to detecting the ninth user input, changing one or more visual properties of the first system user interface to reducing visual prominence of the first system user interface relative to the first user interface object.

169. The method of claim 166, further including:
while displaying the first system user interface and the first user interface object, detecting, via the one or more input devices, a tenth user input that includes gaze input directed to the first system user interface; and
in response to detecting the tenth user input, changing one or more visual properties of the first user interface object to reduce visual prominence of the first user interface object relative to the first system user interface.

170. The method of claim 166, further including:
while displaying, via the first display generation component, an application launching user interface in the three-dimensional environment and the first user interface object, detecting, via the one or more input devices, an eleventh user input that activates a third affordance of the one or more of affordances for accessing the first set of functions of the first computer system; and
in response to detecting the eleventh user input that activates the respective affordance:
displaying a third system user interface for a third system function of the first computer system that corresponds to the third affordance; and
ceasing to display the application launching user interface.

171. The method of claim 166, further including:
while displaying, via the first display generation component, an application user interface in the three-dimensional environment and the first user interface object, detecting, via the one or more input devices, a twelfth user input that activates a fourth affordance of the one or more of affordances for accessing the first set of functions of the first computer system; and
in response to detecting the twelfth user input that activates the respective affordance:
displaying a fourth system user interface for a fourth system function of the first computer system that corresponds to the fourth affordance, concurrently with the application user interface.

172. The method of claim 137, further including:
while displaying, via the first display generation component, the first user interface object, detecting, via the one or more input devices, a thirteenth user input that activates a fifth affordance of the one or more of affordances for accessing the first set of functions of the first computer system; and
in response to detecting the thirteenth user input that activates the fifth affordance:
performing a respective operation that corresponds to activation of the fifth affordance.

173. The method of claim 172, wherein performing the respective operation includes displaying one or more controls for adjusting one or more settings of the first computer system, wherein the one or more controls are displayed overlaying at least a portion of the first user interface object.

174. The method of claim 173, wherein detecting the thirteenth user input that activates the fifth affordance of the one or more of affordances for accessing the first set of functions of the first computer system includes detecting a pinch and release gesture that is directed to the fifth affordance, and the method includes:
while displaying the one or more controls for adjusting one or more settings of the first computer system, detecting a pinch and drag gesture that is directed to a first control of the one or more controls; and
in response to detecting the pinch and drag gesture that is directed to the first control of the one or more controls, adjusting a first setting that corresponds to the first control in accordance with one or more characteristics of the pinch and drag gesture.

175. The method of claim 138, wherein displaying the first user interface object in the first view of the three-dimensional environment includes displaying the first user interface object at a first simulated distance from the first viewpoint of the user, wherein the first simulated distance is less than respective simulated distances of one or more other user interface objects displayed in the first view of the three-dimensional environment from the first viewpoint of the user.

176. The method of claim 137, including:
displaying a plurality of system status indicators that include information about a status of the first computer system, concurrently with displaying the first user interface object.

177. The method of claim 137, wherein the first user interface object is displayed while the first gaze input remains within a first level of proximity to the first user interface object, and the method includes:
while displaying the first user interface object, detecting that the first gaze input moves away from the first user interface object; and
in response to detecting that the first gaze input has moved away from the first user interface object:
in accordance with a determination that the first gaze input is beyond the first level of proximity to the first user interface object, ceasing to display the first user interface object; and
in accordance with a determination that the first gaze input remains within the first level of proximity to the first user interface object, maintaining display the first user interface object.

178. The method of claim 177 including:
after ceasing to display the first user interface object, detecting that the first gaze input has moved back to the first position that has the first spatial relationship to the viewport through which the three-dimensional environment is visible; and
in response to detecting that the first gaze input has moved back to the first position, redisplaying the first user interface object.

179. A computer system, comprising:
a first display generation component;
one or more input devices;
one or more processors; and
memory storing one or more programs, wherein the one or more programs are configured to be executed by the one or more processors, the one or more programs including instructions for:
while a first view of a three-dimensional environment is visible via the first display generation component, detecting, via the one or more input devices, a first user input, including detecting a first gaze input that is directed to a first position in the three-dimensional environment; and
in response to detecting the first user input including detecting the first gaze input:
in accordance with a determination that the first position in the three-dimensional environment has a first spatial relationship to a viewport through which the three-dimensional environment is visible, displaying a first user interface object in the first view of the three-dimensional environment, wherein the first user interface object includes one or more affordances for accessing a first set of functions of the computer system, wherein the first user interface object is displayed at a second position in the three-dimensional environment that has a second spatial relationship, different from the first spatial relationship, to the viewport through which the three-dimensional environment is visible; and
in accordance with a determination that the first position in the three-dimensional environment does not have the first spatial relationship to the viewport through which the three-dimensional environment is visible, forgoing displaying the first user interface object in the first view of the three-dimensional environment.

180. A computer readable storage medium storing one or more programs, the one or more programs comprising instructions that, when executed by a computer system that includes and/or is in communication with a first display generation component, and one or more input devices, cause the computer system to:
while a first view of a three-dimensional environment is visible via the first display generation component, detect, via the one or more input devices, a first user input, including detecting a first gaze input that is directed to a first position in the three-dimensional environment; and
in response to detecting the first user input including detecting the first gaze input:
in accordance with a determination that the first position in the three-dimensional environment has a first spatial relationship to a viewport through which the three-dimensional environment is visible, display a first user interface object in the first view of the three-dimensional environment, wherein the first user interface object includes one or more affordances for accessing a first set of functions of the computer system, wherein the first user interface object is displayed at a second position in the three-dimensional environment that has a second spatial relationship, different from the first spatial relationship, to the viewport through which the three-dimensional environment is visible; and
in accordance with a determination that the first position in the three-dimensional environment does not have the first spatial relationship to the viewport through which the three-dimensional environment is visible, forgo displaying the first user interface object in the first view of the three-dimensional environment.

181-329. (canceled)
